(19) United States
(12) Patent Application Publication
(10) Pub. No.: US 2022/0010248 A1
(43) Pub. Date: Jan. 13, 2022

(54) SCOTCH REPLICAS PRODUCED FROM INDIVIDUAL COMPONENTS

(71) Applicant: Ava Food Labs, Inc., San Francisco, CA (US)

(72) Inventors: Taylor Shulman, Berkeley, CA (US); Ethan Charles Beswick, San Francisco, CA (US); Joshua Canaria Decolongon, San Francisco, CA (US); Jillian Angela Jastrzembski, San Francisco, CA (US); Leslie P. Silva, Emeryville, CA (US); Joshua Lundquist, Dublin, CA (US); Erica Nicole Bilodeau, San Carlos, CA (US); Alec Kremonic Lee, San Francisco, CA (US); Mardonn Carl Chua, San Francisco, CA (US)

(21) Appl. No.: 17/282,203

(22) PCT Filed: Oct. 1, 2019
(86) PCT No.: PCT/US2019/054165

§ 371 Date: Apr. 1, 2021

Related U.S. Application Data
(60) Provisional application No. 62/890,781, filed on Aug. 23, 2019.
(60) Provisional application No. 62/739,682, filed on Oct. 1, 2018.

(51) Int. Cl. C12G 3/07

(52) U.S. Cl. CPC C12G 3/07

(57) ABSTRACT

Materials and methods for producing Scotch-like alcoholic beverages from individual components are provided herein.

### CROSS-REFERENCE TO RELATED APPLICATIONS

This application claims benefit priority to U.S. Provisional Application Ser. No. 62/739,682, filed on Oct. 1, 2018 and U.S. Provisional Application Ser. No. 62/890,781, filed on Aug. 23, 2019, the entirety of each of which is incorporated by reference.

### TECHNICAL FIELD

This document relates to materials and methods for producing Scotch-like alcoholic beverages from individual components.

### BACKGROUND

Whiskey (also known as whisky) is a type of alcoholic beverage that actually encompasses a category of spirits including, without limitation, whiskey, bourbon, scotch, and rye. Whiskey/whisky typically is produced by fermentation of grains, distillation, and aging in wooden barrels. A general determinant between “whiskey” and “whisky” is the production locale. Ireland and the United States typically produce “whiskey,” while Scotland, Canada, Japan, and other countries generally produce “whisky.”

In addition to the country of origin, the type of whiskey/whisky also is determined by the grain used in the distillation process. For example, American whiskeys are a broad category, but usually are made of corn, rye, barley or wheat and aged in oak barrels. Bourbon is an American whiskey, and is required to be made from a mash of at least 51 percent corn and aged in new charred-oak barrels. Irish whiskey is distilled and aged in wooden barrels in Ireland for at least three years before bottling. Scotch whisky is made from barley, and is distilled in Scotland and aged in oak barrels for at least three years. The barley may be dried using smoke from burning peat, which can provide the smoky flavor typical of Scotch. Rye whiskey is an American whiskey, and is similar to bourbon except that it must be distilled with a mash of at least 51 percent rye. Canadian whiskies are fermented, distilled, and aged in Canada using grains that typically are fermented, distilled, and aged separately, and then blended to give a final product.

Going forward in this document, the term “whiskey” refers to both “whiskey” and “whisky” spirits.

Traditional methods for producing whiskey can be lengthy and costly, involving the harvesting of particular crops, followed by processing, fermenting, and aging steps. Conventional distillation begins with grains that undergo a series of chemical and physical processes, from creating the wort and fermenting the mash, to aging the product. The type of grain, the water and wood used to generate a whiskey, and the climate where the product is aged are all important in traditional production methods. Each component of the traditional, geographically constrained processes for making whiskey can have an inherent variability and risk, including climate, crop disease, and contamination, which can render such methods and their resulting products inconsistent from batch to batch and year to year.

### SUMMARY

This document is based, at least in part, on the identification of compounds that contribute to the flavor and aroma of various types of whiskey, and on the development of methods for combining those compounds to yield Scotch replicas that have the taste, aroma, and other characteristics of traditionally generated Scotch spirits. Because each ingredient is added individually, the methods disclosed herein reduce many of the risks and variability associated with traditional whiskey production. The methods also provide infinite reproducibility of a recipe, which is not possible with traditional production methods. Further, the methods described herein allow for unique flexibility in optimization of the flavors, aromas, and textures of whiskeys of various types (e.g., bourbon and Scotch), and greatly reduce or even eliminate the possibility that the resulting beverage will contain detrimental or undesired components. Moreover, the methods disclosed herein differ from currently existing methods in that they are rapid, reproducible, and cost-effective.

In one aspect, provided herein is a Scotch-like alcoholic beverage including ethanol, water, and one or more additional volatile organic compounds (VOCs), wherein the one or more additional VOCs include at least one compound selected from the group consisting of acetoin, (1R)-(−)-myrtenal, 3-ethyl-2-hydroxy-2-cyclopenten-1-one (ethyl cyclopentenolone), 1,4-cineole, 2-acetyl-1-methylpyrrole, 2-isopropyl-4-methyl thiazole, 3-methylthio hexyl acetate, 3-phenylpropanal, 4,5,6,7-tetrahydro-3,6-dimethylbenzofuran, 4-mercapto-4-methyl-2-pentanone, allyl heptanoate, amyl butyrate, anisyl acetate, anisyl butyrate, b-caryophellene, benzyl alcohol, benzyl butyrate, benzyl formate, beta-pinene, butyl butyryllactate, butyl formate, butyraldehyde, cis-3-hexenyl butyrate, cis-3-hexenyl valerate, cis-6-nonen-1-ol, citronellal, D-carvone, d-fenchone, DL-3-methyl-2-butanol, ethyl 2-trans-4-cis-decadienoate, ethyl trans-3-hexenoate, ethyl(methylthio) acetate, eucalyptol, furufyl thioacetate, gamma-hexalactone, gamma-valerolactone, hexyl 3-methylbutanoate, hexyl isobutyrate, IBMP (3-Isobutyl-2-methoxypyrazine), L-menthyl acetate, maltol, methionyl acetate (3-methylthio-propylacetate), methyl anthranilate, methyl cyclopentenolone, myrcene, nonanoic acid, p-anisaldehyde, perillaldehyde, phenylacetaldehyde dimethyl acetal, propionaldehyde, propyl butyrate, tetrahydrolinalool, trans-2-hexen-1-al, valeraldehyde, valeric acid, vanillyl butyl ether.

Implementations can include one or more of the following features. The one or more additional VOCs can include at least one compound selected from the group consisting of acetoin, amyl butyrate, beta-pinene, butyl formate, butyraldehyde, maltol, myrcene, nonanoic acid, p-anisaldehyde, propionaldehyde, trans-2-hexen-1-al, valeraldehyde, valeric acid, and combinations thereof. The one or more additional VOCs can include at least one compound selected from the group consisting of acetoin, beta-pinene, butyl formate, maltol, myrcene, trans-2-hexen-1-al, valeraldehyde, and combinations thereof. The one or more additional VOCs can exclude at least one compound selected from the group consisting 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone. The one or more additional VOCs can exclude at least one compound selected from the group consisting of 2-methoxy-4-methylphenol, 2-methylbutyl acetate, cis-3-hexen-1-ol, decanoic acid, delta-dodecalactone, ethyl salicylate, gamma-dodecalactone, gamma-octalactone, geranyl acetone, hexanoic acid, hexyl acetate, isoamyl isobutyrate, isobutyric acid, methyl decanoate, methyl laurate, myrtenol, octanoic acid, phenethyl octanoate, and propionic acid. The one or more additional VOCs can exclude at least one compound selected from the group consisting of 2-methoxy-4-methylphenol, cis-3-hexen-1-ol, delta-dodecalactone, ethyl salicylate, gamma-dodecalactone, gamma-octalactone, geranyl acetone, hexyl acetate, isoamyl isobutyrate, myrtenol, and phenethyl octanoate. The one or more additional VOCs can exclude at least one compound selected from the group consisting of 2-methoxy-4-methylphenol, cis-3-hexen-1-ol, delta-dodecalactone, ethyl salicylate, gamma-dodecalactone, gamma-octalactone, hexyl acetate, and isoamyl isobutyrate. The one or more additional VOCs can be present in a total amount of less than about 650 mg/L.

In another aspect, provided herein is a Scotch-like alcoholic beverage including ethanol, water, and one or more additional VOCs, wherein the one or more additional VOCs do not include at least one compound selected from the group consisting of 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone. The one or more additional VOCs can be present in a total amount of less than about 650 mg/L.

In another aspect, provided herein is a Scotch-like alcoholic beverage including ethanol, water, and one or more additional VOCs, wherein the one or more additional VOCs are present in a total amount of less than about 650 mg/L.

Implementations of any of the Scotch-like alcoholic beverages provided herein can include one or more of the following features. The one or more additional VOCs can include an ester, an alcohol, an aldehyde, a ketone, or a mixture thereof, and a terpene, an isoprenoid, or a mixture thereof. The Scotch-like alcoholic beverage can further include one or more non-volatile compounds. The one or more non-volatile compounds can include one or more compounds selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose. In some embodiments, a non-volatile compound that is not present in traditional Scotch can be selected from the group consisting of valine, and xylose. The one or more non-volatile compounds can include one or more compounds selected from the group consisting of valine, xylose, and combinations thereof. The one or more non-volatile compounds can exclude one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin. The one or more non-volatiles can exclude one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, AMP, arabitol, egallic acid, homoserine, methyl gallate, pyridine, pyruvic acid, quinic acid, rhamnose, and salicylic acid.

In another aspect provided herein is a Scotch-like alcoholic beverage including ethanol, water, and one or more additional VOCs, wherein at least one of the following, in any combination, is true: 2-methyl-1-butanol is present in an amount less than about 75 mg/L or 2-methyl-1-butanol is present in an amount of at least about 635 mg/L, delta-decalactone is present in an amount less than about 0.013 mg/L or delta-decalactone is present in an amount of at least about 0.27 mg/L, ethyl acetate is present in an amount less than about 42 mg/L or ethyl acetate is present in an amount of at least about 780 mg/L, ethyl undecanoate is present in an amount less than about 0.007 mg/L or ethyl undecanoate is present in an amount of at least about 0.12 mg/L, 1-decanol is present in an amount less than about 0.065 mg/L, 2-methylbutyraldehyde is present in an amount less than about 0.012 mg/L, benzaldehyde is present in an amount less than about 0.003 mg/L, butanol is present in an amount less than about 3.3 mg/L, citronellol is present in an amount less than about 0.0002 mg/L, decanoic acid is present in an amount less than about 1.7 mg/L, diethyl succinate is present in an amount less than about 0.3 mg/L, ethyl butanoate is present in an amount less than about 0.14 mg/L, ethyl cinnamate is present in an amount less than about 0.00035 mg/L, ethyl heptanoate is present in an amount less than about 0.006 mg/L, ethyl isovalerate is present in an amount less than about 0.06 mg/L, ethyl nonanoate is present in an amount less than about 0.0075 mg/L, ethyl octanoate is present in an amount less than about 0.85 mg/L, ethyl propionate is present in an amount less than about 0.34 mg/L, Ethyl Valerate is present in an amount less than about 0.0045 mg/L, furfural is present in an amount less than about 0.7 mg/L, hexanol is present in an amount less than about 0.014 mg/L, isoamyl acetate is present in an amount less than about 0.18 mg/L, isoamyl alcohol is present in an amount less than about 38 mg/L, isoamyl octanoate is present in an amount less than about 0.0005 mg/L, isobutanol is present in an amount less than about 72 mg/L, isobutyl acetate is present in an amount less than about 0.03 mg/L, methyl decanoate is present in an amount less than about 0.0004 mg/L, Myrtenol is present in an amount less than about 0.085 mg/L, octanoic acid is present in an amount less than about 2.5 mg/L, p-cresol is present in an amount less than about 0.009 mg/L, Phenethyl Butyrate is present in an amount less than about 0.0003 mg/L, phenethyl octanoate is present in an amount less than about 0.0006 mg/L, propanol is present in an amount less than about 100 mg/L, ethyl benzoate is present in an amount less than about 0.0045 mg/L, gamma-nonalactone is present in an amount less than about 0.0065 mg/L, Propionic acid is present in an amount less than about 0.38 mg/L, Hexanoic acid is present in an amount less than about 3.6 mg/L, 1,1-diethoxyethane is present in an amount of at least about 4 mg/L, 2,3-pentadione is present in an amount of at least about 0.0015 mg/L, 4-Ethyl Phenol is present in an amount of at least about 1.7 mg/L, amyl alcohol is present in an amount of at least about 0.03 mg/L, beta-ionone is present in an amount of at least about 0.004 mg/L, butyl acetate is present in an amount of at least about 0.98 mg/L, butyric acid is present in an amount of at least about 2 mg/L, carvone is present in an amount of at least about 0.0023 mg/L, Cinnamaldehyde is present in an amount of at least about 0.04 mg/L, damascenone is present in an amount of at least about 0.14 mg/L, ethyl isobutyrate is present in an amount of at least about 5.5 mg/L, gamma-decalactone is present in an amount of at least about 0.4 mg/L, gamma-terpinene is present in an amount of at least about 0.0013 mg/L, limonene is present in an amount of at least about 0.01 mg/L, linalyl acetate is present in an amount of at least about 0.03 mg/L, methyl hexanoate is present in an amount of at least about 0.002 mg/L, geraniol is present in an amount of at least about 0.04 mg/L, isobutyraldehyde is present in an amount of at least about 4.4 mg/L, at least about 0.4% by mass of the one or more additional VOCs is isobutyl acetate, less than about 0.026% by mass of the one or more additional VOCs is decanoic acid, less than about 0.004885% by mass of the one or more additional VOCs is diethyl succinate, less than about 0.00007% by mass of the one or more additional VOCs is Ethyl Valerate, less than about 0.85% by mass of the one or more additional VOCs is isoamyl alcohol, less than about 0.0013% by mass of the one or more additional VOCs is Myrtenol, less than about 0.0000045% by mass of the one or more additional VOCs is Phenethyl Butyrate, at least about 0.00035% by mass of the one or more additional VOCs is carvone, at least about 0.006% by mass of the one or more additional VOCs is Cinnamaldehyde, at least about 0.02% by mass of the one or more additional VOCs is damascenone, at least about 0.04% by mass of the one or more additional VOCs is delta-decalactone, at least about 0.0035% by mass of the one or more additional VOCs is ethyl cinnamate, at least about 0.78% by mass of the one or more additional VOCs is ethyl isobutyrate, at least about 0.4% by mass of the one or more additional VOCs is ethyl isovalerate, at least about 19.% by mass of the one or more additional VOCs is ethyl lactate, at least about 0.017% by mass of the one or more additional VOCs is ethyl undecanoate, at least about 04.5% by mass of the one or more additional VOCs is furfural, at least about 0.06% by mass of the one or more additional VOCs is gamma-decalactone, at least about 0.0002% by mass of the one or more additional VOCs is gamma-terpinene, at least about 0.014% by mass of the one or more additional VOCs is isoamyl hexanoate, at least about 0.0015% by mass of the one or more additional VOCs is limonene, at least about 0.004% by mass of the one or more additional VOCs is linalyl acetate, at least about 0.0003% by mass of the one or more additional VOCs is methyl hexanoate, at least about 0.0025% by mass of the one or more additional VOCs is methyl laurate, at least about 0.003% by mass of the one or more additional VOCs is ethyl 3-hydroxyhexanoate, at least about 0.045% by mass of the one or more additional VOCs is ethyl levulinate, at least about 0.008% by mass of the one or more additional VOCs is farnesol Results, at least about 0.006% by mass of the one or more additional VOCs is geraniol, at least about 0.65% by mass of the one or more additional VOCs is isobutyraldehyde, at least about 0.008% by mass of the one or more additional VOCs is phenethyl formate, at least about 0.035% by mass of the one or more additional VOCs is propyl acetate, at least about 0.02% by mass of the one or more additional VOCs is vanillyl ethyl ether Results, at least about 0.0732393% by mass of the one or more additional VOCs is 2-heptanone, at least about 0.0025% by mass of the one or more additional VOCs is geranyl acetone undacadien, at least about 0.001% by mass of the one or more additional VOCs is methional, at least about 0.01% by mass of the one or more additional VOCs is ethyl trans-2-butenoate; or at least about 0.0003% by mass of the one or more additional VOCs is isoamyl isovalerate,

In another aspect, provided herein is a Scotch-like alcoholic beverage including ethanol, water, and one or more additional VOCs, wherein at least one of the following, in any combination, is true: 1-decanol is present in an amount less than about 0.065 mg/L, 2-methyl-1-butanol is present in an amount less than about 75 mg/L, decanoic acid is present in an amount less than about 1.7 mg/L, diethyl succinate is present in an amount less than about 0.3 mg/L, ethyl acetate is present in an amount less than about 42 mg/L, ethyl butanoate is present in an amount less than about 0.14 mg/L, ethyl propionate is present in an amount less than about 0.34 mg/L, isobutanol is present in an amount less than about 72 mg/L, Myrtenol is present in an amount less than about 0.085 mg/L, octanoic acid is present in an amount less than about 2.5 mg/L, p-cresol is present in an amount less than about 0.009 mg/L, Phenethyl Butyrate is present in an amount less than about 0.0003 mg/L, phenethyl octanoate is present in an amount less than about 0.0006 mg/L, propanol is present in an amount less than about 100 mg/L, gamma-nonalactone is present in an amount less than about 0.0065 mg/L, Propionic acid is present in an amount less than about 0.38 mg/L, Hexanoic acid is present in an amount less than about 3.6 mg/L, amyl alcohol is present in an amount of at least about 0.03 mg/L, delta-decalactone is present in an amount of at least about 0.27 mg/L, linalyl acetate is present in an amount of at least about 0.03 mg/L, geraniol is present in an amount of at least about 0.04 mg/L, at least about 0.04% by mass of the one or more additional VOCs is delta-decalactone, at least about 0.0035% by mass of the one or more additional VOCs is ethyl cinnamate, at least about 0.0015% by mass of the one or more additional VOCs is limonene, at least about 0.004% by mass of the one or more additional VOCs is linalyl acetate, or at least about 0.006% by mass of the one or more additional VOCs is geraniol.

Implementations of any of the Scotch-like alcoholic beverages provided herein can include one or more of the following features. The Scotch-like alcoholic beverage can include or more non-volatile compounds. The one or more non-volatile compounds can include one or more compounds selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose. In some embodiments, a non-volatile compound that is not present in traditional Scotch can be selected from the group consisting of valine, and xylose. The one or more non-volatile compounds can include one or more compounds selected from the group consisting of valine, xylose, and combinations thereof. The one or more non-volatile compounds can include or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin. The one or more non-volatile compounds can exclude one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, AMP, arabitol, egallic acid, homoserine, methyl gallate, pyridine, pyruvic acid, quinic acid, rhamnose, and salicylic acid.

In another aspect, provided herein is a method of making a Scotch-like alcoholic beverage, the method including providing an aqueous solution, and adding to the aqueous solution ingredients including ethanol, a source of a tannin, a plurality of oak pieces or oak extract, nonvolatile compounds, wherein the nonvolatile compounds include a sugar or sugar alcohol and an acid, and VOCs, wherein the VOCs include an ester, an alcohol, an aldehyde or a ketone or both, and a terpene or an isoprenoid or both.

In another aspect, provided herein is a method of making a Scotch-like alcoholic beverage, the method including combining ingredients including water, ethanol, and five or more additional VOCs, wherein at least five of the five or more additional VOCs are provided as separate ingredients.

Implementations can include one or more of the following features. The ingredients can include 10 or more additional VOCs, wherein at least 10 of the 10 or more additional VOCs are provided as separate ingredients.

In another aspect, provided herein is a method of making a Scotch-like alcoholic beverage, the method including providing a composition including ethanol, water, and one or more additional VOCs, wherein at least one of the one or more additional VOCs is present in a concentration of at least about 2-fold the concentration of the same VOC in a corresponding traditional Scotch, and adding to the composition ethanol, water, or a combination thereof such that the concentration of the at least one additional VOC is reduced to about the concentration of the same VOC in a corresponding traditional Scotch.

Implementations can include one or more of the following features. The one or more additional VOCs can include at least one VOC that is not present in a corresponding traditional Scotch. The one or more additional VOCs can exclude at least one VOC that is present in a corresponding traditional Scotch. The Scotch-like alcoholic beverage can further include one or more non-volatile compounds, and wherein the one or more non-volatile compounds include at least one non-volatile compound that is not present in a corresponding traditional Scotch. The Scotch-like alcoholic beverage can further include one or more non-volatile compounds, and wherein the one or more non-volatile compounds exclude at least one non-volatile compound that is present in a corresponding traditional Scotch. The one or more additional VOCs are present in the composition in a concentration of at least about 5-fold the concentration of the same VOCs in a corresponding traditional Scotch. The one or more additional VOCs can be present in the composition in a concentration of at least about 10-fold the concentration of the same VOC in a corresponding traditional Scotch. After the adding step, the Scotch-like alcoholic beverage can be any of the Scotch-like alcoholic beverages provided herein.

In another aspect, this document features a Scotch-like alcoholic beverage containing ethanol, water, and one or more additional volatile organic compounds (VOCs), where the one or more additional VOCs include at least one compound selected from the group consisting of a-terpineol, acetoin, beta-pinene, 4-carvomenthenol, 4-ethyl phenol, amyl butyrate, myrcene, linalool, and p-anisaldehyde. In some cases, the one or more additional VOCs do not include at least one compound selected from the group consisting of 1,1-diethoxyethane, citronellol, ethyl isobutyrate, ethyl nonanoate, ethyl-2-methylbutyrate, eugenol, guaiacol, hexanol, isoamyl acetate, isobutyl acetate, isovaleraldehyde, propanol, 1-octanol, 1-octen-3-ol, 2-heptanone, 2-methoxy-4-propylphenol, 2-methylbutyl acetate, 2-methylbutyraldehyde, 2-nonanone, 2-undecanone, acetophenone, butyl acetate, cinnamaldehyde, cis-3-hexen-1-ol, cis-3-hexenyl acetate, diethyl malate, ethyl 3-hydroxyhexanoate, ethyl benzoate, ethyl heptanoate, ethyl levulinate, ethyl myristate, ethyl phenyl acetate, ethyl salicylate, ethyl trans-2-butenoate, ethyl undecanoate, ethyl valerate, farnesol, gamma-decalactone, gamma-nonalactone, gamma-terpinene, geraniol, geranyl acetone, heptyl acetate, isoamyl hexanoate, isoamyl isobutyrate, isoamyl isovalerate, isoamyl octanoate, isobutyl isobutyrate, isobutyraldehyde, limonene, methyl acetate, methyl hexanoate, methyl laurate, methyl octanoate, p-cresol, p-cymene, phenethyl butyrate, phenethyl formate, phenethyl octanoate, phenethyl propionate, propyl acetate, salicylaldehyde, vanillyl ethyl ether, damascenone, diethyl succinate, and myrtenol. The one or more additional VOCs can be present in a total amount of less than about 650 mg/L.

In another aspect, this document features a Scotch-like alcoholic beverage containing ethanol, water, and one or more additional VOCs, where the one or more additional VOCs do not include at least one compound selected from the group consisting of 1,1-diethoxyethane, citronellol, ethyl isobutyrate, ethyl nonanoate, ethyl-2-methylbutyrate, eugenol, guaiacol, hexanol, isoamyl acetate, isobutyl acetate, isovaleraldehyde, propanol, 1-octanol, 1-octen-3-ol, 2-heptanone, 2-methoxy-4-propylphenol, 2-methylbutyl acetate, 2-methylbutyraldehyde, 2-nonanone, 2-undecanone, acetophenone, butyl acetate, cinnamaldehyde, cis-3-hexen-1-ol, cis-3-hexenyl acetate, diethyl malate, ethyl 3-hydroxyhexanoate, ethyl benzoate, ethyl heptanoate, ethyl levulinate, ethyl myristate, ethyl phenyl acetate, ethyl salicylate, ethyl trans-2-butenoate, ethyl undecanoate, ethyl valerate, farnesol, gamma-decalactone, gamma-nonalactone, gamma-terpinene, geraniol, geranyl acetone, heptyl acetate, isoamyl hexanoate, isoamyl isobutyrate, isoamyl isovalerate, isoamyl octanoate, isobutyl isobutyrate, isobutyraldehyde, limonene, methyl acetate, methyl hexanoate, methyl laurate, methyl octanoate, p-cresol, p-cymene, phenethyl butyrate, phenethyl formate, phenethyl octanoate, phenethyl propionate, propyl acetate, salicylaldehyde, vanillyl ethyl ether, damascenone, diethyl succinate, and myrtenol. The one or more additional VOCs can be present in a total amount of less than about 650 mg/L.

In another aspect, this document features a Scotch-like alcoholic beverage containing ethanol, water, and one or more additional VOCs, where the one or more additional VOCs are present in a total amount of less than about 650 mg/L.

In any of the above embodiments, the one or more additional VOCs can include one or more, two or more, three or more, four or more, five or more, six or more, no more than six, or all of butyl formate, ethyl octanoate, ethyl propionate, ethyl-2-methylbutyrate, isoamyl acetate, isoamyl alcohol, and isobutanol.

The 2,3-pentadione can be present in an amount of less than about 0.00028 mg/L or in an amount of at least about 0.0015 mg/L. The 2-methyl-1-butanol can be present in an amount of less than about 75 mg/L or in an amount of at least about 635 mg/L. The 2-methylbutyraldehyde can be present in an amount of less than about 0.012 mg/L or in an amount of at least about 0.15 mg/L. The 2-nonanone can be present in an amount of less than about 0.012 mg/L or in an amount of at least about 0.085 mg/L. The butyl acetate can be present in an amount of less than about 0.22 mg/L or in an amount of at least about 0.97 mg/L. The cinnamaldehyde can be present in an amount of less than about 0.00009 mg/L or in an amount of at least about 0.014 mg/L. The citronellol can be present in an amount of less than about 0.0002 mg/L or in an amount of at least about 0.046 mg/L. The ethyl acetate can be present in an amount of less than about 42 mg/L or in an amount of at least about 780 mg/L. The ethyl butanoate can be present in an amount of less than about 0.14 mg/L or in an amount of at least about 2.1 mg/L. The ethyl decanoate can be present in an amount of less than about 1.75 mg/L or in an amount of at least about 30 mg/L. The ethyl isobutyrate can be present in an amount of less than about 0.3 mg/L or in an amount of at least about 5.4 mg/L. The ethyl isovalerate can be present in an amount of less than about 0.06 mg/L or in an amount of at least about 1.7 mg/L. The gamma-decalactone can be present in an amount of less than about 0.01 mg/L or in an amount of at least about 0.18 mg/L. The isoamyl acetate can be present in an amount of less than about 0.18 mg/L or in an amount of at least about 8 mg/L. The isobutyl acetate can be present in an amount of less than about 0.032 mg/L or in an amount of at least about 0.23 mg/L. The salicylaldehyde can be present in an amount of less than about 0.0044 mg/L or in an amount of at least about 0.02 mg/L. The 1-decanol can be present in an amount of less than about 0.067 mg/L. The 1-octen-3-ol can be present in an amount of less than about 0.024 mg/L. The 2-methylbutyl acetate can be present in an amount of less than about 0.12 mg/L. The 2-phenylethylacetate can be present in an amount of less than about 0.066 mg/L. The benzaldehyde can be present in an amount of less than about 0.003 mg/L. The butanol can be present in an amount of less than about 3.3 mg/L. The diethyl malate can be present in an amount of less than about 1.2 mg/L. The diethyl succinate can be present in an amount of less than about 1.2 mg/L. The ethyl 3-hydroxyhexanoate can be present in an amount of less than about 0.005 mg/L. The ethyl benzoate can be present in an amount of less than about 0.005 mg/L. The ethyl cinnamate can be present in an amount of less than about 0.00035 mg/L. The ethyl nonanoate can be present in an amount of less than about 0.0075 mg/L. The ethyl octanoate can be present in an amount of less than about 2.3 mg/L. The ethyl phenyl acetate can be present in an amount of less than about 0.01 mg/L. The ethyl propionate can be present in an amount of less than about 0.1 mg/L. The ethyl valerate can be present in an amount of less than about 0.03 mg/L. The eugenol can be present in an amount of less than about 0.035 mg/L. The furfural can be present in an amount of less than about 1.1 mg/L. The gamma-nonalactone can be present in an amount of less than about 0.01 mg/L. The guaiacol can be present in an amount of less than about 0.006 mg/L. The hexanol can be present in an amount of less than about 0.014 mg/L. The isoamyl alcohol can be present in an amount of less than about 50 mg/L. The isoamyl octanoate can be present in an amount of less than about 0.0005 mg/L. The isobutanol can be present in an amount of less than about 72 mg/L. The isovaleraldehyde can be present in an amount of less than about 0.08 mg/L. The methyl salicylate can be present in an amount of less than about 0.003 mg/L. The myrtenol can be present in an amount of less than about 0.085 mg/L. The p-cresol can be present in an amount of less than about 0.009 mg/L. The phenethyl butyrate can be present in an amount of less than about 0.0017 mg/L. The phenethyl octanoate can be present in an amount of less than about 0.0006 mg/L. The propanol can be present in an amount of less than about 100 mg/L. The propyl acetate can be present in an amount of less than about 0.03 mg/L. The whiskey lactone can be present in an amount of less than about 0.2 mg/L. The 1,1-diethoxyethane can be present in an amount of at least about 4 mg/L. The 2-undecanone can be present in an amount of at least about 0.0015 mg/L. The amyl alcohol can be present in an amount of at least about 0.03 mg/L. The beta-ionone can be present in an amount of at least about 0.0037 mg/L. The carvone can be present in an amount of at least about 0.0025 mg/L. The damascenone can be present in an amount of at least about 0.1 mg/L. The ethyl hexanoate can be present in an amount of at least about 4 mg/L. The ethyl myristate can be present in an amount of at least about 0.11 mg/L. The gamma-terpinene can be present in an amount of at least about 0.0009 mg/L. The geraniol can be present in an amount of at least about 0.04 mg/L. The isobutyraldehyde can be present in an amount of at least about 1.15 mg/L. The limonene can be present in an amount of at least about 0.00007 mg/L. The linalyl acetate can be present in an amount of at least about 0.028 mg/L. The methyl laurate can be present in an amount of at least about 0.0003 mg/L. The phenethyl formate can be present in an amount of at least about 0.055 mg/L.

In some cases, one or more of the following can be true: less than about 0.000015% by mass of the one or more additional VOCs is isoamyl octanoate or at least about 0.0012% by mass of the one or more additional VOCs is isoamyl octanoate; less than about 0.00022% by mass of the one or more additional VOCs is ethyl nonanoate or at least about 0.36% by mass of the one or more additional VOCs is ethyl nonanoate; less than about 0.00035% by mass of the one or more additional VOCs is 2-methylbutyraldehyde or at least about 0.02% by mass of the one or more additional VOCs is 2-methylbutyraldehyde; less than about 0.00093% by mass of the one or more additional VOCs is isobutyl acetate or at least about 0.033% by mass of the one or more additional VOCs is isobutyl acetate; less than about 0.001771% by mass of the one or more additional VOCs is ethyl isovalerate or at least about 0.24% by mass of the one or more additional VOCs is ethyl isovalerate; less than about 0.0023% by mass of the one or more additional VOCs is Isovaleraldehyde or at least about 0.13% by mass of the one or more additional VOCs is Isovaleraldehyde; less than about 0.0085% by mass of the one or more additional VOCs is ethyl isobutyrate or at least about 0.77% by mass of the one or more additional VOCs is ethyl isobutyrate; less than about 0.1% by mass of the one or more additional VOCs is butanol or at least about 04.9% by mass of the one or more additional VOCs is butanol; less than about 2.3% by mass of the one or more additional VOCs is 2-methyl-1-butanol or at least about 73.0% by mass of the one or more additional VOCs is 2-methyl-1-butanol; less than about 0.000018% by mass of the one or more additional VOCs is phenethyl octanoate; less than about 0.00005% by mass of the one or more additional VOCs is phenethyl butyrate; less than about 0.00009% by mass of the one or more additional VOCs is methyl salicylate; less than about 0.00025% by mass of the one or more additional VOCs is ethyl phenyl acetate; less than about 0.00025% by mass of the one or more additional VOCs is p-cresol; less than about 0.0004% by mass of the one or more additional VOCs is hexanol; less than about 0.0007% by mass of the one or more additional VOCs is 1-octen-3-ol; less than about 0.0009% by mass of the one or more additional VOCs is ethyl valerate; less than about 0.001% by mass of the one or more additional VOCs is eugenol; less than about 0.002% by mass of the one or more additional VOCs is 1-decanol; less than about 0.0025% by mass of the one or more additional VOCs is myrtenol; less than about 0.004% by mass of the one or more additional VOCs is ethyl butanoate; less than about 0.017% by mass of the one or more additional VOCs is ethyl propionate; less than about 0.035% by mass of the one or more additional VOCs is diethyl succinate; less than about 2.0% by mass of the one or more additional VOCs is isoamyl alcohol; less than about 3.0% by mass of the one or more additional VOCs is propanol; at least about 0.00001% by mass of the one or more additional VOCs is limonene; at least about 0.000043% by mass of the one or more additional VOCs is methyl laurate; at least about 0.00013% by mass of the one or more additional VOCs is gamma-terpinene; at least about 0.0002% by mass of the one or more additional VOCs is 2,3-pentadione; at least about 0.0002% by mass of the one or more additional VOCs is 2-undecanone; at least about 0.00035% by mass of the one or more additional VOCs is carvone; at least about 0.0005% by mass of the one or more additional VOCs is beta-ionone; at least about 0.001% by mass of the one or more additional VOCs is methional; at least about 0.002% by mass of the one or more additional VOCs is cinnamaldehyde; at least about 0.0025% by mass of the one or more additional VOCs is geranyl acetone; at least about 0.003% by mass of the one or more additional VOCs is ethyl 3-hydroxyhexanoate; at least about 0.003% by mass of the one or more additional VOCs is salicylaldehyde; at least about 0.0034% by mass of the one or more additional VOCs is ethyl cinnamate; at least about 0.004% by mass of the one or more additional VOCs is linalyl acetate; at least about 0.0045% by mass of the one or more additional VOCs is amyl alcohol; at least about 0.005% by mass of the one or more additional VOCs is ethyl trans-2-butenoate; at least about 0.0053% by mass of the one or more additional VOCs is ethyl benzoate; at least about 0.006% by mass of the one or more additional VOCs is geraniol; at least about 0.0065% by mass of the one or more additional VOCs is citronellol; at least about 0.0075% by mass of the one or more additional VOCs is farnesol; at least about 0.0077% by mass of the one or more additional VOCs is phenethyl formate; at least about 0.0094% by mass of the one or more additional VOCs is gamma-nonalactone; at least about 0.01% by mass of the one or more additional VOCs is 2-heptanone; at least about 0.01% by mass of the one or more additional VOCs is vanillyl ethyl ether; at least about 0.011% by mass of the one or more additional VOCs is 2-nonanone; at least about 0.015% by mass of the one or more additional VOCs is damascenone; at least about 0.015% by mass of the one or more additional VOCs is ethyl myristate; at least about 0.018% by mass of the one or more additional VOCs is ethyl levulinate; at least about 0.026% by mass of the one or more additional VOCs is gamma-decalactone; at least about 0.032% by mass of the one or more additional VOCs is propyl acetate; at least about 0.05% by mass of the one or more additional VOCs is benzaldehyde; at least about 0.14% by mass of the one or more additional VOCs is butyl acetate; at least about 0.16% by mass of the one or more additional VOCs is isobutyraldehyde; at least about 0.56% by mass of the one or more additional VOCs is 1,1-diethoxyethane; at least about 0.56% by mass of the one or more additional VOCs is ethyl hexanoate; at least about 1.0% by mass of the one or more additional VOCs is guaiacol; at least about 1.15% by mass of the one or more additional VOCs is isoamyl acetate; at least about 2.6% by mass of the one or more additional VOCs is furfural; at least about 4.3% by mass of the one or more additional VOCs is ethyl decanoate; at least about 8.4% by mass of the one or more additional VOCs is ethyl lactate; at least about 9.2% by mass of the one or more additional VOCs is ethyl laurate; or at least about 77.0% by mass of the one or more additional VOCs is ethyl acetate.

The one or more additional VOCs can include an ester, an alcohol, an aldehyde, a ketone, or a mixture thereof, a terpene, an isoprenoid, or a mixture thereof, and a phenol. In some cases, the one or more additional VOCs can further include at least one compound selected from the group consisting of an acid, an alcohol, a lactone, a thiol, or an ether.

For example, the one or more additional VOCs can include one or more esters. Less than about 1.9% by mass of the additional VOCs can include the one or more esters. The one or more esters can be selected from the group consisting of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl succinate, ethyl acetate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl salicylate, ethyl undecanoate, ethyl valerate, ethyl-2-methylbutyrate, isoamyl acetate, isoamyl hexanoate, isoamyl octanoate, isobutyl acetate, linalyl acetate, methyl decanoate, methyl hexanoate, methyl laurate, methyl octanoate, methyl salicylate, phenethyl butyrate, phenethyl octanoate, diethyl malate, ethyl 3-hydroxyhexanoate, ethyl benzoate, ethyl levulinate, phenethyl formate, propyl acetate, ethyl-trans-2-butenoate, ethyl-trans-3-hexenoate, ethyl(methylthio) acetate, heptyl acetate, isoamyl isobutyrate, isoamyl isovalerate, isobutyl isobutyrate, methyl acetate, and phenethyl propionate.

The one or more additional VOCs can include one or more acids. The one or more acids can be selected from the group consisting of 3,7-dimethyl-6-octenoic acid, butyric acid, decanoic acid, isobutyric acid, octanoic acid, propionic acid, isovaleric acid, valeric acid, hexanoic acid, and nonanoic acid.

The one or more additional VOCs can include one or more alcohols. The one or more alcohols can be selected from the group consisting of 1-octanol, 2-methyl-1-butanol, 2-nonanol, 2-phenylethanol, butyl alcohol, cis-3-hexen-1-ol, 1-decanol, 1-octen-3-ol, amyl alcohol, butanol, hexanol, isoamyl alcohol, isobutanol, and propanol.

The one or more additional VOCs can include one or more aldehydes or ketones. At least about 3.4% by mass of the one or more additional VOCs can include the one or more aldehydes or ketones, or less than about 0.008% by mass of the one or more additional VOCs can include the one or more aldehydes or ketones. The one or more aldehydes or ketones can be selected from the group consisting of 1,1-diethoxyethane, 2,3-pentadione, 2-methylbutyraldehyde, 2-nonanone, 2-undecanone, acetaldehyde, acetoin, benzaldehyde, butyraldehyde, cinnamaldehyde, damascenone, furfural, isovaleraldehyde, maltol, nonanal, trans-2-hexen-1-al, isobutyraldehyde, salicylaldehyde, 2-heptanone, acetophenone, methional, valeraldehyde, propionaldehyde, and p-anisaldehyde.

The one or more additional VOCs can include one or more terpenes or isoprenoids. Less than about 0.009% by mass of the one or more additional VOCs can include the one or more terpenes or isoprenoids. The one or more terpenes or isoprenoids can be selected from the group consisting of 3-carene, 4-carvomenthenol, 4-ethylguaiacol, alpha ionone, a-phellandrene, (−)alpha-pinene, a-terpineol, beta-ionone, (−) beta-pinene, carvone, (−)cis-rose-oxide, citronellol, gamma-terpinene, limonene, linalool, linalool oxide, myrcene, myrtenol, p-cymene, farnesol, geraniol, geranyl acetone, and eucalyptol.

The one or more additional VOCs can include one or more phenols. Less than about 0.0015% by mass of the one or more additional VOCs can include the one or more phenols, or at least about 1.1% by mass of the one or more additional VOCs can include the one or more phenols. The one or more phenols can be selected from the group consisting of 2-methoxy-4-propylphenol, 4-ethylphenol, eugenol, guaiacol, and p-cresol.

The one or more additional VOCs can include one or more lactones. At least about 0.8% by mass of the one or more additional VOCs can include the one or more lactones. The one or more lactones can be selected from the group consisting of delta-decalactone, gamma-decalactone, whiskey lactone, and gamma-nonalactone.

The one or more additional VOCs can include one or more thiols. The one or more thiols can include dimethylsulfide.

The one or more additional VOCs can include one or more ethers. At least about 0.01% by mass of the one or more VOCs can include the one or more ethers. The one or more ethers can include vanillyl ethyl ether.

The one or more additional VOCs can include at least five compounds selected from the group consisting of 1-decanol, 1-octen-3-ol, 2,3-pentadione, 2-methyl-1-butanol, 2-phenylethanol, 2-phenylethylacetate, acetaldehyde, amyl alcohol, a-terpineol, benzaldehyde, beta-ionone, beta-pinene, butanol, butyl acetate, cinnamaldehyde, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, isoamyl alcohol, isoamyl hexanoate, isoamyl octanoate, isobutanol, isobutyl acetate, limonene, linalool oxide, maltol, methyl octanoate, methyl salicylate, myrcene, p-cresol, p-cymene, phenethyl butyrate, and whiskey lactone.

The one or more additional VOCs can include at least one compound selected from the group consisting of propanol, ethyl isobutyrate, gamma-terpinene, and butyric acid.

The one or more additional VOCs can include at least one compound selected from the group consisting of 3-carene, 4-carvomenthenol, 4-ethyl phenol, butyl formate, delta-decalactone, ethyl heptanoate, guaiacol, isoamyl acetate, linalool, linalyl acetate.

The one or more additional VOCs can include at least one compound selected from the group consisting of 1,1-diethoxyethane, 2-heptanone, 2-methylbutyl acetate, 2-methylbutyraldehyde, 2-nonanone, 4-ethyl guaiacol, acetoin, acetophenone, amyl butyrate, a-phellandrene, a-pinene, citronellol, damascenone, decanoic acid, diethyl malate, dimethylsulfide, ethyl 3-hydroxyhexanoate, ethyl benzoate, ethyl levulinate, ethyl nonanoate, ethyl palmitate, ethyl trans-2-butenoate, ethyl undecanoate, ethyl-2-methylbutyrate, farnesol, gamma-nonalactone, geraniol, geranyl acetone, hexanol, isobutyraldehyde, isobutyric acid, isovaleraldehyde, methional, methyl decanoate, methyl hexanoate, methyl laurate, myrtenol, nonanal, octanoic acid, p-anisaldehyde, phenethyl formate, phenethyl octanoate, propionaldehyde, propyl acetate, salicylaldehyde, trans-2-hexen-1-al, valeraldehyde, vanillyl ethyl ether, butyraldehyde, propionic acid, isovaleric acid, valeric acid, hexanoic acid, and nonanoic acid.

The one or more additional VOCs can include five or more compounds selected from the group consisting of 1-decanol, 1-octen-3-ol, 2,3-pentadione, 2-methyl-1-butanol, 2-phenylethanol, 2-phenylethylacetate, 3-carene, acetaldehyde, amyl alcohol, a-terpineol, benzaldehyde, beta-ionone, beta-pinene, butanol, butyl acetate, cinnamaldehyde, delta-decalactone, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, guaiacol, isoamyl alcohol, isoamyl hexanoate, isoamyl octanoate, isobutanol, isobutyl acetate, limonene, linalool, linalool oxide, linalyl acetate, maltol, methyl salicylate, myrcene, p-cresol, and whiskey lactone.

The one or more additional VOCs can include at least one compound selected from the group consisting of 1,1-diethoxyethane, 2-heptanone, 4-ethyl guaiacol, acetoin, acetophenone, diethyl malate, ethyl 3-hydroxyhexanoate, ethyl levulinate, ethyl trans-2-butenoate, ethyl undecanoate, ethyl-2-methylbutyrate, gamma-nonalactone, geraniol, isobutyraldehyde, methional, methyl octanoate, p-cymene, phenethyl butyrate, phenethyl formate, propanol, propyl acetate, and vanillyl ethyl ether.

The one or more additional VOCs can have less than about 95% identity to the VOCs in a single reference Scotch. The Scotch-like alcoholic beverage can include at least 61 additional VOCs and wherein no more than 60 of the additional VOCs are found in a single reference Scotch.

The Scotch-like alcoholic beverage can further include one or more non-volatile compounds. The one or more non-volatile compounds can include one or more compounds selected from the group consisting of mannose, valine, tyrosine, xylose, cinnamic acid, and 2-furoic acid. In some embodiments, the one or more non-volatile compounds do not include one or more compounds selected from the group consisting of 2-isopropylmalic acid, 3,4-dihydroxybenzoic acid, arabitol, arginine, aspartic acid, caffeic acid, citrulline, coumaric acid, kynurenic acid, pyruvic acid, rhamnose, serine, trans 4-hydroxy-L-proline, acetovanillone, choline, fucose, fumaric acid, γ-aminobutyric acid (GABA), galactose, gallic acid, mannitol, myo-inositol, proline, quinic acid, ribose, syringaldehyde, syringic acid, vanillic acid, vanillin, and sorbitol. The one or more non-volatile compounds can include one or more of the following: fructose in an amount of less than about 9.6 mg/L, ribose in an amount of less than about 6 mg/L, syringaldehyde in an amount of less than about 0.55 mg/L, vanillic acid in an amount of less than about 10.3 mg/L, vanillin in an amount of less than about 0.3 mg/L, acetovanillone in an amount of at least about 0.26 mg/L, choline in an amount of at least about 2.8 mg/L, citric acid in an amount of at least about 6.6 mg/L, fumaric acid in an amount of at least about 0.65 mg/L, glucosamine in an amount of at least about 0.55 mg/L, glucose in an amount of at least about 120 mg/L, mannitol in an amount of at least about 7.8 mg/L, sorbitol in an amount of at least about 5.8 mg/L, and/or syringic acid in an amount of at least about 5.4 mg/L. The one or more non-volatile compounds can include kelp or a kelp extract. The kelp or kelp extract can be kombu kelp or kombu kelp extract. The one or more non-volatile compounds can include glycerol, gum arabic, or glycerol and gym arabic.

The one or more non-volatile compounds can include 10 or more compounds selected from the group consisting of 4-O-pentopyranosylpentopyranose, Assamicain A, catechin, chlorogenic acid, cinchonain Ia, Cinnamtannin A4, Cinnamtannin B 1, cyanidin3-O-rutinoside, D(−)-amygdalin, digallate glycoside, digallic acid, ellagic acid, epicatechin, epicatechin-3-O-gallate, epigallocatechin, epigallocatechin gallate, eriodictyol, exifone, ferulic acid, gallic acid, gossypin, isorhamnetin, Kandelin A2, linoleic acid, luteolin, mulberroside A, naringenin, oleic acid, palmitoleic acid, p-coumaroylquinicacid, pentagalloyl glucose, phloretin, phloridzin, procyanidin A2, procyanidin B2, procyanidin Cl, quercetin, quercetin glycoside, quercetin-3β-D-glucoside, ramnazin-3-O-rutinoside, rutin, syringic acid, tannic acid, tetragalloyl glucose, theasinesin A, tiliroside, trigalloyl glucose, and vanillic acid. The one or more non-volatile compounds can include at least five compounds selected from the group consisting of D-glucuronic acid, fructose, glucose, lactic acid, malic acid, succinic acid, and tartaric acid. The one or more non-volatile compounds can include at least one compound selected from the group consisting of acetovanillone, choline, fumaric acid, GABA, gallic acid, glucosamine, inositol, mannitol, mannose, proline, ribose, sorbitol, syringaldehyde, syringic acid, trans-ferulic acid, tyrosine, valine, vanillic acid, and vanillin. The one or more non-volatile compounds can have less than about 60% identity to the non-volatile compounds in a single reference Scotch. The Scotch-like alcoholic beverage can include 10 or more non-volatile compounds, where no more than 9 of the non-volatile compounds are found in a single reference Scotch. In some cases, the Scotch-like alcoholic beverage does not include one or more of E. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, and heavy metals.

In another aspect, this document features a Scotch-like alcoholic beverage that contains ethanol, water, and one or more additional VOCs, wherein at least one of the following, in any combination, is true: 2,3-pentadione is present in an amount of less than about 0.00028 mg/L or in an amount of at least about 0.0015 mg/L; 2-methyl-1-butanol is present in an amount of less than about 75 mg/L or in an amount of at least about 635 mg/L; 2-methylbutyraldehyde is present in an amount of less than about 0.012 mg/L or in an amount of at least about 0.15 mg/L; 2-nonanone is present in an amount of less than about 0.012 mg/L or in an amount of at least about 0.085 mg/L; butyl acetate is present in an amount of less than about 0.22 mg/L or in an amount of at least about 0.97 mg/L; cinnamaldehyde is present in an amount of less than about 0.00009 mg/L or in an amount of at least about 0.014 mg/L; citronellol is present in an amount of less than about 0.0002 mg/L or in an amount of at least about 0.046 mg/L; ethyl acetate is present in an amount of less than about 42 mg/L or in an amount of at least about 780 mg/L; ethyl butanoate is present in an amount of less than about 0.14 mg/L or in an amount of at least about 2.1 mg/L; ethyl decanoate is present in an amount of less than about 1.75 mg/L or in an amount of at least about 30 mg/L; ethyl isobutyrate is present in an amount of less than about 0.3 mg/L or in an amount of at least about 5.4 mg/L; ethyl isovalerate is present in an amount of less than about 0.06 mg/L or in an amount of at least about 1.7 mg/L; gamma-decalactone is present in an amount of less than about 0.01 mg/L or in an amount of at least about 0.18 mg/L; isoamyl acetate is present in an amount of less than about 0.18 mg/L or in an amount of at least about 8 mg/L; isobutyl acetate is present in an amount of less than about 0.032 mg/L or in an amount of at least about 0.23 mg/L; salicylaldehyde is present in an amount of less than about 0.0044 mg/L or in an amount of at least about 0.02 mg/L; 1-decanol is present in an amount of less than about 0.067 mg/L; 1-octen-3-ol is present in an amount of less than about 0.024 mg/L; 2-methylbutyl acetate is present in an amount of less than about 0.12 mg/L; 2-phenylethylacetate is present in an amount of less than about 0.066 mg/L; benzaldehyde is present in an amount of less than about 0.003 mg/L; butanol is present in an amount of less than about 3.3 mg/L; diethyl malate is present in an amount of less than about 1.2 mg/L; diethyl succinate is present in an amount of less than about 1.2 mg/L; ethyl 3-hydroxyhexanoate is present in an amount of less than about 0.005 mg/L; ethyl benzoate is present in an amount of less than about 0.005 mg/L; ethyl cinnamate is present in an amount of less than about 0.00035 mg/L; ethyl nonanoate is present in an amount of less than about 0.0075 mg/L; ethyl octanoate is present in an amount of less than about 2.3 mg/L; ethyl phenyl acetate is present in an amount of less than about 0.01 mg/L; ethyl propionate is present in an amount of less than about 0.1 mg/L; ethyl valerate is present in an amount of less than about 0.03 mg/L; eugenol is present in an amount of less than about 0.035 mg/L; furfural is present in an amount of less than about 1.1 mg/L; gamma-nonalactone is present in an amount of less than about 0.01 mg/L; guaiacol is present in an amount of less than about 0.006 mg/L; hexanol is present in an amount of less than about 0.014 mg/L; isoamyl alcohol is present in an amount of less than about 50 mg/L; isoamyl octanoate is present in an amount of less than about 0.0005 mg/L; isobutanol is present in an amount of less than about 72 mg/L; isovaleraldehyde is present in an amount of less than about 0.08 mg/L; methyl salicylate is present in an amount of less than about 0.003 mg/L; myrtenol is present in an amount of less than about 0.085 mg/L; p-cresol is present in an amount of less than about 0.009 mg/L; phenethyl butyrate is present in an amount of less than about 0.0017 mg/L; phenethyl octanoate is present in an amount of less than about 0.0006 mg/L; propanol is present in an amount of less than about 100 mg/L; propyl acetate is present in an amount of less than about 0.03 mg/L; whiskey lactone is present in an amount of less than about 0.2 mg/L; 1,1-diethoxyethane is present in an amount of at least about 4 mg/L; 2-undecanone is present in an amount of at least about 0.0015 mg/L; amyl alcohol is present in an amount of at least about 0.03 mg/L; beta-ionone is present in an amount of at least about 0.0037 mg/L; carvone is present in an amount of at least about 0.0025 mg/L; damascenone is present in an amount of at least about 0.1 mg/L; ethyl hexanoate is present in an amount of at least about 4 mg/L; ethyl myristate is present in an amount of at least about 0.11 mg/L; gamma-terpinene is present in an amount of at least about 0.0009 mg/L; geraniol is present in an amount of at least about 0.04 mg/L; isobutyraldehyde is present in an amount of at least about 1.15 mg/L; limonene is present in an amount of at least about 0.00007 mg/L; linalyl acetate is present in an amount of at least about 0.028 mg/L; methyl laurate is present in an amount of at least about 0.0003 mg/L; phenethyl formate is present in an amount of at least about 0.055 mg/L; less than about 0.000015% by mass of the one or more additional VOCs is isoamyl octanoate or at least about 0.0012% by mass of the one or more VOCs is isoamyl octanoate; less than about 0.00022% by mass of the one or more additional VOCs is ethyl nonanoate or at least about 0.36% by mass of the one or more VOCs is ethyl nonanoate; less than about 0.00035% by mass of the one or more additional VOCs is 2-methylbutyraldehyde or at least about 0.02% by mass of the one or more VOCs is 2-methylbutyraldehyde; less than about 0.00093% by mass of the one or more additional VOCs is isobutyl acetate or at least about 0.033% by mass of the one or more VOCs is isobutyl acetate; less than about 0.001771% by mass of the one or more additional VOCs is ethyl isovalerate or at least about 0.24% by mass of the one or more VOCs is ethyl isovalerate; less than about 0.0023% by mass of the one or more additional VOCs is isovaleraldehyde or at least about 0.13% by mass of the one or more VOCs is isovaleraldehyde; less than about 0.0085% by mass of the one or more additional VOCs is ethyl isobutyrate or at least about 0.77% by mass of the one or more VOCs is ethyl isobutyrate; less than about 0.1% by mass of the one or more additional VOCs is butanol or at least about 04.9% by mass of the one or more VOCs is butanol; less than about 2.3% by mass of the one or more additional VOCs is 2-methyl-1-butanol or at least about 73.0% by mass of the one or more VOCs is 2-methyl-1-butanol; less than about 0.000018% by mass of the one or more additional VOCs is phenethyl octanoate; less than about 0.00005% by mass of the one or more additional VOCs is phenethyl butyrate; less than about 0.00009% by mass of the one or more additional VOCs is methyl salicylate; less than about 0.00025% by mass of the one or more additional VOCs is ethyl phenyl acetate; less than about 0.00025% by mass of the one or more additional VOCs is p-cresol; less than about 0.0004% by mass of the one or more additional VOCs is hexanol; less than about 0.0007% by mass of the one or more additional VOCs is 1-octen-3-ol; less than about 0.0009% by mass of the one or more additional VOCs is ethyl valerate; less than about 0.001% by mass of the one or more additional VOCs is eugenol; less than about 0.002% by mass of the one or more additional VOCs is 1-decanol; less than about 0.0025% by mass of the one or more additional VOCs is myrtenol; less than about 0.004% by mass of the one or more additional VOCs is ethyl butanoate; less than about 0.017% by mass of the one or more additional VOCs is ethyl propionate; less than about 0.035% by mass of the one or more additional VOCs is diethyl succinate; less than about 2.0% by mass of the one or more additional VOCs is isoamyl alcohol; less than about 3.0% by mass of the one or more additional VOCs is propanol; at least about 0.00001% by mass of the one or more VOCs is limonene; at least about 0.000043% by mass of the one or more VOCs is methyl laurate; at least about 0.00013% by mass of the one or more VOCs is gamma-terpinene; at least about 0.0002% by mass of the one or more VOCs is 2,3-pentadione; at least about 0.0002% by mass of the one or more VOCs is 2-undecanone; at least about 0.00035% by mass of the one or more VOCs is carvone; at least about 0.0005% by mass of the one or more VOCs is beta-ionone; at least about 0.001% by mass of the one or more VOCs is methional; at least about 0.002% by mass of the one or more VOCs is cinnamaldehyde; at least about 0.0025% by mass of the one or more VOCs is geranyl acetone; at least about 0.003% by mass of the one or more VOCs is ethyl 3-hydroxyhexanoate; at least about 0.003% by mass of the one or more VOCs is salicylaldehyde; at least about 0.0034% by mass of the one or more VOCs is ethyl cinnamate; at least about 0.004% by mass of the one or more VOCs is linalyl acetate; at least about 0.0045% by mass of the one or more VOCs is amyl alcohol; at least about 0.005% by mass of the one or more VOCs is ethyl trans-2-butenoate; at least about 0.0053% by mass of the one or more VOCs is ethyl benzoate; at least about 0.006% by mass of the one or more VOCs is geraniol; at least about 0.0065% by mass of the one or more VOCs is citronellol; at least about 0.0075% by mass of the one or more VOCs is farnesol; at least about 0.0077% by mass of the one or more VOCs is phenethyl formate; at least about 0.0094% by mass of the one or more VOCs is gamma-nonalactone; at least about 0.01% by mass of the one or more VOCs is 2-heptanone; at least about 0.01% by mass of the one or more VOCs is vanillyl ethyl ether; at least about 0.011% by mass of the one or more VOCs is 2-nonanone; at least about 0.015% by mass of the one or more VOCs is damascenone; at least about 0.015% by mass of the one or more VOCs is ethyl myristate; at least about 0.018% by mass of the one or more VOCs is ethyl levulinate; at least about 0.026% by mass of the one or more VOCs is gamma-decalactone; at least about 0.032% by mass of the one or more VOCs is propyl acetate; at least about 0.05% by mass of the one or more VOCs is benzaldehyde; at least about 0.14% by mass of the one or more VOCs is butyl acetate; at least about 0.16% by mass of the one or more VOCs is isobutyraldehyde; at least about 0.56% by mass of the one or more VOCs is 1,1-diethoxyethane; at least about 0.56% by mass of the one or more VOCs is ethyl hexanoate; at least about 1.0% by mass of the one or more VOCs is guaiacol; at least about 1.15% by mass of the one or more VOCs is isoamyl acetate; at least about 2.6% by mass of the one or more VOCs is furfural; at least about 4.3% by mass of the one or more VOCs is ethyl decanoate; at least about 8.4% by mass of the one or more VOCs is ethyl lactate; at least about 9.2% by mass of the one or more VOCs is ethyl laurate; or at least about 77.0% by mass of the one or more VOCs is ethyl acetate.

In another aspect, this document features a Scotch-like alcoholic beverage containing ethanol, water, and one or more additional VOCs, wherein at least one of the following, in any combination, is true: 1-decanol is present in an amount less than about 0.067 mg/L; 1-octen-3-ol is present in an amount less than about 0.024 mg/L; 2-methyl-1-butanol is present in an amount less than about 75 mg/L; 2-methylbutyl acetate is present in an amount less than about 0.12 mg/L; 2-nonanone is present in an amount less than about 0.012 mg/L; diethyl malate is present in an amount less than about 1.2 mg/L; diethyl succinate is present in an amount less than about 1.2 mg/L; ethyl acetate is present in an amount less than about 42 mg/L; ethyl butanoate is present in an amount less than about 0.14 mg/L; ethyl isobutyrate is present in an amount less than about 0.3 mg/L; ethyl octanoate is present in an amount less than about 2.3 mg/L; ethyl phenyl acetate is present in an amount less than about 0.01 mg/L; ethyl propionate is present in an amount less than about 0.1 mg/L; ethyl valerate is present in an amount less than about 0.03 mg/L; eugenol is present in an amount less than about 0.035 mg/L; gamma-decalactone is present in an amount less than about 0.01 mg/L; gamma-nonalactone is present in an amount less than about 0.01 mg/L; isobutanol is present in an amount less than about 72 mg/L; isovaleraldehyde is present in an amount less than about 0.08 mg/L; methyl salicylate is present in an amount less than about 0.003 mg/L; myrtenol is present in an amount less than about 0.085 mg/L; p-cresol is present in an amount less than about 0.009 mg/L; phenethyl butyrate is present in an amount less than about 0.0017 mg/L; phenethyl octanoate is present in an amount less than about 0.0006 mg/L; propanol is present in an amount less than about 100 mg/L; salicylaldehyde is present in an amount less than about 0.0044 mg/L; whiskey lactone is present in an amount less than about 0.2 mg/L; amyl alcohol is present in an amount of at least about 0.03 mg/L; ethyl myristate is present in an amount of at least about 0.11 mg/L; geraniol is present in an amount of at least about 0.04 mg/L; isobutyraldehyde is present in an amount of at least about 1.15 mg/L; limonene is present in an amount of at least about 0.00007 mg/L; linalyl acetate is present in an amount of at least about 0.028 mg/L; less than about 0.000018% by mass of the one or more VOCs is phenethyl octanoate; less than about 0.00005% by mass of the one or more VOCs is phenethyl butyrate; less than about 0.0025% by mass of the one or more VOCs is myrtenol; less than about 0.0085% by mass of the one or more VOCs is ethyl isobutyrate; at least about 0.00001% by mass of the one or more VOCs is limonene; at least about 0.0034% by mass of the one or more VOCs is ethyl cinnamate; at least about 0.004% by mass of the one or more VOCs is linalyl acetate; at least about 0.0045% by mass of the one or more VOCs is amyl alcohol; at least about 0.005% by mass of the one or more VOCs is ethyl trans-2-butenoate; at least about 0.006% by mass of the one or more VOCs is geraniol; at least about 0.01% by mass of the one or more VOCs is 2-heptanone; at least about 0.015% by mass of the one or more VOCs is ethyl myristate; at least about 0.018% by mass of the one or more VOCs is ethyl levulinate; at least about 0.16% by mass of the one or more VOCs is isobutyraldehyde; at least about 0.24% by mass of the one or more VOCs is ethyl isovalerate; at least about 0.56% by mass of the one or more VOCs is 1,1-diethoxyethane; at least about 0.56% by mass of the one or more VOCs is ethyl hexanoate; or at least about 8.4% by mass of the one or more VOCs is ethyl lactate.

In yet another aspect, this document features a Scotch-like alcoholic beverage containing ethanol, water, and one or more additional VOCs, wherein at least one of the following, in any combination, is true: 1-decanol is present in an amount of less than about 0.067 mg/L; 1-octen-3-ol is present in an amount of less than about 0.024 mg/L; 2,3-pentadione is present in an amount of less than about 0.00028 mg/L; 2-methyl-1-butanol is present in an amount of less than about 75 mg/L; 2-methylbutyl acetate is present in an amount of less than about 0.12 mg/L; 2-nonanone is present in an amount of less than about 0.012 mg/L; diethyl malate is present in an amount of less than about 1.2 mg/L; diethyl succinate is present in an amount of less than about 1.2 mg/L; ethyl 3-hydroxyhexanoate is present in an amount of less than about 0.005 mg/L; ethyl acetate is present in an amount of less than about 42 mg/L; ethyl butanoate is present in an amount of less than about 0.14 mg/L; ethyl isobutyrate is present in an amount of less than about 0.3 mg/L; ethyl octanoate is present in an amount of less than about 2.3 mg/L; ethyl phenyl acetate is present in an amount of less than about 0.01 mg/L; ethyl propionate is present in an amount of less than about 0.1 mg/L; ethyl valerate is present in an amount of less than about 0.03 mg/L; eugenol is present in an amount of less than about 0.035 mg/L; gamma-decalactone is present in an amount of less than about 0.01 mg/L; gamma-nonalactone is present in an amount of less than about 0.01 mg/L; isobutanol is present in an amount of less than about 72 mg/L; isovaleraldehyde is present in an amount of less than about 0.08 mg/L; methyl salicylate is present in an amount of less than about 0.003 mg/L; myrtenol is present in an amount of less than about 0.085 mg/L; p-cresol is present in an amount of less than about 0.009 mg/L; phenethyl butyrate is present in an amount of less than about 0.0017 mg/L; phenethyl octanoate is present in an amount of less than about 0.0006 mg/L; propanol is present in an amount of less than about 100 mg/L; salicylaldehyde is present in an amount of less than about 0.0044 mg/L; whiskey lactone is present in an amount of less than about 0.2 mg/L; 1,1-diethoxyethane is present in an amount of at least about 4 mg/L; 2-undecanone is present in an amount of at least about 0.0015 mg/L; amyl alcohol is present in an amount of at least about 0.03 mg/L; beta-ionone is present in an amount of at least about 0.0037 mg/L; butyl acetate is present in an amount of at least about 0.97 mg/L; carvone is present in an amount of at least about 0.0025 mg/L; citronellol is present in an amount of at least about 0.046 mg/L; ethyl myristate is present in an amount of at least about 0.11 mg/L; geraniol is present in an amount of at least about 0.04 mg/L; isobutyraldehyde is present in an amount of at least about 1.15 mg/L; limonene is present in an amount of at least about 0.00007 mg/L; linalyl acetate is present in an amount of at least about 0.028 mg/L; methyl laurate is present in an amount of at least about 0.0003 mg/L; less than about 0.000018% by mass of the one or more VOCs is phenethyl octanoate; less than about 0.00005% by mass of the one or more VOCs is phenethyl butyrate; less than about 0.00025% by mass of the one or more VOCs is p-cresol; less than about 0.0025% by mass of the one or more VOCs is myrtenol; less than about 0.0085% by mass of the one or more VOCs is ethyl isobutyrate; less than about 0.035% by mass of the one or more VOCs is diethyl succinate; at least about 0.00001% by mass of the one or more VOCs is limonene; at least about 0.000043% by mass of the one or more VOCs is methyl laurate; at least about 0.0002% by mass of the one or more VOCs is 2-undecanone; at least about 0.00035% by mass of the one or more VOCs is carvone; at least about 0.0005% by mass of the one or more VOCs is beta-ionone; at least about 0.0012% by mass of the one or more VOCs is isoamyl octanoate; at least about 0.0034% by mass of the one or more VOCs is ethyl cinnamate; at least about 0.004% by mass of the one or more VOCs is linalyl acetate; at least about 0.0045% by mass of the one or more VOCs is amyl alcohol; at least about 0.005% by mass of the one or more VOCs is ethyl trans-2-butenoate; at least about 0.006% by mass of the one or more VOCs is geraniol; at least about 0.0065% by mass of the one or more VOCs is citronellol; at least about 0.01% by mass of the one or more VOCs is 2-heptanone; at least about 0.015% by mass of the one or more VOCs is ethyl myristate; at least about 0.018% by mass of the one or more VOCs is ethyl levulinate; at least about 0.14% by mass of the one or more VOCs is butyl acetate; at least about 0.16% by mass of the one or more VOCs is isobutyraldehyde; at least about 0.24% by mass of the one or more VOCs is ethyl isovalerate; at least about 0.56% by mass of the one or more VOCs is 1,1-diethoxyethane; at least about 0.56% by mass of the one or more VOCs is ethyl hexanoate; or at least about 8.4% by mass of the one or more VOCs is ethyl lactate.

This document also features a Scotch-like alcoholic beverage containing ethanol, water, and one or more additional VOCs, wherein at least one of the following, in any combination, is true: 1-decanol is present in an amount of less than about 0.067 mg/L; 1-octen-3-ol is present in an amount of less than about 0.024 mg/L; 2-methyl-1-butanol is present in an amount of less than about 75 mg/L; 2-methylbutyl acetate is present in an amount of less than about 0.12 mg/L; 2-methylbutyraldehyde is present in an amount of less than about 0.012 mg/L; 2-nonanone is present in an amount of less than about 0.012 mg/L; benzaldehyde is present in an amount of less than about 0.003 mg/L; butyl acetate is present in an amount of less than about 0.22 mg/L; cinnamaldehyde is present in an amount of less than about 0.00009 mg/L; citronellol is present in an amount of less than about 0.0002 mg/L; diethyl malate is present in an amount of less than about 1.2 mg/L; diethyl succinate is present in an amount of less than about 1.2 mg/L; ethyl acetate is present in an amount of less than about 42 mg/L; ethyl benzoate is present in an amount of less than about 0.005 mg/L; ethyl butanoate is present in an amount of less than about 0.14 mg/L; ethyl isobutyrate is present in an amount of less than about 0.3 mg/L; ethyl nonanoate is present in an amount of less than about 0.0075 mg/L; ethyl octanoate is present in an amount of less than about 2.3 mg/L; ethyl phenyl acetate is present in an amount of less than about 0.01 mg/L; ethyl propionate is present in an amount of less than about 0.1 mg/L; ethyl valerate is present in an amount of less than about 0.03 mg/L; eugenol is present in an amount of less than about 0.035 mg/L; gamma-decalactone is present in an amount of less than about 0.01 mg/L; gamma-nonalactone is present in an amount of less than about 0.01 mg/L; guaiacol is present in an amount of less than about 0.006 mg/L; hexanol is present in an amount of less than about 0.014 mg/L; isoamyl acetate is present in an amount of less than about 0.18 mg/L; isoamyl alcohol is present in an amount of less than about 50 mg/L; isoamyl octanoate is present in an amount of less than about 0.0005 mg/L; isobutanol is present in an amount of less than about 72 mg/L; isovaleraldehyde is present in an amount of less than about 0.08 mg/L; methyl salicylate is present in an amount of less than about 0.003 mg/L; myrtenol is present in an amount of less than about 0.085 mg/L; p-cresol is present in an amount of less than about 0.009 mg/L; phenethyl butyrate is present in an amount of less than about 0.0017 mg/L; phenethyl octanoate is present in an amount of less than about 0.0006 mg/L; propanol is present in an amount of less than about 100 mg/L; salicylaldehyde is present in an amount of less than about 0.0044 mg/L; whiskey lactone is present in an amount of less than about 0.2 mg/L; amyl alcohol is present in an amount of at least about 0.03 mg/L; ethyl myristate is present in an amount of at least about 0.11 mg/L; geraniol is present in an amount of at least about 0.04 mg/L; isobutyraldehyde is present in an amount of at least about 1.15 mg/L; limonene is present in an amount of at least about 0.00007 mg/L; linalyl acetate is present in an amount of at least about 0.028 mg/L; less than about 0.000018% by mass of the one or more VOCs is phenethyl octanoate; less than about 0.00005% by mass of the one or more VOCs is phenethyl butyrate; less than about 0.00009% by mass of the one or more VOCs is methyl salicylate; less than about 0.00022% by mass of the one or more VOCs is ethyl nonanoate; less than about 0.00035% by mass of the one or more VOCs is 2-methylbutyraldehyde; less than about 0.0004% by mass of the one or more VOCs is hexanol; less than about 0.0023% by mass of the one or more VOCs is isovaleraldehyde; less than about 0.0025% by mass of the one or more VOCs is myrtenol; less than about 0.0085% by mass of the one or more VOCs is ethyl isobutyrate; less than about 2.0% by mass of the one or more VOCs is isoamyl alcohol; less than about 3.0% by mass of the one or more VOCs is propanol; at least about 0.00001% by mass of the one or more VOCs is limonene; at least about 0.0002% by mass of the one or more VOCs is 2,3-pentadione; at least about 0.001% by mass of the one or more VOCs is methional; at least about 0.003% by mass of the one or more VOCs is ethyl 3-hydroxyhexanoate; at least about 0.0034% by mass of the one or more VOCs is ethyl cinnamate; at least about 0.004% by mass of the one or more VOCs is linalyl acetate; at least about 0.0045% by mass of the one or more VOCs is amyl alcohol; at least about 0.005% by mass of the one or more VOCs is ethyl trans-2-butenoate; at least about 0.006% by mass of the one or more VOCs is geraniol; at least about 0.0077% by mass of the one or more VOCs is phenethyl formate; at least about 0.01% by mass of the one or more VOCs is 2-heptanone; at least about 0.01% by mass of the one or more VOCs is vanillyl ethyl ether; at least about 0.015% by mass of the one or more VOCs is ethyl myristate; at least about 0.018% by mass of the one or more VOCs is ethyl levulinate; at least about 0.032% by mass of the one or more VOCs is propyl acetate; at least about 0.033% by mass of the one or more VOCs is isobutyl acetate; at least about 0.16% by mass of the one or more VOCs is isobutyraldehyde; at least about 0.24% by mass of the one or more VOCs is ethyl isovalerate; at least about 0.56% by mass of the one or more VOCs is 1,1-diethoxyethane; at least about 0.56% by mass of the one or more VOCs is ethyl hexanoate; at least about 4.9% by mass of the one or more VOCs is butanol; or at least about 8.4% by mass of the one or more VOCs is ethyl lactate.

In any of the above embodiments, the one or more additional VOCs can include one or more, two or more, three or more, four or more, five or more, six or more, no more than six, or all of butyl formate, ethyl octanoate, ethyl propionate, ethyl-2-methylbutyrate, isoamyl acetate, isoamyl alcohol, and isobutanol.

The one or more additional VOCs can include an ester, an alcohol, an aldehyde, a ketone, or a mixture thereof, a terpene, an isoprenoid, or a mixture thereof, and a phenol. In some cases, the one or more additional VOCs can further include at least one compound selected from the group consisting of an acid, an alcohol, a lactone, a thiol, or an ether.

For example, the one or more additional VOCs can include one or more esters. Less than about 1.9% by mass of the additional VOCs can include the one or more esters. The one or more esters can be selected from the group consisting of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl succinate, ethyl acetate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl salicylate, ethyl undecanoate, ethyl valerate, ethyl-2-methylbutyrate, isoamyl acetate, isoamyl hexanoate, isoamyl octanoate, isobutyl acetate, linalyl acetate, methyl decanoate, methyl hexanoate, methyl laurate, methyl octanoate, methyl salicylate, phenethyl butyrate, phenethyl octanoate, diethyl malate, ethyl 3-hydroxyhexanoate, ethyl benzoate, ethyl levulinate, phenethyl formate, propyl acetate, ethyl-trans-2-butenoate, ethyl-trans-3-hexenoate, ethyl(methylthio) acetate, heptyl acetate, isoamyl isobutyrate, isoamyl isovalerate, isobutyl isobutyrate, methyl acetate, and phenethyl propionate.

The one or more additional VOCs can include one or more acids. The one or more acids can be selected from the group consisting of 3,7-dimethyl-6-octenoic acid, butyric acid, decanoic acid, isobutyric acid, octanoic acid, propionic acid, isovaleric acid, valeric acid, hexanoic acid, and nonanoic acid.

The one or more additional VOCs can include one or more alcohols. The one or more alcohols can be selected from the group consisting of 1-octanol, 2-methyl-1-butanol, 2-nonanol, 2-phenylethanol, butyl alcohol, cis-3-hexen-1-ol, 1-decanol, 1-octen-3-ol, amyl alcohol, butanol, hexanol, isoamyl alcohol, isobutanol, and propanol.

The one or more additional VOCs can include one or more aldehydes or ketones. At least about 3.4% by mass of the one or more additional VOCs can include the one or more aldehydes or ketones, or less than about 0.008% by mass of the one or more additional VOCs can include the one or more aldehydes or ketones. The one or more aldehydes or ketones can be selected from the group consisting of 1,1-diethoxyethane, 2,3-pentadione, 2-methylbutyraldehyde, 2-nonanone, 2-undecanone, acetaldehyde, acetoin, benzaldehyde, butyraldehyde, cinnamaldehyde, damascenone, furfural, isovaleraldehyde, maltol, nonanal, trans-2-hexen-1-al, isobutyraldehyde, salicylaldehyde, 2-heptanone, acetophenone, methional, valeraldehyde, propionaldehyde, and p-anisaldehyde.

The one or more additional VOCs can include one or more terpenes or isoprenoids. Less than about 0.009% by mass of the one or more additional VOCs can include the one or more terpenes or isoprenoids. The one or more terpenes or isoprenoids can be selected from the group consisting of 3-carene, 4-carvomenthenol, 4-ethylguaiacol, alpha ionone, a-phellandrene, (−)alpha-pinene, a-terpineol, beta-ionone, (−) beta-pinene, carvone, (−)cis-rose-oxide, citronellol, gamma-terpinene, limonene, linalool, linalool oxide, myrcene, myrtenol, p-cymene, farnesol, geraniol, geranyl acetone, and eucalyptol.

The one or more additional VOCs can include one or more phenols. Less than about 0.0015% by mass of the one or more additional VOCs can include the one or more phenols, or at least about 1.1% by mass of the one or more additional VOCs can include the one or more phenols. The one or more phenols can be selected from the group consisting of 2-methoxy-4-propylphenol, 4-ethylphenol, eugenol, guaiacol, and p-cresol.

The one or more additional VOCs can include one or more lactones. At least about 0.8% by mass of the one or more additional VOCs can include the one or more lactones. The one or more lactones can be selected from the group consisting of delta-decalactone, gamma-decalactone, whiskey lactone, and gamma-nonalactone.

The one or more additional VOCs can include one or more thiols. The one or more thiols can include dimethylsulfide.

The one or more additional VOCs can include one or more ethers. At least about 0.01% by mass of the one or more VOCs can include the one or more ethers. The one or more ethers can include vanillyl ethyl ether.

The one or more additional VOCs can include at least five compounds selected from the group consisting of 1-decanol, 1-octen-3-ol, 2,3-pentadione, 2-methyl-1-butanol, 2-phenylethanol, 2-phenylethylacetate, acetaldehyde, amyl alcohol, a-terpineol, benzaldehyde, beta-ionone, beta-pinene, butanol, butyl acetate, cinnamaldehyde, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, isoamyl alcohol, isoamyl hexanoate, isoamyl octanoate, isobutanol, isobutyl acetate, limonene, linalool oxide, maltol, methyl octanoate, methyl salicylate, myrcene, p-cresol, p-cymene, phenethyl butyrate, and whiskey lactone.

The one or more additional VOCs can include at least one compound selected from the group consisting of propanol, ethyl isobutyrate, gamma-terpinene, and butyric acid.

The one or more additional VOCs can include at least one compound selected from the group consisting of 3-carene, 4-carvomenthenol, 4-ethyl phenol, butyl formate, delta-decalactone, ethyl heptanoate, guaiacol, isoamyl acetate, linalool, linalyl acetate.

The one or more additional VOCs can include at least one compound selected from the group consisting of 1,1-diethoxyethane, 2-heptanone, 2-methylbutyl acetate, 2-methylbutyraldehyde, 2-nonanone, 4-ethyl guaiacol, acetoin, acetophenone, amyl butyrate, a-phellandrene, a-pinene, citronellol, damascenone, decanoic acid, diethyl malate, dimethylsulfide, ethyl 3-hydroxyhexanoate, ethyl benzoate, ethyl levulinate, ethyl nonanoate, ethyl palmitate, ethyl trans-2-butenoate, ethyl undecanoate, ethyl-2-methylbutyrate, farnesol, gamma-nonalactone, geraniol, geranyl acetone, hexanol, isobutyraldehyde, isobutyric acid, isovaleraldehyde, methional, methyl decanoate, methyl hexanoate, methyl laurate, myrtenol, nonanal, octanoic acid, p-anisaldehyde, phenethyl formate, phenethyl octanoate, propionaldehyde, propyl acetate, salicylaldehyde, trans-2-hexen-1-al, valeraldehyde, vanillyl ethyl ether, butyraldehyde, propionic acid, isovaleric acid, valeric acid, hexanoic acid, and nonanoic acid.

The one or more additional VOCs can include five or more compounds selected from the group consisting of 1-decanol, 1-octen-3-ol, 2,3-pentadione, 2-methyl-1-butanol, 2-phenylethanol, 2-phenylethylacetate, 3-carene, acetaldehyde, amyl alcohol, a-terpineol, benzaldehyde, beta-ionone, beta-pinene, butanol, butyl acetate, cinnamaldehyde, delta-decalactone, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, guaiacol, isoamyl alcohol, isoamyl hexanoate, isoamyl octanoate, isobutanol, isobutyl acetate, limonene, linalool, linalool oxide, linalyl acetate, maltol, methyl salicylate, myrcene, p-cresol, and whiskey lactone.

The one or more additional VOCs can include at least one compound selected from the group consisting of 1,1-diethoxyethane, 2-heptanone, 4-ethyl guaiacol, acetoin, acetophenone, diethyl malate, ethyl 3-hydroxyhexanoate, ethyl levulinate, ethyl trans-2-butenoate, ethyl undecanoate, ethyl-2-methylbutyrate, gamma-nonalactone, geraniol, isobutyraldehyde, methional, methyl octanoate, p-cymene, phenethyl butyrate, phenethyl formate, propanol, propyl acetate, and vanillyl ethyl ether.

The one or more additional VOCs can have less than about 95% identity to the VOCs in a single reference Scotch. The Scotch-like alcoholic beverage can include at least 61 additional VOCs and wherein no more than 60 of the additional VOCs are found in a single reference Scotch.

The Scotch-like alcoholic beverage can further include one or more non-volatile compounds. The one or more non-volatile compounds can include one or more compounds selected from the group consisting of mannose, valine, tyrosine, xylose, cinnamic acid, and 2-furoic acid. In some embodiments, the one or more non-volatile compounds do not include one or more compounds selected from the group consisting of 2-isopropylmalic acid, 3,4-dihydroxybenzoic acid, arabitol, arginine, aspartic acid, caffeic acid, citrulline, coumaric acid, kynurenic acid, pyruvic acid, rhamnose, serine, trans 4-hydroxy-L-proline, acetovanillone, choline, fucose, fumaric acid, γ-aminobutyric acid (GABA), galactose, gallic acid, mannitol, myo-inositol, proline, quinic acid, ribose, syringaldehyde, syringic acid, vanillic acid, vanillin, and sorbitol. The one or more non-volatile compounds can include one or more of the following: fructose in an amount of less than about 9.6 mg/L, ribose in an amount of less than about 6 mg/L, syringaldehyde in an amount of less than about 0.55 mg/L, vanillic acid in an amount of less than about 10.3 mg/L, vanillin in an amount of less than about 0.3 mg/L, acetovanillone in an amount of at least about 0.26 mg/L, choline in an amount of at least about 2.8 mg/L, citric acid in an amount of at least about 6.6 mg/L, fumaric acid in an amount of at least about 0.65 mg/L, glucosamine in an amount of at least about 0.55 mg/L, glucose in an amount of at least about 120 mg/L, mannitol in an amount of at least about 7.8 mg/L, sorbitol in an amount of at least about 5.8 mg/L, and/or syringic acid in an amount of at least about 5.4 mg/L. The one or more non-volatile compounds can include kelp or a kelp extract. The kelp or kelp extract can be kombu kelp or kombu kelp extract. The one or more non-volatile compounds can include glycerol, gum arabic, or glycerol and gym arabic.

The one or more non-volatile compounds can include 10 or more compounds selected from the group consisting of 4-O-pentopyranosylpentopyranose, Assamicain A, catechin, chlorogenic acid, cinchonain Ia, Cinnamtannin A4, Cinnamtannin B 1, cyanidin3-O-rutinoside, D(−)-amygdalin, digallate glycoside, digallic acid, ellagic acid, epicatechin, epicatechin-3-O-gallate, epigallocatechin, epigallocatechin gallate, eriodictyol, exifone, ferulic acid, gallic acid, gossypin, isorhamnetin, Kandelin A2, linoleic acid, luteolin, mulberroside A, naringenin, oleic acid, palmitoleic acid, p-coumaroylquinicacid, pentagalloyl glucose, phloretin, phloridzin, procyanidin A2, procyanidin B2, procyanidin Cl, quercetin, quercetin glycoside, quercetin-3β-D-glucoside, ramnazin-3-O-rutinoside, rutin, syringic acid, tannic acid, tetragalloyl glucose, theasinesin A, tiliroside, trigalloyl glucose, and vanillic acid. The one or more non-volatile compounds can include at least five compounds selected from the group consisting of D-glucuronic acid, fructose, glucose, lactic acid, malic acid, succinic acid, and tartaric acid. The one or more non-volatile compounds can include at least one compound selected from the group consisting of acetovanillone, choline, fumaric acid, GABA, gallic acid, glucosamine, inositol, mannitol, mannose, proline, ribose, sorbitol, syringaldehyde, syringic acid, trans-ferulic acid, tyrosine, valine, vanillic acid, and vanillin. The one or more non-volatile compounds can have less than about 60% identity to the non-volatile compounds in a single reference Scotch. The Scotch-like alcoholic beverage can include 10 or more non-volatile compounds, where no more than 9 of the non-volatile compounds are found in a single reference Scotch. In some cases, the Scotch-like alcoholic beverage does not include one or more of E. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6-tribromoanisole, aflatoxin, aldrin, dieldrin, benzene hexachloride, chlordane, DDT, DDE, TDE, dimethylnitrosamine (nitrosodimethylamine), EDB, heptachlor, heptachlor epoxide, lindane, mercury, methanol, ethylene glycol, dichloromethane, and heavy metals.

In another aspect, this document features a Scotch-like alcoholic beverage containing ethanol, water, and one or more non-volatile compounds, where the one or more non-volatile compounds include one or more compounds selected from the group consisting of mannose, valine, tyrosine, xylose, cinnamic acid, and 2-furoic acid. In some cases, the one or more non-volatile compounds do not include one or more compounds selected from the group consisting of 2-isopropylmalic acid, 3,4-dihydroxybenzoic acid, arabitol, arginine, aspartic acid, caffeic acid, citrulline, coumaric acid, kynurenic acid, pyruvic acid, rhamnose, serine, trans 4-hydroxy-L-proline, acetovanillone, choline, fucose, fumaric acid, GABA, galactose, gallic acid, mannitol, myo-inositol, proline, quinic acid, ribose, syringaldehyde, syringic acid, vanillic acid, vanillin, and sorbitol.

In another aspect, this document features a Scotch-like alcoholic beverage containing ethanol, water, and one or more non-volatile compounds, wherein the one or more non-volatile compounds do not include one or more compounds selected from the group consisting of 2-isopropylmalic acid, 3,4-dihydroxybenzoic acid, arabitol, arginine, aspartic acid, caffeic acid, citrulline, coumaric acid, kynurenic acid, pyruvic acid, rhamnose, serine, trans 4-hydroxy-L-proline, acetovanillone, choline, fucose, fumaric acid, GABA, galactose, gallic acid, mannitol, myo-inositol, proline, quinic acid, ribose, syringaldehyde, syringic acid, vanillic acid, vanillin, and sorbitol.

The Scotch-like alcoholic beverage of the above embodiments can include one or more of the following: fructose in an amount of less than about 9.6 mg/L, ribose in an amount of less than about 6 mg/L, syringaldehyde in an amount of less than about 0.55 mg/L, vanillic acid in an amount of less than about 10.3 mg/L, vanillin in an amount of less than about 0.3 mg/L, acetovanillone in an amount of at least about 0.26 mg/L, choline in an amount of at least about 2.8 mg/L, citric acid in an amount of at least about 6.6 mg/L, fumaric acid in an amount of at least about 0.65 mg/L, glucosamine in an amount of at least about 0.55 mg/L, glucose in an amount of at least about 120 mg/L, mannitol in an amount of at least about 7.8 mg/L, sorbitol in an amount of at least about 5.8 mg/L, and/or syringic acid in an amount of at least about 5.4 mg/L. The one or more non-volatile compounds can include kelp or a kelp extract. The kelp or kelp extract can be kombu kelp or kombu kelp extract. The one or more non-volatile compounds can include glycerol, gum arabic, or glycerol and gym arabic.

The one or more non-volatile compounds can include 10 or more compounds selected from the group consisting of 4-O-pentopyranosylpentopyranose, Assamicain A, catechin, chlorogenic acid, cinchonain Ia, Cinnamtannin A4, Cinnamtannin B 1, cyanidin3-O-rutinoside, D(−)-amygdalin, digallate glycoside, digallic acid, ellagic acid, epicatechin, epicatechin-3-O-gallate, epigallocatechin, epigallocatechin gallate, eriodictyol, exifone, ferulic acid, gallic acid, gossypin, isorhamnetin, Kandelin A2, linoleic acid, luteolin, mulberroside A, naringenin, oleic acid, palmitoleic acid, p-coumaroylquinicacid, pentagalloyl glucose, phloretin, phloridzin, procyanidin A2, procyanidin B2, procyanidin Cl, quercetin, quercetin glycoside, quercetin-3β-D-glucoside, ramnazin-3-O-rutinoside, rutin, syringic acid, tannic acid, tetragalloyl glucose, theasinesin A, tiliroside, trigalloyl glucose, and vanillic acid. The one or more non-volatile compounds can include at least five compounds selected from the group consisting of D-glucuronic acid, fructose, glucose, lactic acid, malic acid, succinic acid, and tartaric acid. The one or more non-volatile compounds can include at least one compound selected from the group consisting of acetovanillone, choline, fumaric acid, GABA, gallic acid, glucosamine, inositol, mannitol, mannose, proline, ribose, sorbitol, syringaldehyde, syringic acid, trans-ferulic acid, tyrosine, valine, vanillic acid, and vanillin. The one or more non-volatile compounds can have less than about 60% identity to the non-volatile compounds in a single reference Scotch. The Scotch-like alcoholic beverage can include 10 or more non-volatile compounds, wherein no more than 9 of the non-volatile compounds are found in a single reference Scotch. In some cases, the Scotch-like alcoholic beverage does not include one or more of E. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6-tribromoanisole, aflatoxin, aldrin, dieldrin, benzene hexachloride, chlordane, DDT, DDE, TDE, dimethylnitrosamine (nitrosodimethylamine), EDB, heptachlor, heptachlor epoxide, lindane, mercury, methanol, ethylene glycol, dichloromethane, and heavy metals.

In another aspect, this document features a method of making a Scotch-like alcoholic beverage, where the method includes providing an aqueous solution, and adding to the aqueous solution ingredients that include ethanol, a source of a tannin, a plurality of oak pieces or oak extract, nonvolatile compounds, wherein the nonvolatile compounds include a sugar or sugar alcohol and an acid, and VOCs, wherein the VOCs include an ester, an alcohol, an aldehyde or a ketone or both, and a terpene or an isoprenoid or both. The nonvolatile compounds can include at least one compound selected from the group consisting of mannose, valine, tyrosine, xylose, cinnamic acid, and 2-furoic acid. In some cases, the nonvolatile compounds do not include at least one compound selected from the group consisting of 2-isopropylmalic acid, 3,4-dihydroxybenzoic acid, arabitol, arginine, aspartic acid, caffeic acid, citrulline, coumaric acid, kynurenic acid, pyruvic acid, rhamnose, serine, trans-4-hydroxy-L-proline, acetovanillone, choline, fucose, fumaric acid, GABA, galactose, gallic acid, mannitol, myo-inositol, proline, quinic acid, ribose, syringaldehyde, syringic acid, vanillic acid, vanillin, and sorbitol. The ingredients can further include kelp or a kelp extract. The kelp can be kombu kelp. The ingredients can further include a kelp extract, wherein the kelp extract is added in an amount of 0.1% to about 0.3% (v/v). The ingredients can further include glycerol, gum arabic, or glycerol and gym arabic. The VOCs can include at least one compound selected from the group consisting of a-terpineol, acetoin, beta-pinene, 4-carvomenthenol, 4-ethyl phenol, amyl butyrate, myrcene, linalool, and p-anisaldehyde. In some cases, the VOCs do not include at least one compound selected from the group consisting of 1,1-diethoxyethane, citronellol, ethyl isobutyrate, ethyl nonanoate, ethyl-2-methylbutyrate, eugenol, guaiacol, hexanol, isoamyl acetate, isobutyl acetate, isovaleraldehyde, propanol, 1-octanol, 1-octen-3-ol, 2-heptanone, 2-methoxy-4-propylphenol, 2-methylbutyl acetate, 2-methylbutyraldehyde, 2-nonanone, 2-undecanone, acetophenone, butyl acetate, cinnamaldehyde, cis-3-hexen-1-ol, cis-3-hexenyl acetate, diethyl malate, ethyl 3-hydroxyhexanoate, ethyl benzoate, ethyl heptanoate, ethyl levulinate, ethyl myristate, ethyl phenyl acetate, ethyl salicylate, ethyl trans-2-butenoate, ethyl undecanoate, ethyl valerate, farnesol, gamma-decalactone, gamma-nonalactone, gamma-terpinene, geraniol, geranyl acetone, heptyl acetate, isoamyl hexanoate, isoamyl isobutyrate, isoamyl isovalerate, isoamyl octanoate, isobutyl isobutyrate, isobutyraldehyde, limonene, methyl acetate, methyl hexanoate, methyl laurate, methyl octanoate, p-cresol, p-cymene, phenethyl butyrate, phenethyl formate, phenethyl octanoate, phenethyl propionate, propyl acetate, salicylaldehyde, vanillyl ethyl ether, damascenone, diethyl succinate, and myrtenol. The source of a tannin can be a tannin powder.

In still another aspect, this document features a method for making a Scotch-like alcoholic beverage, where the method includes combining water, one or more acids, one or more sugars, one or more sugar alcohols, one or more tannin components, one or more flavorants, ethanol, and five or more additional VOCs selected from the group consisting of 1,1-diethoxyethane, 1-decanol, 1-octen-3-ol, 2,3-pentadione, 2-heptanone, 2-methyl-1-butanol, 2-methylbutyraldehyde, 2-phenylethanol, 2-phenylethylacetate, 3-carene, 4-ethyl guaiacol, 4-ethyl phenol, acetaldehyde, acetoin, acetophenone, amyl alcohol, a-terpineol, benzaldehyde, beta-ionone, beta-pinene, butanol, butyl acetate, butyric acid, cinnamaldehyde, delta-decalactone, diethyl malate, diethyl succinate, ethyl 3-hydroxyhexanoate, ethyl acetate, ethyl butanoate, ethyl cinnamate, ethyl decanoate, ethyl hexanoate, ethyl isovalerate, ethyl lactate, ethyl laurate, ethyl levulinate, ethyl myristate, ethyl octanoate, ethyl phenyl acetate, ethyl propionate, ethyl trans-2-butenoate, ethyl undecanoate, ethyl valerate, ethyl-2-methylbutyrate, eugenol, furfural, gamma-decalactone, gamma-nonalactone, geraniol, guaiacol, isoamyl acetate, isoamyl alcohol, isoamyl hexanoate, isoamyl octanoate, isobutanol, isobutyl acetate, isobutyraldehyde, isovaleraldehyde, limonene, linalool, linalool oxide, linalyl acetate, maltol, methional, methyl octanoate, methyl salicylate, myrcene, p-anisaldehyde, p-cresol, p-cymene, phenethyl butyrate, phenethyl formate, propanol, propionaldehyde, propyl acetate, salicylaldehyde, valeraldehyde, vanillyl ethyl ether, whiskey lactone, butyraldehyde, propionic acid, isovaleric acid, valeric acid, hexanoic acid, and nonanoic acid. The one or more acids can include tartaric acid, vanillic acid, syringic acid, malic acid, succinic acid, and lactic acid. The one or more sugars can include ribose, fructose, and glucose. The one or more sugar alcohols can include mannitol and inositol. The one or more tannin components can include gallic acid. The one or more flavorants can include vanillin and syringaldehyde. The additional VOCs can include at least one compound selected from the group consisting of a-terpineol, beta-pinene, 4-carvomenthenol, 4-ethyl phenol, amyl butyrate, myrcene, linalool, p-anisaldehyde. In some cases, the additional VOCs do not include one or more compounds selected from the group consisting 1-octanol, 2-methoxy-4-propylphenol, 2-undecanone, cis-3-hexen-1-ol, cis-3-hexenyl acetate, ethyl salicylate, heptyl acetate, isoamyl isobutyrate, isoamyl isovalerate, isobutyl isobutyrate, methyl acetate, phenethyl propionate. The Scotch-like alcoholic beverage can include one or more compounds selected from the group consisting of mannose, valine, tyrosine, xylose, cinnamic acid, and 2-furoic acid. In some cases, the Scotch-like alcoholic beverage does not include one or more compounds selected from the group consisting of 2-isopropylmalic acid, 3,4-dihydroxybenzoic acid, arabitol, arginine, aspartic acid, caffeic acid, citrulline, coumaric acid, kynurenic acid, pyruvic acid, rhamnose, serine, trans-4-hydroxy-L-proline, acetovanillone, choline, fucose, fumaric acid, GABA, galactose, gallic acid, mannitol, myo-inositol, proline, quinic acid, ribose, syringaldehyde, syringic acid, vanillic acid, vanillin, and sorbitol.

In another aspect, this document features a method of making a Scotch-like alcoholic beverage, where the method comprises combining ingredients comprising water, ethanol, and five or more additional VOCs, wherein at least five of the five or more additional VOCs are provided as separate ingredients. The ingredients can include 10 or more additional VOCs, wherein at least 10 of the 10 or more additional VOCs are provided as separate ingredients. The ingredients can include 15 or more additional VOCs, wherein at least 15 of the 15 or more additional VOCs are provided as separate ingredients. The ingredients can include 20 or more additional VOCs, wherein at least 20 of the 20 or more additional VOCs are provided as separate ingredients. The ingredients can further include a non-volatile compound (e.g., one or more non-volatile compounds). The non-volatile compound can include a sugar or a sugar alcohol, an acid, a pH-modifying salt, a nucleobase or nucleotide monophosphate, an amino acid or derivative thereof, or a combination thereof. The acid can include D-glucuronic acid, tartaric acid, vanillic acid, syringic acid, malic acid, succinic acid, lactic acid, or a combination thereof. The sugar or sugar alcohol can include ribose, fructose, glucose, mannitol, inositol, or a combination thereof. The pH-modifying salt can include potassium hydroxide. The nucleobase or nucleotide monophosphate can include adenine, guanine, guanosine monophosphate, inosine monophosphate, or a combination thereof. The amino acid or derivative thereof can include leucine, phenylalanine, methionine, gamma-aminobutyric acid (GABA), tyrosine, serine, aspartic acid, glucosamine, histidine, lysine, isoleucine, carnitine, tryptophan, proline, valine, b-alanine, threonine, glutamine, asparagine, glutamic acid, cysteine, arginine, ornithine, trans 4-hydroxy-L-proline, citrulline, tyramine, or a combination thereof. The non-volatile compound can include a coloring agent. The non-volatile compound can include an emulsifier. The non-volatile compound can include gum arabic. The non-volatile compound can include at least one non-volatile compound that is not present in a corresponding traditional alcoholic beverage. The non-volatile compound can exclude at least one non-volatile compound that is present in a corresponding traditional alcoholic beverage. The one or more additional VOCs can include at least one VOC that is not present in a corresponding traditional alcoholic beverage. The one or more additional VOCs can exclude at least one VOC that is present in a corresponding traditional alcoholic beverage. The Scotch-like alcoholic beverage can be any of the Scotch-like alcoholic beverages described herein.

In another aspect, this document provides a method of making a Scotch-like alcoholic beverage, where the method includes providing a composition comprising ethanol, water, and one or more additional VOCs, wherein at least one of the one or more additional VOCs is present in a concentration of at least about 2-fold the concentration of the same VOC in a corresponding traditional Scotch, and adding to the composition ethanol, water, or a combination thereof such that the concentration of the at least one additional VOC is reduced to about the concentration of the same VOC in a corresponding traditional Scotch. The one or more additional VOCs can include at least one VOC that is not present in a corresponding traditional Scotch. The one or more additional VOCs can exclude at least one VOC that is present in a corresponding traditional Scotch. The Scotch-like alcoholic beverage can further include one or more non-volatile compounds, and wherein the one or more non-volatile compounds include at least one non-volatile compound that is not present in a corresponding traditional Scotch. The Scotch-like alcoholic beverage can further include one or more non-volatile compounds, and wherein the one or more non-volatile compounds exclude least one non-volatile compound that is present in a corresponding traditional Scotch. The one or more additional VOCs can be present in the composition in a concentration of at least about 5-fold the concentration of the same VOCs in a corresponding traditional Scotch. The one or more additional VOCs can be present in the composition in a concentration of at least about 10-fold the concentration of the same VOC in a corresponding traditional Scotch. The one or more additional VOCs can be present in the composition in a concentration of at least about 15-fold the concentration of the same VOCs in a corresponding traditional Scotch. The one or more additional VOCs can be present in the composition in a concentration of at least about 20-fold the concentration of the same VOCs in a corresponding traditional Scotch. The composition can include five or more additional VOCs, wherein at least five of the five or more additional VOCs are present in a concentration of at least about 5-fold the concentration of the same VOCs in a corresponding traditional Scotch. The total amount (in mg/L) of the one or more additional VOCs in the composition can be greater than 5-fold the total amount of the same VOCs (in mg/L) in a corresponding traditional Scotch. After the adding step, the Scotch-like alcoholic beverage can be any of the Scotch-like alcoholic beverages described herein.

In another aspect, this document also provides a method of making a Scotch-like alcoholic beverage, where the method includes providing a composition comprising ethanol, water, and one or more additional non-volatile compounds, wherein at least one of the one or more non-volatile compounds is present in a concentration of at least about 2-fold the concentration of the same non-volatile compound in a corresponding traditional Scotch, and adding to the composition ethanol, water, or a combination thereof such that the concentration of the at least one non-volatile compound is reduced to about the concentration of the same non-volatile compound in a corresponding traditional Scotch. The one or more non-volatile compounds can include at least one non-volatile compound that is not present in a corresponding traditional Scotch. The one or more non-volatile compounds can exclude at least one non-volatile compound that is present in a corresponding traditional Scotch. The Scotch-like alcoholic beverage can further include one or more additional VOCs, and wherein the one or more additional VOCs include at least one VOC that is not present in a corresponding traditional Scotch. The Scotch-like alcoholic beverage can further include one or more additional VOCs, and wherein the one or more additional VOCs exclude at least one VOC that is present in a corresponding traditional Scotch. The one or more non-volatile compounds can be present in the composition in a concentration of at least about 5-fold the concentration of the same non-volatile compounds in a corresponding traditional Scotch. The one or more non-volatile compounds can be present in the composition in a concentration of at least about 10-fold the concentration of the same non-volatile compounds in a corresponding traditional Scotch. The one or more non-volatile compounds can be present in the composition in a concentration of at least about 15-fold the concentration of the same non-volatile compounds in a corresponding traditional Scotch. The one or more non-volatile compounds can be present in the composition in a concentration of at least about 20-fold the concentration of the same non-volatile compounds in a corresponding traditional Scotch. The composition can include five or more non-volatile compounds, wherein at least five of the five or more non-volatile compounds are present in a concentration of at least about 5-fold the concentration of the same non-volatile compounds in a corresponding traditional Scotch. The total amount (in mg/L) of the one or more non-volatile compounds in the composition can be greater than 5-fold the total amount of the same non-volatile compounds (in mg/L) in a corresponding traditional Scotch. After the adding step, the Scotch-like alcoholic beverage can be any of the Scotch-like alcoholic beverages described herein.

In another aspect, this document provides a method of making a Scotch-like alcoholic beverage concentrate, where the method includes combining ethanol, water, and one or more additional VOCs, wherein at least one of the one or more additional VOCs is present in a concentration of at least about 2-fold the concentration of the same VOC in a corresponding traditional Scotch. The one or more additional VOCs can include at least one VOC that is not present in a corresponding traditional Scotch. The one or more additional VOCs can exclude at least one VOC that is present in a corresponding traditional Scotch. The Scotch-like alcoholic beverage concentrate can further include one or more non-volatile compounds, and wherein the one or more non-volatile compounds include at least one non-volatile compound that is not present in a corresponding traditional Scotch. The Scotch-like alcoholic beverage concentrate can further include one or more non-volatile compounds, and wherein the one or more non-volatile compounds exclude at least one non-volatile compound that is present in a corresponding traditional Scotch. The one or more additional VOCs can be present in the concentrate in a concentration of at least about 5-fold the concentration of the same VOCs in a corresponding traditional Scotch. The one or more additional VOCs can be present in the concentrate in a concentration of at least about 10-fold the concentration of the same VOCs in a corresponding traditional Scotch. The one or more additional VOCs can be present in the concentrate in a concentration of at least about 15-fold the concentration of the same VOCs in a corresponding traditional Scotch. The one or more additional VOCs can be present in the concentrate in a concentration of at least about 20-fold the concentration of the same VOC in a corresponding traditional Scotch. The concentrate can include five or more additional VOCs, wherein at least five of the five or more additional VOCs are present in a concentration of at least about 5-fold the concentration of the same VOCs in a corresponding traditional Scotch. The total amount (in mg/L) of the one or more additional VOCs in the concentrate can be greater than 5-fold the total amount of the same VOCs (in mg/L) in a corresponding traditional Scotch. Upon dilution of the Scotch-like alcoholic beverage concentrate to a Scotch-like alcoholic beverage, the Scotch-like alcoholic beverage can be any of the Scotch-like alcoholic beverages described herein.

In another aspect, this document also provides a method of making a Scotch-like alcoholic beverage concentrate, where the method includes combining ethanol, water, and one or more non-volatile compounds, wherein at least one of the one or more non-volatile compounds is present in a concentration of at least about 2-fold the concentration of the same non-volatile compound in a corresponding traditional Scotch. The one or more non-volatile compounds can include at least one non-volatile compound that is not present in a corresponding traditional Scotch. The one or more non-volatile compounds can exclude at least one non-volatile compound that is present in a corresponding traditional Scotch. The Scotch-like alcoholic beverage concentrate can further include one or more additional VOCs, and wherein the one or more additional VOCs include at least one VOC that is not present in a corresponding traditional Scotch. The Scotch-like alcoholic beverage concentrate can further include one or more additional VOCs, and wherein the one or more additional VOCs exclude at least one VOC that is present in a corresponding traditional Scotch. The one or more non-volatile compounds can be present in the concentrate in a concentration of at least about 5-fold the concentration of the same non-volatile compounds in a corresponding traditional Scotch. The one or more non-volatile compounds can be present in the concentrate in a concentration of at least about 10-fold the concentration of the same non-volatile compounds in a corresponding traditional Scotch. The one or more non-volatile compounds can be present in the concentrate in a concentration of at least about 15-fold the concentration of the same non-volatile compounds in a corresponding traditional Scotch. The one or more non-volatile compounds can be present in the concentrate in a concentration of at least about 20-fold the concentration of the same non-volatile compounds in a corresponding traditional Scotch. The concentrate can include five or more non-volatile compounds, wherein at least five of the five or more non-volatile compounds are present in a concentration of at least about 5-fold the concentration of the same non-volatile compounds in a corresponding traditional Scotch. The total amount (in mg/L) of the one or more non-volatile compounds in the concentrate can be greater than 5-fold the total amount of the same non-volatile compounds (in mg/L) in a corresponding traditional Scotch. Upon dilution of the Scotch-like alcoholic beverage to a Scotch-like alcoholic beverage, the Scotch-like alcoholic beverage can be any of the Scotch-like alcoholic beverages described herein.

In another aspect, this document provides a Scotch-like alcoholic beverage concentrate containing ethanol, water, and one or more additional VOCs, wherein at least one of the one or more additional VOCs is present in a concentration of at least about 2-fold the concentration of the same VOC in a corresponding traditional Scotch. The one or more additional VOCs can include at least one VOC that is not present in a corresponding traditional Scotch. The one or more additional VOCs can exclude at least one VOC that is present in a corresponding traditional Scotch. The Scotch-like alcoholic beverage concentrate can further include one or more non-volatile compounds, and wherein the one or more non-volatile compounds include at least one non-volatile compound that is not present in a corresponding traditional Scotch. The Scotch-like alcoholic beverage concentrate can further include one or more non-volatile compounds, and wherein the one or more non-volatile compounds exclude at least one non-volatile compound that is present in a corresponding traditional Scotch. The one or more additional VOCs can be present in the concentrate in a concentration of at least about 5-fold the concentration of the same VOCs in a corresponding traditional Scotch. The one or more additional VOCs can be present in the concentrate in a concentration of at least about 10-fold the concentration of the same VOCs in a corresponding traditional Scotch. The one or more additional VOCs can be present in the concentrate in a concentration of at least about 15-fold the concentration of the same VOCs in a corresponding traditional Scotch. The one or more additional VOCs can be present in the concentrate in a concentration of at least about 20-fold the concentration of the same VOCs in a corresponding traditional Scotch. The concentrate can include five or more additional VOCs, wherein at least five of the five or more additional VOCs are present in a concentration of at least about 5-fold the concentration of the same VOCs in a corresponding traditional Scotch. The total amount (in mg/L) of the one or more additional VOCs in the concentrate can be greater than 5-fold the total amount of the same VOCs (in mg/L) in a corresponding traditional Scotch. Upon dilution of the Scotch-like alcoholic beverage concentrate to a Scotch-like alcoholic beverage, the Scotch-like alcoholic beverage can by any of the Scotch-like alcoholic beverages described herein.

In another aspect, this document also provides a Scotch-like alcoholic beverage concentrate containing ethanol, water, and one or more non-volatile compounds, wherein at least one of the one or more non-volatile compounds is present in a concentration of at least about 2-fold the concentration of the same non-volatile compound in a corresponding traditional Scotch. The one or more non-volatile compounds can include at least one non-volatile compound that is not present in a corresponding traditional Scotch. The one or more non-volatile compounds can exclude least one non-volatile compound that is present in a corresponding traditional Scotch. The Scotch-like alcoholic beverage concentrate can further include one or more additional VOCs, and wherein the one or more additional VOCs include at least one VOC that is not present in a corresponding traditional Scotch. The Scotch-like alcoholic beverage concentrate can further include one or more additional VOCs, and wherein the one or more additional VOCs exclude at least one VOC that is present in a corresponding traditional Scotch. The one or more non-volatile compounds can be present in the concentrate in a concentration of at least about 5-fold the concentration of the same non-volatile compound in a corresponding traditional Scotch. The one or more non-volatile compounds can be present in the concentrate in a concentration of at least about 10-fold the concentration of the same non-volatile compound in a corresponding traditional Scotch. The one or more non-volatile compounds can be present in the concentrate in a concentration of at least about 15-fold the concentration of the same non-volatile compound in a corresponding traditional Scotch. The one or more non-volatile compounds can be present in the concentrate in a concentration of at least about 20-fold the concentration of the same non-volatile compound in a corresponding traditional Scotch. The concentrate can include five or more non-volatile compounds, wherein at least five of the five or more additional non-volatile compounds are present in a concentration of at least about 5-fold the concentration of the same non-volatile compounds in a corresponding traditional Scotch. The total amount (in mg/L) of the one or more non-volatile compounds in the concentrate can be greater than 5-fold the total amount of the same non-volatile compounds (in mg/L) in a corresponding traditional Scotch. Upon dilution of the Scotch-like alcoholic beverage concentrate to a Scotch-like alcoholic beverage, the Scotch-like alcoholic beverage can be any of the Scotch-like alcoholic beverages described herein.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and from the claims.

### DETAILED DESCRIPTION

This document provides Scotch-like alcoholic beverages (also referred to as “Scotch replicas”), as well as methods for making Scotch-like alcoholic beverages by combining water and ethanol with individual VOCs and non-volatile organic compounds. The Scotch-like alcoholic beverages described herein have characteristics—including taste, aroma, mouthfeel, and appearance—of traditionally produced Scotches, and are meant to be consumed and enjoyed in the same manner as traditional Scotches.

As used herein, the terms “traditional” and “reference” Scotch refer to Scotch produced through standard distilling processes, which include the fermentation of grains such as barley, rye, corn, and wheat.

The following standards of identity for traditionally produced whiskeys and spirits are set forth in 27 C.F.R. § 5.22.

A “neutral spirit” or “alcohol” is a distilled spirit produced from any material at or above 190° proof, and, if bottled, bottled at not less than 80° proof. A “grain spirit” is a neutral spirit distilled from a fermented mash of grain and stored in an oak container.

A “whisky” is an alcoholic distillate from a fermented mash of grain produced at less than 190° proof in such a manner that the distillate possesses the taste, aroma, and characteristics generally attributed to whisky, stored in oak containers (except that corn whisky need not be so stored), and bottled at not less than 80° proof, and also includes mixtures of such distillates for which no specific standards of identity are prescribed.

A “bourbon whisky,” “rye whisky,” “wheat whisky,” “malt whisky,” or “rye malt whisky” is a whisky produced at not exceeding 160° proof from a fermented mash of not less than 51 percent corn, rye, wheat, malted barley, or malted rye grain, respectively, and stored at not more than 125° proof in charred new oak containers. “Corn whisky” is whisky produced at not exceeding 160° proof from a fermented mash of not less than 80 percent corn grain, and if stored in oak containers, stored at not more than 125° proof in used or uncharred new oak containers and not subjected in any manner to treatment with charred wood. Whiskies conforming to the above standards, which have been stored in the type of oak containers prescribed for a period of 2 years or more, are designated as “straight” whiskies. “Straight whisky” includes mixtures of straight whiskies of the same type produced in the same State.

“Whisky distilled from bourbon (rye, wheat, malt, or rye malt) mash” is whisky produced in the United States at not exceeding 160° proof from a fermented mash of not less than 51 percent corn, rye, wheat, malted barley, or malted rye grain, respectively, and stored in used oak containers, and also includes mixtures of such whiskies of the same type. Whisky conforming to the standard of identity for corn whisky must be designated corn whisky.

A “Scotch whisky” is whisky that is a distinctive product of Scotland, manufactured in Scotland in compliance with the laws of the United Kingdom regulating the manufacture of Scotch whisky for consumption in the United Kingdom.

“Irish whisky” is whisky which is a distinctive product of Ireland, manufactured either in the Republic of Ireland or in Northern Ireland, in compliance with their laws regulating the manufacture of Irish whisky for home consumption, provided that if such product is a mixture of whiskies, such mixture is “blended Irish whisky” (Irish whisky—a blend).

“Canadian whisky” is whisky that is a distinctive product of Canada, manufactured in Canada in compliance with the laws of Canada regulating the manufacture of Canadian whisky for consumption in Canada, provided that if such product is a mixture of whiskies, such mixture is “blended Canadian whisky” (Canadian whisky—a blend).

A “spirit whisky” is a mixture of neutral spirits and is not less than 5 percent on a proof gallon basis of whisky, or straight whisky, or straight whisky and whisky, if the straight whisky component is less than 20 percent on a proof gallon basis.

“Light whisky” is whisky produced in the United States at more than 160° proof, on or after Jan. 26, 1968, and stored in used or uncharred new oak containers, and also includes mixtures of such whiskies. If “light whisky” is mixed with less than 20 percent of straight whisky on a proof gallon basis, the mixture shall be designated “blended light whisky” (light whisky—a blend).

“Blended whisky” (whisky—a blend) is a mixture that contains straight whisky or a blend of straight whiskies at not less than 20 percent on a proof gallon basis, excluding alcohol derived from added harmless coloring, flavoring or blending materials, and, separately, or in combination, whisky or neutral spirits. A blended whisky containing not less than 51 percent on a proof gallon basis of one of the types of straight whisky shall be further designated by that specific type of straight whisky; for example, “blended rye whisky” (rye whisky—a blend).

“A blend of straight whiskies” (blended straight whiskies) is a mixture of straight whiskies that does not conform to the standard of identify for “straight whisky.” Products so designated may contain harmless coloring, flavoring, or blending materials as set forth in 27 CFR 5.23(a).

“A blend of straight whiskies” (blended straight whiskies) consisting entirely of one of the types of straight whisky, and not conforming to the standard for straight whisky, shall be further designated by that specific type of straight whisky; for example, “a blend of straight rye whiskies” (blended straight rye whiskies). “A blend of straight whiskies” consisting entirely of one of the types of straight whisky shall include straight whisky of the same type which was produced in the same State or by the same proprietor within the same State, provided that such whisky contains harmless coloring, flavoring, or blending materials as stated in 27 CFR 5.23(a).

The harmless coloring, flavoring, or blending materials allowed under this section shall not include neutral spirits or alcohol in their original state. Neutral spirits or alcohol may only appear in a “blend of straight whiskies” or in a “blend of straight whiskies consisting entirely of one of the types of straight whisky” as a vehicle for recognized flavoring of blending material.

In some embodiments, a Scotch replica can include a traditional whiskey, such that the Scotch replica can be considered a “spirit whiskey” as defined above. In such embodiments, about (and not less than) 5 percent of the ethanol in the Scotch replica, on a proof gallon basis, can be from, for example, a neutral spirit such as corn whiskey. For example, 5% to 10% (e.g., 5% to 6%, 6% to 7%, 7% to 8%, 8% to 9%, or 9% to 10%) of the ethanol in a Scotch replica that is a spirit whiskey, on a proof gallon basis, can be from a traditional neutral spirit.

A “proof gallon” is one liquid gallon of spirits that is 50% alcohol at 60° F. Thus, for example, a distilled spirit bottled at 80 proof (40% alcohol) would be 0.8 proof gallons per gallon of liquid. An 80 proof spirit Scotch replica containing 5% ethanol from a traditional whiskey on a proof gallon basis therefore would contain 0.8×0.05=0.04 proof gallon=1 gallon of 4 proof=2% alcohol by volume (ABV) from the traditional whiskey.

The Scotch replicas described herein can contain particular volatile and non-volatile organic compounds. The terms “contain,” “include,” “comprise” are used herein to indicate that a compound is present in a Scotch replica in an amount that is detectable using the methods described herein. The terms “lacks,” “does not contain,” “does not include,” and “does not comprise” are used herein to indicate that a compound is not detectable in a Scotch replica by the methods described herein. The Scotch replicas provided herein can be distinguished from traditional Scotches based on the combination of VOCs and non-volatile organic compounds contained or not contained therein, and/or based on the amounts of particular VOCs or non-volatile organic compounds contained therein.

In some embodiments, a Scotch replica can consist of the ingredients included in a particular list, or can have a VOC content (or non-volatile compound content) that consists of the VOCs or non-volatile compounds included in a particular list. Further, a Scotch replica can consist essentially of the ingredients included in a particular list, or can have a VOC content (or non-volatile compound content) that consists essentially of the VOCs or non-volatile compounds that are included in a particular list. By “consisting essentially of” is meant that a Scotch replica contains specified ingredients/VOCs/non-volatile compounds, and can contain additional ingredients/VOCs/non-volatile compounds that do not materially affect the basic and novel characteristics of the Scotch.

Various formulations for Scotch replicas are described herein. In general, the Scotch replicas include the following components, or classes of components:

a) a source of water, either pure or with mineral content present to improve flavor;

b) a source of ethanol (e.g., a distilled or fermented ethanol) with a concentration between about 20% and 100% weight by volume;

c) one or more additional VOCs; and

d) one or more non-volatile compounds.

Water is the main component of the Scotch replicas, acting as a solvent for all the other ingredients. The ethanol component provides the alcoholic content. The VOCs can provide both aroma and flavor, including fruity, floral, earthy, herbaceous, oak, yeast, spice, and/or mineral aromas and flavors. The non-volatile components can provide acidity and much of the flavor, aftertaste, and mouthfeel perception of the Scotch replicas.

In some embodiments, a Scotch-like alcoholic beverage can include water, ethanol, and (a) one or more additional VOCs (i.e., VOCs in addition to ethanol), where the one or more additional VOCs are not present in a corresponding reference Scotch; (b) one or more additional VOCs, where the one or more additional VOCs do not include one or more VOCs that are present in a corresponding reference Scotch; (c) one or more non-volatile compounds, where the one or more non-volatile compounds are not present in a corresponding reference Scotch; (d) one or more non-volatile compounds, where the one or more non-volatile compounds do not include one or more non-volatile compounds that are present in a corresponding reference Scotch; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)].

In general, the Scotch replicas provided herein can have an ethanol content that ranges from about 30% v/v to about 80% v/v (e.g., about 30%, about 40%, about 43%, about 46%, about 49%, about 50%, about 55%, about 60%, about 65%, about 70%, about 30 to 40%, about 40 to 45%, about 45 to 50%, about 50 to 55%, about 55 to 60%, about 60 to 65%, about 65 to 70%, or about 70 to 80% v/v).

It is to be noted, however, that the ethanol component can be omitted in order to generate a “non-alcoholic” version of a Scotch replica. In such ethanol-free embodiments, the ethanol can essentially be replaced by water, although it is noted that adjustments to the amounts of the additional VOCs and non-volatile components may require adjustment to produce a Scotch replica with the “feel” of traditional Scotch.

The additional VOCs present in a Scotch replica can include compounds that fall into several categories, including esters, acids, alcohols, aldehydes/ketones, terpenes/isoprenoids, phenols, lactones, amines/pyrazines, sulfur-containing compounds (e.g., thiols, thiazoles, and/or sulfides), ethers, furans, and/or acetals. In some embodiments, for example, a Scotch replica can contain VOCs that include an ester, an acid, an alcohol in addition to the ethanol, an aldehyde, ketone, or both, a terpene, isoprenoid, or both, a phenol, a lactone, and an amine, pyrazine, or both.

Esters, including ethyl, methyl, and acetate esters, can contribute fruity and floral characteristics to an alcoholic beverage. In some embodiments, esters that can be used in a Scotch replica include, without limitation, one or more of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl succinate, ethyl acetate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl salicylate, ethyl undecanoate, ethyl valerate, ethyl-2-methylbutyrate, isoamyl acetate, isoamyl hexanoate, isoamyl octanoate, isobutyl acetate, linalyl acetate, methyl decanoate, methyl hexanoate, methyl laurate, methyl octanoate, methyl salicylate, phenethyl butyrate, phenethyl octanoate, diethyl malate, ethyl 3-hydroxyhexanoate, ethyl benzoate, ethyl levulinate, phenethyl formate, propyl acetate, ethyl-trans-2-butenoate, ethyl-trans-3-hexenoate, ethyl(methylthio) acetate, heptyl acetate, isoamyl isobutyrate, isoamyl isovalerate, isobutyl isobutyrate, methyl acetate, phenethyl propionate, and any combination thereof. In some embodiments, esters that can be used in a Scotch replica include, without limitation, 2-methylbutyl acetate, 2-methylbutyl isovalerate, 2-phenylethylacetate, 3-methylthio hexyl acetate, allyl heptanoate, amyl butyrate, anisyl acetate, anisyl butyrate, benzyl acetate, benzyl benzoate, benzyl butyrate, benzyl formate, benzyl propionate, butyl acetate, butyl butyryllactate, butyl formate, butyl isovalerate, cis-3-hexenyl acetate, cis-3-hexenyl butyrate, cis-3-hexenyl valerate, diethyl malate, diethyl succinate, ethyl 2-trans-4-cis-decadienoate, ethyl 3-hydroxyhexanoate, ethyl acetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl trans-2-butenoate, ethyl trans-3-hexenoate, ethyl undecanoate, ethyl valerate, ethyl(methylthio) acetate, ethyl-2-methylbutyrate, heptyl acetate, hexyl 3-methylbutanoate, hexyl acetate, hexyl isobutyrate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl isobutyrate, isobutyl propionate, linalyl acetate, methionyl acetate (3-methylthio-propylacetate), methyl acetate, methyl anthranilate, methyl benzoate, methyl cinnamate, methyl decanoate, methyl hexanoate, methyl laurate, methyl octanoate, methyl salicylate, phenethyl 2-methylbutyrate, phenethyl butyrate, phenethyl formate, phenethyl octanoate, phenethyl propionate, phenethyl tiglate, propyl acetate, propyl butyrate, propyl isovalerate, and any combination thereof. The ester(s) can make up any suitable proportion of the additional VOC content. In some embodiments, for example, the ester(s) can make up about 0.25% to about 95% (e.g., about 0.25% to about 1%, about 1% to about 2%, about 2% to about 5%, about 5% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more esters. In some embodiments, for example, at least about 24% (e.g., at least about 25%, 26%, 27%, 28%, 29%, 30%, 31%, 33%, 35%, 38%, 40%, 43%, 45%, 48%, 50%, 53%, 55%, 58%, or 60%) by mass of the additional VOCs can comprise one or more esters. In some embodiments, for example, less than about 1.9% (e.g., less than about 1.3%, 1.2%, 1.1%, or 1.0%) by mass of the additional VOCs can comprise one or more esters.

Acids may contribute to “sour” or “fermented” aromas that may be important to the general character of an alcoholic beverage. In some embodiments, acids that can be included in a Scotch replica include, without limitation, 3,7-dimethyl-6-octenoic acid, butyric acid, decanoic acid, isobutyric acid, octanoic acid, propionic acid, isovaleric acid, valeric acid, hexanoic acid, nonanoic acid, and any combination thereof. The acid(s) can make up any suitable proportion of the additional VOC content. In some embodiments, for example, the acid(s) can make up about 0.0003% to about 37% (e.g., about 0.0003% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, about 2% to about 5%, about 5% to about 10%, about 10% to about 15%, about 15% to about 20%, about 20% to about 25%, about 25% to about 30%, about 30% to about 35%, or about 35% to about 37%) by mass of the additional VOCs can comprise one or more acids. In some embodiments, for example, at least about 0.0003% (e.g., at least about 0.0005%, 0.001%, 0.005%, 0.01%, 0.05%, 0.1%, 0.5%, 1%, 2%, 3%, 4%, 5%, 6%, 7%, 8%, 10%, 12%, 15%, 16%, 18%, 20%, 22%, 24%, 26%, or 28% by mass of the additional VOCs can comprise one or more acids. In some embodiments, the additional VOCs can comprise no acids.

Alcohols can provide various flavor components to alcoholic beverages, including banana, spice, grassiness, and oxidized characteristics. Higher alcohols also can be important for adding roundness to the general aroma of an alcoholic beverage, as well as some weight on the palate. In some embodiments, alcohols that can be present in the Scotch replicas provided herein include, without limitation, 1-octanol, butanol, 2-nonanol, 2-phenylethanol, butyl alcohol, cis-3-hexen-1-ol, 1-decanol, 1-octen-3-ol, amyl alcohol, butanol, hexanol, isoamyl alcohol, isobutanol, propanol, and any combination thereof. In some embodiments, alcohols that can be present in the Scotch replicas provided herein include, without limitation, 1-decanol, 1-octanol, 1-octen-3-ol, 2-heptanol, 2-methyl-1-butanol, 2-nonanol, 2-phenylethanol, amyl alcohol, benzyl alcohol, butanol, butyl alcohol, cis-3-hexen-1-ol, cis-5-octen-1-ol, cis-6-nonen-1-ol, DL-3-methyl-2-butanol, hexanol, isoamyl alcohol, isobutanol, propanol, and any combination thereof. The alcohol(s) can make up any suitable proportion of the additional VOC content. In some embodiments, for example, about 10% to about 99% (e.g., about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more alcohols. In some embodiments, at least about 28% (e.g., about 30%, 32%, 34%, 36%, 38%, 40%, 42%, or 44%) by mass of the additional VOCs can comprise one or more alcohols.

Aldehydes and ketones also can provide flavors that are important to the general character of an alcoholic beverage. For example, acetaldehyde is a by-product of alcoholic fermentation that gives a vinous and oxidized aroma, diacetyl is a by-product of malolactic fermentation that provides a buttery flavor, and sotolon can provide a maple-like scent. In some embodiments, aldehydes/ketones that can be used in the Scotch replicas provided herein can include, without limitation, 1,1-diethoxyethane, 2,3-pentadione, 2-methylbutyraldehyde, 2-nonanone, 2-undecanone, acetaldehyde, acetoin, benzaldehyde, cinnamaldehyde, damascenone, furfural, isovaleraldehyde, maltol, nonanal, trans-2-hexen-1-al, isobutyraldehyde, salicylaldehyde, 2-heptanone, acetophenone, methional, valeraldehyde, propionaldehyde, p-anisaldehyde, butyraldehyde, and any combination thereof. In some embodiments, aldhdyes/ketones that can be used in the Scotch replicas provided herein can include, without limitation, 3-ethyl-2-hydroxy-2-cyclopenten-1-one (ethyl cyclopentenolone), 1,1-diethoxyethane, 2,3-pentadione, 2-acetyl-1-methylpyrrole, 2-heptanone, 2-methylbutyraldehyde, 2-nonanone, 2-undecanone, 3-phenylpropanal, 5-methyl-2-phenyl-2-hexenal, 6-methyl-5-hepten-2-one, acetaldehyde, acetoin, acetophenone, benzaldehyde, butyraldehyde, cinnamaldehyde, cuminaldehyde, damascenone, decanal, furfural, isobutyraldehyde, isovaleraldehyde, maltol, methional, methyl beta-naphthyl ketone, methyl cyclopentenolone, methyl-2-pyrrolyl ketone, nonanal, octanal, p-anisaldehyde, phenylacetaldehyde, propionaldehyde, salicylaldehyde, trans-2-hexen-1-al, valeraldehyde, and any combination thereof. The aldehyde(s)/ketone(s) can make up any suitable proportion of the additional VOC content. In some embodiments, for example, about 0.0005% to about 23% (e.g., about 0.0005% to about 0.001%, about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, about 2% to about 5%, about 5% to about 10%, about 10% to about 15%, about 15% to about 20%, about 20% to about 25%, about 25% to about 30%, about 30% to about 32%, or about 25% to about 32%) by mass of the additional VOCs can comprise one or more aldehydes and/or ketones. In some embodiments, no more than about 0.0045% (e.g., about 0.004%, 0.003%, 0.002%, or 0.001%) by mass of the additional VOCs can comprise one or more aldehydes and/or ketones. In some embodiments, at least about 7.8% (e.g., 8%, 9%, 10%, 13%, 15%, 18%, 20%, 23%, or 25%) by mass of the additional VOCs can comprise one or more aldehydes and/or ketones.

Terpenes and isoprenoids can contribute various floral and green characteristics to an alcoholic beverage. In some embodiments, terpenes and isoprenoids that can be included in the Scotch replicas provided herein include, without limitation, 3-carene, 4-carvomenthenol, 4-ethylguaiacol, alpha ionone, a-phellandrene, (−)alpha-pinene, a-terpineol, beta-ionone, (−)beta-pinene, carvone, (−)cis-rose-oxide, citronellol, gamma-terpinene, limonene, linalool, linalool oxide, myrcene, myrtenol, p-cymene, farnesol, geraniol, geranyl acetone, eucalyptol, and any combination thereof. In some embodiments, terpenes and isoprenoids that can be included in the Scotch replicas provided herein include, without limitation, (1R)-(−)-myrtenal, 1,4-cineole, 3-carene, 4,5,6,7-tetrahydro-3,6-dimethylbenzofuran, 4-carvomenthenol, 4-ethyl guaiacol, alpha ionone, a-phellandrene, a-pinene, a-terpineol, b-caryophellene, beta-ionone, beta-pinene, carvacrol, carvone, cis-rose oxide, citral, citronellal, citronellol, D-camphor, D-carvone, d-fenchone, eucalyptol, farnesol, gamma-terpinene, geraniol, geranyl acetone undacadien, limonene, linalool, linalool oxide, L-menthyl acetate, myrcene, myrtenol, nerolidol, p,a-dimethyl styrene, p-cymene, perillaldehyde, tetrahydrolinalool, thymol, valencene, and any combination thereof. The terpene(s)/isoprenoid(s) can make up any suitable proportion of the additional VOC content. In some embodiments, for example, about 0.0003% to about 12% by mass (e.g., about 0.0003% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, about 2% to about 4%, about 4% to about 6%, about 6% to about 8%, about 8% to about 10%, or about 10% to about 12%) by mass of the additional VOCs can comprise one or more terpenes/isoprenoids. In some embodiments, at least about 0.07% (e.g., at least about 0.1%, 0.2%, 0.3%, 0.4%, 0.5%, 0.6%, 0.7%, 0.8%, 0.9%, 1%, 1.2%, or 1.5%) by mass of the additional VOCs can comprise one or more terpenes/isoprenoids. In some embodiments, less than about 0.009% (e.g., less than about 0.008%, 0.007%, 0.006%, 0.005%, 0.004%, 0.003%, 0.002%, 0.001%, 0.0008%, or 0.0005%) by mass of the additional VOCs can comprise one or more terpenes/isoprenoids.

Phenols can contribute to the smoky characteristics that may be found in alcoholic beverages as a result of oak exposure, and they also can contribute earthy characteristics. In some embodiments, phenols that can be used in the Scotch replicas described herein can include, without limitation, 2-methoxy-4-propylphenol, 4-ethylphenol, eugenol, guaiacol, p-cresol, and any combination thereof. In some embodiments, phenols that can be used in the Scotch replicas described herein can include, without limitation, 2,4,6-trimethylphenol (mesitol), 2-methoxy-4-methylphenol (creosol), 2-methoxy-4-propylphenol, 4-ethyl phenol, eugenol, guaiacol, isoeugenol, p-cresol, and any combination thereof. The phenol(s) can make up any suitable proportion of the additional VOC content. In some embodiments, about 0.0001% to about 2.6% (e.g., about 0.0001% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.5%, about 0.5% to about 1.0%, about 1.0% to about 1.5%, about 1.5% to about 2.0%, about 2.0% to about 2.5%, or about 2.0% to about 2.6%) by mass of the additional VOCs can comprise one or more phenols. In some embodiments, for example, at least about 1.1% (e.g., at least about 1.2%, 1.3%, 1.4%, 1.5%, 1.6%, 1.7%, 1.8%, 1.9%, or 2.0%) by mass of the additional VOCs can comprise one or more phenols. In some embodiments, less than about 0.0015% (e.g., less than about 0.0014%, 0.0013%, 0.0012%, 0.0011%, 0.0010%, 0.0009%, 0.0008%, 0.0007%, 0.0006%, 0.0005%, 0.0004%, 0.0003%, or 0.0002%) by mass of the additional VOCs can comprise one or more phenols. In some embodiments, for example, the additional VOCs can comprise no phenols.

Lactones are mainly found in alcoholic beverages that have been exposed to oak, which is standard for whiskeys such as bourbon and Scotch, although lactones also may be present in other whiskey varieties. In some embodiments, lactones that can be included in the Scotch replicas provided herein include delta-decalactone, gamma-decalactone, whiskey lactone, gamma-nonalactone, and any combination thereof. In some embodiments, lactones that can be included in the Scotch replicas provided herein include delta-decalactone, delta-dodecalactone, gamma-decalactone, gamma-dodecalactone, gamma-heptalactone, gamma-hexalactone, gamma-nonalactone, gamma-octalactone, gamma-undecalactone, gamma-valerolactone, massoia lactone, omega-pentadecalactone, whiskey lactone, and any combination thereof. The lactone(s) can make up any suitable proportion of the additional VOC content. In some embodiments, for example, about 0.004% to about 6% (e.g., about 0.004% to about 0.01%, about 0.005% to about 0.01%, about 0.01% to about 0.05%, about 0.05% to about 0.1%, about 0.1% to about 0.5%, about 0.5% to about 1%, about 1% to about 2%, about 2% to about 3%, about 3% to about 4%, about 4% to about 5%, or about 5% to about 6%) by mass of the additional VOCs can comprise one or more lactones. In some embodiments, for example, at least about 2.3% (e.g., at least 2.4%, 2.5%, 2.6%, 2.7%, 2.8%, 2.9%, 3.0%, 3.5%, or 4.0%) by mass of the additional VOCs can comprise one or more lactones. In some embodiments, the additional VOCs can include no lactones.

Amines and pyrazines can contribute unique characteristics to alcoholic beverages. Pyrazines, for example, can contribute green bell pepper flavors. In some embodiments, an example of an amine or pyrazine that can be used in a Scotch replica as provided herein is 2-isopropyl-3-methoxypyrazine. In some embodiments, amines or pyrazines that can be included in the Scotch replicas provided herein include 2-ethyl-3-methylpyrazine, 2-isopropyl-3-methoxypyrazine, 2-methoxy-3-(1-methylpropyl) pyrazine, IBMP (3-isobutyl-2-methoxypyrazine), indole, and any combination thereof. The amine(s)/pyrazine(s) can make up any suitable proportion of the additional VOC content. For example, about 0.000004% to about 0.003% (e.g., about 0.000004% to about 0.00001%, about 0.000005% to about 0.00001%, about 0.00001% to about 0.00005%, about 0.00005% to about 0.0001%, about 0.0001% to about 0.0005%, about 0.0005% to about 0.001%, or about 0.001% to about 0.003%) by mass of the additional VOCs can comprise one or more amines and/or pyrazines. In some embodiments, the additional VOCs can include no amines or pyrazines.

Sulfur-containing compounds (e.g., thiols, thiazoles, and/or sulfides) also can contribute to the signature flavors of alcoholic beverages. In some embodiments, a sulfur-containing compound that may be included in the Scotch replicas provided herein is dimethyl sulfide. In some embodiments, sulfur-containing compounds that may be included in the Scotch replicas provided herein include, without limitation, 1-para-menthene-8-thiol, 2-isopropyl-4-methyl thiazole, 4-mercapto-4-methyl-2-pentanone, dimethylsulfide, and furufyl thioacetate. The sulfur-containing compound(s) can make up any suitable proportion of the additional VOC content. In some embodiments, for example, about 0.00000003% to about 0.009% (e.g., about 0.00000003% to about 0.0000001%, about 0.0000001% to about 0.000001%, about 0.000001% to about 0.00001%, about 0.00001% to about 0.0001%, about 0.0001% to about 0.0005%, about 0.0005% to about 0.001%, about 0.001% to about 0.005%, or about 0.005% to about 0.009%) by mass of the additional VOCs can comprise one or more sulfur-containing compounds (e.g., thiols, thiazoles, and/or sulfides). In some embodiments, at least about 0.0000085% (e.g., at least about 0.000009%, 0.00001%, 0.00005%, 0.0001%, 0.0003%, 0.0005%, 0.0007%, 0.0009%, 0.001%, 0.002%, 0.003%, 0.004%, 0.005%, 0.006%, 0.007%, or 0.008%) by mass of the additional VOCs can comprise the one or more sulfur-containing compounds. In some embodiments, the additional VOCs can include no sulfur compounds.

Ethers also can contribute to the signature flavors of alcoholic beverages. Non-limiting examples of ethers that may be included in the Scotch replicas provided herein are vanillyl ethyl ether and vanillyl butyl ether. The ether(s) can make up any suitable proportion of the additional VOC content. In some embodiments, for example, about 0.00003% to about 0.09% (e.g., about 0.00003% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.03%, about 0.03% to about 0.05%, about 0.05% to about 0.07%, or about 0.07% to about 0.09%) by mass of the additional VOCs can comprise one or more ethers. In some embodiments, for example, at least about 0.02% (e.g., at least about 0.03%, 0.04%, 0.05%, or 0.06%) by mass of the additional VOCs can comprise one or more ethers. In some embodiments, the additional VOCs can include no ethers.

Furans can also contribute to the signature flavors of alcoholic beverages. A non-limiting example of a furan that can be included in the Scotch replicas provided herein is 2-pentyl furan. The furan(s) can make up any suitable proportion of the additional VOC content. In some embodiments, the additional VOCs can include no furans.

Acetals can also contribute to the signature flavors of alcoholic beverages. A non-limiting example of an acetal that can be included in the Scotch replicas provided herein is phenylacetaldehyde dimethyl acetal. The acetal(s) can make up any suitable proportion of the additional VOC content. In some embodiments, the additional VOCs can include no acetals.

In some embodiments, a Scotch replica can include one or more (e.g., one, two, three, four, five, six, or all seven) additional VOCs selected from the group consisting of butyl formate, ethyl octanoate, ethyl propionate, ethyl-2-methylbutyrate, isoamyl acetate, isoamyl alcohol, and isobutanol.

For example, in some cases, a Scotch-like alcoholic beverage can include two compounds selected from the group consisting of butyl formate, ethyl octanoate, ethyl propionate, ethyl-2-methylbutyrate, isoamyl acetate, isoamyl alcohol, and isobutanol, where the two compounds are butyl formate and ethyl octanoate; butyl formate and ethyl propionate; butyl formate and ethyl-2-methylbutyrate; butyl formate and isoamyl acetate; butyl formate and isoamyl alcohol; butyl formate and isobutanol; ethyl octanoate and ethyl propionate; ethyl octanoate and ethyl-2-methylbutyrate; ethyl octanoate and isoamyl acetate; ethyl octanoate and isoamyl alcohol; ethyl octanoate and isobutanol; ethyl propionate and ethyl-2-methylbutyrate; ethyl propionate and isoamyl acetate; ethyl propionate and isoamyl alcohol; ethyl propionate and isobutanol; ethyl-2-methylbutyrate and isoamyl acetate; ethyl-2-methylbutyrate and isoamyl alcohol; ethyl-2-methylbutyrate and isobutanol; isoamyl acetate and isoamyl alcohol; isoamyl acetate and isobutanol; or isoamyl alcohol and isobutanol.

In some cases, a Scotch-like alcoholic beverage can include three compounds selected from the group consisting of butyl formate, ethyl octanoate, ethyl propionate, ethyl-2-methylbutyrate, isoamyl acetate, isoamyl alcohol, and isobutanol. The three compounds can be butyl formate, ethyl octanoate, and ethyl propionate; butyl formate, ethyl octanoate, and ethyl-2-methylbutyrate; butyl formate, ethyl octanoate, and isoamyl acetate; butyl formate, ethyl octanoate, and isoamyl alcohol; butyl formate, ethyl octanoate, and isobutanol; butyl formate, ethyl propionate, and ethyl-2-methylbutyrate; butyl formate, ethyl propionate, and isoamyl acetate; butyl formate, ethyl propionate, and isoamyl alcohol; butyl formate, ethyl propionate, and isobutanol; butyl formate, ethyl-2-methylbutyrate, and isoamyl acetate; butyl formate, ethyl-2-methylbutyrate, and isoamyl alcohol; butyl formate, ethyl-2-methylbutyrate, and isobutanol; butyl formate, isoamyl acetate, and isoamyl alcohol; butyl formate, isoamyl acetate, and isobutanol; butyl formate, isoamyl alcohol, and isobutanol; ethyl octanoate, ethyl propionate, and ethyl-2-methylbutyrate; ethyl octanoate, ethyl propionate, and isoamyl acetate; ethyl octanoate, ethyl propionate, and isoamyl alcohol; ethyl octanoate, ethyl propionate, and isobutanol; ethyl octanoate, ethyl-2-methylbutyrate, and isoamyl acetate; ethyl octanoate, ethyl-2-methylbutyrate, and isoamyl alcohol; ethyl octanoate, ethyl-2-methylbutyrate, and isobutanol; ethyl octanoate, isoamyl acetate, and isoamyl alcohol; ethyl octanoate, isoamyl acetate, and isobutanol; ethyl octanoate, isoamyl alcohol, and isobutanol; ethyl propionate, ethyl-2-methylbutyrate, and isoamyl acetate; ethyl propionate, ethyl-2-methylbutyrate, and isoamyl alcohol; ethyl propionate, ethyl-2-methylbutyrate, and isobutanol; ethyl propionate, isoamyl acetate, and isoamyl alcohol; ethyl propionate, isoamyl acetate, and isobutanol; ethyl propionate, isoamyl alcohol, and isobutanol; ethyl-2-methylbutyrate, isoamyl acetate, and isoamyl alcohol; ethyl-2-methylbutyrate, isoamyl acetate, and isobutanol; ethyl-2-methylbutyrate, isoamyl alcohol, and isobutanol; or isoamyl acetate, isoamyl alcohol, and isobutanol.

In some cases, a Scotch-like alcoholic beverage can include four compounds selected from the group consisting of butyl formate, ethyl octanoate, ethyl propionate, ethyl-2-methylbutyrate, isoamyl acetate, isoamyl alcohol, and isobutanol. The four compounds can be butyl formate, ethyl octanoate, ethyl propionate, and ethyl-2-methylbutyrate; butyl formate, ethyl octanoate, ethyl propionate, and isoamyl acetate; butyl formate, ethyl octanoate, ethyl propionate, and isoamyl alcohol; butyl formate, ethyl octanoate, ethyl propionate, and isobutanol; butyl formate, ethyl octanoate, ethyl-2-methylbutyrate, and isoamyl acetate; butyl formate, ethyl octanoate, ethyl-2-methylbutyrate, and isoamyl alcohol; butyl formate, ethyl octanoate, ethyl-2-methylbutyrate, and isobutanol; butyl formate, ethyl octanoate, isoamyl acetate, and isoamyl alcohol; butyl formate, ethyl octanoate, isoamyl acetate, and isobutanol; butyl formate, ethyl octanoate, isoamyl alcohol, and isobutanol; butyl formate, ethyl propionate, ethyl-2-methylbutyrate, and isoamyl acetate; butyl formate, ethyl propionate, ethyl-2-methylbutyrate, and isoamyl alcohol; butyl formate, ethyl propionate, ethyl-2-methylbutyrate, and isobutanol; butyl formate, ethyl propionate, isoamyl acetate, and isoamyl alcohol; butyl formate, ethyl propionate, isoamyl acetate, and isobutanol; butyl formate, ethyl propionate, isoamyl alcohol, and isobutanol; butyl formate, ethyl-2-methylbutyrate, isoamyl acetate, and isoamyl alcohol; butyl formate, ethyl-2-methylbutyrate, isoamyl acetate, and isobutanol; butyl formate, ethyl-2-methylbutyrate, isoamyl alcohol, and isobutanol; butyl formate, isoamyl acetate, isoamyl alcohol, and isobutanol; ethyl octanoate, ethyl propionate, ethyl-2-methylbutyrate, and isoamyl acetate; ethyl octanoate, ethyl propionate, ethyl-2-methylbutyrate, and isoamyl alcohol; ethyl octanoate, ethyl propionate, ethyl-2-methylbutyrate, and isobutanol; ethyl octanoate, ethyl propionate, isoamyl acetate, and isoamyl alcohol; ethyl octanoate, ethyl propionate, isoamyl acetate, and isobutanol; ethyl octanoate, ethyl propionate, isoamyl alcohol, and isobutanol; ethyl octanoate, ethyl-2-methylbutyrate, isoamyl acetate, and isoamyl alcohol; ethyl octanoate, ethyl-2-methylbutyrate, isoamyl acetate, and isobutanol; ethyl octanoate, ethyl-2-methylbutyrate, isoamyl alcohol, and isobutanol; ethyl octanoate, isoamyl acetate, isoamyl alcohol, and isobutanol; ethyl propionate, ethyl-2-methylbutyrate, isoamyl acetate, and isoamyl alcohol; ethyl propionate, ethyl-2-methylbutyrate, isoamyl acetate, and isobutanol; ethyl propionate, ethyl-2-methylbutyrate, isoamyl alcohol, and isobutanol; ethyl propionate, isoamyl acetate, isoamyl alcohol, and isobutanol; or ethyl-2-methylbutyrate, isoamyl acetate, isoamyl alcohol, and isobutanol.

In some cases, a Scotch-like alcoholic beverage can include five compounds selected from the group consisting of butyl formate, ethyl octanoate, ethyl propionate, ethyl-2-methylbutyrate, isoamyl acetate, isoamyl alcohol, and isobutanol. The five compounds can be butyl formate, ethyl octanoate, ethyl propionate, ethyl-2-methylbutyrate, and isoamyl acetate; butyl formate, ethyl octanoate, ethyl propionate, ethyl-2-methylbutyrate, and isoamyl alcohol; butyl formate, ethyl octanoate, ethyl propionate, ethyl-2-methylbutyrate, and isobutanol; butyl formate, ethyl octanoate, ethyl propionate, isoamyl acetate, and isoamyl alcohol; butyl formate, ethyl octanoate, ethyl propionate, isoamyl acetate, and isobutanol; butyl formate, ethyl octanoate, ethyl propionate, isoamyl alcohol, and isobutanol; butyl formate, ethyl octanoate, ethyl-2-methylbutyrate, isoamyl acetate, and isoamyl alcohol; butyl formate, ethyl octanoate, ethyl-2-methylbutyrate, isoamyl acetate, and isobutanol; butyl formate, ethyl octanoate, ethyl-2-methylbutyrate, isoamyl alcohol, and isobutanol; butyl formate, ethyl octanoate, isoamyl acetate, isoamyl alcohol, and isobutanol; butyl formate, ethyl propionate, ethyl-2-methylbutyrate, isoamyl acetate, and isoamyl alcohol; butyl formate, ethyl propionate, ethyl-2-methylbutyrate, isoamyl acetate, and isobutanol; butyl formate, ethyl propionate, ethyl-2-methylbutyrate, isoamyl alcohol, and isobutanol; butyl formate, ethyl propionate, isoamyl acetate, isoamyl alcohol, and isobutanol; butyl formate, ethyl-2-methylbutyrate, isoamyl acetate, isoamyl alcohol, and isobutanol; ethyl octanoate, ethyl propionate, ethyl-2-methylbutyrate, isoamyl acetate, and isoamyl alcohol; ethyl octanoate, ethyl propionate, ethyl-2-methylbutyrate, isoamyl acetate, and isobutanol; ethyl octanoate, ethyl propionate, ethyl-2-methylbutyrate, isoamyl alcohol, and isobutanol; ethyl octanoate, ethyl propionate, isoamyl acetate, isoamyl alcohol, and isobutanol; ethyl octanoate, ethyl-2-methylbutyrate, isoamyl acetate, isoamyl alcohol, and isobutanol; or ethyl propionate, ethyl-2-methylbutyrate, isoamyl acetate, isoamyl alcohol, and isobutanol.

In some cases, a Scotch-like alcoholic beverage can include six compounds selected from the group consisting of butyl formate, ethyl octanoate, ethyl propionate, ethyl-2-methylbutyrate, isoamyl acetate, isoamyl alcohol, and isobutanol. The six compounds can be butyl formate, ethyl octanoate, ethyl propionate, ethyl-2-methylbutyrate, isoamyl acetate, and isoamyl alcohol; butyl formate, ethyl octanoate, ethyl propionate, ethyl-2-methylbutyrate, isoamyl acetate, and isobutanol; butyl formate, ethyl octanoate, ethyl propionate, ethyl-2-methylbutyrate, isoamyl alcohol, and isobutanol; butyl formate, ethyl octanoate, ethyl propionate, isoamyl acetate, isoamyl alcohol, and isobutanol; butyl formate, ethyl octanoate, ethyl-2-methylbutyrate, isoamyl acetate, isoamyl alcohol, and isobutanol; butyl formate, ethyl propionate, ethyl-2-methylbutyrate, isoamyl acetate, isoamyl alcohol, and isobutanol; or ethyl octanoate, ethyl propionate, ethyl-2-methylbutyrate, isoamyl acetate, isoamyl alcohol, and isobutanol.

In some embodiments, a Scotch-like alcoholic beverage as provided herein can include no more than six (e.g., six, five, four, three, two, one, or none), no more than five (e.g., five, four, three, two, one, or none), or no more than four (e.g., four, three, two, one, or none) of the VOCs in the group consisting of butyl formate, ethyl octanoate, ethyl propionate, ethyl-2-methylbutyrate, isoamyl acetate, isoamyl alcohol, and isobutanol.

In some embodiments, additional VOCs can be placed in various groups, and a Scotch replica can include certain additional VOCs according to their groupings.

In certain cases, for example, “Group A” can include 1-decanol, 1-octen-3-ol, 2,3-pentadione, 2-methyl-1-butanol, 2-phenylethanol, 2-phenylethylacetate, acetaldehyde, amyl alcohol, a-terpineol, benzaldehyde, beta-ionone, beta-pinene (also called (−)-beta-pinene or beta-pinene), butanol, butyl acetate, cinnamaldehyde, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, isoamyl alcohol, isoamyl hexanoate, isoamyl octanoate, isobutanol, isobutyl acetate, limonene, linalool oxide, maltol, methyl octanoate, methyl salicylate, myrcene, p-cresol, p-cymene, phenethyl butyrate, and whiskey lactone.

In some cases, “Group B” can include propanol, ethyl isobutyrate, gamma-terpinene, and butyric acid.

In some cases, the VOCs in “Group C” can include 3-carene, 4-carvomenthenol, 4-ethyl phenol, butyl formate, delta-decalactone, ethyl heptanoate, guaiacol, isoamyl acetate, linalool, and linalyl acetate.

“Group D” VOCs can include, in some embodiments, 1,1-diethoxyethane, 1-octanol, 2-heptanone, 2-methylbutyl acetate, 2-methylbutyraldehyde, 2-nonanone, 2-undecanone, 4-ethyl guaiacol, acetoin, acetophenone, amyl butyrate, a-phellandrene, a-pinene, benzyl acetate, butyraldehyde, carvone, citronellol, damascenone, decanoic acid, diethyl malate, dimethylsulfide, ethyl 3-hydroxyhexanoate, ethyl benzoate, ethyl levulinate, ethyl nonanoate, ethyl palmitate, ethyl trans-2-butenoate, ethyl undecanoate, ethyl-2-methylbutyrate, farnesol, gamma-nonalactone, geraniol, geranyl acetone, hexanoic acid, hexanol, isoamyl isovalerate, isobutyl isobutyrate, isobutyraldehyde, isobutyric acid, isovaleraldehyde, isovaleric acid, methional, methyl decanoate, methyl hexanoate, methyl laurate, myrtenol, nonanal, nonanoic acid, octanoic acid, p-anisaldehyde, phenethyl formate, phenethyl octanoate, propionaldehyde, propionic acid, propyl acetate, salicylaldehyde, trans-2-hexen-1-al, valeraldehyde, valeric acid, and vanillyl ethyl ether.

Based on the above groupings of VOCs, a Scotch replica can include, for example, 30 or more (e.g., 31, 32, 33, 34, 35, 36, 37, 38, 39, 40, 41, 42, 43, 44, 45, or more) of the additional VOCs in Group A, optionally 1 or more (e.g., 2, 3, 4, or 5) of the VOCs in Group B, optionally 1 or more (e.g., 2, 3, 4, 5, 6, 7, 8, 9, or 10) of the VOCs in Group C, and optionally 1 or more (e.g., 2, 3, 4, 5, 6, 7, 8, 9, 10, or more) of the VOCs in Group D.

In some cases, “Group E1” can include 1-decanol, 1-octen-3-ol, 2,3-pentadione, 2-methyl-1-butanol, 2-phenylethanol, 2-phenylethylacetate, 3-carene, acetaldehyde, amyl alcohol, a-terpineol, benzaldehyde, beta-ionone, beta-pinene, butanol, butyl acetate, cinnamaldehyde, delta-decalactone, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, guaiacol, isoamyl alcohol, isoamyl hexanoate, isoamyl octanoate, isobutanol, isobutyl acetate, limonene, linalool, linalool oxide, linalyl acetate, maltol, methyl salicylate, myrcene, p-cresol, and whiskey lactone.

In some cases, the VOCs in “Group F1” can include 1,1-diethoxyethane, 2-heptanone, 4-ethyl guaiacol, acetoin, acetophenone, diethyl malate, ethyl 3-hydroxyhexanoate, ethyl levulinate, ethyl trans-2-butenoate, ethyl undecanoate, ethyl-2-methylbutyrate, gamma-nonalactone, geraniol, isobutyraldehyde, methional, methyl octanoate, p-cymene, phenethyl butyrate, phenethyl formate, propanol, propyl acetate, and vanillyl ethyl ether.

In certain cases, for example, “Group G1” can include 2-methylbutyraldehyde, 2-nonanone, 4-carvomenthenol, 4-ethyl phenol, butyl formate, butyric acid, citronellol, ethyl isobutyrate, ethyl nonanoate, farnesol, gamma-terpinene, isoamyl acetate, isovaleraldehyde, p-anisaldehyde, propionaldehyde, salicylaldehyde, valeraldehyde, butyraldehyde, propionic acid, isovaleric acid, valeric acid, hexanoic acid, and nonanoic acid.

Based on the above groupings of VOCs, a Scotch replica can include, for example, the additional VOCs in Group E1, 5 or more (e.g., 7, 8, 9, 10, 12, 14, 16, 18, or 20) of the additional VOCs in Group F1, and optionally, one or more (e.g., 2, 3, 5, 7, 9, 10, 11, 12, or more) of the additional VOCs in Group G1.

In some cases, “Group E2” can include 2-methyl-1-butanol, butyl alcohol, ethyl acetate, ethyl decanoate, ethyl hexanoate, ethyl isovalerate, ethyl lactate, ethyl laurate, ethyl octanoate, furfural, isoamyl alcohol, isobutyl alcohol, phenethyl alcohol, butyl acetate, diethyl succinate, ethyl butyrate, ethyl myristate, ethyl propionate, isobutyl acetate, phenethyl acetate, whiskey lactone, 1-decanol, 1-octen-3-ol, a-terpineol, ethyl valerate, isoamyl hexanoate, benzaldehyde, beta pinene, ethyl cinnamate, ethyl phenyl acetate, isoamyl octanoate, methyl salicylate, and myrcene.

In some cases, the VOCs in “Group F2” can include delta-decalactone, acetaldehyde, amyl alcohol, linalyl acetate, gamma-decalactone, guaiacol, limonene, linalool oxide, 2,3-pentadione, beta-ionone, cinnamaldehyde, eugenol, maltol, p-cresol, 3-carene, ethyl-2-methylbutyrate, 1-linalool, acetal (1,1-diethoxyethane), isobutyraldehyde, propyl alcohol, butyl formate, ethyl isobutyrate, ethyl levulinate, ethyl undecanoate, acetoin, gamma-nonalactone, geraniol, propyl acetate, vanillyl ethyl ether, and 2-nonanone.

In certain cases, for example, “Group G2” can include diethyl malate, 2-heptanone, 4-ethyl guaiacol, butyric acid, ethyl 3-hydroxyhexanoate, ethyl nonanoate, phenethyl formate, acetophenone, gamma-terpinene, methional, salicylaldehyde, 2-methylbutyraldehyde, citronellol, ethyl trans-2-butenoate, farnesol, 4-carvomenthenol, ethyl heptanoate, isoamyl acetate, ethyl benzoate, hexanol, methyl hexanoate, valeraldehyde, 4-ethyl phenol, methyl octanoate, p-cymene, phenethyl butyrate, trans-2-hexen-1-al.

Based on the above groupings of VOCs, a Scotch replica can include, for example, the additional VOCs in Group E2, 10 or more (e.g., 12, 14, 15, 16, 18, 20, 22, 24, 25, 26, 28, or 30) of the additional VOCs in Group F2, and optionally, one or more (e.g., 2, 3, 5, 7, 9, 10, 11, 12, or more) of the additional VOCs in Group G2.

In some cases, “Group M” can include 1-decanol, 1-octen-3-ol, 2-methyl-1-butanol, 2-phenylethanol, 2-phenylethylacetate, 3-carene, amyl alcohol, a-terpineol, benzaldehyde, beta-ionone, butanol, butyl acetate, Cinnamaldehyde, delta-decalactone, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, Ethyl Valerate, eugenol, furfural, guaiacol, isoamyl alcohol, isoamyl hexanoate, isoamyl octanoate, isobutanol, isobutyl acetate, limonene, linalool, linalool oxide, linalyl acetate, methyl salicylate, Myrcene, and whiskey lactone.

In some cases, “Group N” can include beta-pinene, 1,1-diethoxyethane, 2,3-pentadione, 2-heptanone, acetaldehyde, acetoin, acetophenone, diethyl malate, ethyl 3-hydroxyhexanoate, ethyl levulinate, ethyl trans-2-butenoate, ethyl undecanoate, ethyl-2-methylbutyrate, gamma-decalactone, gamma-nonalactone, geraniol, isobutyraldehyde, maltol, methional, methyl octanoate, p-cresol, p-cymene, phenethyl butyrate, phenethyl formate, propanol, propyl acetate, and vanillyl ethyl ether.

In some cases, “Group 0” can include 1-octanol, 2-methylbutyl acetate, 2-methylbutyraldehyde, 2-nonanone, 2-undecanone, 4-carvomenthenol, 4-ethyl guaiacol, 4-ethyl phenol, amyl butyrate, benzyl acetate, butyl formate, butyraldehyde, butyric acid, carvone, citronellol, decanoic acid, ethyl benzoate, ethyl heptanoate, ethyl isobutyrate, ethyl nonanoate, farnesol, gamma-terpinene, hexanoic acid, hexanol, isoamyl acetate, isoamyl isovalerate, isobutyl isobutyrate, isobutyric Acid, isovaleraldehyde, isovaleric acid, methyl decanoate, methyl hexanoate, methyl laurate, nonanal, nonanoic acid, octanoic acid, p-anisaldehyde, propionaldehyde, propionic acid, salicylaldehyde, valeraldehyde, and valeric acid.

Based on the above groupings of VOCs, a Scotch replica can include, for example, the additional VOCs in Group M, 5 or more (e.g., 7, 8, 9, 10, 12, 14, 16, 18, or 20) of the additional VOCs in Group N, and optionally, one or more (e.g., 2, 3, 5, 7, 9, 10, 11, 12, or more) of the additional VOCs in Group 0.

In some cases, “Group P” can include 1,1-diethoxyethane, 1-decanol, 1-octanol, 1-octen-3-ol, 2,3-pentadione, 2-heptanone, 2-methyl-1-butanol, 2-methylbutyl acetate, 2-methylbutyraldehyde, 2-nonanone, 2-phenylethanol, 2-phenylethylacetate, 2-undecanone, 3-carene, 4-carvomenthenol, 4-ethyl guaiacol, 4-ethyl phenol, acetaldehyde, acetoin, acetophenone, amyl alcohol, amyl butyrate, a-phellandrene, a-pinene, a-terpineol, benzaldehyde, benzyl acetate, beta-ionone, beta-pinene, butanol, butyl acetate, butyl formate, butyraldehyde, butyric acid, carvone, cinnamaldehyde, citronellol, damascenone, decanoic acid, delta-decalactone, diethyl malate, diethyl succinate, dimethylsulfide, ethyl 3-hydroxyhexanoate, ethyl acetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl trans-2-butenoate, ethyl undecanoate, ethyl valerate, ethyl-2-methylbutyrate, eugenol, farnesol, furfural, gamma-decalactone, gamma-nonalactone, gamma-terpinene, geraniol, geranyl acetone undacadien, guaiacol, hexanoic acid, hexanol, isoamyl acetate, isoamyl alcohol, isoamyl hexanoate, isoamyl isovalerate, isoamyl octanoate, isobutanol, isobutyl acetate, isobutyl isobutyrate, isobutyraldehyde, isobutyric acid, isovaleraldehyde, isovaleric acid, limonene, linalool, linalool oxide, linalyl acetate, maltol, methional, methyl decanoate, methyl hexanoate, methyl laurate, methyl octanoate, methyl salicylate, myrcene, myrtenol, nonanal, nonanoic acid, octanoic acid, p-anisaldehyde, p-cresol, p-cymene, phenethyl butyrate, phenethyl formate, phenethyl octanoate, propanol, propionaldehyde, propionic acid, propyl acetate, salicylaldehyde, trans-2-hexen-1-al, valeraldehyde, valeric acid, vanillyl ethyl ether, and whiskey lactone.

The Scotch-like alcoholic beverages provided herein can, in some embodiments, include at least ten (e.g., at least 20, at least 30, at least 40, or at least 50) additional VOCs from Group P.

In some cases, “Group Q” can include 1,1-diethoxyethane, 1-decanol, 1-octanol, 1-octen-3-ol, 1-para-menthene-8-thiol, 2,3-pentadione, 2,4,6-trimethylphenol (mesitol), 2-ethyl-3-methylpyrazine, 2-heptanol, 2-heptanone, 2-methoxy-3-(1-methylpropyl) pyrazine, 2-methoxy-4-methylphenol (creosol), 2-methoxy-4-propylphenol, 2-methyl-1-butanol, 2-methylbutyl acetate, 2-methylbutyl isovalerate, 2-methylbutyraldehyde, 2-nonanol, 2-nonanone, 2-pentyl furan, 2-phenylethanol, 2-phenylethylacetate, 2-undecanone, 3-carene, 4-carvomenthenol, 4-ethyl guaiacol, 4-ethyl phenol, 5-methyl-2-phenyl-2-hexenal, 6-methyl-5-hepten-2-one, acetaldehyde, acetoin, acetophenone, alpha ionone, amyl alcohol, amyl butyrate, a-phellandrene, a-pinene, a-terpineol, benzaldehyde, benzyl acetate, benzyl benzoate, benzyl propionate, beta-ionone, beta-pinene, butanol, butyl acetate, butyl alcohol, butyl formate, butyraldehyde, butyric acid, carvacrol, carvone, cinnamaldehyde, cis-3-hexen-1-ol, cis-3-hexenyl acetate, cis-5-octen-1-ol, cis-rose oxide, citral, citronellol, cuminaldehyde, damascenone, D-camphor, decanal, decanoic acid, delta-decalactone, delta-dodecalactone, diethyl malate, diethyl succinate, dimethylsulfide, ethyl 3-hydroxyhexanoate, ethyl acetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl trans-2-butenoate, ethyl undecanoate, ethyl valerate, ethyl-2-methylbutyrate, eugenol, farnesol, furfural, gamma-decalactone, gamma-dodecalactone, gamma-heptalactone, gamma-nonalactone, gamma-octalactone, gamma-terpinene, gamma-undecalactone, geraniol, geranyl acetone undacadien, guaiacol, heptyl acetate, hexanoic acid, hexanol, hexyl acetate, indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutanol, isobutyl acetate, isobutyl isobutyrate, isobutyl propionate, isobutyraldehyde, isobutyric acid, isoeugenol, isovaleraldehyde, isovaleric acid, limonene, linalool, linalool oxide, linalyl acetate, maltol, massoia lactone, methional, methyl acetate, methyl benzoate, methyl beta-naphthyl ketone, methyl cinnamate, methyl decanoate, methyl hexanoate, methyl laurate, methyl octanoate, methyl salicylate, methyl-2-pyrrolyl ketone, myrcene, myrtenol, nerolidol, nonanal, nonanoic acid, octanal, octanoic acid, omega-pentadecalactone, p,a-dimethylstyrene, p-anisaldehyde, p-cresol, p-cymene, phenethyl 2-methylbutyrate, phenethyl butyrate, phenethyl formate, phenethyl octanoate, phenethyl propionate, phenethyl tiglate, phenylacetaldehyde, propanol, propionaldehyde, Propionic acid, propyl acetate, propyl isovalerate, salicylaldehyde, thymol, trans-2-hexen-1-al, valencene, valeraldehyde, valeric acid, vanillyl ethyl ether, whiskey lactone.

The Scotch-like alcoholic beverages provided herein can, in some embodiments, include at least ten (e.g., at least 20, at least 30, at least 40, or at least 50) additional VOCs from Group Q.

In some cases, “Group R” can include (1R)-(−)-myrtenal, (ethyl cyclopentenolone)3-Ethyl-2-hydroxy-2-cyclopenten-1-one, 1,1-diethoxyethane, 1,4-cineole, 1-decanol, 1-octanol, 1-octen-3-ol, 1-para-menthene-8-thiol, 2,3-pentadione, 2,4,6-trimethylphenol (mesitol), 2-acetyl-1-methylpyrrole, 2-ethyl-3-methylpyrazine, 2-heptanol, 2-heptanone, 2-isopropyl-3-methoxypyrazine, 2-isopropyl-4-methyl thiazole, 2-methoxy-3-(1-methylpropyl) pyrazine, 2-methoxy-4-methylphenol (creosol), 2-methoxy-4-propylphenol, 2-methyl-1-butanol, 2-methylbutyl acetate, 2-methylbutyl isovalerate, 2-methylbutyraldehyde, 2-nonanol, 2-nonanone, 2-pentyl furan, 2-phenylethanol, 2-phenylethylacetate, 2-undecanone, 3,7-dimethyl-6-octenoic acid, 3-carene, 3-methylthio hexyl acetate, 3-phenylpropanal, 4,5,6,7-tetrahydro-3,6-dimethylbenzofuran, 4-carvomenthenol, 4-ethyl huaiacol, 4-ethyl phenol, 4-mercapto-4-methyl-2-pentanone, 5-methyl-2-phenyl-2-hexenal, 6-methyl-5-hepten-2-one, acetaldehyde, acetoin, acetophenone, allyl heptanoate, alpha ionone, amyl alcohol, amyl butyrate, anisyl acetate, anisyl butyrate, a-phellandrene, a-pinene, a-terpineol, b-caryophellene, benzaldehyde, benzyl acetate, benzyl alcohol, benzyl benzoate, benzyl butyrate, benzyl formate, benzyl propionate, beta-ionone, beta-pinene, butanol, butyl acetate, butyl alcohol, butyl butyryllactate, butyl formate, butyl isovalerate, butyraldehyde, butyric acid, carvacrol, carvone, cinnamaldehyde, cis-3-hexen-1-ol, cis-3-hexenyl acetate, cis-3-hexenyl butyrate, cis-3-hexenyl valerate, cis-5-octen-1-ol, cis-6-nonen-1-ol, cis-rose oxide, citral, citronellal, citronellol, cuminaldehyde, damascenone, D-camphor, D-carvone, decanal, decanoic acid, delta-decalactone, delta-dodecalactone, d-fenchone, diethyl malate, diethyl succinate, dimethyl sulfide, DL-3-methyl-2-butanol, ethyl 2-trans-4-cis-decadienoate, ethyl 3-hydroxyhexanoate, ethyl acetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl trans-2-butenoate, ethyl trans-3-hexenoate, ethyl undecanoate, ethyl valerate, ethyl(methylthio) acetate, ethyl-2-methylbutyrate, eucalyptol, eugenol, farnesol, furfural, furufyl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone undacadien, guaiacol, heptyl acetate, hexanoic acid, hexanol, hexyl 3-methylbutanoate, hexyl acetate, hexyl isobutyrate, IBMP (3-isobutyl-2-methoxypyrazine), indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutanol, isobutyl acetate, isobutyl isobutyrate, isobutyl propionate, isobutyraldehyde, isobutyric acid, isoeugenol, isovaleraldehyde, isovaleric acid, limonene, linalool, linalool oxide, linalyl acetate, L-menthyl acetate, maltol, massoia lactone, methional, methionyl acetate (3-methylthio-propylacetate), methyl acetate, methyl anthranilate, methyl benzoate, methyl beta-naphthyl ketone, methyl cinnamate, methyl cyclopentenolone, methyl decanoate, methyl hexanoate, methyl laurate, methyl Octanoate, methyl salicylate, methyl-2-pyrrolyl ketone, myrcene, myrtenol, nerolidol, nonanal, nonanoic acid, octanal, octanoic acid, omega-pentadecalactone, p,a-dimethylstyrene, p-anisaldehyde, p-cresol, p-cymene, perillaldehyde, phenethyl 2-methylbutyrate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, tetrahydrolinalool, thymol, trans-2-hexen-1-al, valencene, Valeraldehyde, Valeric acid, vanillyl butyl ether, vanillyl ethyl ether, whiskey lactone.

The Scotch-like alcoholic beverages provided herein can, in some embodiments, include at least ten (e.g., at least 20, at least 30, at least 40, or at least 50) additional VOCs from Group R.

In some cases, “Group S” can include (−)-beta-pinene, 1,1-diethoxyethane, 2-methyl-1-butanol, 2-phenylethanol, 2-phenylethylacetate, 4-ethyl guaiacol, acetoin, a-terpineol, beta-ionone, butanol, citronellol, damascenone, diethyl succinate, ethyl acetate, ethyl butanoate, ethyl cinnamate, ethyl decanoate, ethyl hexanoate, ethyl isobutyrate, ethyl isovalerate, ethyl lactate, ethyl laurate, ethyl nonanoate, ethyl octanoate, ethyl-2-methylbutyrate, eugenol, guaiacol, hexanol, isoamyl acetate, isoamyl alcohol, isobutanol, isobutyl acetate, isovaleraldehyde, linalool oxide, linalyl acetate, myrtenol, propanol, and whiskey lactone.

The Scotch-like alcoholic beverages provided herein can, in some embodiments, include at least ten (e.g., at least 20, or at least 30) additional VOCs from Group S.

In some cases, “Group T” can include (−)-alpha-pinene, (−)-beta-pinene, (−)-cis-rose oxide, 1,1-diethoxyethane, 1-decanol, 1-octanol, 1-octen-3-ol, 2,3-pentadione, 2-heptanone, 2-methoxy-4-propylphenol, 2-methyl-1-butanol, 2-methylbutyl acetate, 2-methylbutyl isovalerate, 2-methylbutyraldehyde, 2-nonanol, 2-nonanone, 2-phenylethanol, 2-phenylethylacetate, 2-undecanone, 3-carene, 4-carvomenthenol, 4-ethyl guaiacol, 4-ethyl phenol, acetophenone, alpha ionone, amyl alcohol, amyl butyrate, a-terpineol, benzaldehyde, benzyl acetate, beta-ionone, butanol, butyl acetate, carvone, cinnamaldehyde, cis-3-hexen-1-ol, cis-3-hexenyl acetate, citronellol, diethyl malate, ethyl 3-hydroxyhexanoate, ethyl acetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenyl acetate, ethyl propionate, ethyl salicylate, ethyl trans-2-butenoate, ethyl trans-3-hexenoate, ethyl undecanoate, ethyl valerate, ethyl(methylthio) acetate, ethyl-2-methylbutyrate, eucalyptol, eugenol, farnesol, furfural, gamma-decalactone, gamma-nonalactone, gamma-terpinene, geraniol, geranyl acetone, guaiacol, heptyl acetate, hexanol, isoamyl acetate, isoamyl alcohol, isoamyl hexanoate, isoamyl isobutyrate, isoamyl isovalerate, isoamyl octanoate, isobutanol, isobutyl acetate, isobutyl isobutyrate, isobutyraldehyde, isovaleraldehyde, limonene, linalool, linalool oxide, linalyl acetate, methional, methyl acetate, methyl hexanoate, methyl laurate, methyl octanoate, methyl salicylate, myrcene, p-anisaldehyde, p-cresol, p-cymene, phenethyl butyrate, phenethyl formate, phenethyl octanoate, phenethyl propionate, propanol, propyl acetate, salicylaldehyde, vanillyl ethyl ether, and whiskey lactone.

The Scotch-like alcoholic beverages provided herein can, in some embodiments, include at least ten (e.g., at least 20, at least 30, at least 40, or at least 50) additional VOCs from Group T.

In some cases, “Group U” can include (1R)-(−)-myrtenal, 3-Ethyl-2-hydroxy-2-cyclopenten-1-one (ethyl cyclopentenolone), 1,1-diethoxyethane, 1,4-cineole, 1-decanol, 1-octanol, 1-octen-3-ol, 1-para-menthene-8-thiol, 2,3-pentadione, 2,4,6-trimethylphenol (mesitol), 2-acetyl-1-methylpyrrole, 2-ethyl-3-methylpyrazine, 2-heptanol, 2-heptanone, 2-isopropyl-3-methoxypyrazine, 2-isopropyl-4-methyl thiazole, 2-methoxy-3-(1-methylpropyl) pyrazine, 2-methoxy-4-methylphenol (creosol), 2-methoxy-4-propylphenol, 2-methyl-1-butanol, 2-methylbutyl acetate, 2-methylbutyl isovalerate, 2-methylbutyraldehyde, 2-nonanol, 2-nonanone, 2-pentyl furan, 2-phenylethanol, 2-phenylethylacetate, 2-undecanone, 3,7-dimethyl-6-octenoic acid, 3-carene, 3-methylthio hexyl acetate, 3-phenylpropanal, 4,5,6,7-tetrahydro-3,6-dimethylbenzofuran, 4-carvomenthenol, 4-ethyl guaiacol, 4-ethyl phenol, 4-mercapto-4-methyl-2-pentanone, 5-methyl-2-phenyl-2-hexenal, 6-methyl-5-hepten-2-one, acetaldehyde, acetoin, acetophenone, allyl heptanoate, alpha ionone, amyl alcohol, amyl butyrate, anisyl acetate, anisyl butyrate, a-phellandrene, a-pinene, a-terpineol, b-caryophellene, benzaldehyde, benzyl acetate, benzyl alcohol, benzyl benzoate, benzyl butyrate, benzyl formate, benzyl propionate, beta-ionone, beta-pinene, butanol, butyl acetate, butyl alcohol, butyl butyryllactate, butyl formate, butyl isovalerate, butyraldehyde, butyric acid, carvacrol, carvone, cinnamaldehyde, cis-3-hexen-1-ol, cis-3-hexenyl acetate, cis-3-hexenyl butyrate, cis-3-hexenyl valerate, cis-5-octen-1-ol, cis-6-nonen-1-ol, cis-rose oxide, citral, citronellal, citronellol, cuminaldehyde, damascenone, D-camphor, D-carvone, decanal, decanoic acid, delta-decalactone, delta-dodecalactone, d-fenchone, diethyl malate, diethyl succinate, dimethyl sulfide, DL-3-methyl-2-butanol, ethyl 2-trans-4-cis-decadienoate, ethyl 3-hydroxyhexanoate, ethyl acetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl trans-2-butenoate, ethyl trans-3-hexenoate, ethyl undecanoate, ethyl valerate, ethyl(methylthio) acetate, ethyl-2-methylbutyrate, eucalyptol, eugenol, farnesol, furfural, furufyl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone undacadien, guaiacol, heptyl acetate, hexanoic acid, hexanol, hexyl 3-methylbutanoate, hexyl acetate, hexyl isobutyrate, IBMP (3-Isobutyl-2-methoxypyrazine), indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutanol, isobutyl acetate, isobutyl isobutyrate, isobutyl propionate, isobutyraldehyde, isobutyric acid, isoeugenol, isovaleraldehyde, isovaleric acid, limonene, linalool, linalool oxide, linalyl acetate, L-menthyl acetate, maltol, massoia lactone, methional, methionyl acetate (3-methylthio-propylacetate), methyl acetate, methyl anthranilate, methyl benzoate, methyl beta-naphthyl ketone, methyl cinnamate, methyl cyclopentenolone, methyl decanoate, methyl hexanoate, methyl laurate, methyl octanoate, methyl salicylate, methyl-2-pyrrolyl ketone, myrcene, myrtenol, nerolidol, nonanal, nonanoic acid, octanal, octanoic acid, omega-pentadecalactone, p,a-dimethylstyrene, p-anisaldehyde, p-cresol, p-cymene, perillaldehyde, phenethyl 2-methylbutyrate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, tetrahydrolinalool, thymol, trans-2-hexen-1-al, valencene, valeraldehyde, valeric acid, vanillyl butyl ether, vanillyl ethyl ether, and whiskey lactone.

The Scotch-like alcoholic beverages provided herein can, in some embodiments, include at least ten (e.g., at least 20, at least 30, at least 40, or at least 50) additional VOCs from Group U.

In some embodiments, the Scotch replicas provided herein can include one or more (e.g., one, two, three, four, five, or more than five) VOCs that are not present in traditional Scotch. Examples of such VOCs include, without limitation, (1R)-(−)-myrtenal, 3-ethyl-2-hydroxy-2-cyclopenten-1-one (ethyl cyclopentenolone), 1,4-cineole, 2-acetyl-1-methylpyrrole, 2-isopropyl-4-methyl thiazole, 3-methylthio hexyl acetate, 3-phenylpropanal, 4,5,6,7-tetrahydro-3,6-dimethylbenzofuran, 4-mercapto-4-methyl-2-pentanone, acetoin, allyl heptanoate, amyl butyrate, anisyl acetate, anisyl butyrate, b-caryophellene, benzyl alcohol, benzyl butyrate, benzyl formate, beta-pinene, butyl butyryllactate, butyl formate, butyraldehyde, cis-3-hexenyl butyrate, cis-3-hexenyl valerate, cis-6-nonen-1-ol, citronellal, D-carvone, d-fenchone, DL-3-methyl-2-butanol, ethyl 2-trans-4-cis-decadienoate, ethyl trans-3-hexenoate, ethyl(methylthio) acetate, eucalyptol, furufyl thioacetate, gamma-hexalactone, gamma-valerolactone, hexyl 3-methylbutanoate, hexyl isobutyrate, IBMP (3-Isobutyl-2-methoxypyrazine), L-menthyl acetate, maltol, methionyl acetate (3-methylthio-propylacetate), methyl anthranilate, methyl cyclopentenolone, myrcene, nonanoic acid, p-anisaldehyde, perillaldehyde, phenylacetaldehyde dimethyl acetal, propionaldehyde, propyl butyrate, tetrahydrolinalool, trans-2-hexen-1-al, valeraldehyde, valeric acid, and vanillyl butyl ether. In Thus, a Scotch replica can include one or more of these compounds. In some embodiments, a Scotch replica can include one or more compounds (e.g., 2, 3, 4, 5, 6, 7, 8, 9, 10, 11, 12, or 13 compounds) not present in traditional Scotch selected from the group consisting of acetoin, amyl butyrate, beta-pinene, butyl formate, butyraldehyde, maltol, myrcene, nonanoic acid, p-anisaldehyde, propionaldehyde, trans-2-hexen-1-al, valeraldehyde, valeric acid, and combinations thereof. In some embodiments, a Scotch replica can include one or more compounds (e.g., 2, 3, 4, 5, 6, or 7 compounds) not present in a traditional Scotch selected from the group consisting of acetoin, beta-pinene, butyl formate, maltol, myrcene, trans-2-hexen-1-al, valeraldehyde, and combinations thereof. It is surprising that the Scotch replicas described herein include one or more compounds not found in any tested traditional Scotch, as it would be expected that to create a Scotch replica, one would only think to use compounds found in one or more traditional Scotches.

VOCs and non-volatile compounds can be detected in traditional Scotches (and other alcoholic beverages) using any suitable methods, including the gas chromatography/mass spectrometry (GC-MS) and liquid chromatography/mass spectrometry (LC-MS) methods described in Example 2 herein. A volatile or non-volatile compound that is “not present” in a reference Scotch is one that is not detected in the reference Scotch using the methods set forth in Example 2. Limits of detection for various VOCs are disclosed in TABLES 3A, 3B, 3C, and 3D herein, and limits of detection for various non-volatile compounds are disclosed in TABLE 5 herein.

Further, in some embodiments, the Scotch replicas provided herein can lack one or more (e.g., one, two, three, four, five, ten, 15, 20, or more than 20) VOCs that are present in a traditional Scotch. Examples of such VOCs include, without limitation, 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone. Thus, a Scotch replica can lack one or more of these compounds. It is surprising that the Scotch replicas described herein lack one or more compounds found in every tested traditional Scotch, as it would be expected that to create a Scotch replica, one would believe that compounds present in every tested traditional Scotch to be important to Scotch flavor.

In some embodiments, VOCs can be placed in various groups, and a Scotch replica can lack certain VOCs according to their groupings.

In certain cases, for example, “Group H1” can include 1,1-diethoxyethane, citronellol, ethyl isobutyrate, ethyl nonanoate, ethyl-2-methylbutyrate, eugenol, guaiacol, hexanol, isoamyl acetate, isobutyl acetate, isovaleraldehyde, and propanol.

In some cases, “Group I1” can include 1-octanol, 1-octen-3-ol, 2-heptanone, 2-methoxy-4-propylphenol, 2-methylbutyl acetate, 2-methylbutyraldehyde, 2-nonanone, 2-undecanone, acetophenone, butyl acetate, cinnamaldehyde, cis-3-hexen-1-ol, cis-3-hexenyl acetate, diethyl malate, ethyl 3-hydroxyhexanoate, ethyl benzoate, ethyl heptanoate, ethyl levulinate, ethyl myristate, ethyl phenyl acetate, ethyl salicylate, ethyl trans-2-butenoate, ethyl undecanoate, ethyl valerate, farnesol, gamma-decalactone, gamma-nonalactone, gamma-terpinene, geraniol, geranyl acetone, heptyl acetate, isoamyl hexanoate, isoamyl isobutyrate, isoamyl isovalerate, isoamyl octanoate, isobutyl isobutyrate, isobutyraldehyde, limonene, methyl acetate, methyl hexanoate, methyl laurate, methyl octanoate, p-cresol, p-cymene, phenethyl butyrate, phenethyl formate, phenethyl octanoate, phenethyl propionate, propyl acetate, and salicylaldehyde.

In some cases, the VOCs in “Group J1” can include damascenone, diethyl succinate, and myrtenol.

Based on the above groupings of additional VOCs, a Scotch replica can lack, for example, 1 or more (e.g., 2, 3, 4, 5, 6, 7, 8, 9, 10, 11 or 12) of the additional VOCs in Group H1, optionally 1 or more (e.g., 2, 3, 4, 5, 6, 7, 8, 9, 10, 15, 20, 30, 40, or 50) of the VOCs in Group I1, and 1 or more (e.g., 2 or 3) of the VOCs in Group J1. In some embodiments, a Scotch replica can lack one or more (e.g., 2, 3, 4, 5, 6, 7, 8, 9, 10, 11, or 12) of the VOCs in Group H1. In some embodiments, a Scotch replica can lack one or more (e.g., 2, 3, 4, 5, 6, 7, 8, 9, 10, 15, 20, 30, 40, or 50) of the additional VOCs in Group I1. In some embodiments, a Scotch replica can lack one or more (e.g., 2 or 3) of the VOCs in Group J1.

In certain cases, for example, “Group H2” can include 2-methoxy-4-methylphenol (creosol), cis-3-hexen-1-ol, delta-dodecalactone, ethyl salicylate, gamma-dodecalactone, gamma-octalactone, hexyl acetate, isoamyl isobutyrate.

In some cases, “Group I2” can include geranyl acetone, myrtenol, and phenethyl octanoate.

In some cases, the VOCs in “Group J2” can include 2-methylbutyl acetate, decanoic acid, hexanoic acid, isobutyric acid, methyl decanoate, methyl laurate, and propionic acid.

Based on the above groupings of additional VOCs, a Scotch replica can lack, for example, 1 or more (e.g., 2, 3, 4, 5, 6, 7, or 8) of the additional VOCs in Group H2, optionally 1 or more (e.g., 2, or 3) of the VOCs in Group I2, and 1 or more (e.g., 2, 3, 4, 5, 6, or 7) of the VOCs in Group J2. In some embodiments, a Scotch replica can lack one or more (e.g., 2, 3, 4, 5, 6, 7, or 8) of the VOCs in Group H2. In some embodiments, a Scotch replica can lack one or more (e.g., 2 or 3) of the additional VOCs in Group I2. In some embodiments, a Scotch replica can lack one or more (e.g., 2, 3, 4, 5, 6, or 7) of the VOCs in Group J2.

In some embodiments, a Scotch replica can include at least 50 (e.g., at least 51, 52, 53, 54, 55, 56, 57, 58, 59, 60, 61, 62, 63, 64, 65, 66, 67, 68, or 69) additional VOCs selected from the group consisting of 1-decanol, 1-octen-3-ol, 2-heptanone, 2-methyl-1-butanol, 2-methylbutyraldehyde, 2-nonanone, 3-carene, acetal (1,1-diethoxyethane), acetoin, acetophenone, amyl alcohol, a-terpineol, benzaldehyde, beta-ionone, butyl acetate, butyl alcohol, cinnamaldehyde, citronellol, delta-decalactone, diethyl malate, diethyl succinate, ethyl acetate, ethyl benzoate, ethyl butyrate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenyl acetate, ethyl propionate, ethyl trans-2-butenoate, ethyl undecanoate, ethyl valerate, ethyl-2-methylbutyrate, eugenol, furfural, gamma-nonalactone, geraniol, guaiacol, hexanol, isoamyl acetate, isoamyl alcohol, isoamyl hexanoate, isoamyl octanoate, isobutyl acetate, isobutyl alcohol, isobutyraldehyde, limonene, linalool oxide, linalyl acetate, 1-linalool, methyl hexanoate, methyl salicylate, Myrcene, p-cymene, phenethyl acetate, phenethyl alcohol, phenethyl formate, propyl acetate, propyl alcohol, and whiskey lactone.

In some cases, the overall population of additional (non-ethanol) VOCs in a replica Scotch can have less than 95% identity to the additional VOCs in a single corresponding reference Scotch (e.g., in a single type of traditional Scotch, in a single brand of traditional Scotch, in a single age statement of a traditional Scotch, or a single bottle of traditional Scotch). For example, the additional VOCs in a Scotch replica can have less than 90%, less than 80%, less than 70%, less than 60%, less than 50%, less than 40%, less than 30%, or less than 20% identity to the population of additional VOCs in a corresponding reference Scotch. As defined herein, the “percent identity” of additional VOCs is calculated by dividing the number of additional VOCs shared by a Scotch replica and a reference Scotch by the total number of VOCs (e.g., the total number of VOCs in Group P, Group Q, Group R, Group S, Group T, or Group U) detected in the reference Scotch. For example, the additional VOCs in a Scotch replica can have less than 90%, less than 80%, less than 70%, less than 60%, less than 50%, less than 40%, less than 30%, or less than 20% identity to the population of additional VOCs in a corresponding reference Scotch. Some Scotch replicas may contain at least 10 (e.g., at least 15, at least 20, at least 25, at least 30, at least 35, at least 40, at least 45, or at least 50) additional VOCs that are not found in a single reference Scotch. Moreover, some Scotch replicas may contain no more than 65 (e.g., no more than 64, 63, 62, 61, 60, 55, 50, 45, 40, 35, 30, 25, 20, 15, or 10) additional VOCs that are present in a single reference Scotch. For example, a Scotch replica can have at least 11 (e.g., 16, 21, 26, 31, 36, 41, 46, 51, 56, 61, or 66) additional VOCs and wherein no more than 10 (e.g., 15, 20, 25, 30, 35, 40, 45, 50, 55, 60, or 65, respectively) of the additional VOCs are found in a single reference Scotch. For example, in some embodiments, a Scotch replica can have at least n additional VOCs and wherein less than n (e.g., n−1, n−2, n−3, n−4, n−5, n−6, n−7, n−8, n−9, n−10, n−15, n−20, and the like, as applicable) of the additional VOCs are found in a single reference Scotch; in some embodiments, n can be equal to 5, 6, 7, 8, 9, 10, 11, 12, 13, 14, 15, 16, 17, 18, 19, 20, 25, 30, 35, 40, 45, 50, 55, 60, 65, 70, 75, 80, or 85.

The Examples below set forth amounts of additional VOCs that were included in Scotch replicas made according to the methods disclosed herein, and also set forth the amounts of additional VOCs that were detected in traditional Scotch samples. In some embodiments, the amount of a particular additional VOC in a Scotch replica can be an amount, based on concentration or percent composition (by mass), that is within a range 30% higher and lower than the amount disclosed for that VOC in any particular example. For example, an additional VOC can be present in a Scotch replica in an amount that is 70 to 90%, 80 to 100%, 90 to 110%, 100 to 120%, 110 to 130%, 70 to 100%, 80 to 110%, 90 to 120%, or 100 to 130% of an amount for that additional VOC in an exemplary Scotch replica or in a traditional Scotch as disclosed herein.

Further, the amount of any particular additional VOC in a Scotch replica may be different than the amount of that additional VOC in a corresponding reference Scotch. In some cases, the amount of an additional VOC in a Scotch replica can be 75% or less (e.g., 70% or less, 60% or less, 50% or less, 40% or less, 30% or less, 20% or less, or 10% or less), by concentration or percent composition (by mass), than the amount of the same additional VOC in a corresponding reference Scotch. In some cases, the amount of a VOC in a Scotch replica can be 125% or more (e.g., 150% or more, 200% or more, or 300% or more), by concentration or percent composition (by mass), than the amount of the same additional VOC in a reference Scotch.

The one or more additional VOCs in a Scotch-like alcoholic beverage can include 1,1-diethoxyethane. In some embodiments, the 1,1-diethoxyethane can be present in an amount of about 0.15 to about 7.4 mg/L (e.g., about 0.15 to about 0.3 mg/L, about 0.3 to about 0.5 mg/L, about 0.5 to about 1.0 mg/L, about 1.0 to about 2.0 mg/L, about 2.0 to about 3.0 mg/L, about 3.0 to about 4.0 mg/L, about 4.0 to about 5.0 mg/L, about 5.0 to about 6.0 mg/L, about 6.0 to about 7.0 mg/L, or about 6.0 to about 7.4 mg/L). In some embodiments, the 1,1-diethoxyethane can be present in an amount of at least about 4 mg/L (e.g., at least about 4.5 mg/L, 5.0 mg/L, 5.5 mg/L, 6.0 mg/L, or 6.5 mg/L). In some embodiments, about 0.002% to about 9% by mass (e.g., about 0.002% to about 0.005%, about 0.005% to about 0.05%, about 0.05% to about 0.5%, about 0.5% to about 1%, about 1% to about 2%, about 2% to about 3%, about 3% to about 5%, about 5% to about 7%, or about 7% to about 9% by mass) of the one or more additional VOCs can be 1,1-diethoxyethane. In some embodiments, at least about 0.56% by mass (e.g., at least about 0.6%, 0.7%, 0.8%, 0.9%, 1%, 2%, 3%, 4%, 5%, 6%, 7%, 8% or 9% by mass) of the one or more additional VOCs can be 1,1-diethoxyethane. In some embodiments, the one or more additional VOCs can include no 1,1-diethoxyethane.

The one or more additional VOCs in a Scotch-like alcoholic beverage can include 1-decanol. In some embodiments, the 1-decanol can be present in an amount of about 0.00001 to about 1.7 mg/L (e.g., 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.02 mg/L, about 0.01 to about 0.03 mg/L, about 0.01 to about 0.05 mg/L, about 0.05 to about 0.1 mg/L, about 0.1 to about 0.5 mg/L, about 0.5 to about 1.0 mg/L, about 1.0 to about 1.5 mg/L, or about 1.0 to about 1.7 mg/L). In some embodiments, the 1-decanol can be present in an amount of less than about 0.067 mg/L (e.g., less than about 0.065, 0.06, 0.05, 0.04, 0.03, 0.02, or 0.01 mg/L). In some embodiments, about 0.0000001% to about 0.25% by mass (0.0000001% to about 0.000001%, about 0.000001% to about 0.00001%, about 0.00001% to about 0.0001%, about 0.0001% to about 0.001%, about 0.001% to about 0.005%, about 0.005% to about 0.01%, about 0.01% to about 0.05%, about 0.05% to about 0.1%, about 0.1% to about 0.2%, or about 0.10% to about 0.25% by mass) of the one or more additional VOCs can be 1-decanol. In some embodiments, less than about 0.002% by mass (e.g., less than about 0.001%, or 0.0005% by mass) of the one or more additional VOCs can be 1-decanol. In some embodiments, the one or more additional VOCs can include no 1-decanol.

The one or more additional VOCs in a Scotch-like alcoholic beverage can include 1-octanol. In some embodiments, the 1-octanol can be present in an amount of about 0.04 to about 0.17 mg/L (e.g., about 0.04 to about 0.05 mg/L, about 0.05 to about 0.07 mg/L, about 0.07 to about 0.09 mg/L, about 0.09 to about 0.11 mg/L, about 0.05 to about 0.10 mg/L, about 0.11 to about 0.13 mg/L, about 0.13 to about 0.15 mg/L, or about 0.15 to about 0.17 mg/L). In some embodiments about 0.001% to about 0.032% by mass (e.g., about 0.001% to about 0.005%, about 0.005% to about 0.010%, about 0.010% to about 0.015%, about 0.015% to about 0.020%, about 0.020% to about 0.025%, about 0.025% to about 0.030%, about 0.025% to about 0.032%, about 0.01% to about 0.03%, about 0.01% to about 0.02%, or about 0.02% to about 0.03% by mass) of the one or more additional VOCs can be 1-octanol. In some embodiments, the one or more additional VOCs can include no 1-octanol.

The one or more additional VOCs in a Scotch-like alcoholic beverage can include 1-octen-3-ol. In some embodiments, the 1-octen-3-ol can be present in an amount of about 0.002 to about 1.7 mg/L (e.g., about 0.002 to about 0.005 mg/L, about 0.005 to about 0.01 mg/L, about 0.01 to about 0.02 mg/L, about 0.02 to about 0.03 mg/L, about 0.03 to about 0.05 mg/L, about 0.05 to about 0.1 mg/L, about 0.1 to about 0.5 mg/L, about 0.5 to about 1.0 mg/L, about 1.0 to about 1.5 mg/L, or about 1.0 to about 1.7 mg/L). In some embodiments, the 1-octen-3-ol can be present in an amount of less than about 0.024 mg/L (e.g., less than about 0.020 mg/L, 0.015 mg/L, 0.010 mg/L, or 0.005 mg/L). In some embodiments about 0.00002% to about 0.25% by mass (e.g., about 0.00002% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.2%, or about 0.10% to about 0.25% by mass) of the one or more additional VOCs can be 1-octen-3-ol. In some embodiments, less than 0.0007% by mass (e.g., less than about 0.0006%, 0.0005%, 0.0004%, 0.0003%, 0.0002%, or 0.0001% by mass) of the one or more additional VOCs can be 1-octen-3-ol. In some embodiments, the one or more additional VOCs can include no 1-octen-3-ol.

The one or more additional VOCs in a Scotch-like alcoholic beverage can include 2,3-pentadione. In some embodiments, the 2,3-pentadione can be present in an amount of about 0.0002 to about 0.13 mg/L (e.g., about 0.0002 to about 0.0005 mg/L, about 0.0005 to about 0.001 mg/L, about 0.001 to about 0.002 mg/L, about 0.002 to about 0.005 mg/L, about 0.005 to about 0.01 mg/L, about 0.01 to about 0.05 mg/L, about 0.05 to about 0.10 mg/L, or about 0.05 to about 0.13 mg/L). In some embodiments, the 2,3-pentadione can be present in an amount of less than about 0.00036 mg/L (e.g., less than about 0.00035 mg/L, 0.00034 mg/L, 0.00033 mg/L, 0.00032 mg/L, 0.00031 mg/L, 0.00030 mg/L, 0.00029 mg/L, or 0.00028 mg/L). In some embodiments, the 2,3-pentadione can be present in an amount of at least about 0.0015 mg/L (e.g., at least about 0.002 mg/L, 0.005 mg/L, 0.01 mg/L, 0.03 mg/L, 0.05 mg/L, 0.07 mg/L, or 0.09 mg/L). In some embodiments, about 0.00001% to about 0.0075% by mass (e.g., about 0.00001% to about 0.00005%, about 0.00005% to about 0.0001%, about 0.0001% to about 0.0005%, about 0.0005% to about 0.0010%, about 0.0010% to about 0.0020%, about 0.0020% to about 0.0030%, about 0.0030% to about 0.0050%, about 0.0050% to about 0.0070%, or about 0.0050% to about 0.0075% by mass) of the one or more additional VOCs can be 2,3-pentadione. In some embodiments, at least about 0.0002% by mass (e.g., at least about 0.0003%, 0.0004%, 0.0005%, or 0.0006% by mass) of the one or more additional VOCs can be 2,3-pentadione. In some embodiments, the one or more additional VOCs can include no 2,3-pentadione.

The one or more additional VOCs in a Scotch-like alcoholic beverage can include 2-methoxy-4-propylphenol. In some embodiments, the 2-methoxy-4-propylphenol can be present in an amount of about 0.0003 to about 0.1 mg/L (e.g., about 0.0003 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.1 mg/L). In some embodiments, about 0.000005% to about 0.015% by mass (e.g., about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.005%, about 0.005% to about 0.01%, or about 0.010% to about 0.015% by mass) of the one or more additional VOCs can be 2-methoxy-4-propylphenol. In some embodiments, the one or more additional VOCs can include no 2-methoxy-4-propylphenol.

The one or more additional VOCs in a Scotch-like alcoholic beverage can include 2-methyl-1-butanol. In some embodiments, the 2-methyl-1-butanol can be present in an amount of about 0.1 to about 9.4 g/L (e.g., about 0.1 to about 1 mg/L, about 1 to about 2 mg/L, about 2 to about 3 mg/L, about 3 to about 4 mg/L, about 4 to about 5 mg/L, about 5 to about 10 mg/L, about 10 to about 50 mg/L, about 50 to about 100 mg/L, about 100 to about 500 mg/L, about 500 to about 1 g/L, about 1 to about 2 g/L, about 2 to about 4 g/L, about 4 to about 6 g/L, about 6 to about 8 g/L, or about 8 to about 9.4 g/L). In some embodiments, the 2-methyl-1-butanol can be present in an amount of less than about 75 mg/L (e.g., less than about 70 mg/L, 60 mg/L, 50 mg/L, 40 mg/L, 30 mg/L, 20 mg/L, 10 mg/L, 5 mg/L, or 1 mg/L). In some embodiments, the 2-methyl-1-butanol can be present in an amount of at least about 635 mg/L (e.g., at least about 700 mg/L, 800 mg/L, 900 mg/L, 1 g/L, 1.5 g/L, 2 g/L, 3 g/L, 4 g/L, 5 g/L, 6 g/L, or 7 g/L). In some embodiments, about 0.15% to about 95% by mass (e.g., about 0.15% to about 1%, about 1% to about 2%, about 2% to about 3%, about 3% to about 4%, about 4% to about 5%, about 5% to about 10%, about 10% to about 20%, about 20% to about 30%, about 30% to about 40%, about 40% to about 50%, about 50% to about 60%, about 60% to about 70%, about 70% to about 80%, about 80% to about 90%, or about 90% to about 95% by mass) of the one or more additional VOCs can be 2-methyl-1-butanol. In some embodiments, less than about 2.3% by mass (e.g., less than about 2.2%, 2.1%, 2.0%, 1.9%, 1.8%, 1.7%, 1.6%, 1.5%, 1.4%, 1.3%, 1.2%, 1.1%, 1.0%, 0.9%, 0.8%, 0.7%, 0.6%, 0.5%, 0.4%, 0.3%, or 0.2% by mass) of the one or more additional VOCs can be 2-methyl-1-butanol. In some embodiments, at least about 73% by mass (e.g., at least about 74%, 75%, 76%, 77%, 78%, 79%, 80%, or 85% by mass) of the one or more additional VOCs can be 2-methyl-1-butanol. In some embodiments, the one or more additional VOCs can include no 2-methyl-1-butanol.

The one or more additional VOCs in a Scotch-like alcoholic beverage can include 2-methylbutyl acetate. In some embodiments, the 2-methylbutyl acetate can be present in an amount of about 0.03 to about 1.2 mg/L (e.g., about 0.03 to about 0.05 mg/L, about 0.03 to about 0.1 mg/L, about 0.05 to about 0.1 mg/L, about 0.1 to about 0.2 mg/L, about 0.2 to about 0.4 mg/L, about 0.4 to about 0.6 mg/L, about 0.6 to about 0.8 mg/L, about 0.8 to about 1.0 mg/L, or about 1.0 to about 1.2 mg/L). In some embodiments, the 2-methylbutyl acetate can be present in an amount of less than about 0.08 mg/L (e.g., less than about 0.07, 0.06, 0.05, or 0.04 mg/L). In some embodiments, about 0.0015% to about 0.2% by mass (e.g., about 0.0015% to about 0.005%, about 0.005% to about 0.01%, about 0.01% to about 0.05%, about 0.05% to about 0.1%, or about 0.1% to about 0.2% by mass) of the one or more additional VOCs can be 2-methylbutyl acetate. In some embodiments, the one or more additional VOCs can include no 2-methylbutyl acetate.

The one or more additional VOCs in a Scotch-like alcoholic beverage can include 2-methylbutyl isovalerate. In some embodiments, the 2-methylbutyl isovalerate can be present in an amount of about 0.0005 to a bout 0.006 mg/L (e.g., about 0.0005 to about 0.001 mg/L, about 0.001 to about 0.005, or about 0.001 to about 0.006 mg/L). In some embodiments, about 0.000008% to about 0.0008% (e.g., about 0.000008% to about 0.00001%, about 0.00001% to about 0.00005%, about 0.00005% to about 0.0001%, about 0.0001% to about 0.0005%, or about 0.0001% to about 0.0008%) by mass of the one or more additional VOCs can be 2-methylbutyl isovalerate. In some embodiments, the one or more additional VOCs can include no 2-methylbutyl isovalerate.

The one or more additional VOCs in a Scotch-like alcoholic beverage can include 2-methylbutyraldehyde. In some embodiments, the 2-methylbutyraldehyde can be present in an amount of about 0.0003 to about 13 mg/L (e.g., about 0.0003 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.2 mg/L, about 0.1 to about 0.5 mg/L, about 0.5 to about 1 mg/L, about 1 to about 2 mg/L, about 1 to about 5 mg/L, about 5 to about 10 mg/L, or about 5 to about 13 mg/L). In some embodiments, the 2-methylbutyraldehyde can be present in an amount of less than about 0.012 mg/L (e.g., less than about 0.01 mg/L, 0.005 mg/L, 0.001 mg/L, or 0.0005 mg/L). In some embodiments, the 2-methylbutyraldehyde can be present in an amount of at least about 0.15 mg/L (e.g., at least about 0.17 mg/L, 0.19 mg/L, 0.2 mg/L, 0.21 mg/L, 0.23 mg/L, or 0.25 mg/L). In some embodiments, about 0.000003% to about 1.8% by mass (e.g., about 0.000003% to about 0.00001%, about 0.00001% to about 0.0001%, about 0.0001% to about 0.001%, about 0.001% to about 0.01%, about 0.01% to about 0.02%, about 0.02% to 0.05%, about 0.05% to about 0.1%, about 0.1% to about 0.2%, about 0.1% to about 0.3%, about 0.1% to about 0.5%, about 0.5% to about 1.0%, about 1.0% to about 1.5%, or about 1.0% to about 1.8% by mass) of the one or more additional VOCs can be 2-methylbutyraldehyde. In some embodiments, less than about 0.0002% by mass (e.g., less than about 0.0003%, 0.0002%, 0.0001% or 0.00005% by mass) of the one or more additional VOCs can be 2-methylbutyraldehyde. In some embodiments, at least about 0.02% by mass (e.g., at least about 0.03%, 0.04%, 0.05%, 0.06%, 0.07%, 0.08%, 0.09%, 0.1%, 0.2%, or 0.3% by mass) of the one or more additional VOCs can be 2-methylbutyraldehyde. In some embodiments, the one or more additional VOCs can include no 2-methylbutyraldehyde.

The one or more additional VOCs in a Scotch-like alcoholic beverage can include 2-nonanol. In some embodiments, the 2-nonanol can be present in an amount of about 0.025 mg/L to about 0.3 mg/L (e.g., about 0.025 to about 0.05 mg/L, about 0.05 to about 0.1 mg/L, about 0.1 to about 0.2 mg/L, about 0.1 to about 0.3 mg/L, or about 0.2 to about 0.3 mg/L). In some embodiments, about 0.0004% to about 0.04% by mass (e.g., about 0.0004% to about 0.001%, about 0.0005% to about 0.001%, about 0.001% to about 0.005%, about 0.005% to about 0.01%, about 0.01% to about 0.04%, about 0.01% to about 0.03%, or about 0.02% to about 0.04% by mass) of the one or more additional VOCs can be 2-nonanol. In some embodiments, the one or more additional VOCs can include no 2-nonanol.

The one or more additional VOCs in a Scotch-like alcoholic beverage can include 2-nonanone. In some embodiments, the 2-nonanone can be present in an amount of about 0.0008 to about 0.2 mg/L (e.g., about 0.0008 to about 0.001 mg/L, about 0.001 to about 0.002 mg/L, about 0.002 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, the 2-nonanone can be present in an amount of less than about 0.012 mg/L (e.g., less than about 0.01 mg/L or less than 0.005 mg/L). In some embodiments, the 2-nonanone can be present in an amount of at least about 0.085 mg/L (e.g., at least about 0.09 mg/L, 0.10 mg/L, 0.12 mg/L, or 0.14 mg/L). In some embodiments, about 0.00002% to about 0.02% by mass (e.g., about 0.00002% to about 0.00005%, about 0.00005% to about 0.0001%, about 0.0001% to about 0.0005%, about 0.0005% to about 0.001%, about 0.001% to about 0.005%, about 0.005% to about 0.01%, or about 0.01% to about 0.02% by mass) of the one or more additional VOCs can be 2-nonanone. In some embodiments, at least about 0.011% by mass (e.g., at least about 0.012%, 0.013%, 0.014%, 0.015%, 0.016%, 0.017%, 0.018%, or 0.019% by mass) of the one or more additional VOCs can be 2-nonanone. In some embodiments, the one or more additional VOCs can include no 2-nonanone.

The one or more additional VOCs in a Scotch-like alcoholic beverage can include 2-phenylethanol. In some embodiments, the 2-phenylethanol can be present in an amount of about 0.16 to about 103 mg/L (e.g., about 0.16 to about 0.5 mg/L, about 0.5 to about 1 mg/L, about 1 to about 2 mg/L, about 2 to about 3 mg/L, about 3 to about 4 mg/L, about 4 to about 5 mg/L, about 5 to about 6 mg/L, about 5 to about 10 mg/L, about 10 to about 20 mg/L, about 20 to about 40 mg/L, about 40 to about 60 mg/L, about 60 to about 80 mg/L, about 80 to about 100 mg/L, or about 80 to about 103 mg/L. In some embodiments, about 0.002% to about 13% by mass (e.g., about 0.002% to about 0.005%, about 0.005% to about 0.01%, about 0.01% to about 0.1%, about 0.1% to about 1%, about 1% to about 2%, about 2% to about 3%, about 3% to about 5%, about 4% to about 6%, about 5% to about 7%, about 7% to about 9%, about 9% to about 11%, or about 11% to about 13% by mass) of the one or more additional VOCs can be 2-phenylethanol. In some embodiments, the one or more additional VOCs can include no 2-phenylethanol.

The one or more additional VOCs in a Scotch-like alcoholic beverage can include 2-phenylethylacetate. In some embodiments, the 2-phenylethylacetate can be present in an amount of about 0.03 to about 90 mg/L (e.g., about 0.03 to about 0.05 mg/L, about 0.05 to about 0.07 mg/L, about 0.07 to about 0.09 mg/L, about 0.08 to about 0.1 mg/L, about 0.1 to about 1 mg/L, about 1 to about 2 mg/L, about 2 to about 3 mg/L, about 3 to about 5 mg/L, about 5 to about 10 mg/L, about 10 to about 20 mg/L, about 20 to about 30 mg/L, about 30 to about 50 mg/L, about 50 to about 70 mg/L, or about 70 to about 90 mg/L). In some embodiments, the 2-phenylethylacetate can be present in an amount of less than about 0.066 mg/L (e.g., less than about 0.06 mg/L or 0.05 mg/L). In some embodiments, about 0.001% to about 12% by mass (e.g., about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, about 2% to about 5%, about 5% to about 10%, or about 10% to about 12% by mass) of the one or more additional VOCs can be 2-phenylethylacetate. In some embodiments, the one or more additional VOCs can include no 2-phenylethylacetate.

The one or more additional VOCs in a Scotch-like alcoholic beverage can include 2-undecanone. In some embodiments, the 2-undecanone can be present in an amount of about 0.0003 to about 0.02 mg/L (e.g., about 0.0003 to about 0.0005 mg/L, about 0.0005 to about 0.0010 mg/L, about 0.0010 to about 0.0015 mg/L, about 0.0015 to about 0.0020 mg/L, about 0.0020 to about 0.0025 mg/L about 0.0020 to about 0.0026 mg/L, about 0.001 to about 0.002 mg/L, about 0.001 to about 0.005 mg/L, about 0.005 to about 0.01 mg/L, or about 0.01 to about 0.02 mg/L). In some embodiments, the 2-undecanone can be present in an amount of at least about 0.0015 mg/L (e.g., at least about 0.0016 mg/L, 0.0017 mg/L, 0.0018 mg/L, 0.0019 mg/L, or 0.002 mg/L). In some embodiments, about 0.000004% to about 0.003% by mass (e.g., about 0.000004% to about 0.00001%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.003%, about 0.001% to about 0.002%, or about 0.002% to about 0.003% by mass) of the one or more additional VOCs can be 2-undecanone. In some embodiments, at least about 0.0002% by mass (e.g., at least about 0.0003%, 0.0004%, 0.0005%, 0.0006%, 0.0007%, 0.0008%, or 0.0009% by mass) of the one or more additional VOCs can be 2-undecanone. In some embodiments, the one or more additional VOCs can include no 2-undecanone.

The one or more additional VOCs in a Scotch-like alcoholic beverage can include 3-carene. In some embodiments, the 3-carene can be present in an amount of about 0.0002 to about 2.5 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.1 mg/L, about 0.1 to about 0.5 mg/L, about 0.5 to about 1.0 mg/L, about 1.0 to about 1.5 mg/L, about 1.5 to about 2.0 mg/L, or about 2.0 to about 2.5 mg/L). In some embodiments, about 0.0002% to about 2.5% by mass (e.g., about 0.0002% to about 0.001%, about 0.001% to about 0.005%, about 0.005% to about 0.01%, about 0.01% to about 0.05%, about 0.05%, to about 0.1%, about 0.1% to about 0.5%, about 0.5% to about 1.0%, about 1.0% to about 1.5%, about 1.5% to about 2.0%, or about 2.0% to about 2.5% by mass) of the one or more additional VOCs can be 3-carene. In some embodiments, the one or more additional VOCs can include no 3-carene.

The one or more additional VOCs in a Scotch-like alcoholic beverage can include 4-carvomenthenol. In some embodiments, the 4-carvomenthenol can be present in an amount of about 0.00003 to about 0.025 mg/L (e.g., about 0.00003 to about 0.0001 mg/L, about 0.0001 to about 0.0002 mg/L, about 0.0002 to about 0.0005 mg/L, about 0.0005 to about 0.001 mg/L, about 0.001 to about 0.005 mg/L, about 0.005 to about 0.01 mg/L, about 0.01 to about 0.02 mg/L, or about 0.02 to about 0.025 mg/L). In some embodiments, about 0.000009% to about 0.003% by mass (e.g., about 0.000009% to about 0.00005%, about 0.00001% to about 0.00005%, about 0.00005% to about 0.0001%, about 0.0001% to about 0.0005%, about 0.0005% to about 0.001%, about 0.001% to about 0.002%, or about 0.002% to about 0.003% by mass) of the one or more additional VOCs can be 4-carvomenthenol. In some embodiments, at least about 0.00035% by mass (e.g., at least about 0.0004%, 0.0005%, 0.0006%, 0.0007%, 0.0008%, 0.0009%, 0.001%, or 0.002% by mass) of the one or more additional VOCs can include 4-carvomenthenol. In some embodiments, the one or more additional VOCs can include no 4-carvomenthenol.

The one or more additional VOCs in a Scotch-like alcoholic beverage can include 4-ethyl guaiacol. In some embodiments, the 4-ethyl guaiacol can be present in an amount of about 0.001 to about 93 mg/L (e.g., about 0.001 to about 0.005 mg/L, about 0.005 to about 0.01 mg/L, 0.01 to about 0.02 mg/L, about 0.02 to about 0.04 mg/L, about 0.04 to about 0.06 mg/L, about 0.06 to about 0.08 mg/L, about 0.08 to about 0.1 mg/L, about 0.1 to about 0.5 mg/L, about 0.5 to about 1 mg/L, about 1 to about 2 mg/L, about 2 to about 5 mg/L, about 5 to about 10 mg/L, about 10 to about 20 mg/L, about 20 to about 30 mg/L, about 30 to about 50 mg/L, about 50 to about 70 mg/L, about 70 to about 90 mg/L, or about 70 to about 93 mg/L). In some embodiments, about 0.00002% to about 12% by mass (e.g., about 0.00002% to about 0.00005%, about 0.00005% to about 0.0001%, about 0.0001% to about 0.0005%, about 0.0005% to about 0.001%, about 0.001% to about 0.01%, about 0.01% to about 0.02%, about 0.02% to about 0.03%, about 0.03% to about 0.05%, about 0.05% to about 0.1%, about 0.1% to about 0.2%, about 0.2% to about 0.5%, about 0.5% to about 1%, about 1% to about 2%, about 2% to about 4%, about 4% to about 6%, about 6% to about 8%, about 8% to about 10%, or about 10% to about 12%) of the one or more additional VOCs can be 4-ethyl guaiacol. In some embodiments, the one or more additional VOCs can include no 4-ethyl guaiacol.

The one or more additional VOCs in a Scotch-like alcoholic beverage can include 4-ethyl phenol. In some embodiments, the 4-ethyl phenol can be present in an amount of about 0.0001 to about 40 mg/L (e.g., about 0.0001 to about 0.0005 mg/L, about 0.0005 to about 0.001 mg/L, about 0.001 to about 0.002 mg/L, about 0.002 to about 0.004 mg/L, about 0.004 to about 0.006 mg/L, about 0.006 to about 0.008 mg/L, about 0.008 to about 0.01 mg/L, about 0.01 to about 0.1 mg/L, about 0.1 to about 0.5 mg/L, about 0.5 to about 1 mg/L, about 1 to about 2 mg/L, about 2 to about 5 mg/L, about 5 to about 10 mg/L, about 10 to about 20 mg/L, about 20 to about 30 mg/L, about 25 to about 35 mg/L, or about 30 to about 40 mg/L). In some embodiments, the 4-ethyl phenol can be present in an amount of at least about 1.7 mg/L (e.g., at least about 1.8, 1.9, 2.0, 2.5, 3, 4, 5, 6, 8, 10, 15, 20, 25, 30, or 25 mg/L). In some embodiments, about 0.000002% to about 2.3% by mass (e.g., about 0.000002% to about 0.000005%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.1%, about 0.1% to about 0.5%, about 0.5% to about 1.0%, about 1.0% to about 1.5%, about 1.5% to about 2.0%, or about 2.0% to about 2.5% by mass) of the one or more additional VOCs can be 4-ethyl phenol. In some embodiments, at least about 0.25% by mass (e.g., at least about 0.3%, 0.4%, 0.5%, 0.6%, 0.7%, 0.8%, 0.9%, 1.0%, 1.2%, 1.4%, 1.6%, 1.8%, or 2.0% by mass) of the one or more additional VOCs can be 4-ethyl phenol. In some embodiments, the one or more additional VOCs can include no 4-ethyl phenol.

The one or more additional VOCs in a Scotch-like alcoholic beverage can include acetaldehyde. In some embodiments, the acetaldehyde can be present in an amount of about 0.03 to about 0.8 mg/L (e.g., about 0.03 to about 0.05 mg/L, about 0.05 to about 0.1 mg/L, about 0.1 to about 0.2 mg/L, about 0.2 to about 0.4 mg/L, about 0.4 to about 0.6 mg/L, about 0.6 to about 0.7 mg/L, or about 0.6 to about 0.8 mg/L). In some embodiments, about 0.01% to about 1% by mass (e.g., about 0.01% to about 0.1%, about 0.01% to about 0.05%, about 0.05% to about 0.1%, about 0.1% to about 0.2%, about 0.2% to about 0.4%, about 0.1% to about 0.5%, about 0.4% to about 0.6%, about 0.6% to about 0.8%, about 0.5% to about 1%, or about 0.8% to about 1% by mass) of the one or more additional VOCs can be acetaldehyde. In some embodiments, the one or more additional VOCs can include no acetaldehyde.

The one or more additional VOCs in a Scotch-like alcoholic beverage can include acetoin. In some embodiments, the acetoin can be present in an amount of about 0.01 to about 1.3 mg/L (e.g., about 0.01 to about 0.02 mg/L, about 0.02 to about 0.04 mg/L, about 0.04 to about 0.06 mg/L, about 0.06 to about 0.08 mg/L, about 0.08 to about 0.1 mg/L, about 0.1 to about 0.2 mg/L, about 0.2 to about 0.3 mg/L, about 0.3 to about 0.5 mg/L, about 0.5 to about 0.7 mg/L, about 0.7 to about 0.9 mg/L, about 0.9 to about 1.1 mg/L, or about 0.9 to about 1.3 mg/L). In some embodiments, about 0.008% to about 0.15% by mass (e.g., about 0.008% to about 0.01%, about 0.01% to about 0.03%, about 0.01% to about 0.05%, about 0.03% to about 0.05%, about 0.05% to about 0.07%, about 0.07% to about 0.09%, about 0.05% to about 0.1% about 0.09% to about 0.11%, about 0.11% to about 0.13%, about 0.10% to about 0.15%, or about 0.13% to about 0.15% by mass) of the one or more additional VOCs can be acetoin. In some embodiments, the one or more additional VOCs can include no acetoin.

The one or more additional VOCs in a Scotch-like alcoholic beverage can include amyl alcohol. In some embodiments, the amyl alcohol can be present in an amount of about 0.002 to about 0.8 mg/L (e.g., about 0.002 to about 0.005 mg/L, about 0.005 to about 0.01 mg/L, about 0.01 to about 0.05 mg/L, about 0.05 to about 0.1 mg/L, about 0.1 to about 0.2 mg/L, about 0.2 to about 0.3 mg/L, about 0.2 to about 0.4 mg/L, about 0.4 to about 0.6 mg/L, or about 0.6 to about 0.8 mg/L). In some embodiments, the amyl alcohol can be present in an amount of at least about 0.03 mg/L (e.g., at least about 0.04 mg/L, 0.05 mg/L, 0.07 mg/L, 0.09 mg/L, 0.1 mg/L, 0.2 mg/L, 0.3 mg/L, 0.4 mg/L, 0.5 mg/L, 0.6 mg/L, or 0.7 mg/L). In some embodiments, about 0.00003% to about 0.85% by mass (e.g., about 0.00003% to about 0.00005%, about 0.00005% to about 0.0001%, about 0.0001% to about 0.001%, about 0.001% to about 0.01%, about 0.01% to about 0.05%, about 0.05% to about 0.10%, about 0.10% to about 0.20%, about 0.20 to about 0.30%, about 0.30% to about 0.40%, about 0.40% to about 0.50%, about 0.1% to about 0.5%, about 0.5% to about 0.8%, about 0.50% to about 0.60%, about 0.60% to about 0.70%, about 0.70% to about 0.80%, or 0.80% to about 0.85% by mass) of the one or more additional VOCs can be amyl alcohol. In some embodiments, at least about 0.0045% by mass (e.g., at least about 0.0046%, 0.0047%, 0.0048%, 0.0049%, 0.005%, 0.006%, 0.007%, 0.008%, 0.009%, 0.01%, 0.05%, 0.1%, 0.2%, 0.3%, 0.4%, 0.5%, 0.6%, 0.7%, or 0.8% by mass) of the one or more additional VOCs can be amyl alcohol. In some embodiments, the one or more additional VOCs can include no amyl alcohol.

The one or more additional VOCs in a Scotch-like alcoholic beverage can include amyl butyrate. In some embodiments, the amyl butyrate can be present in an amount of about 0.0000006 to about 0.1 mg/L (e.g., about 0.0000006 to about 0.000001 mg/L, about 0.000001 to about 0.00001 mg/L, about 0.00001 to about 0.0001 mg/L, about 0.0001 to about 0.001 mg/L, about 0.001 to about 0.01 mg/L, about 0.01 to about 0.1 mg/L, about 0.01 to about 0.05 mg/L, or about 0.05 to about 0.1 mg/L). In some embodiments, about 0.0000002% to about 0.04% by mass (e.g., about 0.0000002% to about 0.0000005%, about 0.0000005% to about 0.000001%, about 0.000001% to about 0.000005%, about 0.000005% to about 0.00001%, about 0.00001% to about 0.00005%, about 0.00005% to about 0.0001%, about 0.0001% to about 0.0005%, about 0.001%, about 0.001% to about 0.005%, about 0.005% to about 0.01%, about 0.01% to about 0.04%, about 0.01% to about 0.02%, about 0.02% to about 0.03%, or about 0.03% to about 0.04% by mass) of the one or more additional VOCs can ben amyl butyrate. In some embodiments, the one or more additional VOCs can include no amyl butyrate.

The one or more additional VOCs in a Scotch-like alcoholic beverage can include alpha ionone. In some embodiments, the alpha ionone can be present in an amount of about 0.001 to about 0.002 mg/L. In some embodiments, about 0.00002% to about 0.0003% by mass (e.g., about 0.00002% to about 0.00005%, 0.00005% to about 0.0001%, about 0.0001% to about 0.0002%, or about 0.0002% to about 0.0003% by mass) of the one or more additional VOCs can be alpha ionone. In some embodiments, the one or more additional VOCs can include no alpha ionone.

The one or more additional VOCs in a Scotch-like alcoholic beverage can include a-phellandrene. In some embodiments, the a-phellandrene can be present in an amount of about 0.003 to about 0.006 mg/L (e.g., about 0.003 to about 0.004 mg/L, about 0.004 to about 0.005 mg/L, or about 0.005 to about 0.006 mg/L). In some embodiments, about 0.00003% to about 0.00020% by mass (e.g., about 0.00003% to about 0.00005%, about 0.00005% to about 0.00010%, about 0.00010% to about 0.00015%, or about 0.00015% to about 0.00020% by mass) of the one or more additional VOCs can be a-phellandrene. In some embodiments, the one or more additional VOCs can include no a-phellandrene.

The one or more additional VOCs in a Scotch-like alcoholic beverage can include (−)a-pinene (also called a-pinene, alpha-pinene, and (−)alpha-pinene). In some embodiments, the (−)a-pinene can be present in an amount of about 0.00015 to about 2.6 mg/L (e.g., about 0.00015 to about 0.001 mg/L, about 0.001 to about 0.01 mg/L, about 0.01 to about 0.1 mg/L, about 0.1 to about 0.5 mg/L, about 0.5 to about 1.0 mg/L, about 1.0 to about 1.5 mg/L, about 1.5 to about 2.0 mg/L, about 1.5 to about 2.5 mg/L, about 2.0 to about 2.5 mg/L, or about 2.0 to about 2.6 mg/L). In some embodiments, about 0.00018% to about 2.6% by mass (e.g., about 0.00018% to about 0.001%, about 0.001% to about 0.01%, about 0.01% to about 0.1%, about 0.1% to about 0.5%, about 0.5% to about 1.0%, about 1.0% to about 1.5%, about 1.5% to about 2.0%, about 1.5% to about 2.5%, about 2.0% to about 2.5%, or about 2.0% to about 2.6% by mass) of the one or more additional VOCs can be (−)a-pinene. In some embodiments, the one or more additional VOCs can include no (−)a-pinene.

The one or more additional VOCs in a Scotch-like alcoholic beverage can include a-terpineol. In some embodiments, the a-terpineol can be present in an amount of about 0.0005 to about 0.5 mg/L (e.g., about 0.0005 to about 0.001 mg/L, about 0.001 to about 0.005 mg/L, about 0.005 to about 0.01 mg/L, about 0.01 to about 0.03 mg/L, about 0.03 to about 0.05 mg/L, about 0.05 to about 0.07 mg/L, about 0.05 to about 0.1 mg/L, about 0.1 to about 0.2 mg/L, about 0.2 to about 0.3 mg/L, about 0.3 to about 0.4 mg/L, or about 0.4 to about 0.5 mg/L). In some embodiments, about 0.00001% to about 0.12% by mass (e.g., about 0.00001% to about 0.0001%, about 0.0001% to about 0.001%, about 0.001% to about 0.01%, about 0.01% to about 0.02%, about 0.02% to about 0.04%, about 0.04% to about 0.06%, about 0.01% to about 0.05% about 0.06% to about 0.08%, about 0.08% to about 0.10%, about 0.05% to about 0.1%, or about 0.10% to about 0.12% by mass) of the one or more additional VOCs can be a-terpineol. In some embodiments, at least about 0.055% by mass (e.g., at least about 0.06%, 0.07%, 0.08%, 0.09%, or 0.1% by mass) of the one or more additional VOCs can be a-terpineol. In some embodiments, the one or more additional VOCs can include no a-terpineol.

The one or more additional VOCs in a Scotch-like alcoholic beverage can include benzaldehyde. In some embodiments, the benzaldehyde can be present in an amount of about 0.00015 to about 2.3 mg/L (e.g., about 0.00015 to about 0.001 mg/L, about 0.001 to about 0.002 mg/L, about 0.002 to about 0.005 mg/L, about 0.005 to about 0.01 mg/L, about 0.001 to about 0.002 mg/L, about 0.001 to about 0.003 mg/L, about 0.003 to about 0.005 mg/L, about 0.01 to about 0.05 mg/L, about 0.05 to about 0.1 mg/L, about 0.1 to about 0.2 mg/L, about 0.1 to about 0.5 mg/L, about 0.5 to about 1.0 mg/L, about 1 to about 2 mg/L, about 1.0 to about 1.5 mg/L, about 1.5 to about 2.0 mg/L, or about 2.0 to about 2.3 mg/L). In some embodiments, the benzaldehyde can be present in an amount of less than about 0.003 mg/L (e.g., less than about 0.0025 mg/L, 0.0020 mg/L, 0.0015 mg/L, 0.0010 mg/L, or 0.0005 mg/L). In some embodiments, about 0.0000018% to about 0.4% by mass (e.g., about 0.0000018% to about 0.00001%, about 0.0001%, about 0.0001% to about 0.001%, about 0.001% to about 0.01%, about 0.01% to about 0.05%, about 0.05% to about 0.1%, about 0.1% to about 0.4%, about 0.1% to about 0.2%, about 0.1% to about 0.3%, or about 0.2% to about 0.4% by mass) of the one or more additional VOCs can be benzaldehyde. In some embodiments, at least about 0.05% by mass (e.g., at least about 0.06%, 0.07%, 0.08%, 0.09%, 0.1%, or 0.2% by mass) of the one or more additional VOCs can be benzaldehyde. In some embodiments, the one or more additional VOCs can include no benzaldehyde.

The one or more additional VOCs in a Scotch-like alcoholic beverage can include benzyl acetate. In some embodiments, the benzyl acetate can be present in an amount of about 0.0001 to about 0.003 mg/L (e.g., about 0.0001 to about 0.0005 mg/L, about 0.0005 to about 0.001 mg/L, about 0.001 to about 0.003 mg/L, about 0.001 to about 0.002 mg/L, or about 0.002 to about 0.003 mg/L). In some embodiments, about 0.000002% to about 0.0012% by mass (e.g., about 0.000002% to about 0.000005%, about 0.000005% to about 0.00001%, about 0.00001% to about 0.00005%, about 0.00005% to about 0.0001%, about 0.0001% to about 0.0005%, about 0.0005% to about 0.001%, about 0.0006% to about 0.0008%, about 0.0008% to about 0.0010%, or about 0.0010% to about 0.0012% by mass) of the one or more additional VOCs can be benzyl acetate. In some embodiments, at least about 0.00065% (e.g., at least about 0.0007%, 0.0008%, 0.0009%, or 0.001% by mass) of the one or more additional VOCs can be benzyl acetate. In some embodiments, the one or more additional VOCs can include no benzyl acetate.

The one or more additional VOCs in a Scotch-like alcoholic beverage can include beta-ionone. In some embodiments, the beta-ionone can be present in an amount of about 0.00004 to about 0.1 mg/L (e.g., about 0.00004 to about 0.00008 mg/L, about 0.00008 to about 0.00012 mg/L, about 0.00012 to about 0.00015 mg/L, about 0.00015 to about 0.0002 mg/L, about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.1 mg/L). In some embodiments, the beta-ionone can be present in an amount of at least about 0.0037 mg/L (e.g., at least about 0.004 mg/L, 0.005 mg/L, 0.006 mg/L, 0.007 mg/L, 0.008 mg/L, 0.009 mg/L, 0.01 mg/L, 0.02 mg/L, 0.03 mg/L, 0.04 mg/L, 0.05 mg/L, 0.06 mg/L, 0.07 mg/L, or 0.08 mg/L). In some embodiments about 0.000004% to about 0.008% by mass (e.g., about 0.000004% to about 0.00001%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.005%, about 0.001% to about 0.008%, or about 0.005% to about 0.008% by mass) of the one or more additional VOCs can be beta-ionone. In some embodiments, at least about 0.0005% by mass (e.g., at least about 0.0006%, 0.0007%, 0.0008%, 0.0009%, 0.001%, 0.002%, 0.003%, 0.004%, 0.005%, 0.006%, or 0.007% by mass) of the one or more additional VOCs can be beta-ionone. In some embodiments, at least about 0.00055% by mass (e.g., at least about 0.0006%, 0.0007%, 0.0008%, 0.0009%, 0.001%, 0.002%, 0.003%, 0.004%, 0.005%, 0.006%, or 0.007%) by mass of the one or more additional VOCs can be beta-ionone. In some embodiments, the one or more additional VOCs can include no beta-ionone.

The one or more additional VOCs in a Scotch-like alcoholic beverage can include (−)beta-pinene (also called beta-pinene or b-pinene). In some embodiments, the (−)beta-pinene can be present in an amount of about 0.000001 to about 0.09 mg/L (e.g., about 0.000001 to about 0.000005 mg/L, about 0.000005 to about 0.00001 mg/L, about 0.00001 to about 0.00002 mg/L, about 0.00002 to about 0.00004 mg/L, about 0.00004 to about 0.00006 mg/L, about 0.00006 to about 0.00008 mg/L, about 0.00008 to about 0.0001 mg/L, about 0.0001 to about 0.001 mg/L, about 0.001 to about 0.005 mg/L, about 0.005 to about 0.01 mg/L, about 0.01 to about 0.02 mg/L, about 0.02 to about 0.03 mg/L, about 0.03 to about 0.05 mg/L, about 0.05 to about 0.07 mg/L, or about 0.07 to about 0.09 mg/L). In some embodiments, about 0.000001% to about 0.01% by mass (e.g., about 0.000001% to about 0.00001%, about 0.00001% to about 0.00002%, about 0.00002% to about 0.00003%, about 0.00003% to about 0.00004%, about 0.00004% to about 0.00005%, about 0.00001% to about 0.00005%, about 0.00005% to about 0.0001%, about 0.0001% to about 0.0005%, about 0.0005% to about 0.001%, about 0.001% to about 0.005%, or about 0.005% to about 0.01% by mass) of the one or more additional VOCs can be (−)beta-pinene. In some embodiments, the one or more additional VOCs can include no (−)beta-pinene.

The one or more additional VOCs in a Scotch-like alcoholic beverage can include butanol (also called butyl alcohol). In some embodiments, the butanol can be present in an amount of about 0.1 to about 90 mg/L (e.g., about 0.1 to about 0.5 mg/L, about 0.5 to about 1.0 mg/L, about 1.0 to about 1.5 mg/L, about 1.5 to about 2 mg/L, about 2 to about 3 mg/L, about 3 to about 5 mg/L, about 5 to about 7 mg/L, about 7 to about 9 mg/L, about 9 to about 11 mg/L, about 10 to about 12 mg/L, about 11 to about 13 mg/L, about 13 to about 15 mg/L, about 15 to about 17 mg/L, about 17 to about 19 mg/L, about 19 to about 21 mg/L, about 21 to about 23 mg/L, about 1 to about 5 mg/L, about 5 to about 10 mg/L, about 10 to about 20 mg/L, about 20 to about 50 mg/L, or about 50 to about 90 mg/L). In some embodiments, the butanol can be present in an amount of less than about 3.3 mg/L (e.g., less than about 3 mg/L, 2.5 mg/L, 2 mg/L, 1.5 mg/L, 1 mg/L, 0.9 mg/L, 0.8 mg/L, 0.7 mg/L, 0.6 mg/L, 0.5 mg/L, 0.4 mg/L, or 0.2 mg/L). In some embodiments, about 0.02% to about 16% by mass (e.g., about 0.02% to about 0.05%, about 0.05% to about 0.1%, about 0.1% to about 0.5%, about 0.5% to about 1%, about 1% to about 2%, about 2% to about 4%, about 1% to about 5% about 4% to about 6%, about 6% to about 8%, about 8% to about 10%, about 5% to about 10%, about 10% to about 12%, about 12% to about 14%, about 10% to about 15%, or about 14% to about 16% by mass) of the one or more additional VOCs can be butanol. In some embodiments, less than about 0.1% by mass (e.g., less than about 0.09%, 0.08%, 0.07%, 0.06%, or 0.05% by mass) of the one or more additional VOCs can be butanol. In some embodiments, at least about 4.9% by mass (e.g., at least about 5%, 6%, 7%, 8%, 9%, 10%, 11%, or 12% by mass) of the one or more additional VOCs can be butanol. In some embodiments, the one or more additional VOCs can include no butanol.

The one or more additional VOCs in a Scotch-like alcoholic beverage can include butyl acetate. In some embodiments, the butyl acetate can be present in an amount of about 0.001 to about 1.3 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.3 mg/L, about 0.3 to about 0.5 mg/L, about 0.5 to about 0.7 mg/L, about 0.7 to about 0.9 mg/L, about 0.9 to about 1.1 mg/L, about 1.1 to about 1.3 mg/L, about 0.1 to about 1 mg/L, about 0.1 to about 0.5 mg/L, about 0.5 to about 1 mg/L, about 0.1 to about 1.3 mg/L, or about 0.5 to about 1.3 mg/L). In some embodiments, butyl acetate can be present in an amount of less than about 0.22 mg/L (e.g., less than about 0.2 mg/L, 0.1 mg/L, 0.5 mg/L, 0.1 mg/L, 0.05 mg/L, 0.01 mg/L, or 0.005 mg/L). In some embodiments, butyl acetate can be present in an amount of at least about 0.97 mg/L (e.g., at least about 0.98 mg/L, 0.99 mg/L, or 1 mg/L). In some embodiments, about 0.00001% to about 0.5% by mass (e.g., about 0.00001% to about 0.0001%, about 0.0001% to about 0.0005%, about 0.0005% to about 0.001%, about 0.001% to about 0.005%, about 0.005% to about 0.01%, about 0.01% to about 0.02%, about 0.02% to about 0.04%, about 0.04% to about 0.06%, about 0.06% to about 0.08%, about 0.08% to about 0.1%, about 0.01% to about 0.05%, about 0.05% to about 0.1%, about 0.1% to about 0.5%, about 0.1% to about 0.2%, about 0.2% to about 0.3%, about 0.3% to about 0.4%, or about 0.4% to about 0.5% by mass) of the one or more additional VOCs can be butyl acetate. In some embodiments, at least about 0.14% by mass (e.g., at least about 0.15%, 0.16%, 0.17%, 0.18%, 0.19%, 0.2%, 0.3%, or 0.4% by mass) of the one or more additional VOCs can be butyl acetate. In some embodiments, the one or more additional VOCs can include no butyl acetate.

The one or more additional VOCs in a Scotch-like alcoholic beverage can include butyl formate. In some embodiments, the butyl formate can be present in an amount of about 0.007 to about 1 mg/L (e.g., about 0.007 to about 0.01 mg/L, about 0.01 to about 0.02 mg/L, about 0.02 to about 0.05 mg/L, about 0.05 to about 0.1 mg/L, about 0.1 to about 0.2 mg/L, about 0.2 to about 0.4 mg/L, about 0.4 to about 0.6 mg/L, about 0.6 to about 0.8 mg/L, or about 0.8 to about 1 mg/L). In some embodiments, about 0.0001% to about 1% by mass (e.g., about 0.0001% to about 0.0005%, 0.0005% to about 0.001%, about 0.001% to about 0.005%, about 0.005% to about 0.01%, about 0.01% to about 0.02%, about 0.02% to about 0.03%, about 0.03% to about 0.04%, about 0.04% to about 0.05%, about 0.01% to about 0.05%, about 0.05% to about 0.1%, about 0.1% to about 0.2%, about 0.2% to about 0.3%, about 0.3% to about 0.4%, about 0.4% to about 0.5%, about 0.1% to about 0.5%, about 0.5% to about 0.6%, about 0.6% to about 0.7%, about 0.7% to about 0.8%, about 0.8% to about 0.9%, about 0.5% to about 1%, or about 0.9% to about 1% by mass) of the one or more additional VOCs can be butyl formate. In some embodiments, the one or more additional VOCs can include no butyl formate.

The one or more additional VOCs in a Scotch-like alcoholic beverage can include butyric acid. In some embodiments, the butyric acid can be present in an amount of about 0.0007 to about 3.8 mg/L (e.g., about 0.0007 to about 0.001 mg/L, about 0.001 to about 0.005 mg/L, about 0.005 to about 0.01 mg/L, about 0.01 to about 0.02 mg/L, about 0.02 to about 0.03 mg/L, about 0.03 to about 0.05 mg/L, about 0.05 to about 0.1 mg/L, 0.1 to about 0.2 mg/L, about 0.2 to about 0.5 mg/L, about 0.5 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.5 mg/L, or about 3.5 to about 3.8 mg/L). In some embodiments, the butyric acid can be present in an amount of at least about 2 mg/L (e.g., at least about 2.1 mg/L, 2.2 mg/L, 2.3 mg/L, 2.4 mg/L, 2.5 mg/L, 2.6 mg/L, 2.7 mg/L, 2.8 mg/L, 2.9 mg/L, 3.0 mg/L, 3.2 mg/L, 3.4 mg/L, or 3.6 mg/L). In some embodiments, about 0.0003% to about 0.5% by mass (e.g., about 0.0003% to about 0.001%, about 0.001% to about 0.005%, about 0.005% to about 0.01%, about 0.01% to about 0.02%, about 0.02% to about 0.03%, about 0.03% to about 0.05%, about 0.01% to about 0.5%, about 0.05% to about 0.1%, about 0.1% to about 0.2%, about 0.2% to about 0.3%, about 0.1% to about 0.5%, about 0.1% to about 0.3%, about 0.3% to about 0.5%, or about 0.2% to about 0.4% by mass) of the one or more additional VOCs can be butyric acid. In some embodiments, the one or more additional VOCs can include no butyric acid.

The one or more additional VOCs in a Scotch-like alcoholic beverage can include carvone. In some embodiments, the carvone can be present in an amount of about 0.0007 to about 0.015 mg/L (e.g., about 0.0007 to about 0.001 mg/L, about 0.001 to about 0.005 mg/L, about 0.005 to about 0.010 mg/L, about 0.010 to about 0.015 mg/L, or about 0.005 to about 0.015 mg/L). In some embodiments, the carvone can be present in an amount of at least about 0.0025 mg/L (e.g., at least about 0.003 mg/L, 0.004 mg/L, 0.005 mg/L, 0.006 mg/L, 0.007 mg/L, 0.008 mg/L, 0.009 mg/L, or 0.01 mg/L). In some embodiments, about 0.00001% to about 0.006% by mass (e.g., about 0.00001% to about 0.00005%, about 0.00005% to about 0.0001%, about 0.0001% to about 0.0005%, about 0.0005% to about 0.001%, about 0.001% to about 0.005%, about 0.001% to about 0.006%, about 0.001% to about 0.002%, about 0.002% to about 0.004%, or about 0.004% to about 0.006% by mass) of the one or more additional VOCs can be carvone. In some embodiments, at least about 0.00035% by mass (e.g., at least about 0.0004%, 0.0005%, 0.0006%, 0.0007%, 0.0008%, 0.0009%, 0.001%, 0.002%, 0.003%, 0.004%, or 0.005% by mass) of the one or more additional VOCs can be carvone. In some embodiments, the one or more additional VOCs can include no carvone.

The one or more additional VOCs in a Scotch-like alcoholic beverage can include cinnamaldehyde. In some embodiments, the cinnamaldehyde can be present in an amount of about 0.000007 to about 0.7 mg/L (e.g., about 0.000007 to about 0.00001 mg/L, about 0.00001 to about 0.0001 mg/L, about 0.0001 to about 0.001 mg/L, about 0.001 mg/L to about 0.1 mg/L, about 0.1 mg/L to about 0.3 mg/L, about 0.3 to about 0.5 mg/L, or about 0.5 to about 0.7 mg/L). In some embodiments, the cinnamaldehyde can be present in an amount of less than about 0.00009 mg/L (e.g., less than about 0.00008 mg/L, 0.00007 mg/L, 0.00006 mg/L, 0.00005 mg/L, 0.00004 mg/L, 0.00003 mg/L, or 0.00002 mg/L). In some embodiments, the cinnamaldehyde can be present in an amount of at least about 0.04 mg/L (e.g., at least about 0.05 mg/L, 0.06 mg/L, 0.07 mg/L, 0.08 mg/L, 0.09 mg/L, 0.1 mg/L, 0.2 mg/L, 0.3 mg/L, 0.4 mg/L, 0.5 mg/L, or 0.6 mg/L). In some embodiments, about 0.000002% to about 0.035% by mass (e.g., about 0.000002% to about 0.000005%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.005%, about 0.005% to about 0.010%, about 0.010% to about 0.020%, about 0.020% to about 0.030%, or about 0.030% to about 0.035% by mass) of the one or more additional VOCs can be cinnamaldehyde. In some embodiments, at least about 0.006% by mass (e.g., at least about 0.007%, 0.008%, 0.009%, 0.01%, 0.02%, or 0.03% by mass) of the one or more additional VOCs can be cinnamaldehyde. In some embodiments, the one or more additional VOCs can include no cinnamaldehyde.

The one or more additional VOCs in a Scotch-like alcoholic beverage can include cis-3-hexen-1-ol. In some embodiments, the cis-3-hexen-1-ol can be present in an amount of about 0.045 to about 0.12 mg/L (e.g., about 0.045 to about 0.05 mg/L, about 0.05 to about 0.06 mg/L, about 0.06 to about 0.07 mg/L, about 0.07 to about 0.08 mg/L, about 0.08 to about 0.09 mg/L, about 0.09 to about 0.10 mg/L, about 0.10 to about 0.11 mg/L, or about 0.11 to about 0.12 mg/L). In some embodiments, about 0.0007% to about 0.02% by mass (e.g., about 0.0007% to about 0.001%, about 0.001% to about 0.002%, about 0.002% to about 0.005%, about 0.001% to about 0.005%, about 0.005% to about 0.01%, or about 0.01% to about 0.02% by mass) of the one or more additional VOCs can be cis-3-hexen-1-ol. In some embodiments, the one or more additional VOCs can include no cis-3-hexen-1-ol.

The one or more additional VOCs in a Scotch-like alcoholic beverage can include cis-3-hexenyl acetate. In some embodiments, the cis-3-hexenyl acetate can be present in an amount of about 0.0005 to about 0.002 mg/L (e.g., about 0.0005 to about 0.0006 mg/L, about 0.0006 to about 0.0008 mg/L, about 0.0008 to about 0.001 mg/L, or about 0.001 to about 0.002 mg/L). In some embodiments, about 0.000008% to about 0.0003% by mass (e.g., about 0.000008% to about 0.00001%, about 0.00001% to about 0.00002%, about 0.00002% to about 0.00005%, about 0.00005% to about 0.0001%, about 0.0001% to about 0.0002%, about 0.0001% to about 0.0003%, or about 0.0002% to about 0.0003% by mass) of the one or more additional VOCs can be cis-3-hexenyl acetate. In some embodiments, the one or more additional VOCs can include no cis-3-hexenyl acetate.

The one or more additional VOCs in a Scotch-like alcoholic beverage can include (−)cis-rose oxide (also called cis-rose oxide or (−)-cis-rose oxide). In some embodiments, the (−)cis-rose oxide can be present in an amount of about 0.00009 to about 0.0003 mg/L (e.g., about 0.00009 to about 0.0001 mg/L, about 0.0001 to about 0.0002 mg/L, about 0.0002 to about 0.0003 mg/L). In some embodiments, about 0.0000015% to about 0.00005% by mass (e.g., about 0.0000015% to about 0.000005%, about 0.000005% to about 0.00001%, about 0.00001% to about 0.00002%, about 0.00002% to about 0.00003%, about 0.00003% to about 0.00004%, about 0.00001% to about 0.00005%, or about 0.00004% to about 0.00005% by mass) of the one or more additional VOCs can be (−)cis-rose oxide. In some embodiments, the one or more additional VOCs can include no (−)cis-rose oxide.

The one or more additional VOCs in a Scotch-like alcoholic beverage can include citronellol. In some embodiments, the citronellol can be present in an amount of about 0.00003 to about 2.5 mg/L (e.g., about 0.00003 to about 0.00005 mg/L, about 0.00005 to about 0.0001 mg/L, about 0.0001 to about 0.0001 to about 0.0002 mg/L, about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1.0 mg/L, about 1.0 to about 1.5 mg/L, about 1.5 to about 2.0 mg/L, or about 2.0 to about 2.5 mg/L). In some embodiments, the citronellol can be present in an amount of less than about 0.0002 mg/L (e.g., less than about 0.0001 mg/L, 0.00009 mg/L, 0.00008 mg/L, 0.00007 mg/L, 0.00006 mg/L, or 0.00005 mg/L). In some embodiments, the citronellol can be present in an amount of at least about 0.046 mg/L (e.g., at least about 0.05 mg/L, 0.06 mg/L, 0.07 mg/L, 0.08 mg/L, 0.09 mg/L, 0.1 mg/L, 0.2 mg/L, 0.3 mg/L, 0.4 mg/L, 0.5 mg/L, 0.6 mg/L, 0.7 mg/L, 0.8 mg/L, 0.9 mg/L, 1.0 mg/L, 1.2 mg/L, 1.4 mg/L, 1.6 mg/L, 1.8 mg/L, or 2.0 mg/L). In some embodiments, about 0.000005% to about 2.5% by mass (e.g., about 0.000005% to about 0.00001%, about 0.00001% to about 0.0001%, about 0.0001% to about 0.0005%, about 0.0005% to about 0.001%, about 0.001% to about 0.005%, about 0.005% to about 0.01%, about 0.01% to about 0.02%, about 0.02% to about 0.03%, about 0.03% to about 0.05%, about 0.01% to about 0.05%, about 0.05% to about 0.1%, about 0.1% to about 0.5%, about 0.5% to about 0.5% to about 1.0%, about 1.0% to about 1.5%, about 1.5% to about 2.0%, or about 2.0% to about 2.5% by mass) of the one or more additional VOCs can be citronellol. In some embodiments, at least about 0.0065% by mass (e.g., at least about 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.5%, or 2.0% by mass) of the one or more additional VOCs can be citronellol. In some embodiments, the one or more additional VOCs can include no citronellol.

The one or more additional VOCs in a Scotch-like alcoholic beverage can include damascenone (also sometimes called beta-damascenone). In some embodiments, the damascenone can be present in an amount of about 0.015 to about 28 mg/L (e.g., about 0.015 to about 0.05 mg/L, about 0.05 to about 0.1 mg/L, about 0.1 to about 0.2 mg/L, about 0.2 to about 0.5 mg/L, about 0.5 to about 1 mg/L, about 1 to about 2 mg/L, about 2 to about 5 mg/L, about 5 to about 10 mg/L, about 10 to about 15 mg/L, about 15 to about 20 mg/L, about 20 to about 25 mg/L, or about 25 to about 28 mg/L). In some embodiments, the damascenone can be present in an amount of at least about 0.1 mg/L (e.g., at least about 0.14 mg/L, 0.15 mg/L, 0.16 mg/L, 0.17 mg/L, 0.18 mg/L, 0.19 mg/L, 0.2 mg/L, 0.3 mg/L, 0.4 mg/L 0.5 mg/L, 0.6 mg/L, 0.7 mg/L, 0.8 mg/L, 0.9 mg/L, 1 mg/L, 2 mg/L, 3 mg/L, 4 mg/L, 5 mg/L, 10 mg/L, 15 mg/L, or 20 mg/L). In some embodiments, about 0.0002% to about 3.8% by mass (e.g., about 0.0002% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.2%, about 0.2% to about 0.4%, about 0.1% to about 0.5%, about 0.4% to about 0.6%, about 0.6% to about 0.8%, about 0.8% to about 1.0%, about 0.5% to about 1.0%, about 1.0% to about 2.0%, about 1.0% to about 3.0%, about 2.0% to about 3.0%, about 2.0% to about 3.8%, or about 3.0% to about 3.8% by mass) of the one or more additional VOCs can be damascenone. In some embodiments, at least about 0.015% by mass (e.g., at least about 0.02%, 0.03%, 0.04%, 0.05%, 0.06%, 0.07%, 0.08%, 0.09%, 0.1%, 0.2%, 0.3%, 0.4%, 0.5%, 0.6%, or 0.7% by mass) of the one or more additional VOCs can be damascenone. In some embodiments, the one or more additional VOCs can include no damascenone.

The one or more additional VOCs in a Scotch-like alcoholic beverage can include decanoic acid. In some embodiments, the decanoic acid can be present in an amount of about 0.02 to about 90 mg/L (e.g., about 0.02 to about 0.05 mg/L, about 0.05 to about 0.1 mg/L, about 0.1 to about 0.5 mg/L, about 0.5 mg/L to about 1 mg/L, about 1 to about 2 mg/L, about 2 to about 5 mg/L, about 5 to about 10 mg/L, about 10 to about 15 mg/L, about 10 to about 20 mg/L, about 15 to about 20 mg/L, about 20 to about 25 mg/L, about 20 to about 30 mg/L, about 25 to about 30 mg/L, about 20 to about 40 mg/L, about 40 to about 60 mg/L, about 60 to about 80 mg/L, about 10 to about 30 mg/L, about 30 to about 50 mg/L, about 50 to about 70 mg/L, or about 70 to about 90 mg/L). In some embodiments, the decanoic acid can be present in an amount of less than about 1.7 mg/L (e.g., less than about 1.6 mg/L, 1.5 mg/L, 1.4 mg/L, 1.3 mg/L, 1.2 mg/L, 1.1 mg/L, 1.0 mg/L, 0.9 mg/L, 0.7 mg/L, 0.5 mg/L, 0.3 mg/L, 0.1 mg/L, or 0.05 mg/L). In some embodiments, about 0.0002% to about 28% by mass (e.g., about 0.0002% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, about 1% to about 5%, about 5% to about 10%, about 10% to about 15%, about 15% to about 20%, about 10% to about 20%, about 20% to about 25%, about 20% to about 28%, or about 25% to about 28% by mass) of the one or more additional VOCs can be decanoic acid. In some embodiments, less than about 0.026% by mass (e.g., less than about 0.025%, 0.024%, 0.023%, 0.022%, 0.021%, 0.020%, 0.015%, 0.010%, 0.008%, 0.006%, or 0.004% by mass) of the one or more additional VOCs can be decanoic acid. In some embodiments, the one or more additional VOCs can include no decanoic acid.

The one or more additional VOCs in a Scotch-like alcoholic beverage can include delta-decalactone. In some embodiments, the delta-decalactone can be present in an amount of about 0.002 to about 5.2 mg/L (e.g., about 0.002 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.5 mg/L, about 3.5 to about 4.0 mg/L, about 4.0 to about 4.5 mg/L, about 4.5 to about 5.0 mg/L, or about 4.5 to about 5.2 mg/L). In some embodiments, the delta-decalactone can be present in an amount of less than about 0.013 mg/L (e.g., less than about 0.012 mg/L, 0.011 mg/L, 0.010 mg/L, 0.008 mg/L, 0.006 mg/L, or 0.004 mg/L). In some embodiments, the delta-decalactone can be present in an amount of at least about 0.27 mg/L (e.g., at least about 0.28 mg/L, 0.3 mg/L, 0.4 mg/L, 0.5 mg/L, 0.6 mg/L, 0.7 mg/L, 0.8 mg/L, 0.9 mg/L, 1.0 mg/L, 1.5 mg/L, 2.0 mg/L, 2.5 mg/L, 3.0 mg/L, 3.5 mg/L, 4.0 mg/L, 4.5 mg/L, or 5.0 mg/L). In some embodiments, about 0.00002% to about 5.7% by mass (e.g., about 0.00002% to about 0.0001%, about 0.0001% to about 0.001%, about 0.001% to about 0.01%, about 0.01% to about 0.1%, about 0.1% to about 0.5%, about 0.5% to about 1.0%, about 1.0% to about 1.5%, about 1.5% to about 2.0%, about 2.0% to about 2.5%, about 2.5% to about 3.0%, about 3.0% to about 3.5%, about 3.5% to about 4.0%, about 4.0% to about 4.5%, about 4.5% to about 5.0%, about 5.0% to about 5.5%, or about 5.0% to about 5.7% by mass) of the one or more additional VOCs can be delta-decalactone. In some embodiments, at least about 0.04% by mass (e.g., at least about 0.05%, 0.06%, 0.07%, 0.08%, 0.09%, 0.1%, 0.2%, 0.4%, 0.5%, 0.6%, 0.8%, 1.0%, 1.5%, 2.0%, 2.5%, 3.0%, 3.5%, 4.0%, 4.5%, or 5.0% by mass) of the one or more additional VOCs can be delta-decalactone. In some embodiments, the one or more additional VOCs can include no delta-decalactone.

The one or more additional VOCs in a Scotch-like alcoholic beverage can include diethyl succinate. In some embodiments, the diethyl succinate can be present in an amount of about 0.025 to about 15 mg/L (e.g., about 0.025 to about 0.05 mg/L, about 0.05 to about 0.1 mg/L, about 0.1 to about 0.5 mg/L, about 0.5 to about 1 mg/L, about 1 to about 2 mg/L, about 2 to about 3 mg/L, about 3 to about 5 mg/L, about 5 to about 7 mg/L, about 7 to about 9 mg/L, about 9 to about 11 mg/L, about 11 to about 13 mg/L, or about 13 to about 15 mg/L). In some embodiments, the diethyl succinate can be present in an amount of less than about 0.3 mg/L (e.g., less than about 0.2 mg/L, 0.1 mg/L, 0.09 mg/L, 0.08 mg/L, 0.07 mg/L, 0.06 mg/L, 0.05 mg/L, 0.04 mg/L, or 0.03 mg/L). In some embodiments, about 0.002% to about 2.0% by mass (e.g., about 0.002% to about 0.005%, about 0.005% to about 0.01%, about 0.01% to about 0.05%, about 0.05% to about 0.1%, about 0.1% to about 0.2%, about 0.2% to about 0.5%, about 0.5% to about 1.0%, about 1.0% to about 1.5%, about 1% to about 2%, or about 1.5% to about 2.0% by mass) of the one or more additional VOCs can be diethyl succinate. In some embodiments, less than about 0.035% by mass (e.g., less than about 0.03%, 0.02%, 0.01%, 0.009%, 0.008%, 0.007%, 0.006%, 0.005%, 0.004%, or 0.003% by mass) of the one or more additional VOCs can be diethyl succinate. In some embodiments, the one or more additional VOCs can include no diethyl succinate.

The one or more additional VOCs in a Scotch-like alcoholic beverage can include dimethylsulfide. In some embodiments, the dimethylsulfide can be present in an amount of about 0.01 to about 0.07 mg/L (e.g., about 0.01 to about 0.03 mg/L, about 0.03 to about 0.05 mg/L, or about 0.05 to about 0.07 mg/L). In some embodiments, about 0.0001% to about 0.009% by mass (e.g., about 0.0001% to about 0.0005%, about 0.0005% to about 0.001%, about 0.001% to about 0.002%, about 0.002% to about 0.003%, about 0.001% to about 0.004%, about 0.003% to about 0.004%, about 0.001% to about 0.009%, about 0.001% to about 0.005%, about 0.005% to about 0.009%, about 0.005% to about 0.007%, or about 0.007% to about 0.009% by mass) of the one or more additional VOCs can be dimethylsulfide. In some embodiments, the one or more additional VOCs can include no dimethylsulfide.

The one or more additional VOCs in a Scotch-like alcoholic beverage can include ethyl acetate. In some embodiments, the ethyl acetate can be present in an amount of about 2.5 mg/L to about 10 g/L (e.g., about 2.5 to about 5 mg/L, about 5 to about 10 mg/L, about 10 to about 20 mg/L, about 20 to about 40 mg/L, about 40 to about 60 mg/L, about 60 to about 80 mg/L, about 80 to about 100 mg/L, about 100 to about 150 mg/L, about 150 to about 200 mg/L, about 200 to about 300 mg/L, about 300 to about 500 mg/L, about 500 mg/L to about 1 g/L, about 1 to about 2 g/L, about 2 to about 4 g/L, about 4 to about 6 g/L, about 6 to about 8 g/L, or about 8 to about 10 g/L). In some embodiments, the ethyl acetate can be present in an amount of less than about 42 mg/L (e.g., less than about 40 mg/L, 35 mg/L, 30 mg/L, 25 mg/L, 20 mg/L, 15 mg/L, 10 mg/L, or 5 mg/L). In some embodiments, the ethyl acetate can be present in an amount of at least about 780 mg/L (e.g., at least about 800 mg/L, 1 g/L, 2 g/L, 3 g/L, 4 g/L, 5 g/L, 6 g/L, 7 g/L, or 8 g/L). In some embodiments, about 1% to about 90% by mass (e.g., about 1% to about 2%, about 2% to about 4%, about 1.9% to about 5%, about 4% to about 6%, about 6% to about 8%, about 8% to about 10%, about 5% to about 10%, about 10% to about 12%, about 12% to about 15%, about 10% to about 15%, about 10% to about 20%, about 15% to about 20%, about 20% to about 25%, about 25% to about 30%, about 20% to about 30%, about 30% to about 40%, about 40% to about 50%, about 50% to about 60%, about 60% to about 70%, about 70% to about 80%, or about 80% to about 90% by mass) of the one or more additional VOCs can be ethyl acetate. In some embodiments, at least about 77% by mass (e.g., at least about 78%, 79%, 80%, 81%, 82%, 83%, 84%, 85%, 86%, 87%, 88%, or 89% by mass) of the one or more additional VOCs can be ethyl acetate. In some embodiments, the one or more additional VOCs can include no ethyl acetate.

The one or more additional VOCs in a Scotch-like alcoholic beverage can include ethyl butanoate (also called ethyl butyrate). In some embodiments, the ethyl butanoate can be present in an amount of about 0.02 to about 4.5 mg/L (e.g., about 0.02 to about 0.03 mg/L, about 0.03 to about 0.05 mg/L, about 0.05 to about 0.07 mg/L, about 0.07 to about 0.09 mg/L, about 0.09 to about 0.1 mg/L, about 0.1 to about 0.2 mg/L, about 0.2 to about 0.5 mg/L, about 0.5 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.5 mg/L, about 3.5 to about 4.0 mg/L, about 4.0 to about 4.5 mg/L, about 1 to about 4 mg/L, about 1 to about 2 mg/L, about 1 to about 3 mg/L, or about 2 to about 4 mg/L). In some embodiments, the ethyl butanoate can be present in an amount of less than about 0.14 mg/L (e.g., less than about 0.13 mg/L, 0.12 mg/L, 0.11 mg/L, 0.10 mg/L, 0.09 mg/L, 0.08 mg/L, 0.07 mg/L, or 0.06 mg/L). In some embodiments, the ethyl butanoate can be present in an amount of at least about 2.1 mg/L (e.g., at least about 2.2 mg/L, 2.3 mg/L, 2.4 mg/L, or 2.5 mg/L). In some embodiments, about 0.002% to about 0.6% by mass (e.g., about 0.002% to about 0.005%, about 0.005% to about 0.01%, about 0.01% to about 0.05%, about 0.05% to about 0.1%, about 0.1% to about 0.2%, about 0.1% to about 0.3%, about 0.2% to about 0.3%, about 0.1% to about 0.5%, about 0.1% to about 0.6%, about 0.2% to about 0.4%, about 0.4% to about 0.6%, or about 0.3% to about 0.5% by mass) of the one or more additional VOCs can be ethyl butanoate. In some embodiments, less than about 0.004% by mass (e.g., less than about 0.003% by mass) of the one or more additional VOCs can be ethyl butanoate. In some embodiments, the one or more additional VOCs can include no ethyl butanoate.

The one or more additional VOCs in a Scotch-like alcoholic beverage can include ethyl cinnamate. In some embodiments, the ethyl cinnamate can be present in an amount of about 0.00003 to about 0.016 mg/L (e.g., about 0.00003 to about 0.00005 mg/L, about 0.00005 to about 0.0001 mg/L, about 0.0001 to about 0.0002 mg/L, about 0.0002 to about 0.0005 mg/L, about 0.0005 to about 0.001 mg/L, about 0.001 to about 0.002 mg/L, about 0.002 to about 0.004 mg/L, about 0.004 to about 0.006 mg/L, about 0.006 to about 0.008 mg/L, about 0.008 to about 0.010 mg/L, about 0.010 to about 0.012 mg/L, about 0.012 to about 0.014 mg/L, or about 0.014 to about 0.016 mg/L). In some embodiments, the ethyl cinnamate can be present in an amount of less than about 0.00035 mg/L (e.g., less than about 0.0003 mg/L, 0.0002 mg/L, or 0.0001 mg/L). In some embodiments, about 0.000008% to about 0.015% by mass (e.g., about 0.000008% to about 0.00001%, about 0.00001% to about 0.00005%, about 0.00005% to about 0.0001%, about 0.0001% to about 0.0005%, about 0.0005% to about 0.001%, about 0.001% to about 0.003%, about 0.003% to about 0.005%, about 0.001% to about 0.005%, about 0.005% to about 0.01%, about 0.010% to about 0.015%, about 0.005% to about 0.007%, about 0.007% to about 0.009%, about 0.009% to about 0.011%, about 0.011% to about 0.013%, or about 0.013% to about 0.015% by mass) of the one or more additional VOCs can be ethyl cinnamate. In some embodiments, at least about 0.0034% by mass (e.g., at least about 0.0035%, 0.004%, 0.005%, 0.006%, 0.007%, 0.008%, 0.009%, or 0.01% by mass) of the one or more additional VOCs can be ethyl cinnamate. In some embodiments, the one or more additional VOCs can include no ethyl cinnamate.

The one or more additional VOCs in a Scotch-like alcoholic beverage can include ethyl decanoate. In some embodiment, the ethyl decanoate can be present in an amount of about 0.4 to about 50 mg/L (e.g., about 0.4 to about 0.5 mg/L, about 0.5 to about 1.0 mg/L, about 1.0 to about 1.5 mg/L, about 1.5 to about 2.0 mg/L, about 2.0 to about 2.5 mg/L, about 2.5 to about 3.0 mg/L, about 3 to about 5 mg/L, about 5 to about 10 mg/L, about 10 to about 15 mg/L, about 15 to about 20 mg/L, about 20 to about 30 mg/L, about 30 to about 40 mg/L, or about 40 to about 50 mg/L). In some embodiments, the ethyl decanoate can be present in an amount of less than about 1.75 mg/L (e.g., less than about 1.7 mg/L, 1.6 mg/L, 1.5 mg/L, 1.4 mg/L, 1.3 mg/L, 1.2 mg/L, 1.1 mg/L, 1.0 mg/L, 0.9 mg/L, 0.8 mg/L, 0.7 mg/L, or 0.6 mg/L). In some embodiments, the ethyl decanoate can be present in an amount of at least about 30 mg/L (e.g., at least about 31 mg/L, 32 mg/L, 33 mg/L, 34 mg/L, 35 mg/L, 36 mg/L, 37 mg/L, 38 mg/L, 39 mg/L, or 40 mg/L). In some embodiments, about 0.02% to about 7% by mass (e.g., about 0.02% to about 0.05%, about 0.05% to about 0.1%, about 0.1% to about 0.5%, about 0.5% to about 1%, about 1% to about 2%, about 2% to about 3%, about 3% to about 4%, about 4% to about 5%, about 1% to about 5%, about 1% to about 6%, about 1% to about 7%, or about 5% to about 7% by mass) of the one or more additional VOCs can be ethyl decanoate. In some embodiments, at least about 4.3% by mass (e.g., at least about 4.4%, 4.5%, 4.6%, 4.7%, 4.8%, 4.9%, 5.0%, 5.2%, 5.4%, 5.5%, 5.6%, or 5.8% by mass) of the one or more additional VOCs can be ethyl decanoate. In some embodiments, the one or more additional VOCs can include no ethyl decanoate.

The one or more additional VOCs in a Scotch-like alcoholic beverage can include ethyl heptanoate. In some embodiments, the ethyl heptanoate can be present in an amount of about 0.00009 to about 0.25 mg/L (e.g., about 0.00009 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.2 mg/L, or about 0.10 to about 0.25 mg/L). In some embodiments, the ethyl heptanoate can be present in an amount of less than about 0.006 mg/L (e.g., less than about 0.005 mg/L, 0.004 mg/L, 0.003 mg/L, 0.002 mg/L, 0.001 mg/L, 0.0009 mg/L, 0.0007 mg/L, 0.0005 mg/L, 0.0003 mg/L, or 0.0001 mg/L). In some embodiments, about 0.000001% to about 0.04% by mass (e.g., about 0.000001% to about 0.00001%, about 0.00001% to about 0.0001%, about 0.0001% to about 0.0005%, about 0.0005% to about 0.001%, about 0.001% to about 0.002%, about 0.002% to about 0.003%, about 0.003% to about 0.004%, about 0.001% to about 0.005%, about 0.005% to about 0.01%, about 0.01% to about 0.02%, about 0.01% to about 0.03%, or about 0.01% to about 0.04% by mass) of the one or more additional VOCs can be ethyl heptanoate. In some embodiments, the one or more additional VOCs can include no ethyl heptanoate.

The one or more additional VOCs in a Scotch-like alcoholic beverage can include ethyl hexanoate. In some embodiments, the ethyl hexanoate can be present in an amount of about 0.03 to about 9 mg/L (e.g., about 0.03 to about 0.05 mg/L, about 0.05 to about 0.1 mg/L, about 0.1 to about 0.2 mg/L, about 0.2 to about 0.3 mg/L, about 0.3 to about 0.5 mg/L, about 0.5 to about 0.7 mg/L, about 0.7 to about 0.9 mg/L, about 0.8 to about 1 mg/L, about 1 to about 2 mg/L, about 2 to about 3 mg/L, about 3 to about 5 mg/L, about 5 to about 7 mg/L, or about 7 to about 9 mg/L). In some embodiments, the ethyl hexanoate can be present in an amount of at least about 4 mg/L (e.g., at least about 5 mg/L, 6 mg/L, 7 mg/L, or 8 mg/L). In some embodiments, about 0.0004% to about 1.5% by mass (e.g., about 0.0004% to about 0.001%, about 0.0005% to about 0.001%, about 0.001% to about 0.01%, about 0.01% to about 0.1%, about 0.1% to about 0.1% to about 0.3%, about 0.3% to about 0.5%, about 0.5% to about 0.7%, about 0.7% to about 0.9%, about 0.8% to about 1.0%, about 0.9% to about 1.1%, about 1.1% to about 1.3%, or about 1.3% to about 1.5% by mass) of the one or more additional VOCs can be ethyl hexanoate. In some embodiments, at least about 0.56% by mass (e.g., at least about 0.6%, 0.7%, 0.8%, 0.9%, or 1% by mass) of the one or more additional VOCs can be ethyl hexanoate. In some embodiments, the one or more additional VOCs can include no ethyl hexanoate.

The one or more additional VOCs in a Scotch-like alcoholic beverage can include ethyl isobutyrate. In some embodiments, the ethyl isobutyrate can be present in an amount of about 0.003 to about 155 mg/L (e.g., about 0.003 to about 0.005 mg/L, about 0.005 to about 0.01 mg/L, about 0.01 to about 0.05 mg/L, about 0.05 to about 0.1 mg/L, about 0.1 to about 0.2 mg/L, about 0.2 to about 0.5 mg/L, about 0.5 to about 1 mg/L, about 1 to about 2 mg/L, about 2 to about 5 mg/L, about 5 to about 10 mg/L, about 10 to about 20 mg/L, about 20 to about 30 mg/L, about 30 to about 50 mg/L, about 50 to about 100 mg/L, or about 100 to about 155 mg/L). In some embodiments, the ethyl isobutyrate can be present in an amount of less than about 0.3 mg/L (e.g., less than about 0.2 mg/L, 0.1 mg/L, 0.09 mg/L, 0.08 mg/L, 0.07 mg/L, 0.06 mg/L, 0.05 mg/L, 0.04 mg/L, 0.03 mg/L, 0.02 mg/L, or 0.01 mg/L). In some embodiments, the ethyl isobutyrate can be present in an amount of at least about 5.4 mg/L (e.g., at least about 5.5 mg/L, 5.7 mg/L, 5.8 mg/L, 5.9 mg/L, 6 mg/L, 7 mg/L, 8 mg/L, 9 mg/L, 10 mg/L, 15 mg/L, 20 mg/L, 30 mg/L, 40 mg/L, 50 mg/L, 60 mg/L, 70 mg/L, 80 mg/L, 90 mg/L, 100 mg/L, or 120 mg/L). In some embodiments, about 0.0015% to about 10% by mass (e.g., about 0.0015% to about 0.005%, about 0.005% to about 0.01%, about 0.01% to about 0.1%, about 0.1% to about 0.2%, about 0.2% to about 0.3%, about 0.3% to about 0.5%, about 0.5% to about 1%, about 1% to about 2%, about 2% to about 4%, about 4% to about 6%, about 1% to about 5%, about 5% to about 10%, about 6% to about 8%, or about 8% to about 10% by mass) of the one or more additional VOCs can be ethyl isobutyrate. In some embodiments, less than about 0.0085% by mass (e.g., less than about 0.008%, 0.007%, 0.006%, 0.005%, 0.004%, 0.003%, or 0.002% by mass) of the one or more additional VOCs can be ethyl isobutyrate. In some embodiments, at least about 0.77% by mass (e.g., at least about 0.78%, 0.79%, 0.8%, 0.9%, 1%, 2%, 3%, 4%, 5%, 6%, 7%, or 8% by mass) of the one or more additional VOCs can be ethyl isobutyrate. In some embodiments, the one or more additional VOCs can include no ethyl isobutyrate.

The one or more additional VOCs in a Scotch-like alcoholic beverage can include ethyl isovalerate. In some embodiments, the ethyl isovalerate can be present in an amount of about 0.03 to about 3.8 mg/L (e.g., about 0.03 to about 0.05 mg/L, about 0.05 to about 0.1 mg/L, about 0.1 to about 0.2 mg/L, about 0.2 to about 0.4 mg/L, about 0.4 to about 0.6 mg/L, about 0.6 to about 0.8 mg/L, about 0.8 to about 1 mg/L, about 1.0 to about 1.5 mg/L, about 1 to about 2 mg/L, about 2 to about 3 mg/L, or about 3.0 to about 3.8 mg/L). In some embodiments, the ethyl isovalerate can be present in an amount of less than about 0.06 mg/L (e.g., less than about 0.05 mg/L or 0.04 mg/L). In some embodiments, the ethyl isovalerate can be present in an amount of at least about 1.7 mg/L (e.g., at least about 1.8 mg/L, 1.9 mg/L, 2.0 mg/L, 2.2 mg/L, 2.4 mg/L, 2.6 mg/L, 2.8 mg/L, or 3.0 mg/L). In some embodiments, about 0.0003% to about 4.6% by mass (e.g., about 0.0003% to about 0.0005%, about 0.0005% to about 0.001%, about 0.001% to about 0.01%, about 0.01% to about 0.1%, about 0.1% to about 0.2%, about 0.2% to about 0.4%, about 0.4% to about 0.6%, about 0.1% to about 0.5%, about 0.5% to about 1%, about 0.6% to about 0.8%, about 0.8% to about 1.0%, about 1.0% to about 1.5%, about 1.5% to about 2.0%, about 2.0% to about 3.0%, about 3.0% to about 4.0%, or about 4.0% to about 4.6% by mass) of the one or more additional VOCs can be ethyl isovalerate. In some embodiments, at least about 0.4% by mass (e.g., at least about 0.45%, 0.5%, 0.6.%, 0.7%, 0.8%, 0.9%, 1.0%, 1.2%, 1.4%, 1.6%, 1.8%, or 2.0% by mass) of the one or more additional VOCs can be ethyl isovalerate. In some embodiments, the one or more additional VOCs can include no ethyl isovalerate.

The one or more additional VOCs in a Scotch-like alcoholic beverage can include ethyl lactate. In some embodiments, the ethyl lactate can be present in an amount of about 0.1 to about 95 mg/L (e.g., about 0.1 to about 0.5 mg/L, about 0.5 to about 1 mg/L, about 1 to about 2 mg/L, about 2 to about 4 mg/L, about 1 to about 5 mg/L, about 5 to about 10 mg/L, about 4 to about 6 mg/L, about 6 to about 8 mg/L, about 8 to about 10 mg/L, about 10 to about 15 mg/L, about 15 to about 20 mg/L, about 20 to about 30 mg/L, about 30 to about 40 mg/L, about 30 to about 50 mg/L, about 50 to about 70 mg/L, or about 70 to about 90 mg/L). In some embodiments, about 0.007% to about 38% by mass (e.g., about 0.007% to about 0.01%, about 0.01% to about 0.1%, about 0.1% to about 0.5%, about 0.5% to about 1%, about 1% to about 2%, about 2% to about 5%, about 1% to about 5%, about 5% to about 10%, about 10% to about 15%, about 10% to about 12%, about 12% to about 15%, about 15% to about 20%, about 25%, about 25% to about 30%, about 22% to about 27%, about 30% to about 35%, or about 35% to about 38% by mass) of the one or more additional VOCs can be ethyl lactate. In some embodiments, at least about 19% by mass (e.g., at least about 20%, 22%, 24%, 26%, 28%, 30%, 32%, 34%, or 36% by mass) of the one or more additional VOCs can be ethyl lactate. In some embodiments, the one or more additional VOCs can include no ethyl lactate.

The one or more additional VOCs in a Scotch-like alcoholic beverage can include ethyl laurate. In some embodiments, the ethyl laurate can be present in an amount of about 0.3 to about 180 mg/L (e.g., about 0.3 to about 0.5 mg/L, about 0.5 to about 1 mg/L, about 0.8 to about 1.2 mg/L, about 1 to about 2 mg/L, about 1.8 to about 2.2 mg/L, about 2 to about 3 mg/L, about 3 to about 5 mg/L, about 5 to about 10 mg/L, about 10 to about 15 mg/L, about 15 to about 20 mg/L, about 20 to about 30 mg/L, about 30 to about 40 mg/L, about 30 to about 50 mg/L, about 30 to about 60 mg/L, about 60 to about 90 mg/L, about 90 to about 120 mg/L, about 120 to about 150 mg/L, or about 150 to about 180 mg/L). In some embodiments, about 0.006% to about 27% by mass (e.g., 0.006% to about 0.01%, about 0.01% to about 0.05%, about 0.05% to about 0.1%, about 0.1% to about 0.5%, about 0.5% to about 1%, about 0.8% to about 1.2%, about 1% to about 5%, about 1% to about 2%, about 2% to about 3%, about 3% to about 5%, about 5% to about 10%, about 10% to about 15%, about 15% to about 20%, about 20% to about 25%, or about 20% to about 27% by mass) of the one or more additional VOCs can be ethyl laurate. In some embodiments, at least about 9.2% by mass (e.g., at least about 9.5%, 10%, 11%, 12%, 13%, 14%, 15%, 16%, 18%, or 20% by mass) of the one or more additional VOCs can be ethyl laurate. In some embodiments, the one or more additional VOCs can include no ethyl laurate.

The one or more additional VOCs in a Scotch-like alcoholic beverage can include ethyl myristate. In some embodiments, the ethyl myristate can be present in an amount of about 0.01 to about 4 mg/L (e.g., about 0.01 to about 0.1 mg/L, about 0.1 to about 0.2 mg/L, about 0.2 to about 0.3 mg/L, about 0.3 to about 0.5 mg/L, about 0.5 to about 1 mg/L, about 1 to about 2 mg/L, about 2 to about 3 mg/L, about 1 to about 4 mg/L, about 1 to about 3 mg/L, or about 2 to about 4 mg/L). In some embodiments, the ethyl myristate can be present in an amount of at least about 0.11 mg/L (e.g., at least about 0.15 mg/L, 0.2 mg/L, 0.3 mg/L, 0.4 mg/L, 0.5 mg/L, 0.7 mg/L, 0.9 mg/L, 1 mg/L, 1.5 mg/L, or 2 mg/L). In some embodiments, about 0.0001% to about 0.6% by mass (e.g., about 0.0001% to about 0.0005%, about 0.0005% to about 0.001%, about 0.001% to about 0.005%, about 0.005% to about 0.01%, about 0.01% to about 0.02%, about 0.02% to about 0.05%, about 0.01% to about 0.05%, about 0.05% to about 0.1%, about 0.1% to about 0.2%, about 0.2% to about 0.3%, 0.3% to about 0.4%, about 0.4% to about 0.5%, about 0.1% to about 0.5%, about 0.1% to about 0.6%, or about 0.5% to about 0.6% by mass) of the one or more additional VOCs can be ethyl myristate. In some embodiments, at least about 0.015% by mass (e.g., at least about 0.2%, 0.3%, 0.4%, or 0.5% by mass) of the one or more additional VOCs can be ethyl myristate. In some embodiments, the one or more additional VOCs can include no ethyl myristate.

The one or more additional VOCs in a Scotch-like alcoholic beverage can include ethyl nonanoate. In some embodiments, the ethyl nonanoate can be present in an amount of about 0.00003 to about 2.6 mg/L (e.g., about 0.00003 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1.0 mg/L, about 1.0 to about 2.0 mg/L, or about 2.0 to about 2.6 mg/L). In some embodiments, the ethyl nonanoate can be present in an amount of less than about 0.0075 mg/L (e.g., less than about 0.007 mg/L, 0.006 mg/L, 0.005 mg/L, 0.004 mg/L, 0.002 mg/L, 0.001 mg/L, 0.0005 mg/L, 0.0001 mg/L, or 0.00005 mg/L). In some embodiments, about 0.00004% to about 2.6% by mass (e.g., about 0.00004% to about 0.0001%, about 0.0001% to about 0.0005%, about 0.0005% to about 0.001%, about 0.001% to about 0.003%, about 0.003% to about 0.005%, about 0.005% to about 0.007%, about 0.007% to about 0.009%, about 0.009% to about 0.011%, about 0.005% to about 0.01%, about 0.01% to about 0.02%, about 0.02% to about 0.05%, about 0.01% to about 0.05%, about 0.05% to about 0.1%, about 0.1% to about 0.5%, about 0.5% to about 1.0%, about 1.0% to about 1.5%, about 1.5% to about 2.0%, about 2.0% to about 2.5%, or about 2.0% to about 2.6% by mass) of the one or more additional VOCs can be ethyl nonanoate. In some embodiments, less than about 0.00022% by mass (e.g., less than about 0.00020%, 0.00018%, 0.00016%, 0.00014%, 0.00012%, or 0.00010% by mass) of the one or more additional VOCs can be ethyl nonanoate. In some embodiments, at least about 0.36% by mass (e.g., at least about 0.37%, 0.38%, 0.39%, 0.4%, 0.5%, 0.6%, 0.7%, 0.8%, 0.9%, 1.0%, 1.5%, 2.0%, or 2.5% by mass) of the one or more additional VOCs can be ethyl nonanoate. In some embodiments, the one or more additional VOCs can include no ethyl nonanoate.

The one or more additional VOCs in a Scotch-like alcoholic beverage can include ethyl octanoate. In some embodiments, the ethyl octanoate can be present in an amount of about 0.3 to about 76 mg/L (e.g., about 0.3 to about 0.4 mg/L, about 0.4 to about 0.6 mg/L, about 0.6 to about 0.8 mg/L, about 0.8 to about 1 mg/L, about 1 to about 2 mg/L, about 2 to about 3 mg/L, about 3 to about 5 mg/L, about 5 to about 10 mg/L, about 10 to about 20 mg/L, about 20 to about 30 mg/L, about 30 to about 40 mg/L, about 40 to about 50 mg/L, about 50 to about 60 mg/L, about 60 to about 70 mg/L, or about 70 to about 76 mg/L). In some embodiments, the ethyl octanoate is present in an amount of less than about 0.85 mg/L (e.g., less than 0.84 mg/L, 0.83 mg/L, 0.82 mg/L, 0.81 mg/L, 0.80 mg/L, 0.75 mg/L, 0.70 mg/L, 0.65 mg/L, 0.60 mg/L, 0.55 mg/L, or 0.50 mg/L). In some embodiments, about 0.02% to about 10% by mass (e.g., about 0.02% to about 0.05%, about 0.05% to about 0.1%, about 0.1% to about 0.5%, about 0.5% to about 1.0%, about 1.0% to about 1.5%, about 1.5 to about 2.0%, about 2% to about 3%, about 3% to about 4%, about 4% to about 6%, about 1% to about 5%, about 5% to about 10%, about 6% to about 8%, or about 8% to about 10% by mass) of the one or more additional VOCs can be ethyl octanoate. In some embodiments, the one or more additional VOCs can include no ethyl octanoate.

The one or more additional VOCs in a Scotch-like alcoholic beverage can include ethyl palmitate. In some embodiments, the ethyl palmitate can be present in an amount of about 0.1 to about 32 mg/L (e.g., about 0.1 to about 0.5 mg/L, about 0.5 to about 1 mg/L, about 1 to about 2 mg/L, about 2 to about 5 mg/L, about 5 to about 10 mg/L, about 10 to about 15 mg/L, about 15 to about 20 mg/L, about 20 to about 25 mg/L, about 25 to about 30 mg/L, or about 25 to about 32 mg/L). In some embodiments, about 0.002% to about 1% by mass (e.g., about 0.002% to about 0.005%, about 0.005% to about 0.01%, about 0.01% to about 0.05%, about 0.05% to about 0.1%, about 0.1% to about 0.5%, or about 0.5% to about 1% by mass) of the one or more additional VOCs can be ethyl palmitate. In some embodiments, the one or more additional VOCs can include no ethyl palmitate.

The one or more additional VOCs in a Scotch-like alcoholic beverage can include ethyl phenyl acetate. In some embodiments, the ethyl phenyl acetate can be present in an amount of about 0.001 to about 0.1 mg/L (e.g., about 0.001 to about 0.003 mg/L, about 0.003 to about 0.005 mg/L, about 0.005 to about 0.007 mg/L, about 0.007 to about 0.009 mg/L, about 0.008 to about 0.01 mg/L, about 0.01 to about 0.02 mg/L, about 0.02 to about 0.04 mg/L, about 0.04 to about 0.06 mg/L, about 0.06 to about 0.08 mg/L, about 0.08 to about 0.1 mg/L, about 0.01 to about 0.05 mg/L, or about 0.05 to about 0.1 mg/L). In some embodiments, the ethyl phenyl acetate can be present in an amount of less than about 0.01 mg/L (e.g., less than about 0.009 mg/L, 0.008 mg/L, 0.007 mg/L, 0.006 mg/L, 0.005 mg/L, 0.004 mg/L, or 0.003 mg/L). In some embodiments, about 0.00001% to about 0.015% by mass (e.g., about 0.00001% to about 0.00005%, about 0.00005% to about 0.0001%, about 0.0001% to about 0.0005%, about 0.0005% to about 0.001%, about 0.001% to about 0.005%, about 0.005% to about 0.010%, or about 0.010% to about 0.015% by mass) of the one or more additional VOCs can be ethyl phenyl acetate. In some embodiments, less than about 0.00025% by mass (e.g., less than about 0.0002%, 0.0001%, 0.00009%, 0.00008%, 0.00007%, 0.00006%, 0.00005%, 0.00004%, 0.00003%, or 0.00002% by mass) of the one or more additional VOCs can be ethyl phenyl acetate. In some embodiments, the one or more additional VOCs can include no ethyl phenyl acetate.

The one or more additional VOCs in a Scotch-like alcoholic beverage can include ethyl propionate. In some embodiments, the ethyl propionate can be present in an amount of about 0.05 to about 2 mg/L (e.g., about 0.05 to about 0.07 mg/L, about 0.07 to about 0.09 mg/L, about 0.09 to about 0.11 mg/L, about 0.11 to about 0.13 mg/L, about 0.13 to about 0.15 mg/L, about 0.15 to about 0.17 mg/L, about 0.17 to about 0.19 mg/L, about 0.19 to about 0.21 mg/L, about 0.21 to about 0.23 mg/L, about 0.23 to about 0.25 mg/L, about 0.25 to about 0.5 mg/L, about 0.5 to about 1.0 mg/L, about 1.0 to about 1.5 mg/L, about 1 to about 2 mg/L, or about 1.5 to about 2.0 mg/L). In some embodiments, the ethyl propionate can be present in an amount of less than about 0.34 mg/L (e.g., less than about 0.33 mg/L, 0.32 mg/L, 0.31 mg/L, 0.3 mg/L, 0.2 mg/L, 0.1 mg/L, 0.09 mg/L, or 0.08 mg/L). In some embodiments, about 0.002% to about 0.5% by mass (e.g., about 0.002% to about 0.005%, about 0.005% to about 0.01%, about 0.01% to about 0.02%, about 0.02% to about 0.05%, about 0.01% to about 0.05%, about 0.05% to about 0.1%, about 0.1% to about 0.2%, about 0.2% to about 0.3%, about 0.3% to about 0.4%, about 0.1% to about 0.5%, or about 0.4% to about 0.5% by mass) of the one or more additional VOCs can be ethyl propionate. In some embodiments, less than about 0.017% by mass (e.g., less than about 0.016%, 0.015%, 0.014%, 0.013%, 0.012%, 0.010%, 0.009%, 0.008%, 0.007%, 0.006%, 0.005%, 0.004%, or 0.003% by mass) of the one or more additional VOCs can be ethyl propionate. In some embodiments, the one or more additional VOCs can include no ethyl propionate.

The one or more additional VOCs in a Scotch-like alcoholic beverage can include ethyl salicylate. In some embodiments, the ethyl salicylate can be present in an amount of about 0.00006 to about 0.003 mg/L (e.g., about 0.00006 to about 0.0001 mg/L, about 0.0001 to about 0.0005 mg/L, about 0.0005 to about 0.001 mg/L, about 0.001 to about 0.003 mg/L, about 0.001 to about 0.002 mg/L, or about 0.002 to about 0.003 mg/L). In some embodiments, about 0.0000009% to about 0.0005% by mass (e.g., about 0.0000009% to about 0.000005%, about 0.000001% to about 0.000005%, about 0.000005% to about 0.00001%, about 0.00001% to about 0.00005%, about 0.00005% to about 0.0001%, or about 0.0001% to about 0.0005% by mass) of the one or more additional VOCs can be ethyl salicylate. In some embodiments, the one or more additional VOCs can include no ethyl salicylate.

The one or more additional VOCs in a Scotch-like alcoholic beverage can include ethyl undecanoate. In some embodiments, the ethyl undecanoate can be present in an amount of about 0.001 to about 0.3 mg/L (e.g., about 0.001 to about 0.01 mg/L, about 0.01 to about 0.05 mg/L, about 0.05 to about 0.1 mg/L, about 0.1 to about 0.2 mg/L, or about 0.2 to about 0.3 mg/L). In some embodiments, the ethyl undecanoate can be present in an amount of less than about 0.007 mg/L (e.g., less than about 0.006 mg/L, 0.005 gm/L, 0.004 mg/L, 0.003 mg/L, or 0.002 mg/L). In some embodiments, the ethyl decanoate can be present in an amount of at least about 0.12 mg/L (e.g., at least about 0.13 mg/L, 0.14 mg/L, 0.15 mg/L, 0.16 mg/L, 0.17 mg/L, 0.18 mg/L, 0.19 mg/L, or 0.2 mg/L). In some embodiments, about 0.00015% to about 0.3% by mass (e.g., about 0.00015% to about 0.0005%, about 0.0005% to about 0.001%, about 0.001% to about 0.002%, about 0.002% to about 0.005%, about 0.005% to about 0.01%, about 0.01% to about 0.05%, about 0.05% to about 0.1%, about 0.1% to about 0.2%, about 0.1% to about 0.3%, or about 0.2% to about 0.3% by mass) of the one or more additional VOCs can be ethyl undecanoate. In some embodiments, at least about 0.017% by mass (e.g., at least about 0.018%, 0.019%, 0.02%, 0.03%, 0.04%, 0.05%, 0.06%, 0.07%, 0.08%, 0.09%, 0.10%, 0.15%, or 0.20% by mass) of the one or more additional VOCs can be ethyl undecanoate. In some embodiments, the one or more additional VOCs can include no ethyl undecanoate.

The one or more additional VOCs in a Scotch-like alcoholic beverage can include ethyl valerate. In some embodiments, the ethyl valerate can be present in an amount of about 0.001 to about 0.16 mg/L (e.g., about 0.001 to about 0.005 mg/L, about 0.005 to about 0.01 mg/L, about 0.01 to about 0.02 mg/L, about 0.02 to about 0.03 mg/L, about 0.03 to about 0.05 mg/L, about 0.05 to about 0.10 mg/L, about 0.10 to about 0.15 mg/L, or about 0.10 to about 0.16 mg/L). In some embodiments, the ethyl valerate can be present in an amount of less than about 0.0045 mg/L (e.g., less than about 0.0044 mg/L, 0.0043 mg/L, 0.0042 mg/L, 0.0041 mg/L, 0.0040 mg/L, 0.0035 mg/L, 0.0030 mg/L, 0.0025 mg/L, 0.0020 mg/L, or 0.0015 mg/L). In some embodiments, about 0.00001% to about 0.025% by mass (e.g., about 0.00001% to about 0.0001%, about 0.0001% to about 0.0005%, about 0.0005% to about 0.001%, about 0.001% to about 0.005%, about 0.005% to about 0.01%, about 0.01% to about 0.02%, or about 0.020% to about 0.025% by mass) of the one or more additional VOCs can be ethyl valerate. In some embodiments, less than about 0.00007% by mass (e.g., less than about 0.00006%, 0.00005%, 0.00004%, 0.00003%, or 0.00002% by mass) of the one or more additional VOCs can be ethyl valerate. In some embodiments, the one or more additional VOCs can include no ethyl valerate.

The one or more additional VOCs in a Scotch-like alcoholic beverage can include ethyl-2-methylbutyrate. In some embodiments, the ethyl-2-methylbutyrate can be present in an amount of about 0.01 to about 1 mg/L (e.g., about 0.01 to about 0.03 mg/L, about 0.03 mg/L to about 0.05 mg/L, about 0.05 to about 0.07 mg/L, about 0.07 to about 0.09 mg/L, about 0.08 to about 0.1 mg/L, about 0.1 to about 0.3 mg/L, about 0.3 to about 0.5 mg/L, about 0.5 to about 0.7 mg/L, about 0.7 to about 0.9 mg/L, or about 0.8 to about 1 mg/L). In some embodiments, about 0.0003% to about 0.2% by mass (e.g., about 0.0003% to about 0.0005%, about 0.0003% to about 0.001%, 0.0005% to about 0.001%, about 0.001% to about 0.005%, about 0.005% to about 0.01%, about 0.01% to about 0.02%, about 0.02% to about 0.04%, about 0.04% to about 0.06%, about 0.06% to about 0.08%, about 0.08% to about 0.1%, about 0.01% to about 0.05%, about 0.1% to about 0.5%, or about 0.1% to about 0.2% by mass) of the one or more additional VOCs can be ethyl-2-methylbutyrate. In some embodiments, the one or more additional VOCs can include no ethyl-2-methylbutyrate.

The one or more additional VOCs in a Scotch-like alcoholic beverage can include eugenol. In some embodiments, the eugenol can be present in an amount of about 0.001 to about 0.5 mg/L (e.g., about 0.001 to about 0.003 mg/L, about 0.003 to about 0.005 mg/L, about 0.005 to about 0.007 mg/L, about 0.007 to about 0.009 mg/L, about 0.008 to about 0.01 mg/L, about 0.01 to about 0.03 mg/L, about 0.03 to about 0.05 mg/L, about 0.05 to about 0.07 mg/L, about 0.07 to about 0.09 mg/L, about 0.08 to about 0.1 mg/L, about 0.1 to about 0.2 mg/L, about 0.2 to about 0.3 mg/L, about 0.3 to about 0.4 mg/L, or about 0.4 to about 0.5 mg/L). In some embodiments, the eugenol can be present in an amount of less than about 0.035 mg/L (e.g., less than about 0.03 mg/L, 0.02 mg/L, 0.01 mg/L, 0.009 mg/L, 0.008 mg/L, 0.007 mg/L, 0.006 mg/L, 0.005 mg/L, 0.004 mg/L, or 0.003 mg/L). In some embodiments, about 0.00002% to about 0.07% by mass (e.g., about about 0.00002% to about 0.00005%, about 0.00005% to about 0.0001%, about 0.0001% to about 0.0005%, 0.0005% to about 0.001%, about 0.001% to about 0.002%, about 0.002% to about 0.003%, about 0.003% to about 0.005%, about 0.005% to about 0.009%, about 0.008% to about 0.01%, about 0.001% to about 0.005%, about 0.005% to about 0.01%, about 0.01% to about 0.02%, about 0.02% to about 0.04%, about 0.04% to about 0.06%, about 0.01% to about 0.05%, or about 0.06% to about 0.07% by mass) of the one or more additional VOCs can be eugenol. In some embodiments, less than about 0.001% by mass (e.g., less than about 0.0009%, 0.0008%, 0.0007%, 0.0006%, or 0.0005% by mass) of the one or more additional VOCs can be eugenol. In some embodiments, the one or more additional VOCs can include no eugenol.

The one or more additional VOCs in a Scotch-like alcoholic beverage can include furfural. In some embodiments, the furfural can be present in an amount of about 0.4 to about 23 mg/L (e.g., about 0.4 to about 0.5 mg/L, about 0.5 to about 1 mg/L, about 1 to about 2 mg/L, about 2 to about 3 mg/L, about 3 to about 5 mg/L, about 5 to about 10 mg/L, about 10 to about 15 mg/L, about 15 to about 20 mg/L, or about 20 to about 23 mg/L). In some embodiments, the furfural can be present in an amount of less than about 0.7 mg/L (e.g., less than about 0.69 mg/L, 0.68 mg/L, 0.67 mg/L, 0.66 mg/L, 0.65 mg/L, 0.64 mg/L, 0.63 mg/L, 0.62 mg/L, 0.61 mg/L, 0.6 mg/L, or 0.5 mg/L). In some embodiments, about 0.01% to about 12% by mass (e.g., about 0.01% to about 0.05%, about 0.05% to about 0.1%, about 0.1% to about 0.5%, about 0.5% to about 1%, about 1% to about 2%, about 2% to about 3%, about 3% to about 4%, about 4% to about 5%, about 5% to about 6%, about 6% to about 8%, about 8% to about 10%, about 1% to about 5%, about 5% to about 10%, or about 10% to about 12% by mass) of the one or more additional VOCs can be furfural. In some embodiments at least about 4.5% by mass (e.g., at least about 5.0%, 5.5%, 6.0%, 6.5%, 7.0%, 7.5%, 8.0%, 8.5%, 9.0%, 9.5%, 10.0%, 10.5%, 11.0%, or 11.5% by mass) of the one or more additional VOCs can be furfural. In some embodiments, the one or more additional VOCs can include no furfural.

The one or more additional VOCs in a Scotch-like alcoholic beverage can include gamma-decalactone. In some embodiments, the gamma-decalactone can be present in an amount of about 0.003 to about 3.8 mg/L (e.g., about 0.003 to about 0.004 mg/L, about 0.004 to about 0.006 mg/L, about 0.006 to about 0.008 mg/L, about 0.008 to about 0.01 mg/L, about 0.01 to about 0.05 mg/L, about 0.05 to about 0.1 mg/L, about 0.1 to about 0.2 mg/L, about 0.2 to about 0.5 mg/L, about 0.5 to about 1.0 mg/L, about 1.0 to about 1.5 mg/L, about 1.5 to about 2.0 mg/L, about 2.0 to about 3.0 mg/L, or about 3.0 to about 3.8 mg/L). In some embodiments, the gamma-decalactone can be present in an amount of less than about 0.01 mg/L (e.g., less than about 0.01 mg/L, 0.009 mg/L, 0.008 mg/L, 0.007 mg/L, 0.006 mg/L, or 0.005 mg/L). In some embodiments, the gamma-decalactone can be present in an amount of at least about 0.4 mg/L (e.g., at least about 0.5 mg/L, 0.6 mg/L, 0.7 mg/L, 0.8 mg/L, 0.9 mg/L, 1 mg/L, 2 mg/L, or 3 mg/L). In some embodiments, about 0.0001% to about 0.5% by mass (e.g., about 0.0001% to about 0.0005%, about 0.0005% to about 0.001%, about 0.001% to about 0.002%, about 0.002% to about 0.005%, about 0.001% to about 0.005%, about 0.005% to about 0.01%, about 0.01% to about 0.02%, about 0.02% to about 0.05%, about 0.01% to about 0.05%, about 0.05% to about 0.1%, about 0.1% to about 0.2%, about 0.1% to about 0.3%, about 0.1% to about 0.5%, about 0.2% to about 0.4%, or about 0.3% to about 0.5% by mass) of the one or more additional VOCs can be gamma-decalactone. In some embodiments, at least about 0.06% by mass (e.g., at least about 0.07%, 0.08%, 0.09%, 0.1%, or 0.2% by mass) of the one or more additional VOCs can be gamma-decalactone. In some embodiments, the one or more additional VOCs can include no gamma-decalactone.

The one or more additional VOCs in a Scotch-like alcoholic beverage can include gamma-terpinene. In some embodiments, the gamma-terpinene can be present in an amount of about 0.00005 to about 0.35 mg/L (e.g., about 0.00005 to about 0.0001 mg/L, about 0.0001 to about 0.0005 mg/L, about 0.0005 to about 0.001 mg/L, about 0.001 to about 0.002 mg/L, about 0.002 to about 0.005 mg/L, about 0.005 to about 0.01 mg/L, about 0.01 to about 0.05 mg/L, about 0.05 to about 0.10 mg/L, about 0.10 to about 0.20 mg/L, about 0.20 to about 0.30 mg/L, or about 0.30 to about 0.35 mg/L). In some embodiments, the gamma-terpinene can be present in an amount of at least about 0.0013 mg/L (e.g., at least about 0.0015 mg/L, 0.002 mg/L, 0.003 mg/L, 0.005 mg/L, 0.01 mg/L, 0.02 mg/L, 0.05 mg/L, 0.1 mg/L, or 0.2 mg/L). In some embodiments, about 0.000002% to about 0.05% by mass (e.g., about 0.000002% to about 0.00001%, about 0.00001% to about 0.0001%, about 0.0001% to about 0.0002%, about 0.0002% to about 0.0005%, about 0.0001% to about 0.0005%, about 0.0005% to about 0.001%, about 0.001% to about 0.002%, about 0.002% to about 0.005%, about 0.001% to about 0.005%, about 0.005% to about 0.01%, about 0.01% to about 0.02%, about 0.01% to about 0.05%, about 0.01% to about 0.03%, about 0.02% to about 0.04%, or about 0.03% to about 0.05% by mass) of the one or more additional VOCs can be gamma-terpinene. In some embodiments, at least about 0.0002% by mass (e.g., at least about 0.00025%, 0.0003%, 0.0004%, 0.0005%, 0.001%, 0.002%, 0.005%, or 0.01% by mass) of the one or more additional VOCs can be gamma-terpinene. In some embodiments, the one or more additional VOCs can include no gamma-terpinene.

The one or more additional VOCs in a Scotch-like alcoholic beverage can include guaiacol. In some embodiments, the guaiacol can be present in an amount of about 0.001 to about 5.4 mg/L (e.g., about 0.001 to about 0.002 mg/L, about 0.002 to about 0.004 mg/L, about 0.004 to about 0.006 mg/L, about 0.006 to about 0.008 mg/L, about 0.008 to about 0.01 mg/L, about 0.01 to about 0.05 mg/L, about 0.05 to about 0.1 mg/L, about 0.1 to about 0.5 mg/L, about 0.5 to about 1.0 mg/L, about 1.0 to about 1.5 mg/L, about 1.5 to about 2.0 mg/L, about 2.0 to about 3.0 mg/L, about 3.0 to about 4.0 mg/L, about 4.0 to about 5.0 mg/L, or about 4.0 to about 5.4 mg/L). In some embodiments, the guaiacol can be present in an amount of less than about 0.006 mg/L (e.g., less than about 0.005 mg/L, 0.004 mg/L, 0.003 mg/L, or 0.002 mg/L). In some embodiments, about 0.0001% to about 2.6% by mass (e.g., about 0.0001% to about 0.0005%, about 0.0005% to about 0.001%, about 0.001% to about 0.002%, about 0.002% to about 0.004%, about 0.004% to about 0.006%, about 0.001% to about 0.005%, about 0.006% to about 0.008%, about 0.008% to about 0.01%, about 0.005% to about 0.01%, about 0.01% to about 0.05%, about 0.05% to about 0.1%, about 0.1% to about 0.5%, about 0.5% to about 1.0%, about 1.0% to about 1.5%, about 1.5% to about 2.0%, about 2.0% to about 2.5%, or about 2.0% to about 2.6% by mass) of the one or more additional VOCs can be guaiacol. In some embodiments, at least about 1.0% by mass (e.g., at least about 1.1%, 1.2%, 1.3%, 1.4%, 1.5%, 1.6%, 1.7%, 1.8%, 1.9%, 2.0%, 2.1%, 2.2%, 2.3%, 2.4%, or 2.5% by mass) of the one or more additional VOCs can be guaiacol. In some embodiments, the one or more additional VOCs can include no guaiacol.

The one or more additional VOCs in a Scotch-like alcoholic beverage can include hexanol. In some embodiments, the hexanol can be present in an amount of about 0.004 to about 2.7 mg/L (e.g., about 0.004 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 mg/L, to about 1.0 mg/L, about 1.0 to about 1.5 mg/L, about 1.5 to about 2.0 mg/L, about 2.0 to about 2.5 mg/L, or about 2.0 to about 2.7 mg/L). In some embodiments, the hexanol can be present in an amount of less than about 0.014 mg/L (e.g., less than about 0.013 mg/L, 0.012 mg/L, 0.011 mg/L, 0.010 mg/L, 0.009 mg/L, 0.008 mg/L, 0.007 mg/L, 0.006 mg/L, 0.005 mg/L, or 0.004 mg/L). In some embodiments, about 0.00004% to about 0.4% by mass (e.g., about 0.00004% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.2%, about 0.2% to about 0.3%, about 0.1% to about 0.4%, or about 0.3% to about 0.4% by mass) of the one or more additional VOCs can be hexanol. In some embodiments, less than about 0.0004% by mass (e.g., less than about 0.0003%, 0.0002%, 0.0001%, 0.00009%, 0.00008%, 0.00007%, 0.00006%, or 0.00005% by mass) of the one or more additional VOCs can be hexanol. In some embodiments, the one or more additional VOCs can include no hexanol.

The one or more additional VOCs in a Scotch-like alcoholic beverage can include isoamyl acetate. In some embodiments, the isoamyl acetate can be present in an amount of about 0.06 to about 13 mg/L (e.g., about 0.06 to about 0.1 mg/L, about 0.1 to about 0.5 mg/L, about 0.5 to about 1 mg/L, about 1 to about 2 mg/L, about 2 to about 3 mg/L, about 3 to about 5 mg/L, about 5 to about 7 mg/L, about 7 to about 9 mg/L, about 9 to about 11 mg/L, or about 11 to about 13 mg/L). In some embodiments, the isoamyl acetate can be present in an amount of less than about 0.18 mg/L (e.g., less than about 0.17 mg/L, 0.16 mg/L, or 0.15 mg/L). In some embodiments, the isoamyl acetate can be present in an amount of at least about 8 mg/L (e.g., at least about 9 mg/L, 10 mg/L, 11 mg/L, or 12 mg/L). In some embodiments, about 0.003% to about 1.8% by mass (e.g., about 0.003% to about 0.005%, about 0.005% to about 0.01%, about 0.01% to about 0.05%, about 0.05% to about 0.1%, about 0.1% to about 0.2%, about 0.2% to about 0.4%, about 0.4% to about 0.6%, about 0.1% to about 0.5%, about 0.6% to about 0.8%, about 0.8% to about 1.0%, about 0.5% to about 1.0%, about 1.0% to about 1.2%, about 1.2% to about 1.4%, about 1.4% to about 1.6%, about 1.0% to about 1.5%, or about 1.6% to about 1.8% by mass) of the one or more additional VOCs can be isoamyl acetate. In some embodiments, at least about 1.15% by mass (e.g., at least about 1.2%, 1.3%, 1.4%, 1.5%, 1.6%, or 1.7% by mass) of the one or more additional VOCs can be isoamyl acetate. In some embodiments, the one or more additional VOCs can include no isoamyl acetate.

The one or more additional VOCs in a Scotch-like alcoholic beverage can include isoamyl alcohol. In some embodiments, the isoamyl alcohol can be present in an amount of about 0.6 mg/L to about 3 g/L (e.g., about 0.6 to about 1 mg/L, about 0.6 to about 0.8 mg/L, about 0.8 to about 1 mg/L, about 1 to about 2 mg/L, about 2 to about 5 mg/L, about 5 to about 10 mg/L, about 10 to about 15 mg/L, about 15 to about 20 mg/L, about 20 to about 30 mg/L, about 30 to about 40 mg/L, about 40 to about 48 mg/L, about 40 to about 50 mg/L, about 50 to about 100 mg/L, about 100 to about 200 mg/L, about 200 to about 500 mg/L, about 500 mg/L to about 1.0 g/L, about 1 to about 2 g/L, about 1 to about 3 g/L, or about 2 to about 3 g/L). In some embodiments, the isoamyl alcohol can be present in an amount of less than about 38 mg/L (e.g., less than about 35 mg/L, 30 mg/L, 25 mg/L, 20 mg/L, 15 mg/L, 10 mg/L, 5 mg/L, 2 mg/L, or 1 mg/L). In some embodiments, about 0.01% to about 90% by mass (0.01% to about 0.05%, about 0.05% to about 0.1%, about 0.1% to about 0.5%, about 0.5% to about 1.0%, about 1.0% to about 1.5%, about 1.5% to about 2%, about 2% to about 5%, about 1% to about 5%, about 5% to about 10%, about 10% to about 20%, about 20% to about 30%, about 30% to about 50%, about 50% to about 70%, or about 70% to about 90% by mass) of the one or more additional VOCs can be isoamyl alcohol. In some embodiments, less than about 0.85% by mass (e.g., less than about 0.8%, 0.7%, 0.6%, 0.5%, 0.4%, 0.3%, 0.2%, 0.1%, or 0.05% by mass) of the one or more additional VOCs can be isoamyl alcohol. In some embodiments, the one or more additional VOCs can include no isoamyl alcohol.

The one or more additional VOCs in a Scotch-like alcoholic beverage can include isoamyl hexanoate. In some embodiments, the isoamyl hexanoate can be present in an amount of about 0.0002 to about 0.06 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.02 mg/L, about 0.01 to about 0.05 mg/L, about 0.01 to about 0.06 mg/L, about 0.01 to about 0.03 mg/L, about 0.03 to about 0.05 mg/L, about 0.02 to about 0.4 mg/L, or about 0.04 to about 0.06 mg/L). In some embodiments, 0.000002% to about 0.035% by mass (e.g., about 0.000002% to about 0.000005%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.005%, about 0.005% to about 0.010%, about 0.010% to about 0.015%, about 0.015% to about 0.020%, about 0.020% to about 0.025%, about 0.025% to about 0.030%, or about 0.030% to about 0.035% by mass) of the one or more additional VOCs can be isoamyl hexanoate. In some embodiments, at least about 0.014% by mass (e.g., at least about 0.015%, 0.016%, 0.017%, 0.018%, 0.019%, 0.020%, 0.022%, 0.024%, 0.025%, 0.026%, or 0.028% by mass) of the one or more additional VOCs can be isoamyl hexanoate. In some embodiments, the one or more additional VOCs can include no isoamyl hexanoate.

The one or more additional VOCs in a Scotch-like alcoholic beverage can include isoamyl octanoate. In some embodiments, the isoamyl octanoate can be present in an amount of about 0.0001 to about 1.8 mg/L (e.g., about 0.0001 to about 0.0005 mg/L, about 0.0005 to about 0.001 mg/L, about 0.001 to about 0.003 mg/L, about 0.003 to about 0.005 mg/L, about 0.005 to about 0.007 mg/L, about 0.007 to about 0.009 mg/L, about 0.008 to about 0.01 mg/L, about 0.005 to about 0.01 mg/L, about 0.01 to about 0.05 mg/L, about 0.05 to about 0.1 mg/L, about 0.1 to about 0.5 mg/L, about 0.5 to about 1.0 mg/L, about 1.0 to about 1.5 mg/L, or about 1.0 to about 1.8 mg/L). In some embodiments, the isoamyl octanoate can be present in an amount of less than about 0.0005 mg/L (e.g., less than about 0.00045 mg/L, about 0.0004 mg/L, 0.0003 mg/L, or 0.0002 mg/L). In some embodiments, about 0.000005% to about 0.3% by mass (e.g., about 0.000005% to about 0.00001%, about 0.00001% to about 0.00005%, about 0.00005% to about 0.0001%, about 0.0001% to about 0.0002%, about 0.0002% to about 0.0004%, about 0.0004% to about 0.0006%, about 0.0001% to about 0.0005%, about 0.0006% to about 0.0008%, about 0.0008% to about 0.0010%, about 0.0005% to about 0.001%, about 0.001% to about 0.003%, about 0.001% to about 0.005%, about 0.005% to about 0.01%, about 0.01% to about 0.05%, about 0.05% to about 0.1%, about 0.1% to about 0.3%, about 0.1% to about 0.2%, or about 0.2% to about 0.3% by mass) of the one or more additional VOCs can be isoamyl octanoate. In some embodiments, less than about 0.000015% by mass (e.g., less than about 0.000014%, 0.000013%, 0.000012%, 0.000011%, 0.000010%, 0.000009%, 0.000008%, 0.000007%, or 0.000006% by mass) of the one or more additional VOCS can be isoamyl octanoate. In some embodiments, at least about 0.0012% (e.g., at least about 0.0013%, 0.0014%, 0.0015%, 0.0016%, 0.0017%, 0.0018%, 0.0019%, 0.0020%, 0.0025%, or 0.0030% by mass) of the one or more additional VOCs can be isoamyl octanoate. In some embodiments, the one or more additional VOCs can include no isoamyl octanoate.

The one or more additional VOCs in a Scotch-like alcoholic beverage can include isobutanol (also called isobutyl alcohol). In some embodiments, the isobutanol can be present in an amount of about 3.5 mg/L to about 1 g/L (e.g., about 3.5 to about 4 mg/L, about 4 to about 5 mg/L, about 5 to about 6 mg/L, about 6 to about 8 mg/L, about 8 to about 10 mg/L, about 10 to about 15 mg/L, about 15 to about 20 mg/L, about 20 to about 25 mg/L, about 25 to about 30 mg/L, about 30 mg/L to about 40 mg/L, about 40 to about 50 mg/L, about 50 to about 70 mg/L, about 70 to about 90 mg/L, about 80 to about 100 mg/L, about 100 to about 150 mg/L, about 150 to about 200 mg/L, about 200 to about 300 mg/L, about 300 to about 400 mg/L, about 400 to about 500 mg/L, about 500 to about 700 mg/L, about 700 to about 900 mg/L, or about 900 mg/L to about 1 g/L). In some embodiments, the isobutanol can be present in an amount of less than about 72 mg/L (e.g., less than about 70 mg/L, 60 mg/L, 50 mg/L, 40 mg/L, 30 mg/L, 20 mg/L, 10 mg/L, or 5 mg/L). In some embodiments, about 2.4% to about 75% by mass (e.g., about 2.4% to about 5%, about 5% to about 10%, about 10% to about 15%, about 15% to about 20%, about 20% to about 25%, about 25% to about 30%, about 20% to about 30%, about 30% to about 40%, about 40% to about 50%, about 50% to about 60%, about 60% to about 70%, about 70% to about 75%, or about 60% to about 75% by mass) of the one or more additional VOCs can be isobutanol. In some embodiments, the one or more additional VOCs can include no isobutanol.

The one or more additional VOCs in a Scotch-like alcoholic beverage can include isobutyl acetate. In some embodiments, the isobutyl acetate can be present in an amount of about 0.003 to about 1.9 mg/L (e.g., about 0.003 to about 0.005 mg/L, about 0.005 to about 0.01 mg/L, about 0.01 to about 0.02 mg/L, about 0.02 to about 0.03 mg/L, about 0.03 to about 0.05 mg/L, about 0.05 to about 0.1 mg/L, about 0.1 to about 0.2 mg/L, about 0.2 to about 0.3 mg/L, about 0.3 to about 0.5 mg/L, about 0.1 to about 0.5 mg/L, about 0.5 to about 0.7 mg/L, about 0.7 to about 0.9 mg/L, about 0.9 to about 1.1 mg/L, about 1.1 to about 1.3 mg/L, about 1.3 to about 1.5 mg/L, about 1.5 to about 1.7 mg/L, about 1.7 to about 1.9 mg/L, about 1.0 to about 1.5 mg/L, about 1.0 to about 1.9 mg/L, or about 1.5 to about 1.9 mg/L). In some embodiments, the isobutyl acetate can be present in an amount of less than about 0.032 mg/L (e.g., less than about 0.030 mg/L, 0.025 mg/L, 0.020 mg/L, 0.015 mg/L, 0.010 mg/L, or about 0.005 mg/L). In some embodiments, the isobutyl acetate can be present in an amount of at least about 0.23 mg/L (e.g., at least about 0.25 mg/L, 0.3 mg/L, 0.4 mg/L, 0.5 mg/L, 0.6 mg/L, 0.7 mg/L, 0.8 mg/L, 0.9 mg/L, or 1 mg/L). In some embodiments, about 0.0001% to about 1.6% by mass (e.g., about 0.0001% to about 0.0005%, about 0.0005% to about 0.001%, about 0.001% to about 0.005%, about 0.005% to about 0.01%, about 0.01% to about 0.02%, about 0.02% to about 0.04%, about 0.01% to about 0.05%, about 0.04% to about 0.06%, about 0.06% to about 0.08%, about 0.08% to about 0.1%, about 0.05% to about 0.1%, about 0.1% to about 0.2%, about 0.2% to about 0.4%, about 0.4% to about 0.6%, about 0.1% to about 0.5% about 0.6% to about 0.8%, about 0.8% to about 1.0%, about 0.5% to about 1.0% about 1.0% to about 1.2%, about 1.2% to about 1.4%, about 1.0% to about 1.5%, or about 1.4% to about 1.6% by mass) of the one or more additional VOCs can be isobutyl acetate. In some embodiments, less than about 0.00093% by mass (e.g., less than about 0.0009%, 0.0008%, 0.0007%, 0.0006%, 0.0005%, 0.0004%, 0.0003%, or 0.0002% by mass) of the one or more additional VOCs can be isobutyl acetate. In some embodiments, at least about 0.4% by mass (e.g., at least about 0.45%, 0.5%, 0.6%, 0.7%, 0.8%, 0.9%, or 1% by mass) of the one or more additional VOCs can be isobutyl acetate. In some embodiments, the one or more additional VOCs can include no isobutyl acetate.

The one or more additional VOCs in a Scotch-like alcoholic beverage can include isobutyric acid. In some embodiments, the isobutyric acid can be present in an amount of about 0.8 to about 5 mg/L (e.g., about 0.8 to about 1.0 mg/L, about 1.0 to about 1.2 mg/L, about 1.2 to about 1.4 mg/L, about 1.4 to about 1.6 mg/L, about 1.0 to about 1.5 mg/L, about 1.6 to about 1.8 mg/L, about 1.8 to about 2.0 mg/L, about 1.5 to about 2.0 mg/L, about 2.0 to about 2.2 mg/L, about 2.2 to about 2.4 mg/L, about 2.4 to about 2.6 mg/L, about 2.0 to about 2.5 mg/L, about 2.6 to about 2.8 mg/L, about 1 to about 5 mg/L, about 1 to about 2 mg/L, about 1 to about 3 mg/L, about 2 to about 4 mg/L, or about 3 to about 5 mg/L). In some embodiments, about 0.012% to about 1.6% by mass (e.g., about 0.012% to about 0.02%, about 0.02% to about 0.05%, about 0.05% to about 0.1%, about 0.1% to about 0.5%, about 0.5% to about 1.0%, about 1.0% to about 1.5%, or about 1.0% to about 1.6% by mass) of the one or more additional VOCs can be isobutyric acid. In some embodiments, the one or more additional VOCs can include no isobutyric acid.

The one or more additional VOCs in a Scotch-like alcoholic beverage can include isovaleraldehyde. In some embodiments, the isovaleraldehyde can be present in an amount of about 0.01 to about 0.6 mg/L (e.g., about 0.01 to about 0.05 mg/L, about 0.05 to about 0.1 mg/L, about 0.1 to about 0.2 mg/L, about 0.2 to about 0.4 mg/L, or about 0.4 to about 0.6 mg/L). In some embodiments, the isovaleraldehyde can be present in an amount of less than about 0.08 mg/L (e.g., less than about 0.07 mg/L, 0.06 mg/L, or 0.05 mg/L). In some embodiments, about 0.0003% to about 0.4% by mass (e.g., about 0.0003% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.2%, about 0.2% to about 0.3%, about 0.1% to about 0.3%, about 0.1% to about 0.4%, or about 0.3% to about 0.4% by mass) of the one or more additional VOCs can be isovaleraldehyde. In some embodiments, less than about 0.0023% by mass (e.g., less than about 0.0022%, 0.0021%, 0.0020%, 0.0015%, 0.0010%, 0.0008%, 0.0006%, or 0.0004% by mass) of the one or more additional VOCs can be isovaleraldehyde. In some embodiments, at least about 0.13% by mass (e.g., at least about 0.14%, 0.15%, 0.16%, 0.17%, 0.18%, 0.19%, 0.20%, 0.25%, 0.30%, or 0.35% by mass) of the one or more additional VOCs can be isovaleraldehyde. In some embodiments, the one or more additional VOCs can include no isovaleraldehyde.

The one or more additional VOCs in a Scotch-like alcoholic beverage can include limonene. In some embodiments, the limonene can be present in an amount of about 0.000006 to about 0.02 mg/L (e.g., about 0.000006 to about 0.00001 mg/L, about 0.00001 to about 0.00005 mg/L, about 0.00005 to about 0.0001 mg/L, about 0.0001 to about 0.005 mg/L, about 0.005 to about 0.01 mg/L, or about 0.01 to about 0.2 mg/L). In some embodiments, the limonene can be present in an amount of at least about 0.01 mg/L (e.g., at least about 0.011 mg/L, 0.012 mg/L, 0.013 mg/L, 0.014 mg/L, or 0.15 mg/L). In some embodiments, about 0.0000001% to about 0.03% by mass (e.g., about 0.0000001% to about 0.000001%, about 0.000001% to about 0.00001%, about 0.00001% to about 0.0001%, about 0.0001% to about 0.001%, about 0.001% to about 0.002%, about 0.002% to about 0.005%, about 0.001% to about 0.005%, about 0.005% to about 0.01%, about 0.01% to about 0.02%, about 0.01% to about 0.03% or about 0.02% to about 0.03% by mass) of the one or more additional VOCs can be limonene. In some embodiments, at least about 0.0015% by mass (e.g., at least about 0.002%, 0.003%, 0.005%, 0.007%, 0.009%, 0.01%, or 0.02% by mass) of the one or more additional VOCs can be limonene. In some embodiments, the one or more additional VOCs can include no limonene.

The one or more additional VOCs in a Scotch-like alcoholic beverage can include linalool. In some embodiments, the linalool can be present in an amount of about 0.0000006 to about 2 mg/L (e.g., about 0.0000006 to about 0.000001 mg/L, about 0.000001 to about 0.00001 mg/L, about 0.00001 to about 0.0001 mg/L, about 0.0001 to about 0.001 mg/L, about 0.001 to about 0.01 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 2 mg/L). In some embodiments, about 0.00000005% to about 0.3% by mass (e.g., about 0.00000005% to about 0.0000001%, about 0.0000001% to about 0.000001%, about 0.000001% to about 0.00001%, about 0.00001% to about 0.0001%, about 0.0001% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.2%, or about 0.2% to about 0.3% by mass) of the one or more additional VOCs can be linalool. In some embodiments, the one or more additional VOCs can include no linalool.

The one or more additional VOCs in a Scotch-like alcoholic beverage can include linalool oxide. In some embodiments, the linalool oxide can be present in an amount of about 0.003 to about 0.4 mg/L (e.g., about 0.003 to about 0.005 mg/L, about 0.005 to about 0.01 mg/L, about 0.01 to about 0.02 mg/L, about 0.02 to about 0.03 mg/L, about 0.03 to about 0.05 mg/L, about 0.05 to about 0.1 mg/L, about 0.1 to about 0.4 mg/L, about 0.1 to about 0.2 mg/L, about 0.2 to about 0.3 mg/L, or about 0.3 to about 0.4 mg/L). In some embodiments, about 0.0001% to about 0.07% by mass (e.g., about 0.0001% to about 0.0005%, about 0.0005% to about 0.001%, about 0.001% to about 0.005%, about 0.005% to about 0.01%, about 0.01% to about 0.03%, about 0.03% to about 0.05%, about 0.01% to about 0.05%, or about 0.05% to about 0.07% by mass) of the one or more additional VOCs can include no linalool oxide.

The one or more additional VOCs in a Scotch-like alcoholic beverage can include linalyl acetate. In some embodiments, the linalyl acetate can be present in an amount of about 0.00005 to about 0.5 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 mg/L to about 0.05 mg/L, about 0.05 to about 0.1 mg/L, about 0.1 to about 0.2 mg/L, about 0.2 to about 0.3 mg/L, about 0.3 to about 0.4 mg/L, about 0.4 to about 0.5, or about 0.1 to about 0.5 mg/L). In some embodiments, the linalyl acetate can be present in an amount of about at least about 0.028 mg/L (e.g., at least about 0.03 mg/L, 0.04 mg/L, 0.05 mg/L, 0.06 mg/L, 0.07 mg/L, 0.08 mg/L, 0.09 mg/L, 0.1 mg/L, 0.2 mg/L, 0.3 mg/L, or 0.4 mg/L). In some embodiments, about 0.0000008% to about 0.7% by mass (e.g., about 0.0000008% to about 0.00001%, about 0.000001% to about 0.00001%, about 0.00001% to about 0.0001%, about 0.0001% to about 0.001%, about 0.001% to about 0.003%, about 0.003% to about 0.005%, about 0.001% to about 0.005%, about 0.005% to about 0.007%, about 0.009%, about 0.009% to about 0.01%, about 0.005% to about 0.01%, about 0.01% to about 0.05%, about 0.05% to about 0.1%, about 0.1% to about 0.3%, about 0.3% to about 0.5%, about 0.1% to about 0.5%, or about 0.5% to about 0.7% by mass) of the one or more additional VOCs can be linalyl acetate. In some embodiments, at least about 0.004% by mass (e.g., at least about 0.005%, 0.006%, 0.007%, 0.008%, 0.009%, 0.01%, 0.02%, 0.05%, 0.1%, 0.2%, 0.3%, or 0.4% by mass) of the one or more additional VOCs can be linalyl acetate. In some embodiments, the one or more additional VOCs can include no linalyl acetate.

The one or more additional VOCs in a Scotch-like alcoholic beverage can include maltol. In some embodiments, the maltol can be present in an amount of about 0.00005 to about 5.5 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 2 mg/L, about 2 to about 3 mg/L, about 3 to about 4 mg/L, about 4 to about 5 mg/L, about 4.0 to about 5.5 mg/L, about 1 to about 5 mg/L, or about 1.0 to about 5.5 mg/L). In some embodiments, about 0.00002% to about 4% by mass (e.g., about 0.00002% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, about 2% to about 3%, about 3% to about 4%, or about 1% to about 4% by mass) of the one or more additional VOCs can be maltol. In some embodiments, the one or more additional VOCs can include no maltol.

The one or more additional VOCs in a Scotch-like alcoholic beverage can include methyl decanoate. In some embodiments, the methyl decanoate can be present in an amount of about 0.00002 to about 0.025 mg/L (e.g., about 0.00002 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.02 mg/L, about 0.010 to about 0.015 mg/L, about 0.015 to about 0.020 mg/L, about 0.020 to about 0.025 mg/L, about 0.010 to about 0.025 mg/L, or about 0.015 to about 0.025 mg/L). In some embodiments, the methyl decanoate can be present in an amount of less than about 0.0004 mg/L (e.g., less than about 0.0003 mg/L, 0.0002 mg/L, or 0.0001 mg/L). In some embodiments, about 0.0000004% to about 0.01% (e.g., about 0.0000004% to about 0.0000005%, about 0.0000005% to about 0.000001%, about 0.000001% to about 0.000005%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.005%, or about 0.005% to about 0.01% by mass) of the one or more additional VOCs can be methyl decanoate. In some embodiments, less than about 0.0000065% by mass (e.g., less than about 0.000006%, 0.000005%, 0.000004%, 0.000003%, 0.000002%, or 0.000001% by mass) of the one or more additional VOCs can be methyl decanoate. In some embodiments, at least about 0.004% by mass (e.g., at least about 0.005%, 0.006%, or 0.007% by mass) of the one or more additional VOCs can be methyl decanoate. In some embodiments, the one or more additional VOCs can include no methyl decanoate.

The one or more additional VOCs in a Scotch-like alcoholic beverage can include methyl hexanoate. In some embodiments, the methyl hexanoate can be present in an amount of about 0.0002 to about 0.09 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.02 mg/L, 0.02 to about 0.03 mg/L, about 0.03 to about 0.05 mg/L, about 0.01 to about 0.05 mg/L, about 0.05 to about 0.07 mg/L, about 0.05 to about 0.09 mg/L, about 0.01 to about 0.09 mg/L, or about 0.07 to about 0.09 mg/L). In some embodiments, the methyl hexanoate can be present in an amount of at least about 0.002 mg/L (e.g., at least about 0.003 mg/L, 0.004 mg/L, 0.005 mg/L, 0.006 mg/L, 0.007 mg/L, 0.008 mg/L, 0.009 mg/L, 0.01 mg/L, 0.02 mg/L, 0.03 mg/L, 0.04 mg/L, 0.05 mg/L, 0.06 mg/L, or 0.07 mg/L). In some embodiments, about 0.000004% to about 0.15% by mass (e.g., about 0.000004% to about 0.00001%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.005%, about 0.0004% to about 0.0005%, about 0.0005% to about 0.001%, about 0.001% to about 0.003%, about 0.003% to about 0.005%, about 0.001% to about 0.005%, about 0.005% to about 0.007%, about 0.005% to about 0.01%, about 0.01% to about 0.05%, about 0.05% to about 0.1%, about 0.10% to about 0.15%, or about 0.05% to about 0.15% by mass) of the one or more additional VOCs can be methyl hexanoate. In some embodiments, at least about 0.0003% by mass (e.g., at least about 0.0004%, 0.0005%, 0.0006%, 0.0007%, 0.0008%, 0.0009%, 0.001%, 0.003%, 0.005%, 0.007%, 0.009%, 0.01%, 0.03%, 0.05%, 0.09%, or 0.1% by mass) of the one or more additional VOCs can be methyl hexanoate. In some embodiments, the one or more additional VOCs can include no methyl hexanoate.

The one or more additional VOCs in a Scotch-like alcoholic beverage can include methyl laurate. In some embodiments, the methyl laurate can be present in amount of about 0.000007 to about 0.02 mg/L (e.g., about 0.000007 to about 0.00001 mg/L, about 0.00001 to about 0.00005 mg/L, about 0.00005 to about 0.0001 mg/L, about 0.0001 to about 0.0005 mg/L, about 0.0005 mg/L to about 0.001 mg/L, about 0.001 to about 0.005 mg/L, about 0.005 to about 0.01 mg/L, or about 0.01 to about 0.02 mg/L). In some embodiments, the methyl laurate can be present in amount of at least about 0.0003 mg/L (e.g., at least about 0.0004 mg/L, 0.0005 mg/L, 0.0006 mg/L, 0.0007 mg/L, 0.0008 mg/L, 0.0009 mg/L, 0.001 mg/L, 0.002 mg/L, 0.004 mg/L, 0.005 mg/L, 0.006 mg/L, 0.008 mg/L, or 0.01 mg/L). In some embodiments, about 0.0000001% to about 0.007% by mass (e.g., about 0.0000001% to about 0.0000005%, about 0.0000005% to about 0.000001%, about 0.000001% to about 0.000005%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.007%, about 0.001% to about 0.005%, or about 0.005% to about 0.007% by mass) of the one or more additional VOCs can be methyl laurate. In some embodiments, at least about 0.0025% by mass (e.g., at least about 0.003%, 0.004%, 0.005%, or 0.006% by mass) of the one or more additional VOCs can be methyl laurate. In some embodiments, the one or more additional VOCs can include no methyl laurate.

The one or more additional VOCs in a Scotch-like alcoholic beverage can include methyl octanoate. In some embodiments, the methyl octanoate can be present in an amount of 0.000000006 to about 0.006 mg/L (e.g., about 0.000000006 to about 0.00000001 mg/L, about 0.00000001 to about 0.0000001 mg/L, about 0.0000001 to about 0.000001 mg/L, about 0.000001 to about 0.00001 mg/L, about 0.00001 to about 0.0001 mg/L, about 0.0001 to about 0.0005 mg/L, about 0.0005 to about 0.001 mg/L, about 0.001 to about 0.005 mg/L, or about 0.001 to about 0.006 mg/L). In some embodiments, about 0.000000001% to about 0.0008% by mass (e.g., about 0.000000001% to about 0.000000005%, about 0.000000005% to about 0.0000001%, about 0.00000005%, about 0.00000005% to about 0.0000001%, about 0.0000001% to about 0.000001%, about 0.000001% to about 0.00001%, about 0.00001% to about 0.00005%, about 0.00005% to about 0.0001%, about 0.0001% to about 0.0008%, about 0.0001% to about 0.0005%, or about 0.0005% to about 0.0008% by mass) of the one or more additional VOCs can be methyl octanoate. In some embodiments, the one or more additional VOCs can include no methyl octanoate.

The one or more additional VOCs in a Scotch-like alcoholic beverage can include methyl salicylate. In some embodiments, the methyl salicylate can be present in an amount of about 0.00001 to about 0.017 mg/L (e.g., about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.010 mg/L, about 0.010 to about 0.015, or about 0.010 to about 0.017 mg/L). In some embodiments, the methyl salicylate can be present in an amount of less than about 0.003 mg/L (e.g., less than about 0.002 mg/L, 0.001 mg/L, 0.0009 mg/L, 0.0007 mg/L, 0.0005 mg/L, 0.0003 mg/L, 0.0001 mg/L, 0.00009 mg/L, 0.00007 mg/L, 0.00005 mg/L, or 0.00003 mg/L). In some embodiments, about 0.000004% to about 0.0025% by mass (e.g., about 0.000004% to about 0.000005%, about 0.000005% to about 0.00001%, about 0.00001% to about 0.00005%, about 0.00005% to about 0.0001%, about 0.0001% to about 0.0005%, about 0.0005% to about 0.001%, or about 0.001% to about 0.0025% by mass) of the one or more additional VOCs can be methyl salicylate. In some embodiments, less than about 0.00009% by mass (e.g., less than about 0.00008%, 0.00007%, 0.00006%, 0.00005%, 0.00004%, 0.00003%, 0.00002%, 0.00001%, 0.000009%, 0.000008%, 0.000007%, 0.000006%, or 0.000005% by mass) of the one or more additional VOCs can be methyl salicylate. In some embodiments, the one or more additional VOCs can include no methyl salicylate.

The one or more additional VOCs in a Scotch-like alcoholic beverage can include myrcene. In some embodiments, the myrcene can be present in an amount of about 0.000003 to about 0.0026 mg/L (e.g., about 0.000003 to about 0.000005 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.002 mg/L, or about 0.0010 to about 0.0026 mg/L). In some embodiments, about 0.0000006% to about 0.001% (e.g., about 0.0000006% to about 0.000001%, about 0.000001% to about 0.000005%, about 0.000005% to about 0.00001%, about 0.00001% to about 0.00005%, about 0.00005% to about 0.0001%, about 0.0001% to about 0.0005%, or about 0.0005% to about 0.001% by mass) of the one or more additional VOCs can be myrcene. In some embodiments, the one or more additional VOCs can include no myrcene.

The one or more additional VOCs in a Scotch-like alcoholic beverage can include myrtenol. In some embodiments, the myrtenol can be present in an amount of about 0.001 to about 0.6 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, or about 0.1 to about 0.6 mg/L). In some embodiments, the myrtenol is present in an amount of less than about 0.085 mg/L (e.g., less than about 0.08 mg/L, 0.07 mg/L 0.06 mg/L, 0.05 mg/L, 0.04 mg/L, 0.03 mg/L, 0.02 mg/L, 0.01 mg/L, or about 0.005 mg/L). In some embodiments, about 0.00002% to about 0.08% by mass (e.g., about 0.00001% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.03%, about 0.03% to about 0.05%, about 0.01% to about 0.05%, about 0.05% to about 0.07%, or about 0.07% to about 0.09% by mass) of the one or more additional VOCs can be myrtenol. In some embodiments, less than about 0.0013% by mass (e.g., less than about 0.0012%, 0.0011%, 0.0010%, 0.0005%, or 0.0001% by mass) of the one or more additional VOCs can be myrtenol. In some embodiments, the one or more additional VOCs can include no myrtenol.

The one or more additional VOCs in a Scotch-like alcoholic beverage can include nonanal. In some embodiments, the nonanal can be present in an amount of about 0.004 to about 0.05 mg/L (e.g., about 0.004 to about 0.01 mg/L, about 0.01 to about 0.04 mg/L, about 0.01 to about 0.02 mg/L, about 0.02 to about 0.03 mg/L, about 0.03 to about 0.04 mg/L, about 0.01 to about 0.05 mg/L, about 0.01 to about 0.03 mg/L, or about 0.03 to about 0.05 mg/L). In some embodiments, about 0.00006% to about 0.007% by mass (e.g., about 0.00006% to about 0.00001%, about 0.0001% to about 0.0005%, about 0.0005% to about 0.001%, about 0.001% to about 0.003%, about 0.001% to about 0.002%, about 0.002% to about 0.003%, about 0.001% to about 0.005%, about 0.001% to about 0.007%, about 0.003% to about 0.005%, or about 0.005% to about 0.007% by mass) of the one or more additional VOCs can be nonanal. In some embodiments, the one or more additional VOCs can include no nonanal.

The one or more additional VOCs in a Scotch-like alcoholic beverage can include octanoic acid. In some embodiments, the octanoic acid can be present in an amount of about 0.8 to about 75 mg/L (e.g., about 0.8 to about 1 mg/L, about 1 to about 2 mg/L, about 1 to about 5 mg/L, about 2 to about 5 mg/L, about 5 to about 10 mg/L, about 10 to about 15 mg/L, about 15 to about 20 mg/L, about 20 to about 25 mg/L, about 15 to about 25 mg/L, about 20 to about 30 mg/L, about 25 to about 30 mg/L, about 25 to about 50 mg/L, or about 50 to about 75 mg/L). In some embodiments, the octanoic acid can be present in an amount of less than about 2.5 mg/L (e.g, less than about 2.4 mg/L, 2.3 mg/L, 2.2 mg/L, 2.1 mg/L, 2.0 mg/L, 1.8 mg/L, 1.6 mg/L, 1.4 mg/L, or 1.2 mg/L). In some embodiments, about 0.05% to about 10% by mass (e.g., about 0.05% to about 0.1%, about 0.1% to about 0.5%, about 0.5% to about 1.0%, about 1.0 to about 1.5%, about 1.5% to about 2.0%, about 1% to about 5%, about 5% to about 10%, about 1% to about 2%, about 2% to about 4%, about 4% to about 6%, about 6% to about 8%, or about 8% to about 10% by mass) of the one or more additional VOCs can be octanoic acid. In some embodiments, the one or more additional VOCs can include no octanoic acid.

The one or more additional VOCs in a Scotch-like alcoholic beverage can include p-cresol. In some embodiments, the p-cresol can be present in an amount of about 0.0001 to about 11 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.3 mg/L, about 1 to about 2 mg/L, about 1 to about 5 mg/L, about 5 to about 10 mg/L, about 1 to about 3 mg/L, about 3 to about 5 mg/L, about 5 to about 7 mg/L, about 7 to about 9 mg/L, or about 9 to about 11 mg/L). In some embodiments, the p-cresol is present in an amount of less than about 0.009 mg/L (e.g., less than about 0.0085 mg/L, 0.008 mg/L, 0.007 mg/L, 0.006 mg/L, 0.005 mg/L, 0.004 mg/L, 0.003 mg/L, 0.002 mg/L, 0.001 mg/L, 0.0009 mg/L, 0.0007 mg/L, or 0.0005 mg/L). In some embodiments, about 0.00006% to about 1.5% by mass (e.g., about 0.00006% to about 0.0001%, about 0.0001% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.2%, about 0.2% to about 0.3%, about 0.3% to about 0.4%, about 0.1% to about 0.5%, about 0.4% to about 0.5%, about 0.1% to about 0.5%, about 0.5% to about 1.0%, about 0.5 to about 0.7%, about 0.7% to about 0.9%, about 0.4% to about 0.6%, about 0.6% to about 0.8%, about 0.8% to about 1.0%, or about 1.0% to about 1.5% by mass) of the one or more additional VOCs can be p-cresol. In some embodiments, less than about 0.00025% by mass (e.g., less than about 0.00024%, 0.00023%, 0.00022%, 0.00021%, 0.00020%, about 0.00015%, or 0.00010% by mass) of the one or more additional VOCs can be p-cresol. In some embodiments, the one or more additional VOCs can include no p-cresol.

The one or more additional VOCs in a Scotch-like alcoholic beverage can include p-cymene. In some embodiments, the p-cymene can be present in an amount of about 0.000001 to about 0.003 mg/L (e.g., about 0.000001 to about 0.000005 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.003 mg/L, about 0.001 to about 0.002 mg/L, or about 0.002 to about 0.003 mg/L). In some embodiments, about 0.0000002% to about 0.0015% (e.g., about 0.0000002% to about 0.0000005%, about 0.0000005% to about 0.000001%, about 0.000001% to about 0.000005%, about 0.000005% to about 0.00001%, about 0.00001% to about 0.00005%, about 0.00005% to about 0.0001%, about 0.0001% to about 0.0005%, about 0.0005% to about 0.0010%, or about 0.0010% to about 0.0015% by mass) of the one or more additional VOCs can be p-cymene. In some embodiments, the one or more additional VOCs can include no p-cymene.

The one or more additional VOCs in a Scotch-like alcoholic beverage can include phenethyl butyrate. In some embodiments, the phenethyl butyrate can be present in an amount of about 0.0000002 to about 0.01 mg/L (e.g., about 0.0000002 to about 0.0000005 mg/L, about 0.0000005 to about 0.000001 mg/L, about 0.000001 to about 0.000005 mg/L, about 0.000005 to about 0.00001 mg/L, about 0.00001 to about 0.00005 mg/L, about 0.00005 to about 0.0001 mg/L, about 0.001 to about 0.003 mg/L, about 0.003 to about 0.005 mg/L, about 0.001 to about 0.005 mg/L, or about 0.005 to about 0.01 mg/L). In some embodiments, the phenethyl butyrate can be present in an amount of less than about 0.0003 mg/L (e.g., less than about 0.0002 mg/L, 0.0001 mg/L, 0.00009 mg/L, 0.00007 mg/L, 0.00005 mg/L, 0.00003 mg/L, 0.00001 mg/L, 0.000009 mg/L, 0.000007 mg/L, 0.000005 mg/L, 0.000003 mg/L, 0.000001 mg/L, 0.0000009 mg/L, 0.0000007 mg/L, or 0.0000005 mg/L). In some embodiments, about 0.00000005% to about 0.0015% by mass (e.g., about 0.00000005% to about 0.0000001%, about 0.0000005%, about 0.0000005% to about 0.000001%, about 0.000001% to about 0.000005%, about 0.000005% to about 0.00001%, about 0.00001% to about 0.00005%, about 0.00005% to about 0.0001%, about 0.0001% to about 0.0003%, about 0.0003% to about 0.0005%, about 0.0001% to about 0.0005%, about 0.0005% to about 0.0007%, about 0.0005% to about 0.001%, about 0.001% to about 0.0015%, or about 0.0005 to about 0.0015% by mass) of the one or more additional VOCs can be phenethyl butyrate. In some embodiments, less than 0.0000045% by mass (e.g., less than 0.000004%, 0.000003%, 0.000001%, 0.00000009%, 0.0000007%, or 0.0000005% by mass) of the one or more additional VOCs can be phenethyl butyrate. In some embodiments, the one or more additional VOCs can include no phenethyl butyrate.

The one or more additional VOCs in a Scotch-like alcoholic beverage can include phenethyl octanoate. In some embodiments, the phenethyl octanoate can be present in an amount of about 0.0003 to about 0.3 mg/L (e.g., about 0.0003 to about 0.0005 mg/L, about 0.0005 to about 0.001 mg/L, about 0.001 to about 0.004 mg/L, about 0.001 to about 0.002 mg/L, about 0.002 to about 0.003 mg/L, about 0.003 to about 0.004 mg/L, about 0.001 to about 0.005 mg/L, about 0.005 to about 0.01 mg/L, about 0.01 to about 0.05 mg/L, about 0.05 to about 0.1 mg/L, about 0.1 to about 0.3 mg/L, about 0.1 to about 0.2 mg/L, or about 0.2 to about 0.3 mg/L). In some embodiments, the phenethyl octanoate can be present in an amount of less than about 0.0006 mg/L (e.g., less than about 0.0005 mg/L or 0.0004 mg/L). In some embodiments, about 0.000003% to about 0.04% by mass (e.g., about 0.000003% to about 0.000005%, about 0.000005% to about 0.00001%, about 0.00001% to about 0.00005%, about 0.00005% to about 0.0001%, about 0.0001% to about 0.0002%, about 0.0002% to about 0.0004%, about 0.0001% to about 0.0005%, about 0.0004% to about 0.0006%, about 0.0005% to about 0.001%, about 0.001% to about 0.005%, about 0.005% to about 0.01%, about 0.01% to about 0.04%, about 0.01% to about 0.03%, or about 0.02% to about 0.04% by mass) of the one or more additional VOCs can be phenethyl octanoate. In some embodiments, less than about 0.000018% by mass (e.g., less than about 0.000015%, 0.000012%, 0.000010%, 0.000008%, 0.000006%, or 0.000004% by mass) of the one or more additional VOCs can be phenethyl octanoate. In some embodiments, the one or more additional VOCs can include no phenethyl octanoate.

The one or more additional VOCs in a Scotch-like alcoholic beverage can include propanol. In some embodiments, the propanol can be present in an amount of about 0.9 to about 2.5 g/L (e.g., about 0.9 to about 1 mg/L, about 1 to about 2 mg/L, about 2 to about 5 mg/L, about 1 to about 5 mg/L, about 5 to about 10 mg/L, about 10 to about 20 mg/L, about 20 to about 30 mg/L, about 30 to about 40 mg/L, about 40 to about 50 mg/L, about 50 to about 60 mg/L, about 60 to about 70 mg/L, about 70 to about 80 mg/L, about 80 to about 90 mg/L, about 90 to about 100 mg/L, about 100 to about 150 mg/L, about 150 to about 200 mg/L, about 200 to about 300 mg/L, about 300 to about 400 mg/L, about 400 to about 500 mg/L, about 0.5 g/L to about 1 g/L, about 1 g/L to about 2 g/L, about 1.5 to about 2.5 g/L, or about 1.0 to about 2.5 g/L). In some embodiments, the propanol can be present in an amount of less than about 100 mg/L (e.g., less than about 95 mg/L, 90 mg/L, 85 mg/L, 80 mg/L, 75 mg/L, 70 mg/L, 65 mg/L, 60 mg/L, 55 mg/L, 50 mg/L 45 mg/L, 40 mg/L, 35 mg/L, 30 mg/L, 25 mg/L, 20 mg/L, 15 mg/L, 10 mg/L, or 5 mg/L). In some embodiments, about 0.25% to about 90% by mass (e.g., about 0.25% to about 0.5%, about 0.5% to about 1%, about 1% to about 2%, about 2% to about 4%, about 1% to about 5%, about 4% to about 6%, about 6% to about 8%, about 8% to about 10%, about 5% to about 10%, about 10% to about 15%, about 15% to about 20%, about 20% to about 30%, about 30% to about 40%, about 40% to about 50%, about 50% to about 70%, or about 70% to about 90% by mass) of the one or more additional VOCs can be propanol. In some embodiments, less than about 3% by mass (e.g., less than about 2.5%, 2.0%, 1.5%, 1.0%, 0.9%, or 0.8% by mass) of the one or more additional VOCs can be propanol. In some embodiments, the one or more additional VOC can include no propanol.

The one or more additional VOCs in a Scotch-like alcoholic beverage can include trans-2-hexen-1-al. In some embodiments, the trans-2-hexen-1-al can be present in an amount of about 0.0004 to about 0.0009 mg/L (e.g., about 0.0004 to about 0.0005 mg/L, about 0.0005 to about 0.0006 mg/L, about 0.0006 to about 0.0007 mg/L, 0.0007 to about 0.0008 mg/L, or about 0.0008 to about 0.0009 mg/L). In some embodiments, 0.000005% to about 0.0015% by mass (e.g., about 0.000005% to about 0.00001%, about 0.00001% to about 0.00005%, about 0.00001% to about 0.00007%, about 0.00005% to about 0.0001%, about 0.0001% to about 0.0005%, about 0.0005% to about 0.001%, about 0.0010% to about 0.0015%, or about 0.0005% to about 0.0015% by mass) of the one or more additional VOCs can be trans-2-hexen-1-al. In some embodiments, the one or more additional VOCs can include no trans-2-hexen-1-al.

The one or more additional VOCs in a Scotch-like alcoholic beverage can include whiskey lactone (also called cis-whiskey lactone). In some embodiments, the whiskey lactone can be present in an amount of about 0.02 to about 4 mg/L (e.g., about 0.02 to about 0.05 mg/L, about 0.05 to about 0.1 mg/L, about 0.1 to about 0.2 mg/L, about 0.2 to about 0.5 mg/L, about 0.5 to about 1 mg/L, about 1 to about 2 mg/L, about 2 to about 4 mg/L, or about 1 to about 4 mg/L). In some embodiments, the whiskey lactone can be present in an amount of less than about 0.2 mg/L (e.g., less than about 0.1 mg/L, 0.09 mg/L, 0.08 mg/L, 0.07 mg/L, 0.06 mg/L, or 0.05 mg/L). In some embodiments, about 0.007% to about 0.5% by mass (e.g., about 0.006% to about 0.01%, about 0.01% to about 0.05%, about 0.05% to about 0.1%, about 0.1% to about 0.3%, about 0.3% to about 0.5%, or about 0.1% to about 0.5% by mass) of the one or more additional VOCs can be whiskey lactone. In some embodiments, the one or more additional VOCs can include no whiskey lactone.

The one or more additional VOCs in a Scotch-like alcoholic beverage can include diethyl malate. In some embodiments, the diethyl malate can be present in an amount of about 0.08 to about 33 mg/L (e.g., about 0.08 to about 0.1 mg/L, about 0.1 to about 0.5 mg/L, about 0.5 to about 1 mg/L, about 1 to about 2 mg/L, about 2 to about 5 mg/L, about 5 to about 10 mg/L, about 10 to about 15 mg/L, about 15 to about 20 mg/L, about 20 to about 25 mg/L, about 25 to about 30 mg/L, or about 30 to about 33 mg/L). In some embodiments, the diethyl malate can be present in an amount of less than about 1.2 mg/L (e.g., less than about 1.1 mg/L, 1.0 mg/L, 0.9 mg/L, 0.8 mg/L, 0.7 mg/L, 0.6 mg/L, 0.5 mg/L, 0.4 mg/L, 0.3 mg/L, 0.2 mg/L, or 0.1 mg/L). In some embodiments, about 0.001% to about 4.5% by mass (e.g., about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, about 2% to about 3%, about 3% to about 4%, or about 4.0% to about 4.5% by mass) of the one or more additional VOCs can be diethyl malate. In some embodiments, the one or more additional VOCs can include no diethyl malate.

The one or more additional VOCs in a Scotch-like alcoholic beverage can include ethyl 3-hydroxyhexanoate. In some embodiments, the ethyl 3-hydroxyhexanoate can be present in an amount of about 0.002 to about 0.02 mg/L (e.g., about 0.002 to about 0.005 mg/L, about 0.005 to about 0.01 mg/L, or about 0.01 to about 0.02 mg/L). In some embodiments, the ethyl 3-hydroxyhexanoate can be present in an amount of less than about 0.005 mg/L (e.g., less than about 0.004 mg/L or 0.003 mg/L). In some embodiments, about 0.0001% to about 0.03% by mass (e.g., about 0.0001% to about 0.0005%, about 0.0005% to about 0.001%, about 0.001% to about 0.002%, about 0.002% to about 0.003%, about 0.003% to about 0.004%, about 0.004% to about 0.005%, about 0.001% to about 0.005%, about 0.005% to about 0.01%, about 0.01% to about 0.02%, about 0.01$ to about 0.03%, or about 0.02% to about 0.03% by mass) of the one or more additional VOCs can be ethyl 3-hydroxyhexanoate. In some embodiments, at least about 0.003% by mass (e.g., at least about 0.0035%, 0.004%, 0.005%, 0.006%, 0.007%, 0.008%, 0.009%, 0.01%, or 0.02% by mass) of the one or more additional VOCs can be ethyl 3-hydroxyhexanoate. In some embodiments, the one or more additional VOCs can include no ethyl 3-hydroxyhexanoate.

The one or more additional VOCs in a Scotch-like alcoholic beverage can include ethyl benzoate. In some embodiments, the ethyl benzoate can be present in an amount of about 0.002 to about 0.2 mg/L (e.g., about 0.002 to about 0.005 mg/L, about 0.005 to about 0.01 mg/L, about 0.01 to about 0.02 mg/L, about 0.02 to about 0.03 mg/L, about 0.01 to about 0.05 mg/L, about 0.05 to about 0.1 mg/L, or about 0.1 to about 0.2 mg/L). In some embodiments, the ethyl benzoate can be present in an amount of less than about 0.0045 mg/L (e.g., less than about 0.0044 mg/L, or 0.0043 mg/L). In some embodiments, about 0.0001% to about 0.03% by mass (e.g., about 0.0001% to about 0.0005%, about 0.0005% to about 0.001%, about 0.001% to about 0.005%, about 0.005% to about 0.01%, about 0.01% to about 0.02%, about 0.01% to about 0.03%, or about 0.02% to about 0.03% by mass) of the one or more additional VOCs can be ethyl benzoate. In some embodiments, at least about 0.0053% by mass (e.g., at least about 0.0055%, 0.006% 0.007%, 0.008%, 0.009%, 0.01%, or 0.02% by mass) of the one or more additional VOCs can be ethyl benzoate. In some embodiments, the one or more additional VOCs can include no ethyl benzoate.

The one or more additional VOCs in a Scotch-like alcoholic beverage can include ethyl levulinate. In some embodiments, the ethyl levulinate can be present in an amount of about 0.007 to about 0.2 mg/L (e.g., about 0.007 to about 0.01 mg/L, about 0.01 to about 0.02 mg/L, about 0.01 to about 0.05 mg/L, about 0.02 to about 0.04 mg/L, about 0.04 to about 0.06 mg/L, about 0.06 to about 0.08 mg/L, about 0.08 to about 0.10, about 0.05 to about 0.10 mg/L, about 0.10 to about 0.12 mg/L, about 0.12 to about 0.14 mg/L, about 0.10 to about 0.14 mg/L, about 0.1 to about 0.2 mg/L, about 0.10 to about 0.15 mg/L, or about 0.15 to about 0.20 mg/L). In some embodiments, about 0.0001% to about 0.15% by mass (e.g., about 0.0001% to about 0.0005%, about 0.0005% to about 0.001%, about 0.001% to about 0.005%, about 0.005% to about 0.01%, about 0.01% to about 0.02%, about 0.02% to about 0.03%, about 0.03% to about 0.05%, about 0.01% to about 0.05%, about 0.05% to about 0.07%, about 0.07% to about 0.09%, about 0.09% to about 0.11%, about 0.11% to about 0.13%, about 0.13% to about 0.15%, about 0.05% to about 0.10%, or about 0.10% to about 0.15% by mass) of the one or more additional VOCs can be ethyl levulinate. In some embodiments, at least about 0.045% by mass (e.g., at least about 0.05%, 0.06%, 0.07%, 0.08%, 0.09%, or 0.1% by mass) of the one or more additional VOCs can be ethyl levulinate. In some embodiments, the one or more additional VOCs can include no ethyl levulinate.

The one or more additional VOCs in a Scotch-like alcoholic beverage can include farnesol. In some embodiments, the farnesol can be present in an amount of about 0.007 to about 0.06 mg/L (e.g., about 0.007 to about 0.01 mg/L, about 0.01 to about 0.02 mg/L, about 0.01 to about 0.05 mg/L, about 0.01 to about 0.06 mg/L, about 0.02 to about 0.04 mg/L, or about 0.04 to about 0.06 mg/L). In some embodiments, about 0.0002% to about 0.07% by mass (e.g., about 0.0002% to about 0.0005%, about 0.0005% to about 0.001%, about 0.001% to about 0.005%, about 0.005% to about 0.01%, about 0.01% to about 0.03%, 0.03% to about 0.05%, about 0.01% to about 0.05%, or about 0.05% to about 0.07% by mass) of the one or more additional VOCs can be farnesol. In some embodiments, at least about 0.0075% by mass (e.g., at least about 0.008%, 0.009%, 0.01%, 0.02%, 0.03%, 0.04%, 0.05%, or 0.06% by mass) of the one or more additional VOCs can be farnesol. In some embodiments, the one or more additional VOCs can include no farnesol.

The one or more additional VOCs in a Scotch-like alcoholic beverage can include gamma-nonalactone. In some embodiments, the gamma-nonalactone can be present in an amount of about 0.004 to about 0.4 mg/L (e.g., about 0.004 to about 0.005 mg/L, about 0.005 to about 0.01 mg/L, about 0.01 to about 0.02 mg/L, about 0.02 to about 0.3 mg/L, about 0.03 to about 0.04 mg/L, about 0.01 to about 0.04 mg/L, about 0.02 to about 0.04 mg/L, about 0.01 to about 0.05 mg/L, about 0.05 to about 0.1 mg/L, about 0.1 to about 0.4 mg/L, about 0.1 to about 0.3 mg/L, or about 0.2 to about 0.4 mg/L). In some embodiments, the gamma-nonalactone can be present in an amount of less than about 0.0065 mg/L (e.g., less than about 0.0064, 0.0063, 0.0062, 0.0061, or 0.0060 mg/L). In some embodiments, about 0.0001% to about 0.06% by mass (e.g., about 0.0001% to about 0.0005%, about 0.0005% to about 0.001%, about 0.001% to about 0.005%, about 0.005% to about 0.01%, about 0.01% to about 0.02%, about 0.02% to about 0.03%, about 0.01% to about 0.04%, about 0.03% to about 0.04%, about 0.01% to about 0.05%, about 0.01% to about 0.06%, about 0.01% to about 0.03%, about 0.03% to about 0.05%, or about 0.02% to about 0.04% by mass) of the one or more additional VOCs can be gamma-nonalactone. In some embodiments, at least about 0.0094% by mass (e.g., at least about 0.0095%, 0.0096%, 0.0097%, 0.0098%, 0.0099%, 0.010%, 0.015%, 0.020%, 0.025%, 0.030%, or 0.035% by mass) of the one or more additional VOCs can be gamma-nonalactone. In some embodiments, the one or more additional VOCs can include no gamma-nonalactone.

The one or more additional VOCs in a Scotch-like alcoholic beverage can include geraniol. In some embodiments, the geraniol can be present in an amount of about 0.007 to about 5.6 mg/L (e.g., about 0.007 to about 0.01 mg/L, about 0.01 to 0.05 mg/L, about 0.05 to about 0.1 mg/L, about 0.1 to about 0.5 mg/L, about 0.5 to about 1 mg/L, about 1 to about 5 mg/L, about 1.0 to about 5.6 mg/L, about 1 to about 2 mg/L, about 2 to about 3 mg/L, about 3 to about 4 mg/L, about 4 to about 5 mg/L, about 4.0 to about 5.6 mg/L, or about 5.0 to about 5.6 mg/L). In some embodiments, the geraniol can be present in an amount of at least about 0.04 mg/L (e.g., at least about 0.05 mg/L, 0.06 mg/L, 0.07 mg/L, 0.08 mg/L, 0.09 mg/L, 0.1 mg/L, 0.2 mg/L, 0.3 mg/L, 0.4 mg/L, 0.5 mg/L, 0.6 mg/L, 0.7 mg/L, 0.8 mg/L, 0.9 mg/L, 1 mg/L, 2 mg/L, 3 mg/L, 4 mg/L, or 5 mg/L). In some embodiments, about 0.0002% to about 2.2% by mass (e.g., about 0.0002% to about 0.0005%, about 0.0005% to about 0.001%, about 0.001% to about 0.005%, about 0.005% to about 0.006%, about 0.006% to about 0.007%, about 0.007% to about 0.008%, about 0.008% to 0.009%, about 0.009% to about 0.01%, about 0.005% to about 0.01%, about 0.01% to about 0.02%, about 0.02% to about 0.03%, about 0.03% to about 0.05%, about 0.05% to about 0.1%, about 0.1% to about 0.5%, about 0.5% to about 1%, about 1.0% to about 1.5%, about 1.5% to about 2.0%, about 1.5% to about 2.2%, or about 1% to about 2% by mass) of the one or more additional VOCs can be geraniol. In some embodiments, at least about 0.006% by mass (e.g., at least about 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.5%, or 2.0% by mass) of the one or more additional VOCs can be geraniol. In some embodiments, the one or more additional VOCs can include no geraniol.

The one or more additional VOCs in a Scotch-like alcoholic beverage can include isobutyraldehyde. In some embodiments, the isobutyraldehyde can be present in an amount of about 0.03 to about 12 mg/L (e.g., about 0.03 to about 0.1 mg/L, about 0.03 to about 0.05 mg/L, about 0.05 to about 0.1 mg/L, about 0.1 to about 0.5 mg/L, about 0.5 to about 1 mg/L, about 1 to about 2 mg/L, about 2 to about 4 mg/L, about 4 to about 6 mg/L, about 6 to about 8 mg/L, about 8 to about 10 mg/L, or about 10 to about 12 mg/L). In some embodiments, the isobutyraldehyde can be present in an amount of at least about 4.4 mg/L (e.g., at least about 4.5 mg/L, 4.6 mg/L, 4.7 mg/L, 4.8 mg/L, 4.9 mg/L, 5 mg/L, 6 mg/L, 7 mg/L, 8 mg/L, 9 mg/L, or 10 mg/L). In some embodiments, about 0.0005% to about 15% by mass (e.g., about 0.0005% to about 0.001%, about 0.001% to about 0.005%, about 0.005% to about 0.01%, about 0.01% to about 0.05%, about 0.05% to about 0.1%, about 0.1% to about 0.2%, about 0.2% to about 0.5%, about 0.5% to about 1%, about 1% to about 2%, about 2% to about 3%, about 3% to about 5%, about 1% to about 5%, about 5% to about 7%, about 7% to about 9%, about 9% to about 11%, about 5% to about 10%, about 11% to about 13%, about 10% to about 15%, or about 13% to about 15% by mass) of the one or more additional VOCs can be isobutyraldehyde. In some embodiments, at least about 0.65% by mass (e.g., at least about 0.7%, 0.8%, 0.9%, 1%, 2%, 3%, 4%, 5%, 6%, 7%, 8%, 9%, 10%, 11%, 12%, 13%, or 14% by mass) of the one or more additional VOCs can be isobutyraldehyde. In some embodiments, the one or more additional VOCs can include no isobutyraldehyde.

The one or more additional VOCs in a Scotch-like alcoholic beverage can include phenethyl formate. In some embodiments, the phenethyl formate can be present in an amount of about 0.01 to about 0.1 mg/L (e.g., about 0.01 to about 0.02 mg/L, about 0.02 to about 0.04 mg/L, about 0.04 to about 0.06 mg/L, about 0.06 to about 0.08 mg/L, about 0.01 to about 0.05 mg/L, about 0.05 to about 0.1 mg/L, or about 0.08 to about 0.1 mg/L). In some embodiments, the phenethyl formate can be present in an amount of at least about 0.055 mg/L (e.g., at least about 0.06 mg/L, 0.07 mg/L, 0.08 mg/L, or 0.09 mg/L). In some embodiments, about 0.0002% to about 0.12% by mass (e.g., about 0.0002% to about 0.0005%, about 0.0005% to about 0.001%, about 0.001% to about 0.005%, about 0.005% to about 0.01%, about 0.01% to about 0.02%, about 0.02% to about 0.04%, about 0.01% to about 0.05%, about 0.04% to about 0.06%, about 0.06% to about 0.08%, about 0.08% to about 0.10%, about 0.05% to about 0.10%, or about 0.10% to about 0.12% by mass) of the one or more additional VOCs can be phenethyl formate. In some embodiments, at least about 0.0077% by mass (e.g., at least about 0.008%, 0.009%, 0.01%, 0.02%, 0.03%, 0.04%, 0.05%, 0.06%, 0.07%, 0.08%, 0.09%, or 0.1% by mass) of the one or more additional VOCs can be phenethyl formate. In some embodiments, the one or more additional VOCs can include no phenethyl formate.

The one or more additional VOCs in a Scotch-like alcoholic beverage can include propyl acetate. In some embodiments, the propyl acetate can be present in an amount of about 0.01 to about 0.15 mg/L (e.g., about 0.01 to about 0.03 mg/L, about 0.03 to about 0.05 mg/L, about 0.01 to about 0.05 mg/L, about 0.05 to about 0.07 mg/L, about 0.07 to about 0.09 mg/L, about 0.09 to about 0.11 mg/L, about 0.05 to about 0.10 mg/L, about 0.11 to about 0.13 mg/L, about 0.13 to about 0.15 mg/L, or about 0.10 to about 0.15 mg/L). In some embodiments, the propyl acetate can be present in an amount of less than about 0.03 mg/L (e.g., less than about 0.02 mg/L). In some embodiments, about 0.0006% to about 0.2% by mass (e.g., about 0.0006% to about 0.001%, about 0.001% to about 0.005%, about 0.005% to about 0.01%, about 0.01% to about 0.05%, about 0.05% to about 0.1%, or about 0.1% to about 0.2% by mass) of the one or more additional VOCs can be propyl acetate. In some embodiments, at least about 0.032% by mass (e.g., at least about 0.035%, 0.04%, 0.05%, 0.06% 0.07% 0.08%, 0.09%, or 0.1% by mass) of the one or more additional VOCs can be propyl acetate. In some embodiments, the one or more additional VOCs can include no propyl acetate.

The one or more additional VOCs in a Scotch-like alcoholic beverage can include salicylaldehyde. In some embodiments, the salicylaldehyde can be present in an amount of about 0.001 to about 0.065 mg/L (e.g., about 0.001 to about 0.005 mg/L, about 0.005 to about 0.01 mg/L, about 0.01 to about 0.02 mg/L, about 0.01 to about 0.05 mg/L, about 0.02 to about 0.04 mg/L, about 0.04 to about 0.06 mg/L, or about 0.040 to about 0.065 mg/L). In some embodiments, the salicylaldehyde can be present in an amount of less than about 0.0044 mg/L (e.g., less than about 0.004 mg/L, 0.003 mg/L or 0.002 mg/L). In some embodiments, the salicylaldehyde can be present in an amount of at least about 0.02 mg/L (e.g., at least about 0.03 mg/L, 0.04 mg/L, or 0.05 mg/L). In some embodiments, about 0.00002% to about 0.05% by mass (e.g., about 0.00002% to about 0.00005%, about 0.00005% to about 0.0001%, about 0.0001% to about 0.0005%, about 0.0005% to about 0.001%, about 0.001% to about 0.003% to about 0.005%, about 0.001% to about 0.005%, about 0.005% to about 0.01%, 0.01% to about 0.02%, about 0.02% to about 0.03%, about 0.03% to about 0.04%, about 0.04% to about 0.05%, or about 0.01% to about 0.05% by mass) of the one or more additional VOCs can be salicylaldehyde. In some embodiments, at least about 0.003% by mass (e.g., at least about 0.004%, 0.005%, 0.006%, 0.007%, 0.008%, 0.009%, 0.01%, 0.02%, 0.03%, or 0.04% by mass) of the one or more additional VOCs can be salicylaldehyde. In some embodiments, the one or more additional VOCs can include no salicylaldehyde.

The one or more additional VOCs in a Scotch-like alcoholic beverage can include vanillyl ethyl ether. In some embodiments, the vanillyl ethyl ether can be present in an amount of about 0.002 to about 0.1 mg/L (e.g., about 0.002 to about 0.005 mg/L, about 0.005 to about 0.01 mg/L, about 0.009 to about 0.01 mg/L, about 0.01 to about 0.03 mg/L, about 0.01 to about 0.05 mg/L, about 0.03 to about 0.05 mg/L, about 0.05 to about 0.07 mg/L, about 0.07 to about 0.09 mg/L, about 0.01 to about 0.05 mg/L, or about 0.05 to about 0.1 mg/L). In some embodiments, about 0.00003% to about 0.09% by mass (e.g., about 0.00003% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.03%, about 0.03% to about 0.05%, about 0.01% to about 0.05%, about 0.05% to about 0.07%, about 0.05% to about 0.09%, or about 0.07% to about 0.09% by mass) of the one or more additional VOCs can be vanillyl ethyl ether. In some embodiments, at least about 0.02% by mass (e.g., about 0.03%, 0.04%, 0.05%, 0.06%, 0.07%, or 0.08% by mass) of the one or more additional VOCs can be vanillyl ethyl ether. In some embodiments, the one or more additional VOCs can include no vanillyl ethyl ether.

The one or more additional VOCs in a Scotch-like alcoholic beverage can include 2-heptanone. In some embodiments, the 2-heptanone can be present in an amount of about 0.009 to about 0.4 mg/L (e.g., about 0.004 to about 0.005 mg/L, about 0.005 to about 0.01 mg/L, about 0.01 to about 0.02 mg/L, about 0.01 to about 0.05 mg/L, about 0.02 to about 0.04 mg/L, about 0.04 to about 0.06 mg/L, about 0.06 to about 0.08 mg/L, about 0.08 to about 0.1 mg/L, about 0.05 to about 0.1 mg/L, about 0.1 to about 0.4 mg/L, about 0.1 to about 0.3 mg/L, or about 0.2 to about 0.4 mg/L). In some embodiments, about 0.0001% to about 0.1% by mass (e.g., about 0.0001% to about 0.0005%, about 0.0005% to about 0.001%, about 0.001% to about 0.005%, about 0.005% to about 0.01%, about 0.01% to about 0.02%, about 0.02% to about 0.04%, about 0.01% to about 0.05%, about 0.04% to about 0.06%, about 0.06% to about 0.08%, about 0.05% to about 0.1%, or about 0.08% to about 0.1% by mass) of the one or more additional VOCs can be 2-heptanone. In some embodiments, at least about 0.010% by mass (e.g., about 0.015%, about 0.02%, 0.03%, 0.04%, 0.05%, 0.06%, 0.07%, 0.08%, or 0.09% by mass) of the one or more additional VOCs can be 2-heptanone. In some embodiments, the one or more additional VOCs can include no 2-heptanone.

The one or more additional VOCs in a Scotch-like alcoholic beverage can include acetophenone. In some embodiments, the acetophenone can be present in an amount of about 0.001 to about 0.2 mg/L (e.g., about 0.001 to about 0.005 mg/L, about 0.005 to about 0.01 mg/L, about 0.01 to about 0.02 mg/L, about 0.01 to about 0.05 mg/L, about 0.02 to about 0.04 mg/L, 0.04 to about 0.06 mg/L, about 0.06 to about 0.08 mg/L, about 0.08 to about 0.1 mg/L, about 0.05 to about 0.1 mg/L, or about 0.1 to about 0.2 mg/L). In some embodiments, about 0.00003% to about 0.03% by mass (e.g., about 0.00003% to about 0.00005%, about 0.00005% to about 0.0001%, about 0.0001% to about 0.0005%, about 0.0005% to about 0.001%, about 0.001% to about 0.002%, about 0.002% to about 0.004%, about 0.004% to about 0.006%, about 0.001% to about 0.005%, about 0.006% to about 0.008%, about 0.005% to about 0.01%, about 0.008% to about 0.01%, about 0.01% to about 0.03%, about 0.01% to about 0.02%, or about 0.02% to about 0.03% by mass) of the one or more additional VOCs can be acetophenone. In some embodiments, the one or more additional VOCs can include no acetophenone.

The one or more additional VOCs in a Scotch-like alcoholic beverage can include geranyl acetone. In some embodiments, the geranyl acetone can be present in an amount of about 0.0025 to about 0.02 mg/L (e.g., about 0.0025 to about 0.005 mg/L, about 0.005 to about 0.01 mg/L, or about 0.01 to about 0.02 mg/L). In some embodiments, about 0.00007% to about 0.025% by mass (e.g., about 0.00007% to about 0.0001%, about 0.00007% to about 0.0005%, about 0.0001% to about 0.0005%, about 0.0005% to about 0.001%, about 0.001% to about 0.005%, about 0.005% to about 0.010%, about 0.010% to about 0.015%, about 0.015% to about 0.020%, or about 0.020% to about 0.025% by mass) of the one or more additional VOCs can be geranyl acetone. In some embodiments, at least about 0.0023% (e.g., at least about 0.0025%, 0.003%, 0.004%, 0.005%, 0.006%, 0.007%, 0.008%, 0.009%, 0.010%, 0.015%, or 0.020% by mass) of the one or more additional VOCs can be geranyl acetone. In some embodiments, the one or more additional VOCs can include no geranyl acetone.

The one or more additional VOCs in a Scotch-like alcoholic beverage can include methional. In some embodiments, the methional can be present in an amount of about 0.001 to about 0.009 mg/L (e.g., about 0.001 to about 0.003 mg/L, about 0.003 to about 0.005 mg/L, about 0.005 to about 0.007 mg/L, about 0.001 to about 0.005 mg/L, about 0.005 to about 0.009 mg/L, or about 0.007 to about 0.009 mg/L). In some embodiments, about 0.00003% to about 0.01% by mass (e.g., about 0.00003% to about 0.00005%, 0.00005% to about 0.0001%, about 0.0001% to about 0.0005%, about 0.0005% to about 0.001%, about 0.001% to about 0.002%, about 0.002% to about 0.004%, about 0.004% to about 0.006%, about 0.001% to about 0.005%, about 0.006% to about 0.008%, about 0.005% to about 0.01%, or about 0.008% to about 0.01% by mass) of the one or more additional VOCs can be methional. In some embodiments, at least about 0.0010% by mass (e.g., about 0.0015%, 0.002%, 0.003%, 0.004%, 0.005%, 0.006%, 0.007%, 0.008%, or 0.009% by mass) of the one or more additional VOCs can be methional. In some embodiments, the one or more additional VOCs can include no methional.

The one or more additional VOCs in a Scotch-like alcoholic beverage can include ethyl trans-2-butenoate. In some embodiments, the ethyl trans-2-butenoate can be present in an amount of about 0.005 to about 0.05 mg/L (e.g., about 0.005 to about 0.01 mg/L, about 0.01 to about 0.02 mg/L, about 0.01 to about 0.04 mg/L, about 0.02 to about 0.03 mg/L, about 0.03 to about 0.04 mg/L, about 0.04 to about 0.05 mg/L, or about 0.01 to about 0.05 mg/L). In some embodiments, about 0.0001% to about 0.05% by mass (e.g., about 0.0001% to about 0.0005%, about 0.0005% to about 0.001%, about 0.001% to about 0.005%, about 0.005% to about 0.01%, about 0.005% to about 0.01%, about 0.01% to about 0.02%, about 0.02% to about 0.03%, about 0.03% to about 0.04%, about 0.01% to about 0.05%, or about 0.04% to about 0.05% by mass) of the one or more additional VOCs can be ethyl trans-2-butenoate. In some embodiments, at least about 0.01% by mass (e.g., at least about 0.015%, 0.02%, 0.03%, or 0.04% by mass) of the one or more additional VOCs can be ethyl trans-2-butenoate. In some embodiments, the one or more additional VOCs can include no ethyl trans-2-butenoate.

The one or more additional VOCs in a Scotch-like alcoholic beverage can include valeraldehyde. In some embodiments, the valeraldehyde can be present in an amount of about 0.007 to about 0.06 mg/L (e.g., about 0.007 to about 0.01 mg/L, about 0.01 to about 0.05 mg/L, about 0.01 to about 0.06 mg/L, about 0.01 to about 0.02 mg/L, about 0.02 to about 0.04 mg/L, or about 0.04 to about 0.06 mg/L). In some embodiments, about 0.004% to about 0.07% by mass (e.g., about 0.004% to about 0.005%, about 0.005% to about 0.01%, about 0.01% to about 0.02%, about 0.02% to about 0.03%, 0.03% to about 0.04%, about 0.04% to about 0.05%, about 0.01% to about 0.05%, about 0.05% to about 0.06%, or about 0.06% to about 0.07% by mass) of the one or more additional VOCs can include no valeraldehyde.

The one or more additional VOCs in a Scotch-like alcoholic beverage can include propionaldehyde. In some embodiments, the propionaldehyde can be present in an amount of about 0.07 to about 0.13 mg/L (e.g., about 0.07 to about 0.09 mg/L, about 0.09 to about 0.11 mg/L, about 0.11 to about 0.13 mg/L, about 0.07 to about 0.10 mg/L, or about 0.10 to about 0.13 mg/L). In some embodiments, about 0.04% to about 0.2% by mass (e.g., about 0.04% to about 0.10%, about 0.05% to about 0.10%, about 0.10% to about 0.15%, about 0.15% to about 0.20%, or about 0.1% to about 0.2% by mass) of the one or more additional VOCs can be propionaldehyde. In some embodiments, the one or more additional VOCs can include no propionaldehyde.

The one or more additional VOCs in a Scotch-like alcoholic beverage can include heptyl acetate. In some embodiments, the heptyl acetate can be present in an amount of about 0.003 to about 0.03 mg/L (e.g., about 0.003 to about 0.005 mg/L, about 0.005 to about 0.01 mg/L, about 0.01 to about 0.03 mg/L, about 0.01 to about 0.02 mg/L, or about 0.02 to about 0.03 mg/L). In some embodiments, about 0.00005% to about 0.005% by mass (e.g., about 0.00005% to about 0.0001%, about 0.0001% to about 0.0005%, about 0.0005% to about 0.001%, or about 0.001% to about 0.005% by mass) of the one or more additional VOCs can be heptyl acetate. In some embodiments, the one or more additional VOCs can include no heptyl acetate.

The one or more additional VOCs in a Scotch-like alcoholic beverage can include isoamyl isovalerate. In some embodiments, the isoamyl isovalerate can be present in an amount of about 0.0003 to about 0.028 mg/L (e.g., about 0.0003 to about 0.0005 mg/L, about 0.0005 to about 0.001 mg/L, about 0.001 to about 0.005 mg/L, about 0.005 to about 0.01 mg/L, about 0.01 to about 0.02 mg/L, about 0.010 to about 0.028 mg/L, about 0.014 to about 0.020 mg/L, about 0.015 to about 0.020 mg/L, about 0.020 to about 0.025 mg/L, about 0.020 to about 0.028 mg/L, or about 0.025 to about 0.028 mg/L). In some embodiments, about 0.000005% to about 0.01% by mass (e.g., about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.005%, about 0.005% to about 0.01%, about 0.005% to about 0.007%, about 0.007% to about 0.009%, about 0.006% to about 0.008%, or about 0.008% to about 0.01% by mass) of the one or more additional VOCs can be isoamyl isovalerate. In some embodiments, at least about 0.0003% by mass (e.g., at least about 0.0004%, 0.0005%, 0.0006%, 0.0007%, 0.0008%, 0.0009%, 0.001%, 0.002%, 0.003%, 0.004%, 0.005%, 0.006%, or 0.007% by mass) of the one or more additional VOCs can be isoamyl isovalerate. In some embodiments, the one or more additional VOCs can include no isoamyl isovalerate.

The one or more additional VOCs in a Scotch-like alcoholic beverage can include isobutyl isobutyrate. In some embodiments, the isobutyl isobutyrate can be present in an amount of about 0.0005 to about 0.01 mg/L (e.g., about 0.0005 to about 0.0007 mg/L, about 0.0006 to about 0.0008 mg/L, or about 0.0007 to about 0.0009 mg/L). In some embodiments, about 0.0002% to about 0.0004% (e.g., about 0.0002% to about 0.0003%, or about 0.0003% to about 0.0004%) by mass of the one or more additional VOCs can be isobutyl isobutyrate. In some embodiments, the one or more additional VOCs can include no isobutyl isobutyrate.

The one or more additional VOCs in a Scotch-like alcoholic beverage can include p-anisaldehyde. In some embodiments, the p-anisaldehyde can be present in an amount of about 0.028 to about 0.055 mg/L (e.g., about 0.028 to about 0.030 mg/L, about 0.03 to about 0.04 mg/L, about 0.04 to about 0.05 mg/L, about 0.03 to about 0.05 mg/L, or about 0.50 to about 0.55 mg/L). In some embodiments, about 0.02% to about 0.05% by mass (e.g., about 0.02% to about 0.03%, about 0.03% to about 0.04%, or about 0.04% to about 0.05% by mass) of the one or more additional VOCs can be p-anisaldehyde. In some embodiments, the one or more additional VOCs can include no p-anisaldehyde.

The one or more additional VOCs in a Scotch-like alcoholic beverage can include phenethyl propionate. In some embodiments, the phenethyl propionate can be present in an amount of about 0.0003 to about 0.05 mg/L (e.g., about 0.0003 to about 0.0004 mg/L, about 0.0004 to about 0.0006 mg/L, about 0.0005 to about 0.001 mg/L, about 0.0006 to about 0.0008 mg/L, about 0.0008 to about 0.0010 mg/L, about 0.0010 to about 0.0012 mg/L, about 0.001 to about 0.005 mg/L, about 0.005 to about 0.01 mg/L, or about 0.01 to about 0.05 mg/L). In some embodiments, about 0.000005% to about 0.007% by mass (e.g., about 0.000005% to about 0.00001%, about 0.00001% to about 0.00005%, about 0.00005% to about 0.0001%, about 0.0001% to about 0.0002%, about 0.0001% to about 0.0005%, about 0.0005% to about 0.001%, about 0.001% to about 0.007%, about 0.001% to about 0.005%, about 0.001% to about 0.003%, about 0.003% to about 0.005%, or about 0.005% to about 0.007% by mass) of the one or more additional VOCs can be phenethyl propionate. In some embodiments, the one or more additional VOCs can include no phenethyl propionate.

The one or more additional VOCs in a Scotch-like alcoholic beverage can include butyraldehyde. In some embodiments, the butyraldehyde can be present in an amount of about 0.01 to about 0.03 mg/L (e.g., about 0.01 to about 0.02 mg/L or 0.02 to about 0.03 mg/L). In some embodiments, about 0.008% to about 0.025% by mass (e.g., about 0.008% to about 0.010%, about 0.010% to about 0.015%, about 0.015% to about 0.020%, about 0.01% to about 0.02%, or about 0.020% to about 0.025% by mass) of the one or more additional VOCs can be butyraldehyde. In some embodiments, the one or more additional VOCs can include no butyraldehyde.

The one or more additional VOCs in a Scotch-like alcoholic beverage can include propionic acid. In some embodiments, the propionic acid can be present in an amount of about 0.14 to about 3 mg/L (e.g., about 0.14 to about 0.20 mg/L, about 0.15 to about 0.20 mg/L about 0.20 to about 0.25 mg/L, about 0.15 to about 0.25 mg/L, about 0.2 to about 0.5 mg/L, about 0.1 to about 0.5 mg/L, about 0.5 to about 1 mg/L, about 1 to about 2 mg/L, about 1 to about 3 mg/L, or about 2 to about 3 mg/L). In some embodiments, the propionic acid can be present in an amount of less than about 0.38 mg/L (e.g., less than about 0.36 mg/L, 0.35 mg/L, 0.34 mg/L, 0.32 mg/L, 0.30 mg/L, 0.28 mg/L, 0.26 mg/L, 0.25 mg/L, 0.24 mg/L, 0.22 mg/L, or 0.20 mg/L). In some embodiments, about 0.008% to about 0.4% by mass (e.g., about 0.008% to about 0.01%, about 0.01% to about 0.05%, about 0.05% to about 0.1%, about 0.08% to about 0.10%, about 0.10% to about 0.15%, about 0.15% to about 0.20%, about 0.20% to about 0.25%, about 0.10% to about 0.20%, about 0.15% to about 0.25%, about 0.1% to about 0.4%, about 0.1% to about 0.3%, or about 0.2% to about 0.4% by mass) of the one or more additional VOCs can be propionic acid. In some embodiments, the one or more additional VOCs can include no propionic acid.

The one or more additional VOCs in a Scotch-like alcoholic beverage can include isovaleric acid. In some embodiments, the isovaleric acid can be present in an amount of about 0.5 to about 3.6 mg/L (e.g., about 0.5 to about 1.0 mg/L, about 1.0 to about 2.0 mg/L, about 0.5 to about 1.5 mg/L, about 1.5 to about 2.0 mg/L, about 1.8 to about 2.0 mg/L, about 1.8 to about 2.5 mg/L, about 2.0 to about 2.5 mg/L, about 2.0 to about 3.0 mg/L, about 2.5 to about 3.0 mg/L, about 3.0 to about 3.5 mg/L, or about 3.0 to about 3.6 mg/L). In some embodiments, about 0.009% to about 3.2% by mass (e.g., about 0.009% to about 0.05%, about 0.01% to about 0.05%, about 0.05% to about 0.1%, about 0.1% to about 0.5%, about 0.5% to about 1.0%, about 1.0% to about 1.5%, about 1.0% to about 2.0%, about 1.1% to about 1.5%, about 1.5% to about 2.0%, about 1.1% to about 2.0%, about 2.0% to about 2.5%, about 2.0% to about 3.0%, about 2.0% to about 3.2%, about 2.5% to about 3.0%, or about 2.5% to about 3.2% by mass) of the one or more additional VOCs can be isovaleric acid. In some embodiments, the one or more additional VOCs can include no isovaleric acid.

The one or more additional VOCs in a Scotch-like alcoholic beverage can include valeric acid. In some embodiments, the valeric acid can be present in an amount of 0.04 to about 0.08 mg/L (e.g., about 0.04 to about 0.05 mg/L, about 0.05 to about 0.06 mg/L, about 0.06 to about 0.07 mg/L, about 0.07 to about 0.08 mg/L, about 0.04 to about 0.06 mg/L, about 0.06 to about 0.08 mg/L, about 0.05 to about 0.07 mg/L). In some embodiments, about 0.02% to about 0.07% by mass (e.g., about 0.02% to about 0.03%, about 0.03% to about 0.04%, about 0.04% to about 0.05%, about 0.05% to about 0.06%, about 0.06% to about 0.07%, about 0.02% to about 0.04%, about 0.04% to about 0.06%, about 0.03% to about 0.05%, or about 0.05% to about 0.07% by mass) of the one or more additional VOCs can be valeric acid. In some embodiments, the one or more additional VOCs can include no valeric acid.

The one or more additional VOCs in a Scotch-like alcoholic beverage can include hexanoic acid. In some embodiments, the hexanoic acid can be present in an amount of about 0.14 to about 20 mg/L (e.g., about 0.14 to about 0.20 mg/L, about 0.15 to about 0.20 mg/L about 0.20 to about 0.25 mg/L, about 0.15 to about 0.25 mg/L, about 0.20 to about 0.26 mg/L, about 0.15 to about 0.26 mg/L, about 0.14 to about 0.5 mg/L, about 0.2 to about 0.5 mg/L, about 0.5 to about 1 mg/L, about 1 to about 2 mg/L, about 1 to about 5 mg/, about 1 to about 10 mg/L, about 5 to about 10 mg/L, or about 10 to about 20 mg/L). In some embodiments, the hexanoic acid can be present in an amount of less than about 3.6 mg/L (e.g., less than about 3.5 mg/L, 3.4 mg/L, 3.3 mg/L, 3.2 mg/L, 3.1 mg/L, 3.0 mg/L, 2.5 mg/L, 2.0 mg/L, 1.5 mg/L, 1.0 mg/L, 0.8 mg/L, 0.6 mg/L, 0.5 mg/L, or 0.4 mg/L). In some embodiments, about 0.08% to about 3% by mass (e.g., about 0.08% to about 0.10%, about 0.10% to about 0.15%, about 0.15% to about 0.20%, about 0.20% to about 0.25%, about 0.10% to about 0.20%, about 0.15% to about 0.25%, about 0.1% to about 0.5%, about 0.5% to about 1%, about 1% to about 3%, about 1% to about 2%, or about 2% to about 3% by mass) of the one or more additional VOCs can be hexanoic acid. In some embodiments, the one or more additional VOCs can include no hexanoic acid.

The one or more additional VOCs in a Scotch-like alcoholic beverage can include nonanoic acid. In some embodiments, the nonanoic acid can be present in an amount of about 0.07 to about 0.18 mg/L (e.g., about 0.07 to about 0.10 mg/L, about 0.10 to about 0.12 mg/L, about 0.12 to about 0.14 mg/L, about 0.14 to about 0.16 mg/L, about 0.16 to about 0.18 mg/L, or about 0.10 to about 0.15 mg/L). In some embodiments, about 0.03% to about 0.16% by mass (e.g., about 0.03% to about 0.05%, about 0.05% to about 0.08% by mass, about 0.08% to about 0.11%, about 0.11% to about 0.14%, about 0.14% to about 0.16%, about 0.05% to about 0.10%, about 0.10% to about 0.15%, about 0.10 to about 0.18%, or about 0.15% to about 0.18% by mass) of the one or more additional VOCs can be nonanoic acid.

The one or more additional VOCs in a Scotch replica can include 2-ethyl-3-methylpyrazine. In some embodiments, the 2-ethyl-3-methylpyrazine can be present in an amount of about 0.0002 mg/L to about 0.02 mg/L (e.g., about 0.0002 to about 0.0005 mg/L, about 0.0005 to about 0.001 mg/L, about 0.001 to about 0.005 mg/L, about 0.005 to about 0.01 mg/L, or about 0.01 to about 0.02 mg/L). In some embodiments, about 0.000004% to about 0.003% by mass (e.g., about 0.000004% to about 0.00001%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.003%, about 0.001% to about 0.002%, or about 0.002% to about 0.003% by mass) of the one or more additional VOCs can be 2-ethyl-3-methylpyrazine. In some embodiments, the one or more additional VOCs can include no 2-ethyl-3-methylpyrazine.

The one or more additional VOCs in a Scotch replica can include 2-heptanol. In some embodiments, the 2-heptanol can be present in an amount of about 0.01 mg/L to about 0.5 mg/L (e.g., about 0.01 to about 0.05 mg/L, about 0.05 to about 0.1 mg/L, or about 0.1 to about 0.5 mg/L). In some embodiments, about 0.0002% to about 0.06% by mass (e.g., about 0.0002% to about 0.0005%, about 0.0005% to about 0.001%, about 0.001% to about 0.005%, about 0.005% to about 0.01%, about 0.01% to about 0.05%, about 0.01% to about 0.06%, about 0.01% to about 0.03%, about 0.03% to about 0.05%, about 0.02% to about 0.04%, or about 0.04% to about 0.06% by mass) of the one or more additional VOCs can be 2-heptanol. In some embodiments, the one or more additional VOCs can include no 2-heptanol.

The one or more additional VOCs in a Scotch replica can include 2-methoxy-4-methylphenol (creosol). In some embodiments, the 2-methoxy-4-methylphenol (creosol) can be present in an amount of about 0.00004 mg/L to about 0.07 mg/L (e.g., about 0.00004 to about 0.0001 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.01 to about 0.07 mg/L, or about 0.05 to about 0.07 mg/L). In some embodiments, about 0.0000006% to about 0.01% by mass (e.g., about 0.0000006% to about 0.000001%, about 0.000001% to about 0.00001%, about 0.00001% to about 0.0001%, about 0.0001% to about 0.001%, about 0.001% to about 0.005%, or about 0.005% to about 0.01% by mass) of the one or more additional VOCs can be 2-methoxy-4-methylphenol (creosol). In some embodiments, the one or more additional VOCs can include no 2-methoxy-4-methylphenol (creosol).

The one or more additional VOCs in a Scotch replica can include 2-pentyl furan. In some embodiments, the 2-pentyl furan can be present in an amount of about 0.009 mg/L to about 0.08 mg/L (e.g., about 0.009 to about 0.05 mg/L, about 0.01 to about 0.05 mg/L, about 0.01 to about 0.08 mg/L, or about 0.05 to about 0.08 mg/L). In some embodiments, about 0.0001% to about 0.01% by mass (e.g., about 0.0001% to about 0.0005%, about 0.0005% to about 0.001%, about 0.001% to about 0.005%, or about 0.005% to about 0.01% by mass) of the one or more additional VOCs can be 2-pentyl furan. In some embodiments, the one or more additional VOCs can include no 2-pentyl furan.

The one or more additional VOCs in a Scotch replica can include carvacrol. In some embodiments, the carvacrol can be present in an amount of about 0.0001 mg/L to about 0.006 mg/L (e.g., about 0.0001 to about 0.0005 mg/L, about 0.0005 to about 0.001 mg/L, about 0.001 to about 0.005 mg/L, or about 0.001 to about 0.006 mg/L). In some embodiments, about 0.000002% to about 0.0009% by mass (e.g., about 0.000002% to about 0.000005%, about 0.000005% to about 0.00001%, about 0.00001% to about 0.00005%, about 0.00005% to about 0.0001%, about 0.0001% to about 0.0005%, or about 0.0005% to about 0.0009% by mass) of the one or more additional VOCs can be carvacrol. In some embodiments, the one or more additional VOCs can include no carvacrol.

The one or more additional VOCs in a Scotch replica can include cis-5-octen-1-ol. In some embodiments, the cis-5-octen-1-ol can be present in an amount of about 1 mg/L to about 2 mg/L (e.g., about 1.0 to about 1.5 mg/L or about 1.5 to about 2.0 mg/L). In some embodiments, about 0.015% to about 0.3% by mass (e.g., about 0.015% to about 0.05%, about 0.05% to about 0.1%, about 0.1% to about 0.3%, about 0.1% to about 0.2%, or about 0.2% to about 0.3% by mass) of the one or more additional VOCs can be cis-5-octen-1-ol. In some embodiments, the one or more additional VOCs can include no cis-5-octen-1-ol.

The one or more additional VOCs in a Scotch replica can include citral. In some embodiments, the citral can be present in an amount of about 0.01 mg/L to about 0.08 mg/L (e.g., about 0.01 to about 0.05 mg/L, about 0.05 to about 0.08 mg/L, about 0.01 to about 0.03 mg/L, about 0.03 to about 0.05 mg/L, about 0.05 to about 0.07 mg/L, about 0.02 to about 0.04 mg/L, about 0.04 to about 0.06 mg/L, or about 0.06 to about 0.08 mg/L). In some embodiments, about 0.0002% to about 0.01% by mass (e.g., about 0.0002% to about 0.0005%, about 0.0005% to about 0.001%, about 0.001% to about 0.005%, or about 0.005% to about 0.01% by mass) of the one or more additional VOCs can be citral. In some embodiments, the one or more additional VOCs can include no citral.

The one or more additional VOCs in a Scotch replica can include cuminaldehyde. In some embodiments, the cuminaldehyde can be present in an amount of about 0.0004 mg/L to about 0.002 mg/L (e.g., about 0.0004 to about 0.001 mg/L, about 0.0005 to about 0.001 mg/L, or about 0.001 to about 0.002 mg/L). In some embodiments, about 0.000006% to about 0.0003% by mass (e.g., about 0.000006% to about 0.00001%, about 0.00001% to about 0.00005%, about 0.00005% to about 0.0001%, about 0.0001% to about 0.0003%, about 0.0001% to about 0.0002%, or about 0.0002% to about 0.003% by mass) of the one or more additional VOCs can be cuminaldehyde. In some embodiments, the one or more additional VOCs can include no cuminaldehyde.

The one or more additional VOCs in a Scotch replica can include D-camphor. In some embodiments, the D-camphor can be present in an amount of about 0.0001 mg/L to about 0.002 mg/L (e.g., about 0.0001 to about 0.0005 mg/L, about 0.0005 to about 0.001 mg/L, or about 0.001 to about 0.002 mg/L). In some embodiments, about 0.000002% to about 0.0003% by mass (e.g., about 0.000002% to about 0.000005%, about 0.000005% to about 0.00001%, about 0.00001% to about 0.00005%, about 0.00005% to about 0.0001%, about 0.0001% to about 0.0003%, about 0.0001% to about 0.0002%, or about 0.0002% to about 0.0003% by mass) of the one or more additional VOCs can be D-camphor. In some embodiments, the one or more additional VOCs can include no D-camphor.

The one or more additional VOCs in a Scotch replica can include decanal. In some embodiments, the decanal can be present in an amount of about 0.002 mg/L to about 0.025 mg/L (e.g., about 0.002 to about 0.005 mg/L, about 0.005 to about 0.01 mg/L, about 0.01 to about 0.02 mg/L, or about 0.010 to about 0.25 mg/L). In some embodiments, about 0.00003% to about 0.003% by mass (e.g., about 0.00003% to about 0.00005%, about 0.00005% to about 0.0001%, about 0.0001% to about 0.0005%, about 0.0005% to about 0.001%, about 0.001% to about 0.003%, about 0.001% to about 0.002%, or about 0.002% to about 0.003% by mass) of the one or more additional VOCs can be decanal. In some embodiments, the one or more additional VOCs can include no decanal.

The one or more additional VOCs in a Scotch replica can include gamma-dodecalactone. In some embodiments, the gamma-dodecalactone can be present in an amount of about 0.7 mg/L to about 9 mg/L (e.g., about 0.7 to about 1 mg/L, about 1 to about 5 mg/L, about 5 to about 9 mg/L, about 1 to about 3 mg/L, about 3 to about 5 mg/L, about 5 to about 7 mg/L, or about 7 to about 9 mg/L). In some embodiments, about 0.01% to about 1.3% by mass (e.g., about 0.01% to about 0.05%, about 0.05% to about 0.1%, about 0.1% to about 0.5%, about 0.5% to about 1.0%, about 1.0% to about 1.3%, or about 0.5% to about 1.3% by mass) of the one or more additional VOCs can be gamma-dodecalactone. In some embodiments, the one or more additional VOCs can include no gamma-dodecalactone.

The one or more additional VOCs in a Scotch replica can include gamma-heptalactone. In some embodiments, the gamma-heptalactone can be present in an amount of about 0.0008 mg/L to about 0.01 mg/L (e.g., about 0.0008 to about 0.001 mg/L, about 0.001 to about 0.005 mg/L, or about 0.005 to about 0.01 mg/L). In some embodiments, about 0.00001% to about 0.002% by mass (e.g., about 0.00001% to about 0.00005%, about 0.00005% to about 0.0001%, about 0.0001% to about 0.0005%, about 0.0005% to about 0.001%, or about 0.001% to about 0.002% by mass) of the one or more additional VOCs can be gamma-heptalactone. In some embodiments, the one or more additional VOCs can include no gamma-heptalactone.

The one or more additional VOCs in a Scotch replica can include gamma-octalactone. In some embodiments, the gamma-octalactone can be present in an amount of about 0.002 mg/L to about 0.08 mg/L (e.g., about 0.002 to about 0.005 mg/L, about 0.005 to about 0.01 mg/L, about 0.01 to about 0.05 mg/L, about 0.01 to about 0.08 mg/L, or about 0.05 to about 0.08 mg/L). In some embodiments, about 0.00003% to about 0.01% by mass (e.g., about 0.00003% to about 0.00005%, about 0.00005% to about 0.0001%, about 0.0001% to about 0.0005%, about 0.0005% to about 0.001%, about 0.001% to about 0.005%, or about 0.005% to about 0.01% by mass) of the one or more additional VOCs can be gamma-octalactone. In some embodiments, the one or more additional VOCs can include no gamma-octalactone.

The one or more additional VOCs in a Scotch replica can include gamma-undecalactone. In some embodiments, the gamma-undecalactone can be present in an amount of about 0.06 mg/L to about 0.1 mg/L (e.g., about 0.06 to about 0.08 mg/L, or about 0.08 to about 0.1 mg/L). In some embodiments, about 0.001% to about 0.02% by mass (e.g., about 0.001% to about 0.005%, about 0.005% to about 0.01%, or about 0.01% to about 0.02% by mass) of the one or more additional VOCs can be gamma-undecalactone. In some embodiments, the one or more additional VOCs can include no gamma-undecalactone.

The one or more additional VOCs in a Scotch replica can include hexyl acetate. In some embodiments, the hexyl acetate can be present in an amount of about 0.003 mg/L to about 0.15 mg/L (e.g., about 0.003 to about 0.005 mg/L, about 0.005 to about 0.01 mg/L, about 0.01 to about 0.05 mg/L, about 0.05 to about 0.1 mg/L, about 0.10 to about 0.15 mg/L, or about 0.05 to about 0.15 mg/L). In some embodiments, about 0.00005% to about 0.02% by mass (e.g., about 0.00005% to about 0.0001%, about 0.0001% to about 0.0005%, about 0.0005% to about 0.001%, about 0.001% to about 0.005%, about 0.005% to about 0.01%, or about 0.01% to about 0.02% by mass) of the one or more additional VOCs can be hexyl acetate. In some embodiments, the one or more additional VOCs can include no hexyl acetate.

The one or more additional VOCs in a Scotch replica can include indole. In some embodiments, the indole can be present in an amount of about 0.00005 mg/L to about 0.0002 mg/L (e.g., about 0.00005 to about 0.0001 mg/L or about 0.0001 to about 0.0002). In some embodiments, about 0.0000008% to about 0.00003% by mass (e.g., about 0.0000008% to about 0.000001%, about 0.000001% to about 0.000005%, about 0.000005% to about 0.00001%, about 0.00001% to about 0.00003%, about 0.00001% to about 0.00002%, or about 0.00002% to about 0.00003% by mass) of the one or more additional VOCs can be indole. In some embodiments, the one or more additional VOCs can include no indole.

The one or more additional VOCs in a Scotch replica can include methyl-2-pyrrolyl ketone. In some embodiments, the methyl-2-pyrrolyl ketone can be present in an amount of about 0.006 mg/L to about 0.05 mg/L (e.g., about 0.006 to about 0.01 mg/L or about 0.01 to about 0.05 mg/L). In some embodiments, about 0.0001% to about 0.006% by mass (e.g., about 0.0001% to about 0.0005%, about 0.0005% to about 0.001%, about 0.001% to about 0.005%, or about 0.001% to about 0.006% by mass) of the one or more additional VOCs can be methyl-2-pyrrolyl ketone. In some embodiments, the one or more additional VOCs can include no methyl-2-pyrrolyl ketone.

The one or more additional VOCs in a Scotch replica can include methyl cinnamate. In some embodiments, the methyl cinnamate can be present in an amount of about 0.00003 mg/L to about 0.0005 mg/L (e.g., about 0.00003 to about 0.00005 mg/L, about 0.00005 to about 0.0001 mg/L, or about 0.0001 to about 0.0005 mg/L). In some embodiments, about 0.0000006% to about 0.00008% by mass (e.g., about 0.0000006% to about 0.000001%, about 0.000001% to about 0.000005%, about 0.000005% to about 0.00001%, about 0.00001% to about 0.00008%, about 0.00001% to about 0.00005%, or about 0.00005% to about 0.00008% by mass) of the one or more additional VOCs can be methyl cinnamate. In some embodiments, the one or more additional VOCs can include no methyl cinnamate.

The one or more additional VOCs in a Scotch replica can include methyl beta-naphthyl ketone. In some embodiments, the methyl beta-naphthyl ketone can be present in an amount of about 0.0015 mg/L to about 0.012 mg/L (e.g., about 0.0015 to about 0.005 mg/L, about 0.005 to about 0.01 mg/L, or about 0.005 to about 0.012 mg/L). In some embodiments, about 0.00002% to about 0.002% by mass (e.g., about 0.00002% to about 0.00005%, about 0.00005% to about 0.0001%, about 0.0001% to about 0.0005%, about 0.0005% to about 0.001%, or about 0.001% to about 0.002% by mass) of the one or more additional VOCs can be methyl beta-naphthyl ketone. In some embodiments, the one or more additional VOCs can include no methyl beta-naphthyl ketone.

The one or more additional VOCs in a Scotch replica can include nerolidol. In some embodiments, the nerolidol can be present in an amount of about 0.0008 mg/L to about 0.02 mg/L (e.g., about 0.0008 to about 0.001 mg/L, about 0.001 to about 0.005 mg/L, about 0.005 to about 0.01 mg/L, or about 0.01 to about 0.02 mg/L). In some embodiments, about 0.00001% to about 0.0025% by mass (e.g., about 0.00001% to about 0.00005%, about 0.00005% to about 0.0001%, about 0.0001% to about 0.0005%, about 0.0005% to about 0.001%, about 0.001% to about 0.002%, or about 0.0010% to about 0.0025% by mass) of the one or more additional VOCs can be nerolidol. In some embodiments, the one or more additional VOCs can include no nerolidol.

The one or more additional VOCs in a Scotch replica can include phenylacetaldehyde. In some embodiments, the phenylacetaldehyde can be present in an amount of about 0.001 mg/L to about 0.2 mg/L (e.g., about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, about 0.00001% to about 0.03% by mass (e.g., about 0.00001% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.03%, about 0.01% to about 0.02%, or about 0.02% to about 0.03% by mass) of the one or more additional VOCs can be phenylacetaldehyde. In some embodiments, the one or more additional VOCs can include no phenylacetaldehyde.

The one or more additional VOCs in a Scotch replica can include thymol. In some embodiments, the thymol can be present in an amount of about 0.00009 mg/L to about 0.005 mg/L (e.g., about 0.00009 to about 0.0005 mg/L, about 0.0001 to about 0.0005 mg/L, about 0.0005 to about 0.001 mg/L, or about 0.001 to about 0.005 mg/L). In some embodiments, about 0.000001% to about 0.0007% by mass (e.g., about 0.000001% to about 0.000005%, about 0.000005% to about 0.00001% to about 0.00005%, about 0.00005% to about 0.0001%, about 0.0001% to about 0.0007%, about 0.0001% to about 0.0005%, or about 0.0005% to about 0.0007% by mass) of the one or more additional VOCs can be thymol. In some embodiments, the one or more additional VOCs can include no thymol.

The one or more additional VOCs in a Scotch replica can include p,a-dimethylstyrene. In some embodiments, the p,a-dimethylstyrene can be present in an amount of about 0.0001 mg/L to about 0.001 mg/L (e.g., about 0.0001 to about 0.0005 mg/L or about 0.0005 to about 0.001 mg/L). In some embodiments, about 0.000001% to about 0.00015% by mass (e.g., about 0.000001% to about 0.000005%, about 0.000005% to about 0.00001%, about 0.00001% to about 0.00005%, about 0.00005% to about 0.0001%, about 0.00005% to about 0.00015%, or about 0.00010% to about 0.00015% by mass) of the one or more additional VOCs can be p,a-dimethylstyrene. In some embodiments, the one or more additional VOCs can include no p,a-dimethylstyrene.

The one or more additional VOCs in a Scotch replica can include phenethyl tiglate. In some embodiments, the phenethyl tiglate can be present in an amount of about 0.001 mg/L to about 0.006 mg/L (e.g., about 0.001 to about 0.005 mg/L, about 0.001 to about 0.003 mg/L, about 0.003 to about 0.005 mg/L, about 0.002 to about 0.004 mg/L, or about 0.004 to about 0.006 mg/L). In some embodiments, about 0.00001% to about 0.0009% by mass (e.g., about 0.00001% to about 0.00005%, about 0.00005% to about 0.0001%, about 0.0001% to about 0.0005%, or about 0.0005% to about 0.0009% by mass) of the one or more additional VOCs can be phenethyl tiglate. In some embodiments, the one or more additional VOCs can include no phenethyl tiglate.

The one or more additional VOCs in a Scotch replica can include massoia lactone. In some embodiments, the massoia lactone can be present in an amount of about 0.000004 mg/L to about 0.004 mg/L (e.g., about 0.000004 to about 0.00001 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.004 mg/L, about 0.001 to about 0.002 mg/L, or about 0.002 to about 0.004 mg/L). In some embodiments, about 0.00000006% to about 0.0005% by mass (e.g., about 0.00000006% to about 0.0000001%, about 0.0000001% to about 0.000001%, about 0.000001% to about 0.00001%, about 0.00001% to about 0.00005%, about 0.00005% to about 0.0001%, or about 0.0001% to about 0.0005% by mass) of the one or more additional VOCs can be massoia lactone. In some embodiments, the one or more additional VOCs can include no massoia lactone.

The one or more additional VOCs in a Scotch replica can include 5-methyl-2-phenyl-2-hexenal. In some embodiments, the 5-methyl-2-phenyl-2-hexenal can be present in an amount of about 0.0001 mg/L to about 0.008 mg/L (e.g., about 0.0001 to about 0.0005 mg/L, about 0.0005 to about 0.001 mg/L, about 0.001 to about 0.005 mg/L, or about 0.005 to about 0.008 mg/L). In some embodiments, about 0.000002% to about 0.0001% by mass (e.g., about 0.000002% to about 0.000005%, about 0.000005% to about 0.00001%, about 0.00001% to about 0.00005%, or about 0.00005% to about 0.0001% by mass) of the one or more additional VOCs can be 5-methyl-2-phenyl-2-hexenal. In some embodiments, the one or more additional VOCs can include no 5-methyl-2-phenyl-2-hexenal.

The one or more additional VOCs in a Scotch replica can include octanal. In some embodiments, the octanal can be present in an amount of about 0.001 mg/L to about 0.015 mg/L (e.g., about 0.001 to about 0.005 mg/L, about 0.005 to about 0.015 mg/L, about 0.005 to about 0.01 mg/L, or about 0.010 to about 0.015 mg/L). In some embodiments, about 0.00002% to about 0.002% by mass (e.g., about 0.00002% to about 0.00005%, about 0.00005% to about 0.0001%, about 0.0001% to about 0.0005%, about 0.0005% to about 0.001%, or about 0.001% to about 0.002% by mass) of the one or more additional VOCs can be octanal. In some embodiments, the one or more additional VOCs can include no octanal.

The one or more additional VOCs in a Scotch replica can include 2,4,6-trimethylphenol (mesitol). In some embodiments, the 2,4,6-trimethylphenol (mesitol) can be present in an amount of about 0.003 mg/L to about 0.1 mg/L (e.g., about 0.003 to about 0.005 mg/L, about 0.005 to about 0.01 mg/L, about 0.01 to about 0.05 mg/L, or about 0.05 to about 0.1 mg/L). In some embodiments, about 0.00005% to about 0.015% by mass (e.g., about 0.00005% to about 0.0001%, about 0.0001% to about 0.0005%, about 0.0005% to about 0.001%, about 0.001% to about 0.005%, about 0.005% to about 0.01%, about 0.005% to about 0.015%, or about 0.010% to about 0.015% by mass) of the one or more additional VOCs can be 2,4,6-trimethylphenol (mesitol). In some embodiments, the one or more additional VOCs can include no 2,4,6-trimethylphenol (mesitol).

The one or more additional VOCs in a Scotch replica can include omega-pentadecalactone. In some embodiments, the omega-pentadecalactone can be present in an amount of about 1 mg/L to about 2 mg/L (e.g., about 1.0 to about 1.5 mg/L or about 1.5 to about 2.0 mg/L). In some embodiments, about 0.015% to about 0.03% by mass (e.g., about 0.015% to about 0.02% or about 0.02% to about 0.03% by mass) of the one or more additional VOCs can be omega-pentadecalactone. In some embodiments, the one or more additional VOCs can include no omega-pentadecalactone.

The one or more additional VOCs in a Scotch replica can include isoamyl cinnamate. In some embodiments, the isoamyl cinnamate can be present in an amount of about 0.0007 mg/L to about 0.003 mg/L (e.g., about 0.0007 to about 0.001 mg/L, about 0.001 to about 0.002 mg/L, or about 0.002 to about 0.003 mg/L). In some embodiments, about 0.00001% to about 0.0004% by mass (e.g., about 0.00001% to about 0.00005%, about 0.00005% to about 0.0001%, about 0.0001% to about 0.0004%, about 0.0001% to about 0.0002%, or about 0.0002% to about 0.0004% by mass) of the one or more additional VOCs can be isoamyl cinnamate. In some embodiments, the one or more additional VOCs can include no isoamyl cinnamate.

The one or more additional VOCs in a Scotch replica can include benzyl benzoate. In some embodiments, the benzyl benzoate can be present in an amount of about 0.0002 mg/L to about 0.0025 mg/L (e.g., about 0.0002 to about 0.0005 mg/L, about 0.0005 to about 0.001 mg/L, about 0.001 to about 0.002 mg/L, or about 0.0010 to about 0.0025 mg/L). In some embodiments, about 0.000005% to about 0.0004% by mass (e.g., about 0.000005% to about 0.00001%, about 0.00001% to about 0.00005%, about 0.00005% to about 0.0001%, about 0.0001% to about 0.0004%, about 0.0001% to about 0.0002%, or about 0.0002% to about 0.0004% by mass) of the one or more additional VOCs can be benzyl benzoate. In some embodiments, the one or more additional VOCs can include no benzyl benzoate.

The one or more additional VOCs in a Scotch replica can include 1-para-menthene-8-thiol. In some embodiments, the 1-para-menthene-8-thiol can be present in an amount of about 0.000002 mg/L to about 0.00004 mg/L (e.g., about 0.000002 to about 0.000005 mg/L, about 0.000005 to about 0.00001 mg/L, about 0.00001 to about 0.00004 mg/L, about 0.00001 to about 0.00002 mg/L, or about 0.00002 to about 0.00004 mg/L). In some embodiments, about 0.00000003% to about 0.000005% by mass (e.g., about 0.00000003% to about 0.0000001%, about 0.0000001% to about 0.0000005%, about 0.0000005% to about 0.000001%, or about 0.000001% to about 0.000005% by mass) of the one or more additional VOCs can be 1-para-menthene-8-thiol. In some embodiments, the one or more additional VOCs can include no 1-para-menthene-8-thiol.

The one or more additional VOCs in a Scotch replica can include isoeugenol. In some embodiments, the isoeugenol can be present in an amount of about 0.007 mg/L to about 0.04 mg/L (e.g., about 0.007 to about 0.01 mg/L, about 0.01 to about 0.04 mg/L, about 0.01 to about 0.02 mg/L, or about 0.02 to about 0.04 mg/L). In some embodiments, about 0.0001% to about 0.006% by mass (e.g., about 0.0001% to about 0.0005%, about 0.0005% to about 0.001%, about 0.001% to about 0.005%, or about 0.001% to about 0.006% by mass) of the one or more additional VOCs can be isoeugenol. In some embodiments, the one or more additional VOCs can include no isoeugenol.

The one or more additional VOCs in a Scotch replica can include 2-methoxy-3-(1-methylpropyl) pyrazine. In some embodiments, the 2-methoxy-3-(1-methylpropyl) pyrazine can be present in an amount of about 0.0005 mg/L to about 0.001 mg/L (e.g., about 0.0005 to about 0.0007 mg/L or about 0.0007 to about 0.001 mg/L). In some embodiments, about 0.000008% to about 0.00015% by mass (e.g., about 0.000008% to about 0.00001%, about 0.00001% to about 0.00005%, about 0.00005% to about 0.0001%, about 0.00005% to about 0.00015%, or about 0.0010% to about 0.0015% by mass) of the one or more additional VOCs can be 2-methoxy-3-(1-methylpropyl) pyrazine. In some embodiments, the one or more additional VOCs can include no 2-methoxy-3-(1-methylpropyl) pyrazine.

The one or more additional VOCs in a Scotch replica can include phenethyl 2-methylbutyrate. In some embodiments, the phenethyl 2-methylbutyrate can be present in an amount of about 0.0006 mg/L to about 0.001 mg/L (e.g., about 0.0006 to about 0.0008 mg/L or about 0.0008 to about 0.001 mg/L). In some embodiments, about 0.000009% to about 0.00015% by mass (e.g., about 0.000009% to about 0.00005%, about 0.00001% to about 0.00005%, about 0.00005% to about 0.0001%, about 0.00005% to about 0.00015%, or about 0.00010% to about 0.00015% by mass) of the one or more additional VOCs can be phenethyl 2-methylbutyrate. In some embodiments, the one or more additional VOCs can include no phenethyl 2-methylbutyrate.

The one or more additional VOCs in a Scotch replica can include methyl benzoate. In some embodiments, the methyl benzoate can be present in an amount of about 0.0001 mg/L to about 0.02 mg/L (e.g., about 0.0001 to about 0.0005 mg/L, about 0.0005 to about 0.001 mg/L, about 0.001 to about 0.005 mg/L, about 0.005 to about 0.01 mg/L, or about 0.01 to about 0.02 mg/L). In some embodiments, about 0.000002% to about 0.003% by mass (e.g., about 0.000002% to about 0.000005%, about 0.000005% to about 0.00001%, about 0.00001% to about 0.00005%, about 0.00005% to abut 0.0001%, about 0.0001% to about 0.0005%, about 0.0005% to about 0.001%, about 0.001% to about 0.003%, about 0.001% to about 0.002%, or about 0.002% to about 0.003% by mass) of the one or more additional VOCs can be methyl benzoate. In some embodiments, the one or more additional VOCs can include no methyl benzoate.

The one or more additional VOCs in a Scotch replica can include 6-methyl-5-hepten-2-one. In some embodiments, the 6-methyl-5-hepten-2-one can be present in an amount of about 0.003 mg/L to about 0.03 mg/L (e.g., about 0.003 to about 0.005 mg/L, about 0.005 to about 0.01 mg/L, about 0.01 to about 0.03 mg/L, about 0.01 to about 0.02 mg/L, or about 0.02 to about 0.03 mg/L). In some embodiments, about 0.00004% to about 0.005% by mass (e.g., about 0.00004% to about 0.0001%, about 0.00005% to about 0.0001%, about 0.0001% to about 0.0005%, about 0.0005% to about 0.001%, or about 0.001% to about 0.005% by mass) of the one or more additional VOCs can be 6-methyl-5-hepten-2-one. In some embodiments, the one or more additional VOCs can include no 6-methyl-5-hepten-2-one.

The one or more additional VOCs in a Scotch replica can include propyl isovalerate. In some embodiments, the propyl isovalerate can be present in an amount of about 0.0006 mg/L to about 0.003 mg/L (e.g., about 0.0006 to about 0.001 mg/L, about 0.001 to about 0.003 mg/L, about 0.001 to about 0.002 mg/L, or about 0.002 to about 0.003 mg/L). In some embodiments, about 0.00001% to about 0.0004% by mass (e.g., about 0.00001% to about 0.00005%, about 0.00005% to about 0.0001%, about 0.0001% to about 0.0004%, about 0.0001% to about 0.0002%, or about 0.0002% to about 0.0004% by mass) of the one or more additional VOCs can be propyl isovalerate. In some embodiments, the one or more additional VOCs can include no propyl isovalerate.

The one or more additional VOCs in a Scotch replica can include valencene. In some embodiments, the valencene can be present in an amount of about 0.00002 mg/L to about 0.007 mg/L (e.g., about 0.00002 to about 0.00005 mg/L, about 0.00005 to abut 0.0001 mg/L, about 0.0001 to about 0.0005 mg/L, about 0.0005 to about 0.001 mg/L, about 0.001 to about 0.005 mg/L, about 0.001 to about 0.007 mg/L, or about 0.005 to abut 0.007 mg/L). In some embodiments, about 0.0000003% to about 0.001% by mass (e.g., about 0.0000003% to about 0.000001%, about 0.000001% to about 0.00001%, about 0.00001% to about 0.0001%, about 0.0001% to about 0.0005%, or about 0.0005% to about 0.001% by mass) of the one or more additional VOCs can be valencene. In some embodiments, the one or more additional VOCs can include no valencene.

The one or more additional VOCs in a Scotch replica can include isoamyl phenylacetate. In some embodiments, the isoamyl phenylacetate can be present in an amount of about 0.0002 mg/L to about 0.002 mg/L (e.g., about 0.0002 to about 0.0005 mg/L, about 0.0005 to about 0.001 mg/L, or about 0.001 to about 0.002 mg/L). In some embodiments, about 0.000003% to about 0.0003% by mass (e.g., about 0.000003% to about 0.000005%, about 0.000005% to about 0.00001%, about 0.00001% to about 0.00005%, about 0.00005% to about 0.0001%, about 0.0001% to about 0.0003%, about 0.0001% to about 0.0002%, or about 0.0002% to about 0.0003% by mass) of the one or more additional VOCs can be isoamyl phenylacetate. In some embodiments, the one or more additional VOCs can include no isoamyl phenylacetate.

The one or more additional VOCs in a Scotch replica can include benzyl propionate. In some embodiments, the benzyl propionate can be present in an amount of about 0.003 mg/L to about 0.008 mg/L (e.g., about 0.003 to about 0.005 mg/L or about 0.005 to about 0.008 mg/L). In some embodiments, about 0.00004% to about 0.001% by mass (e.g., about 0.00004% to about 0.0001%, about 0.00005% to about 0.0001%, about 0.0001% to about 0.0005%, or about 0.0005% to about 0.001% by mass) of the one or more additional VOCs can be benzyl propionate. In some embodiments, the one or more additional VOCs can include no benzyl propionate.

The one or more additional VOCs in a Scotch replica can include isobutyl propionate. In some embodiments, the isobutyl propionate can be present in an amount of about 0.01 mg/L to about 0.03 mg/L (e.g., about 0.01 to about 0.02 mg/L or about 0.02 to about 0.03 mg/L). In some embodiments, about 0.0001% to about 0.004% by mass (e.g., about 0.0001% to about 0.0005%, about 0.0005% to about 0.001%, about 0.001% to about 0.004%, about 0.001% to about 0.002%, or about 0.002% to about 0.004% by mass) of the one or more additional VOCs can be isobutyl propionate. In some embodiments, the one or more additional VOCs can include no isobutyl propionate.

The one or more additional VOCs in a Scotch replica can include delta-dodecalactone. In some embodiments, the delta-dodecalactone can be present in an amount of about 0.005 mg/L to about 0.07 mg/L (e.g., about 0.005 to about 0.01 mg/L, about 0.01 to about 0.05 mg/L, about 0.01 to about 0.07 mg/L, or about 0.05 to about 0.07 mg/L). In some embodiments, about 0.00007% to about 0.009% by mass (e.g., about 0.00007% to about 0.0001%, about 0.0001% to about 0.0005%, about 0.0005% to about 0.001%, about 0.001% to about 0.005%, or about 0.005% to about 0.009% by mass) of the one or more additional VOCs can be delta-dodecalactone. In some embodiments, the one or more additional VOCs can include no delta-dodecalactone.

Exemplary combinations of VOCs are shown in TABLES VA-VC. Each combination of the eight columns in Tables VA and VB is specifically contemplated. Each combination of the eight columns in VA, VB, and VC is specifically contemplated. In particular, VA1VB1VC1, VA2VB2VC2, VA3VB3VC3, VA4VB4VC4, VA5VB5VC5, VA6VB6VC6, VA7VB7VC7, and VA8VB8VC8 are contemplated.

TABLE VA
Exemplary VOC combinations, part A.

| | A1 | | A2 | | A3 | | A4 | | A5 | | A6 | | A7 | | A8 | |
|---|---|---|---|---|---|---|---|---|---|---|---|---|---|---|---|---|
| | Lower | Upper | Lower | Upper | Lower | Upper | Lower | Upper | Lower | Upper | Lower | Upper | Lower | Upper | Lower | Upper |
| 2-methyl-1-butanol | 2.55E+00 | 5.20E+00 | 2.55E+00 | 4.73E+00 | 2.55E+00 | 4.73E+00 | 2.55E+00 | 4.73E+00 | 2.55E+00 | 4.73E+00 | 2.55E+00 | 4.73E+00 | 2.55E+00 | 4.73E+00 | 2.80E+00 | 5.20E+00 |
| 3-carene | 0.00E+00 | 1.25E−01 | optional | optional | 6.72E−04 | 1.25E−03 | 6.72E−04 | 1.25E−03 | 6.72E−02 | 1.25E−01 | 6.72E−04 | 1.25E−03 | 6.72E−02 | 1.25E−01 | optional | optional |
| acetal (1,1- | 0.00E+00 | 3.93E+00 | 2.12E+00 | 3.93E+00 | optional | optional | optional | optional | 2.12E+00 | 3.93E+00 | 2.10E+00 | 3.90E+00 | 2.12E+00 | 3.93E+00 | optional | optional |
| diethoxyethane) | | | | | | | | | | | | | | | | |
| acetaldehyde | 0.00E+00 | 3.94E−01 | 2.12E−01 | 3.94E−01 | 2.12E−01 | 3.94E−01 | 2.12E−01 | 3.94E−01 | 2.12E−01 | 3.94E−01 | 2.12E−01 | 3.94E−01 | 2.12E−01 | 3.94E−01 | optional | optional |
| amyl alcohol | 0.00E+00 | 3.76E−01 | 1.01E−01 | 1.88E−01 | 2.02E−01 | 3.76E−01 | 2.02E−01 | 3.76E−01 | 1.01E−01 | 1.88E−01 | 1.01E−01 | 1.88E−01 | 1.01E−01 | 1.88E−01 | optional | optional |
| butyl acetate | 1.38E−03 | 1.32E−01 | 3.54E−02 | 6.58E−02 | 7.08E−02 | 1.32E−01 | 7.08E−02 | 1.32E−01 | 3.54E−02 | 6.58E−02 | 3.45E−02 | 6.58E−02 | 3.54E−02 | 6.58E−02 | 1.38E−03 | 2.57E−03 |
| butyl alcohol | 2.12E+00 | 1.06E+01 | 2.86E+00 | 5.32E+00 | 2.86E+00 | 5.32E+00 | 2.86E+00 | 5.32E+00 | 3.89E+00 | 7.23E+00 | 2.86E+00 | 5.32E+00 | 2.86E+00 | 5.32E+00 | 2.12E+00 | 3.94E+00 |
| butyl formate | 0.00E+00 | 4.68E−01 | optional | optional | 1.40E−02 | 2.60E−02 | 1.40E−02 | 2.60E−02 | 2.52E−01 | 4.68E−01 | optional | optional | optional | optional | 1.07E−02 | 2.00E−02 |
| [symbol] | 0.00E+00 | 2.58E+00 | 1.39E+00 | 2.58E+00 | 1.39E+00 | 2.58E+00 | 1.39E+00 | 2.58E+00 | 1.39E+00 | 2.58E+00 | 1.39E+00 | 2.58E+00 | 1.39E+00 | 2.58E+00 | optional | optional |
| [symbol] | 0.00E+00 | 3.06E+00 | optional | optional | optional | optional | optional | optional | 6.99E−01 | 1.30E+00 | 6.99E−01 | 1.30E+00 | 6.99E−01 | 1.30E+00 | optional | optional |
| diethyl succinate | 6.74E−02 | 1.51E−01 | 6.74E−02 | 1.25E−01 | 6.74E−02 | 1.25E−01 | 6.74E−02 | 1.25E−01 | 6.74E−02 | 1.25E−01 | 6.74E−02 | 1.25E−01 | 6.74E−02 | 1.25E−01 | 8.14E−02 | 1.51E−01 |
| ethyl acetate | 5.83E+00 | 2.24E+01 | 5.83E+00 | 1.08E+01 | 1.16E+01 | 2.16E+01 | 1.16E+01 | 2.16E+01 | 5.83E+00 | 1.08E+01 | 5.83E+00 | 1.08E+01 | 5.83E+00 | 1.08E+01 | 1.21E+01 | 2.24E+01 |
| ethyl butyrate | 5.17E−02 | 1.06E−01 | 5.71E−02 | 1.06E−01 | 5.71E−02 | 1.06E−01 | 5.71E−02 | 1.06E−01 | 5.71E−02 | 1.06E−01 | 5.71E−02 | 1.06E−01 | 5.71E−02 | 1.06E−01 | 5.17E−02 | 9.60E−02 |
| ethyl decanoate | 7.27E−01 | 2.55E+00 | 1.37E+00 | 2.55E+00 | 1.37E+00 | 2.55E+00 | 1.37E+00 | 2.55E+00 | 1.37E+00 | 2.55E+00 | 1.37E+00 | 2.55E+00 | 1.37E+00 | 2.55E+00 | 7.27E−01 | 1.35E+00 |
| ethyl hexanoate | 9.29E−02 | 1.04E+00 | 5.62E−01 | 1.04E+00 | 5.62E−01 | 1.04E+00 | 2.81E−01 | 5.22E−01 | 5.62E−01 | 1.04E+00 | 5.62E−01 | 1.04E+00 | 5.62E−01 | 1.04E+00 | 9.29E−02 | 1.73E−01 |
| ethyl isobutyrate | 0.00E+00 | 2.51E−01 | optional | optional | 1.35E−01 | 2.51E−01 | 1.35E−01 | 2.51E−01 | 1.35E−01 | 2.51E−01 | optional | optional | optional | optional | 1.11E−01 | 2.07E−01 |
| ethyl isovalerate | 3.30E−02 | 1.91E+00 | 5.14E−01 | 9.54E−01 | 1.03E+00 | 1.91E+00 | 1.03E+00 | 1.91E+00 | 5.14E−01 | 9.54E−01 | 5.14E−01 | 9.54E−01 | 5.14E−01 | 9.54E−01 | 3.30E−02 | 6.14E−02 |
| ethyl lactate | 6.49E−01 | 2.55E+01 | 1.37E+01 | 2.55E+01 | 6.87E+00 | 1.27E+01 | 6.87E+00 | 1.27E+01 | 1.37E+01 | 2.55E+01 | 1.37E+01 | 2.55E+01 | 1.37E+01 | 2.55E+01 | 6.49E−01 | 1.21E+00 |
| ethyl laurate | 7.07E−01 | 3.90E+00 | 7.07E−01 | 1.31E+00 | 7.07E−01 | 1.31E+00 | 7.07E−01 | 1.31E+00 | 1.41E+00 | 2.63E+00 | 7.07E−01 | 1.31E+00 | 7.07E−01 | 1.31E+00 | 2.10E+00 | 3.90E+00 |
| ethyl levulinate | 0.00E+00 | 1.16E−01 | 6.27E−02 | 1.16E−01 | optional | optional | optional | optional | 6.27E−02 | 1.16E−01 | 6.27E−02 | 1.16E−01 | 6.27E−02 | 1.16E−01 | optional | optional |
| ethyl myristate | 2.41E−02 | 2.49E−01 | 1.34E−01 | 2.49E−01 | 1.34E−01 | 2.49E−01 | 1.34E−01 | 2.49E−01 | 1.34E−01 | 2.49E−01 | 1.34E−01 | 2.49E−01 | 1.34E−01 | 2.49E−01 | 2.41E−02 | 4.47E−02 |
| ethyl octanoate | 3.46E−01 | 2.71E+00 | 3.46E−01 | 6.42E−01 | 6.91E−01 | 1.28E+00 | 6.91E−01 | 1.28E+00 | 3.46E−01 | 6.42E−01 | 3.46E−01 | 6.42E−01 | 3.46E−01 | 6.42E−01 | 1.46E+00 | 2.71E+00 |
| ethyl propionate | 5.52E−02 | 3.46E−01 | 5.52E−02 | 1.02E−01 | 1.10E−01 | 2.05E−01 | 1.10E−01 | 2.05E−01 | 5.52E−02 | 1.02E−01 | 5.52E−02 | 1.02E−01 | 5.52E−02 | 1.02E−01 | 1.86E−01 | 3.46E−01 |
| ethyl undecanoate | 0.00E+00 | 1.93E−01 | 1.04E−01 | 1.93E−01 | optional | optional | optional | optional | 1.04E−01 | 1.93E−01 | 2.08E−03 | 3.86E−03 | 1.04E−01 | 1.93E−01 | optional | optional |
| furfural | 1.34E+00 | 4.99E+00 | 1.34E+00 | 2.50E+00 | 2.69E+00 | 4.99E+00 | 2.69E+00 | 4.99E+00 | 1.34E+00 | 2.50E+00 | 1.34E+00 | 2.50E+00 | 1.34E+00 | 2.50E+00 | 2.44E+00 | 4.52E+00 |
| isoamyl acetate | 0.00E+00 | 5.13E−01 | optional | optional | optional | optional | 2.76E−01 | 5.13E−01 | optional | optional | optional | optional | optional | optional | optional | optional |
| isoamyl alcohol | 6.83E−01 | 2.74E+00 | 6.83E−01 | 1.27E+00 | 6.83E−01 | 1.27E+00 | 1.32E+00 | 2.45E+00 | 6.83E−01 | 1.27E+00 | 6.83E−01 | 1.27E+00 | 6.83E−01 | 1.27E+00 | 1.47E+00 | 2.74E+00 |
| isobutyl acetate | 1.16E−02 | 6.41E−01 | 3.45E−02 | 6.41E−02 | 3.45E−01 | 6.41E−01 | 3.45E−01 | 6.41E−01 | 6.90E−02 | 1.28E−01 | 3.45E−01 | 6.41E−01 | 3.45E−01 | 6.41E−01 | 1.16E−02 | 2.16E−02 |
| isobutyl alcohol | 1.01E+01 | 2.60E+01 | 1.38E+01 | 2.57E+01 | 1.40E+01 | 2.60E+01 | 1.01E+01 | 1.88E+01 | 1.38E+01 | 2.57E+01 | 1.38E+01 | 2.57E+01 | 1.38E+01 | 2.57E+01 | 1.40E+01 | 2.60E+01 |
| isobutyraldehyde | 0.00E+00 | 1.22E+01 | 1.37E+00 | 2.54E+00 | optional | optional | optional | optional | 1.37E−01 | 2.54E−01 | 2.91E+00 | 5.41E+00 | 2.91E+00 | 5.41E+00 | optional | optional |
| linalyl acetate | 0.00E+00 | 5.16E−01 | 2.78E−01 | 5.16E−01 | 1.39E−02 | 2.58E−02 | 1.39E−02 | 2.58E−02 | 2.78E−01 | 5.16E−01 | 2.78E−02 | 5.16E−02 | 2.78E−01 | 5.16E−01 | optional | optional |
| phenethyl acetate | 5.79E−02 | 2.15E−01 | 5.79E−02 | 1.08E−01 | 5.79E−02 | 1.08E−01 | 1.16E−01 | 2.15E−01 | 5.79E−02 | 1.08E−01 | 5.79E−02 | 1.08E−01 | 5.79E−02 | 1.08E−01 | 7.22E−02 | 1.34E−01 |
| phenethyl alcohol | 6.92E−01 | 7.78E+00 | 2.09E+00 | 3.89E+00 | 4.19E+00 | 7.78E+00 | 4.19E+00 | 7.78E+00 | 2.79E+00 | 5.19E+00 | 2.09E+00 | 3.89E+00 | 2.09E+00 | 3.89E+00 | 6.92E−01 | 1.28E+00 |
| propyl alcohol | 0.00E+00 | 1.06E+01 | optional | optional | 4.23E+00 | 7.85E+00 | 4.23E+00 | 7.85E+00 | 3.73E+00 | 6.93E+00 | optional | optional | optional | optional | 5.71E+00 | 1.06E+01 |
| whiskey lactone | 5.00E−02 | 2.55E−01 | 9.56E−02 | 1.78E−01 | 5.00E−02 | 9.29E−02 | 5.00E−02 | 9.29E−02 | 9.56E−02 | 1.78E−01 | 9.56E−02 | 1.78E−01 | 9.56E−02 | 1.78E−01 | 1.37E−01 | 2.55E−01 |

[symbol]

indicates data missing or illegible when filed

TABLE VB
Exemplary VOC combinations, part B.

| | B1 | | B2 | | B3 | | B4 | | B5 | | B6 | | B7 | | B8 | |
|---|---|---|---|---|---|---|---|---|---|---|---|---|---|---|---|---|
| | Lower | Upper | Lower | Upper | Lower | Upper | Lower | Upper | Lower | Upper | Lower | Upper | Lower | Upper | Lower | Upper |
| 1-decanol | 1.37E−03 | 2.53E−02 | 6.82E−03 | 1.27E−02 | 6.82E−03 | 1.27E−02 | 6.82E−03 | 1.27E−02 | 1.36E−02 | 2.53E−02 | 6.82E−03 | 1.27E−02 | 6.82E−03 | 1.27E−02 | 1.37E−03 | 2.54E−03 |
| 1-octen-3-ol | 2.31E−03 | 2.56E−02 | 6.90E−03 | 1.28E−02 | 6.90E−03 | 1.28E−02 | 6.90E−03 | 1.28E−02 | 1.38E−02 | 2.56E−02 | 6.90E−03 | 1.28E−02 | 6.90E−03 | 1.28E−02 | 2.31E−03 | 4.29E−03 |
| 2-heptanone | 0.00E+00 | 4.16E−02 | 2.24E−02 | 4.16E−02 | optional | optional | optional | optional | 2.24E−02 | 4.16E−02 | optional | optional | 2.24E−02 | 4.16E−02 | optional | optional |
| 2-methylbutyraldehyde | 0.00E+00 | 4.60E−02 | optional | optional | optional | optional | optional | optional | optional | optional | 2.48E−02 | 4.60E−02 | optional | optional | 2.86E−04 | 5.32E−04 |
| 4-Ethyl Guaiacol | 0.00E+00 | 7.85E−02 | optional | optional | 2.82E−02 | 5.23E−02 | 2.82E−02 | 5.23E−02 | 4.23E−02 | 7.85E−02 | optional | optional | optional | optional | optional | optional |
| acetoin | 0.00E+00 | 4.74E−02 | 2.55E−02 | 4.74E−02 | optional | optional | optional | optional | 2.55E−02 | 4.74E−02 | 2.55E−02 | 4.74E−02 | 2.55E−02 | 4.74E−02 | optional | optional |
| a-terpineol | 9.05E−04 | 7.72E−02 | 4.16E−02 | 7.72E−02 | 2.08E−02 | 3.86E−02 | 2.08E−02 | 3.86E−02 | 4.16E−02 | 7.72E−02 | 4.16E−02 | 7.72E−02 | 4.16E−02 | 7.72E−02 | 9.05E−04 | 1.68E−03 |
| butyric acid | 0.00E+00 | 5.17E−02 | optional | optional | 2.04E−02 | 3.80E−02 | 2.04E−02 | 3.80E−02 | optional | optional | optional | optional | optional | optional | 2.78E−02 | 5.17E−02 |
| citronellol | 0.00E+00 | 1.26E−02 | optional | optional | optional | optional | 6.80E−05 | 1.26E−04 | 6.80E−03 | 1.26E−02 | optional | optional | optional | optional | optional | optional |
| ethyl 3- | 0.00E+00 | 1.04E−02 | optional | optional | optional | optional | optional | optional | 5.57E−03 | 1.04E−02 | 5.56E−03 | 1.03E−02 | 5.57E−03 | 1.04E−02 | optional | optional |
| hydroxyhexanoate | | | | | | | | | | | | | | | | |
| ethyl benzoate | 0.00E+00 | 1.11E−02 | optional | optional | optional | optional | optional | optional | optional | optional | 6.00E−03 | 1.11E−02 | optional | optional | optional | optional |
| ethyl nonanoate | 0.00E+00 | 1.01E−02 | optional | optional | optional | optional | 6.82E−05 | 1.27E−04 | 5.46E−03 | 1.01E−02 | optional | optional | optional | optional | 1.29E−03 | 2.40E−03 |
| ethyl trans-2- | 0.00E+00 | 2.03E−02 | optional | optional | optional | optional | optional | optional | 1.09E−02 | 2.03E−02 | optional | optional | 1.09E−02 | 2.03E−02 | optional | optional |
| butenoate | | | | | | | | | | | | | | | | |
| Ethyl Valerate | 1.03E−03 | 1.53E−02 | 8.22E−03 | 1.53E−02 | 4.11E−03 | 7.64E−03 | 4.11E−03 | 7.64E−03 | 8.22E−03 | 1.53E−02 | 8.22E−03 | 1.53E−02 | 8.22E−03 | 1.53E−02 | 1.03E−03 | 1.91E−03 |
| ethyl-2- | 0.00E+00 | 7.11E−02 | 3.79E−02 | 7.03E−02 | optional | optional | optional | optional | 3.79E−02 | 7.03E−02 | 3.83E−02 | 7.11E−02 | 3.79E−02 | 7.03E−02 | 3.63E−02 | 6.75E−02 |
| methylbutyrate | | | | | | | | | | | | | | | | |
| farnesol | 0.00E+00 | 2.99E−02 | optional | optional | optional | optional | optional | optional | 7.05E−03 | 1.31E−02 | 1.61E−02 | 2.99E−02 | optional | optional | optional | optional |
| gamma-decalactone | 0.00E+00 | 1.15E−02 | 3.08E−03 | 5.72E−03 | 6.22E−03 | 1.15E−02 | 6.22E−03 | 1.15E−02 | 3.08E−03 | 5.72E−03 | 3.08E−03 | 5.72E−03 | 3.08E−03 | 5.72E−03 | optional | optional |
| gamma-nonalactone | 0.00E+00 | 1.42E−02 | 4.46E−03 | 8.28E−03 | optional | optional | optional | optional | 4.46E−03 | 8.28E−03 | 7.66E−03 | 1.42E−02 | 4.46E−03 | 8.28E−03 | optional | optional |
| geraniol | 0.00E+00 | 9.34E−02 | 5.03E−02 | 9.34E−02 | optional | optional | optional | optional | 6.98E−03 | 1.30E−02 | 2.51E−02 | 4.65E−02 | 5.03E−02 | 9.34E−02 | optional | optional |
| guaiacol | 0.00E+00 | 4.13E−02 | 1.39E−03 | 2.58E−03 | 1.39E−03 | 2.58E−03 | 2.22E−02 | 4.13E−02 | 2.78E−03 | 5.16E−03 | 1.39E−03 | 2.58E−03 | 1.39E−03 | 2.58E−03 | optional | optional |
| [symbol] | 2.10E−02 | 3.89E−02 | optional | optional | optional | optional | optional | optional | optional | optional | optional | optional | optional | optional | 2.10E−02 | 3.89E−02 |
| isoamyl hexanoate | 2.06E−04 | 1.54E−02 | 4.11E−03 | 7.64E−03 | 8.29E−03 | 1.54E−02 | 8.29E−03 | 1.54E−02 | 4.11E−03 | 7.64E−03 | 4.11E−03 | 7.64E−03 | 4.11E−03 | 7.64E−03 | 2.06E−04 | 3.83E−04 |
| limonene | 0.00E+00 | 1.06E−02 | 5.69E−03 | 1.06E−02 | 5.69E−03 | 1.06E−02 | 5.69E−03 | 1.06E−02 | 5.69E−03 | 1.06E−02 | 5.69E−03 | 1.06E−02 | 5.69E−03 | 1.06E−02 | optional | optional |
| linalool oxide | 0.00E+00 | 2.85E−02 | 7.72E−03 | 1.43E−02 | 1.54E−02 | 2.85E−02 | 1.54E−02 | 2.85E−02 | 7.72E−03 | 1.43E−02 | 7.72E−03 | 1.43E−02 | 7.72E−03 | 1.43E−02 | optional | optional |
| methyl hexanoate | 0.00E+00 | 9.34E−02 | optional | optional | optional | optional | optional | optional | optional | optional | optional | optional | optional | optional | 5.03E−02 | 9.34E−02 |
| phenethyl formate | 0.00E+00 | 4.71E−02 | optional | optional | optional | optional | optional | optional | 1.22E−02 | 2.27E−02 | 2.53E−02 | 4.71E−02 | 1.22E−02 | 2.27E−02 | optional | optional |
| propyl acetate | 0.00E+00 | 6.39E−02 | 3.44E−02 | 6.39E−02 | optional | optional | optional | optional | 3.44E−02 | 6.39E−02 | 3.42E−02 | 6.35E−02 | 3.44E−02 | 6.39E−02 | optional | optional |
| Valeraldehyde | 0.00E+00 | 6.17E−02 | optional | optional | optional | optional | optional | optional | 3.32E−02 | 6.17E−02 | optional | optional | optional | optional | optional | optional |
| vanillyl ethyl ether | 0.00E+00 | 3.51E−02 | 1.88E−02 | 3.49E−02 | optional | optional | optional | optional | 1.88E−02 | 3.49E−02 | 1.89E−02 | 3.51E−02 | 1.88E−02 | 3.49E−02 | optional | optional |

[symbol]

indicates data missing or illegible when filed

TABLE VC
Exemplary VOC combinations, part C.

| | C1 | | C2 | | C3 | | C4 | |
|---|---|---|---|---|---|---|---|---|
| | Lower | Upper | Lower | Upper | Lower | Upper | Lower | Upper |
| 2,3-pentadione | 0.00E+00 | 2.57E−03 | 6.93E−04 | 1.29E−03 | 1.39E−03 | 2.57E−03 | 1.39E−03 | 2.57E−03 |
| 2-nonanone | 0.00E+00 | 6.35E−03 | optional | optional | optional | optional | 3.42E−03 | 6.35E−03 |
| 4-carvomenthenol | 0.00E+00 | 1.26E−03 | optional | optional | optional | optional | 6.80E−05 | 1.26E−04 |
| 4-Ethyl Phenol | 0.00E+00 | 7.19E−03 | optional | optional | optional | optional | optional | optional |
| acetophenone | 0.00E+00 | 6.85E−03 | 3.69E−03 | 6.85E−03 | optional | optional | optional | optional |
| benzaldehyde | 1.56E−04 | 1.92E−03 | 1.03E−03 | 1.92E−03 | 1.03E−03 | 1.92E−03 | 1.03E−03 | 1.92E−03 |
| beta pinene | 9.48E−07 | 5.12E−05 | 1.38E−05 | 2.56E−05 | 2.76E−05 | 5.12E−05 | 2.76E−05 | 5.12E−05 |
| beta-ionone | 0.00E+00 | 2.53E−04 | 6.81E−05 | 1.26E−04 | 1.36E−04 | 2.53E−04 | 1.36E−04 | 2.53E−04 |
| Cinnamaldehyde | 0.00E+00 | 2.61E−05 | 1.41E−05 | 2.61E−05 | 1.41E−05 | 2.61E−05 | 1.41E−05 | 2.61E−05 |
| ethyl cinnamate | 7.44E−04 | 6.52E−03 | 3.51E−03 | 6.52E−03 | 3.51E−03 | 6.52E−03 | 3.51E−03 | 6.52E−03 |
| ethyl heptanoate | 0.00E+00 | 6.41E−04 | optional | optional | optional | optional | 3.45E−04 | 6.41E−04 |
| e [symbol] henyl acetate | 1.02E−03 | 6.39E−03 | 1.72E−03 | 3.20E−03 | 3.44E−03 | 6.39E−03 | 3.44E−03 | 6.39E−03 |
| eugenol | 0.00E+00 | 5.21E−03 | 1.40E−03 | 2.61E−03 | 1.40E−03 | 2.61E−03 | 2.81E−03 | 5.21E−03 |
| gamma-terpinene | 0.00E+00 | 1.74E−03 | optional | optional | 9.39E−04 | 1.74E−03 | 9.39E−04 | 1.74E−03 |
| isoamyl octanoate | 2.95E−04 | 9.45E−04 | 2.95E−04 | 5.49E−04 | 2.95E−04 | 5.49E−04 | 2.95E−04 | 5.49E−04 |
| 1-linalool | 0.00E+00 | 1.59E−03 | 8.56E−04 | 1.59E−03 | 4.28E−06 | 7.95E−06 | optional | optional |
| Maltol | 0.00E+00 | 3.90E−04 | 5.17E−05 | 9.60E−05 | 2.10E−04 | 3.90E−04 | 2.10E−04 | 3.90E−04 |
| methional | 0.00E+00 | 2.17E−03 | 1.17E−03 | 2.17E−03 | optional | optional | optional | optional |
| Methyl Octanoate | 0.00E+00 | 1.03E−06 | optional | optional | optional | optional | optional | optional |
| methyl salicylate | 2.05E−05 | 6.57E−04 | 2.05E−05 | 3.81E−05 | 2.05E−05 | 3.81E−05 | 2.05E−05 | 3.81E−05 |
| Myrcene | 3.11E−06 | 1.07E−04 | 3.11E−06 | 5.78E−06 | 6.46E−06 | 1.20E−05 | 6.46E−06 | 1.20E−05 |
| p-cresol | 0.00E+00 | 5.47E−04 | 2.95E−04 | 5.47E−04 | 2.95E−04 | 5.47E−04 | 2.95E−04 | 5.47E−04 |
| p-cymene | 0.00E+00 | 2.45E−05 | optional | optional | optional | optional | optional | optional |
| Phenethyl Butyrate | 0.00E+00 | 8.35E−06 | optional | optional | optional | optional | optional | optional |
| salicylaldehyde | 0.00E+00 | 4.47E−03 | optional | optional | optional | optional | optional | optional |
| trans-2-hexen-1-al | 0.00E+00 | 8.83E−04 | optional | optional | optional | optional | optional | optional |
| | C5 | | C6 | | C7 | | C8 | |
| | Lower | Upper | Lower | Upper | Lower | Upper | Lower | Upper |
| 2,3-pentadione | 6.93E−04 | 1.29E−03 | 6.93E−04 | 1.29E−03 | 6.93E−04 | 1.29E−03 | optional | optional |
| 2-nonanone | 8.55E−04 | 1.59E−03 | optional | optional | 8.55E−04 | 1.59E−03 | 8.49E−04 | 1.58E−03 |
| 4-carvomenthenol | 6.80E−04 | 1.26E−03 | optional | optional | optional | optional | optional | optional |
| 4-Ethyl Phenol | 3.87E−03 | 7.19E−03 | optional | optional | optional | optional | optional | optional |
| acetophenone | 3.69E−03 | 6.85E−03 | optional | optional | 3.69E−03 | 6.85E−03 | optional | optional |
| benzaldehyde | 1.03E−03 | 1.92E−03 | 1.03E−03 | 1.92E−03 | 1.03E−03 | 1.92E−03 | 1.56E−04 | 2.90E−04 |
| beta pinene | 1.38E−05 | 2.56E−05 | 1.38E−05 | 2.56E−05 | 1.38E−05 | 2.56E−05 | 9.48E−07 | 1.76E−06 |
| beta-ionone | 6.81E−05 | 1.26E−04 | 6.81E−05 | 1.26E−04 | 6.81E−05 | 1.26E−04 | optional | optional |
| Cinnamaldehyde | 1.41E−05 | 2.61E−05 | 1.41E−05 | 2.61E−05 | 1.41E−05 | 2.61E−05 | optional | optional |
| ethyl cinnamate | 3.51E−03 | 6.52E−03 | 3.51E−03 | 6.52E−03 | 3.51E−03 | 6.52E−03 | 7.44E−04 | 1.38E−03 |
| ethyl heptanoate | optional | optional | optional | optional | optional | optional | 9.43E−05 | 1.75E−04 |
| [symbol] acetate | 1.72E−03 | 3.20E−03 | 1.72E−03 | 3.20E−03 | 1.72E−03 | 3.20E−03 | 1.02E−03 | 1.90E−03 |
| eugenol | 1.40E−03 | 2.61E−03 | 1.40E−03 | 2.61E−03 | 1.40E−03 | 2.61E−03 | optional | optional |
| gamma-terpinene | 5.62E−05 | 1.04E−04 | optional | optional | optional | optional | optional | optional |
| isoamyl octanoate | 2.95E−04 | 5.49E−04 | 2.95E−04 | 5.49E−04 | 2.95E−04 | 5.49E−04 | 5.09E−04 | 9.45E−04 |
| 1-linalool | 8.56E−04 | 1.59E−03 | 4.28E−06 | 7.95E−06 | 8.56E−04 | 1.59E−03 | optional | optional |
| Maltol | 5.17E−05 | 9.60E−05 | 5.17E−05 | 9.60E−05 | 5.17E−05 | 9.60E−05 | optional | optional |
| methional | 1.17E−03 | 2.17E−03 | optional | optional | 1.17E−03 | 2.17E−03 | optional | optional |
| Methyl Octanoate | optional | optional | optional | optional | optional | optional | 5.53E−07 | 1.03E−06 |
| methyl salicylate | 2.05E−05 | 3.81E−05 | 2.05E−05 | 3.81E−05 | 2.05E−05 | 3.81E−05 | 3.54E−04 | 6.57E−04 |
| Myrcene | 3.11E−06 | 5.78E−06 | 3.11E−06 | 5.78E−06 | 3.11E−06 | 5.78E−06 | 5.76E−05 | 1.07E−04 |
| p-cresol | 2.95E−04 | 5.47E−04 | 2.95E−04 | 5.47E−04 | 2.95E−04 | 5.47E−04 | optional | optional |
| p-cymene | optional | optional | optional | optional | optional | optional | 1.32E−05 | 2.45E−05 |
| Phenethyl Butyrate | optional | optional | optional | optional | optional | optional | 4.49E−06 | 8.35E−06 |
| salicylaldehyde | 1.14E−03 | 2.11E−03 | 2.41E−03 | 4.47E−03 | 1.14E−03 | 2.11E−03 | optional | optional |
| trans-2-hexen-1-al | optional | optional | optional | optional | optional | optional | 4.75E−04 | 8.83E−04 |

[symbol]

indicates data missing or illegible when filed

In some cases, the total amount of additional (non-ethanol) VOCs in a Scotch replica can be less than the total amount of additional VOCs in a reference Scotch. For example, a Scotch-like alcoholic beverage can have a total additional VOC content that is 1250 mg/L or less (e.g., 1200, 1150, 1100, 1050, 1000, 950, 900, 850, 800, 750, 700, 650, 600, 550, 500, 450, 400, 350, 300, 250, 200, 150, or 100 mg/L or less). In some embodiments, a Scotch-like alcoholic beverage can have a total additional VOC content from the additional VOCs in Group P that is 1250 mg/L or less (e.g., 1200, 1150, 1100, 1050, 1000, 950, 900, 850, 800, 750, 700, 650, 600, 550, 500, 450, 400, 350, 300, 250, 200, 150, or 100 mg/L or less). In some embodiments, a Scotch-like alcoholic beverage can have a total additional VOC content from the additional VOCs in Group Q that is 1250 mg/L or less (e.g., 1200, 1150, 1100, 1050, 1000, 950, 900, 850, 800, 750, 700, 650, 600, 550, 500, 450, 400, 350, 300, 250, 200, 150, or 100 mg/L or less). In some embodiments, a Scotch-like alcoholic beverage can have a total additional VOC content from the additional VOCs in Group R that is 1250 mg/L or less (e.g., 1200, 1150, 1100, 1050, 1000, 950, 900, 850, 800, 750, 700, 650, 600, 550, 500, 450, 400, 350, 300, 250, 200, 150, or 100 mg/L or less). In some embodiments, a Scotch-like alcoholic beverage can have a total additional VOC content from the additional VOCs in Group S that is 1250 mg/L or less (e.g., 1200, 1150, 1100, 1050, 1000, 950, 900, 850, 800, 750, 700, 650, 600, 550, 500, 450, 400, 350, 300, 250, 200, 150, or 100 mg/L or less). In some embodiments, a Scotch-like alcoholic beverage can have a total additional VOC content from the additional VOCs in Group T that is 1250 mg/L or less (e.g., 1200, 1150, 1100, 1050, 1000, 950, 900, 850, 800, 750, 700, 650, 600, 550, 500, 450, 400, 350, 300, 250, 200, 150, or 100 mg/L or less).

In some embodiments, a Scotch-like alcoholic beverage can have a total additional VOC content of about 50 to about 1250 mg/L (e.g., about 50 to about 100 mg/L, about 50 to about 200 mg/L, about 50 to about 300 mg/L, about 50 to about 400 mg/L, about 50 to about 500 mg/L, about 50 to about 600 mg/L, about 50 to about 700 mg/L, about 50 to about 800 mg/L, about 50 to about 900 mg/L, about 50 to about 1000 mg/L, about 50 to about 1100 mg/L, about 50 to about 1250, about 100 to about 1250 mg/L, about 200 to about 1250 mg/L, about 300 to about 1250 mg/L, about 400 to about 1250 mg/L, about 500 to about 1250 mg/L, about 600 to about 1250 mg/L, about 700 to about 1250 mg/L, about 800 to about 1250 mg/L, about 900 to about 1250 mg/L, about 1000 to about 1250 mg/L, about 1100 to about 1250 mg/L, about 100 to about 200 mg/L, about 200 to about 300 mg/L, 300 to about 400 mg/L, about 400 to about 500 mg/L, about 500 to about 600 mg/L, about 600 to about 700 mg/L, about 700 to about 800 mg/L, about 800 to about 900 mg/L, about 900 to about 1000 mg/L, about 1000 to about 1100 mg/L, or about 1100 to about 1200 mg/L).

In some embodiments, a Scotch-like alcoholic beverage can have a total additional VOC content from the VOCs that are in Group P of about 50 to about 1250 mg/L (e.g., about 50 to about 100 mg/L, about 50 to about 200 mg/L, about 50 to about 300 mg/L, about 50 to about 400 mg/L, about 50 to about 500 mg/L, about 50 to about 600 mg/L, about 50 to about 700 mg/L, about 50 to about 800 mg/L, about 50 to about 900 mg/L, about 50 to about 1000 mg/L, about 50 to about 1100 mg/L, about 50 to about 1250, about 100 to about 1250 mg/L, about 200 to about 1250 mg/L, about 300 to about 1250 mg/L, about 400 to about 1250 mg/L, about 500 to about 1250 mg/L, about 600 to about 1250 mg/L, about 700 to about 1250 mg/L, about 800 to about 1250 mg/L, about 900 to about 1250 mg/L, about 1000 to about 1250 mg/L, about 1100 to about 1250 mg/L, about 100 to about 200 mg/L, about 200 to about 300 mg/L, 300 to about 400 mg/L, about 400 to about 500 mg/L, about 500 to about 600 mg/L, about 600 to about 700 mg/L, about 700 to about 800 mg/L, about 800 to about 900 mg/L, about 900 to about 1000 mg/L, about 1000 to about 1100 mg/L, or about 1100 to about 1200 mg/L).

In some embodiments, a Scotch-like alcoholic beverage can have a total additional VOC content from the VOCs that are in Group Q of about 50 to about 1250 mg/L (e.g., about 50 to about 100 mg/L, about 50 to about 200 mg/L, about 50 to about 300 mg/L, about 50 to about 400 mg/L, about 50 to about 500 mg/L, about 50 to about 600 mg/L, about 50 to about 700 mg/L, about 50 to about 800 mg/L, about 50 to about 900 mg/L, about 50 to about 1000 mg/L, about 50 to about 1100 mg/L, about 50 to about 1250, about 100 to about 1250 mg/L, about 200 to about 1250 mg/L, about 300 to about 1250 mg/L, about 400 to about 1250 mg/L, about 500 to about 1250 mg/L, about 600 to about 1250 mg/L, about 700 to about 1250 mg/L, about 800 to about 1250 mg/L, about 900 to about 1250 mg/L, about 1000 to about 1250 mg/L, about 1100 to about 1250 mg/L, about 100 to about 200 mg/L, about 200 to about 300 mg/L, 300 to about 400 mg/L, about 400 to about 500 mg/L, about 500 to about 600 mg/L, about 600 to about 700 mg/L, about 700 to about 800 mg/L, about 800 to about 900 mg/L, about 900 to about 1000 mg/L, about 1000 to about 1100 mg/L, or about 1100 to about 1200 mg/L).

In some embodiments, a Scotch-like alcoholic beverage can have a total additional VOC content from the VOCs that are in Group R of about 50 to about 1250 mg/L (e.g., about 50 to about 100 mg/L, about 50 to about 200 mg/L, about 50 to about 300 mg/L, about 50 to about 400 mg/L, about 50 to about 500 mg/L, about 50 to about 600 mg/L, about 50 to about 700 mg/L, about 50 to about 800 mg/L, about 50 to about 900 mg/L, about 50 to about 1000 mg/L, about 50 to about 1100 mg/L, about 50 to about 1250, about 100 to about 1250 mg/L, about 200 to about 1250 mg/L, about 300 to about 1250 mg/L, about 400 to about 1250 mg/L, about 500 to about 1250 mg/L, about 600 to about 1250 mg/L, about 700 to about 1250 mg/L, about 800 to about 1250 mg/L, about 900 to about 1250 mg/L, about 1000 to about 1250 mg/L, about 1100 to about 1250 mg/L, about 100 to about 200 mg/L, about 200 to about 300 mg/L, 300 to about 400 mg/L, about 400 to about 500 mg/L, about 500 to about 600 mg/L, about 600 to about 700 mg/L, about 700 to about 800 mg/L, about 800 to about 900 mg/L, about 900 to about 1000 mg/L, about 1000 to about 1100 mg/L, or about 1100 to about 1200 mg/L).

In some embodiments, a Scotch-like alcoholic beverage can have a total additional VOC content from the VOCs that are in Group S of about 50 to about 1250 mg/L (e.g., about 50 to about 100 mg/L, about 50 to about 200 mg/L, about 50 to about 300 mg/L, about 50 to about 400 mg/L, about 50 to about 500 mg/L, about 50 to about 600 mg/L, about 50 to about 700 mg/L, about 50 to about 800 mg/L, about 50 to about 900 mg/L, about 50 to about 1000 mg/L, about 50 to about 1100 mg/L, about 50 to about 1250, about 100 to about 1250 mg/L, about 200 to about 1250 mg/L, about 300 to about 1250 mg/L, about 400 to about 1250 mg/L, about 500 to about 1250 mg/L, about 600 to about 1250 mg/L, about 700 to about 1250 mg/L, about 800 to about 1250 mg/L, about 900 to about 1250 mg/L, about 1000 to about 1250 mg/L, about 1100 to about 1250 mg/L, about 100 to about 200 mg/L, about 200 to about 300 mg/L, 300 to about 400 mg/L, about 400 to about 500 mg/L, about 500 to about 600 mg/L, about 600 to about 700 mg/L, about 700 to about 800 mg/L, about 800 to about 900 mg/L, about 900 to about 1000 mg/L, about 1000 to about 1100 mg/L, or about 1100 to about 1200 mg/L).

In some embodiments, a Scotch-like alcoholic beverage can have a total additional VOC content from the VOCs that are in Group T of about 50 to about 1250 mg/L (e.g., about 50 to about 100 mg/L, about 50 to about 200 mg/L, about 50 to about 300 mg/L, about 50 to about 400 mg/L, about 50 to about 500 mg/L, about 50 to about 600 mg/L, about 50 to about 700 mg/L, about 50 to about 800 mg/L, about 50 to about 900 mg/L, about 50 to about 1000 mg/L, about 50 to about 1100 mg/L, about 50 to about 1250, about 100 to about 1250 mg/L, about 200 to about 1250 mg/L, about 300 to about 1250 mg/L, about 400 to about 1250 mg/L, about 500 to about 1250 mg/L, about 600 to about 1250 mg/L, about 700 to about 1250 mg/L, about 800 to about 1250 mg/L, about 900 to about 1250 mg/L, about 1000 to about 1250 mg/L, about 1100 to about 1250 mg/L, about 100 to about 200 mg/L, about 200 to about 300 mg/L, 300 to about 400 mg/L, about 400 to about 500 mg/L, about 500 to about 600 mg/L, about 600 to about 700 mg/L, about 700 to about 800 mg/L, about 800 to about 900 mg/L, about 900 to about 1000 mg/L, about 1000 to about 1100 mg/L, or about 1100 to about 1200 mg/L).

In some embodiments, a Scotch-like alcoholic beverage can have a total additional VOC content from the VOCs that are in Group U of about 50 to about 1250 mg/L (e.g., about 50 to about 100 mg/L, about 50 to about 200 mg/L, about 50 to about 300 mg/L, about 50 to about 400 mg/L, about 50 to about 500 mg/L, about 50 to about 600 mg/L, about 50 to about 700 mg/L, about 50 to about 800 mg/L, about 50 to about 900 mg/L, about 50 to about 1000 mg/L, about 50 to about 1100 mg/L, about 50 to about 1250, about 100 to about 1250 mg/L, about 200 to about 1250 mg/L, about 300 to about 1250 mg/L, about 400 to about 1250 mg/L, about 500 to about 1250 mg/L, about 600 to about 1250 mg/L, about 700 to about 1250 mg/L, about 800 to about 1250 mg/L, about 900 to about 1250 mg/L, about 1000 to about 1250 mg/L, about 1100 to about 1250 mg/L, about 100 to about 200 mg/L, about 200 to about 300 mg/L, 300 to about 400 mg/L, about 400 to about 500 mg/L, about 500 to about 600 mg/L, about 600 to about 700 mg/L, about 700 to about 800 mg/L, about 800 to about 900 mg/L, about 900 to about 1000 mg/L, about 1000 to about 1100 mg/L, or about 1100 to about 1200 mg/L). In some embodiments, a Scotch-like alcoholic beverage can have a total additional VOC content from the additional VOCs in Group U that is 1250 mg/L or less (e.g., 1200, 1150, 1100, 1050, 1000, 950, 900, 850, 800, 750, 700, 650, 600, 550, 500, 450, 400, 350, 300, 250, 200, 150, or 100 mg/L or less).

In some cases, the total amount of additional (non-ethanol) VOCs in a Scotch replica can be greater than the total amount of additional VOCs in a reference Scotch. For example, a Scotch-like alcoholic beverage can have a total additional VOC content that is 7500 mg/L or greater (e.g., 8000, 8500, or 9000 mg/L or greater).

In some cases, the total amount of additional (non-ethanol) VOCs in a Scotch replica can be less than the total amount of additional VOCs in a reference Scotch. For example, a Scotch-like alcoholic beverage can have a total additional VOC content that is 1200 mg/L or less (e.g., 1000, 900, 800, 700, 600, 500, 400, 300, 200, 100, 90, 80, 70 mg/L or less). In some embodiments, the total amount of additional VOCs in a Scotch replica can be about 50 to about 200 mg/L, (e.g., about 50 to about 150 mg/L, about 50 to about 100 mg/L, about 50 to about 90 mg/L, about 50 to about 80 mg/L, about 50 to about 70 mg/L, about 60 to about 90 mg/L, about 60 to about 80 mg/L, about 70 to about 100 mg/L, about 70 to about 90 mg/L. In some embodiments, the total amount of additional VOCs in a Scotch replica can be about 60 to about 90 mg/L. In some embodiments, the total amount of additional VOCs in a Scotch replica can be about 70 to about 80 mg/L.

The non-volatile compounds present in a Scotch replica can include compounds that fall into any of several categories, including amino acids and amino acid derivatives, acids (e.g., organic acids), sugars and sugar alcohols, and nucleobases, nucleosides, and nucleotide monophosphates. In some cases, a Scotch replica can include non-volatile compounds that fall into the categories of lipids and lipid components, tannin components, vitamins, amines and amine derivatives, polyphenols, emulsifiers, and other compounds.

It is noted that some of the compounds listed in the following paragraphs (e.g., vanillin, syringaldehyde, acetovanillone, pyridine, 2,3-dimethylpyrazine, methyl-2-pyrrolyl ketone, 2,3,5-trimethylpyrazine, 2,3,5,6-tetramethylpyrazine, and piperine) have volatile properties. Since they were detected and quantified by LC-MS rather than GC-MS, however, they are categorized with the non-volatile compounds herein.

In some embodiments, amino acids or derivatives thereof that may be present in a Scotch replica as provided herein include, without limitation, leucine, phenylalanine, methionine, gamma-aminobutyric acid (GABA), tyrosine, serine, aspartic acid, glucosamine, histidine, lysine, isoleucine, carnitine, tryptophan, proline, valine, b-alanine, threonine, glutamine, asparagine, glutamic acid, cysteine, arginine, ornithine, trans 4-hydroxy-L-proline, citrulline, tyramine, and any combination thereof. In some embodiments, amino acids or derivatives thereof that may be present in a Scotch replica as provided herein include, without limitation, arginine, asparagine, aspartic acid, beta-alanine, betaine, carnitine, carnosine, citrulline, cysteine, cystine, GABA, glucosamine, glutamic acid, glutamine, glycine, histidine, homoserine, isoleucine, leucine, lysine, methionine, ornithine, phenylalanine, proline, serine, threonine, trans-4-hydroxy-L-proline, tryptamine, tryptophan tyramine, tyrosine, valine, and any combination thereof.

In some embodiments, examples of acids that can be included in a Scotch replica include, without limitation, quinic acid, pantothenic acid, caffeic acid, vanillic acid, syringic acid, coumaric acid, kynurenic acid, sorbic acid, D-glucuronic acid, malic acid, tartaric acid, lactic acid, succinic acid, citric acid, fumaric acid, pyruvic acid, gallic acid, 3,4-dihydroxybenzoic acid, 2-furoic acid, 2-isopropylmalic acid, trans-ferulic acid, camphoric acid, vanillin, syringaldehyde, acetovanillone, and any combination thereof. In some embodiments, examples of acids that can be included in a Scotch replica, include, without limitation, 2-furoic acid, 2-isopropylmalic acid, 4-guanidinobutyric acid, adipic acid, camphoric acid, cinnamic acid, citric acid, D-glucuronic acid, fumaric acid, lactic acid, malic acid, pipecolinic acid, pyruvic acid, sorbic acid, succinic acid, tartaric acid, trans-ferulic acid, and any combination thereof. In some embodiments, examples of phenolics that can be included in a Scotch replica include, without limitation, 3,4-dihydroxybenzoic acid, acetovanillone, caffeic acid, catechin, coumaric acid, egallic acid, epicatechin gallate, epichatechin, gallic acid, hesperetin, kynurenic acid, methyl gallate, pantothenic acid, polydatin, propyl gallate, quercetin, quinic acid, resveratrol, rutin, salicylic acid, sinapinic acid, syringaldehyde, syringic acid, vanillic acid, vanillin, and any combination thereof.

Sugars and sugar alcohols that can be used in a Scotch replica include, without limitation, xylose, fucose, sorbitol, mannose, galactose, glycerol, inositol (e.g., myo-inositol), ribose, arabitol, fructose, rhamnose, mannitol, glucose, and any combination thereof.

Examples of vitamins that can be included in a Scotch replica include, without limitation, pyridoxine.

Examples of lipids and lipid components that can be included in a Scotch replica include, without limitation, choline.

Examples of polyphenols that can be included in a Scotch replica include, without limitation, polydatin and epicatechin gallate.

Examples of nucleobases that can be included in a Scotch replica include, without limitation, adenine, cytidine, uracil, and guanine.

Examples of nucleosides that can be included in a Scotch replica include, without limitation, cytosine.

Examples of nucleoside monophosophates that can be included in a Scotch replica include, without limitation guanosine monophosphate, inosine monophosphate, adenosine monophosphate (AMP), and cytosine monophosphate (CMP).

A non-limiting example of a pH-modifying salt that can be included in a Scotch replica is potassium hydroxide.

A non-limiting example of an emulsifier that can be used in a Scotch replica is gum arabic.

A Scotch replica can include tannin components such as, for example, oak extract, oak tannin, or a combination thereof.

Other non-volatile compounds that can be included in a Scotch replica include, without limitation, pyridine, 2,3-dimethylpyrazine, methyl-2-pyrrolyl ketone, 2,3,5-trimethylpyrazine, 2,3,5,6-tetramethylpyrazine, and piperine.

The non-volatile compounds in a Scotch replica as provided herein can include, for example, one or more of D-glucuronic acid, fructose, gallic acid, glucose, lactic acid, malic acid, mannitol, inositol (also referred to herein as myo-inositol), succinic acid, syringaldehyde, syringic acid, tartaric acid, vanillic acid, vanillin, mannose, ribose, sorbitol, trans-ferulic acid, acetovanillone, choline, fumaric acid, GABA, proline, glucosamine, tyrosine, and valine.

In some embodiments, non-volatile compounds can be placed in various groups, and can be included in a Scotch replica according to their groupings. In certain cases, for example, “Group K” compounds can include D-glucuronic acid, fructose, glucose, lactic acid, malic acid, succinic acid, and tartaric acid, and “Group L” compounds can include 2-furoic acid, acetovanillone, choline, cinnamic acid, citric acid, fucose, fumaric acid, GABA, galactose, gallic acid, glucosamine, glycerol, gum arabic, inositol, mannitol, mannose, proline, ribose, sorbitol, syringaldehyde, syringic acid, trans-ferulic acid, tyrosine, valine, vanillic acid, vanillin, and xylose.

In some cases, “Group V” compounds can include 2-furoic acid, acetovanillone, choline, cinnamic acid, citric acid, D-glucuronic acid, fructose, fucose, fumaric acid, GABA, galactose, gallic acid, glucosamine, glucose, lactic acid, malic acid, mannitol, mannose, inositol, proline, ribose, sorbitol, succinic acid, syringaldehyde, syringic acid, tartaric acid, trans-ferulic acid, tyrosine, valine, vanillic acid, vanillin, and xylose.

In some cases, “Group W” compounds can include 2,3,5,6-tetramethylpyrazine, 2,3,5-trimethylpyrazine, 2,3-dimethylpyrazine, 2-furoic acid, 2-isopropylmalic acid, 3,4-dihydroxybenzoic acid, 4-guanidinobutyric acid, acetovanillone, adenine, AMP, arabitol, arginine, asparagine, aspartic acid, beta-alanine, betaine, caffeic acid, carnitine, choline, cinnamic acid, citric acid, citrulline, CMP, coumaric acid, cytidine, cytosine, D-glucuronic acid, egallic Acid, fructose, fucose, fumaric acid, GABA, galactose, gallic acid, glucosamine, glucose, glutamic acid, glutamine, glycine, guanine, histidine, homoserine, kynurenic acid, lactic acid, leucine, lysine, malic acid, mannitol, mannose, methionine, methyl gallate, methyl-2-pyrrolyl ketone, inositol (e.g., myo-inositol), phenylalanine, pipecolinic acid, proline, propyl gallate, pyridine, pyridoxine, pyruvic acid, quinic acid, rhamnose, ribose, rutin, salicylic acid, serine, sorbic acid, sorbitol, succinic acid, syringaldehyde, syringic acid, tartaric acid, threonine, trans-4-hydroxy-L-proline, trans-ferulic acid, tryptamine, tyramine, tyrosine, uracil, valine, vanillic acid, vanillin, and xylose.

In some cases, “Group X” compounds can include 2,3,5,6-tetramethylpyrazine, 2,3,5-trimethylpyrazine, 2,3-dimethylpyrazine, 2-furoic acid, 2-isopropylmalic acid, 3,4-dihydroxybenzoic acid, acetovanillone, adenine, arabitol, arginine, asparagine, aspartic acid, b-alanine, caffeic acid, camphoric acid, carnitine, choline, cinnamic acid, citric acid, citrulline, coumaric acid, cysteine, D-glucuronic acid, epicatechin gallate, fructose, fucose, fumaric acid, GABA, galactose, gallic acid, glucosamine, glucose, glutamic acid, glutamine, glycerol, guanine, histidine, isoleucine, kynurenic acid, lactic acid, leucine, lysine, malic acid, mannitol, methionine, methyl 2-pyrrolyl ketone, inositol, ornithine, pantothenic acid, phenylalanine, piperine, polydatin, proline, pyridine, pyridoxine, pyruvic acid, quinic acid, rhamnose, ribose, serine, sorbic acid, sorbitol, succinic acid, syringaldehyde, syringic acid, tartaric acid, threonine, trans-4-hydroxy-L-proline, trans-ferulic acid, tryptamine, tryptophan, tyramine, tyrosine, valine, vanillic acid, vanillin, xylose, 4-guanidinobutyric acid, adipic acid, AMP, betaine, carnosine, catechin, CMP, cystine, cytidine, cytosine, egallic acid, epichatechin, glycine, hesperetin, homoserine, methyl gallate, pipecolinic acid, propyl gallate, quercetin, resveratrol, rutin, salicylic acid, sinapinic acid, and uracil.

A Scotch replica can include, for example, at least three (e.g., at least five, at least eight, or at least ten) of the compounds of Group K, in combination with at least one (e.g., at least two, at least three, at least five, or at least ten) of the compounds of Group L. For example, in some embodiments, a Scotch-like alcoholic beverage can include all of the non-volatile compounds from Group K and one non-volatile compound from Group L. Thus, in some cases, a Scotch replica can include D-glucuronic acid, fructose, glucose, lactic acid, malic acid, succinic acid, and tartaric acid, plus acetovanillone, choline, fumaric acid, GABA, gallic acid, glucosamine, inositol, mannitol, mannose, proline, ribose, sorbitol, syringaldehyde, syringic acid, trans-ferulic acid, tyrosine, valine, vanillic acid, or vanillin.

In some cases, a Scotch-like alcoholic beverage can include all of the non-volatile compounds from Group K and two non-volatile compounds from Group L. Thus, in some cases, a Scotch replica can include D-glucuronic acid, fructose, glucose, lactic acid, malic acid, succinic acid, and tartaric acid, plus 2-furoic acid and acetovanillone, 2-furoic acid and choline, 2-furoic acid and cinnamic acid, 2-furoic acid and citric acid, 2-furoic acid and fucose, 2-furoic acid and fumaric acid, 2-furoic acid and GABA, 2-furoic acid and galactose, 2-furoic acid and gallic acid, 2-furoic acid and glucosamine, 2-furoic acid and glycerol, 2-furoic acid and gum arabic, 2-furoic acid and mannitol, 2-furoic acid and mannose, 2-furoic acid and inositol, 2-furoic acid and proline, 2-furoic acid and ribose, 2-furoic acid and sorbitol, 2-furoic acid and syringaldehyde, 2-furoic acid and syringic acid, 2-furoic acid and trans-ferulic acid, 2-furoic acid and tyrosine, 2-furoic acid and valine, 2-furoic acid and vanillic acid, 2-furoic acid and vanillin, 2-furoic acid and xylose, acetovanillone and choline, acetovanillone and cinnamic acid, acetovanillone and citric acid, acetovanillone and fucose, acetovanillone and fumaric acid, acetovanillone and GABA, acetovanillone and galactose, acetovanillone and gallic acid, acetovanillone and glucosamine, acetovanillone and glycerol, acetovanillone and gum arabic, acetovanillone and mannitol, acetovanillone and mannose, acetovanillone and inositol, acetovanillone and proline, acetovanillone and ribose, acetovanillone and sorbitol, acetovanillone and syringaldehyde, acetovanillone and syringic acid, acetovanillone and trans-ferulic acid, acetovanillone and tyrosine, acetovanillone and valine, acetovanillone and vanillic acid, acetovanillone and vanillin, acetovanillone and xylose, choline and cinnamic acid, choline and citric acid, choline and fucose, choline and fumaric acid, choline and GABA, choline and galactose, choline and gallic acid, choline and glucosamine, choline and glycerol, choline and gum arabic, choline and mannitol, choline and mannose, choline and inositol, choline and proline, choline and ribose, choline and sorbitol, choline and syringaldehyde, choline and syringic acid, choline and trans-ferulic acid, choline and tyrosine, choline and valine, choline and vanillic acid, choline and vanillin, choline and xylose, cinnamic acid and citric acid, cinnamic acid and fucose, cinnamic acid and fumaric acid, cinnamic acid and GABA, cinnamic acid and galactose, cinnamic acid and gallic acid, cinnamic acid and glucosamine, cinnamic acid and glycerol, cinnamic acid and gum arabic, cinnamic acid and mannitol, cinnamic acid and mannose, cinnamic acid and inositol, cinnamic acid and proline, cinnamic acid and ribose, cinnamic acid and sorbitol, cinnamic acid and syringaldehyde, cinnamic acid and syringic acid, cinnamic acid and trans-ferulic acid, cinnamic acid and tyrosine, cinnamic acid and valine, cinnamic acid and vanillic acid, cinnamic acid and vanillin, cinnamic acid and xylose, citric acid and fucose, citric acid and fumaric acid, citric acid and GABA, citric acid and galactose, citric acid and gallic acid, citric acid and glucosamine, citric acid and glycerol, citric acid and gum arabic, citric acid and mannitol, citric acid and mannose, citric acid and inositol, citric acid and proline, citric acid and ribose, citric acid and sorbitol, citric acid and syringaldehyde, citric acid and syringic acid, citric acid and trans-ferulic acid, citric acid and tyrosine, citric acid and valine, citric acid and vanillic acid, citric acid and vanillin, citric acid and xylose, fucose and fumaric acid, fucose and GABA, fucose and galactose, fucose and gallic acid, fucose and glucosamine, fucose and glycerol, fucose and gum arabic, fucose and mannitol, fucose and mannose, fucose and inositol, fucose and proline, fucose and ribose, fucose and sorbitol, fucose and syringaldehyde, fucose and syringic acid, fucose and trans-ferulic acid, fucose and tyrosine, fucose and valine, fucose and vanillic acid, fucose and vanillin, fucose and xylose, fumaric acid and GABA, fumaric acid and galactose, fumaric acid and gallic acid, fumaric acid and glucosamine, fumaric acid and glycerol, fumaric acid and gum arabic, fumaric acid and mannitol, fumaric acid and mannose, fumaric acid and inositol, fumaric acid and proline, fumaric acid and ribose, fumaric acid and sorbitol, fumaric acid and syringaldehyde, fumaric acid and syringic acid, fumaric acid and trans-ferulic acid, fumaric acid and tyrosine, fumaric acid and valine, fumaric acid and vanillic acid, fumaric acid and vanillin, fumaric acid and xylose, GABA and galactose, GABA and gallic acid, GABA and glucosamine, GABA and glycerol, GABA and gum arabic, GABA and mannitol, GABA and mannose, GABA and inositol, GABA and proline, GABA and ribose, GABA and sorbitol, GABA and syringaldehyde, GABA and syringic acid, GABA and trans-ferulic acid, GABA and tyrosine, GABA and valine, GABA and vanillic acid, GABA and vanillin, GABA and xylose, galactose and gallic acid, galactose and glucosamine, galactose and glycerol, galactose and gum arabic, galactose and mannitol, galactose and mannose, galactose and inositol, galactose and proline, galactose and ribose, galactose and sorbitol, galactose and syringaldehyde, galactose and syringic acid, galactose and trans-ferulic acid, galactose and tyrosine, galactose and valine, galactose and vanillic acid, galactose and vanillin, galactose and xylose, gallic acid and glucosamine, gallic acid and glycerol, gallic acid and gum arabic, gallic acid and mannitol, gallic acid and mannose, gallic acid and inositol, gallic acid and proline, gallic acid and ribose, gallic acid and sorbitol, gallic acid and syringaldehyde, gallic acid and syringic acid, gallic acid and trans-ferulic acid, gallic acid and tyrosine, gallic acid and valine, gallic acid and vanillic acid, gallic acid and vanillin, gallic acid and xylose, glucosamine and glycerol, glucosamine and gum arabic, glucosamine and mannitol, glucosamine and mannose, glucosamine and inositol, glucosamine and proline, glucosamine and ribose, glucosamine and sorbitol, glucosamine and syringaldehyde, glucosamine and syringic acid, glucosamine and trans-ferulic acid, glucosamine and tyrosine, glucosamine and valine, glucosamine and vanillic acid, glucosamine and vanillin, glucosamine and xylose, glycerol and gum arabic, glycerol and mannitol, glycerol and mannose, glycerol and inositol, glycerol and proline, glycerol and ribose, glycerol and sorbitol, glycerol and syringaldehyde, glycerol and syringic acid, glycerol and trans-ferulic acid, glycerol and tyrosine, glycerol and valine, glycerol and vanillic acid, glycerol and vanillin, glycerol and xylose, gum arabic and mannitol, gum arabic and mannose, gum arabic and inositol, gum arabic and proline, gum arabic and ribose, gum arabic and sorbitol, gum arabic and syringaldehyde, gum arabic and syringic acid, gum arabic and trans-ferulic acid, gum arabic and tyrosine, gum arabic and valine, gum arabic and vanillic acid, gum arabic and vanillin, gum arabic and xylose, mannitol and mannose, mannitol and inositol, mannitol and proline, mannitol and ribose, mannitol and sorbitol, mannitol and syringaldehyde, mannitol and syringic acid, mannitol and trans-ferulic acid, mannitol and tyrosine, mannitol and valine, mannitol and vanillic acid, mannitol and vanillin, mannitol and xylose, mannose and inositol, mannose and proline, mannose and ribose, mannose and sorbitol, mannose and syringaldehyde, mannose and syringic acid, mannose and trans-ferulic acid, mannose and tyrosine, mannose and valine, mannose and vanillic acid, mannose and vanillin, mannose and xylose, inositol and proline, inositol and ribose, inositol and sorbitol, inositol and syringaldehyde, inositol and syringic acid, inositol and trans-ferulic acid, inositol and tyrosine, inositol and valine, inositol and vanillic acid, inositol and vanillin, inositol and xylose, proline and ribose, proline and sorbitol, proline and syringaldehyde, proline and syringic acid, proline and trans-ferulic acid, proline and tyrosine, proline and valine, proline and vanillic acid, proline and vanillin, proline and xylose, ribose and sorbitol, ribose and syringaldehyde, ribose and syringic acid, ribose and trans-ferulic acid, ribose and tyrosine, ribose and valine, ribose and vanillic acid, ribose and vanillin, ribose and xylose, sorbitol and syringaldehyde, sorbitol and syringic acid, sorbitol and trans-ferulic acid, sorbitol and tyrosine, sorbitol and valine, sorbitol and vanillic acid, sorbitol and vanillin, sorbitol and xylose, syringaldehyde and syringic acid, syringaldehyde and trans-ferulic acid, syringaldehyde and tyrosine, syringaldehyde and valine, syringaldehyde and vanillic acid, syringaldehyde and vanillin, syringaldehyde and xylose, syringic acid and trans-ferulic acid, syringic acid and tyrosine, syringic acid and valine, syringic acid and vanillic acid, syringic acid and vanillin, syringic acid and xylose, trans-ferulic acid and tyrosine, trans-ferulic acid and valine, trans-ferulic acid and vanillic acid, trans-ferulic acid and vanillin, trans-ferulic acid and xylose, tyrosine and valine, tyrosine and vanillic acid, tyrosine and vanillin, tyrosine and xylose, valine and vanillic acid, valine and vanillin, valine and xylose, vanillic acid and vanillin, vanillic acid and xylose, vanillin and xylose.

In some embodiments, Scotch replicas provided herein can include at least 10 (e.g., at least 11, 12, 13, 14, 15, 16, 17, 19, 20, 21, 22, 23, or 24) compounds selected from the group consisting of 2-furoic acid, adenine, choline, citric acid, D-glucuronic acid, fructose, fucose, fumaric acid, galactose, gallic acid, glucosamine, glucose, guanine, lactic acid, malic acid, inositol (e.g., myo-inositol), pyridoxine, sorbitol, succinic acid, syringaldehyde, syringic acid, tartaric acid, vanillin, and xylose.

In some embodiments, the Scotch replicas provided herein can include one or more (e.g., one, two, three, four, five, or more than five) non-volatile compounds that are not present in traditional Scotch. Examples of such non-volatile compounds include, without limitation, adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose. In some embodiments, a non-volatile compound that is not present in traditional Scotch can be selected from the group consisting of valine, xylose, and combinations thereof. It is surprising that the Scotch replicas described herein include one or more compounds not found in any tested traditional Scotch, as it would be expected that to create a Scotch replica, one would only think to use compounds found in one or more traditional Scotches.

Again, non-volatile compounds can be detected in traditional Scotches using any suitable method, including the LC-MS method described in Example 2 herein. A non-volatile compound that is “not present” in a reference Scotch is one that is not detected in the reference Scotch using the methods set forth in Example 2. Limits of detection for various non-volatile compounds are disclosed in TABLE 5 herein.

Further, in some embodiments, the Scotch replicas provided herein can lack one or more (e.g., one, two, three, four, five, or more than five) non-volatile compounds that are present in traditional Scotch. Examples of such non-volatile compounds include, without limitation, 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin. In some embodiments, a Scotch replica as provided herein can lack one or more (e.g, 2, 3, 4, 5, 6, 7, 8, 9, 10, 11, 12, 13, 14, or 15) compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, AMP, arabitol, egallic acid, homoserine, methyl gallate, pyridine, pyruvic acid, quinic acid, rhamnose, and salicylic acid. It is surprising that the Scotch replicas described herein include one or more compounds not found in any tested traditional Scotch, as it would be expected that to create a Scotch replica, one would only think to use compounds found in one or more traditional Scotches.

In some cases, the overall population of non-volatile compounds in a replica Scotch can have less than 60% identity to the non-volatile compounds in a corresponding reference Scotch (e.g., in a single type of traditional Scotch). For example, the non-volatile compounds in a Scotch replica can have less than 50%, less than 40%, less than 30%, or less than 20% identity to the population of non-volatile compounds in a corresponding reference Scotch. As defined herein, the “percent identity” of non-volatile compounds is calculated by dividing the number of non-volatile compounds shared by a Scotch replica and a reference Scotch by the total number of non-volatile compounds (e.g., the total number of non-volatile compounds in Group V, Group W, or Group X) detected in the reference Scotch. Some Scotch replicas may contain at least 1 (e.g., at least 2, 3, 4, 5, 6, 7, 8, 9, 10, or more) non-volatile compounds that are not found in a single reference Scotch. Moreover, some Scotch replicas may contain no more than 25 (e.g., no more than 24, 23, 22, 21, 20, 19, 18, 17, 16, 15, 14, 13, 12, 11, 10, or fewer) non-volatile compounds that are present in a single reference Scotch. For example, in some embodiments, a Scotch replica can have at least m nonvolatile compounds and less than m (e.g., m−1, m−2, m−3, m−4, m−5, m−6, m−7, m−8, m−9, m−10, m−15, m−20, and the like, as applicable) of the nonvolatile compounds are found in a single reference Scotch; in some embodiments, m can be equal to 5, 6, 7, 8, 9, 10, 11, 12, 13, 14, 15, 16, 17, 18, 19, 20, 25, 30, 35, 40, 45, 50, 55, or 60.

The Examples below set forth amounts of non-volatile compounds that were included in Scotch replicas made according to the methods disclosed herein, and also set forth the amounts of non-volatile compounds that were detected in traditional Scotch samples. In some embodiments, the amount of a particular non-volatile compound in a Scotch replica can be an amount, based on concentration or percent composition, that is within a range 30% higher and lower than the amount disclosed for that non-volatile compound. For example, a non-volatile compound can be present in a Scotch replica in an amount that is 70 to 90%, 80 to 100%, 90 to 110%, 100 to 120%, 110 to 130%, 70 to 100%, 80 to 110%, 90 to 120%, or 100 to 130% of a disclosed amount for that non-volatile compound as disclosed herein.

The one or more non-volatile compounds in a Scotch-like alcoholic beverage can include xylose. In some embodiments, the xylose can be present in an amount of about 9 mg/L to about 18 mg/L (e.g. about 9 to about 15 mg/L, about 10 to about 15 mg/L, about 9 to about 12 mg/L, about 12 to about 15 mg/L, or about 15 to about 18 mg/L). In some embodiments, the one or more non-volatile compounds can include no xylose.

The one or more non-volatile compounds in a Scotch-like alcoholic beverage can include fucose. In some embodiments, the fucose can be present in an amount of about 7 mg/L to about 83 mg/L (e.g., about 7 to about 10 mg/L, about 7 to about 15 mg/L, about 10 to about 15 mg/L, about 15 to about 20 mg/L, about 10 to about 20 mg/L, about 20 to about 30 mg/L, about 30 to about 40 mg/L, about 40 to about 50 mg/L, about 50 to about 60 mg/L, about 60 to about 70 mg/L, about 70 to about 80 mg/L, or about 70 to about 83 mg/L). In some embodiments, the one or more non-volatile compounds can include no fucose.

The one or more non-volatile compounds in a Scotch-like alcoholic beverage can include sorbitol. In some embodiments, the sorbitol can be present in an amount of about 0.1 mg/L to about 15 mg/L (e.g., about 0.1 to about 0.5 mg/L, about 0.5 to about 1 mg/L, about 1 to about 2 mg/L, about 2 to about 3 mg/L, about 3 to about 4 mg/L, about 4 to about 5 mg/L, about 5 to about 7 mg/L, about 7 to about 9 mg/L, about 9 to about 11 mg/L, about 11 to about 13 mg/L, or about 13 to about 15 mg/L). In some embodiments, the sorbitol can be present in an amount of at least about 5.8 mg/L (e.g., at least about 6 mg/L, 7 mg/L, 8 mg/L, 9 mg/L, 10 mg/L, 11 mg/L, 12 mg/L, 13 mg/L, or 14 mg/L). In some embodiments, the one or more non-volatile compounds can include no sorbitol.

The one or more non-volatile compounds in a Scotch-like alcoholic beverage can include mannose. In some embodiments, the mannose can be present in an amount of about 10 to about 55 mg/L (e.g., about 10 to about 20 mg/L, about 20 to about 25 mg/L, about 25 to about 30 mg/L, about 30 to about 40 mg/L, about 40 to about 50 mg/L, or about 50 to about 55 mg/L). In some embodiments, the one or more non-volatile components can include no mannose.

The one or more non-volatile compounds in a Scotch-like alcoholic beverage can include galactose. In some embodiments, the galactose can be present in an amount of about 5 to about 22 mg/L (e.g., about 5 to about 10 mg/L, about 10 to about 15 mg/L, about 15 to about 20 mg/L, about 20 to about 22 mg/L, or about 15 to about 22 mg/L). In some embodiments, the one or more non-volatile compounds can include no galactose.

The one or more non-volatile compounds in a Scotch-like alcoholic beverage can include inositol (e.g., myo-inositol). In some embodiments, the inositol can be present in an amount of about 0.6 to about 35 mg/L (e.g., about 0.6 to about 1 mg/L, about 1 to about 2 mg/L, about 1 to about 5 mg/L, about 5 to about 10 mg/L, about 10 to about 15 mg/L, about 15 to about 20 mg/L, about 20 to about 25 mg/L, about 25 to about 30 mg/L, about 30 to about 35 mg/L, about 10 to about 20 mg/L, or about 20 to about 30 mg/L). In some embodiments, the one or more non-volatile compounds can include no inositol.

The one or more non-volatile compounds in a Scotch-like alcoholic beverage can include ribose. In some embodiments, the ribose can be present in an amount of about 3.7 to about 68 mg/L (e.g., about 3.7 to about 4 mg/L, about 4 to about 5 mg/L, about 5 to about 6 mg/L, about 6 to about 8 mg/L, about 8 to about 10 mg/L, about 10 to about 15 mg/L, about 15 to about 20 mg/L, about 20 to about 30 mg/L, about 30 to about 40 mg/L, about 40 to about 50 mg/L, about 50 to about 60 mg/L, or about 60 to about 68 mg/L. In some embodiments, the ribose can be present in an amount of less than about 6 mg/L (e.g., less than about 5.5 mg/L, 5.0 mg/L, 4.5 mg/L, or 4.0 mg/L). In some embodiments, the one or more non-volatile compounds can include no ribose.

The one or more non-volatile compounds in a Scotch-like alcoholic beverage can include arabitol. In some embodiments, the arabitol can be present in an amount of about 0.1 mg/L to about 2.5 mg/L (e.g., about 0.1 to about 0.2 mg/L, about 0.2 to about 0.3 mg/L, about 0.3 to about 0.5 mg/L, about 0.1 to about 0.5 mg/L, about 0.5 to about 1.0 mg/L, about 1.0 to about 1.5 mg/L, about 1.5 to about 2.0 mg/L, or about 2.0 to about 2.5 mg/L). In some embodiments, the one or more non-volatile compounds can include no arabitol.

The one or more non-volatile compounds in a Scotch-like alcoholic beverage can include fructose. In some embodiments, the fructose can be present in an amount of about 1.4 to about 146 mg/L (e.g., about 1.4 to about 1.5 mg/L, about 1.5 to about 2 mg/L. about 2 to about 5 mg/L, about 5 to about 10 mg/L, about 10 to about 20 mg/L, about 20 to about 40 mg/L, about 40 to about 60 mg/L, about 60 to about 80 mg/L, about 80 to about 100 mg/L, about 100 to about 120 mg/L, about 120 to about 140 mg/L, or about 120 to about 146 mg/L). In some embodiments, the fructose can be present in an amount of less than about 9.6 mg/L (e.g., less than about 9.5 mg/L, 9.4 mg/L, 9.3 mg/L, 9.2 mg/L, 9.1 mg/L, 9.0 mg/L, 8.5 mg/L, 8.0 mg/L, 7.5 mg/L, 7.0 mg/L, 6.5 mg/L, 6.0 mg/L, 5.5 mg/L, 5.0 mg/L, 4.5 mg/L, 4.0 mg/L, 3.5 mg/L, 3.0 mg/L, 2.5 mg/L, 2.0 mg/L, or 1.5 mg/L). In some embodiments, the one or more non-volatile compounds can include no fructose.

The one or more non-volatile compounds in a Scotch-like alcoholic beverage can include rhamnose. In some embodiments, the rhamnose can be present in an amount of about 4.4 to about 35 mg/L (e.g., about 4.4 to about 5 mg/L, about 5 to about 10 mg/L, about 10 to about 15 mg/L, about 15 to about 20 mg/L, about 20 to about 25 mg/L, about 25 to about 30 mg/L, or about 30 to about 35 mg/L). In some embodiments, the one or more non-volatile compounds can include no rhamnose.

The one or more non-volatile compounds in a Scotch-like alcoholic beverage can include mannitol. In some embodiments, the mannitol can be present in an amount of about 0.06 to about 13.5 mg/L (e.g., about 0.06 to about 0.1 mg/L, about 0.1 to about 0.2 mg/L, about 0.2 to about 0.5 mg/L, about 0.1 to about 0.5 mg/L, about 0.5 to about 1.0 mg/L, about 1.0 to about 2.0 mg/L, about 2.0 to about 3.0 mg/L, about 3.0 to about 5.0 mg/L, about 1.0 to about 5.0 mg/L, about 5.0 to about 7.0 mg/L, about 7.0 to about 9.0 mg/L, about 11.0 to about 13.0 mg/L, or about 11.0 to about 13.5 mg/L). In some embodiments, the mannitol can be present in an amount of at least about 7.8 mg/L (e.g., at least about 7.9 mg/L, 8.0 mg/L, 8.5 mg/L, 9.0 mg/L, 9.5 mg/L, 10.0 mg/L, 10.5 mg/L, 11.0 mg/L, 11.5 mg/L, 12.0 mg/L, 12.5 mg/L, or 13.0 mg/L). In some embodiments, the one or more non-volatile compounds can include no mannitol.

The one or more non-volatile compounds in a Scotch-like alcoholic beverage can include glucose. In some embodiments, the glucose can be present in an amount of about 13 to about 320 mg/L (e.g., about 13 to about 25 mg/L, about 25 to about 50 mg/L, about 50 to about 100 mg/L, about 100 to about 150 mg/L, about 150 to about 200 mg/L, about 200 to about 250 mg/L, about 250 to about 300 mg/L, or about 250 to about 320 mg/L). In some embodiments, the glucose can be present in an amount of at least about 120 mg/L (e.g., at least about 130 mg/L, 140 mg/L, 150 mg/L, 160 mg/L, 170 mg/L, 180 mg/L, 190 mg/L, 200 mg/L, 210 mg/L, 220 mg/L, 230 mg/L, 250 mg/L, 260 mg/L, 270 mg/L, 280 mg/L, 290 mg/L, 300 mg/L, or 310 mg/L). In some embodiments, the one or more non-volatile compounds can include no glucose.

The one or more non-volatile compounds in a Scotch-like alcoholic beverage can include glycerol. In some embodiments, the glycerol can be present in an amount of about 5 g/L to about 10.5 g/L (e.g., about 5 g/L to about 10 g/L, about 5 g/L to about 6 g/L, about 6 g/L to about 7 g/L, about 7 to about 8 g/L, about 8 to about 9 g/L, about 9 to about 10 g/L, about 10.0 to about 10.5 g/L, about 5 to about 7 g/L, about 7 to about 9 g/L, about 6 to about 8 g/L, or about 8 to about 10 g/L). In some embodiments, the one or more non-volatile compounds can include no glycerol.

The one or more non-volatile compounds in a Scotch-like alcoholic beverage can include quinic acid. In some embodiments, the quinic acid can be present in an amount of about 0.6 to about 2 mg/L (e.g., about 0.6 to about 1.0 mg/L, about 1 to about 2 mg/L, about 1.0 to about 1.5 mg/L, or about 1.5 to about 2.0 mg/L). In some embodiments, the one or more non-volatile compounds can include no quinic acid.

The one or more non-volatile compounds in a Scotch-like alcoholic beverage can include caffeic acid. In some embodiments, the caffeic acid can be present in an amount of about 0.9 to about 2.8 mg/L (e.g., about 0.9 to about 1.0 mg/L, about 1.0 to about 1.2 mg/L, about 1.2 to about 1.5 mg/L, about 1.5 to about 2.0 mg/L, about 2.0 to about 2.5 mg/L, or about 2.5 to about 2.8 mg/L). In some embodiments, the one or more non-volatile compounds can include no caffeic acid.

The one or more non-volatile compounds in a Scotch-like alcoholic beverage can include vanillic acid. In some embodiments, the vanillic acid can be present in an amount of about 0.7 to about 110 mg/L (e.g., about 0.7 to about 1 mg/L, about 1 to about 2 mg/L, about 2 to about 5 mg/L, about 5 to about 10 mg/L, about 10 to about 20 mg/L, about 20 to about 30 mg/L, about 30 to about 50 mg/L, about 50 to about 70 mg/L, about 70 to about 90 mg/L, or about 90 to about 110 mg/L). In some embodiments, the vanillic acid can be present in an amount less than about 6.3 mg/L (e.g., less than about 6.0 mg/L, 5.5 mg/L, 5.0 mg/L, 4.5 mg/L, 4.0 mg/L, 3.5 mg/L, 3.0 mg/L, 2.5 mg/L, 2.0 mg/L, 1.5 mg/L, or 1.0 mg/L). In some embodiments, the one or more non-volatile compounds can include no vanillic acid.

The one or more non-volatile compounds in a Scotch-like alcoholic beverage can include syringic acid. In some embodiments, the syringic acid can be present in an amount of about 0.02 to about 31 mg/L (e.g., about 0.02 to about 0.05 mg/L, about 0.05 to about 0.1 mg/L, about 0.1 to about 0.5 mg/L, about 0.5 to about 1 mg/L, about 1 to about 2 mg/L, about 2 to about 3 mg/L, about 3 to about 5 mg/L, about 1 to about 5 mg/L, about 5 to about 7 mg/L, about 7 to about 9 mg/L, about 8 to about 10 mg/L, about 5 to about 10 mg/L, about 10 to about 15 mg/L, about 15 to about 20 mg/L, about 20 to about 25 mg/L, about 25 to about 30 mg/L, or about 25 to about 31 mg/L). In some embodiments, the syringic acid can be present in an amount of at least about 5.4 mg/L (e.g., at least about 5.5 mg/L, 6 mg/L, 7 mg/L, 8 mg/L, 9 mg/L, 10 mg/L, 11 mg/L, 12 mg/L 13 mg/L, 14 mg/L, 15 mg/L, 17 mg/L, 20 mg/L, 22 mg/L, 25 mg/L, 27 mg/L, or 30 mg/L). In some embodiments, the one or more non-volatile compounds can include no syringic acid.

The one or more non-volatile compounds in a Scotch-like alcoholic beverage can include vanillin. In some embodiments, the vanillin can be present in an amount of about 0.08 to about 7 mg/L (e.g., about 0.08 to about 0.1 mg/L, about 0.08 to about 0.5 mg/L, about 0.1 to about 0.5 mg/L, about 1 to about 2 mg/L, about 2 to about 3 mg/L, about 3 to about 4 mg/L, about 4 to about 5 mg/L, about 1 to about 5 mg/L, about 5 to about 6 mg/L, about 5 to about 7 mg/L, or about 6 to about 7 mg/L). In some embodiments, the vanillin can be present in an amount of less than about 0.12 mg/L (e.g., less than about 0.011 mg/L or 0.10 mg/L). In some embodiments, the one or more non-volatile compounds can include no vanillin.

The one or more non-volatile compounds in a Scotch-like alcoholic beverage can include syringaldehyde. In some embodiments, the syringaldehyde can be present in an amount of about 0.1 to about 11 mg/L, (e.g., about 0.1 to about 0.5 mg/L, about 0.5 to about 1 mg/L, about 1 to about 2 mg/L, about 2 to about 3 mg/L, about 3 to about 5 mg/L, about 1 to about 5 mg/L, about 5 to about 7 mg/L, about 7 to about 9 mg/L, about 5 to about 10 mg/L, about 5 to about 11 mg/L, or about 9 to about 11 mg/L). In some embodiments, the syringaldehyde can be present in an amount of less than about 0.21 mg/L (e.g., less than 0.20 mg/L, 0.19 mg/L, 0.18 mg/L, 0.17 mg/L, 0.16 mg/L, or 0.15 mg/L). In some embodiments, the one or more non-volatile compounds can include no syringaldehyde.

The one or more non-volatile compounds in a Scotch-like alcoholic beverage can include coumaric acid. In some embodiments, the coumaric acid can be present in an amount of about 0.4 to about 2.3 mg/L (e.g., about 0.4 to about 0.5 mg/L, about 0.5 to about 0.7 mg/L, about 0.7 to about 1.0 mg/L, about 0.5 to about 1.0 mg/L, about 1.0 to about 1.5 mg/L, about 1.5 to about 2.0 mg/L, or about 2.0 to about 2.3 mg/L). In some embodiments, the one or more non-volatile compounds can include no coumaric acid.

The one or more non-volatile compounds in a Scotch-like alcoholic beverage can include acetovanillone. In some embodiments, the acetovanillone can be present in an amount of about 0.017 to about 0.6 mg/L (e.g., about 0.017 to about 0.02 mg/L, about 0.02 to about 0.03 mg/L, about 0.02 to about 0.05 mg/L, about 0.03 to about 0.05 mg/L, about 0.05 to about 0.1 mg/L, about 0.1 to about 0.2 mg/L, about 0.2 to about 0.3 mg/L, about 0.3 to about 0.4 mg/L, about 0.4 to about 0.5 mg/L, or about 0.5 to about 0.6 mg/L). In some embodiments, the acetovanillone can be present in an amount of at least about 0.26 mg/L (e.g., at least about 0.27 mg/L, 0.28 mg/L, 0.29 mg/L, 0.30 mg/L, 0.25 mg/L, 0.40 mg/L, 0.45 mg/L, 0.46 mg/L, 0.47 mg/L, 0.48 mg/L, 0.49 mg/L, 0.50 mg/L, or 0.55 mg/L). In some embodiments, the one or more non-volatile compounds can include no acetovanillone.

The one or more non-volatile compounds in a Scotch-like alcoholic beverage can include egallic acid. In some embodiments, the egallic acid can be present in an amount of about 14 to about 26 mg/L (e.g., about 14 to about 20 mg/L, about 15 to about 20 mg/L, about 20 to about 25 mg/L, about 20 to about 26 mg/L, about 16 to about 24 mg/L, or about 18 to about 22 mg/L). In some embodiments, the one or more non-volatile compounds can include no acetovanillone.

The one or more non-volatile compounds in a Scotch-like alcoholic beverage can include cinnamic acid. In some embodiments, the cinnamic acid can be present in an amount of about 0.7 to about 3.6 mg/L (e.g. about 0.7 to about 1.0 mg/L, about 1.0 to about 2.0 mg/L, about 2.0 to about 3.0 mg/L, about 0.7 to about 1.5 mg/L, about 2.5 to about 3.5 mg/L, about 2.5 to about 3.7 mg/L, about 1.4 to about 2.0 mg/L, about 1.5 to about 2.0 mg/L, about 1.5 to about 2.5 mg/L, about 2.0 to about 2.5 mg/L, or about 2.0 to about 2.6 mg/L). In some embodiments, the one or more non-volatile compounds can include no cinnamic acid.

The one or more non-volatile compounds in a Scotch-like alcoholic beverage can include trans-4-hydroxy-L-proline. In some embodiments, the trans-4-hydroxy-L-proline can be present in an amount of about 0.01 to about 0.7 mg/L (e.g., about 0.01 to about 0.02 mg/L, about 0.02 to about 0.03 mg/L, about 0.03 to about 0.05 mg/L, about 0.01 to about 0.05 mg/L, about 0.05 to about 0.1 mg/L, about 0.1 to about 0.2 mg/L, about 0.2 to about 0.3 mg/L, about 0.3 to about 0.4 mg/L, about 0.4 to about 0.5 mg/L, about 0.1 to about 0.5 mg/L, about 0.5 to about 0.6 mg/L, or about 0.6 to about 0.7 mg/L). In some embodiments, the one or more non-volatile compounds can include no trans-4-hydroxy-L-proline.

The one or more non-volatile compounds in a Scotch-like alcoholic beverage can include citrulline. In some embodiments, the citrulline can be present in an amount of about 0.004 to about 0.025 mg/L (e.g., about 0.004 to about 0.005 mg/L, about 0.005 to about 0.010 mg/L, about 0.010 to about 0.015 mg/L, about 0.01 to about 0.02 mg/L, about 0.015 mg/L to about 0.020 mg/L, about 0.020 to about 0.025 mg/L, or about 0.015 to about 0.025 mg/L). In some embodiments, the one or more non-volatile compounds can include no citrulline.

The one or more non-volatile compounds in a Scotch-like alcoholic beverage can include adenine. In some embodiments, the adenine can be present in an amount of about 0.01 to about 0.1 mg/L (e.g., about 0.01 to about 0.02 mg/L, about 0.02 to about 0.03 mg/L, about 0.03 to about 0.04 mg/L, about 0.04 to about 0.05 mg/L, about 0.01 to about 0.05 mg/L, about 0.05 to about 0.1 mg/L, about 0.05 to about 0.06 mg/L, about 0.06 to about 0.07 mg/L, about 0.07 to about 0.08 mg/L, about 0.08 to about 0.09 mg/L, or about 0.09 to about 0.1 mg/L). In some embodiments, the one or more non-volatile compounds can include no adenine.

The one or more non-volatile compounds in a Scotch-like alcoholic beverage can include guanine. In some embodiments, the guanine can be present in an amount of about 0.00014 to about 0.3 mg/L (e.g., about 0.00014 to about 0.0002 mg/L, about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.2 mg/L, or about 0.2 to about 0.3 mg/L). In some embodiments, the one or more non-volatile compounds can include no guanine.

The one or more non-volatile compounds in a Scotch-like alcoholic beverage can include tyramine. In some embodiments, the tyramine can be present in an amount of about 0.001 to about 0.005 mg/L (e.g., about 0.001 to about 0.002 mg/L, about 0.002 to about 0.003 mg/L, about 0.003 to about 0.004 mg/L, or about 0.004 to about 0.005 mg/L). In some embodiments, the one or more non-volatile compounds can include no tyramine.

The one or more non-volatile compounds in a Scotch-like alcoholic beverage can include kynurenic acid. In some embodiments, the kynurenic acid can be present in an amount of about 0.005 to about 0.1 mg/L (e.g., about 0.005 to about 0.01 mg/L, about 0.01 to about 0.02 mg/L, about 0.02 to about 0.04 mg/L, about 0.01 to about 0.05 mg/L, about 0.05 to about 0.1 mg/L, about 0.04 to about 0.06 mg/L, about 0.06 to about 0.08 mg/L, or about 0.08 to about 0.1 mg/L). In some embodiments, the one or more non-volatile compounds can include no kynurenic acid.

The one or more non-volatile compounds in a Scotch-like alcoholic beverage can include sorbic acid. In some embodiments, the sorbic acid can be present in an amount of about 0.07 to about 0.5 mg/L (e.g., about 0.07 to about 0.1 mg/L, about 0.1 to about 0.5 mg/L, about 0.1 to about 0.3 mg/L, about 0.2 to about 0.4 mg/L, or about 0.3 to about 0.5 mg/L). In some embodiments, the one or more non-volatile compounds can include no sorbic acid.

The one or more non-volatile compounds in a Scotch-like alcoholic beverage can include pyridoxine. In some embodiments, the pyridoxine can be present in an amount of about 0.0008 to about 0.013 mg/L (e.g., about 0.0008 to about 0.001 mg/L, about 0.001 to about 0.002 mg/L, about 0.002 to about 0.003 mg/L, about 0.003 to about 0.005 mg/L, about 0.001 to about 0.005 mg/L, about 0.005 to about 0.008 mg/L, about 0.001 to about 0.002 mg/L, about 0.002 to about 0.004 mg/L, about 0.004 to about 0.006 mg/L, about 0.006 to about 0.008 mg/L, about 0.001 to about 0.005 mg/L, about 0.005 to about 0.10 mg/L, or about 0.010 to about 0.013 mg/L). In some embodiments, the one or more non-volatile compounds can include no pyridoxine.

The one or more non-volatile compounds in a Scotch-like alcoholic beverage can include choline. In some embodiments, the choline can be present in a n amount of about 0.15 to about 19 mg/L (e.g., about 0.15 to about 0.2 mg/L, about 0.2 to about 0.5 mg/L, about 0.5 to about 1 mg/L, about 1 to about 2 mg/L, about 1 to about 5 mg/L, about 2 to about 3 mg/L, about 3 to about 5 mg/L, about 5 to about 7 mg/L, about 5 to about 10 mg/L, about 7 to about 9 mg/L, about 9 to about 11 mg/L, about 10 to about 15 mg/L, about 11 to about 13 mg/L, about 13 to about 15 mg/L, about 15 to about 17 mg/L, about 15 to about 19 mg/L, or about 17 to about 19 mg/L). In some embodiments, the choline can be present in an amount of at least about 2.8 mg/L (e.g., at least about 3 mg/L, 4 mg/L, 5 mg/L, 6 mg/L, 7 mg/L, 8 mg/L, 9 mg/L, 10 mg/L, 11 mg/L, 12 mg/L, 13 mg/L, 14 mg/L, 15 mg/L, 16 mg/L, 17 mg/L, or 18 mg/L). In some embodiments, the one or more non-volatile compounds can include no choline.

The one or more non-volatile compounds in a Scotch-like alcoholic beverage can include phenylalanine. In some embodiments, the phenylalanine can be present in an amount of about 0.03 to about 0.24 mg/L (e.g., about 0.03 to about 0.05 mg/L, about 0.05 to about 0.07 mg/L, about 0.05 to about 0.10 mg/L, about 0.07 to about 0.10 mg/L, about 0.10 to about 0.12 mg/L, about 0.12 to about 0.14 mg/L, about 0.14 to about 0.16 mg/L, about 0.10 to about 0.15 mg/L, about 0.16 to about 0.18 mg/L, about 0.18 to about 0.20 mg/L, about 0.15 to about 0.20 mg/L, about 0.20 to about 0.22 mg/L, or about 0.22 to about 0.24 mg/L). In some embodiments, the one or more non-volatile compounds can include no phenylalanine.

The one or more non-volatile compounds in a Scotch-like alcoholic beverage can include methionine. In some embodiments, the methionine can be present in an amount of about 0.02 to about 0.05 mg/L (e.g., about 0.02 to about 0.03 mg/L, about 0.03 to about 0.04 mg/L, or about 0.04 to about 0.05 mg/L). In some embodiments, the one or more non-volatile compounds can include no methionine.

The one or more non-volatile compounds in a Scotch-like alcoholic beverage can include GABA (gamma-aminobutyric acid). In some embodiments, the GABA can be present in an amount of about 0.015 to about 2.2 mg/L (e.g., about 0.015 to about 0.02 mg/L, about 0.02 to about 0.03 mg/L, about 0.03 to about 0.05 mg/L, about 0.05 to about 0.1 mg/L, about 0.1 to about 0.2 mg/L, about 0.2 to about 0.5 mg/L, about 0.5 to about 1.0 mg/L, about 1.0 to about 1.5 mg/L, about 1.5 to about 2.0 mg/L, or about 2.0 to about 2.2 mg/L). In some embodiments, the one or more non-volatile compounds can include no GABA.

The one or more non-volatile compounds in a Scotch-like alcoholic beverage can include tyrosine. In some embodiments, the tyrosine can be present in an amount of about 0.44 to about 0.82 mg/L (e.g., about 0.44 to about 0.45 mg/L, about 0.45 to about 0.50 mg/L, about 0.50 to about 0.55 mg/L, about 0.55 to about 0.60 mg/L, about 0.60 to about 0.65 mg/L, about 0.65 to about 0.70 mg/L, about 0.70 to about 0.75 mg/L, about 0.75 mg/L to about 0.80 mg/L, or about 0.75 to about 0.82 mg/L). In some embodiments, the one or more non-volatile compounds can include no tyrosine.

The one or more non-volatile compounds in a Scotch-like alcoholic beverage can include serine. In some embodiments, the serine can be present in an amount of about 0.024 to about 0.17 mg/L (e.g., about 0.024 to about 0.03 mg/L, about 0.03 to about 0.05 mg/L, about 0.05 to about 0.07 mg/L, about 0.07 to about 0.09 mg/L, about 0.09 to about 0.11 mg/L, about 0.05 to about 0.10 mg/L, about 0.11 to about 0.13 mg/L, about 0.13 to about 0.15 mg/L, about 0.10 to about 0.15 mg/L, or about 0.15 to about 0.17 mg/L). In some embodiments, the one or more non-volatile compounds can include no serine.

The one or more non-volatile compounds in a Scotch-like alcoholic beverage can include aspartic acid. In some embodiments, the aspartic acid can be present in an amount of about 0.015 to about 0.45 mg/L (e.g., about 0.015 to about 0.02 mg/L, about 0.02 to about 0.03 mg/L, about 0.03 to about 0.05 mg/L, about 0.05 to about 0.10 mg/L, about 0.10 to about 0.15 mg/L, about 0.15 to about 0.20 mg/L, about 0.20 to about 0.25 mg/L, about 0.25 to about 0.30 mg/L, about 0.30 to about 0.35 mg/L, about 0.35 to about 0.40 mg/L, or about 0.40 to about 0.45 mg/L). In some embodiments, the one or more non-volatile compounds can include no aspartic acid.

The one or more non-volatile compounds in a Scotch-like alcoholic beverage can include glucosamine. In some embodiments, the glucosamine can be present in an amount of about 0.02 to about 100 mg/L (e.g., about 0.02 to about 0.05 mg/L, about 0.05 to about 0.1 mg/L, about 0.1 to about 0.5 mg/L, about 0.5 to about 1 mg/L, about 1 to about 2 mg/L, about 2 to about 3 mg/L, about 3 to about 5 mg/L, about 1 to about 5 mg/L, about 5 to about 10 mg/L, about 10 to about 20 mg/L, about 20 to about 30 mg/L, about 30 to about 40 mg/L, about 40 to about 50 mg/L, about 50 to about 60 mg/L, about 60 to about 70 mg/L, about 70 to about 80 mg/L, about 80 to about 90 mg/L, or about 90 to about 100 mg/L). In some embodiments, the glucosamine can be present in an amount of at least about 0.55 mg/L (e.g., at least about 0.6 mg/L, 0.7 mg/L, 0.8 mg/L, 0.9 mg/L, 1 mg/L, 2 mg/L, 3 mg/L, 4 mg/L, 5 mg/L, 6 mg/L, 7 mg/L, 8 mg/L, 9 mg/L, 10 mg/L, 15 mg/L, 20 mg/L, 25 mg/L, 30 mg/L, 35 mg/L, 40 mg/L, 45 mg/L, 50 mg/L, 60 mg/L, 70 mg/L, 80 mg/L, or 90 mg/L). In some embodiments, the one or more non-volatile compounds can include no glucosamine.

The one or more non-volatile compounds in a Scotch-like alcoholic beverage can include histidine. In some embodiments, the histidine can be present in an amount of about 0.05 to about 0.1 mg/L (e.g., about 0.05 to about 0.06 mg/L, about 0.06 to about 0.07 mg/L, about 0.07 to about 0.08 mg/L, about 0.08 to about 0.09 mg/L, or about 0.09 to about 0.1 mg/L). In some embodiments, the one or more non-volatile compounds can include no histidine.

The one or more non-volatile compounds in a Scotch-like alcoholic beverage can include lysine. In some embodiments, the lysine can be present in an amount of about 0.08 to about 0.16 mg/L (e.g., about 0.08 to about 0.10 mg/L, about 0.10 to about 0.12 mg/L, about 0.12 to about 0.14 mg/L, or about 0.14 to about 0.16 mg/L). In some embodiments, the one or more non-volatile compounds can include no lysine.

The one or more non-volatile compounds in a Scotch-like alcoholic beverage can include carnitine. In some embodiments, the carnitine can be present in an amount of about 0.009 to about 0.042 mg/L (e.g., about 0.009 to about 0.010 mg/L, about 0.010 to about 0.015 mg/L, about 0.015 to about 0.020 mg/L, about 0.020 to about 0.025 mg/L, about 0.025 to about 0.030 mg/L, about 0.030 to about 0.035 mg/L, about 0.035 to about 0.040 mg/L, or about 0.035 to about 0.042 mg/L). In some embodiments, the one or more non-volatile compounds can include no carnitine.

The one or more non-volatile compounds in a Scotch-like alcoholic beverage can include proline. In some embodiments, the proline can be present in an amount of about 0.1 to about 20 mg/L (e.g., about 0.1 to about 0.2 mg/L, about 0.2 to about 0.5 mg/L, about 0.5 to about 1 mg/L, about 1 to about 2 mg/L, about 1 to about 5 mg/L, about 2 to about 4 mg/L, about 4 to about 6 mg/L, about 6 to about 8 mg/L, about 8 to about 10 mg/L, about 5 to about 10 mg/L, about 10 to about 12 mg/L, about 12 to about 14 mg/L, about 14 to about 16 mg/L, about 10 to about 15 mg/L, about 16 to about 18 mg/L, about 15 to about 20 mg/L, or about 18 to about 20 mg/L). In some embodiments, the one or more non-volatile compounds can include no proline.

The one or more non-volatile compounds in a Scotch-like alcoholic beverage can include valine. In some embodiments, the valine can be present in an amount of about 0.9 to about 1.7 mg/L (e.g., about 0.9 to about 1.1 mg/L, about 1.1 to about 1.3 mg/L, about 1.0 to about 1.5 mg/L, about 1.3 to about 1.5 mg/L, or about 1.5 to about 1.7 mg/L). In some embodiments, the one or more non-volatile compounds can include no valine.

The one or more non-volatile compounds in a Scotch-like alcoholic beverage can include beta-alanine (also called B-Alanine). In some embodiments, the beta-alanine can be present in an amount of about 0.02 to about 0.34 mg/L (e.g., about 0.02 to about 0.05 mg/L, about 0.05 to about 0.10 mg/L, about 0.10 to about 0.15 mg/L, about 0.15 to about 0.20 mg/L, about 0.20 to about 0.25 mg/L, about 0.25 mg/L to about 0.30 mg/L, or about 0.30 to about 0.34 mg/L). In some embodiments, the one or more non-volatile compounds can include no beta-alanine.

The one or more non-volatile compounds in a Scotch-like alcoholic beverage can include glutamine. In some embodiments, the glutamine can be present in an amount of about 0.015 to about 0.028 mg/L (e.g., about 0.015 to about 0.017 mg/L, about 0.017 to about 0.019 mg/L, about 0.019 to about 0.021 mg/L, about 0.021 to about 0.023 mg/L, about 0.023 to about 0.025 mg/L, about 0.025 to about 0.027 mg/L, or about 0.027 to about 0.028 mg/L). In some embodiments, the one or more non-volatile compounds can include no glutamine.

The one or more non-volatile compounds in a Scotch-like alcoholic beverage can include asparagine. In some embodiments, the asparagine can be present in an amount of about 0.025 to about 0.058 mg/L (e.g., about 0.025 to about 0.030 mg/L, about 0.030 to about 0.035 mg/L, about 0.035 to about 0.040 mg/L, about 0.040 to about 0.045 mg/L, about 0.045 to about 0.050 mg/L, about 0.050 to about 0.055 mg/L, or about 0.055 to about 0.058 mg/L). In some embodiments, the one or more non-volatile compounds can include no asparagine.

The one or more non-volatile compounds in a Scotch-like alcoholic beverage can include glutamic acid. In some embodiments, the glutamic acid can be present in an amount of about 0.01 to about 0.17 mg/L (e.g., about 0.01 to about 0.03 mg/L, about 0.03 to about 0.05 mg/L, about 0.01 to about 0.05 mg/L, about 0.05 to about 0.07 mg/L, about 0.07 to about 0.09 mg/L, about 0.09 to about 0.11 mg/L, about 0.11 to about 0.13 mg/L, about 0.10 to about 0.15 mg/L, about 0.13 to about 0.15 mg/L, or about 0.15 to about 0.17 mg/L). In some embodiments, the one or more non-volatile compounds can include no glutamic acid.

The one or more non-volatile compounds in a Scotch-like alcoholic beverage can include arginine. In some embodiments, the arginine can be present in an amount of about 0.055 to about 0.25 mg/L (e.g., about 0.055 to about 0.06 mg/L, about 0.06 to about 0.10 mg/L, about 0.10 to about 0.15 mg/L, about 0.15 to about 0.20 mg/L, or about 0.20 to about 0.25 mg/L). In some embodiments, the one or more non-volatile compounds in a Scotch-like alcoholic beverage can include no arginine.

The one or more non-volatile compounds in a Scotch-like alcoholic beverage can include homoserine. In some embodiments, the homoserine can be present in an amount f about 0.04 to about 0.12 mg/L (e.g., about 0.04 to about 0.1 mg/L, about 0.05 to about 0.1 mg/L, or about 0.05 to about 0.12 mg/L). In some embodiments, the one or more non-volatile compounds in a Scotch-like alcoholic beverage can include no homoserine.

The one or more non-volatile compounds in a Scotch-like alcoholic beverage can include D-glucuronic acid. In some embodiments, the D-glucuronic acid can be present in an amount of about 0.08 to about 15 mg/L (e.g., about 0.08 to about 0.1 mg/L, about 0.1 to about 0.5 mg/L, about 0.5 to about 1 mg/L, about 1 to about 2 mg/L, about 2 to about 3 mg/L, about 1 to about 5 mg/L, about 3 to about 5 mg/L, about 5 to about 7 mg/L, about 7 to about 9 mg/L, about 5 to about 10 mg/L, about 9 to about 11 mg/L, about 11 to about 13 mg/L, about 10 to about 15 mg/L, or about 13 to about 15 mg/L). In some embodiments, the one or more non-volatile compounds can include no D-glucuronic acid.

The one or more non-volatile compounds in a Scotch-like alcoholic beverage can include malic acid. In some embodiments, the malic acid can be present in an amount of about 0.2 to about 20 mg/L (e.g., about 0.2 to about 0.3 mg/L, about 0.3 to about 0.5 mg/L, about 0.5 to about 1 mg/L, about 1 to about 2 mg/L, about 2 to about 3 mg/L, about 3 to about 5 mg/L, about 1 to about 5 mg/L, about 5 to about 10 mg/L, about 10 to about 15 mg/L, about 15 to about 20 mg/L, or about 10 to about 20 mg/L). In some embodiments, the one or more non-volatile compounds can include no malic acid.

The one or more non-volatile compounds in a Scotch-like alcoholic beverage can include tartaric acid. In some embodiments, the tartaric acid can be present in an amount of about 0.3 to about 350 mg/L (e.g., about 0.3 to about 0.5 mg/L, about 0.5 to about 1 mg/L, about 1 to about 2 mg/L, about 2 to about 5 mg/L, about 1 to about 5 mg/L, about 5 to about 10 mg/L, about 10 to about 20 mg/L, about 20 to about 50 mg/L, about 50 to about 100 mg/L, about 100 to about 150 mg/L, about 150 to about 200 mg/L, about 200 to about 250 mg/L, about 250 to about 300 mg/L, or about 300 to about 350 mg/L). In some embodiments, the one or more non-volatile compounds can include no tartaric acid.

The one or more non-volatile compounds in a Scotch-like alcoholic beverage can include lactic acid. In some embodiments, the lactic acid can be present in an amount of about 1 to about 23 mg/L (e.g., about 1 to about 2 mg/L, about 2 to about 3 mg/L, about 3 to about 5 mg/L, about 1 to about 5 mg/L, about 5 to about 10 mg/L, about 10 to about 15 mg/L, about 15 to about 20 mg/L, or about 20 to about 23 mg/L). In some embodiments, the one or more non-volatile compounds can include no lactic acid.

The one or more non-volatile compounds in a Scotch-like alcoholic beverage can include succinic acid. In some embodiments, the succinic acid can be present in an amount of about 0.1 to about 11 mg/L (e.g., about 0.1 to about 0.2 mg/L, about 0.2 to about 0.3 mg/L, about 0.3 to about 0.5 mg/L, about 0.1 to about 0.5 mg/L, about 0.5 to about 1 mg/L, about 1 to about 2 mg/L, about 2 to about 3 mg/L, about 3 to about 5 mg/L, about 1 to about 5 mg/L, about 5 to about 7 mg/L, about 7 to about 9 mg/L, about 5 to about 10 mg/L, or about 9 to about 11 mg/L). In some embodiments, the one or more non-volatile compounds can include no succinic acid.

The one or more non-volatile compounds in a Scotch-like alcoholic beverage can include citric acid. In some embodiments, the citric acid can be present in an amount of about 0.01 to about 22 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 15 mg/L, about 15 to about 20 mg/L, about 10 to about 20 mg/L, about 20 to about 22 mg/L, or about 15 to about 22 mg/L). In some embodiments, the citric acid can be present in an amount of at least about 6.6 mg/L (e.g., at least about 7.0 mg/L, 7.5 mg/L, 8.0 mg/L, 8.5 mg/L, 9.0 mg/L, 9.5 mg/L, 10 mg/L, 11 mg/L, 12 mg/L, 13 mg/L, 14 mg/L, 15 mg/L, 16 mg/L, 17 mg/L, 18 mg/L, 19 mg/L, or 20 mg/L). In some embodiments, the one or more non-volatile compounds can include no citric acid.

The one or more non-volatile compounds in a Scotch-like alcoholic beverage can include fumaric acid. In some embodiments, the fumaric acid can be present in an amount of about 0.02 to about 22 mg/L (e.g., about 0.02 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 15 mg/L, about 15 to about 20 mg/L, about 10 to about 20 mg/L, about 20 to about 22 mg/L, or about 15 to about 22 mg/L). In some embodiments, the fumaric acid can be present in an amount of at least about 0.64 mg/L (e.g., at least about 0.65 mg/L, 0.7 mg/L, 0.8 mg/L, 0.9 mg/L, 1 mg/L, 2 mg/L, 3 mg/L, 4 mg/L, 5 mg/L, 6 mg/L, 7 mg/L, 8 mg/L, 9 mg/L, 10 mg/L, 12 mg/L, 13 mg/L, 14 mg/L, 15 mg/L, 16 mg/L, 17 mg/L, 18 mg/L, 19 mg/L, or 20 mg/L). In some embodiments, the one or more non-volatile compounds can include no fumaric acid.

The one or more non-volatile compounds in a Scotch-like alcoholic beverage can include pyruvic acid. In some embodiments, the pyruvic acid can be present in an amount of about 0.2 to about 2.6 mg/L (e.g., about 0.2 to about 0.3 mg/L, about 0.3 to about 0.5 mg/L, about 0.5 to about 1.0 mg/L, about 1.0 to about 1.5 mg/L, about 1.5 to about 2.0 mg/L, about 2.0 to about 2.5 mg/L, or about 2.0 to about 2.6 mg/L). In some embodiments, the one or more non-volatile compounds can include no pyruvic acid.

The one or more non-volatile compounds in a Scotch-like alcoholic beverage can include gallic acid. In some embodiments, the gallic acid can be present in an amount of about 0.4 to about 38 mg/L (e.g., about 0.4 to about 1 mg/L, about 0.5 to about 1 mg/L, about 1 to about 2 mg/L, about 2 to about 3 mg/L, about 3 to about 5 mg/L, about 1 to about 5 mg/L, about 5 to about 10 mg/L, about 10 to about 15 mg/L, about 15 to about 20 mg/L, about 20 to about 25 mg/L, about 25 to about 30 mg/L, about 30 to about 35 mg/L, or about 35 to about 38 mg/L). In some embodiments, the one or more non-volatile compounds can include no gallic acid.

The one or more non-volatile compounds in a Scotch-like alcoholic beverage can include 3,4-dihydroxybenzoic acid. In some embodiments, the 3,4-dihydroxybenzoic acid can be present in an amount of about 0.08 to about 1 mg/L (e.g., about 0.08 to about 0.1 mg/L, about 0.1 to about 0.2 mg/L, about 0.2 to about 0.4 mg/L, about 0.4 to about 0.6 mg/L, about 0.6 to about 0.8 mg/L, or about 0.8 to about 1 mg/L). In some embodiments, the one or more non-volatile compounds can include no 3,4-dihydroxybenzoic acid.

The one or more non-volatile compounds in a Scotch-like alcoholic beverage can include 2-furoic acid. In some embodiments, the 2-furoic acid can be present in an amount of about 3 to about 16 mg/L (e.g., about 3 to about 5 mg/L, about 5 to about 10 mg/L, about 4 to about 6 mg/L, about 6 to about 8 mg/L, about 8 to about 10 mg/L, about 10 to about 12 mg/L, about 12 to about 14 mg/L, about 14 to about 16 mg/L, or about 10 to about 15 mg/L). In some embodiments, the one or more non-volatile compounds can include no 2-furoic acid.

The one or more non-volatile compounds in a Scotch-like alcoholic beverage can include 2-isopropylmalic acid. In some embodiments, the 2-isopropylmalic acid can be present in an amount of about 0.04 to about 2.3 mg/L (e.g. about 0.04 to about 0.06 mg/L, about 0.05 to about 0.1 mg/L, about 0.06 to about 0.1 mg/L, about 0.1 to about 0.2 mg/L, about 0.2 to about 0.3 mg/L, about 0.3 to about 0.5 mg/L, about 0.1 to about 0.5 mg/L, about 0.5 to about 1.0 mg/L, about 1.0 to about 1.5 mg/L, about 1.5 to about 2.0 mg/L, or about 2.0 to about 2.3 mg/L). In some embodiments, the one or more non-volatile compounds can include no 2-isopropylmalic acid.

The one or more non-volatile compounds in a Scotch-like alcoholic beverage can include 4-guanidinobutyric acid. In some embodiments, the 4-guanidinobutyric acid can be present in an amount of about 0.025 to about 0.15 mg/L (e.g., about 0.025 to about 0.05 mg/L, about 0.05 to about 0.1 mg/L, about 0.05 to about 0.15 mg/L, or about 0.10 to about 0.15 mg/L). In some embodiments, the one or more non-volatile compounds can include no 4-guanidinobutyric acid.

The one or more non-volatile compounds in a Scotch-like alcoholic beverage can include pipecolinic acid. In some embodiments, the pipecolinic acid can be present in an amount of about 0.07 to about 0.4 mg/L (e.g., about 0.07 to about 0.1 mg/L, about 0.1 to about 0.4 mg/L, about 0.1 to about 0.2 mg/L, or about 0.2 to about 0.4 mg/L). In some embodiments, the one or more non-volatile compounds can include no pipecolinic acid.

The one or more non-volatile compounds in a Scotch-like alcoholic beverage can include uracil. In some embodiments, the uracil can be present in an amount of about 0.06 to about 0.15 mg/L (e.g., about 0.06 to about 0.1 mg/L or about 0.10 to about 0.15 mg/L). In some embodiments, the one or more non-volatile compounds can include no uracil.

The one or more non-volatile compounds in a Scotch-like alcoholic beverage can include pyridine. In some embodiments, the pyridine can be present in an amount of about 0.4 to about 11 mg/L (e.g., about 0.4 to about 1 mg/L, about 0.5 to about 1 mg/L, about 1.2 to about 1.5 mg/L, about 1.5 to about 2 mg/L, about 1 to about 2 mg/L, about 2 to about 3 mg/L, about 3 to about 4 mg/L, about 1 to about 5 mg/L, about 5 to about 10 mg/L, about 5 to about 11 mg/L, about 3 to about 5 mg/L, about 5 to about 7 mg/L, about 7 to about 9 mg/L, or about 9 to about 11 mg/L). In some embodiments, the one or more non-volatile compounds can include no pyridine.

The one or more non-volatile compounds in a Scotch-like alcoholic beverage can include 2,3-dimethylpyrazine. In some embodiments, the 2,3-dimethylpyrazine can be present in an amount of about 0.10 to about 0.30 mg/L (e.g., about 0.10 to about 0.15 mg/L, about 0.15 to about 0.20 mg/L, about 0.20 to about 0.25 mg/L, or about 0.25 to about 0.3 mg/L). In some embodiments, the one or more non-volatile compounds can include no 2,3-dimethylpyrazine.

The one or more non-volatile compounds in a Scotch-like alcoholic beverage can include 2,3,5-trimethylpyrazine. In some embodiments, the 2,3,5-trimethylpyrazine can be present in an amount of about 0.005 to about 0.02 mg/L (e.g., about 0.005 to about 0.01 mg/L or about 0.01 to about 0.02 mg/L). In some embodiments, the one or more non-volatile compounds can include no 2,3,5-trimethylpyrazine.

The one or more non-volatile compounds in a Scotch-like alcoholic beverage can include trans-ferulic acid. In some embodiments, the trans-ferulic acid can be present in an amount of 0.025 to about 2.5 mg/L (e.g., about 0.025 to about 0.05 mg/L, about 0.05 to about 0.1 mg/L, about 0.1 to about 0.2 mg/L, about 0.2 to about 0.3 mg/L, about 0.3 to about 0.4 mg/L, about 0.1 to about 0.5 mg/L, about 0.4 to about 0.5 mg/L, about 0.5 to about 1.0 mg/L, about 1.0 to about 2.0 mg/L, about 1.0 to about 2.5 mg/L, about 0.5 to about 1.5 mg/L, or about 1.5 to about 2.5 mg/L). In some embodiments, the trans-ferulic acid can be present in an amount of less than about 0.5 mg/L (e.g., less than about 0.4 mg/L, 0.3 mg/L, 0.1 mg/L, 0.09 mg/L, 0.07 mg/L, or 0.05 mg/L). In some embodiments, the one or more non-volatile compounds can include no trans-ferulic acid.

The one or more non-volatile compounds in a Scotch-like alcoholic beverage can include gum arabic. In some embodiments, the gum arabic can be present in an amount of about 0.7 to about 1.3 mg/L (e.g., about 0.7 to about 0.9 mg/L, about 0.9 to about 1.1 mg/L, or about 1.1 to about 1.3 mg/L). In some embodiments, the one or more non-volatile compounds can include no gum arabic.

The one or more non-volatile compounds in a Scotch-like alcoholic beverage can include one or more compounds selected from the group consisting of adipic acid, AMP, betaine, camphoric acid, carnosine, catechin, CMP, cysteine, cystine, cytidine, cytosine, epicatechin gallate, epichatechin, glycine, hesperetin, isoleucine, leucine, methyl gallate, methyl-2-pyrrolyl ketone, ornithine, pantothenic acid, piperine, polydatin, propyl gallate, quercetin, resveratrol, rutin, salicylic acid, sinapinic acid, threonine, tryptamine, tryptophan, oak extract, and tannins (e.g., oak tannins, powdered oak tannins).

In some embodiments, the one or more non-volatile compounds in a Scotch-like alcoholic beverage can include one or more compounds (e.g., 2, 3, 4, 5, 6, 7, 8, 9, 10, or more) selected from the group consisting of 4-O-pentopyranosylpentopyranose, Assamicain A, catechin, chlorogenic acid, cinchonain Ia, Cinnamtannin A4, Cinnamtannin B1, cyanidin3-O-rutinoside, D(−)-amygdalin, digallate glycoside, digallic acid, ellagic acid, epicatechin, epicatechin-3-O-gallate, epigallocatechin, epigallocatechin gallate, eriodictyol, exifone, ferulic acid, gallic acid, gossypin, isorhamnetin, Kandelin A2, linoleic acid, luteolin, mulberroside A, naringenin, oleic acid, palmitoleic acid, p-coumaroylquinicacid, pentagalloyl glucose, phloretin, phloridzin, procyanidin A2, procyanidin B2, procyanidin Cl, quercetin, quercetin glycoside, quercetin-3β-D-glucoside, ramnazin-3-O-rutinoside, rutin, syringic acid, tannic acid, tetragalloyl glucose, theasinesin A, tiliroside, trigalloyl glucose, and vanillic acid.

In some cases, the amount of any particular non-volatile compound in a Scotch replica may be different than the amount of that non-volatile compound in a corresponding reference Scotch. In some cases, the amount of a non-volatile compound in a Scotch replica can be 75% or less (e.g., 70% or less, 60% or less, 50% or less, 40% or less, 30% or less, 20% or less, or 10% or less), by concentration or percent mass, than the amount of the same non-volatile compound in a corresponding reference Scotch. In some cases, the amount of a non-volatile compound in a Scotch replica can be 125% or more (e.g., 150% or more, 200% or more, or 300% or more), by concentration or percent mass, than the amount of the same non-volatile compound in a corresponding reference Scotch.

For example, a Scotch-like alcoholic beverage can include one or more of the following: ribose in an amount less than about 6 mg/L (e.g., less than about 5.9 mg/L, 5.8 mg/L, 5.7 mg/L, 5.6 mg/L, 5.5 mg/L, 5.4 mg/L, 5.3 mg/L, 5.2 mg/L, 5.1 mg/L, or 5.0 mg/L); fructose in an amount less than about 9.6 mg/L (e.g., less than about 9.5 mg/L, 9.4 mg/L, 9.3 mg/L, 9.2 mg/L, 9.1 mg/L, 9.0 mg/L, 8.5 mg/L, 8.0 mg/L, 7.5 mg/L, 7.0 mg/L, 6.5 mg/L, 6.0 mg/L, 5.5 mg/L, 5.0 mg/L, 4.5 mg/L, 4.0 mg/L, 3.5 mg/L, 3.0 mg/L, 2.5 mg/L, 2.0 mg/L, or 1.5 mg/L); vanillic acid in an amount less than about 10.3 mg/L (e.g., less than about 10 mg/L, 9 mg/L, 8 mg/L, 7 mg/L, 6 mg/L, 5 mg/L, 4 mg/L, 3 mg/L, 2 mg/L, or 1 mg/L); vanillin in an amount less than about 0.3 mg/L (e.g., less than about 0.2 or 0.1 mg/L); syringaldehyde in an amount less than about 0.55 mg/L (e.g., less than about 0.5 mg/L, 0.4 mg/L, 0.3 mg/L, or 0.2 mg/L); sorbitol in an amount of at least about 5.8 mg/L (e.g., at least about 6 mg/L, 7 mg/L, 8 mg/L, 9 mg/L, 10 mg/L, 11 mg/L, or 12 mg/L); mannitol in an amount of at least about 7.8 mg/L (e.g., at least about 8.0 mg/L, 8.5 mg/L, 9.0 mg/L, 9.5 mg/L, 10.0 mg/L, or 10.5 mg/L); glucose in an amount of at least about 120 mg/L (e.g., at least about 125 mg/L, 150 mg/L, 175 mg/L, 200 mg/L, 225 mg/L, 250 mg/L, 275 mg/L, or 300 mg/L); syringic acid in an amount of at least about 5.4 mg/L (e.g., at least about 5.5 mg/L, 6 mg/L, 7 mg/L, 8 mg/L, 9 mg/L, 10 mg/L, 11 mg/L, 12 mg/L 13 mg/L, 14 mg/L, 15 mg/L, 17 mg/L, 20 mg/L, 22 mg/L, 25 mg/L, 27 mg/L, or 30 mg/L); acetovanillone in an amount of at least about 0.26 mg/L (e.g., at least about 0.27 mg/L, 0.28 mg/L, 0.29 mg/L, 0.30 mg/L, 0.25 mg/L, 0.40 mg/L, 0.45 mg/L, 0.46 mg/L, 0.47 mg/L, 0.48 mg/L, 0.49 mg/L, 0.50 mg/L, or 0.55 mg/L); choline in an amount of at least about 2.8 mg/L (e.g., at least about 3 mg/L, 5 mg/L, 7 mg/L, 9 mg/L, 10 mg/L, 12 mg/L, 14 mg/L, 16 mg/L, or 18 mg/L); glucosamine in an amount of at least about 0.55 mg/L (e.g., at least about 0.6 mg/L, 0.8 mg/L, 1 mg/L, 2 mg/L, 5 mg/L, 10 mg/L, 20 mg/L, 30 mg/L, 40 mg/L, 50 mg/L, 60 mg/L, 70 mg/L, 80 mg/L, or 90 mg/L); citric acid in an amount of at least about 6.6 mg/L (e.g., at least about 7.0 mg/L, 7.5 mg/L, 8.0 mg/L, 8.5 mg/L, 9.0 mg/L, 9.5 mg/L, 10 mg/L, 11 mg/L, 12 mg/L, 13 mg/L, 14 mg/L, 15 mg/L, 16 mg/L, 17 mg/L, 18 mg/L, 19 mg/L, or 20 mg/L); or fumaric acid in an amount of at least about 0.65 mg/L (e.g., at least about 0.7 mg/L, 0.8 mg/L, 0.9 mg/L, 1 mg/L, 2 mg/L, 3 mg/L, 4 mg/L, 5 mg/L, 6 mg/L, 7 mg/L, 8 mg/L, 9 mg/L, 10 mg/L, 11 mg/L, 12 mg/L, 13 mg/L, 14 mg/L, 15 mg/L, 16 mg/L, 17 mg/L, 18 mg/L, 19 mg/L, or 20 mg/L).

In some embodiments, a Scotch replica can further include a kelp extract. In some embodiments, a kelp extract is included in a Scotch replica in an amount of 0.05% to about 0.5% (volume of kelp extract/volume of Scotch replica) (e.g., about 0.05% to about 0.1%, about 0.1% to about 0.2%, about 0.2% to about 0.3%, about 0.3% to about 0.4%, about 0.4% to about 0.5%, about 0.1% to about 0.3%, or about 0.3% to about 0.5% (v/v)).

Because of the methods by which they are made, the Scotch-like alcoholic beverages provided herein typically lack contaminants and other detrimental compounds that sometimes are encountered in traditional wines. These include, without limitation, organisms such as Escherichia coli, Salmonella sp., Brettanomyces sp., Lactobacillales, Saccharomyces sp. (which are often used by distillers and brewers), Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, and Verticillium psalliotae (strains that have been isolated from the corks of corked wine; see, www.ncbi.nlm.nih.gov/pmc/articles/PMC134401/), as well as mold, mildew, rot, insects, insect eggs, insect filth, rodent filth, mammalian excreta, insect lecithins, hydrogen sulfide, hydrogen disulfide, 2,4,6-trichloranisole (which has been linked to a skunked wine smell), 2,4,6-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, and heavy metals.

This document also provides methods for making Scotch replicas. In some embodiments, the methods provided herein are carried out by first mixing one or more organic acids with water, adding ethanol and nonvolatile ingredients, and then adding small quantities of diluted VOCs. In general, water, ethanol, organic acids, additional VOCs, amino acids, and certain texture and flavor modifying ingredients are all used to generate a final product having the characteristics of a traditionally-produced whiskey.

In some embodiments, a method of making a Scotch replica provided herein can include providing an aqueous solution and adding to the aqueous solution ingredients including ethanol, a source of a tannin, a plurality of oak pieces or oak extract, nonvolatile compounds, wherein the nonvolatile compounds comprise a sugar or sugar alcohol and an acid, and additional VOCs, wherein the additional VOCs include an ester, an alcohol, an aldehyde or a ketone or both, and a terpene or an isoprenoid or both.

In some embodiments, a method of making a Scotch replica as provided herein can include combining water one or more acids, one or more sugars, a pH-modifying salt, one or more nucleotide monophosphates, one or more amino acids, ethanol, and five or more (e.g., 10, 20, 30, 40, 50, or more) additional VOCs.

In any of the methods described herein, the additional VOCs that are combined with the other ingredients can a lack, for example, 1 or more (e.g., 2, 3, 4, 5, 6, 7, 8, 9, 10, 11 or 12) of the additional VOCs in Group H1, 1 or more (e.g., 2, 3, 4, 5, 6, 7, 8, 9, 10, 15, 20, 30, 40, or 50) of the VOCs in Group I1, and 1 or more (e.g., 2 or 3) of the VOCs in Group J1. In some embodiments of the methods described herein, for example, a Scotch replica can lack one or more (e.g., 2, 3, 4, 5, 6, 7, 8, 9, 10, 11, or 12) of the VOCs in Group H1. In some embodiments of the methods described herein, for example, a Scotch replica can lack one or more (e.g., 2, 3, 4, 5, 6, 7, 8, 9, 10, 15, 20, 30, 40, or 50) of the additional VOCs in Group I1. In some embodiments of the methods described herein, for example, a Scotch replica can lack one or more (e.g., 2 or 3) of the VOCs in Group J1.

In any of the methods described herein, the additional VOCs that are combined with the other ingredients can lack, for example 1 or more (e.g., 2, 3, 4, 5, 6, 7, or 8) of the additional VOCs in Group H2, optionally 1 or more (e.g., 2, or 3) of the VOCs in Group I2, and 1 or more (e.g., 2, 3, 4, 5, 6, or 7) of the VOCs in Group J2. In some embodiments of the methods described herein, a Scotch replica can lack one or more (e.g., 2, 3, 4, 5, 6, 7, or 8) of the VOCs in Group H2. In some embodiments of the methods described herein, a Scotch replica can lack one or more (e.g., 2 or 3) of the additional VOCs in Group I2. In some embodiments of the methods described herein, a Scotch replica can lack one or more (e.g., 2, 3, 4, 5, 6, or 7) of the VOCs in Group J2.

In any of the methods described herein, the additional VOCs that are combined with the other ingredients can be selected from the group consisting of: one or more additional VOCs from Group A, one or more additional VOCs from Group B, one or more additional VOCs from Group C, one or more additional VOCs from Group D, and mixtures thereof. In any of the methods described herein, the additional VOCs can be selected from the group consisting of: one or more additional VOCs from Group E, one or more additional VOCs from group F, one or more additional VOCs from Group G, and mixtures thereof. In some embodiments of the methods described herein, the additional VOCs can include, for example, 30 or more (e.g., 31, 32, 33, 34, 35, 36, 37, 38, 39, 40, 41, 42, 43, 44, 45, or more) of the additional VOCs in Group A, optionally 1 or more (e.g., 2, 3, 4, or 5) of the VOCs in Group B, optionally 1 or more (e.g., 2, 3, 4, 5, 6, 7, 8, 9, or 10) of the VOCs in Group C, and optionally 1 or more (e.g., 2, 3, 4, 5, 6, 7, 8, 9, 10, or more) of the VOCs in Group D.

In any of the methods described herein, the additional VOCs that are combined with the other ingredients can be selected from the group consisting of Group P compounds. In any of the methods described herein, the additional VOCs that are combined with the other ingredients can be selected from the group consisting of Group Q compounds. In any of the methods described herein, the additional VOCs that are combined with the other ingredients can be selected from the group consisting of Group R compounds. In any of the methods described herein, the additional VOCs that are combined with the other ingredients can be selected from the group consisting of 1,1-diethoxyethane, 1-decanol, 1-octanol, 1-octen-3-ol, 2,3-pentadione, 2-heptanone, 2-isopropyl-3-methoxypyrazine, 2-methoxy-4-propylphenol, 2-methyl-1-butanol, 2-methylbutyl acetate, 2-methylbutyl isovalerate, 2-methylbutyraldehyde, 2-nonanol, 2-nonanone, 2-phenylethanol, 2-phenylethylacetate, 2-undecanone, 3,7-dimethyl-6-octenoic acid, 3-carene, 4-carvomenthenol, 4-ethyl guaiacol, 4-ethyl phenol, acetaldehyde, acetoin, acetophenone, alpha ionone, amyl alcohol, amyl butyrate, a-phellandrene, (−)a-pinene, a-terpineol, benzaldehyde, benzyl acetate, beta-ionone, (−)beta-pinene, butanol, butyl acetate, butyl alcohol, butyl formate, butyl isovalerate, butyric acid, carvone, cinnamaldehyde, cis-3-hexen-1-ol, cis-3-hexenyl acetate, (−)cis-rose oxide, citronellol, damascenone, decanoic acid, delta-decalactone, diethyl malate, diethyl succinate, dimethylsulfide, ethyl 3-hydroxyhexanoate, ethyl acetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl trans-2-butenoate, ethyl trans-3-hexenoate, ethyl undecanoate, ethyl valerate, ethyl(methylthio) acetate, ethyl-2-methylbutyrate, eucalyptol, eugenol, farnesol, furfural, gamma-decalactone, gamma-nonalactone, gamma-terpinene, geraniol, geranyl acetone, guaiacol, heptyl acetate, hexanol, isoamyl acetate, isoamyl alcohol, isoamyl hexanoate, isoamyl isobutyrate, isoamyl isovalerate, isoamyl octanoate, isobutanol, isobutyl acetate, isobutyl isobutyrate, isobutyraldehyde, isobutyric acid, isovaleraldehyde, limonene, linalool, linalool oxide, linalyl acetate, maltol, methional, methyl acetate, methyl decanoate, methyl hexanoate, methyl laurate, methyl octanoate, methyl salicylate, myrcene, myrtenol, nonanal, octanoic acid, p-anisaldehyde, p-cresol, p-cymene, phenethyl butyrate, phenethyl formate, phenethyl octanoate, phenethyl propionate, propanol, propionaldehyde, propyl acetate, salicylaldehyde, trans-2-hexen-1-al, valeraldehyde, vanillyl ethyl ether, whiskey lactone, butyraldehyde, propionic acid, isovaleric acid, valeric acid, hexanoic acid, and nonanoic acid.

In some embodiments of any of the methods described herein, the nonvolatile compounds can include at least one compound selected from the group consisting of adipic acid, camphoric_acid, carnosine, catechin, cysteine, cystine, epicatechin_gallate, epichatechin, hesperetin, isoleucine, ornithine, pantothenic_acid, piperine, polydatin, quercetin, resveratrol, sinapinic acid, tryptophan, valine, and xylose, and mixtures thereof. In any of the methods described herein, the nonvolatile compounds can lack a nonvolatile compound selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, d-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.

In any of the methods described herein, the nonvolatile compounds can be selected from the group consisting of: one or more compounds from Group K, one or more compounds from Group L, and mixtures thereof. In any of the methods described herein the nonvolatile compounds can include, for example, at least three (e.g., at least five, at least eight, or at least ten) of the compounds of Group K, in combination with at least one (e.g., at least two, at least three, at least five, or at least ten) of the compounds of Group L. For example, in some embodiments of the methods described herein, the nonvolatile compounds can include all of the non-volatile compounds from Group K and one non-volatile compound from Group L.

In some embodiments of any of the methods herein, the nonvolatile compounds in a Scotch replica can further include a kelp extract. In some embodiments, a kelp extract is included in a Scotch replica in an amount of 0.05% to about 0.5% (volume of kelp extract/volume of Scotch replica) (e.g., about 0.05% to about 0.1%, about 0.1% to about 0.2%, about 0.2% to about 0.3%, about 0.3% to about 0.4%, about 0.4% to about 0.5%, about 0.1% to about 0.3%, or about 0.3% to about 0.5% (v/v)).

This document also provides methods for making a kelp extract. Without being bound by any theory, it is believed that kelp (e.g., kombu kelp, Saccharina japonica) can provide a smoky flavor to a Scotch replica (e.g., replicating peaty Scotch whiskeys, from, for example, Islay Island). Again, without being bound by any theory, it is believed that sulfur- and/or bromine-containing compounds (e.g., bromophenols) contribute to this flavor from kelp. In some embodiments, a method of making a kelp extract can include combining a plurality of kelp pieces with ethanol, incubating the plurality of kelp pieces and ethanol for a period of time (e.g., about 30 minutes to about 1 hour, about 1 hour to about 2 hours, about 1 hour to about 3 hours, about 3 hours to about 5 hours, about 5 hours to about 10 hours, about 1 hour to about 12 hours, or about 12 hours to about 24 hours) to make a kelp extract mixture, and removing solids from the kelp extract mixture to make a kelp extract. In some embodiments, the kelp can be kombu kelp. In some embodiments, the kelp pieces are wet. In some embodiments, the kelp pieces (when wet or dry) are combined with ethanol in a ratio of about 5% to about 70% (e.g., about 5% to about 10%, about 10% to about 20%, about 20% to about 30%, about 30% to about 40%, about 40% to about 50%, about 50% to about 60%, about 60% to about 70%, about 5% to about 15%, about 15% to about 25%, about 25% to about 35%, about 35% to about 45%, about 45% to about 55%, or about 55% to about 65%) mass-to-volume ratio. In some embodiments, the incubating step can include shaking, mixing, rotating, or stirring. In some embodiments, the removing step can include gravity settling, filtration, and/or centrifugation.

This document also provides methods for making oak extract. Without being bound by any theory, it is believed that oak (e.g., American oak) can provide a flavor replicating the process of aging a liquor in oak barrels. In some embodiments, a method of making an oak extract can include combining a plurality of oak pieces with ethanol, incubating the plurality of oak pieces and ethanol for a period of time (e.g., about 1 hour to about 6 hours, about 6 hours to about 12 hours, about 1 hour to about 12 hours, about 12 hours to about 1 day, about 12 hours to about 2 days, about 1 day to about 2 days, about 2 days to about 3 days, about 3 days to about 4 days, or about 4 days to about 5 days) to make an oak extract mixture, and removing solids from the oak extract mixture to make an oak extract. In some embodiments, the oak pieces can be ground oak, oak chips, or oak chunks. In some embodiments, the plurality of oak pieces can be combined with ethanol in an about 0.05% to about 25% (e.g., about 0.05% to about 0.1%, about 0.1% to about 0.5%, about 0.5% to about 1%, about 1% to about 2%, about 2% to about 4%, about 4% to about 6%, about 6% to about 8%, about 8% to about 10%, about 1% to about 5%, about 5% to about 10%, about 10% to about 15%, about 15% to about 20%, or about 20% to about 25%) mass-to-volume ratio. In some embodiments, the incubating step can include shaking, mixing, rotating, or stirring. In some embodiments, the incubation step can take place in the dark. In some embodiments, the removing step can include gravity settling, filtration, and/or centrifugation.

This document also provides methods for generating concentrated versions of any Scotch-like alcoholic beverage, where the concentrated versions include all of the additional VOCs and non-volatile components of the final product, but without the bulk of the ethanol and water. Such concentrates can be manufactured and then shipped to a second location, where water and ethanol can be added at the appropriate ABV and volume to create a finished product.

Any suitable concentration of additional VOCs and non-volatile compounds can be used. For example, a concentrated Scotch-like alcoholic beverage can include additional VOCs and non-volatile components in a concentration of at least 1.1-fold (e.g., 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold concentrations, as compared to their concentrations in the final product, such that they can be diluted by at least about 1.1-fold (e.g., 1.2-fold, 1.3-fold, 1.5-fold, 1.6-fold, 1.7-fold, 1.8-fold, 1.9-fold, 2-fold, 5-fold, 8-fold, 10-fold, 15-fold, or 20-fold), respectively, with water and ethanol to yield the final product. The concentrates provided herein can contain all of the formulaic flavor, acid, and other components (as well as any grain neutral spirits) that are present in the final product. In general, such concentrates can be prepared in much the same way as a non-concentrated Scotch-like alcoholic beverage, by combining the desired amounts of additional VOCs and non-volatile components but omitting the water and the bulk of the ethanol. It is noted that in some cases, some amount of ethanol can be included in the concentrate in order to facilitate dissolution of the additional VOCs and non-volatile compounds.

Any of the Scotch-like alcoholic beverages described herein can be made as a concentrate, e.g., using the methods disclosed herein. It will be appreciated that the amount of any component (e.g., additional VOC or non-volatile) disclosed herein as an amount for an alcoholic beverage replica (e.g., a 1× alcoholic beverage replica) can be multiplied by the concentration factor (e.g., 1.1-fold, 1.2-fold, 1.3-fold, 1.5-fold, 1.6-fold, 1.7-fold, 1.8-fold, 1.9-fold 2-fold, 3-fold, 5-fold, 8-fold, 10-fold, 15-fold, or 20-fold) for the appropriate concentrated amount.

### EXEMPLARY EMBODIMENTS

Embodiment 1 is a Scotch-like alcoholic beverage comprising:

ethanol;

water; and

one or more additional volatile organic compounds (VOCs),

wherein the one or more additional VOCs comprise at least one compound selected from the group consisting of (1R)-(−)-myrtenal, 3-ethyl-2-hydroxy-2-cyclopenten-1-one (ethyl cyclopentenolone), 1,4-cineole, 2-acetyl-1-methylpyrrole, 2-isopropyl-4-methyl thiazole, 3-methylthio hexyl acetate, 3-phenylpropanal, 4,5,6,7-tetrahydro-3,6-dimethylbenzofuran, 4-mercapto-4-methyl-2-pentanone, acetoin, allyl heptanoate, amyl butyrate, anisyl acetate, anisyl butyrate, b-caryophellene, benzyl alcohol, benzyl butyrate, benzyl formate, beta-pinene, butyl butyryllactate, butyl formate, butyraldehyde, cis-3-hexenyl butyrate, cis-3-hexenyl valerate, cis-6-nonen-1-ol, citronellal, D-carvone, d-fenchone, DL-3-methyl-2-butanol, ethyl 2-trans-4-cis-decadienoate, ethyl trans-3-hexenoate, ethyl(methylthio) acetate, eucalyptol, furufyl thioacetate, gamma-hexalactone, gamma-valerolactone, hexyl 3-methylbutanoate, hexyl isobutyrate, IBMP (3-Isobutyl-2-methoxypyrazine), L-menthyl acetate, maltol, methionyl acetate (3-methylthio-propylacetate), methyl anthranilate, methyl cyclopentenolone, myrcene, nonanoic acid, p-anisaldehyde, perillaldehyde, phenylacetaldehyde dimethyl acetal, propionaldehyde, propyl butyrate, tetrahydrolinalool, trans-2-hexen-1-al, valeraldehyde, valeric acid, vanillyl butyl ether.

Embodiment 2 is the Scotch-like alcoholic beverage of embodiment 1, wherein the one or more additional VOCs comprise at least one compound selected from the group consisting of acetoin, amyl butyrate, beta-pinene, butyl formate, butyraldehyde, maltol, myrcene, nonanoic acid, p-anisaldehyde, propionaldehyde, trans-2-hexen-1-al, valeraldehyde, valeric acid, and combinations thereof.
Embodiment 3 is the Scotch-like alcoholic beverage of embodiment 1 or embodiment 2, wherein the one or more additional VOCs comprise at least one compound selected from the group consisting of acetoin, beta-pinene, butyl formate, maltol, myrcene, trans-2-hexen-1-al, valeraldehyde, and combinations thereof.
Embodiment 4 is the Scotch-like alcoholic beverage of any one of embodiments 1-3, wherein the one or more additional VOCs do not comprise at least one compound selected from the group consisting 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone.
Embodiment 5 is the Scotch-like alcoholic beverage of embodiment 4, wherein the one or more additional VOCs do not comprise at least one compound selected from the group consisting of 2-methoxy-4-methylphenol, 2-methylbutyl acetate, cis-3-hexen-1-ol, decanoic acid, delta-dodecalactone, ethyl salicylate, gamma-dodecalactone, gamma-octalactone, geranyl acetone, hexanoic acid, hexyl acetate, isoamyl isobutyrate, isobutyric acid, methyl decanoate, methyl laurate, myrtenol, octanoic acid, phenethyl octanoate, and propionic acid.
Embodiment 6 is the Scotch-like alcoholic beverage of embodiment 4 or embodiment 5, wherein the one or more additional VOCs do not comprise at least one compound selected from the group consisting of 2-methoxy-4-methylphenol, cis-3-hexen-1-ol, delta-dodecalactone, ethyl salicylate, gamma-dodecalactone, gamma-octalactone, geranyl acetone, hexyl acetate, isoamyl isobutyrate, myrtenol, and phenethyl octanoate.
Embodiment 7 is the Scotch-like alcoholic beverage of any one of embodiments 4-6, wherein the one or more additional VOCs do not comprise at least one compound selected from the group consisting of 2-methoxy-4-methylphenol, cis-3-hexen-1-ol, delta-dodecalactone, ethyl salicylate, gamma-dodecalactone, gamma-octalactone, hexyl acetate, and isoamyl isobutyrate.
Embodiment 8 is the Scotch-like alcoholic beverage of any one of embodiments 1-7, wherein the one or more additional VOCs are present in a total amount of less than about 650 mg/L.
Embodiment 9 is a Scotch-like alcoholic beverage comprising:

ethanol;

water; and

one or more additional VOCs, wherein the one or more additional VOCs do not comprise at least one compound selected from the group consisting of 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone.

Embodiment 10 is the Scotch-like alcoholic beverage of embodiment 4, wherein the one or more additional VOCs are present in a total amount of less than about 650 mg/L.
Embodiment 11 is a Scotch-like alcoholic beverage comprising:

ethanol;

water; and

one or more additional VOCs, wherein the one or more additional VOCs are present in a total amount of less than about 650 mg/L.

Embodiment 12 is the Scotch-like alcoholic beverage of any one of embodiments 1 to 11, wherein the one or more additional VOCs comprise one or more of butyl formate, ethyl octanoate, ethyl propionate, ethyl-2-methylbutyrate, isoamyl acetate, isoamyl alcohol, and isobutanol.
Embodiment 13 is the Scotch-like alcoholic beverage of any one of embodiments 1 to 11, wherein the one or more additional VOCs comprise two or more of butyl formate, ethyl octanoate, ethyl propionate, ethyl-2-methylbutyrate, isoamyl acetate, isoamyl alcohol, and isobutanol.
Embodiment 14 is the Scotch-like alcoholic beverage of any one of embodiments 1 to 11, wherein the one or more additional VOCs comprise three or more of butyl formate, ethyl octanoate, ethyl propionate, ethyl-2-methylbutyrate, isoamyl acetate, isoamyl alcohol, and isobutanol.
Embodiment 15 is the Scotch-like alcoholic beverage of any one of embodiments 1 to 11, wherein the one or more additional VOCs comprise four or more of butyl formate, ethyl octanoate, ethyl propionate, ethyl-2-methylbutyrate, isoamyl acetate, isoamyl alcohol, and isobutanol.
Embodiment 16 is the Scotch-like alcoholic beverage of any one of embodiments 1 to 11, wherein the one or more additional VOCs comprise five or more of butyl formate, ethyl octanoate, ethyl propionate, ethyl-2-methylbutyrate, isoamyl acetate, isoamyl alcohol, and isobutanol.
Embodiment 17 is the Scotch-like alcoholic beverage of any one of embodiments 1 to 11, wherein the one or more additional VOCs comprise six or more of butyl formate, ethyl octanoate, ethyl propionate, ethyl-2-methylbutyrate, isoamyl acetate, isoamyl alcohol, and isobutanol.
Embodiment 18 is the Scotch-like alcoholic beverage of any one of embodiments 1 to 11, wherein the one or more additional VOCs comprise butyl formate, ethyl octanoate, ethyl propionate, ethyl-2-methylbutyrate, isoamyl acetate, isoamyl alcohol, and isobutanol.
Embodiment 19 is the Scotch-like alcoholic beverage of any one of embodiments 1 to 11, wherein the one or more additional VOCs comprise no more than six of butyl formate, ethyl octanoate, ethyl propionate, ethyl-2-methylbutyrate, isoamyl acetate, isoamyl alcohol, and isobutanol.
Embodiment 20 is the Scotch-like alcoholic beverage of any one of embodiments 1 to 19, wherein 1-decanol is present in an amount of less than about 0.065 mg/L.
Embodiment 21 is the Scotch-like alcoholic beverage of any one of embodiments 1 to 20, wherein 2,3-pentadione is present in an amount of at least about 0.0015 mg/L.
Embodiment 22 is the Scotch-like alcoholic beverage of any one of embodiments 1 to 21, wherein 2-methyl-1-butanol is present in an amount of less than about 75 mg/L or in an amount of at least about 635 mg/L.
Embodiment 23 is the Scotch-like alcoholic beverage of any one of embodiments 1 to 22, wherein 2-methylbutyl acetate is present in an amount of less than about 0.08 mg/L.
Embodiment 24 is the Scotch-like alcoholic beverage of any one of embodiments 1 to 23, wherein 2-methylbutyraldehyde is present in an amount of less than about 0.012 mg/L.
Embodiment 25 is the Scotch-like alcoholic beverage of any one of embodiments 1 to 24, wherein 4-ethyl phenol is present in an amount of at least about 1.7 mg/L.
Embodiment 26 is the Scotch-like alcoholic beverage of any one of embodiments 1 to 25, wherein amyl alcohol is present in an amount of at least about 0.03 mg/L.
Embodiment 27 is the Scotch-like alcoholic beverage of any one of embodiments 1 to 26, wherein benzaldehyde is present in an amount of less than about 0.003 mg/L.
Embodiment 28 is the Scotch-like alcoholic beverage of any one of embodiments 1 to 27, wherein beta-ionone is present in an amount of at least about 0.004 mg/L.
Embodiment 29 is the Scotch-like alcoholic beverage of any one of embodiments 1 to 28, wherein butyl acetate is present in an amount of at least about 0.98 mg/L.
Embodiment 30 is the Scotch-like alcoholic beverage of any one of embodiments 1 to 29, wherein butyric acid is present in an amount of at least about 2 mg/L.
Embodiment 31 is the Scotch-like alcoholic beverage of any one of embodiments 1 to 30, wherein carvone is present in an amount of at least about 0.0023 mg/L.
Embodiment 32 is the Scotch-like alcoholic beverage of any one of embodiments 1 to 31, wherein cinnamaldehyde is present in an amount of at least about 0.04 mg/L.
Embodiment 33 is the Scotch-like alcoholic beverage of any one of embodiments 1 to 32, wherein citronellol is present in an amount of less than about 0.0002 mg/L.
Embodiment 34 is the Scotch-like alcoholic beverage of any one of embodiments 1 to 33, wherein damascenone is present in an amount of at least about 0.14 mg/L.
Embodiment 35 is the Scotch-like alcoholic beverage of any one of embodiments 1 to 34, wherein decanoic acid is present in an amount of less than about 1.7 mg/L.
Embodiment 36 is the Scotch-like alcoholic beverage of any one of embodiments 1 to 35, wherein delta-decalactone is present in an amount of less than about 0.013 mg/L or at least about 0.27 mg/L.
Embodiment 37 is the Scotch-like alcoholic beverage of any one of embodiments 1 to 36, wherein diethyl succinate is present in an amount of less than 0.3 mg/L.
Embodiment 38 is the Scotch-like alcoholic beverage of any one of embodiments 1 to 37, wherein ethyl acetate is present in an amount of less than about 42 mg/L or in an amount of at least about 780 mg/L.
Embodiment 39 is the Scotch-like alcoholic beverage of any one of embodiments 1 to 38, wherein ethyl butanoate is present in an amount of less than about 0.14 mg/L.
Embodiment 40 is the Scotch-like alcoholic beverage of any one of embodiments 1 to 39, wherein ethyl cinnamate is present in an amount of less than about 0.00035 mg/L.
Embodiment 41 is the Scotch-like alcoholic beverage of any one of embodiments 1 to 40, wherein ethyl heptanoate is present in an amount of less than 0.005 mg/L.
Embodiment 42 is the Scotch-like alcoholic beverage of any one of embodiments 1 to 41, wherein ethyl isobutyrate is present in an amount of at least about 5.5 mg/L.
Embodiment 43 is the Scotch-like alcoholic beverage of any one of embodiments 1 to 42, wherein ethyl isovalerate is present in an amount of less than about 0.06 mg/L.
Embodiment 44 is the Scotch-like alcoholic beverage of any one of embodiments 1 to 43, wherein ethyl nonanoate is present in an amount of less than 0.0075 mg/L.
Embodiment 45 is the Scotch-like alcoholic beverage of any one of embodiments 1 to 44, wherein ethyl octanoate is present in an amount of less than about 0.85 mg/L.
Embodiment 46 is the Scotch-like alcoholic beverage of any one of embodiments 1 to 45, wherein ethyl propionate is present in an amount of less than about 0.34 mg/L.
Embodiment 47 is the Scotch-like alcoholic beverage of any one of embodiments 1 to 46, wherein ethyl decanoate is present in an amount of less than about 0.007 mg/L or at least about 0.12 mg/L.
Embodiment 48 is the Scotch-like alcoholic beverage of any one of embodiments 1 to 47, wherein ethyl valerate is present in an amount of less than about 0.0045 mg/L.
Embodiment 49 is the Scotch-like alcoholic beverage of any one of embodiments 1 to 48, wherein furfural is present in an amount of less than 0.7 mg/L.
Embodiment 50 is the Scotch-like alcoholic beverage of any one of embodiments 1 to 49, wherein gamma-decalactone is present in an amount of at least about 0.4 mg/L.
Embodiment 51 is the Scotch-like alcoholic beverage of any one of embodiments 1 to 50, wherein gamma-terpinene is present in an amount of at least about 0.0013 mg/L.
Embodiment 52 is the Scotch-like alcoholic beverage of any one of embodiments 1 to 51, wherein hexanol is present in an amount of less than about 0.014 mg/L.
Embodiment 53 is the Scotch-like alcoholic beverage of any one of embodiments 1 to 52, wherein isoamyl acetate is present in an amount of less than about 0.18 mg/L.
Embodiment 54 is the Scotch-like alcoholic beverage of any one of embodiments 1 to 53, wherein isoamyl alcohol is present in an amount of less than about 38 mg/L.
Embodiment 55 is the Scotch-like alcoholic beverage of any one of embodiments 1 to 54, wherein isoamyl octanoate is present in an amount of less than 0.0005 mg/L.
Embodiment 56 is the Scotch-like alcoholic beverage of any one of embodiments 1 to 55, wherein isobutyl acetate is present in an amount of less than about 0.03 mg/L.
Embodiment 57 is the Scotch-like alcoholic beverage of any one of embodiments 1 to 56, wherein limonene is present in an amount of at least about 0.01 mg/L.
Embodiment 58 is the Scotch-like alcoholic beverage of any one of embodiments 1 to 57, wherein linalyl acetate is present in an amount of at least about 0.03 mg/L.
Embodiment 59 is the Scotch-like alcoholic beverage of any one of embodiments 1 to 58 wherein methyl decanoate is present in an amount of less than about 0.0004 mg/L.
Embodiment 60 is the Scotch-like alcoholic beverage of any one of embodiments 1 to 59, wherein methyl hexanoate is present in an amount of at least about 0.002 mg/L.
Embodiment 61 is the Scotch-like alcoholic beverage of any one of embodiments 1 to 60, wherein myrtenol is present in an amount of less than 0.085 mg/L.
Embodiment 62 is the Scotch-like alcoholic beverage of any one of embodiments 1 to 61, wherein octanoic acid is present in amount of less than about 2.5 mg/L.
Embodiment 63 is the Scotch-like alcoholic beverage of any one of embodiments 1 to 62, wherein p-cresol is present in an amount of less than 0.009 mg/L.
Embodiment 64 is the Scotch-like alcoholic beverage of any one of embodiments 1 to 63, wherein phenethyl butyrate is present in an amount of less than about 0.0003 mg/L.
Embodiment 65 is the Scotch-like alcoholic beverage of any one of embodiments 1 to 64, wherein phenethyl octanoate is present in an amount of less than about 0.0006 mg/L.
Embodiment 66 is the Scotch-like alcoholic beverage of any one of embodiments 1 to 65, wherein propanol is present in an amount of less than 100 mg/L.
Embodiment 67 is the Scotch-like alcoholic beverage of any one of embodiments 1 to 66, wherein ethyl benzoate is present in an amount of less than about 0.0045 mg/L.
Embodiment 68 is the Scotch-like alcoholic beverage of any one of embodiments 1 to 67, wherein gamma-nonalactone is present in an amount of less than about 0.0065 mg/L.
Embodiment 69 is the Scotch-like alcoholic beverage of any one of embodiments 1 to 68, wherein geraniol is present in an amount of at least about 0.04 mg/L.
Embodiment 70 is the Scotch-like alcoholic beverage of any one of embodiments 1 to 69, wherein isobutyraldehyde is present in an amount of at least about 4.4 mg/L.
Embodiment 71 is the Scotch-like alcoholic beverage of any one of embodiments 1 to 70 wherein isoamyl isovalerate is present in an amount of at least about 0.002 mg/L.
Embodiment 72 is the Scotch-like alcoholic beverage of any one of embodiments 1 to 71, wherein propionic acid is present in an amount of less than about 0.38 mg/L.
Embodiment 73 is the Scotch-like alcoholic beverage of any one of embodiments 1 to 72, wherein hexanoic acid is present in an amount of less than about 3.6 mg/L.
Embodiment 74 is the Scotch-like alcoholic beverage of any one of embodiments 1 to 73, wherein less than about 0.000065% by mass of the one or more additional VOCs is methyl decanoate or at least about 0.004% by mass of the one or more additional VOCs is methyl decanoate octanoate.
Embodiment 75 is the Scotch-like alcoholic beverage of any one of embodiments 1 to 74, wherein less than about 0.001% by mass of the one or more additional VOCs is 1-decanol.
Embodiment 76 is the Scotch-like alcoholic beverage of any one of embodiments 1 to 75, wherein less than about 0.0002% by mass of the one or more additional VOCs is 2-methylbutyraldehyde.
Embodiment 77 is the Scotch-like alcoholic beverage of any one of embodiments 1 to 76, wherein less than about 0.26% by mass of the one or more additional VOCs is decanoic acid.
Embodiment 78 is the Scotch-like alcoholic beverage of any one of embodiments 1 to 77, wherein less than about 0.00007% by mass of the one or more additional VOCs is ethyl valerate.
Embodiment 79 is the Scotch-like alcoholic beverage of any one of embodiments 1 to 78, wherein less than about 0.85% by mass of the one or more additional VOCs is isoamyl alcohol.
Embodiment 80 is the Scotch-like alcoholic beverage of any one of embodiments 1 to 79, wherein less than about 0.0013% by mass of the one or more additional VOCs is myrtenol.
Embodiment 81 is the Scotch-like alcoholic beverage of any one of embodiments 1 to 80, wherein less than about 0.0000045% by mass of the one or more additional VOCs is phenethyl butyrate.
Embodiment 82 is the Scotch-like alcoholic beverage of any one of embodiments 1 to 81, wherein at least about 0.6% by mass of the one or more additional VOCs is 1,1-diethoxyethane.
Embodiment 83 is the Scotch-like alcoholic beverage of any one of embodiments 1 to 82, wherein at least about 0.0002% by mass of the one or more additional VOCs is 2,3-pentadione.
Embodiment 84 is the Scotch-like alcoholic beverage of any one of embodiments 1 to 83, wherein at least about 75% by mass of the one or more additional VOCs is 2-methyl-1-butanol.
Embodiment 85 is the Scotch-like alcoholic beverage of any one of embodiments 1 to 84, wherein at least about 0.00035% by mass of the one or more additional VOCs is 4-carvomenthenol.
Embodiment 86 is the Scotch-like alcoholic beverage of any one of embodiments 1 to 85, wherein at least about 0.25% by mass of the one or more additional VOCs is 4-ethyl phenol.
Embodiment 87 is the Scotch-like alcoholic beverage of any one of embodiments 1 to 86, wherein at least about 0.0046% by mass of the one or more additional VOCs is amyl alcohol.
Embodiment 88 is the Scotch-like alcoholic beverage of any one of embodiments 1 to 87, wherein at least about 0.055% by mass of the one or more additional VOCs is a-terpineol.
Embodiment 89 is the Scotch-like alcoholic beverage of any one of embodiments 1 to 88, wherein at least about 0.00065% by mass of the one or more additional VOCs is benzyl acetate.
Embodiment 90 is the Scotch-like alcoholic beverage of any one of embodiments 1 to 89, wherein at least about 0.00055% by mass of the one or more additional VOCs is beta-ionone.
Embodiment 91 is the Scotch-like alcoholic beverage of any one of embodiments 1 to 90, wherein at least about 4.9% by mass of the one or more additional VOCs is butanol.
Embodiment 92 is the Scotch-like alcoholic beverage of any one of embodiments 1 to 91, wherein at least about 0.14% by mass of the one or more additional VOCs is butyl acetate.
Embodiment 93 is the Scotch-like alcoholic beverage of any one of embodiments 1 to 92, wherein at least about 0.00035% by mass of the one or more additional VOCs is carvone.
Embodiment 94 is the Scotch-like alcoholic beverage of any one of embodiments 1 to 93, wherein at least about 0.006% by mass of the one or more additional VOCs is cinnamaldehyde.
Embodiment 95 is the Scotch-like alcoholic beverage of any one of embodiments 1 to 94, wherein at least about 0.4% by mass of the one or more additional VOCs is citronellol.
Embodiment 96 is the Scotch-like alcoholic beverage of any one of embodiments 1 to 95, wherein at least about 0.02% by mass of the one or more additional VOCs is damascenone.
Embodiment 97 is the Scotch-like alcoholic beverage of any one of embodiments 1 to 96, wherein at least about 78% by mass of the one or more additional VOCs is ethyl acetate.
Embodiment 98 is the Scotch-like alcoholic beverage of any one of embodiments 1 to 97, wherein at least bout 0.0035% by mass of the one or more additional VOCs is ethyl cinnamate.
Embodiment 99 is the Scotch-like alcoholic beverage of any one of embodiments 1 to 98, wherein at least about 0.78% by mass of the one or more additional VOCs is ethyl isobutyrate.
Embodiment 100 is the Scotch-like alcoholic beverage of any one of embodiments 1 to 99, wherein at least about 19% by mass of the one or more additional VOCs is ethyl lactate.
Embodiment 101 is the Scotch-like alcoholic beverage of any one of embodiments 1 to 100, wherein at least about 0.017% by mass of the one or more additional VOCs is ethyl undecanoate.
Embodiment 102 is the Scotch-like alcoholic beverage of any one of embodiments 1 to 101, wherein least about 4.5% by mass of the one or more additional VOCs is furfural.
Embodiment 103 is the Scotch-like alcoholic beverage of any one of embodiments 1 to 102, wherein least about 0.06% by mass of the one or more additional VOCs is gamma-decalactone.
Embodiment 104 is the Scotch-like alcoholic beverage of any one of embodiments 1 to 103, wherein at least about 0.0002% by mass of the one or more additional VOCs is gamma-terpinene.
Embodiment 105 is the Scotch-like alcoholic beverage of any one of embodiments 1 to 104, wherein at least about 1% by mass of the one or more additional VOCs is guaiacol.
Embodiment 106 is the Scotch-like alcoholic beverage of any one of embodiments 1 to 105, wherein at least about 0.014% by mass of the one or more additional VOCs is isoamyl hexanoate.
Embodiment 107 is the Scotch-like alcoholic beverage of any one of embodiments 1 to 106, wherein at least about 1.1% by mass of the one or more additional VOCs is isobutyric acid.
Embodiment 108 is the Scotch-like alcoholic beverage of any one of embodiments 1 to 107, wherein at least about 0.13% by mass of the one or more additional VOCs is isovaleraldehyde.
Embodiment 109 is the Scotch-like alcoholic beverage of any one of embodiments 1 to 108, wherein at least about 0.0015% by mass of the one or more additional VOCs is limonene.
Embodiment 110 is the Scotch-like alcoholic beverage of any one of embodiments 1 to 109, wherein at least about 0.004% by mass of the one or more additional VOCs is linalyl acetate.
Embodiment 111 is the Scotch-like alcoholic beverage of any one of embodiments 1 to 110, wherein at least about 0.0003% by mass of the one or more additional VOCs is methyl hexanoate.
Embodiment 112 is the Scotch-like alcoholic beverage of any one of embodiments 1 to 111, wherein at least about 0.0025% by mass of the one or more additional VOCs is methyl laurate.
Embodiment 113 is the Scotch-like alcoholic beverage of any one of embodiments 1 to 112, wherein at least about 0.003% by mass of the one or more additional VOCs is ethyl 3-hydroxyhexanoate.
Embodiment 114 is the Scotch-like alcoholic beverage of any one of embodiments 1 to 113, wherein at least about 0.045% by mass of the one or more additional VOCs is ethyl levulinate.
Embodiment 115 is the Scotch-like alcoholic beverage of any one of embodiments 1 to 114, wherein at least about 0.008% by mass of the one or more additional VOCs is farnesol.
Embodiment 116 is the Scotch-like alcoholic beverage of any one of embodiments 1 to 115, wherein at least about 0.006% by mass of the one or more additional VOCs is geraniol.
Embodiment 117 is the Scotch-like alcoholic beverage of any one of embodiments 1 to 116, wherein at least about 0.65% by mass of the one or more additional VOCs is isobutyraldehyde.
Embodiment 118 is the Scotch-like alcoholic beverage of any one of embodiments 1 to 117, wherein at least about 0.008% by mass of the one or more additional VOCs is phenethyl formate.
Embodiment 119 is the Scotch-like alcoholic beverage of any one of embodiments 1 to 118, wherein at least about 0.035% by mass of the one or more additional VOCs is propyl acetate.
Embodiment 120 is the Scotch-like alcoholic beverage of any one of embodiments 1 to 119, wherein at least about 0.005% by mass of the one or more additional VOCs is salicylaldehyde.
Embodiment 121 is the Scotch-like alcoholic beverage of any one of embodiments 1 to 120, wherein at least about 0.02% by mass of the one or more additional VOCs is vanillyl ethyl ether.
Embodiment 122 is the Scotch-like alcoholic beverage of any one of embodiments 1 to 121, wherein at least about 0.07% by mass of the one or more additional VOCs is 2-heptanone.
Embodiment 123 is the Scotch-like alcoholic beverage of any one of embodiments 1 to 122, wherein at least about 0.0025% by mass of the one or more additional VOCs is geranyl acetone.
Embodiment 124 is the Scotch-like alcoholic beverage of any one of embodiments 1 to 123, wherein at least about 0.001% by mass of the one or more additional VOCs is methional.
Embodiment 125 is the Scotch-like alcoholic beverage of any one of embodiments 1 to 124, wherein at least about 0.01% by mass of the one or more additional VOCs is ethyl trans-2-butenoate.
Embodiment 126 is the Scotch-like alcoholic beverage of any one of embodiments 1 to 125, wherein at least about 0.0003% by mass of the one or more additional VOCs is isoamyl isovalerate.
Embodiment 127 is the Scotch-like alcoholic beverage of any one of embodiments 1 to 126, wherein at least about 0.55% by mass of the one or more additional VOCs is isovaleric acid.
Embodiment 128 is the Scotch-like alcoholic beverage of any one of embodiments 1 to 127, wherein at least about 0.011% by mass of the one or more additional VOCs is 2-nonanone.
Embodiment 129 is the Scotch-like alcoholic beverage of any one of embodiments 1 to 128, wherein at least about 0.015% by mass of the one or more additional VOCs is damascenone.
Embodiment 130 is the Scotch-like alcoholic beverage of any one of embodiments 1 to 129, wherein at least about 0.015% by mass of the one or more additional VOCs is ethyl myristate.
Embodiment 131 is the Scotch-like alcoholic beverage of any one of embodiments 1 to 130, wherein at least about 0.018% by mass of the one or more additional VOCs is ethyl levulinate.
Embodiment 132 is the Scotch-like alcoholic beverage of any one of embodiments 1 to 131, wherein at least about 0.026% by mass of the one or more additional VOCs is gamma-decalactone.
Embodiment 133 is the Scotch-like alcoholic beverage of any one of embodiments 1 to 132, wherein at least about 0.032% by mass of the one or more additional VOCs is propyl acetate.
Embodiment 134 is the Scotch-like alcoholic beverage of any one of embodiments 1 to 133, wherein at least about 0.05% by mass of the one or more additional VOCs is benzaldehyde.
Embodiment 135 is the Scotch-like alcoholic beverage of any one of embodiments 1 to 134, wherein at least about 0.14% by mass of the one or more additional VOCs is butyl acetate.
Embodiment 136 is the Scotch-like alcoholic beverage of any one of embodiments 1 to 135, wherein at least about 0.16% by mass of the one or more additional VOCs is isobutyraldehyde.
Embodiment 137 is the Scotch-like alcoholic beverage of any one of embodiments 1 to 136, wherein at least about 0.56% by mass of the one or more additional VOCs is 1,1-diethoxyethane.
Embodiment 138 is the Scotch-like alcoholic beverage of any one of embodiments 1 to 137, wherein at least about 0.56% by mass of the one or more additional VOCs is ethyl hexanoate.
Embodiment 139 is the Scotch-like alcoholic beverage of any one of embodiments 1 to 138, wherein at least about 1.0% by mass of the one or more additional VOCs is guaiacol.
Embodiment 140 is the Scotch-like alcoholic beverage of any one of embodiments 1 to 139, wherein at least about 1.15% by mass of the one or more additional VOCs is isoamyl acetate.
Embodiment 141 is the Scotch-like alcoholic beverage of any one of embodiments 1 to 140, wherein at least about 2.6% by mass of the one or more additional VOCs is furfural.
Embodiment 142 is the Scotch-like alcoholic beverage of any one of embodiments 1 to 141, wherein at least about 4.3% by mass of the one or more additional VOCs is ethyl decanoate.
Embodiment 143 is the Scotch-like alcoholic beverage of any one of embodiments 1 to 142, wherein at least about 8.4% by mass of the one or more additional VOCs is ethyl lactate.
Embodiment 144 is the Scotch-like alcoholic beverage of any one of embodiments 1 to 143, wherein at least about 9.2% by mass of the one or more additional VOCs is ethyl laurate.
Embodiment 145 is the Scotch-like alcoholic beverage of any one of embodiments 1 to 144, wherein at least about 77.0% by mass of the one or more additional VOCs is ethyl acetate.
Embodiment 146 is the Scotch-like alcoholic beverage of any one of embodiments 1 to 11, wherein the one or more additional VOCs comprise:

an ester;

an alcohol;

an aldehyde, a ketone, or a mixture thereof; and

a terpene, an isoprenoid, or a mixture thereof.

Embodiment 147 is the Scotch-like alcoholic beverage of any one of embodiments 1 to 6, wherein the one or more additional VOCs further comprise at least one compound selected from the group consisting of an acid, an alcohol, a phenol, a lactone, a thiol, or an ether.
Embodiment 148 is the Scotch-like alcoholic beverage of any one of embodiments 1 to 11, wherein the one or more additional VOCs comprise one or more esters.
Embodiment 149 is the Scotch-like alcoholic beverage of embodiment 148, wherein less than about 1.9% by mass of the additional VOCs comprise one or more esters.
Embodiment 150 is the Scotch-like alcoholic beverage of embodiment 148 or embodiment 149, wherein the one or more esters are selected from the group consisting of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl succinate, ethyl acetate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl salicylate, ethyl undecanoate, ethyl valerate, ethyl-2-methylbutyrate, isoamyl acetate, isoamyl hexanoate, isoamyl octanoate, isobutyl acetate, linalyl acetate, methyl decanoate, methyl hexanoate, methyl laurate, methyl octanoate, methyl salicylate, phenethyl butyrate, phenethyl octanoate, diethyl malate, ethyl 3-hydroxyhexanoate, ethyl benzoate, ethyl levulinate, phenethyl formate, propyl acetate, ethyl-trans-2-butenoate, ethyl-trans-3-hexenoate, ethyl(methylthio) acetate, heptyl acetate, isoamyl isobutyrate, isoamyl isovalerate, isobutyl isobutyrate, methyl acetate, and phenethyl propionate.
Embodiment 151 is the Scotch-like alcoholic beverage of any one of embodiments 1 to 11 and 148 to 150, wherein the one or more additional VOCs comprise one or more acids.
Embodiment 152 is the Scotch-like alcoholic beverage of embodiment 151, wherein the one or more acids are selected from the group consisting of 3,7-dimethyl-6-octenoic acid, butyric acid, decanoic acid, isobutyric acid, octanoic acid, propionic acid, isovaleric acid, valeric acid, hexanoic acid, and nonanoic acid.
Embodiment 153 is the Scotch-like alcoholic beverage of any one of embodiments 1 to 11 and 148 to 152, wherein the one or more additional VOCs comprise one or more alcohols.
Embodiment 154 is the Scotch-like alcoholic beverage of embodiment 153, wherein the one or more alcohols are selected from the group consisting of 1-octanol, 2-methyl-1-butanol, 2-nonanol, 2-phenylethanol, butyl alcohol, cis-3-hexen-1-ol, 1-decanol, 1-octen-3-ol, amyl alcohol, butanol, hexanol, isoamyl alcohol, isobutanol, and propanol.
Embodiment 155 is the Scotch-like alcoholic beverage of any one of embodiments 1 to 11 and 148 to 154, wherein the one or more additional VOCs comprise one or more aldehydes or ketones.
Embodiment 156 is the Scotch-like alcoholic beverage of embodiment 155, wherein at least about 7.8% by mass of the one or more additional VOCs comprises the one or more aldehydes or ketones.
Embodiment 157 is the Scotch-like alcoholic beverage of embodiment 155, wherein less than about 0.0045% by mass of the one or more additional VOCs comprises the one or more aldehydes or ketones.
Embodiment 158 is the Scotch-like alcoholic beverage of any one of embodiments 155 to 157, wherein the one or more aldehydes or ketones are selected from the group consisting of 1,1-diethoxyethane, 2,3-pentadione, 2-methylbutyraldehyde, 2-nonanone, 2-undecanone, acetaldehyde, acetoin, benzaldehyde, butyraldehyde, cinnamaldehyde, damascenone, furfural, isovaleraldehyde, maltol, nonanal, trans-2-hexen-1-al, isobutyraldehyde, salicylaldehyde, 2-heptanone, acetophenone, methional, valeraldehyde, propionaldehyde, and p-anisaldehyde.
Embodiment 159 is the Scotch-like alcoholic beverage of any one of embodiments 1 to 11 or 148 to 158, wherein the one or more additional VOCs comprise one or more terpenes or isoprenoids.
Embodiment 160 is the Scotch-like alcoholic beverage of embodiment 147, wherein less than about 0.009% by mass of the one or more additional VOCs comprises the one or more terpenes or isoprenoids.
Embodiment 161 is the Scotch-like alcoholic beverage of embodiment 159 or embodiment 160, wherein the one or more terpenes or isoprenoids are selected from the group consisting of 3-carene, 4-carvomenthenol, 4-ethylguaiacol, alpha ionone, a-phellandrene, (−)alpha-pinene, a-terpineol, beta-ionone, (−)beta-pinene, carvone, (−)cis-rose-oxide, citronellol, gamma-terpinene, limonene, linalool, linalool oxide, myrcene, myrtenol, p-cymene, farnesol, geraniol, geranyl acetone, and eucalyptol.
Embodiment 162 is the Scotch-like alcoholic beverage of any one of embodiments 1 to 11 or 148 to 161, wherein the one or more additional VOCs comprise one or more phenols.
Embodiment 163 is the Scotch-like alcoholic beverage of embodiment 162, wherein less than about 0.0015% by mass of the one or more additional VOCs comprises the one or more phenols.
Embodiment 164 is the Scotch-like alcoholic beverage of any one of embodiments 162 or 163, wherein the one or more phenols are selected from the group consisting of 2-methoxy-4-propylphenol, 4-ethylphenol, eugenol, guaiacol, and p-cresol.
Embodiment 165 is the Scotch-like alcoholic beverage of any one of embodiments 1 to 11 or 148 to 164, wherein the one or more additional VOCs comprise one or more lactones.
Embodiment 166 is the Scotch-like alcoholic beverage of embodiment 165, wherein at least about 2.3% by mass of the one or more additional VOCs comprises the one or more lactones.
Embodiment 167 is the Scotch-like alcoholic beverage of embodiment 165 or embodiment 166, wherein the one or more lactones are selected from the group consisting of delta-decalactone, gamma-decalactone, whiskey lactone, and gamma-nonalactone.
Embodiment 168 is the Scotch-like alcoholic beverage of any one of embodiments 1 to 6 or 148 to 167, wherein the one or more additional VOCs comprise one or more sulfur-containing compounds.
Embodiment 169 is the Scotch-like alcoholic beverage of embodiment 168, wherein the one or more sulfur-containing compounds comprise dimethylsulfide.
Embodiment 170 is the Scotch-like alcoholic beverage of embodiment 168 or embodiment 169, wherein at least about 0.0000085% of the one or more additional VOCs comprises the one or more sulfur-containing compounds.
Embodiment 171 is the Scotch-like alcoholic beverage of any one of embodiments 1 to 11 or 148 to 170, wherein the one or more additional VOCs comprise one or more ethers.
Embodiment 172 is the Scotch-like alcoholic beverage of embodiment 171, wherein at least about 0.02% by mass of the one or more VOCs comprises the one or more ethers.
Embodiment 173 is the Scotch-like alcoholic beverage of embodiment 171 or embodiment 172, wherein the one or more ethers comprise vanillyl ethyl ether.
Embodiment 174 is the Scotch-like alcoholic beverage of any one of embodiments 1 to 173, wherein the one or more additional VOCs comprise at least five compounds select& from the group consisting of 1-decanol, 1-octen-3-ol, 2,3-pentadione, 2-methyl-1-butanol, 2-phenylethanol, 2-phenylethylacetate, acetaldehyde, amyl alcohol, a-terpineol, benzaldehyde, beta-ionone, beta-pinene, butanol, butyl acetate, cinnamaldehyde, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, isoamyl alcohol, isoamyl hexanoate, isoamyl octanoate, isobutanol, isobutyl acetate, limonene, linalool oxide, maltol, methyl octanoate, methyl salicylate, myrcene, p-cresol, p-cymene, phenethyl butyrate, and whiskey lactone.
Embodiment 175 is the Scotch-like alcoholic beverage of embodiment 174, wherein the one or more additional VOCs comprise at least one compound selected from the group consisting of propanol, ethyl isobutyrate, gamma-terpinene, and butyric acid.
Embodiment 176 is the Scotch-like alcoholic beverage of embodiments 174 or embodiment 175, wherein the one or more additional VOCs comprise at least one compound selected from the group consisting of 3-carene, 4-carvomenthenol, 4-ethyl phenol, butyl formate, delta-decalactone, ethyl heptanoate, guaiacol, isoamyl acetate, linalool, linalyl acetate.
Embodiment 177 is the Scotch-like alcoholic beverage of any one of embodiments 174 to 176, wherein the one or more additional VOCs comprise at least one compound selected from the group consisting of 1,1-diethoxyethane, 2-heptanone, 2-methylbutyl acetate, 2-methylbutyraldehyde, 2-nonanone, 4-ethyl guaiacol, acetoin, acetophenone, amyl butyrate, a-phellandrene, a-pinene, citronellol, damascenone, decanoic acid, diethyl malate, dimethylsulfide, ethyl 3-hydroxyhexanoate, ethyl benzoate, ethyl levulinate, ethyl nonanoate, ethyl palmitate, ethyl trans-2-butenoate, ethyl undecanoate, ethyl-2-methylbutyrate, farnesol, gamma-nonalactone, geraniol, geranyl acetone, hexanol, isobutyraldehyde, isobutyric acid, isovaleraldehyde, methional, methyl decanoate, methyl hexanoate, methyl laurate, myrtenol, nonanal, octanoic acid, p-anisaldehyde, phenethyl formate, phenethyl octanoate, propionaldehyde, propyl acetate, salicylaldehyde, trans-2-hexen-1-al, valeraldehyde, vanillyl ethyl ether, butyraldehyde, propionic acid, isovaleric acid, valeric acid, hexanoic acid, and nonanoic acid.
Embodiment 178 is the Scotch-like alcoholic beverage of any one of embodiments 1 to 173, wherein the one or more additional VOCs comprise five or more compounds selected from the group consisting of 1-decanol, 1-octen-3-ol, 2,3-pentadione, 2-methyl-1-butanol, 2-phenylethanol, 2-phenylethylacetate, 3-carene, acetaldehyde, amyl alcohol, a-terpineol, benzaldehyde, beta-ionone, beta-pinene, butanol, butyl acetate, cinnamaldehyde, delta-decalactone, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, guaiacol, isoamyl alcohol, isoamyl hexanoate, isoamyl octanoate, isobutanol, isobutyl acetate, limonene, linalool, linalool oxide, linalyl acetate, maltol, methyl salicylate, myrcene, p-cresol, and whiskey lactone.
Embodiment 179 is the Scotch-like alcoholic beverage of embodiment 178, wherein the one or more additional VOCs comprise at least one compound selected from the group consisting of 1,1-diethoxyethane, 2-heptanone, 4-ethyl guaiacol, acetoin, acetophenone, diethyl malate, ethyl 3-hydroxyhexanoate, ethyl levulinate, ethyl trans-2-butenoate, ethyl undecanoate, ethyl-2-methylbutyrate, gamma-nonalactone, geraniol, isobutyraldehyde, methional, methyl octanoate, p-cymene, phenethyl butyrate, phenethyl formate, propanol, propyl acetate, and vanillyl ethyl ether.
Embodiment 180 is the Scotch-like alcoholic beverage of any one of embodiments 1 to 179, wherein the additional VOCs have less than about 95% identity to the VOCs in a single reference Scotch.
Embodiment 181 is the Scotch-like alcoholic beverage of any one of embodiments 1 to 180, wherein the Scotch-like alcoholic beverage comprises at least 61 additional VOCs and wherein no more than 60 of the additional VOCs are found in a single reference Scotch.
Embodiment 182 is the Scotch-like alcoholic beverage of any one of embodiments 1 to 181, further comprising one or more non-volatile compounds.
Embodiment 183 is the Scotch-like alcoholic beverage of embodiment 182, wherein the one or more non-volatile compounds comprise one or more compounds selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose. In some embodiments, a non-volatile compound that is not present in traditional Scotch can be selected from the group consisting of valine, and xylose.
Embodiment 184 is the Scotch-like alcoholic beverage of embodiment 183, wherein the one or more non-volatile compounds comprise one or more compounds selected from the group consisting of valine, xylose, and combinations thereof.
Embodiment 185 is the Scotch-like alcoholic beverage of any one of embodiments 182 to 184, wherein the one or more non-volatile compounds do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.
Embodiment 186 is the Scotch-like alcoholic beverage of embodiment 185, wherein the one or more non-volatiles do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, AMP, arabitol, egallic acid, homoserine, methyl gallate, pyridine, pyruvic acid, quinic acid, rhamnose, and salicylic acid.
Embodiment 187 is the Scotch-like alcoholic beverage of any one of embodiments 182 to 186, wherein the one or more non-volatile compounds comprise ribose in an amount of less than about 6 mg/L.
Embodiment 188 is the Scotch-like alcoholic beverage of any one of embodiments embodiment 182 to 187, wherein the one or more non-volatile compounds comprise fructose in an amount of less than about 9.6 mg/L.
Embodiment 189 is the Scotch-like alcoholic beverage of any one of embodiments embodiment 182 to 188, wherein the one or more non-volatile compounds comprise syringaldehyde in an amount of less than about 0.21 mg/L.
Embodiment 190 is the Scotch-like alcoholic beverage of any one of embodiments embodiment 182 to 189, wherein the one or more non-volatile compounds comprise vanillic acid in an amount of less than about 6.3 mg/L.
Embodiment 191 is the Scotch-like alcoholic beverage of any one of embodiments embodiment 182 to 190, wherein the one or more non-volatile compounds comprise vanillin in an amount of less than about 0.12 mg/L.
Embodiment 192 is the Scotch-like alcoholic beverage of any one of embodiments embodiment 182 to 191, wherein the one or more non-volatile compounds comprise acetovanillone in an amount of at least about 0.26 mg/L.
Embodiment 193 is the Scotch-like alcoholic beverage of any one of embodiments embodiment 182 to 192, wherein the one or more non-volatile compounds comprise choline in an amount of at least about 2.8 mg/L.
Embodiment 194 is the Scotch-like alcoholic beverage of any one of embodiments embodiment 182 to 193, wherein the one or more non-volatile compounds comprise citric acid in an amount of at least about 6.6 mg/L.
Embodiment 195 is the Scotch-like alcoholic beverage of any one of embodiments embodiment 182 to 194, wherein the one or more non-volatile compounds comprise fumaric acid in an amount of at least about 0.64 mg/L.
Embodiment 196 is the Scotch-like alcoholic beverage of any one of embodiments embodiment 182 to 195, wherein the one or more non-volatile compounds comprise glucosamine in an amount of at least about 0.55 mg/L.
Embodiment 197 is the Scotch-like alcoholic beverage of any one of embodiments embodiment 182 to 196, wherein the one or more non-volatile compounds comprise glucose in an amount of at least about 120 mg/L.
Embodiment 198 is the Scotch-like alcoholic beverage of any one of embodiments embodiment 182 to 197, wherein the one or more non-volatile compounds comprise mannitol in an amount of at least about 7.8 mg/L.
Embodiment 199 is the Scotch-like alcoholic beverage of any one of embodiments embodiment 182 to 198, wherein the one or more non-volatile compounds comprise sorbitol in an amount of at least about 5.8 mg/L.
Embodiment 200 is the Scotch-like alcoholic beverage of any one of embodiments embodiment 182 to 199, wherein the one or more non-volatile compounds comprise syringic acid in an amount of at least about 5.4 mg/L.
Embodiment 201 is the Scotch-like alcoholic beverage of any one of embodiments 182 to 200, wherein the one or more non-volatile compounds comprise trans-ferulic acid in an amount of less than about 0.5 mg/L.
Embodiment 202 is the Scotch-like alcoholic beverage of any one of embodiments 182 to 201, wherein the one or more non-volatile compounds comprise kelp or a kelp extract.
Embodiment 203 is the Scotch-like alcoholic beverage of any one of embodiments 182 to 202, wherein the one or more non-volatile compounds comprise glycerol, gum arabic, or glycerol and gym arabic.
Embodiment 204 is the Scotch-like alcoholic beverage of any one of embodiments 182 to 203, wherein the one or more non-volatile compounds comprise at least five compounds selected from the group consisting of D-glucuronic acid, fructose, glucose, lactic acid, malic acid, succinic acid, and tartaric acid.
Embodiment 205 is the Scotch-like alcoholic beverage of any one of embodiments 182 to 204, wherein the one or more non-volatile compounds comprise at least one compound selected from the group consisting of acetovanillone, choline, fumaric acid, GABA, gallic acid, glucosamine, inositol, mannitol, mannose, proline, ribose, sorbitol, syringaldehyde, syringic acid, trans-ferulic acid, tyrosine, valine, vanillic acid, and vanillin.
Embodiment 206 is the Scotch-like alcoholic beverage of any one of embodiments 182 to 205, wherein the one or more non-volatile compounds have less than about 60% identity to the non-volatile compounds in a single reference Scotch.
Embodiment 207 is a Scotch-like alcoholic beverage comprising:

ethanol;

water; and

one or more additional VOCs,

wherein at least one of the following, in any combination, is true:
2-methyl-1-butanol is present in an amount less than about 75 mg/L or 2-methyl-1-butanol is present in an amount of at least about 635 mg/L;
delta-decalactone is present in an amount less than about 0.013 mg/L or delta-decalactone is present in an amount of at least about 0.27 mg/L;
ethyl acetate is present in an amount less than about 42 mg/L or ethyl acetate is present in an amount of at least about 780 mg/L;
ethyl undecanoate is present in an amount less than about 0.007 mg/L or ethyl undecanoate is present in an amount of at least about 0.12 mg/L;
1-decanol is present in an amount less than about 0.065 mg/L;
2-methylbutyraldehyde is present in an amount less than about 0.012 mg/L;
benzaldehyde is present in an amount less than about 0.003 mg/L;
butanol is present in an amount less than about 3.3 mg/L;
citronellol is present in an amount less than about 0.0002 mg/L;
decanoic acid is present in an amount less than about 1.7 mg/L;
diethyl succinate is present in an amount less than about 0.3 mg/L;
ethyl butanoate is present in an amount less than about 0.14 mg/L;
ethyl cinnamate is present in an amount less than about 0.00035 mg/L;
ethyl heptanoate is present in an amount less than about 0.006 mg/L;
ethyl isovalerate is present in an amount less than about 0.06 mg/L;
ethyl nonanoate is present in an amount less than about 0.0075 mg/L;
ethyl octanoate is present in an amount less than about 0.85 mg/L;
ethyl propionate is present in an amount less than about 0.34 mg/L;
Ethyl Valerate is present in an amount less than about 0.0045 mg/L;
furfural is present in an amount less than about 0.7 mg/L;
hexanol is present in an amount less than about 0.014 mg/L;
isoamyl acetate is present in an amount less than about 0.18 mg/L;
isoamyl alcohol is present in an amount less than about 38 mg/L;
isoamyl octanoate is present in an amount less than about 0.0005 mg/L;
isobutanol is present in an amount less than about 72 mg/L;
isobutyl acetate is present in an amount less than about 0.03 mg/L;
methyl decanoate is present in an amount less than about 0.0004 mg/L;
Myrtenol is present in an amount less than about 0.085 mg/L;
octanoic acid is present in an amount less than about 2.5 mg/L;
p-cresol is present in an amount less than about 0.009 mg/L;
Phenethyl Butyrate is present in an amount less than about 0.0003 mg/L;
phenethyl octanoate is present in an amount less than about 0.0006 mg/L;
propanol is present in an amount less than about 100 mg/L;
ethyl benzoate is present in an amount less than about 0.0045 mg/L;
gamma-nonalactone is present in an amount less than about 0.0065 mg/L;
Propionic acid is present in an amount less than about 0.38 mg/L;
Hexanoic acid is present in an amount less than about 3.6 mg/L;
1,1-diethoxyethane is present in an amount of at least about 4 mg/L;
2,3-pentadione is present in an amount of at least about 0.0015 mg/L;
4-Ethyl Phenol is present in an amount of at least about 1.7 mg/L;
amyl alcohol is present in an amount of at least about 0.03 mg/L;
beta-ionone is present in an amount of at least about 0.004 mg/L;
butyl acetate is present in an amount of at least about 0.98 mg/L;
butyric acid is present in an amount of at least about 2 mg/L;
carvone is present in an amount of at least about 0.0023 mg/L;
Cinnamaldehyde is present in an amount of at least about 0.04 mg/L;
damascenone is present in an amount of at least about 0.14 mg/L;
ethyl isobutyrate is present in an amount of at least about 5.5 mg/L;
gamma-decalactone is present in an amount of at least about 0.4 mg/L;
gamma-terpinene is present in an amount of at least about 0.0013 mg/L;
limonene is present in an amount of at least about 0.01 mg/L;
linalyl acetate is present in an amount of at least about 0.03 mg/L;
methyl hexanoate is present in an amount of at least about 0.002 mg/L;
geraniol is present in an amount of at least about 0.04 mg/L;
isobutyraldehyde is present in an amount of at least about 4.4 mg/L;
at least about 0.4% by mass of the one or more additional VOCs is isobutyl acetate;
less than about 0.026% by mass of the one or more additional VOCs is decanoic acid;
less than about 0.004885% by mass of the one or more additional VOCs is diethyl succinate;
less than about 0.00007% by mass of the one or more additional VOCs is Ethyl Valerate;
less than about 0.85% by mass of the one or more additional VOCs is isoamyl alcohol;
less than about 0.0013% by mass of the one or more additional VOCs is Myrtenol;
less than about 0.0000045% by mass of the one or more additional VOCs is Phenethyl Butyrate;
at least about 0.00035% by mass of the one or more additional VOCs is carvone;
at least about 0.006% by mass of the one or more additional VOCs is Cinnamaldehyde;
at least about 0.02% by mass of the one or more additional VOCs is damascenone;
at least about 0.04% by mass of the one or more additional VOCs is delta-decalactone;
at least about 0.0035% by mass of the one or more additional VOCs is ethyl cinnamate;
at least about 0.78% by mass of the one or more additional VOCs is ethyl isobutyrate;
at least about 0.4% by mass of the one or more additional VOCs is ethyl isovalerate;
at least about 19.% by mass of the one or more additional VOCs is ethyl lactate;
at least about 0.017% by mass of the one or more additional VOCs is ethyl undecanoate;
at least about 04.5% by mass of the one or more additional VOCs is furfural;
at least about 0.06% by mass of the one or more additional VOCs is gamma-decalactone;
at least about 0.0002% by mass of the one or more additional VOCs is gamma-terpinene;
at least about 0.014% by mass of the one or more additional VOCs is isoamyl hexanoate;
at least about 0.0015% by mass of the one or more additional VOCs is limonene;
at least about 0.004% by mass of the one or more additional VOCs is linalyl acetate;
at least about 0.0003% by mass of the one or more additional VOCs is methyl hexanoate;
at least about 0.0025% by mass of the one or more additional VOCs is methyl laurate;
at least about 0.003% by mass of the one or more additional VOCs is ethyl 3-hydroxyhexanoate;
at least about 0.045% by mass of the one or more additional VOCs is ethyl levulinate;
at least about 0.008% by mass of the one or more additional VOCs is farnesol;
at least about 0.006% by mass of the one or more additional VOCs is geraniol;
at least about 0.65% by mass of the one or more additional VOCs is isobutyraldehyde;
at least about 0.008% by mass of the one or more additional VOCs is phenethyl formate;
at least about 0.035% by mass of the one or more additional VOCs is propyl acetate;
at least about 0.02% by mass of the one or more additional VOCs is vanillyl ethyl ether Results;
at least about 0.0732393% by mass of the one or more additional VOCs is 2-heptanone;
at least about 0.0025% by mass of the one or more additional VOCs is geranyl acetone undacadien;
at least about 0.001% by mass of the one or more additional VOCs is methional;
at least about 0.01% by mass of the one or more additional VOCs is ethyl trans-2-butenoate; or
at least about 0.0003% by mass of the one or more additional VOCs is isoamyl isovalerate;
   Embodiment 208 is a Scotch-like alcoholic beverage comprising:

ethanol;

water; and

one or more additional VOCs,

wherein at least one of the following, in any combination, is true:
1-decanol is present in an amount less than about 0.065 mg/L;
2-methyl-1-butanol is present in an amount less than about 75 mg/L;
decanoic acid is present in an amount less than about 1.7 mg/L;
diethyl succinate is present in an amount less than about 0.3 mg/L;
ethyl acetate is present in an amount less than about 42 mg/L;
ethyl butanoate is present in an amount less than about 0.14 mg/L;
ethyl propionate is present in an amount less than about 0.34 mg/L;
isobutanol is present in an amount less than about 72 mg/L;
Myrtenol is present in an amount less than about 0.085 mg/L;
octanoic acid is present in an amount less than about 2.5 mg/L;
p-cresol is present in an amount less than about 0.009 mg/L;
Phenethyl Butyrate is present in an amount less than about 0.0003 mg/L;
phenethyl octanoate is present in an amount less than about 0.0006 mg/L;
propanol is present in an amount less than about 100 mg/L;
gamma-nonalactone is present in an amount less than about 0.0065 mg/L;
Propionic acid is present in an amount less than about 0.38 mg/L;
Hexanoic acid is present in an amount less than about 3.6 mg/L;
amyl alcohol is present in an amount of at least about 0.03 mg/L;
delta-decalactone is present in an amount of at least about 0.27 mg/L;
linalyl acetate is present in an amount of at least about 0.03 mg/L;
geraniol is present in an amount of at least about 0.04 mg/L;
at least about 0.04% by mass of the one or more additional VOCs is delta-decalactone;
at least about 0.0035% by mass of the one or more additional VOCs is ethyl cinnamate;
at least about 0.0015% by mass of the one or more additional VOCs is limonene;
at least about 0.004% by mass of the one or more additional VOCs is linalyl acetate; or
at least about 0.006% by mass of the one or more additional VOCs is geraniol.
   Embodiment 209 is a Scotch-like alcoholic beverage comprising:

ethanol;

water; and

one or more additional VOCs,

wherein at least one of the following, in any combination, is true:
1-decanol is present in an amount less than about 0.065 mg/L;
2-methyl-1-butanol is present in an amount less than about 75 mg/L;
2-methylbutyraldehyde is present in an amount less than about 0.012 mg/L;
benzaldehyde is present in an amount less than about 0.003 mg/L;
citronellol is present in an amount less than about 0.0002 mg/L;
decanoic acid is present in an amount less than about 1.7 mg/L;
diethyl succinate is present in an amount less than about 0.3 mg/L;
ethyl acetate is present in an amount less than about 42 mg/L;
ethyl butanoate is present in an amount less than about 0.14 mg/L;
ethyl heptanoate is present in an amount less than about 0.006 mg/L;
ethyl nonanoate is present in an amount less than about 0.0075 mg/L;
ethyl octanoate is present in an amount less than about 0.85 mg/L;
ethyl propionate is present in an amount less than about 0.34 mg/L;
hexanol is present in an amount less than about 0.014 mg/L;
isoamyl acetate is present in an amount less than about 0.18 mg/L;
isoamyl alcohol is present in an amount less than about 38 mg/L;
isoamyl octanoate is present in an amount less than about 0.0005 mg/L;
isobutanol is present in an amount less than about 72 mg/L;
methyl decanoate is present in an amount less than about 0.0004 mg/L;
Myrtenol is present in an amount less than about 0.085 mg/L;
octanoic acid is present in an amount less than about 2.5 mg/L;
p-cresol is present in an amount less than about 0.009 mg/L;
Phenethyl Butyrate is present in an amount less than about 0.0003 mg/L;
phenethyl octanoate is present in an amount less than about 0.0006 mg/L;
propanol is present in an amount less than about 100 mg/L;
ethyl benzoate is present in an amount less than about 0.0045 mg/L;
gamma-nonalactone is present in an amount less than about 0.0065 mg/L;
Propionic acid is present in an amount less than about 0.38 mg/L;
Hexanoic acid is present in an amount less than about 3.6 mg/L;
amyl alcohol is present in an amount of at least about 0.03 mg/L;
delta-decalactone is present in an amount of at least about 0.27 mg/L;
ethyl undecanoate is present in an amount of at least about 0.12 mg/L;
linalyl acetate is present in an amount of at least about 0.03 mg/L;
geraniol is present in an amount of at least about 0.04 mg/L;
at least about 0.04% by mass of the one or more additional VOCs is delta-decalactone;
at least about 0.0035% by mass of the one or more additional VOCs is ethyl cinnamate;
at least about 0.4% by mass of the one or more additional VOCs is ethyl isovalerate;
at least about 19.0% by mass of the one or more additional VOCs is ethyl lactate;
at least about 0.017% by mass of the one or more additional VOCs is ethyl undecanoate;
at least about 0.4% by mass of the one or more additional VOCs is isobutyl acetate;
at least about 0.0015% by mass of the one or more additional VOCs is limonene;
at least about 0.004% by mass of the one or more additional VOCs is linalyl acetate;
at least about 0.003% by mass of the one or more additional VOCs is ethyl 3-hydroxyhexanoate;
at least about 0.045% by mass of the one or more additional VOCs is ethyl levulinate;
at least about 0.006% by mass of the one or more additional VOCs is geraniol;
at least about 0.65% by mass of the one or more additional VOCs is isobutyraldehyde;
at least about 0.008% by mass of the one or more additional VOCs is phenethyl formate;
at least about 0.035% by mass of the one or more additional VOCs is propyl acetate;
at least about 0.02% by mass of the one or more additional VOCs is vanillyl ethyl ether;
at least about 0.001% by mass of the one or more additional VOCs is methional; or
at least about 0.01% by mass of the one or more additional VOCs is ethyl trans-2-butenoate.
   Embodiment 210 is a Scotch-like alcoholic beverage comprising:

ethanol;

water; and

one or more additional VOCs,

wherein at least one of the following, in any combination, is true:
1-decanol is present in an amount less than about 0.065 mg/L;
2-methyl-1-butanol is present in an amount less than about 75 mg/L;
decanoic acid is present in an amount less than about 1.7 mg/L;
diethyl succinate is present in an amount less than about 0.3 mg/L;
ethyl acetate is present in an amount less than about 42 mg/L;
ethyl butanoate is present in an amount less than about 0.14 mg/L;
ethyl propionate is present in an amount less than about 0.34 mg/L;
isobutanol is present in an amount less than about 72 mg/L;
Myrtenol is present in an amount less than about 0.085 mg/L;
octanoic acid is present in an amount less than about 2.5 mg/L;
p-cresol is present in an amount less than about 0.009 mg/L;
Phenethyl Butyrate is present in an amount less than about 0.0003 mg/L;
phenethyl octanoate is present in an amount less than about 0.0006 mg/L;
propanol is present in an amount less than about 100 mg/L;
gamma-nonalactone is present in an amount less than about 0.0065 mg/L;
Propionic acid is present in an amount less than about 0.38 mg/L;
Hexanoic acid is present in an amount less than about 3.6 mg/L;
1,1-diethoxyethane is present in an amount of at least about 4 mg/L;
amyl alcohol is present in an amount of at least about 0.03 mg/L;
beta-ionone is present in an amount of at least about 0.004 mg/L;
butyl acetate is present in an amount of at least about 0.98 mg/L;
carvone is present in an amount of at least about 0.0023 mg/L;
delta-decalactone is present in an amount of at least about 0.27 mg/L;
limonene is present in an amount of at least about 0.01 mg/L;
linalyl acetate is present in an amount of at least about 0.03 mg/L;
geraniol is present in an amount of at least about 0.04 mg/L;
at least about 0.00035% by mass of the one or more additional VOCs is carvone;
at least about 0.04% by mass of the one or more additional VOCs is delta-decalactone;
at least about 0.0035% by mass of the one or more additional VOCs is ethyl cinnamate;
at least about 0.0015% by mass of the one or more additional VOCs is limonene;
at least about 0.004% by mass of the one or more additional VOCs is linalyl acetate;
at least about 0.0003% by mass of the one or more additional VOCs is methyl hexanoate;
at least about 0.0025% by mass of the one or more additional VOCs is methyl laurate;
at least about 0.006% by mass of the one or more additional VOCs is geraniol;
at least about 0.0003% by mass of the one or more additional VOCs is isoamyl isovalerate.
   Embodiment 211 is the Scotch-like alcoholic beverage of any one of embodiments 207 to 210, wherein the one or more additional VOCs comprise one or more of butyl formate, ethyl octanoate, ethyl propionate, ethyl-2-methylbutyrate, isoamyl acetate, isoamyl alcohol, and isobutanol.
   Embodiment 212 is the Scotch-like alcoholic beverage of any one of embodiments 207 to 210, wherein the one or more additional VOCs comprise two or more of butyl formate, ethyl octanoate, ethyl propionate, ethyl-2-methylbutyrate, isoamyl acetate, isoamyl alcohol, and isobutanol.
   Embodiment 213 is the Scotch-like alcoholic beverage of any one of embodiments 207 to 210, wherein the one or more additional VOCs comprise three or more of butyl formate, ethyl octanoate, ethyl propionate, ethyl-2-methylbutyrate, isoamyl acetate, isoamyl alcohol, and isobutanol.
   Embodiment 214 is the Scotch-like alcoholic beverage of any one of embodiments 207 to 210, wherein the one or more additional VOCs comprise four or more of butyl formate, ethyl octanoate, ethyl propionate, ethyl-2-methylbutyrate, isoamyl acetate, isoamyl alcohol, and isobutanol.
   Embodiment 215 is the Scotch-like alcoholic beverage of any one of embodiments 207 to 210, wherein the one or more additional VOCs comprise five or more of butyl formate, ethyl octanoate, ethyl propionate, ethyl-2-methylbutyrate, isoamyl acetate, isoamyl alcohol, and isobutanol.
   Embodiment 216 is the Scotch-like alcoholic beverage of any one of embodiments 207 to 210, wherein the one or more additional VOCs comprise six or more of butyl formate, ethyl octanoate, ethyl propionate, ethyl-2-methylbutyrate, isoamyl acetate, isoamyl alcohol, and isobutanol.
   Embodiment 217 is the Scotch-like alcoholic beverage of any one of embodiments 207 to 210, wherein the one or more additional VOCs comprise butyl formate, ethyl octanoate, ethyl propionate, ethyl-2-methylbutyrate, isoamyl acetate, isoamyl alcohol, and isobutanol.
   Embodiment 218 is the Scotch-like alcoholic beverage of any one of embodiments 207 to 210, wherein the one or more additional VOCs comprise no more than six of butyl formate, ethyl octanoate, ethyl propionate, ethyl-2-methylbutyrate, isoamyl acetate, isoamyl alcohol, and isobutanol.
   Embodiment 219 is the Scotch-like alcoholic beverage of any one of embodiments 207 to 210, wherein the one or more additional VOCs comprise:

an ester;

an alcohol;

an aldehyde, a ketone, or a mixture thereof; and

a terpene, an isoprenoid, or a mixture thereof.

Embodiment 220 is the Scotch-like alcoholic beverage of any one of embodiments 207 to 210, wherein the one or more additional VOCs further comprise at least one compound selected from the group consisting of an acid, an alcohol, a phenol, a lactone, a thiol, or an ether.
Embodiment 221 is the Scotch-like alcoholic beverage of any one of embodiments 207 to 210, wherein the one or more additional VOCs comprise one or more esters.
Embodiment 222 is the Scotch-like alcoholic beverage of embodiment 221, wherein less than about 1.9% by mass of the additional VOCs comprise one or more esters.
Embodiment 223 is the Scotch-like alcoholic beverage of embodiment 221 or embodiment 222, wherein the one or more esters are selected from the group consisting of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl succinate, ethyl acetate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl salicylate, ethyl undecanoate, ethyl valerate, ethyl-2-methylbutyrate, isoamyl acetate, isoamyl hexanoate, isoamyl octanoate, isobutyl acetate, linalyl acetate, methyl decanoate, methyl hexanoate, methyl laurate, methyl octanoate, methyl salicylate, phenethyl butyrate, phenethyl octanoate, diethyl malate, ethyl 3-hydroxyhexanoate, ethyl benzoate, ethyl levulinate, phenethyl formate, propyl acetate, ethyl-trans-2-butenoate, ethyl-trans-3-hexenoate, ethyl(methylthio) acetate, heptyl acetate, isoamyl isobutyrate, isoamyl isovalerate, isobutyl isobutyrate, methyl acetate, and phenethyl propionate.
Embodiment 224 is the Scotch-like alcoholic beverage of any one of embodiments 207 to 210 and 221 to 223, wherein the one or more additional VOCs comprise one or more acids.
Embodiment 225 is the Scotch-like alcoholic beverage of embodiment 224, wherein the one or more acids are selected from the group consisting of 3,7-dimethyl-6-octenoic acid, butyric acid, decanoic acid, isobutyric acid, octanoic acid, propionic acid, isovaleric acid, valeric acid, hexanoic acid, and nonanoic acid.
Embodiment 226 is the Scotch-like alcoholic beverage of any one of embodiments 207 to 210 and 221 to 225, wherein the one or more additional VOCs comprise one or more alcohols.
Embodiment 227 is the Scotch-like alcoholic beverage of embodiment 226, wherein the one or more alcohols are selected from the group consisting of 1-octanol, 2-methyl-1-butanol, 2-nonanol, 2-phenylethanol, butyl alcohol, cis-3-hexen-1-ol, 1-decanol, 1-octen-3-ol, amyl alcohol, butanol, hexanol, isoamyl alcohol, isobutanol, and propanol.
Embodiment 228 is the Scotch-like alcoholic beverage of any one of embodiments 207 to 210 and 221 to 227, wherein the one or more additional VOCs comprise one or more aldehydes or ketones.
Embodiment 229 is the Scotch-like alcoholic beverage of embodiment 228, wherein at least about 7.8% by mass of the one or more additional VOCs comprises the one or more aldehydes or ketones.
Embodiment 230 is the Scotch-like alcoholic beverage of embodiment 228, wherein less than about 0.0045% by mass of the one or more additional VOCs comprises the one or more aldehydes or ketones.
Embodiment 231 is the Scotch-like alcoholic beverage of any one of embodiments 228 to 230, wherein the one or more aldehydes or ketones are selected from the group consisting of 1,1-diethoxyethane, 2,3-pentadione, 2-methylbutyraldehyde, 2-nonanone, 2-undecanone, acetaldehyde, acetoin, benzaldehyde, butyraldehyde, cinnamaldehyde, damascenone, furfural, isovaleraldehyde, maltol, nonanal, trans-2-hexen-1-al, isobutyraldehyde, salicylaldehyde, 2-heptanone, acetophenone, methional, valeraldehyde, propionaldehyde, and p-anisaldehyde.
Embodiment 232 is the Scotch-like alcoholic beverage of any one of embodiments 207 to 210 or 221 to 231, wherein the one or more additional VOCs comprise one or more terpenes or isoprenoids.
Embodiment 233 is the Scotch-like alcoholic beverage of embodiment 232, wherein less than about 0.009% by mass of the one or more additional VOCs comprises the one or more terpenes or isoprenoids.
Embodiment 234 is the Scotch-like alcoholic beverage of embodiment 232 or embodiment 233, wherein the one or more terpenes or isoprenoids are selected from the group consisting of 3-carene, 4-carvomenthenol, 4-ethylguaiacol, alpha ionone, a-phellandrene, (−)alpha-pinene, a-terpineol, beta-ionone, (−)beta-pinene, carvone, (−)cis-rose-oxide, citronellol, gamma-terpinene, limonene, linalool, linalool oxide, myrcene, myrtenol, p-cymene, farnesol, geraniol, geranyl acetone, and eucalyptol.
Embodiment 235 is the Scotch-like alcoholic beverage of any one of embodiments 207 to 210 or 221 to 234, wherein the one or more additional VOCs comprise one or more phenols.
Embodiment 236 is the Scotch-like alcoholic beverage of embodiment 235, wherein less than about 0.0015% by mass of the one or more additional VOCs comprises the one or more phenols.
Embodiment 237 is the Scotch-like alcoholic beverage of any one of embodiments 235 or 236, wherein the one or more phenols are selected from the group consisting of 2-methoxy-4-propylphenol, 4-ethylphenol, eugenol, guaiacol, and p-cresol.
Embodiment 238 is the Scotch-like alcoholic beverage of any one of embodiments 207 to 210 or 221 to 237, wherein the one or more additional VOCs comprise one or more lactones.
Embodiment 239 is the Scotch-like alcoholic beverage of embodiment 238, wherein at least about 2.3% by mass of the one or more additional VOCs comprises the one or more lactones.
Embodiment 240 is the Scotch-like alcoholic beverage of embodiment 238 or embodiment 239, wherein the one or more lactones are selected from the group consisting of delta-decalactone, gamma-decalactone, whiskey lactone, and gamma-nonalactone.
Embodiment 241 is the Scotch-like alcoholic beverage of any one of embodiments 207 to 210 or 221 to 240, wherein the one or more additional VOCs comprise one or more sulfur-containing compounds.
Embodiment 242 is the Scotch-like alcoholic beverage of embodiment 241, wherein the one or more sulfur-containing compounds comprise dimethylsulfide.
Embodiment 243 is the Scotch-like alcoholic beverage of embodiment 241 or embodiment 242, wherein at least about 0.0000085% of the one or more additional VOC comprises the one or more sulfur-containing compounds.
Embodiment 244 is the Scotch-like alcoholic beverage of any one of embodiments 207 to 210 or 221 to 243, wherein the one or more additional VOCs comprise one or more ethers.
Embodiment 245 is the Scotch-like alcoholic beverage of embodiment 244, wherein at least about 0.02% by mass of the one or more VOCs comprises the one or more ethers.
Embodiment 246 is the Scotch-like alcoholic beverage of embodiment 244 or embodiment 245, wherein the one or more ethers comprise vanillyl ethyl ether.
Embodiment 247 is the Scotch-like alcoholic beverage of any one of embodiments 207 to 246, wherein the one or more additional VOCs comprise at least five compounds selected from the group consisting of 1-decanol, 1-octen-3-ol, 2,3-pentadione, 2-methyl-1-butanol, 2-phenylethanol, 2-phenylethylacetate, acetaldehyde, amyl alcohol, a-terpineol, benzaldehyde, beta-ionone, beta-pinene, butanol, butyl acetate, cinnamaldehyde, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, isoamyl alcohol, isoamyl hexanoate, isoamyl octanoate, isobutanol, isobutyl acetate, limonene, linalool oxide, maltol, methyl octanoate, methyl salicylate, myrcene, p-cresol, p-cymene, phenethyl butyrate, and whiskey lactone.
Embodiment 248 is the Scotch-like alcoholic beverage of embodiment 247, wherein the one or more additional VOCs comprise at least one compound selected from the group consisting of propanol, ethyl isobutyrate, gamma-terpinene, and butyric acid.
Embodiment 249 is the Scotch-like alcoholic beverage of embodiments 247 or embodiment 248, wherein the one or more additional VOCs comprise at least one compound selected from the group consisting of 3-carene, 4-carvomenthenol, 4-ethyl phenol, butyl formate, delta-decalactone, ethyl heptanoate, guaiacol, isoamyl acetate, linalool, linalyl acetate.
Embodiment 250 is the Scotch-like alcoholic beverage of any one of embodiments 247 to 248, wherein the one or more additional VOCs comprise at least one compound selected from the group consisting of 1,1-diethoxyethane, 2-heptanone, 2-methylbutyl acetate, 2-methylbutyraldehyde, 2-nonanone, 4-ethyl guaiacol, acetoin, acetophenone, amyl butyrate, a-phellandrene, a-pinene, citronellol, damascenone, decanoic acid, diethyl malate, dimethylsulfide, ethyl 3-hydroxyhexanoate, ethyl benzoate, ethyl levulinate, ethyl nonanoate, ethyl palmitate, ethyl trans-2-butenoate, ethyl undecanoate, ethyl-2-methylbutyrate, farnesol, gamma-nonalactone, geraniol, geranyl acetone, hexanol, isobutyraldehyde, isobutyric acid, isovaleraldehyde, methional, methyl decanoate, methyl hexanoate, methyl laurate, myrtenol, nonanal, octanoic acid, p-anisaldehyde, phenethyl formate, phenethyl octanoate, propionaldehyde, propyl acetate, salicylaldehyde, trans-2-hexen-1-al, valeraldehyde, vanillyl ethyl ether, butyraldehyde, propionic acid, isovaleric acid, valeric acid, hexanoic acid, and nonanoic acid.
Embodiment 251 is the Scotch-like alcoholic beverage of any one of embodiments 207 to 250, wherein the one or more additional VOCs comprise five or more compounds selected from the group consisting of 1-decanol, 1-octen-3-ol, 2,3-pentadione, 2-methyl-1-butanol, 2-phenylethanol, 2-phenylethylacetate, 3-carene, acetaldehyde, amyl alcohol, a-terpineol, benzaldehyde, beta-ionone, beta-pinene, butanol, butyl acetate, cinnamaldehyde, delta-decalactone, diethyl succinate, ethyl acetate, ethyl butanoate, ethyl cinnamate, ethyl decanoate, ethyl hexanoate, ethyl isovalerate, ethyl lactate, ethyl laurate, ethyl myristate, ethyl octanoate, ethyl phenyl acetate, ethyl propionate, ethyl valerate, eugenol, furfural, gamma-decalactone, guaiacol, isoamyl alcohol, isoamyl hexanoate, isoamyl octanoate, isobutanol, isobutyl acetate, limonene, linalool, linalool oxide, linalyl acetate, maltol, methyl salicylate, myrcene, p-cresol, and whiskey lactone.
Embodiment 252 is the Scotch-like alcoholic beverage of embodiment 251, wherein the one or more additional VOCs comprise at least one compound selected from the group consisting of 1,1-diethoxyethane, 2-heptanone, 4-ethyl guaiacol, acetoin, acetophenone, diethyl malate, ethyl 3-hydroxyhexanoate, ethyl levulinate, ethyl trans-2-butenoate, ethyl undecanoate, ethyl-2-methylbutyrate, gamma-nonalactone, geraniol, isobutyraldehyde, methional, methyl octanoate, p-cymene, phenethyl butyrate, phenethyl formate, propanol, propyl acetate, and vanillyl ethyl ether.
Embodiment 253 is the Scotch-like alcoholic beverage of any one of embodiments 207 to 252, wherein the additional VOCs have less than about 95% identity to the VOCs in a single reference Scotch.
Embodiment 254 is the Scotch-like alcoholic beverage of any one of embodiments 207 to 253, wherein the Scotch-like alcoholic beverage comprises at least 61 additional VOCs and wherein no more than 60 of the additional VOCs are found in a single reference Scotch.
Embodiment 255 is the Scotch-like alcoholic beverage of any one of embodiments 207 to 254, further comprising one or more non-volatile compounds.
Embodiment 256 is the Scotch-like alcoholic beverage of embodiment 255, wherein the one or more non-volatile compounds comprise one or more compounds selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose. In some embodiments, a non-volatile compound that is not present in traditional Scotch can be selected from the group consisting of valine, and xylose.
Embodiment 257 is the Scotch-like alcoholic beverage of embodiment 256, wherein the one or more non-volatile compounds comprise one or more compounds selected from the group consisting of valine, xylose, and combinations thereof.
Embodiment 258 is the Scotch-like alcoholic beverage of any one of embodiments 255 to 257, wherein the one or more non-volatile compounds do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.
Embodiment 259 is the Scotch-like alcoholic beverage of embodiment 258, wherein the one or more non-volatiles do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, AMP, arabitol, egallic acid, homoserine, methyl gallate, pyridine, pyruvic acid, quinic acid, rhamnose, and salicylic acid.
Embodiment 260 is the Scotch-like alcoholic beverage of any one of embodiments 255 to 259, wherein the one or more non-volatile compounds comprise ribose in an amount of less than about 6 mg/L.
Embodiment 261 is the Scotch-like alcoholic beverage of any one of embodiments embodiment 255 to 260, wherein the one or more non-volatile compounds comprise fructose in an amount of less than about 9.6 mg/L.
Embodiment 262 is the Scotch-like alcoholic beverage of any one of embodiments embodiment 255 to 261, wherein the one or more non-volatile compounds comprise syringaldehyde in an amount of less than about 0.21 mg/L.
Embodiment 263 is the Scotch-like alcoholic beverage of any one of embodiments embodiment 255 to 262, wherein the one or more non-volatile compounds comprise vanillic acid in an amount of less than about 6.3 mg/L.
Embodiment 264 is the Scotch-like alcoholic beverage of any one of embodiments embodiment 255 to 263, wherein the one or more non-volatile compounds comprise vanillin in an amount of less than about 0.12 mg/L.
Embodiment 265 is the Scotch-like alcoholic beverage of any one of embodiments embodiment 255 to 264, wherein the one or more non-volatile compounds comprise acetovanillone in an amount of at least about 0.26 mg/L.
Embodiment 266 is the Scotch-like alcoholic beverage of any one of embodiments embodiment 255 to 265, wherein the one or more non-volatile compounds comprise choline in an amount of at least about 2.8 mg/L.
Embodiment 267 is the Scotch-like alcoholic beverage of any one of embodiments embodiment 255 to 266, wherein the one or more non-volatile compounds comprise citric acid in an amount of at least about 6.6 mg/L.
Embodiment 268 is the Scotch-like alcoholic beverage of any one of embodiments embodiment 255 to 267, wherein the one or more non-volatile compounds comprise fumaric acid in an amount of at least about 0.64 mg/L.
Embodiment 269 is the Scotch-like alcoholic beverage of any one of embodiments embodiment 255 to 268, wherein the one or more non-volatile compounds comprise glucosamine in an amount of at least about 0.55 mg/L.
Embodiment 270 is the Scotch-like alcoholic beverage of any one of embodiments embodiment 255 to 269, wherein the one or more non-volatile compounds comprise glucose in an amount of at least about 120 mg/L.
Embodiment 271 is the Scotch-like alcoholic beverage of any one of embodiments embodiment 255 to 270, wherein the one or more non-volatile compounds comprise mannitol in an amount of at least about 7.8 mg/L.
Embodiment 272 is the Scotch-like alcoholic beverage of any one of embodiments embodiment 255 to 271, wherein the one or more non-volatile compounds comprise sorbitol in an amount of at least about 5.8 mg/L.
Embodiment 273 is the Scotch-like alcoholic beverage of any one of embodiments embodiment 255 to 272, wherein the one or more non-volatile compounds comprise syringic acid in an amount of at least about 5.4 mg/L.
Embodiment 274 is the Scotch-like alcoholic beverage of any one of embodiments 255 to 273, wherein the one or more non-volatile compounds comprise trans-ferulic acid in an amount of less than about 0.5 mg/L.
Embodiment 275 is the Scotch-like alcoholic beverage of any one of embodiments 255 to 274, wherein the one or more non-volatile compounds comprise kelp or a kelp extract.
Embodiment 276 is the Scotch-like alcoholic beverage of any one of embodiments 255 to 275, wherein the one or more non-volatile compounds comprise glycerol, gum arabic, or glycerol and gym arabic.
Embodiment 277 is the Scotch-like alcoholic beverage of any one of embodiments 255 to 276, wherein the one or more non-volatile compounds comprise at least five compounds selected from the group consisting of D-glucuronic acid, fructose, glucose, lactic acid, malic acid, succinic acid, and tartaric acid.
Embodiment 278 is the Scotch-like alcoholic beverage of any one of embodiments 255 to 277, wherein the one or more non-volatile compounds comprise at least one compound selected from the group consisting of acetovanillone, choline, fumaric acid, GABA, gallic acid, glucosamine, inositol, mannitol, mannose, proline, ribose, sorbitol, syringaldehyde, syringic acid, trans-ferulic acid, tyrosine, valine, vanillic acid, and vanillin.
Embodiment 279 is the Scotch-like alcoholic beverage of any one of embodiments 255 to 278, wherein the one or more non-volatile compounds have less than about 60% identity to the non-volatile compounds in a single reference Scotch.
Embodiment 280 is a Scotch-like alcoholic beverage comprising:

ethanol;

water; and

one or more non-volatile compounds, wherein the one or more non-volatile compounds comprise one or more compounds selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose.

Embodiment 281 is the Scotch-like alcoholic beverage of embodiment 280, wherein the one or more non-volatile compounds comprise one or more compounds selected from the group consisting of valine, xylose, and combinations thereof.
Embodiment 282 is the Scotch-like alcoholic beverage of embodiment 280, wherein the one or more non-volatile compounds do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.
Embodiment 283 is the Scotch-like alcoholic beverage of embodiment 282, wherein the one or more non-volatile compounds do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, AMP, arabitol, egallic acid, homoserine, methyl gallate, pyridine, pyruvic acid, quinic acid, rhamnose, and salicylic acid.
Embodiment 284 is a Scotch-like alcoholic beverage comprising:

ethanol;

water; and

one or more non-volatile compounds, wherein the one or more non-volatile compounds do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.

Embodiment 285 is the Scotch-like alcoholic beverage of any one of embodiments 280 to 284, wherein the one or more non-volatile compounds comprise ribose in an amount of less than about 6 mg/L.
Embodiment 286 is the Scotch-like alcoholic beverage of any one of embodiments embodiment 280 to 285, wherein the one or more non-volatile compounds comprise fructose in an amount of less than about 9.6 mg/L.
Embodiment 287 is the Scotch-like alcoholic beverage of any one of embodiments embodiment 280 to 286, wherein the one or more non-volatile compounds comprise syringaldehyde in an amount of less than about 0.21 mg/L.
Embodiment 288 is the Scotch-like alcoholic beverage of any one of embodiments embodiment 280 to 287, wherein the one or more non-volatile compounds comprise vanillic acid in an amount of less than about 6.3 mg/L.
Embodiment 289 is the Scotch-like alcoholic beverage of any one of embodiments embodiment 280 to 288, wherein the one or more non-volatile compounds comprise vanillin in an amount of less than about 0.12 mg/L.
Embodiment 290 is the Scotch-like alcoholic beverage of any one of embodiments embodiment 280 to 289, wherein the one or more non-volatile compounds comprise acetovanillone in an amount of at least about 0.26 mg/L.
Embodiment 291 is the Scotch-like alcoholic beverage of any one of embodiments embodiment 280 to 290, wherein the one or more non-volatile compounds comprise choline in an amount of at least about 2.8 mg/L.
Embodiment 292 is the Scotch-like alcoholic beverage of any one of embodiments embodiment 280 to 291, wherein the one or more non-volatile compounds comprise citric acid in an amount of at least about 6.6 mg/L.
Embodiment 293 is the Scotch-like alcoholic beverage of any one of embodiments embodiment 280 to 292, wherein the one or more non-volatile compounds comprise fumaric acid in an amount of at least about 0.64 mg/L.
Embodiment 294 is the Scotch-like alcoholic beverage of any one of embodiments embodiment 280 to 293, wherein the one or more non-volatile compounds comprise glucosamine in an amount of at least about 0.55 mg/L.
Embodiment 295 is the Scotch-like alcoholic beverage of any one of embodiments embodiment 280 to 294, wherein the one or more non-volatile compounds comprise glucose in an amount of at least about 120 mg/L.
Embodiment 296 is the Scotch-like alcoholic beverage of any one of embodiments embodiment 280 to 295, wherein the one or more non-volatile compounds comprise mannitol in an amount of at least about 7.8 mg/L.
Embodiment 297 is the Scotch-like alcoholic beverage of any one of embodiments embodiment 280 to 296, wherein the one or more non-volatile compounds comprise sorbitol in an amount of at least about 5.8 mg/L.
Embodiment 298 is the Scotch-like alcoholic beverage of any one of embodiments embodiment 280 to 297, wherein the one or more non-volatile compounds comprise syringic acid in an amount of at least about 5.4 mg/L.
Embodiment 299 is the Scotch-like alcoholic beverage of any one of embodiments 280 to 298, wherein the one or more non-volatile compounds comprise trans-ferulic acid in an amount of less than about 0.5 mg/L.
Embodiment 300 is the Scotch-like alcoholic beverage of any one of embodiments 280 to 299, wherein the one or more non-volatile compounds comprise kelp or a kelp extract.
Embodiment 301 is the Scotch-like alcoholic beverage of any one of embodiments 280 to 300, wherein the one or more non-volatile compounds comprise glycerol, gum arabic, or glycerol and gym arabic.
Embodiment 302 is the Scotch-like alcoholic beverage of any one of embodiments 280 to 301, wherein the one or more non-volatile compounds comprise at least five compounds selected from the group consisting of D-glucuronic acid, fructose, glucose, lactic acid, malic acid, succinic acid, and tartaric acid.
Embodiment 303 is the Scotch-like alcoholic beverage of any one of embodiments 280 to 302, wherein the one or more non-volatile compounds comprise at least one compound selected from the group consisting of acetovanillone, choline, fumaric acid, GABA, gallic acid, glucosamine, inositol, mannitol, mannose, proline, ribose, sorbitol, syringaldehyde, syringic acid, trans-ferulic acid, tyrosine, valine, vanillic acid, and vanillin.
Embodiment 304 is the Scotch-like alcoholic beverage of any one of embodiments 280 to 303, wherein the one or more non-volatile compounds have less than about 60% identity to the non-volatile compounds in a single reference Scotch.
Embodiment 305. A method of making a Scotch-like alcoholic beverage, the method comprising:

providing an aqueous solution; and

adding to the aqueous solution ingredients comprising:
ethanol,
a source of a tannin,
a plurality of oak pieces or oak extract,
nonvolatile compounds, wherein the nonvolatile compounds comprise a sugar or sugar alcohol and an acid, and
VOCs, wherein the VOCs comprise an ester, an alcohol, an aldehyde or a ketone or both, and a terpene or an isoprenoid or both.
   Embodiment 306 is the method of embodiment 305, wherein the nonvolatile compounds comprise at least one compound selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose.
   Embodiment 307 is the method of embodiment 305 or embodiment 306, wherein the nonvolatile compounds do not comprise at least one compound selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.
   Embodiment 308 is the method of any one of embodiments 305 to 307, wherein the ingredients further comprise kelp or a kelp extract.
   Embodiment 309 is the method of embodiment 308, wherein the kelp is kombu kelp.
   Embodiment 310 is the method of any one of embodiments 305 to 309, wherein the ingredients further comprise glycerol, gum arabic, or glycerol and gym arabic.
   Embodiment 311 is the method of any one of embodiments 305 to 310, wherein the VOCs comprise at least one compound selected from the group consisting of (1R)-(−)-myrtenal, 3-ethyl-2-hydroxy-2-cyclopenten-1-one (ethyl cyclopentenolone), 1,4-cineole, 2-acetyl-1-methylpyrrole, 2-isopropyl-4-methyl thiazole, 3-methylthio hexyl acetate, 3-phenylpropanal, 4,5,6,7-tetrahydro-3,6-dimethylbenzofuran, 4-mercapto-4-methyl-2-pentanone, acetoin, allyl heptanoate, amyl butyrate, anisyl acetate, anisyl butyrate, b-caryophellene, benzyl alcohol, benzyl butyrate, benzyl formate, beta-pinene, butyl butyryllactate, butyl formate, butyraldehyde, cis-3-hexenyl butyrate, cis-3-hexenyl valerate, cis-6-nonen-1-ol, citronellal, D-carvone, d-fenchone, DL-3-methyl-2-butanol, ethyl 2-trans-4-cis-decadienoate, ethyl trans-3-hexenoate, ethyl(methylthio) acetate, eucalyptol, furufyl thioacetate, gamma-hexalactone, gamma-valerolactone, hexyl 3-methylbutanoate, hexyl isobutyrate, IBMP (3-Isobutyl-2-methoxypyrazine), L-menthyl acetate, maltol, methionyl acetate (3-methylthio-propylacetate), methyl anthranilate, methyl cyclopentenolone, myrcene, nonanoic acid, p-anisaldehyde, perillaldehyde, phenylacetaldehyde dimethyl acetal, propionaldehyde, propyl butyrate, tetrahydrolinalool, trans-2-hexen-1-al, valeraldehyde, valeric acid, vanillyl butyl ether.
   Embodiment 312 is the method of any one of embodiments 305 to 311, wherein the VOCs do not comprise at least one compound selected from the group consisting of 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone.
   Embodiment 313 is the method of any one of embodiments 305 to 312, wherein the source of a tannin is a tannin powder.
   Embodiment 314 is a method for making a Scotch-like alcoholic beverage, the method comprising combining:

water,

one or more acids,

one or more sugars,

one or more sugar alcohols,

one or more tannin components,

one or more flavorants,

ethanol, and

five or more additional VOCs selected from the group consisting of 1,1-diethoxyethane, 1-decanol, 1-octen-3-ol, 2,3-pentadione, 2-heptanone, 2-methyl-1-butanol, 2-phenylethanol, 2-phenylethylacetate, 3-carene, acetaldehyde, acetoin, acetophenone, amyl alcohol, a-terpineol, benzaldehyde, beta-ionone, beta-pinene, butanol, butyl acetate, cinnamaldehyde, delta-decalactone, diethyl malate, diethyl succinate, ethyl 3-hydroxyhexanoate, ethyl acetate, ethyl butanoate, ethyl cinnamate, ethyl decanoate, ethyl hexanoate, ethyl isovalerate, ethyl lactate, ethyl laurate, ethyl levulinate, ethyl myristate, ethyl octanoate, ethyl phenyl acetate, ethyl propionate, ethyl trans-2-butenoate, ethyl undecanoate, ethyl valerate, ethyl-2-methylbutyrate, eugenol, furfural, gamma-decalactone, gamma-nonalactone, geraniol, guaiacol, isoamyl alcohol, isoamyl hexanoate, isoamyl octanoate, isobutanol, isobutyl acetate, isobutyraldehyde, limonene, linalool, linalool oxide, linalyl acetate, maltol, methional, methyl octanoate, methyl salicylate, myrcene, p-cresol, p-cymene, phenethyl butyrate, phenethyl formate, propyl acetate, vanillyl ethyl ether, and whiskey lactone.

Embodiment 315 is the method of embodiment 314, wherein the one or more acids comprise tartaric acid, vanillic acid, syringic acid, malic acid, succinic acid, and lactic acid.
Embodiment 316 is the method of embodiment 314 or embodiment 315, wherein the one or more sugars comprise ribose, fructose, and glucose.
Embodiment 317 is the method of any one of embodiments 314 to 316, wherein the one or more sugar alcohols comprise mannitol and inositol.
Embodiment 318 is the method of any one of embodiments 314 to 317, wherein the one or more tannin components comprise gallic acid.
Embodiment 319 is the method of any one of embodiments 314 to 318, wherein the one or more flavorants comprise vanillin and syringaldehyde.
Embodiment 320 is the method of any one of embodiments 314 to 319, wherein the additional VOCs comprise at least one compound selected from the group consisting (1R)-(−)-myrtenal, 3-ethyl-2-hydroxy-2-cyclopenten-1-one (ethyl cyclopentenolone), 1,4-cineole, 2-acetyl-1-methylpyrrole, 2-isopropyl-4-methyl thiazole, 3-methylthio hexyl acetate, 3-phenylpropanal, 4,5,6,7-tetrahydro-3,6-dimethylbenzofuran, 4-mercapto-4-methyl-2-pentanone, acetoin, allyl heptanoate, amyl butyrate, anisyl acetate, anisyl butyrate, b-caryophellene, benzyl alcohol, benzyl butyrate, benzyl formate, beta-pinene, butyl butyryllactate, butyl formate, butyraldehyde, cis-3-hexenyl butyrate, cis-3-hexenyl valerate, cis-6-nonen-1-ol, citronellal, D-carvone, d-fenchone, DL-3-methyl-2-butanol, ethyl 2-trans-4-cis-decadienoate, ethyl trans-3-hexenoate, ethyl(methylthio) acetate, eucalyptol, furufyl thioacetate, gamma-hexalactone, gamma-valerolactone, hexyl 3-methylbutanoate, hexyl isobutyrate, IBMP (3-Isobutyl-2-methoxypyrazine), L-menthyl acetate, maltol, methionyl acetate (3-methylthio-propylacetate), methyl anthranilate, methyl cyclopentenolone, myrcene, nonanoic acid, p-anisaldehyde, perillaldehyde, phenylacetaldehyde dimethyl acetal, propionaldehyde, propyl butyrate, tetrahydrolinalool, trans-2-hexen-1-al, valeraldehyde, valeric acid, vanillyl butyl ether.
Embodiment 321 is the method of any one of embodiments 314 to 320, wherein the additional VOCs do not comprise one or more compounds selected from the group consisting 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone.
Embodiment 322 is the method of any one of embodiments 314 to 321, wherein the Scotch-like alcoholic beverage comprises one or more compounds selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose.
Embodiment 323 is the method of any one of embodiments 314 to 322, wherein the Scotch-like alcoholic beverage does not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.
Embodiment 324 is the method of making a Scotch-like alcoholic beverage, the method comprising:

combining ingredients comprising:
water;
ethanol; and
five or more additional VOCs, wherein at least five of the five or more additional VOCs are provided as separate ingredients.
   Embodiment 325 is the method of embodiment 324, comprising 10 or more additional VOCs, wherein at least 10 of the 10 or more additional VOCs are provided as separate ingredients.
   Embodiment 326 is the method of embodiment 324, comprising 15 or more additional VOCs, wherein at least 15 of the 15 or more additional VOCs are provided as separate ingredients.
   Embodiment 327 is the method of embodiment 324, comprising 20 or more additional VOCs, wherein at least 20 of the 20 or more additional VOCs are provided as separate ingredients.
   Embodiment 328 is the method of any one of embodiments 324-327, wherein the ingredients further comprise a non-volatile compound.
   Embodiment 329 is the method of embodiment 328, wherein the non-volatile compound is a sugar or a sugar alcohol, an acid, a pH-modifying salt, a nucleobase or nucleotide monophosphate, an amino acid or derivative thereof, or a combination thereof.
   Embodiment 330 is the method of embodiment 329, wherein the acid comprises D-glucuronic acid, tartaric acid, vanillic acid, syringic acid, malic acid, succinic acid, lactic acid, or a combination thereof.
   Embodiment 331 is the method of embodiment 329 or embodiment 330, wherein the sugar or sugar alcohol comprises ribose, fructose, glucose, mannitol, inositol, or a combination thereof.
   Embodiment 332 is the method of any one of embodiments 329-331, wherein the pH-modifying salt comprises potassium hydroxide.
   Embodiment 333 is the method of any one of embodiments 329-332, wherein the nucleobase or nucleotide monophosphate comprises adenine, guanine, guanosine monophosphate, inosine monophosphate, or a combination thereof.
   Embodiment 334 is the method of any one of embodiments 329-333, wherein the amino acid or derivative thereof comprises leucine, phenylalanine, methionine, gamma-aminobutyric acid (GABA), tyrosine, serine, aspartic acid, glucosamine, histidine, lysine, isoleucine, carnitine, tryptophan, proline, valine, b-alanine, threonine, glutamine, asparagine, glutamic acid, cysteine, arginine, ornithine, trans 4-hydroxy-L-proline, citrulline, tyramine, or a combination thereof.
   Embodiment 335 is the method of any one of embodiments 329-332, wherein the non-volatile compound comprises a coloring agent.
   Embodiment 336 is the method of any one of embodiments 329-335, wherein the non-volatile compound comprises an emulsifier.
   Embodiment 337 is the method of any one of embodiments 329-336, wherein the non-volatile compound comprises gum arabic.
   Embodiment 338 is the method of any one of embodiments 329-337, wherein the non-volatile compound comprises at least one non-volatile compound that is not present in a corresponding traditional alcoholic beverage.
   Embodiment 339 is the method of any one of embodiments 329-338, wherein the non-volatile compound does not comprise at least one non-volatile compound that is present in a corresponding traditional alcoholic beverage.
   Embodiment 340 is the method of any one of embodiments 324-339, wherein the one or more additional VOCs comprise at least one VOC that is not present in a corresponding traditional alcoholic beverage.
   Embodiment 341 is the method of any one of embodiments 324-340, wherein the one or more additional VOCs do not comprise at least one VOC that is present in a corresponding traditional alcoholic beverage.
   Embodiment 342 is the method of any one of embodiments 324-341, wherein the Scotch-like alcoholic beverage is the Scotch-like alcoholic beverage of any one of embodiments 1-304.
   Embodiment 343 is a method of making a Scotch-like alcoholic beverage, the method comprising:

providing a composition comprising:
ethanol;
water; and
one or more additional VOCs, wherein at least one of the one or more additional VOCs is present in a concentration of at least about 2-fold the concentration of the same VOC in a corresponding traditional Scotch, and

adding to the composition ethanol, water, or a combination thereof such that the concentration of the at least one additional VOC is reduced to about the concentration of the same VOC in a corresponding traditional Scotch.

Embodiment 344 is the method of embodiment 343, wherein the one or more additional VOCs comprise at least one VOC that is not present in a corresponding traditional Scotch.
Embodiment 345 is the method of embodiment 343 or embodiment 344, wherein the one or more additional VOCs do not comprise at least one VOC that is present in a corresponding traditional Scotch.
Embodiment 346 is the method of any one of embodiments 343-345, wherein the Scotch-like alcoholic beverage further comprises one or more non-volatile compounds, and wherein the one or more non-volatile compounds comprise at least one non-volatile compound that is not present in a corresponding traditional Scotch.
Embodiment 347 is the method of any one of embodiments 343-346, wherein the Scotch-like alcoholic beverage further comprises one or more non-volatile compounds, and wherein the one or more non-volatile compounds do not comprise at least one non-volatile compound that is present in a corresponding traditional Scotch.
Embodiment 348 is the method of any one of embodiments 343-347, wherein the one or more additional VOCs are present in the composition in a concentration of at least about 5-fold the concentration of the same VOCs in a corresponding traditional Scotch.
Embodiment 349 is the method of any one of embodiments 343-347, wherein the one or more additional VOCs are present in the composition in a concentration of at least about 10-fold the concentration of the same VOC in a corresponding traditional Scotch.
Embodiment 350 is the method of any one of embodiments 343-347, wherein the one or more additional VOCs are present in the composition in a concentration of at least about 15-fold the concentration of the same VOCs in a corresponding traditional Scotch.
Embodiment 351 is the method of any one of embodiments 343-347, wherein the one or more additional VOCs are present in the composition in a concentration of at least about 20-fold the concentration of the same VOCs in a corresponding traditional Scotch.
Embodiment 352 is the method of any one of embodiments 343-351, wherein the composition comprises five or more additional VOCs, wherein at least five of the five or more additional VOCs are present in a concentration of at least about 5-fold the concentration of the same VOCs in a corresponding traditional Scotch.
Embodiment 353 is the method of any one of embodiments 343-352, wherein the total amount (in mg/L) of the one or more additional VOCs in the composition is greater than 5-fold the total amount of the same VOCs (in mg/L) in a corresponding traditional Scotch.
Embodiment 354 is the method of any one of embodiments 343-353, wherein after the adding step, the Scotch-like alcoholic beverage is the Scotch-like alcoholic beverage of any one of embodiments 1-304.
Embodiment 355 is a method of making a Scotch-like alcoholic beverage, the method comprising:

providing a composition comprising:
ethanol;
water; and
one or more additional non-volatile compounds, wherein at least one of the one or more non-volatile compounds is present in a concentration of at least about 2-fold the concentration of the same non-volatile compound in a corresponding traditional Scotch; and

adding to the composition ethanol, water, or a combination thereof such that the concentration of the at least one non-volatile compound is reduced to about the concentration of the same non-volatile compound in a corresponding traditional Scotch.

Embodiment 356 is the method of embodiment 355, wherein the one or more non-volatile compounds comprise at least one non-volatile compound that is not present in a corresponding traditional Scotch.
Embodiment 357 is the method of embodiment 355 or embodiment 356, wherein the one or more non-volatile compounds do not comprise at least one non-volatile compound that is present in a corresponding traditional Scotch.
Embodiment 358 is the method of any one of embodiments 355-357, wherein the Scotch-like alcoholic beverage further comprises one or more additional VOCs, and wherein the one or more additional VOCs comprise at least one VOC that is not present in a corresponding traditional Scotch.
Embodiment 359 is the method of any one of embodiments 355-358, wherein the Scotch-like alcoholic beverage further comprises one or more additional VOCs, and wherein the one or more additional VOCs do not comprise at least one VOC that is present in a corresponding traditional Scotch.
Embodiment 360 is the method of any one of embodiments 355-359, wherein the one or more non-volatile compounds are present in the composition in a concentration of at least about 5-fold the concentration of the same non-volatile compounds in a corresponding traditional Scotch.
Embodiment 361 is the method of any one of embodiments 355-359, wherein the one or more non-volatile compounds are present in the composition in a concentration of at least about 10-fold the concentration of the same non-volatile compounds in a corresponding traditional Scotch.
Embodiment 362 is the method of any one of embodiments 355-359, wherein the one or more non-volatile compounds are present in the composition in a concentration of at least about 15-fold the concentration of the same non-volatile compounds in a corresponding traditional Scotch.
Embodiment 363 is the method of any one of embodiments 355-359, wherein the one or more non-volatile compounds are present in the composition in a concentration of at least about 20-fold the concentration of the same non-volatile compounds in a corresponding traditional Scotch.
Embodiment 364 is the method of any one of embodiments 355-363, wherein the composition comprises five or more non-volatile compounds, wherein at least five of the five or more non-volatile compounds are present in a concentration of at least about 5-fold the concentration of the same non-volatile compounds in a corresponding traditional Scotch.
Embodiment 365 is the method of any one of embodiments 355-364, wherein the total amount (in mg/L) of the one or more non-volatile compounds in the composition is greater than 5-fold the total amount of the same non-volatile compounds (in mg/L) in a corresponding traditional Scotch.
Embodiment 366 is the method of any one of embodiments 355-365, wherein after the adding step, the Scotch-like alcoholic beverage is the Scotch-like alcoholic beverage of any one of embodiments 1-304.
Embodiment 367 is a method of making a Scotch-like alcoholic beverage concentrate, the method comprising combining:

ethanol;

water; and

one or more additional VOCs, wherein at least one of the one or more additional VOCs is present in a concentration of at least about 2-fold the concentration of the same VOC in a corresponding traditional Scotch.

Embodiment 368 is the method of embodiment 367, wherein the one or more additional VOCs comprise at least one VOC that is not present in a corresponding traditional Scotch.
Embodiment 369 is the method of embodiment 367 or embodiment 368, wherein the one or more additional VOCs do not comprise at least one VOC that is present in a corresponding traditional Scotch.
Embodiment 370 is the method of any one of embodiments 367-369, wherein the Scotch-like alcoholic beverage concentrate further comprises one or more non-volatile compounds, and wherein the one or more non-volatile compounds comprise at least one non-volatile compound that is not present in a corresponding traditional Scotch.
Embodiment 371 is the method of any one of embodiments 367-370, wherein the Scotch-like alcoholic beverage concentrate further comprises one or more non-volatile compounds, and wherein the one or more non-volatile compounds do not comprise at least one non-volatile compound that is present in a corresponding traditional Scotch.
Embodiment 372 is the method of any one of embodiments 367-371, wherein the one or more additional VOCs are present in the concentrate in a concentration of at least about 5-fold the concentration of the same VOCs in a corresponding traditional Scotch.
Embodiment 373 is the method of any one of embodiments 367-371, wherein the one or more additional VOCs are present in the concentrate in a concentration of at least about 10-fold the concentration of the same VOCs in a corresponding traditional Scotch.
Embodiment 374 is the method of any one of embodiments 367-371, wherein the one or more additional VOCs are present in the concentrate in a concentration of at least about 15-fold the concentration of the same VOCs in a corresponding traditional Scotch.
Embodiment 375 is the method of any one of embodiments 367-371, wherein the one or more additional VOCs are present in the concentrate in a concentration of at least about 20-fold the concentration of the same VOC in a corresponding traditional Scotch.
Embodiment 376 is the method of any one of embodiments 367-375, wherein the concentrate comprises five or more additional VOCs, wherein at least five of the five or more additional VOCs are present in a concentration of at least about 5-fold the concentration of the same VOCs in a corresponding traditional Scotch.
Embodiment 377 is the method of any one of embodiments 367-376, wherein the total amount (in mg/L) of the one or more additional VOCs in the concentrate is greater than 5-fold the total amount of the same VOCs (in mg/L) in a corresponding traditional Scotch.
Embodiment 378 is the method of any one of embodiments 367-377, wherein upon dilution of the Scotch-like alcoholic beverage concentrate to a Scotch-like alcoholic beverage, the Scotch-like alcoholic beverage is the Scotch-like alcoholic beverage of any one of embodiments 1-304.
Embodiment 379 is a method of making a Scotch-like alcoholic beverage concentrate, the method comprising combining:

ethanol;

water; and

one or more non-volatile compounds, wherein at least one of the one or more non-volatile compounds is present in a concentration of at least about 2-fold the concentration of the same non-volatile compound in a corresponding traditional Scotch.

Embodiment 380 is the method of embodiment 379, wherein the one or more non-volatile compounds comprise at least one non-volatile compound that is not present in a corresponding traditional Scotch.
Embodiment 381 is the method of embodiment 379 or embodiment 380, wherein the one or more non-volatile compounds do not comprise at least one non-volatile compound that is present in a corresponding traditional Scotch.
Embodiment 382 is the method of any one of embodiments 379-381, wherein the Scotch-like alcoholic beverage concentrate further comprises one or more additional VOCs, and wherein the one or more additional VOCs comprise at least one VOC that is not present in a corresponding traditional Scotch.
Embodiment 383 is the method of any one of embodiments 379-382, wherein the Scotch-like alcoholic beverage concentrate further comprises one or more additional VOCs, and wherein the one or more additional VOCs do not comprise at least one VOC that is present in a corresponding traditional Scotch.
Embodiment 384 is the method of any one of embodiments 379-383, wherein the one or more non-volatile compounds are present in the concentrate in a concentration of at least about 5-fold the concentration of the same non-volatile compounds in a corresponding traditional Scotch.
Embodiment 385 is the method of any one of embodiments 379-383, wherein the one or more non-volatile compounds are present in the concentrate in a concentration of at least about 10-fold the concentration of the same non-volatile compounds in a corresponding traditional Scotch.
Embodiment 386 is the method of any one of embodiments 379-383, wherein the one or more non-volatile compounds are present in the concentrate in a concentration of at least about 15-fold the concentration of the same non-volatile compounds in a corresponding traditional Scotch.
Embodiment 387 is the method of any one of embodiments 379-383, wherein the one or more non-volatile compounds are present in the concentrate in a concentration of at least about 20-fold the concentration of the same non-volatile compounds in a corresponding traditional Scotch.
Embodiment 388 is the method of any one of embodiments 379-387, wherein the concentrate comprises five or more non-volatile compounds, wherein at least five of the five or more non-volatile compounds are present in a concentration of at least about 5-fold the concentration of the same non-volatile compounds in a corresponding traditional Scotch.
Embodiment 389 is the method of any one of embodiments 379-388, wherein the total amount (in mg/L) of the one or more non-volatile compounds in the concentrate is greater than 5-fold the total amount of the same non-volatile compounds (in mg/L) in a corresponding traditional Scotch.
Embodiment 390 is the method of any one of embodiments 379-389, wherein upon dilution of the Scotch-like alcoholic beverage to a Scotch-like alcoholic beverage, the Scotch-like alcoholic beverage is the Scotch-like alcoholic beverage of any one of embodiments 1-304.
Embodiment 391 is a Scotch-like alcoholic beverage concentrate comprising:

ethanol;

water; and

one or more additional VOCs, wherein at least one of the one or more additional VOCs is present in a concentration of at least about 2-fold the concentration of the same VOC in a corresponding traditional Scotch.

Embodiment 392 is the Scotch-like alcoholic beverage concentrate of embodiment 391, wherein the one or more additional VOCs comprise at least one VOC that is not present in a corresponding traditional Scotch.
Embodiment 393 is the Scotch-like alcoholic beverage concentrate of embodiment 391 or embodiment 392, wherein the one or more additional VOCs do not comprise at least one VOC that is present in a corresponding traditional Scotch.
Embodiment 394 is the Scotch-like alcoholic beverage concentrate of any one of embodiments 391-393, wherein the Scotch-like alcoholic beverage concentrate further comprises one or more non-volatile compounds, and wherein the one or more non-volatile compounds comprise at least one non-volatile compound that is not present in a corresponding traditional Scotch.
Embodiment 395 is the Scotch-like alcoholic beverage concentrate of any one of embodiments 391-394, wherein the Scotch-like alcoholic beverage concentrate further comprises one or more non-volatile compounds, and wherein the one or more non-volatile compounds do not comprise at least one non-volatile compound that is present in a corresponding traditional Scotch.
Embodiment 396 is the Scotch-like alcoholic beverage concentrate of any one of embodiments 391-395, wherein the one or more additional VOCs are present in the concentrate in a concentration of at least about 5-fold the concentration of the same VOCs in a corresponding traditional Scotch.
Embodiment 397 is the Scotch-like alcoholic beverage concentrate of any one of embodiments 391-395, wherein the one or more additional VOCs are present in the concentrate in a concentration of at least about 10-fold the concentration of the same

VOCs in a corresponding traditional Scotch.

Embodiment 398 is the Scotch-like alcoholic beverage concentrate of any one of embodiments 391-395, wherein the one or more additional VOCs are present in the concentrate in a concentration of at least about 15-fold the concentration of the same VOCs in a corresponding traditional Scotch.
Embodiment 399 is the Scotch-like alcoholic beverage concentrate of any one of embodiments 391-395, wherein the one or more additional VOCs are present in the concentrate in a concentration of at least about 20-fold the concentration of the same VOCs in a corresponding traditional Scotch.
Embodiment 400 is the Scotch-like alcoholic beverage concentrate of any one of embodiments 391-399, wherein the concentrate comprises five or more additional VOCs, wherein at least five of the five or more additional VOCs are present in a concentration of at least about 5-fold the concentration of the same VOCs in a corresponding traditional Scotch.
Embodiment 401 is the Scotch-like alcoholic beverage concentrate of any one of embodiments 391-400, wherein the total amount (in mg/L) of the one or more additional VOCs in the concentrate is greater than 5-fold the total amount of the same VOCs (in mg/L) in a corresponding traditional Scotch.
Embodiment 402 is the Scotch-like alcoholic beverage of any one of embodiments 391-401, wherein upon dilution of the Scotch-like beverage concentrate to a Scotch-like alcoholic beverage, the Scotch-like alcoholic beverage is the Scotch-like alcoholic beverage of any one of embodiments 1-304.
Embodiment 403 is a Scotch-like alcoholic beverage concentrate comprising:

ethanol;

water; and

one or more non-volatile compounds, wherein at least one of the one or more non-volatile compounds is present in a concentration of at least about 2-fold the concentration of the same non-volatile compound in a corresponding traditional Scotch.

Embodiment 404 is the Scotch-like alcoholic beverage concentrate of embodiment 403, wherein the one or more non-volatile compounds comprise at least one non-volatile compound that is not present in a corresponding traditional Scotch.
Embodiment 405 is the Scotch-like alcoholic beverage concentrate embodiment 403 or 404, wherein the one or more non-volatile compounds do not comprise at least one non-volatile compound that is present in a corresponding traditional Scotch.
Embodiment 406 is the Scotch-like alcoholic beverage concentrate of any one of embodiments 403-405, wherein the Scotch-like alcoholic beverage concentrate further comprises one or more additional VOCs, and wherein the one or more additional VOCs comprise at least one VOC that is not present in a corresponding traditional Scotch.
Embodiment 407 is the Scotch-like alcoholic beverage concentrate of any one of embodiments 403-406, wherein the Scotch-like alcoholic beverage concentrate further comprises one or more additional VOCs, and wherein the one or more additional VOCs do not comprise at least one VOC that is present in a corresponding traditional Scotch.
Embodiment 408 is the Scotch-like alcoholic beverage concentrate of any one of embodiments 403-407, wherein the one or more non-volatile compounds is present in the concentrate in a concentration of at least about 5-fold the concentration of the same non-volatile compound in a corresponding traditional Scotch.
Embodiment 409 is the Scotch-like alcoholic beverage concentrate of any one of embodiments 403-407, wherein the one or more non-volatile compounds is present in the concentrate in a concentration of at least about 10-fold the concentration of the same non-volatile compound in a corresponding traditional Scotch.
Embodiment 410 is the Scotch-like alcoholic beverage concentrate of any one of embodiments 403-407, wherein the one or more non-volatile compounds is present in the concentrate in a concentration of at least about 15-fold the concentration of the same non-volatile compound in a corresponding traditional Scotch.
Embodiment 411 is the Scotch-like alcoholic beverage concentrate of any one of embodiments 403-407, wherein the one or more non-volatile compounds is present in the concentrate in a concentration of at least about 20-fold the concentration of the same non-volatile compound in a corresponding traditional Scotch.
Embodiment 412 is the Scotch-like alcoholic beverage concentrate of any one of embodiments 403-411, wherein the concentrate comprises five or more non-volatile compounds, wherein at least five of the five or more additional non-volatile compounds are present in a concentration of at least about 5-fold the concentration of the same non-volatile compounds in a corresponding traditional Scotch.
Embodiment 413 is the Scotch-like alcoholic beverage concentrate of any one of embodiments 403-412, wherein the total amount (in mg/L) of the one or more non-volatile compounds in the concentrate is greater than 5-fold the total amount of the same non-volatile compounds (in mg/L) in a corresponding traditional Scotch.
Embodiment 414 is the Scotch-like alcoholic beverage of any one of embodiments 403-413, wherein upon dilution of the Scotch-like alcoholic beverage concentrate to a Scotch-like alcoholic beverage, the Scotch-like alcoholic beverage is the Scotch-like alcoholic beverage of any one of embodiments 1-304.

The invention will be further described in the following examples, which do not limit the scope of the invention described in the claims.

### EXAMPLES

### Example 1—Method for Making Scotch-Like Alcoholic Beverages

A 10 L batch of Scotch replica was prepared from individual components. The ingredients included:

| | | |
|---|---|---|
| 458 mg tartaric acid | 53.5 mg ribose | 481 μL malic acid |
| | | (1 g/50 mL H₂O) |
| 104 mg gallic acid | 19.8 mg fructose | 228 μL succinic acid |
| | | (1 g/50 mL H₂O) |
| 10.6 mg vanillic acid | 9.52 mg mannitol | 42.4 μL lactic acid |
| | | [88% (stock)] |
| 99.8 mg syringic acid | 231 mg glucose | 4240 mL Ethanol |
| | | (75.5% EtOH) |
| 54.2 mg vanillin | 18.9 mg inositol | 500 mL Tannin solution |
| 51.9 mg | 1900 mL oak | ~200 mL VOC solution |
| syringaldehyde | extract | (TABLE 1A, TABLE 1B) |

To prepare oak extract, Oak chips were ground, and 35 g of ground chips was placed into each of two 1 L Erlenmeyer flasks. To each flask, 1 L 40% EtOH solution (530 mL Ethanol, 470 mL tap water) was added. The flasks were covered with parafilm, swirled vigorously, and stored in the dark for 24 hours. The extracted oak was vacuum filtered; the filtrate was saved and the remaining wood chips were discarded. The filtrate was divided into 40 Falcon tubes (˜47 mL each), which were centrifuged for 5 minutes at 5000 rpm.

To prepare Tannin solution, 0.8 g Tannin powder was added to 50 mL water in a Falcon tube, and mixed by vortexing. This was repeated nine times to yield 10 tubes of Tannin solution. Each tube was centrifuged at 5000 rpm for 5 minutes and decanted twice, saving the liquid portion both times.

To prepare the Scotch replica, about 500 mL water was placed in a beaker with a stir bar on a stir plate. All dry chemicals were weighed out and added to the water in the beaker. 240 mL Ethanol was added to the beaker, followed by the malic acid, succinic acid, and lactic acid. Once the mixture was uniform, it was poured into a 2 L graduated cylinder (without the stir bar). All (500 mL) of the prepared Tannin solution was added to the cylinder, which was then filled to 2 L with water. The contents of cylinder were poured into a 10 L carboy. Oak extract from all 40 tubes was added into the 2 L cylinder, and water was added to 2 L. The diluted oak extract was added to the carboy. The remaining Ethanol (4 L) was then added to the carboy using the 2 L cylinder. Finally, the VOCs and remaining Ethanol (500 mL) were added to the cylinder, which was topped up to 2 L with water and added to the carboy. The Scotch was carefully but vigorously shaken to mix the contents.

Additional non-nonvolatile formulations are shown in TABLE 1C.

The Scotch replica had a final ABV of 43%, and was identical to Scotch crafted by traditional methods in terms of color; like many Scotches, it had an amber color with characteristic “tears” on the sides of the glass upon swirling, and the mouthfeel (viscosity) was comparable to that of traditional Scotch. Much like traditionally-made Scotch, the Scotch replica had peaty, grain-like, fruity, floral, and woody aromas. In particular, the Scotch replica had a grain-like character on the nose, dominated with sweet wood-like aromas including vanilla and baking spices, along with aromas reminiscent of ripe apple, caramel, and very light hints of smoke. The taste characteristics of the Scotch replica, including sweetness, alcoholic perception, flavors, and finish or length also were analogous to those of traditionally-made Scotches. In particular, on the palate, the Scotch replica had a creamy body with some spicy heat and an echo of the flavors found on the nose.

It is noted that the above process, and similar processes using variations of the VOC and non-volatile ingredient lists, can be scaled up for commercial production of a Scotch-like alcoholic beverage. Such scaled up processes (e.g., to generate 1000 L or more) can utilize tanks or vats for carbonation.

It also is noted that in some cases, a portion of the water that is included in a Scotch replica can be replaced with a neutral spirit such as, without limitation, corn whiskey. When such a substitution is made, the neutral spirit is added such that the ethanol provided by the neutral spirit is not less than 5%, on a proof gallon basis, of the total amount of ethanol in the Scotch replica. For example, 10 L of a Scotch replica containing 3.1 L Ethanol (192 proof), 0.38 L of corn whiskey (135 proof) and 1.8 L of oak extract (151 proof) contains 6.4% alcohol, on a proof gallon basis, from the corn whiskey, which is 2.6% ABV.

As an example, a 1000 L batch of Scotch replica was prepared from individual components, including:

| | Concentration in final product |
|---|---|
| Component | (mg/L, unless denoted otherwise) |
| Ethanol (192 proof) | 310 L (per 1000 L) |
| Corn whiskey | 38 L (per 1000 L) |
| Filtered water | 506 L (per 1000 L; 420 L + 86 L |
| | from 5x wood-tannin) |
| Oak Wood Chips | 1750-28000 |
| Tannin | 0.20-3.20 |
| Ethanol (151 proof) | 114 L (per 1000 L; from 5X wood-tannin) |
| Malic acid | 1.09-17.36 |
| Tartaric acid | 16.79-268.60 |
| Lactic acid | 2.95-47.20 |
| Citric acid | 4.25-68.00 |
| D-Glucuronic acid | 2.89-46.24 |
| Succinic acid | 0.71-11.40 |
| Cinnamic acid | 0.50-8.00 |
| Fructose | 5.75-92.00 |
| Glucose | 11.25-180.00 |
| Glycerol | 2000-32000 |
| Gum Arabic | 0.25-4.00 |

First, 1000 L of a 5× wood-tannin solution was prepared by placing 8750-140000 g of American Oak Wood chips and 1000-16000 g of Tannin in a filter bag, and submerging in a mixture of 570 L ethanol (151 proof) and 430 L filtered water. The mixture was recirculated for 18-24 hours, and then filtered through a 1 micron filter pad. Malic acid (5.50-88.00 g), tartaric acid (85.00-1360.00 g), lactic acid (14.75-236.00 g), citric acid (21.25-340.00 g), D-glucuronic acid (14.5-232.00 g), succinic acid (3.50-56.00 g), and cinnamic acid (2.50-40.00 g) were added to the mixture, which was then recirculated until all ingredients were dissolved (about 5 minutes).

Separately, 310 L of ethanol (192 proof), 38 L of corn whiskey, and 420 L of filtered water were added to a mixing tank and recirculated for 10-15 minutes. Fructose (5.75-92.00 g), glucose (11.25-180 g), glycerol (2000-32000 g), and gum arabic (0.25-4 g) were added to the mixture, which was then recirculated until all ingredients were dissolved (about 15-20 minutes). The VOCs (3-5 L total) and 200 L of the wood-tannin solution were added to the mixture and recirculated for 30 minutes. The mixture was pad filtered (0.5 micron filter) and held until bottling.

It is noted that while Scotch replicas can include volatile and non-volatile compounds as listed herein, the added compounds may react with one another to generate additional compounds, or to change the effective amount of one or more of the added compounds within the Scotch replica formulation.

TABLE 1A
VOCs in Scotch formulations (mg/L)

| Values in mg/L | Formulation 1 | Formulation 3 | Formulation 4 | Formulation 2 | Formulation 5 |
|---|---|---|---|---|---|
| 1,1-diethoxyethane | 0.0E+00 − 3.9E+00 | 2.1E+00 − 3.9E+00 | optional | 2.1E+00 − 6.6E+00 | 0.0E+00 − 7.4E+00 |
| 1-decanol | 6.8E−03 − 2.5E−02 | 6.8E−03 − 1.3E−02 | 2.2E−03 − 4.0E−03 | 6.8E−03 − 3.0E−02 | 6.8E−03 − 1.3E−02 |
| 1-octanol | optional | optional | optional | 4.4E−02 − 8.2E−02 | optional |
| 1-octen-3-ol | 6.9E−03 − 2.6E−02 | 6.9E−03 − 1.3E−02 | 4.6E−03 − 8.6E−03 | 6.9E−03 − 2.5E−02 | 6.9E−03 − 1.3E−02 |
| 2,3-pentadione | 6.9E−04 − 2.6E−03 | 6.9E−04 − 1.3E−03 | 3.9E−04 − 7.2E−04 | 0.0E+00 − 1.3E−03 | 6.9E−04 − 1.3E−03 |
| 2-heptanone | 0.0E+00 − 4.2E−02 | optional | optional | 2.2E−02 − 7.7E−02 | optional |
| 2-methyl-1-butanol | 2.5E+00 − 4.7E+00 | 2.5E+00 − 4.7E+00 | 2.8E+00 − 5.2E+00 | 2.5E+00 − 1.0E+01 | 2.5E+00 − 4.7E+00 |
| 2-methylbutyl acetate | optional | optional | optional | 3.2E−02 − 5.9E−02 | optional |
| 2-methylbutyraldehyde | optional | 2.5E−02 − 4.6E−02 | optional | 0.0E+00 − 3.0E−01 | 0.0E+00 − 9.1E−02 |
| 2-nonanone | 0.0E+00 − 1.6E−03 | optional | 4.0E−03 − 7.5E−03 | 0.0E+00 − 1.4E−02 | optional |
| 2-phenylethanol | 2.1E+00 − 7.8E+00 | 2.1E+00 − 3.9E+00 | 1.6E+00 − 3.0E+00 | 2.1E+00 − 4.3E+00 | 2.1E+00 − 3.9E+00 |
| 2-phenylethylacetate | 5.8E−02 − 1.1E−01 | 5.8E−02 − 1.1E−01 | 6.5E−02 − 1.2E−01 | 5.8E−02 − 2.3E−01 | 5.8E−02 − 1.1E−01 |
| 2-undecanone | optional | optional | optional | 1.4E−03 − 2.6E−03 | optional |
| 3-carene | 6.7E−04 − 1.2E−01 | 6.7E−04 − 1.2E−03 | optional | 6.7E−04 − 2.5E−02 | 6.7E−04 − 1.2E−03 |
| 4-carvomenthenol | 0.0E+00 − 1.3E−03 | optional | 7.6E−04 − 1.4E−03 | optional | optional |
| 4-Ethyl Guaiacol | 0.0E+00 − 7.9E−02 | optional | optional | 0.0E+00 − 3.9E−01 | optional |
| 4-Ethyl Phenol | 0.0E+00 − 7.2E−03 | optional | 1.5E−03 − 2.9E−03 | 0.0E+00 − 1.1E−01 | optional |
| acetaldehyde | 2.1E−01 − 3.9E−01 | 2.1E−01 − 3.9E−01 | 6.4E−02 − 1.2E−01 | 2.1E−01 − 3.9E−01 | 2.1E−01 − 3.9E−01 |
| acetoin | 0.0E+00 − 6.2E−02 | 2.6E−02 − 4.7E−02 | optional | 2.6E−02 − 5.4E−02 | 2.6E−02 − 4.7E−02 |
| acetophenone | 0.0E+00 − 6.9E−03 | optional | optional | 3.7E−03 − 1.7E−02 | optional |
| amyl alcohol | 1.0E−01 − 3.8E−01 | 1.0E−01 − 1.9E−01 | 2.9E−02 − 5.5E−02 | 1.0E−01 − 2.0E−01 | 1.0E−01 − 1.9E−01 |
| amyl butyrate | optional | optional | 1.2E−06 − 2.2E−06 | 0.0E+00 − 1.0E−01 | optional |
| a-terpineol | 2.1E−02 − 7.7E−02 | 4.2E−02 − 7.7E−02 | 0.0E+00 − 2.8E−02 | 4.2E−02 − 1.3E−01 | 4.2E−02 − 7.7E−02 |
| benzaldehyde | 1.0E−03 − 1.9E−03 | 1.0E−03 − 1.9E−03 | 0.0E+00 − 2.3E−03 | 1.0E−03 − 1.8E−01 | 1.0E−03 − 1.9E−03 |
| benzyl acetate | optional | optional | optional | 1.7E−03 − 3.1E−03 | optional |
| beta-ionone | 6.8E−05 − 2.5E−04 | 6.8E−05 − 1.3E−04 | 8.9E−05 − 1.6E−04 | 6.8E−05 − 1.9E−02 | 6.8E−05 − 1.3E−04 |
| beta-pinene | 1.4E−05 − 5.1E−05 | 1.4E−05 − 2.6E−05 | 1.8E−04 − 3.4E−04 | 0.0E+00 − 2.6E−05 | 1.4E−05 − 2.6E−05 |
| butanol | 2.9E+00 − 1.1E+01 | 2.9E+00 − 5.3E+00 | 2.0E−01 − 3.7E−01 | 2.9E+00 − 5.4E+00 | 2.9E+00 − 5.3E+00 |
| butyl acetate | 3.5E−02 − 1.3E−01 | 3.5E−02 − 6.6E−02 | 2.2E−02 − 4.1E−02 | 3.5E−02 − 1.3E+00 | 3.5E−02 − 6.6E−02 |
| butyl formate | 0.0E+00 − 4.7E−01 | optional | 2.6E−01 − 4.8E−01 | optional | optional |
| Butyraldehyde | optional | optional | optional | 0.0E+00 − 2.6E−02 | optional |
| butyric acid | 0.0E+00 − 3.8E−02 | optional | 1.6E−03 − 3.0E−03 | 0.0E+00 − 2.6E−01 | optional |
| carvone | optional | optional | optional | 8.1E−03 − 1.5E−02 | optional |
| Cinnamaldehyde | 1.4E−05 − 2.6E−05 | 1.4E−05 − 2.6E−05 | 6.4E−05 − 1.2E−04 | 1.4E−05 − 2.6E−02 | 1.4E−05 − 2.6E−05 |
| citronellol | 0.0E+00 − 1.3E−02 | optional | optional | 0.0E+00 − 1.3E−01 | optional |
| delta-decalactone | 1.4E+00 − 2.6E+00 | 1.4E+00 − 2.6E+00 | optional | 6.9E−01 − 2.6E+00 | 1.4E+00 − 2.6E+00 |
| diethyl malate | 0.0E+00 − 1.5E+00 | 1.6E+00 − 3.1E+00 | optional | 8.1E−02 − 1.5E+00 | 1.6E+00 − 3.1E+00 |
| diethyl succinate | 6.7E−02 − 1.3E−01 | 6.7E−02 − 1.3E−01 | 5.1E−02 − 9.5E−02 | 5.7E−02 − 1.3E−01 | 6.7E−02 − 1.3E−01 |
| ethyl 3- | 0.0E+00 − 1.0E−02 | 5.6E−03 − 1.0E−02 | optional | 0.0E+00 − 1.0E−02 | 5.6E−03 − 1.0E−02 |
| hydroxyhexanoate | | | | | |
| ethyl acetate | 5.8E+00 − 2.2E+01 | 5.8E+00 − 1.1E+01 | 2.4E+01 − 4.5E+01 | 5.8E+00 − 5.0E+01 | 5.8E+00 − 1.1E+01 |
| ethyl benzoate | optional | 6.0E−03 − 1.1E−02 | optional | 0.0E+00 − 1.5E−02 | 6.0E−03 − 1.1E−02 |
| ethyl butanoate | 5.7E−02 − 1.1E−01 | 5.7E−02 − 1.1E−01 | 8.3E−02 − 1.5E−01 | 5.7E−02 − 1.8E−01 | 5.7E−02 − 1.1E−01 |
| ethyl cinnamate | 3.5E−03 − 6.5E−03 | 3.5E−03 − 6.5E−03 | 6.9E−05 − 1.3E−04 | 3.5E−03 − 1.2E−02 | 3.5E−03 − 6.5E−03 |
| ethyl decanoate | 1.4E+00 − 2.5E+00 | 1.4E+00 − 2.5E+00 | 9.0E−01 − 1.7E+00 | 1.4E+00 − 4.9E+00 | 1.4E+00 − 2.5E+00 |
| ethyl heptanoate | optional | optional | 7.5E−04 − 1.4E−03 | 0.0E+00 − 9.9E−03 | optional |
| ethyl hexanoate | 5.6E−01 − 1.0E+00 | 5.6E−01 − 1.0E+00 | 1.8E−01 − 3.4E−01 | 5.6E−01 − 1.9E+00 | 5.6E−01 − 1.0E+00 |
| ethyl isobutyrate | 0.0E+00 − 2.5E−01 | optional | 1.4E−01 − 2.7E−01 | 0.0E+00 − 7.3E−03 | optional |
| ethyl isovalerate | 5.1E−01 − 1.9E+00 | 5.1E−01 − 9.5E−01 | 5.0E−01 − 9.3E−01 | 5.1E−01 − 1.2E+00 | 5.1E−01 − 9.5E−01 |
| ethyl lactate | 6.9E+00 − 2.5E+01 | 1.4E+01 − 2.5E+01 | 2.5E−01 − 4.7E−01 | 1.4E+01 − 4.6E+01 | 1.4E+01 − 2.5E+01 |
| ethyl laurate | 7.1E−01 − 2.6E+00 | 7.1E−01 − 1.3E+00 | 8.0E+00 − 1.5E+01 | 7.1E−01 − 2.2E+00 | 7.1E−01 − 1.3E+00 |
| ethyl levulinate | 0.0E+00 − 1.2E−01 | 3.2E−02 − 5.9E−02 | optional | 6.3E−02 − 1.4E−01 | 3.2E−02 − 5.9E−02 |
| ethyl myristate | 1.3E−01 − 2.5E−01 | 1.3E−01 − 2.5E−01 | 8.1E−02 − 1.5E−01 | 1.3E−01 − 3.7E−01 | 1.3E−01 − 2.5E−01 |
| ethyl nonanoate | 0.0E+00 − 1.0E−02 | optional | optional | 0.0E+00 − 4.2E−02 | optional |
| ethyl octanoate | 3.5E−01 − 1.3E+00 | 3.5E−01 − 6.4E−01 | 7.5E−01 − 1.4E+00 | 3.5E−01 − 1.2E+00 | 3.5E−01 − 6.4E−01 |
| ethyl phenyl acetate | 1.7E−03 − 6.4E−03 | 1.7E−03 − 3.2E−03 | 2.3E−03 − 4.2E−03 | 1.4E−03 − 3.2E−03 | 1.7E−03 − 3.2E−03 |
| ethyl propionate | 5.5E−02 − 2.0E−01 | 5.5E−02 − 1.0E−01 | 1.1E−01 − 2.0E−01 | 5.1E−02 − 1.0E−01 | 5.5E−02 − 1.0E−01 |
| ethyl trans-2-butenoate | 0.0E+00 − 2.0E−02 | optional | optional | 1.1E−02 − 3.0E−02 | optional |
| ethyl undecanoate | 0.0E+00 − 1.9E−01 | 2.1E−03 − 3.9E−03 | optional | 1.4E−02 − 1.9E−01 | 2.1E−03 − 3.9E−03 |
| Ethyl Valerate | 4.1E−03 − 1.5E−02 | 8.2E−03 − 1.5E−02 | 2.1E−03 − 4.0E−03 | 7.0E−03 − 1.5E−02 | 8.2E−03 − 1.5E−02 |
| ethyl-2-methylbutyrate | 0.0E+00 − 7.1E−02 | 3.8E−02 − 7.1E−02 | optional | 3.8E−02 − 8.3E−02 | 3.8E−02 − 7.1E−02 |
| eugenol | 1.4E−03 − 2.6E−03 | 1.4E−03 − 2.6E−03 | 2.2E−03 − 4.0E−03 | 1.4E−03 − 2.7E−02 | 1.4E−03 − 2.6E−03 |
| farnesol | 0.0E+00 − 3.0E−02 | 0.0E+00 − 5.8E−02 | optional | optional | 1.6E−02 − 3.0E−02 |
| furfural | 1.3E+00 − 5.0E+00 | 1.3E+00 − 2.5E+00 | 4.3E−01 − 8.0E−01 | 1.3E+00 − 7.3E+00 | 1.3E+00 − 2.5E+00 |
| gamma-decalactone | 3.1E−03 − 1.2E−02 | 3.1E−03 − 5.7E−03 | 6.2E−03 − 1.2E−02 | 0.0E+00 − 5.7E−03 | 3.1E−03 − 5.7E−03 |
| gamma-nonalactone | 0.0E+00 − 1.4E−02 | 0.0E+00 − 2.8E−02 | optional | 4.2E−03 − 8.3E−03 | 7.7E−03 − 1.4E−02 |
| gamma-terpinene | 0.0E+00 − 1.7E−03 | optional | 9.4E−04 − 1.7E−03 | optional | optional |
| geraniol | 0.0E+00 − 9.3E−02 | 2.5E−02 − 4.7E−02 | optional | 5.0E−02 − 5.6E+00 | 2.5E−02 − 4.7E−02 |
| guaiacol | 1.4E−03 − 5.2E−03 | 1.4E−03 − 2.6E−03 | optional | 1.4E−03 − 1.3E−01 | 1.4E−03 − 2.6E−03 |
| Hexanoic acid | optional | optional | optional | 0.0E+00 − 2.6E−01 | optional |
| hexanol | optional | optional | optional | 5.0E−02 − 9.2E−02 | optional |
| isoamyl acetate | optional | optional | 2.5E−01 − 4.6E−01 | 0.0E+00 − 4.5E−01 | optional |
| isoamyl alcohol | 6.8E−01 − 1.3E+00 | 6.8E−01 − 1.3E+00 | 1.3E+00 − 2.5E+00 | 6.8E−01 − 1.3E+02 | 6.8E−01 − 1.3E+00 |
| isoamyl hexanoate | 4.1E−03 − 1.5E−02 | 4.1E−03 − 7.6E−03 | 8.3E−03 − 1.5E−02 | 3.9E−03 − 7.6E−03 | 4.1E−03 − 7.6E−03 |
| isoamyl isovalerate | optional | optional | optional | 1.5E−02 − 2.8E−02 | optional |
| isoamyl octanoate | 3.0E−04 − 5.5E−04 | 3.0E−04 − 5.5E−04 | 3.0E−04 − 5.5E−04 | 3.0E−04 − 8.3E−03 | 3.0E−04 − 5.5E−04 |
| isobutanol | 1.4E+01 − 2.6E+01 | 1.4E+01 − 2.6E+01 | 2.2E+01 − 4.0E+01 | 1.4E+01 − 5.8E+01 | 1.4E+01 − 2.6E+01 |
| isobutyl acetate | 3.5E−02 − 6.4E−01 | 3.5E−01 − 6.4E−01 | 6.1E−03 − 1.1E−02 | 3.3E−02 − 6.4E−02 | 3.5E−01 − 6.4E−01 |
| isobutyl isobutyrate | optional | optional | optional | 5.6E−04 − 1.0E−03 | optional |
| isobutyraldehyde | 0.0E+00 − 6.2E+00 | 3.3E+00 − 6.2E+00 | optional | 9.5E−01 − 2.5E+00 | 3.3E+00 − 6.2E+00 |
| Isovaleraldehyde | optional | optional | optional | 0.0E+00 − 3.0E−01 | optional |
| Isovaleric acid | optional | optional | optional | 0.0E+00 − 3.5E+00 | optional |
| limonene | 5.7E−03 − 1.1E−02 | 5.7E−03 − 1.1E−02 | 3.0E−03 − 5.5E−03 | 5.7E−03 − 1.5E−02 | 5.7E−03 − 1.1E−02 |
| linalool | 4.3E−06 − 1.6E−03 | 4.3E−06 − 8.0E−06 | optional | 4.3E−06 − 1.9E−01 | 4.3E−06 − 8.0E−06 |
| linalool oxide | 7.7E−03 − 2.9E−02 | 7.7E−03 − 1.4E−02 | 7.7E−03 − 1.4E−02 | 5.6E−03 − 1.4E−02 | 7.7E−03 − 1.4E−02 |
| linalyl acetate | 1.4E−02 − 5.2E−01 | 2.8E−02 − 5.2E−02 | optional | 2.8E−02 − 2.6E−01 | 2.8E−02 − 5.2E−02 |
| Maltol | 5.2E−05 − 3.9E−04 | 5.2E−05 − 9.6E−05 | 1.1E−04 − 2.0E−04 | 0.0E+00 − 5.3E+00 | 5.2E−05 − 9.6E−05 |
| methional | 0.0E+00 − 2.2E−03 | optional | optional | 0.0E+00 − 2.2E−03 | optional |
| methyl decanoate | optional | optional | optional | 1.3E−02 − 2.4E−02 | optional |
| methyl hexanoate | optional | optional | optional | 1.1E−03 − 2.1E−03 | optional |
| methyl laurate | optional | optional | optional | 9.8E−03 − 1.8E−02 | optional |
| Methyl Octanoate | 0.0E+00 − 1.2E−08 | 6.4E−09 − 1.2E−08 | 6.4E−09 − 1.2E−08 | 0.0E+00 − 1.2E−08 | 6.4E−09 − 1.2E−08 |
| methyl salicylate | 2.1E−05 − 3.8E−05 | 2.1E−05 − 3.8E−05 | 2.1E−05 − 3.8E−05 | 2.1E−05 − 1.0E−03 | 2.1E−05 − 3.8E−05 |
| Myrcene | 3.1E−06 − 1.2E−05 | 3.1E−06 − 5.8E−06 | 1.3E−05 − 2.4E−05 | 3.1E−06 − 2.6E−03 | 3.1E−06 − 5.8E−06 |
| nonanal | optional | optional | optional | 3.9E−03 − 7.3E−03 | optional |
| Nonanoic acid | optional | optional | optional | 0.0E+00 − 1.8E−01 | optional |
| p-anisaldehyde | optional | optional | optional | 0.0E+00 − 5.2E−02 | optional |
| p-cresol | 2.9E−04 − 5.5E−04 | 2.9E−04 − 5.5E−04 | 2.9E−04 − 5.5E−04 | 0.0E+00 − 5.5E−04 | 2.9E−04 − 5.5E−04 |
| p-cymene | 0.0E+00 − 2.2E−06 | 1.2E−06 − 2.2E−06 | 1.2E−06 − 2.2E−06 | 1.2E−06 − 3.1E−03 | 1.2E−06 − 2.2E−06 |
| Phenethyl Butyrate | 0.0E+00 − 4.8E−07 | 2.6E−07 − 4.8E−07 | 2.6E−07 − 4.8E−07 | 0.0E+00 − 4.8E−07 | 2.6E−07 − 4.8E−07 |
| phenethyl formate | 0.0E+00 − 4.7E−02 | 2.5E−02 − 4.7E−02 | optional | 1.0E−02 − 2.3E−02 | 2.5E−02 − 4.7E−02 |
| propanol | 0.0E+00 − 7.9E+00 | optional | 4.2E+00 − 7.9E+00 | 0.0E+00 − 2.4E+01 | optional |
| Propionaldehyde | optional | optional | optional | 0.0E+00 − 1.3E−01 | optional |
| Propionic acid | optional | optional | optional | 0.0E+00 − 2.6E−01 | optional |
| propyl acetate | 0.0E+00 − 6.4E−02 | 3.4E−02 − 6.3E−02 | optional | 3.4E−02 − 6.6E−02 | 3.4E−02 − 6.3E−02 |
| salicylaldehyde | 0.0E+00 − 4.5E−03 | 2.4E−03 − 4.5E−03 | optional | 0.0E+00 − 6.5E−02 | 2.4E−03 − 4.5E−03 |
| Valeraldehyde | 0.0E+00 − 6.2E−02 | optional | optional | 0.0E+00 − 1.3E−02 | optional |
| Valeric acid | optional | optional | optional | 0.0E+00 − 7.8E−02 | optional |
| vanillyl ethyl ether | 0.0E+00 − 3.5E−02 | 1.9E−02 − 3.5E−02 | optional | 0.0E+00 − 3.5E−02 | 1.9E−02 − 3.5E−02 |
| whiskey lactone | 5.0E−02 − 1.8E−01 | 9.6E−02 − 1.8E−01 | 5.0E−02 − 9.3E−02 | 9.1E−02 − 1.8E−01 | 9.6E−02 − 1.8E−01 |

TABLE 1B
VOCs in Scotch formulations (mg/L)

| | 1 | | 2 | | 3 | | 4 | | 5 | | 6 | | 7 | | 8 | |
|---|---|---|---|---|---|---|---|---|---|---|---|---|---|---|---|---|
| | Lower | Upper | Lower | Upper | Lower | Upper | Lower | Upper | Lower | Upper | Lower | Upper | Lower | Upper | Lower | Upper |
| 1-decanol | 1.37E−03 | 2.53E−02 | 6.82E−03 | 1.27E−02 | 6.82E−03 | 1.27E−02 | 6.82E−03 | 1.27E−02 | 1.36E−02 | 2.53E−02 | 6.82E−03 | 1.27E−02 | 6.82E−03 | 1.27E−02 | 1.37E−03 | 2.54E−03 |
| 1- [symbol] -3-ol | 2.31E−03 | 2.56E−02 | 6.90E−03 | 1.28E−02 | 6.90E−03 | 1.28E−02 | 6.90E−03 | 1.28E−02 | 1.38E−02 | 2.56E−02 | 6.90E−03 | 1.28E−02 | 6.90E−03 | 1.28E−02 | 2.31E−03 | 4.29E−03 |
| 2,3-pentadione | 0.00E+00 | 2.57E−03 | 6.93E−04 | 1.29E−03 | 1.39E−03 | 2.57E−03 | 1.39E−03 | 2.57E−03 | 6.93E−04 | 1.29E−03 | 6.93E−04 | 1.29E−03 | 6.93E−04 | 1.29E−03 | optional | optional |
| 2-heptanone | 0.00E+00 | 4.16E−02 | 2.24E−02 | 4.16E−02 | optional | optional | optional | optional | 2.24E−02 | 4.16E−02 | optional | optional | 2.24E−02 | 4.16E−02 | optional | optional |
| 2-methyl-1-butanol | 2.55E+00 | 5.20E+00 | 2.55E+00 | 4.73E+00 | 2.55E+00 | 4.73E+00 | 2.55E+00 | 4.73E+00 | 2.55E+00 | 4.73E+00 | 2.55E+00 | 4.73E+00 | 2.55E+00 | 4.73E+00 | 2.80E+00 | 5.20E+00 |
| 2- | 0.00E+00 | 4.60E−02 | optional | optional | optional | optional | optional | optional | optional | optional | 2.48E−02 | 4.60E−02 | optional | optional | 2.86E−04 | 5.32E−04 |
| methylbutyraldehyde | | | | | | | | | | | | | | | | |
| 2-nonanone | 0.00E+00 | 6.35E−03 | optional | optional | optional | optional | 3.42E−03 | 6.35E−03 | 8.55E−04 | 1.59E−03 | optional | optional | 8.55E−04 | 1.59E−03 | 8.49E−04 | 1.58E−03 |
| 3-carene | 0.00E+00 | 1.25E−01 | optional | optional | 6.72E−04 | 1.25E−03 | 6.72E−04 | 1.25E−03 | 6.72E−02 | 1.25E−01 | 6.72E−04 | 1.25E−03 | 6.72E−02 | 1.25E−01 | optional | optional |
| 4-carvomenthenol | 0.00E+00 | 1.26E−03 | optional | optional | optional | optional | 6.80E−05 | 1.26E−04 | 6.80E−04 | 1.26E−03 | optional | optional | optional | optional | optional | optional |
| 4-Ethyl Guaiacol | 0.00E+00 | 7.85E−02 | optional | optional | 2.82E−02 | 5.23E−02 | 2.82E−02 | 5.23E−02 | 4.23E−02 | 7.85E−02 | optional | optional | optional | optional | optional | optional |
| 4-Ethyl Phenol | 0.00E+00 | 7.19E−03 | optional | optional | optional | optional | optional | optional | 3.87E−03 | 7.19E−03 | optional | optional | optional | optional | optional | optional |
| acetal (1,1- | 0.00E+00 | 3.93E+00 | 2.12E+00 | 3.93E+00 | optional | optional | optional | optional | 2.12E+00 | 3.93E+00 | 2.10E+00 | 3.90E+00 | 2.12E+00 | 3.93E+00 | optional | optional |
| diethoxyethane) | | | | | | | | | | | | | | | | |
| acetaldehyde | 0.00E+00 | 3.94E−01 | 2.12E−01 | 3.94E−01 | 2.12E−01 | 3.94E−01 | 2.12E−01 | 3.94E−01 | 2.12E−01 | 3.94E−01 | 2.12E−01 | 3.94E−01 | 2.12E−01 | 3.94E−01 | optional | optional |
| acetoin | 0.00E+00 | 4.74E−02 | 2.55E−02 | 4.74E−02 | optional | optional | optional | optional | 2.55E−02 | 4.74E−02 | 2.55E−02 | 4.74E−02 | 2.55E−02 | 4.74E−02 | optional | optional |
| acetophenone | 0.00E+00 | 6.85E−03 | 3.69E−03 | 6.85E−03 | optional | optional | optional | optional | 3.69E−03 | 6.85E−03 | optional | optional | 3.69E−03 | 6.85E−03 | optional | optional |
| amyl alcohol | 0.00E+00 | 3.76E−01 | 1.01E−01 | 1.88E−01 | 2.02E−01 | 3.76E−01 | 2.02E−01 | 3.76E−01 | 1.01E−01 | 1.88E−01 | 1.01E−01 | 1.88E−01 | 1.01E−01 | 1.88E−01 | optional | optional |
| a-terpineol | 9.05E−04 | 7.72E−02 | 4.16E−02 | 7.72E−02 | 2.08E−02 | 3.86E−02 | 2.08E−02 | 3.86E−02 | 4.16E−02 | 7.72E−02 | 4.16E−02 | 7.72E−02 | 4.16E−02 | 7.72E−02 | 9.05E−04 | 1.68E−03 |
| benzaldehyde | 1.56E−04 | 1.92E−03 | 1.03E−03 | 1.92E−03 | 1.03E−03 | 1.92E−03 | 1.03E−03 | 1.92E−03 | 1.03E−03 | 1.92E−03 | 1.03E−03 | 1.92E−03 | 1.03E−03 | 1.92E−03 | 1.56E−04 | 2.90E−04 |
| beta pinene | 9.48E−07 | 5.12E−05 | 1.38E−05 | 2.56E−05 | 2.76E−05 | 5.12E−05 | 2.76E−05 | 5.12E−05 | 1.38E−05 | 2.56E−05 | 1.38E−05 | 2.56E−05 | 1.38E−05 | 2.56E−05 | 9.48E−07 | 1.76E−06 |
| beta-ionone | 0.00E+00 | 2.53E−04 | 6.81E−05 | 1.26E−04 | 1.36E−04 | 2.53E−04 | 1.36E−04 | 2.53E−04 | 6.81E−05 | 1.26E−04 | 6.81E−05 | 1.26E−04 | 6.81E−05 | 1.26E−04 | optional | optional |
| butyl acetate | 1.38E−03 | 1.32E−01 | 3.54E−02 | 6.58E−02 | 7.08E−02 | 1.32E−01 | 7.08E−02 | 1.32E−01 | 3.54E−02 | 6.58E−02 | 3.54E−02 | 6.58E−02 | 3.54E−02 | 6.58E−02 | 1.38E−03 | 2.57E−03 |
| butyl alcohol | 2.12E+00 | 1.06E+01 | 2.86E+00 | 5.32E+00 | 2.86E+00 | 5.32E+00 | 2.86E+00 | 5.32E+00 | 3.89E+00 | 7.23E+00 | 2.86E+00 | 5.32E+00 | 2.86E+00 | 5.32E+00 | 2.12E+00 | 3.94E+00 |
| butyl formate | 0.00E+00 | 4.68E−01 | optional | optional | 1.40E−02 | 2.60E−02 | 1.40E−02 | 2.60E−02 | 2.52E−01 | 4.68E−01 | optional | optional | optional | optional | 1.07E−02 | 2.00E−02 |
| butyric acid | 0.00E+00 | 5.17E−02 | optional | optional | 2.04E−02 | 3.80E−02 | 2.04E−02 | 3.80E−02 | optional | optional | optional | optional | optional | optional | 2.78E−02 | 5.17E−02 |
| Cinnamaldehyde | 0.00E+00 | 2.61E−05 | 1.41E−05 | 2.61E−05 | 1.41E−05 | 2.61E−05 | 1.41E−05 | 2.61E−05 | 1.41E−05 | 2.61E−05 | 1.41E−05 | 2.61E−05 | 1.41E−05 | 2.61E−05 | optional | optional |
| citronellol | 0.00E+00 | 1.26E−02 | optional | optional | optional | optional | 6.80E−05 | 1.26E−04 | 6.80E−03 | 1.26E−02 | optional | optional | optional | optional | optional | optional |
| delta-decalactone | 0.00E+00 | 2.58E+00 | 1.39E+00 | 2.58E+00 | 1.39E+00 | 2.58E+00 | 1.39E+00 | 2.58E+00 | 1.39E+00 | 2.58E+00 | 1.39E+00 | 2.58E+00 | 1.39E+00 | 2.58E+00 | optional | optional |
| diethyl malate | 0.00E+00 | 3.06E+00 | optional | optional | optional | optional | optional | optional | 6.99E−01 | 1.30E+00 | 6.99E−01 | 1.30E+00 | 6.99E−01 | 1.30E+00 | optional | optional |
| [symbol] | 6.74E−02 | 1.51E−01 | 6.74E−02 | 1.25E−01 | 6.74E−02 | 1.25E−01 | 6.74E−02 | 1.25E−01 | 6.74E−02 | 1.25E−01 | 6.74E−02 | 1.25E−01 | 6.74E−02 | 1.25E−01 | 8.14E−02 | 1.51E−01 |
| [symbol] - | 0.00E+00 | 1.04E−02 | optional | optional | optional | optional | optional | optional | 5.57E−03 | 1.04E−02 | 5.56E−03 | 1.03E−02 | 5.57E−03 | 1.04E−02 | optional | optional |
| hydroxyhexanoate | | | | | | | | | | | | | | | | |
| ethyl acetate | 5.83E+00 | 2.24E+01 | 5.83E+00 | 1.08E+01 | 1.16E+01 | 2.16E+01 | 1.16E+01 | 2.16E+01 | 5.83E+00 | 1.08E+01 | 5.83E+00 | 1.08E+01 | 5.83E+00 | 1.08E+01 | 1.21E+01 | 2.24E+01 |
| ethyl benzoate | 0.00E+00 | 1.11E−02 | optional | optional | optional | optional | optional | optional | optional | optional | 6.00E−03 | 1.11E−02 | optional | optional | optional | optional |
| ethyl butyrate | 5.17E−02 | 1.06E−01 | 5.71E−02 | 1.06E−01 | 5.71E−02 | 1.06E−01 | 5.71E−02 | 1.06E−01 | 5.71E−02 | 1.06E−01 | 5.71E−02 | 1.06E−01 | 5.71E−02 | 1.06E−01 | 5.17E−02 | 9.60E−02 |
| ethyl cinnamate | 7.44E−04 | 6.52E−03 | 3.51E−03 | 6.52E−03 | 3.51E−03 | 6.52E−03 | 3.51E−03 | 6.52E−03 | 3.51E−03 | 6.52E−03 | 3.51E−03 | 6.52E−03 | 3.51E−03 | 6.52E−03 | 7.44E−04 | 1.38E−03 |
| ethyl decanoate | 7.27E−01 | 2.55E+00 | 1.37E+00 | 2.55E+00 | 1.37E+00 | 2.55E+00 | 1.37E+00 | 2.55E+00 | 1.37E+00 | 2.55E+00 | 1.37E+00 | 2.55E+00 | 1.37E+00 | 2.55E+00 | 7.27E−01 | 1.35E+00 |
| ethyl heptanoate | 0.00E+00 | 6.41E−04 | optional | optional | optional | optional | 3.45E−04 | 6.41E−04 | optional | optional | optional | optional | optional | optional | 9.43E−05 | 1.75E−04 |
| ethyl hexanoate | 9.29E−02 | 1.04E+00 | 5.62E−01 | 1.04E+00 | 5.62E−01 | 1.04E+00 | 2.81E−01 | 5.22E−01 | 5.62E−01 | 1.04E+00 | 5.62E−01 | 1.04E+00 | 5.62E−01 | 1.04E+00 | 9.29E−02 | 1.73E−01 |
| ethyl isobutyrate | 0.00E+00 | 2.51E−01 | optional | optional | 1.35E−01 | 2.51E−01 | 1.35E−01 | 2.51E−01 | 1.35E−01 | 2.51E−01 | optional | optional | optional | optional | 1.11E−01 | 2.07E−01 |
| ethyl isovalerate | 3.30E−02 | 1.91E+00 | 5.14E−01 | 9.54E−01 | 1.03E+00 | 1.91E+00 | 1.03E+00 | 1.91E+00 | 5.14E−01 | 9.54E−01 | 5.14E−01 | 9.54E−01 | 5.14E−01 | 9.54E−01 | 3.30E−02 | 6.14E−02 |
| ethyl lactate | 6.49E−01 | 2.55E+01 | 1.37E+01 | 2.55E+01 | 6.87E+00 | 1.27E+01 | 6.87E+00 | 1.27E+01 | 1.37E+01 | 2.55E+01 | 1.37E+01 | 2.55E+01 | 1.37E+01 | 2.55E+01 | 6.49E−01 | 1.21E+00 |
| ethyl laurate | 7.07E−01 | 3.90E+00 | 7.07E−01 | 1.31E+00 | 7.07E−01 | 1.31E+00 | 7.07E−01 | 1.31E+00 | 1.41E+00 | 2.63E+00 | 7.07E−01 | 1.31E+00 | 7.07E−01 | 1.31E+00 | 2.10E+00 | 3.90E+00 |
| ethyl levulinate | 0.00E+00 | 1.16E−01 | 6.27E−02 | 1.16E−01 | optional | optional | optional | optional | 6.27E−02 | 1.16E−01 | 6.27E−02 | 1.16E−01 | 6.27E−02 | 1.16E−01 | optional | optional |
| ethyl myristate | 2.41E−02 | 2.49E−01 | 1.34E−01 | 2.49E−01 | 1.34E−01 | 2.49E−01 | 1.34E−01 | 2.49E−01 | 1.34E−01 | 2.49E−01 | 1.34E−01 | 2.49E−01 | 1.34E−01 | 2.49E−01 | 2.41E−02 | 4.47E−02 |
| ethyl nonanoate | 0.00E+00 | 1.01E−02 | optional | optional | optional | optional | 6.28E−05 | 1.27E−04 | 5.46E−03 | 1.01E−02 | optional | optional | optional | optional | 1.29E−03 | 2.40E−03 |
| ethyl octanoate | 3.46E−01 | 2.71E+00 | 3.46E−01 | 6.42E−01 | 6.91E−01 | 1.28E+00 | 6.91E−01 | 1.28E+00 | 3.46E−01 | 6.42E−01 | 3.46E−01 | 6.42E−01 | 3.46E−01 | 6.42E−01 | 1.46E+00 | 2.71E+00 |
| ethyl phenyl acetate | 1.02E−03 | 6.39E−03 | 1.72E−03 | 3.20E−03 | 3.44E−03 | 6.39E−03 | 3.44E−03 | 6.39E−03 | 1.72E−03 | 3.20E−03 | 1.72E−03 | 3.20E−03 | 1.72E−03 | 3.20E−03 | 1.02E−03 | 1.90E−03 |
| ethyl propionate | 5.52E−02 | 3.46E−01 | 5.52E−02 | 1.02E−01 | 1.10E−01 | 2.05E−01 | 1.10E−01 | 2.05E−01 | 5.52E−02 | 1.02E−01 | 5.52E−02 | 1.02E−01 | 5.52E−02 | 1.02E−01 | 1.86E−01 | 3.46E−01 |
| ethyl trans-2- | 0.00E+00 | 2.03E−02 | optional | optional | optional | optional | optional | optional | 1.09E−02 | 2.03E−02 | optional | optional | 1.09E−02 | 2.03E−02 | optional | optional |
| butenoate | | | | | | | | | | | | | | | | |
| ethyl undecanoate | 0.00E+00 | 1.93E−01 | 1.04E−01 | 1.93E−01 | optional | optional | optional | optional | 1.04E−01 | 1.93E−01 | 2.08E−03 | 3.86E−03 | 1.04E−01 | 1.93E−01 | optional | optional |
| Ethyl Valerate | 1.03E−03 | 1.53E−02 | 8.22E−03 | 1.53E−02 | 4.11E−03 | 7.64E−03 | 4.11E−03 | 7.64E−03 | 8.22E−03 | 1.53E−02 | 8.22E−03 | 1.53E−02 | 8.22E−03 | 1.53E−02 | 1.03E−03 | 1.91E−03 |
| ethyl-2- | 0.00E+00 | 7.11E−02 | 3.79E−02 | 7.03E−02 | optional | optional | optional | optional | 3.79E−02 | 7.03E−02 | 3.83E−02 | 7.11E−02 | 3.79E−02 | 7.03E−02 | 3.63E−02 | 6.75E−02 |
| methylbutyrate | | | | | | | | | | | | | | | | |
| eugenol | 0.00E+00 | 5.21E−03 | 1.40E−03 | 2.61E−03 | 1.40E−03 | 2.61E−03 | 2.81E−03 | 5.21E−03 | 1.40E−03 | 2.61E−03 | 1.40E−03 | 2.61E−03 | 1.40E−03 | 2.61E−03 | optional | optional |
| farnesol | 0.00E+00 | 2.99E−02 | optional | optional | optional | optional | optional | optional | 7.05E−03 | 1.31E−02 | 1.61E−02 | 2.99E−02 | optional | optional | optional | optional |
| furfural | 1.34E+00 | 4.99E+00 | 1.34E+00 | 2.50E+00 | 2.69E+00 | 4.99E+00 | 2.69E+00 | 4.99E+00 | 1.34E+00 | 2.50E+00 | 1.34E+00 | 2.50E+00 | 1.34E+00 | 2.50E+00 | 2.44E+00 | 4.52E+00 |
| gamma-decalactone | 0.00E+00 | 1.15E−02 | 3.08E−03 | 5.72E−03 | 6.22E−03 | 1.15E−02 | 6.22E−03 | 1.15E−02 | 3.08E−03 | 5.72E−03 | 3.08E−03 | 5.72E−03 | 3.08E−03 | 5.72E−03 | optional | optional |
| [symbol] -nonalactone | 0.00E+00 | 1.42E−02 | 4.46E−03 | 8.28E−03 | optional | optional | optional | optional | 4.46E−03 | 8.28E−03 | 7.66E−03 | 1.42E−02 | 4.46E−03 | 8.28E−03 | optional | optional |
| gamma-terpinene | 0.00E+00 | 1.74E−03 | optional | optional | 9.39E−04 | 1.74E−03 | 9.39E−04 | 1.74E−03 | 5.62E−05 | 1.04E−04 | optional | optional | optional | optional | optional | optional |
| geraniol | 0.00E+00 | 9.34E−02 | 5.03E−02 | 9.34E−02 | optional | optional | optional | optional | 6.98E−03 | 1.30E−02 | 2.51E−02 | 4.65E−02 | 5.03E−02 | 9.34E−02 | optional | optional |
| guaiacol | 0.00E+00 | 4.13E−02 | 1.39E−03 | 2.58E−03 | 1.39E−03 | 2.58E−03 | 2.22E−02 | 4.13E−02 | 2.78E−03 | 5.16E−03 | 1.39E−03 | 2.58E−03 | 1.39E−03 | 2.58E−03 | optional | optional |
| hexanol | 2.10E−02 | 3.89E−02 | optional | optional | optional | optional | optional | optional | optional | optional | optional | optional | optional | optional | 2.10E−02 | 3.89E−02 |
| isoamyl acetate | 0.00E+00 | 5.13E−01 | optional | optional | optional | optional | 2.76E−01 | 5.13E−01 | optional | optional | optional | optional | optional | optional | optional | optional |
| isoamyl alcohol | 6.83E−01 | 2.74E+00 | 6.83E−01 | 1.27E+00 | 6.83E−01 | 1.27E+00 | 1.32E+00 | 2.45E+00 | 6.83E−01 | 1.27E+00 | 6.83E−01 | 1.27E+00 | 6.83E−01 | 1.27E+00 | 1.47E+00 | 2.74E+00 |
| isoamyl hexanoate | 2.06E−04 | 1.54E−02 | 4.11E−03 | 7.64E−03 | 8.29E−03 | 1.54E−02 | 8.29E−03 | 1.54E−02 | 4.11E−03 | 7.64E−03 | 4.11E−03 | 7.64E−03 | 4.11E−03 | 7.64E−03 | 2.06E−04 | 3.83E−04 |
| isoamyl octanoate | 2.95E−04 | 9.45E−04 | 2.95E−04 | 5.49E−04 | 2.95E−04 | 5.49E−04 | 2.95E−04 | 5.49E−04 | 2.95E−04 | 5.49E−04 | 2.95E−04 | 5.49E−04 | 2.95E−04 | 5.49E−04 | 5.09E−04 | 9.45E−04 |
| isobutyl acetate | 1.16E−02 | 6.41E−01 | 3.45E−02 | 6.41E−02 | 3.45E−01 | 6.41E−01 | 3.45E−01 | 6.41E−01 | 6.90E−02 | 1.28E−01 | 3.45E−01 | 6.41E−01 | 3.45E−01 | 6.41E−01 | 1.16E−02 | 2.16E−02 |
| isobutyl alcohol | 1.01E+01 | 2.60E+01 | 1.38E+01 | 2.57E+01 | 1.40E+01 | 2.60E+01 | 1.01E+01 | 1.88E+01 | 1.38E+01 | 2.57E+01 | 1.38E+01 | 2.57E+01 | 1.38E+01 | 2.57E+01 | 1.40E+01 | 2.60E+01 |
| isobutyraldehyde | 0.00E+00 | 1.22E+01 | 1.37E+00 | 2.54E+00 | optional | optional | optional | optional | 1.37E−01 | 2.54E−01 | 2.91E+00 | 5.41E+00 | 2.91E+00 | 5.41E+00 | optional | optional |
| limonene | 0.00E+00 | 1.06E−02 | 5.69E−03 | 1.06E−02 | 5.69E−03 | 1.06E−02 | 5.69E−03 | 1.06E−02 | 5.69E−03 | 1.06E−02 | 5.69E−03 | 1.06E−02 | 5.69E−03 | 1.06E−02 | optional | optional |
| linalool oxide | 0.00E+00 | 2.85E−02 | 7.72E−03 | 1.43E−02 | 1.54E−02 | 2.85E−02 | 1.54E−02 | 2.85E−02 | 7.72E−03 | 1.43E−02 | 7.72E−03 | 1.43E−02 | 7.72E−03 | 1.43E−02 | optional | optional |
| linalyl acetate | 0.00E+00 | 5.16E−01 | 2.78E−01 | 5.16E−01 | 1.39E−02 | 2.58E−02 | 1.39E−02 | 2.58E−02 | 2.78E−01 | 5.16E−01 | 2.78E−01 | 5.16E−01 | 2.78E−01 | 5.16E−01 | optional | optional |
| 1-linalool | 0.00E+00 | 1.59E−03 | 8.56E−04 | 1.59E−03 | 4.28E−06 | 7.95E−06 | optional | optional | 8.56E−04 | 1.59E−03 | 4.28E−06 | 7.95E−06 | 8.56E−04 | 1.59E−03 | optional | optional |
| Maltol | 0.00E+00 | 3.90E−04 | 5.17E−05 | 9.60E−05 | 2.10E−04 | 3.90E−04 | 2.10E−04 | 3.90E−04 | 5.17E−05 | 9.60E−05 | 5.17E−05 | 9.60E−05 | 5.17E−05 | 9.60E−05 | optional | optional |
| methional | 0.00E+00 | 2.17E−03 | 1.17E−03 | 2.17E−03 | optional | optional | optional | optional | 1.17E−03 | 2.17E−03 | optional | optional | 1.17E−03 | 2.17E−03 | optional | optional |
| methyl hexanoate | 0.00E+00 | 9.34E−02 | optional | optional | optional | optional | optional | optional | optional | optional | optional | optional | optional | optional | 5.03E−02 | 9.34E−02 |
| Methyl Octanoate | 0.00E+00 | 1.03E−06 | optional | optional | optional | optional | optional | optional | optional | optional | optional | optional | optional | optional | 5.53E−07 | 1.03E−06 |
| methyl salicylate | 2.05E−05 | 6.57E−04 | 2.05E−05 | 3.81E−05 | 2.05E−05 | 3.81E−05 | 2.05E−05 | 3.81E−05 | 2.05E−05 | 3.81E−05 | 2.05E−05 | 3.81E−05 | 2.05E−05 | 3.81E−05 | 3.54E−04 | 6.57E−04 |
| Myrcene | 3.11E−06 | 1.07E−04 | 3.11E−06 | 5.78E−06 | 6.46E−06 | 1.20E−05 | 6.46E−06 | 1.20E−05 | 3.11E−06 | 5.78E−06 | 3.11E−06 | 5.78E−06 | 3.11E−06 | 5.78E−06 | 5.76E−05 | 1.07E−04 |
| p-cresol | 0.00E+00 | 5.47E−04 | 2.95E−04 | 5.47E−04 | 2.95E−04 | 5.47E−04 | 2.95E−04 | 5.47E−04 | 2.95E−04 | 5.47E−04 | 2.95E−04 | 5.47E−04 | 2.95E−04 | 5.47E−04 | optional | optional |
| p-cymene | 0.00E+00 | 2.45E−05 | optional | optional | optional | optional | optional | optional | optional | optional | optional | optional | optional | optional | 1.32E−05 | 2.45E−05 |
| phenethyl acetate | 5.79E−02 | 2.15E−01 | 5.79E−02 | 1.08E−01 | 5.79E−02 | 1.08E−01 | 1.16E−01 | 2.15E−01 | 5.79E−02 | 1.08E−01 | 5.79E−02 | 1.08E−01 | 5.79E−02 | 1.08E−01 | 7.22E−02 | 1.34E−01 |
| phenethyl alcohol | 6.92E−01 | 7.78E+00 | 2.09E+00 | 3.89E+00 | 4.19E+00 | 7.78E+00 | 4.19E+00 | 7.78E+00 | 2.79E+00 | 5.19E+00 | 2.09E+00 | 3.89E+00 | 2.09E+00 | 3.89E+00 | 6.92E−01 | 1.28E+00 |
| Phenethyl Butyrate | 0.00E+00 | 8.35E−06 | optional | optional | optional | optional | optional | optional | optional | optional | optional | optional | optional | optional | 4.49E−06 | 8.35E−06 |
| [symbol] formate | 0.00E+00 | 4.71E−02 | optional | optional | optional | optional | optional | optional | 1.22E−02 | 2.27E−02 | 2.53E−02 | 4.71E−02 | 1.22E−02 | 2.27E−02 | optional | optional |
| propyl acetate | 0.00E+00 | 6.39E−02 | 3.44E−02 | 6.39E−02 | optional | optional | optional | optional | 3.44E−02 | 6.39E−02 | 3.42E−02 | 6.35E−02 | 3.44E−02 | 6.39E−02 | optional | optional |
| propyl alcohol | 0.00E+00 | 1.06E+01 | optional | optional | 4.23E+00 | 7.85E+00 | 4.23E+00 | 7.85E+00 | 3.73E+00 | 6.93E+00 | optional | optional | optional | optional | 5.71E+00 | 1.06E+01 |
| salicylaldehyde | 0.00E+00 | 4.47E−03 | optional | optional | optional | optional | optional | optional | 1.14E−03 | 2.11E−03 | 2.41E−03 | 4.47E−03 | 1.14E−03 | 2.11E−03 | optional | optional |
| trans-2- | 0.00E+00 | 8.83E−04 | optional | optional | optional | optional | optional | optional | optional | optional | optional | optional | optional | optional | 4.75E−04 | 8.83E−04 |
| hexen-1-al | | | | | | | | | | | | | | | | |
| Valeraldehyde | 0.00E+00 | 6.17E−02 | optional | optional | optional | optional | optional | optional | 3.32E−02 | 6.17E−02 | optional | optional | optional | optional | optional | optional |
| vanillyl ethyl ether | 0.00E+00 | 3.51E−02 | 1.88E−02 | 3.49E−02 | optional | optional | optional | optional | 1.88E−02 | 3.49E−02 | 1.89E−02 | 3.51E−02 | 1.88E−02 | 3.49E−02 | optional | optional |
| whiskey lactone | 5.00E−02 | 2.55E−01 | 9.56E−02 | 1.78E−01 | 5.00E−02 | 9.29E−02 | 5.00E−02 | 9.29E−02 | 9.56E−02 | 1.78E−01 | 9.56E−02 | 1.78E−01 | 9.56E−02 | 1.78E−01 | 1.37E−01 | 2.55E−01 |

[symbol]

indicates data missing or illegible when filed

TABLE 1C
Non-volatiles in Scotch formulations (mg/L)

| | 1 | | 2 | | 3 | | 4 | |
|---|---|---|---|---|---|---|---|---|
| | Lower | Upper | Lower | Upper | Lower | Upper | Lower | Upper |
| Acetovanillone | 3.2E−01 | 5.9E−01 | optional | optional | optional | optional | optional | optional |
| Choline | 1.0E+01 | 1.9E+01 | optional | optional | optional | optional | optional | optional |
| Cinnamic acid | optional | optional | optional | optional | optional | optional | 1.4E+00 | 2.6E+00 |
| Citric acid | optional | optional | optional | optional | optional | optional | 1.2E+01 | 2.2E+01 |
| D-Glucuronic acid | 7.0E+00 | 1.3E+01 | 7.7E−02 | 1.4E−01 | 8.1E+00 | 1.5E+01 | 8.1E+00 | 1.5E+01 |
| Fructose | 7.9E+01 | 1.5E+02 | 1.4E+00 | 2.6E+00 | 5.7E+01 | 1.1E+02 | 1.6E+01 | 3.0E+01 |
| Fumaric acid | 2.3E−02 | 4.3E−02 | optional | optional | optional | optional | optional | optional |
| GABA | 8.4E−02 | 1.6E−01 | optional | optional | optional | optional | optional | optional |
| Gallic acid | 1.9E+01 | 3.5E+01 | 7.3E+00 | 1.4E+01 | 2.0E+01 | 3.8E+01 | optional | optional |
| Glucosamine | 5.4E+01 | 1.0E+02 | optional | optional | optional | optional | optional | optional |
| Glucose | 1.7E+02 | 3.2E+02 | 1.6E+01 | 3.0E+01 | 1.7E+02 | 3.1E+02 | 3.2E+01 | 5.9E+01 |
| Lactic acid | 4.8E+00 | 8.9E+00 | 2.6E+00 | 4.9E+00 | 8.3E+00 | 1.5E+01 | 8.3E+00 | 1.5E+01 |
| Malic acid | 1.4E+00 | 2.6E+00 | 6.7E−01 | 1.2E+00 | 3.0E+00 | 5.6E+00 | 3.0E+00 | 5.6E+00 |
| Mannitol | 7.3E+00 | 1.4E+01 | 6.7E−01 | 1.2E+00 | 5.5E+00 | 1.0E+01 | optional | optional |
| Mannose | 2.9E+01 | 5.4E+01 | optional | optional | 1.9E+01 | 3.5E+01 | optional | optional |
| Inositol | 1.2E+01 | 2.3E+01 | 1.3E+00 | 2.5E+00 | 1.2E+01 | 2.2E+01 | optional | optional |
| (e.g, myo-inositol) | | | | | | | | |
| proline | 1.5E+00 | 2.9E+00 | optional | optional | optional | optional | optional | optional |
| Ribose | optional | optional | 3.7E+00 | 7.0E+00 | 1.0E+01 | 1.9E+01 | optional | optional |
| Sorbitol | 7.8E+00 | 1.4E+01 | optional | optional | 3.2E+00 | 5.9E+00 | optional | optional |
| Succinic acid | 1.4E+00 | 2.7E+00 | 3.2E−01 | 6.0E−01 | 2.0E+00 | 3.7E+00 | 2.0E+00 | 3.7E+00 |
| Syringaldehyde | 5.7E+00 | 1.1E+01 | 3.6E+00 | 6.7E+00 | 5.4E+00 | 1.0E+01 | optional | optional |
| Syringic acid | 1.7E+01 | 3.1E+01 | 7.0E+00 | 1.3E+01 | 1.3E+01 | 2.4E+01 | optional | optional |
| Tartaric acid | 1.2E+01 | 2.3E+01 | 3.2E+01 | 6.0E+01 | 4.7E+01 | 8.7E+01 | 4.7E+01 | 8.7E+01 |
| trans-ferulic acid | optional | optional | 2.7E−01 | 5.1E−01 | 2.6E−02 | 4.8E−02 | optional | optional |
| Tyrosine | 4.4E−01 | 8.2E−01 | optional | optional | optional | optional | optional | optional |
| valine | 8.9E−01 | 1.7E+00 | optional | optional | optional | optional | optional | optional |
| Vanillic acid | 1.8E+01 | 3.4E+01 | 7.4E−01 | 1.4E+00 | 5.7E+01 | 1.1E+02 | optional | optional |
| Vanillin | 3.4E+00 | 6.3E+00 | 3.8E+00 | 7.0E+00 | 2.3E+00 | 4.3E+00 | optional | optional |
| Glycerol | optional | optional | optional | optional | optional | optional | 5.6E+03 | 1.0E+04 |
| Tannin Powder | 5.6E+02 | 1.0E+03 | 5.6E+02 | 1.0E+03 | 5.6E+02 | 1.0E+03 | optional | optional |
| oak extract | 4.9E+03 | 9.1E+03 | 4.9E+03 | 9.1E+03 | 4.9E+03 | 9.1E+03 | optional | optional |
| Gum arabic | optional | optional | optional | optional | optional | optional | 7.0E−01 | 1.3E+00 |

It is noted that while Scotch replicas can include volatile compounds as listed in TABLES 1A and 1B, the added compounds may react with one another to generate additional compounds, or to change the effective amount of one or more of the added compounds within the Scotch replica formulation.

### Example 2—VOCs and nonVOCs in Reference Scotches

GC-MS/MS was used to assess the amounts of various VOCs in traditional Scotches.

GC-MS/MS Conditions: All analyses were performed using an Agilent 7890B GC interfaced with a 7000D Triple Quadrupole mass spectrometer, and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco; Bellefonte, Pa.). HS-SPME autosampler conditions were as follows: pre-incubation time of 5 minutes, incubation temperature of 60° C., extraction time of 15 minutes, and desorption time 2 to 10 minutes. Post-desorption fiber conditioning time was 30 minutes. For liquid injection experiments, the injection volume was 0.5 μL. SPME injections were run in splitless mode, while liquid injections were run with a split ratio of 1:20 or 1:10, with a desorption temperature of 250° C. The column was a 30 m×0.25 mm×0.25 Agilent DB-WAX or DBHeavyWax (ultra inert). Helium was used as the carrier gas at a constant flow rate of 1 mL/min. The MS ion source temperature and interface temperature were 250° C. A first temperature program was as follows: initial temperature of 40° C., held for 5 minutes, then increased to 180° C. at a rate of 4° C./min, and then increased to 240° C. at a rate of 45° C./min, and held for 10 minutes, for a total run time of 52 minutes. A second temperature program was as follows: initial temperature of 40° C., held for 0.5 minutes, then increased to 240° C. at a rate of 5° C./min, and held for 10 minutes, for a total run time of 30 minutes.

Selection of target compounds and MRM method development: Samples were first analyzed by HS-SPME-GC/MS in full scan mode (m/z 40-200) to identify potential target compounds. Collected data were analyzed manually using Agilent MassHunter Qualitative Analysis Version B.07.00, or using Agilent MassHunter Unknowns Analysis Version B.08.00. Multiple Reaction Monitoring (MRM) optimization was performed for commercially available standards. First, full scan experiments were repeated with liquid injection (5 mg/L in pure EtOH) to verify retention time and potential precursor ions. Product ion scans were performed using liquid injection and varying collision energies across a range of 5-35 V. Optimized MRM transitions and collision energies were selected, and are displayed in TABLES 3A, 3B, and 3D. A dynamic MRM (dMRM) method was developed for the generation of calibration curves, as described below. Compounds were divided into multiple methods to minimize simultaneous transitions (no greater than 6).

Quantification. Calibrations for some groups were performed using the method of standard additions. Solutions were prepared for SPME as 1 mL sample diluted with 9 mL milliQ water in 20-mL amber vials, with 3 g of salt added to enhance volatility. This concentration of EtOH minimized swelling of the SPME fiber to maximize signal despite the dilution factor. Concentration range of spiked standards was varied by compound based on the expected range in real samples. Spiking solutions were prepared in EtOH for standard addition of anlaytes, and spiked into samples at 10, 20, 30, and 40 uL.

Calibrations for other groups were performed using external calibration with SPME. Calibration solutions were prepared as analytes spiked into 10 mL H₂O with 3 g of NaCl. Samples were prepared as 100 uL of whiskey in 10 mL H2O; the high dilution factor was to mitigate SPME matrix effects of major volatile compounds.

Other groups were calibrated using liquid injection with external calibration curves. Whiskeys were either injected neat, or diluted 1:10 in EtOH, depending on the native concentration of the analyte.

Data were analyzed using Agilent Quantitative Analysis (for QQQ). Values reported as not detected (nf, zero) may be considered to be below the limits of detection (LODs) listed in TABLES 3A, 3B, 3C, and 3D. LODs were approximated based on SN ratios as generated by the MassHunter software.

Various reference Scotch samples were assayed by GC-MS; the levels of VOCs therein are shown in TABLES 4A and 4B. In these tables, each column is designated by a numeral that refers to a particular whiskey. These numerals are (1) 18y Highland Single Malt Scotch Whisky, (2) Laphroaig 10y Islay Single Malt Scotch Whisky, and (3) Lagavulin 16y Islay Single Malt Scotch Whisky. Additional Scotch samples were assayed by GCMS; the levels of VOCs therein are shown in TABLE 4C. In this table, each column is designated by a numeral that refers to a particular whiskey. These numerals are (W1) Auchentoshan, (W2) Bruichladdich, (W3) Glenmorangie 10, (W4) Lagavulin 16, (W5) Laphroaig 10, (W6) Macallan 10, (W7) Macallan 18, (W8) Oban 14, and (W9) Scoresby.

TABLE 3A
Method A Transitions and Figures of Merit

| Compound Method | | | | Qualifier 1 Method | | | |
|---|---|---|---|---|---|---|---|
| | RT | | Collision | | Collision | Calibration | LOD |
| Name | (min) | Transition | Energy | Transition | Energy | Range (mg/L) | (mg/L) |
| propanol | 1.96 | 59.0 → 31.0 | 10 | 42.0 → 39.0 | 35 | 1-200 | 0.002 |
| ethyl acetate | 2.30 | 61.0 → 43.0 | 15 | 45.0 → 43.0 | 35 | 1-200 | 1 |
| isobutanol | 2.40 | 43.0 → 39.0 | 35 | 74.0 → 41.0 | 25 | 1-200 | 0.0025 |
| isovaleraldehyde | 2.68 | 44.0 → 43.0 | 10 | 58 → 31 | 25 | 0.001-0.05 | 0.1 |
| butanol | 2.79 | 56.0 → 41.0 | 10 | 56.0 → 39.0 | 15 | 0.02-1 | 0.01 |
| 1,1-diethoxyethane | 3.91 | 73.0 → 45.0 | 10 | 103.0 → 47.0 | 10 | 0.05-2.5 | N/A |
| isoamyl alcohol | 4.03 | 70.0 → 55.0 | 15 | 55.0 → 39.0 | 15 | 15-750 | 0.0002 |
| 2-methyl-1-butanol | 4.04 | 70.0 → 41.0 | 25 | 55.0 → 40.0 | 25 | 1-200 | 0.5 |
| ethyl isobutyrate | 4.66 | 43.0 → 27.0 | 10 | 71.0 → 43.0 | 10 | 0.001-0.05 | 0.000005 |
| isobutyl acetate | 5.11 | 73.0 → 43.0 | 5 | 56.0 → 41.0 | 15 | 0.001-0.05 | 0.001 |
| ethyl butyrate | 6.05 | 71.0 → 43.0 | 10 | 88.0 → 61.0 | 10 | 0.001-.2 | 0.000005 |
| ethyl lactate | 6.57 | 45.0 → 29.0 | 15 | 45.0 → 27.0 | 15 | 0.5-25 | 0.1 |
| ethyl-2-methylbutyrate | 7.97 | 102.0 → 74.0 | 10 | 85.0 → 57.0 | 5 | 0.001-0.05 | 0.0005 |
| ethyl isovalerate | 8.12 | 70.0 → 55.0 | 5 | 88.0 → 61.0 | 5 | 0.001-0.2 | 0.00005 |
| isoamyl acetate | 8.77 | 70.0 → 55.0 | 10 | 55.0 → 29.0 | 10 | 0.02-1 | 0.00001 |
| hexanol | 9.09 | 69.0 → 41.0 | 15 | 56.0 → 41.0 | 10 | 0.001-0.05 | 0.00001 |
| benzaldehyde | 12.50 | 105.0 → 51.0 | 35 | 106.0 → 77.0 | 35 | 0.001-0.05 | 0.0005 |
| (−)-beta-pinene | 13.12 | 93.0 → 77.0 | 15 | 93.0 → 51.0 | 25 | 0.001-0.01 | 0.0001 |
| ethyl hexanoate | 14.31 | 88.0 → 61.0 | 5 | 99.0 → 43.0 | 5 | 0.005-1 | 0.0001 |
| linalool oxide | 17.18 | 59.0 → 31.0 | 18 | 94.0 → 79.0 | 10 | 0.001-0.2 | 0.0005 |
| guaiacol | 17.85 | 109.0 → 81.0 | 15 | 124.0 → 109.0 | 15 | 0.001-0.2 | 0.001 |
| linalool | 18.29 | 71.0 → 43.0 | 15 | 55.0 → 39.0 | 25 | 0.001-0.2 | 0.0005 |
| 2-phenylethanol | 18.77 | 122.0 → 91.0 | 15 | 92.0 → 65.0 | 25 | 0.2-10 | 0.00005 |
| myrtenol | 18.77 | 79.0 → 51.0 | 35 | 91.0 → 65.0 | 35 | 0.001-0.05 | 0.001 |
| alpha-terpineol | 21.69 | 93.0 → 51.0 | 25 | 121.0 → 77.0 | 25 | 0.001-0.05 | 0.001 |
| ethyl octanoate | 22.01 | 88.0 → 43.0 | 25 | 101.0 → 55.0 | 25 | 0.05-2.5 | 0.00001 |
| citronellol | 23.10 | 69.0 → 41.0 | 10 | 41.0 → 39.0 | 10 | 0.001-0.2 | 0.005 |
| linalyl acetate | 24.07 | 93.0 → 77.0 | 15 | 121.0 → 105.0 | 10 | 0.001-0.2 | 0.0005 |
| 4-ethyl guaiacol | 24.86 | 152.0 → 94.0 | 35 | 137.0 → 66.0 | 35 | 0.01-1 | 0.0001 |
| ethyl nonanoate | 25.48 | 88.0 → 61.0 | 10 | 101.0 → 73.0 | 10 | 0.001-0.05 | 0.00001 |
| cis-whiskey lactone | 26.37 | 99.0 → 43.0 | 20 | 99.0 → 41.0 | 20 | 0.01-0.1 | 0.005 |
| eugenol | 27.51 | 164.0 → 149.0 | 10 | 164.0 → 104.0 | 15 | 0.05-2.5 | 0.0001 |
| damascenone | 28.41 | 69.0 → 41.0 | 20 | 121.0 → 77.0 | 20 | 0.001-0.05 | 0.0005 |
| ethyl decanoate | 28.75 | 88.0 → 43.0 | 20 | 61.0 → 43.0 | 20 | 0.05-2.5 | 0.0001 |
| ethyl cinnamate | 30.93 | 131.0 → 103.0 | 10 | 131.0 → 77.0 | 25 | 0.0004-0.004 | 0.00001 |
| beta-ionone | 31.59 | 177.0 → 147.0 | 35 | 135.0 → 43.0 | 35 | 0.001-0.05 | 0.00001 |
| ethyl laurate | 34.75 | 88.0 → 61.0 | 15 | 101.0 → 55.0 | 25 | 0.001-0.05 | 0.001 |

TABLE 3B
Method B Transitions and Figures of Merit

| Compound Method | | | | Qualifier 1 Method | | | |
|---|---|---|---|---|---|---|---|
| | RT | | Collision | | Collision | Calibration | LOD |
| Name | (min) | Transition | Energy | Transition | Energy | Range (mg/L) | (mg/L) |
| 2-methylbutyraldehyde | 2.79 | 57.0 → 39.0 | 25 | 58.0 → 31.0 | 25 | 0.005-0.05 | 0.002 |
| 2,3-pentadione | 3.20 | 100.0 → 57.0 | 5 | 57.0 → 42.0 | 30 | 0.005-0.05 | 1 |
| ethyl propionate | 3.52 | 102.0 → 46.0 | 35 | 75.0 → 57.0 | 35 | 0.005-0.05 | 0.01 |
| butyl formate | 3.75 | 73.0 → 45.0 | 15 | 56.0 → 41.0 | 15 | 0.005-0.05 | 0.001 |
| amyl alcohol | 4.92 | 70.0 → 55.0 | 5 | 55.0 → 53.0 | 35 | 0.005-0.05 | 0.0001 |
| butyl acetate | 6.53 | 56.0 → 41.0 | 15 | 73.0 → 43.0 | 5 | 0.005-0.05 | 0.001 |
| furfural | 7.30 | 95.0 → 53.0 | 35 | 96.0 → 95.0 | 25 | 0.005-0.05 | 0.0001 |
| ethyl valerate | 10.10 | 57.0 → 41.0 | 10 | 88.0 → 61.0 | 10 | 0.005-0.05 | 0.0005 |
| 1-octen-3-ol | 13.42 | 57.0 → 31.0 | 25 | 72.0 → 43.0 | 25 | 0.005-0.05 | 0.01 |
| p-cymene | 15.20 | 134.0 → 91.0 | 35 | 119.0 → 77.0 | 35 | 0.005-0.05 | 0.0001 |
| limonene | 15.34 | 93.0 → 77.0 | 15 | 68.0 → 53.0 | 15 | 0.005-0.05 | 0.0001 |
| butyl isovalerate | 16.22 | 85.0 → 41.0 | 15 | 57.0 → 41.0 | 15 | 0.005-0.05 | 0.0005 |
| gamma-terpinene | 16.62 | 93.0 → 51.0 | 35 | 136.0 → 77.0 | 25 | 0.005-0.05 | 0.00005 |
| p-cresol | 17.39 | 108.0 → 107.0 | 5 | 107.0 → 77.0 | 0 | 0.005-0.05 | 0.05 |
| 2-nonanone | 18.00 | 58.0 → 43.0 | 15 | 71.0 → 43.0 | 15 | 0.005-0.05 | 0.00001 |
| amyl butyrate | 18.10 | 71.0 → 43.0 | 10 | 89.0 → 43.0 | 15 | 0.005-0.05 | 0.0001 |
| ethyl heptanoate | 18.36 | 113.0 → 57.0 | 10 | 88.0 → 61.0 | 15 | 0.005-0.05 | 0.00001 |
| nonanal | 18.47 | 98.0 → 56.0 | 5 | 57.0 → 39.0 | 15 | 0.005-0.05 | 0.00005 |
| 4-ethylphenol | 20.86 | 108.0 → 78.0 | 25 | 121.0 → 77.0 | 25 | 0.005-0.05 | 0.0005 |
| isoamyl hexanoate | 23.57 | 70.0 → 55.0 | 10 | 99.0 → 43.0 | 10 | 0.005-0.05 | 0.0001 |
| ethyl phenyl acetate | 23.69 | 91.0 → 65.0 | 35 | 164.0 → 91.0 | 10 | 0.005-0.05 | 0.00001 |
| cinnamaldehyde | 24.54 | 131.0 → 77.0 | 25 | 103.0 → 77.0 | 25 | 0.005-0.05 | 0.0001 |
| 1-decanol | 24.63 | 70.0 → 55.0 | 15 | 55.0 → 51.0 | 40 | 0.005-0.05 | 0.00005 |
| gamma-nonalactone | 27.66 | 85.0 → 57.0 | 25 | 114.0 → 70.0 | 25 | 0.005-0.05 | 0.001 |
| gamma-decalactone | 31.00 | 99.0 → 43.0 | 25 | 71.0 → 41.0 | 25 | 0.005-0.05 | 0.001 |
| ethyl myristate | 40.20 | 101.0 → 73.0 | 5 | 88.0 → 61.0 | 5 | 0.005-0.05 | 0.001 |
| ethyl palmitate | 42.26 | 101.0 → 73.0 | 5 | 88.0 → 61.0 | 5 | 0.005-0.05 | 0.0005 |

TABLE 3C
Additional LODs in GCMS assays

| | LOD |
|---|---|
| Compound | (mg/L) |
| (−)cis-rose oxide | <0.001 |
| cis-3-hexen-1-ol | <0.02 |
| farnesol | <0.0025 |
| geranyl acetone | <0.005 |
| isoamyl isovalerate | <0.0025 |

TABLE 3D
Transitions and Figures of Merit

| | | Collision | LOD |
|---|---|---|---|
| | Transition | Energy | (ug/L) |
| (1R)-(−)-myrtenal | 107 −> 79 | 15 | 0.1 |
| 3-Ethy1-2-hydroxy-2- | 126 −> 84 | 10 | 100 |
| cyclopenten-1-one | | | |
| (ethyl cyclopentenolone) | | | |
| 1,4-cineole | 125 −> 43 | 10 | 0.01 |
| 1-octanol | 56.0 −> 41.0 | 15 | 1 |
| 1-para-menthene-8-thiol | 68.0 −> 67.0 | 5 | 0.001 |
| 2,4,6-trimethylphenol | 136.0 −> 121.0 | 15 | 1 |
| (mesitol) | | | |
| 2-acetyl-1-methylpyrrole | 123 −> 108 | 10 | 0.1 |
| 2-ethyl-3-methylpyrazine | 122.0 −> 121.0 | 10 | 0.01 |
| 2-heptanol | 83.0 −> 55.0 | 10 | 1 |
| 2-heptanone | 58.0 −> 43.0 | 15 | 0.1 |
| 2-isopropyl-4-methyl thiazole | 141 −> 126 | 10 | 0.01 |
| 2-methoxy-3-(1-methylpropyl) | 138.0 −> 123.0 | 10 | 0.01 |
| pyrazine | | | |
| 2-methoxy-4-methylphenol | 123.0 −> 95.0 | 5 | 0.01 |
| (creosol) | | | |
| 2-methoxy-4-propylphenol | 137.0 −> 94.0 | 25 | 0.01 |
| 2-methylbutyl acetate | 70.0 −> 55.0 | 10 | 0.001 |
| 2-methylbutyl isovalerate | 70.0 −> 55.0 | 10 | 0.1 |
| 2-nonanol | 83.0 −> 55.0 | 10 | 1 |
| 2-pentyl furan | 81.0 −> 53.0 | 10 | 0.01 |
| 2-undecanone | 58.0 −> 43.0 | 25 | 0.01 |
| 3-carene | 93.0 −> 77.0 | 15 | 0.1 |
| 3-methylthio hexyl acetate | 115 −> 81 | 5 | 1 |
| 3-phenylpropanal | 134 −> 92 | 10 | 0.0001 |
| 4,5,6,7-tetrahydro-3,6- | 150 −> 108 | 10 | 0.01 |
| dimethylbenzofuran | | | |
| 4-carvomenthenol | 111.0 −> 77.0 | 25 | 0.05 |
| (terpinen-4-ol) | | | |
| 4-mercapto-4-methyl-2-pentanone | 132 −> 89 | 5 | 0.001 |
| 5-methyl-2-phenyl-2-hexenal | 117.0 −> 115.0 | 15 | 0.05 |
| 6-methyl-5-hepten-2-one | 108.0 −> 93.0 | 5 | 0.1 |
| acetoin | 88 −> 45 | 5 | 1000 |
| acetophenone | 105.0 −> 77.0 | 15 | 1 |
| a-ionone | 93.0 −> 51.0 | 30 | 100 |
| allyl heptanoate | 113 −> 43 | 5 | 0.001 |
| alpha-pinene | 93.0 −> 77.0 | 25 | 1 |
| anisyl acetate | 180 −> 138 | 5 | 0.01 |
| anisyl butyrate | 121 −> 77 | 15 | 0.1 |
| b-caryophellene | 93.0 −> 77.0 | 15 | 0.1 |
| benzyl acetate | 108.0 −> 79.0 | 15 | 0.1 |
| benzyl alcohol | 108 −> 79 | 15 | 10 |
| benzyl benzoate | 105.0 −> 77.0 | 15 | 0.01 |
| benzyl butyrate | 108 −> 79 | 5 | 0.01 |
| benzyl formate | 136 −> 108 | 5 | 1 |
| benzyl propionate | 108.0 −> 79.0 | 15 | 0.1 |
| butyl butyryllactate | 71 −> 43 | 5 | 0.01 |
| butyraldehyde | 72 −> 57 | 10 | 1 |
| butyric acid | 60.0 −> 42.0 | 10 | 0.2 |
| carvacrol | 150.0 −> 135.0 | 10 | 0.01 |
| cis-3-hexenyl acetate | 82.0 −> 67.0 | 10 | 0.1 |
| cis-3-hexenyl butyrate | 82 −> 67 | 5 | 100 |
| cis-3-hexenyl valerate | 85 −> 57 | 5 | 0.1 |
| cis-5-octen-1-ol | 81.0 −> 79.0 | 10 | 50 |
| cis-6-nonen-1-ol | 82 −> 67 | 10 | 1 |
| citral | 69.0 −> 41.0 | 10 | 1 |
| citronellal | 121 −> 93 | 15 | 0.01 |
| cuminaldehyde | 148.0 −> 119.0 | 10 | 0.01 |
| D-camphor | 152.0 −> 108.0 | 5 | 0.01 |
| D-carvone | 54.0 −> 39.0 | 15 | 0.5 |
| decanal | 82.0 −> 67.0 | 15 | 0.05 |
| decanoic acid | 73.0 −> 55.0 | 15 | 1 |
| delta-decalactone | 99.0 −> 43.0 | 10 | 1 |
| delta-dodecalactone | 99.0 −> 71.0 | 5 | 0.1 |
| d-fenchone | 69 −> 41 | 5 | 0.05 |
| diethyl malate | 117.0 −> 71.0 | 15 | 20 |
| diethyl succinate | 129.0 −> 101.0 | 5 | 5 |
| DL-3-methyl-2-butanol | 73 −> 45 | 10 | 1 |
| ethyl 2-methylbutyrate | 102.0 −> 74.0 | 10 | 0.1 |
| ethyl 2-trans-4-cis-decadienoate | 125 −> 97 | 10 | 0.01 |
| ethyl 3-hydroxyhexanoate | 117.0 −> 71.0 | 10 | 1 |
| ethyl benzoate | 105.0 −> 77.0 | 10 | 0.01 |
| ethyl laurate | 88.0 −> 61.0 | 15 | 0.005 |
| ethyl levulinate | 129.0 −> 101.0 | 10 | 1 |
| ethyl salicylate | 120.0 −> 92.0 | 10 | 0.01 |
| ethyl trans-2-butenoate | 99.0 −> 43.0 | 25 | 1 |
| ethyl undecanoate | 101.0 −> 73.0 | 5 | 0.1 |
| ethyl(methylthio) acetate | 134.0 −> 88.0 | 5 | 0.01 |
| ethyl-trans-3-hexenoate | 69.0 −> 41.0 | 10 | 0.1 |
| eucalyptol | 108.0 −> 77.0 | 15 | 0.1 |
| furufyl thioacetate | 81.0 −> 53.0 | 15 | 0.5 |
| gamma-dodecalactone | 43.0 −> 27.0 | 10 | 0.5 |
| gamma-heptalactone | 85.0 −> 29.0 | 10 | 1 |
| gamma-hexalactone | 85 −> 29 | 15 | 1 |
| gamma-octalactone | 85.0 −> 29.0 | 15 | 1 |
| gamma-undecalactone | 55.0 −> 27.0 | 20 | 1 |
| gamma-valerolactone | 85 −> 57 | 5 | 1 |
| geraniol | 69.0 −> 41.0 | 30 | 0.1 |
| heptyl acetate | 56.0 −> 41.0 | 15 | 0.1 |
| hexanoic acid | 60.0 −> 42.0 | 25 | 5 |
| hexyl 3-methylbutanoate | 103 −> 43 | 15 | 0.0001 |
| hexyl acetate | 69.0 −> 41.0 | 15 | 0.1 |
| hexyl isobutyrate | 89.0 −> 43.0 | 5 | 0.001 |
| IBMP | 124 −> 94 | 10 | 0.1 |
| (3-Isobutyl-2-methoxypyrazine) | | | |
| indole | 117.0 −> 90.0 | 10 | 0.005 |
| isoamyl cinnamate | 131.0 −> 103.0 | 10 | 0.01 |
| isoamyl isovalerate | 85.0 −> 57.0 | 5 | 0.01 |
| isoamyl octanoate | 70.0 −> 55.0 | 15 | 5 |
| isoamyl phenylacetate | 136.0 −> 91.0 | 10 | 0.01 |
| isobutyl isobutyrate | 71.0 −> 43.0 | 10 | 0.1 |
| isobutyl propionate | 57.0 −> 29.0 | 5 | 0.5 |
| isobutyraldehyde | 72.0 −> 43.0 | 5 | 10 |
| isobutyric acid | 73.0 −> 55.0 | 20 | 0.5 |
| isoeugenol | 164.0 −> 149.0 | 10 | 0.1 |
| isovaleric acid | 60.0 −> 42.0 | 25 | 0.5 |
| L-Carvone | 70 −> 55 | 5 | 1 |
| L-menthyl acetate | 138.0 −> 95.0 | 5 | 0.01 |
| Maltol | 126 −> 71 | 20 | 100 |
| massoia lactone | 97.0 −> 69.0 | 5 | 0.1 |
| methionyl acetate | 148 −> 88 | 5 | 0.1 |
| (3-methylthio-propylacetate) | | | |
| methyl acetate | 74.0 −> 43.0 | 5 | 1 |
| Methyl anthranilate | 151 −> 119 | 10 | 0.01 |
| methyl benzoate | 105.0 −> 77.0 | 5 | 0.05 |
| methyl beta-naphthyl ketone | 155.0 −> 127.0 | 10 | 0.5 |
| methyl cinnamate | 131.0 −> 103.0 | 10 | 0.005 |
| Methyl cyclopentenolone | 112 −> 84 | 5 | 100 |
| methyl decanoate | 74.0 −> 43.0 | 25 | 0.01 |
| methyl hexanoate | 74.0 −> 43.0 | 15 | 0.01 |
| methyl laurate | 74.0 −> 43.0 | 15 | 0.01 |
| methyl octanoate | 74.0 −> 43.0 | 15 | 0.01 |
| methyl salicylate | 120.0 −> 64.0 | 15 | 0.1 |
| methyl-2-pyrrolyl ketone | 94.0 −> 66.0 | 10 | 1 |
| Myrcene | 69.0 −> 41.0 | 10 | 0.1 |
| nerolidol | 93.0 −> 77.0 | 10 | 0.5 |
| nonanoic acid | 60.0 −> 42.0 | 15 | 0.2 |
| octanal | 84.0 −> 55.0 | 10 | 0.1 |
| octanoic acid | 60.0 −> 42.0 | 25 | 2 |
| omega-pentadecalactone | 83.0 −> 55.0 | 5 | 0.5 |
| p,a-dimethylstyrene | 132.0 −> 117.0 | 15 | 0.01 |
| p-anisaldehyde | 135 −> 77 | 25 | 100 |
| Perillaldehyde | 122 −> 107 | 5 | 1 |
| phenethyl 2-methylbutyrate | 105.0 −> 79.0 | 15 | 0.1 |
| Phenethyl acetate | 104.0 −> 78.0 | 25 | 0.0005 |
| phenethyl butyrate | 104.0 −> 78.0 | 10 | 0.001 |
| phenethyl formate | 104.0 −> 78.0 | 15 | 1000 |
| phenethyl octanoate | 104.0 −> 78.0 | 15 | 0.0001 |
| phenethyl propionate | 104.0 −> 78.0 | 25 | 0.1 |
| phenethyl tiglate | 104.0 −> 78.0 | 5 | 0.1 |
| phenylacetaldehyde | 120.0 −> 91.0 | 15 | 1 |
| phenylacetaldehyde dimethyl acetal | 135 −> 103 | 15 | 0.01 |
| propionaldehyde | 58 −> 57 | 5 | 100 |
| propionic acid | 73.0 −> 55.0 | 10 | 0.5 |
| propyl acetate | 73.0 −> 43.0 | 5 | 1 |
| propyl butyrate | 71.0 −> 43.0 | 10 | 0.5 |
| propyl isovalerate | 85.0 −> 57.0 | 5 | 0.1 |
| salicylaldehyde | 122.0 −> 121.0 | 15 | 0.1 |
| tetrahydrolinalool | 73 −> 55 | 10 | 1 |
| thymol | 150.0 −> 135.0 | 10 | 0.01 |
| trans-2-Hexen-1-al | 83 −> 55 | 5 | 1 |
| valencene | 161.0 −> 105.0 | 15 | 0.5 |
| valeraldehyde | 58 −> 57 | 10 | 1 |
| valeric acid | 60.0 −> 42.0 | 15 | 0.4 |
| vanillyl butyl ether | 137 −> 94 | 15 | 0.05 |
| vanillyl ethyl ether | 137.0 −> 94.0 | 20 | 1 |

TABLE 4A
VOCs in reference Scotches

| Round 1 assays | | | | | | |
|---|---|---|---|---|---|---|
| (values in mg/L) | 1 | 1 | 1 | 2 | 2 | 2 |
| (−)-beta-pinene | NF | NF | NF | NF | NF | NF |
| 1,1-diethoxyethane | 6.23E−01 | 5.65E−01 | 8.97E−01 | 2.11E−01 | 3.76E−01 | 3.17E−01 |
| 2-methyl-1-butanol | 1.90E+02 | 1.52E+02 | 2.02E+02 | 2.97E+02 | 3.18E+02 | 3.01E+02 |
| 2-phenylethanol | 2.50E−01 | 2.29E−01 | 2.73E−01 | 7.43E−01 | 7.86E−01 | 7.45E−01 |
| 2-phenylethylacetate | 3.67E+01 | 2.78E+01 | 3.53E+01 | 5.74E+01 | 6.85E+01 | 6.84E+01 |
| 4-Ethyl Guaiacol | NF | NF | NF | 3.17E+00 | 3.50E+00 | 3.24E+00 |
| acetoin | NF | NF | NF | NF | NF | NF |
| a-terpineol | NF | NF | NF | NF | NF | NF |
| beta-ionone | NF | NF | NF | NF | NF | NF |
| [symbol] tanol | 8.51E+00 | 6.63E+00 | 7.68E+00 | 9.54E+00 | 1.06E+01 | 1.03E+01 |
| citronellol | 2.15E−02 | 1.76E−02 | 2.32E−02 | 8.17E−03 | 1.12E−02 | 4.30E−04 |
| damascenone | 4.26E−02 | 4.52E−02 | 4.73E−02 | 5.33E−02 | 4.77E−02 | 4.73E−02 |
| diethyl succinate | 9.70E+00 | 8.14E+00 | 1.12E+01 | 2.40E+00 | 2.69E+00 | 2.59E+00 |
| ethyl acetate | 2.93E+02 | 2.36E+02 | 2.70E+02 | 1.30E+02 | 1.32E+02 | 1.24E+02 |
| ethyl butanoate | 9.84E−01 | 7.65E−01 | 1.05E+00 | 6.05E−01 | 6.33E−01 | 6.05E−01 |
| ethyl cinnamate | 9.03E−03 | 9.03E−03 | 1.12E−02 | 1.16E−02 | 1.12E−02 | 1.20E−02 |
| ethyl decanoate | 8.57E+00 | 1.06E+01 | 8.72E+00 | 5.95E+00 | 5.15E+00 | 5.89E+00 |
| ethyl hexanoate | 2.09E−01 | 2.26E−01 | 2.58E−01 | 4.47E−02 | 4.52E−02 | 4.17E−02 |
| ethyl isobutyrate | 1.67E+00 | 1.37E+00 | 1.67E+00 | 5.79E−01 | 6.87E−01 | 6.50E−01 |
| ethyl isovalerate | 7.81E−01 | 6.42E−01 | 8.32E−01 | 2.08E−01 | 2.91E−01 | 2.37E−01 |
| ethyl lactate | 4.70E+00 | 4.69E+00 | 4.62E+00 | NF | NF | NF |
| ethyl laurate | 3.08E+01 | 3.39E+01 | 3.14E+01 | 1.61E+01 | 1.46E+01 | 1.55E+01 |
| ethyl nonanoate | 5.13E−01 | 6.88E−01 | 5.87E−01 | 1.30E+00 | 1.20E+00 | 1.31E+00 |
| ethyl octanoate | 3.71E+01 | 5.87E+01 | 5.31E+01 | 9.67E+00 | 8.09E+00 | 9.29E+00 |
| ethyl-2- | 7.15E−01 | 6.76E−01 | 7.92E−01 | 2.24E−01 | 2.13E−01 | 2.30E−01 |
| methylbutyrate | | | | | | |
| eugenol | 2.37E−01 | 2.27E−01 | 2.74E−01 | 3.64E−01 | 3.11E−01 | 3.25E−01 |
| guaiacol | 1.20E−02 | 2.15E−02 | 3.61E−02 | 2.50E+00 | 3.09E+00 | 3.54E+00 |
| hexanol | 3.23E−02 | 2.75E−02 | 3.23E−02 | 6.54E−02 | 7.48E−02 | 7.91E−02 |
| isoamyl acetate | 4.49E−01 | 3.56E−01 | 5.63E−01 | 1.39E+00 | 1.50E+00 | 1.44E+00 |
| isoamyl alcohol | 6.47E+02 | 5.32E+02 | 6.76E+02 | 1.04E+03 | 1.12E+03 | 9.29E+02 |
| isobutanol | 4.64E+02 | 3.16E+02 | 4.09E+02 | 6.74E+02 | 7.74E+02 | 7.27E+02 |
| isobutyl acetate | 8.04E−02 | 7.05E−02 | 9.29E−02 | 1.09E−01 | 1.10E−01 | 9.46E−02 |
| Isovaleraldehyde | 1.79E−01 | 1.92E−01 | 1.56E−01 | 3.07E−01 | 3.56E−01 | 3.43E−01 |
| linalool oxide | 2.65E−01 | 2.13E−01 | 2.17E−01 | NF | 2.37E−01 | 1.57E−01 |
| linalyl acetate | 5.59E−03 | 1.38E−02 | 4.30E−04 | NF | NF | 2.15E−03 |
| [symbol] yrtenol | 3.00E−01 | 4.18E−01 | 3.85E−01 | 2.00E−01 | 1.70E−01 | 1.97E−01 |
| propanol | 2.75E+02 | 2.00E+02 | 2.51E+02 | 2.88E+02 | 3.05E+02 | 2.61E+02 |
| whiskey lactone | 5.36E−01 | 4.17E−01 | 5.67E−01 | 1.46E+00 | 1.65E+00 | 1.43E+00 |

BC = below the standard curve
ND = not done
NF = not found
SC = bad standard curve
*Detected, but below the curve [symbol]
indicates data missing or illegible when filed

TABLE 4B
VOCs in reference Scotches

| Round 2 assays | | | | | | | | | |
|---|---|---|---|---|---|---|---|---|---|
| (values in mg/L) | 1 | 1 | 1 | 2 | 2 | 2 | 3 | 3 | 3 |
| (−)-alpha-pinene | NF | NF | NF | BC | BC | BC | BC | BC | BC |
| (−)-beta-pinene | NF | NF | NF | NF | NF | NF | NF | NF | NF |
| (−)-cis-rose oxide | 1.33E−04 | 1.73E−04 | 1.69E−04 | 2.26E−04 | 2.41E−04 | 1.69E−04 | NF | NF | NF |
| 1,1-diethoxyethane | 1.39E+00 | 1.45E+00 | 2.00E+00 | 1.05E+00 | 1.02E+00 | 1.19E+00 | 1.92E+00 | 1.58E+00 | 1.80E+00 |
| 1-decanol | 1.44E−01 | 1.38E−01 | 1.38E−01 | 3.13E−01 | 3.54E−01 | 3.47E−01 | 1.58E−01 | 1.73E−01 | 1.81E−01 |
| 1-octanol | 1.04E−01 | 1.12E−01 | 1.12E−01 | 1.15E−01 | 1.16E−01 | 1.14E−01 | 1.29E−01 | 1.08E−01 | 1.28E−01 |
| 1-octen-3-ol | 2.00E−01 | 1.93E−01 | 1.87E−01 | 1.06E−01 | 1.06E−01 | 1.07E−01 | 4.80E−02 | 5.10E−02 | 5.51E−02 |
| 2,3-pentadione | NF | NF | NF | NF | NF | NF | NF | NF | 7.26E−04 |
| 2-heptanone | 3.44E−02 | 3.26E−02 | 3.27E−02 | 3.08E−02 | 3.15E−02 | 3.00E−02 | 1.39E−02 | 1.31E−02 | 1.66E−02 |
| 2-methoxy-4- | 1.23E−03 | 8.79E−04 | 9.42E−04 | 3.16E−02 | 2.81E−02 | 2.75E−02 | 1.91E−02 | 2.11E−02 | 2.46E−02 |
| p [symbol] ylphenol | | | | | | | | | |
| 2-methyl-1-butanol | 2.41E+02 | 2.08E+02 | 2.30E+02 | 2.11E+02 | 2.64E+02 | 2.63E+02 | 2.39E+02 | 2.58E+02 | 2.40E+02 |
| 2-methylbutyl | 2.80E−01 | 2.36E−01 | 3.59E−01 | 5.63E−01 | 5.55E−01 | 5.26E−01 | 7.74E−01 | 7.57E−01 | 8.66E−01 |
| acetate | | | | | | | | | |
| 2-methylbutyl | BC | BC | BC | NF | NF | NF | NF | NF | NF |
| isovalerate | | | | | | | | | |
| 2- | 2.47E−02 | 2.83E−02 | 2.72E−02 | 6.84E−02 | 7.11E−02 | 7.37E−02 | 4.99E−02 | 4.12E−02 | 4.58E−02 |
| methylbutyraldehyde | | | | | | | | | |
| 2-nonanol | NF | NF | NF | NF | NF | NF | NF | NF | NF |
| 2-nonanone | 4.19E−02 | 4.20E−02 | 3.64E−02 | 3.48E−02 | 3.47E−02 | 3.44E−02 | 2.48E−02 | 2.37E−02 | 3.04E−02 |
| 2-phenylethanol | 4.38E+01 | 4.48E+01 | 4.41E+01 | 7.91E+01 | 7.30E+01 | 7.92E+01 | 6.07E+01 | 6.42E+01 | 4.23E+01 |
| 2-phenylethylacetate | 1.41E−01 | 1.32E−01 | 1.49E−01 | 3.05E−01 | 3.21E−01 | 3.28E−01 | 5.58E−01 | 5.77E−01 | 5.99E−01 |
| 2-undecanone | 5.75E−04 | 6.13E−04 | 6.25E−04 | 5.25E−04 | 6.23E−04 | 6.61E−04 | 6.68E−04 | 5.65E−04 | 4.00E−04 |
| 3-carene | BC | BC | BC | NF | NF | NF | NF | NF | NF |
| 4-carvomenthenol | NF | NF | NF | NF | NF | NF | NF | NF | NF |
| 4-Ethyl Guaiacol | 2.78E+00 | 2.68E+00 | 2.65E+00 | 6.67E+01 | 6.78E+01 | 7.13E+01 | 4.13E+01 | 4.21E+01 | 4.43E+01 |
| 4-Ethyl Phenol | NF | NF | NF | NF | NF | NF | NF | NF | NF |
| acetophenone | 2.71E−03 | 2.74E−03 | 2.73E−03 | 4.07E−02 | 4.15E−02 | 4.19E−02 | 3.04E−02 | 2.90E−02 | 3.47E−02 |
| alpha ionone | NF | NF | NF | 1.42E−03 | 1.44E−03 | 1.48E−03 | NF | NF | NF |
| amyl alcohol | 8.75E−03 | 9.18E−03 | 2.67E−03 | 1.24E−02 | 1.17E−02 | 1.62E−02 | 4.18E−03 | 3.10E−03 | 0.00E+00 |
| amyl butyrate | NF | NF | NF | NF | NF | NF | NF | NF | NF |
| a-terpineol | NF | NF | NF | NF | NF | NF | NF | NF | NF |
| benzaldehyde | 1.42E−01 | 1.74E−01 | 1.59E−01 | 5.50E−02 | 2.34E−02 | 6.12E−02 | BC | 5.90E−03 | BC |
| benzyl acetate | NF | NF | NF | NF | NF | NF | NF | NF | NF |
| beta-ionone | 6.82E−04 | 6.80E−04 | 7.00E−04 | 1.78E−03 | 1.75E−03 | 1.85E−03 | 5.89E−04 | 5.72E−04 | 5.66E−04 |
| butanol | 1.26E+01 | 1.10E+01 | 8.17E+00 | 1.76E+01 | 1.73E+01 | 1.63E+01 | 1.57E+01 | 1.54E+01 | 1.61E+01 |
| butyl acetate | BC | BC | BC | BC | BC | BC | 4.45E−01 | 4.58E−01 | 4.87E−01 |
| carvone | NF | NF | NF | 1.12E−03 | 1.17E−03 | 1.14E−03 | NF | NF | NF |
| C [symbol] amaldehyde | 1.28E−03 | 1.74E−03 | 2.51E−03 | 5.88E−03 | 2.67E−03 | 7.12E−03 | 1.71E−04 | 2.31E−03 | 1.05E−03 |
| cis-3-hexen-1-ol | 8.36E−02 | 7.87E−02 | 8.56E−02 | 7.35E−02 | 7.23E−02 | 7.32E−02 | 6.85E−02 | 6.66E−02 | 6.95E−02 |
| cis-3-hexenyl acetate | 1.16E−03 | 1.38E−03 | 1.54E−03 | 1.23E−03 | 1.07E−03 | 1.19E−03 | 8.69E−04 | 7.81E−04 | 8.31E−04 |
| citronellol | 4.87E−03 | 4.77E−03 | 4.76E−03 | 6.21E−03 | 5.20E−03 | 5.71E−03 | 4.04E−03 | 4.07E−03 | 3.43E−03 |
| diethyl malate | 2.50E+01 | 2.06E+01 | 2.29E+01 | 3.26E+00 | 3.31E+00 | 3.03E+00 | 2.41E+00 | 3.05E+00 | 2.88E+00 |
| ethyl 3- | 1.00E−02 | 1.01E−02 | 1.04E−02 | 9.65E−03 | 9.68E−03 | 9.71E−03 | 1.04E−02 | 1.02E−02 | 1.04E−02 |
| hydroxyhexanoate | | | | | | | | | |
| ethyl acetate | 3.91E+02 | 3.88E+02 | 3.67E+02 | 1.11E+02 | 1.07E+02 | 1.21E+02 | 1.24E+02 | 1.62E+02 | 8.51E+01 |
| ethyl benzoate | 1.09E−02 | 1.06E−02 | 1.02E−02 | 1.79E−02 | 1.82E−02 | 1.89E−02 | 1.09E−02 | 1.10E−02 | 1.14E−02 |
| ethyl butanoate | 5.34E−01 | 5.10E−01 | 5.10E−01 | 2.85E−01 | 2.86E−01 | 2.73E−01 | 4.36E−01 | 4.39E−01 | 4.57E−01 |
| ethyl cinnamate | 7.25E−04 | 7.42E−04 | 8.01E−04 | 7.99E−04 | 8.64E−04 | 8.83E−04 | 7.40E−04 | 7.67E−04 | 8.00E−04 |
| ethyl decanoate | 1.53E+01 | 1.45E+01 | 1.38E+01 | 3.53E+00 | 5.74E+00 | 5.84E+00 | 9.84E+00 | 9.23E+00 | 5.95E+00 |
| ethyl heptanoate | BC | BC | BC | BC | BC | BC | BC | BC | BC |
| ethyl hexanoate | 2.00E+00 | 1.87E+00 | 1.91E+00 | 6.09E−01 | 5.98E−01 | 6.28E−01 | 1.24E+00 | 1.22E+00 | 1.35E+00 |
| ethyl isobutyrate | 2.34E+00 | 2.46E+00 | 2.72E+00 | 1.08E+00 | 1.08E+00 | 1.16E+00 | 1.58E+00 | 1.41E+00 | 1.52E+00 |
| ethyl isovalerate | 7.14E−01 | 7.23E−01 | 6.43E−01 | 1.21E−01 | 1.96E−01 | 2.14E−01 | 2.52E−01 | 2.57E−01 | 1.64E−01 |
| ethyl lactate | 2.58E+01 | 2.10E+01 | 3.11E+01 | 6.96E+00 | 8.68E+00 | 8.82E+00 | 4.01E+00 | 2.95E+00 | 3.35E+00 |
| ethyl laurate | 1.78E+00 | 1.71E+00 | 1.61E+00 | 6.70E−01 | 6.54E−01 | 7.44E−01 | 1.36E+00 | 5.87E−01 | 1.39E+00 |
| ethyl levulinate | 5.54E−02 | 5.51E−02 | 6.31E−02 | 1.12E−02 | 1.74E−02 | 1.56E−02 | 1.41E−02 | 1.63E−02 | 1.62E−02 |
| ethyl myristate | 5.32E−02 | 5.08E−02 | 5.05E−02 | 3.81E−02 | 1.37E−02 | 1.37E−02 | 3.23E−02 | 2.97E−02 | 3.30E−02 |
| ethyl nonanoate | 1.87E−02 | 1.50E−02 | 1.62E−02 | 3.55E−02 | 3.52E−02 | 3.98E−02 | 1.84E−02 | 1.61E−02 | 1.74E−02 |
| ethyl octanoate | 1.58E+01 | 1.54E+01 | 1.65E+01 | 4.60E+00 | 4.56E+00 | 4.89E+00 | 1.02E+01 | 9.03E+00 | 9.68E+00 |
| ethyl phenyl acetate | 5.75E−02 | 5.28E−02 | 5.25E−02 | 4.41E−02 | 4.55E−02 | 4.84E−02 | 1.89E−02 | 1.95E−02 | 2.07E−02 |
| ethyl propionate | 1.42E+00 | 1.37E+00 | 1.32E+00 | 1.25E+00 | 1.26E+00 | 1.18E+00 | 1.33E+00 | 1.33E+00 | 1.40E+00 |
| ethyl salicylate | BC | BC | BC | BC | BC | BC | BC | BC | BC |
| ethyl trans-2- | 1.60E−02 | 1.54E−02 | 1.58E−02 | 1.17E−02 | 1.04E−02 | 1.05E−02 | 1.57E−02 | 1.70E−02 | 1.78E−02 |
| butenoate | | | | | | | | | |
| ethyl trans-3- | NF | NF | NF | NF | NF | NF | NF | NF | NF |
| h [symbol] enoate | | | | | | | | | |
| ethyl undecanoate | BC | BC | BC | BC | BC | BC | BC | BC | BC |
| ethyl valerate | 6.13E−02 | 6.45E−02 | 7.20E−02 | 1.12E−01 | 1.15E−01 | 1.21E−01 | 1.15E−01 | 9.86E−02 | 1.10E−01 |
| ethyl(methylthio) | NF | NF | NF | NF | NF | NF | NF | NF | NF |
| acetate | | | | | | | | | |
| ethyl-2- | 1.77E−01 | 1.85E−01 | 2.12E−01 | 2.82E−02 | 2.79E−02 | 3.06E−02 | 4.92E−02 | 4.09E−02 | 4.46E−02 |
| methylbutyrate | | | | | | | | | |
| eucalyptol | NF | NF | NF | NF | NF | NF | NF | NF | NF |
| eugenol | 7.08E−02 | 6.87E−02 | 6.79E−02 | 1.13E−01 | 1.16E−01 | 1.23E−01 | 7.50E−02 | 7.70E−02 | 8.13E−02 |
| farnesol | 2.36E−02 | 2.34E−02 | 2.27E−02 | 2.44E−02 | 2.65E−02 | 2.55E−02 | 1.96E−02 | 1.95E−02 | 1.77E−02 |
| furfural | 9.22E+00 | 8.59E+00 | 8.85E+00 | 6.06E+00 | 6.17E+00 | 6.23E+00 | 2.33E+00 | 2.39E+00 | 2.22E+00 |
| gamma-decalactone | 6.09E−02 | 6.26E−02 | 6.42E−02 | 6.00E−02 | 9.04E−02 | 9.11E−02 | 3.63E−02 | 3.30E−02 | 1.98E−02 |
| gamma-nonalactone | 2.44E−02 | 2.42E−02 | 2.73E−02 | 3.26E−02 | 3.30E−02 | 3.13E−02 | 2.18E−02 | 2.10E−02 | 2.10E−02 |
| gamma-terpinene | 1.62E−04 | 1.59E−04 | 1.61E−04 | 4.10E−04 | 4.18E−04 | 4.49E−04 | 2.37E−04 | 2.54E−04 | 2.82E−04 |
| geraniol | 2.05E−02 | 2.11E−02 | 1.99E−02 | 1.94E−02 | 1.96E−02 | 1.96E−02 | 2.03E−02 | 2.03E−02 | 2.04E−02 |
| geranyl acetone | 7.09E−03 | 7.03E−03 | 7.11E−03 | 8.12E−03 | 8.08E−03 | 8.21E−03 | 6.98E−03 | 6.91E−03 | 6.90E−03 |
| guaiacol | 1.28E−02 | 1.22E−02 | 1.29E−02 | 6.59E−01 | 7.12E−01 | 7.40E−01 | 4.42E−01 | 4.35E−01 | 4.64E−01 |
| heptyl acetate | BC | BC | BC | BC | BC | BC | BC | BC | BC |
| hexanol | 1.60E+00 | 1.58E+00 | 1.47E+00 | 2.07E+00 | 1.99E+00 | 1.98E+00 | 1.49E+00 | 1.28E+00 | 1.47E+00 |
| isoamyl acetate | 1.26E+00 | 1.16E+00 | 1.29E+00 | 2.05E+00 | 1.92E+00 | 2.11E+00 | 3.86E+00 | 3.77E+00 | 4.08E+00 |
| isoamyl alcohol | 1.02E+02 | 1.05E+02 | 9.70E+01 | 1.02E+03 | 7.68E+02 | 8.01E+02 | 4.99E+02 | 5.01E+02 | 2.71E+02 |
| isoamyl hexanoate | BC | BC | BC | BC | BC | BC | BC | BC | BC |
| isoamyl isobutyrate | BC | BC | BC | BC | BC | BC | BC | BC | BC |
| isoamyl isovalerate | BC | BC | BC | BC | BC | BC | BC | BC | BC |
| isoamyl octanoate | 3.96E−03 | 4.18E−03 | 4.16E−03 | 1.35E−03 | 1.04E−03 | 1.70E−03 | 1.94E−03 | 1.62E−03 | 1.63E−03 |
| isobutanol | 1.68E+02 | 1.44E+02 | 1.65E+02 | 3.57E+02 | 3.08E+02 | 3.36E+02 | 3.23E+02 | 3.02E+02 | 2.99E+02 |
| isobutyl acetate | 7.02E−02 | 6.40E−02 | 7.12E−02 | 7.23E−02 | 7.33E−02 | 7.62E−02 | 1.12E−01 | 1.07E−01 | 1.16E−01 |
| is [symbol] utyl isobutyrate | BC | BC | BC | BC | BC | BC | BC | BC | BC |
| isobutyraldehyde | 5.74E−01 | 5.09E−01 | 4.77E−01 | 2.38E−01 | 2.26E−01 | 2.10E−01 | 1.12E−01 | 1.17E−01 | 1.27E−01 |
| Isovaleraldehyde | 3.85E−01 | 4.01E−01 | 4.15E−01 | 4.53E−01 | 4.33E−01 | 4.16E−01 | 2.80E−01 | 2.89E−01 | 3.07E−01 |
| limonene | 3.02E−05 | 3.45E−05 | 3.20E−05 | 8.31E−06 | 2.43E−05 | 3.31E−05 | 3.04E−05 | 3.22E−05 | 3.10E−05 |
| linalool | NF | NF | NF | NF | NF | NF | NF | NF | NF |
| linalool oxide | 3.63E−02 | 3.34E−02 | 3.34E−02 | 5.07E−02 | 5.30E−02 | 5.58E−02 | 1.22E−02 | 1.38E−02 | 1.51E−02 |
| linalyl acetate | 2.25E−04 | 1.90E−04 | 1.41E−04 | 7.13E−05 | BC | BC | BC | BC | BC |
| methional | 3.64E−03 | 3.49E−03 | 3.55E−03 | 3.66E−03 | 3.61E−03 | 3.61E−03 | 3.56E−03 | 3.52E−03 | 0.00E+00 |
| methyl acetate | BC | BC | BC | BC | BC | BC | BC | BC | BC |
| methyl hexanoate | BC | BC | BC | BC | BC | BC | BC | BC | BC |
| methyl laurate | 1.52E−04 | 1.22E−04 | 1.15E−04 | 1.02E−05 | BC | BC | BC | BC | BC |
| Methyl Octanoate | BC | BC | BC | BC | BC | BC | BC | BC | BC |
| methyl salicylate | 1.01E−02 | 9.84E−03 | 9.75E−03 | 7.45E−03 | 7.51E−03 | 7.52E−03 | 6.26E−03 | 6.26E−03 | 6.30E−03 |
| Myrcene | NF | NF | NF | NF | NF | NF | NF | NF | NF |
| p-anisaldehyde | NF | NF | NF | NF | NF | NF | NF | NF | NF |
| p-cresol | 1.73E−02 | 1.73E−02 | 1.77E−02 | 2.52E+00 | 2.50E+00 | 2.47E+00 | 1.76E+00 | 1.75E+00 | 1.76E+00 |
| p-cymene | BC | BC | BC | BC | BC | BC | BC | BC | BC |
| Phenethyl Butyrate | 3.44E−03 | 3.44E−03 | 3.43E−03 | 3.65E−03 | 3.67E−03 | 3.67E−03 | 3.68E−03 | 3.70E−03 | 3.74E−03 |
| phenethyl formate | 2.49E−02 | 2.49E−02 | 2.50E−02 | 2.64E−02 | 2.65E−02 | 2.64E−02 | 2.73E−02 | 2.69E−02 | 2.50E−02 |
| phenethyl octanoate | 2.91E−03 | 2.87E−03 | 2.78E−03 | 1.94E−03 | 2.05E−03 | 2.24E−03 | 1.28E−03 | 1.26E−03 | 1.24E−03 |
| phenethyl propionate | 4.98E−04 | 4.88E−04 | 4.62E−04 | 7.43E−04 | 7.77E−04 | 7.10E−04 | 9.22E−04 | 7.88E−04 | 7.33E−04 |
| propanol | 2.75E+02 | 2.83E+02 | 3.74E+02 | 3.42E+02 | 3.19E+02 | 3.44E+02 | 3.68E+02 | 3.15E+02 | 3.45E+02 |
| propyl acetate | 1.12E−01 | 9.50E−02 | 1.03E−01 | 6.20E−02 | 5.70E−02 | 6.34E−02 | 9.20E−02 | 8.89E−02 | 9.19E−02 |
| salicylaldehyde | 9.43E−03 | 9.37E−03 | 9.46E−03 | 9.59E−03 | 1.03E−02 | 1.06E−02 | 8.90E−03 | 9.16E−03 | 9.43E−03 |
| vanillyl ethyl ether | 2.66E−02 | 2.74E−02 | 2.60E−02 | 3.41E−02 | 3.13E−02 | 3.20E−02 | 1.86E−02 | 1.86E−02 | 1.47E−02 |
| whiskey lactone | 9.95E−01 | 1.05E+00 | 1.00E+00 | 2.67E+00 | 2.49E+00 | 2.45E+00 | 6.96E−01 | 6.94E−01 | 4.15E−01 |

BC = below the standard curve
ND = not done
NF = not found
SC = bad standard curve
*Detected, but below the curve [symbol]
indicates data missing or illegible when filed

TABLE 4C
VOCs in reference Scotches

| Round 3 assays | | | | | | | | | |
|---|---|---|---|---|---|---|---|---|---|
| (values in mg/L) | W1 | W2 | W3 | W4 | W5 | W6 | W7 | W8 | W9 |
| (1R)-(−)-myrtenal | 0.00E+00 | 0.00E+00 | 0.00E+00 | 0.00E+00 | 0.00E+00 | 0.00E+00 | 0.00E+00 | 0.00E+00 | 0.00E+00 |
| (ethyl cyclopentenolone)3- | 0.00E+00 | 0.00E+00 | 0.00E+00 | 0.00E+00 | 0.00E+00 | 0.00E+00 | 0.00E+00 | 0.00E+00 | 0.00E+00 |
| Ethyl-2-hydroxy-2- | | | | | | | | | |
| cyclopenten-1-one | | | | | | | | | |
| 1,4-cineole | 0.00E+00 | 0.00E+00 | 0.00E+00 | 0.00E+00 | 0.00E+00 | 0.00E+00 | 0.00E+00 | 0.00E+00 | 0.00E+00 |
| 1-decanol | ND | 8.39E−01 | 7.04E−01 | 1.32E+00 | 8.64E−01 | 6.02E−01 | 5.54E−01 | 2.03E−01 | ND |
| 1-octanol | 0.00E+00 | 0.00E+00 | 0.00E+00 | 0.00E+00 | 0.00E+00 | 0.00E+00 | 0.00E+00 | 0.00E+00 | 0.00E+00 |
| 1-octen-3-ol | ND | 0.00E+00 | 1.52E−02 | 1.29E+00 | 7.26E−02 | 7.81E−03 | 1.05E−01 | 2.40E−01 | ND |
| 1-para-menthene-8-thiol | 1.01E−05 | 1.34E−05 | 2.93E−05 | 0.00E+00 | 0.00E+00 | 0.00E+00 | 0.00E+00 | 3.39E−06 | 0.00E+00 |
| 2,3-pentadione | 0.00E+00 | 0.00E+00 | 0.00E+00 | 0.00E+00 | 0.00E+00 | 0.00E+00 | 0.00E+00 | 0.00E+00 | 0.00E+00 |
| 2,4,6-trimethylphenol | 0.00E+00 | 5.29E−03 | 0.00E+00 | 7.21E−02 | 5.20E−02 | 0.00E+00 | 0.00E+00 | 0.00E+00 | 0.00E+00 |
| (mesitol) | | | | | | | | | |
| 2-acetyl-1-methylpyrrole | 0.00E+00 | 0.00E+00 | 0.00E+00 | 0.00E+00 | 0.00E+00 | 0.00E+00 | 0.00E+00 | 0.00E+00 | 0.00E+00 |
| 2-ethyl-3-methylpyrazine | 0.00E+00 | 2.24E−03 | 1.03E−03 | 1.44E−02 | 1.01E−02 | 1.29E−03 | 5.30E−04 | 4.10E−04 | 0.00E+00 |
| 2-heptanol | 1.80E−02 | 5.05E−02 | 0.00E+00 | 0.00E+00 | 0.00E+00 | 2.81E−02 | 0.00E+00 | 3.36E−01 | 0.00E+00 |
| 2 [symbol] ptanone | 2.55E−02 | 2.55E−01 | 3.34E−02 | 5.51E−02 | 3.96E−02 | 5.07E−02 | 3.67E−02 | 9.82E−02 | 4.36E−02 |
| 2-isopropyl-4-methyl | 0.00E+00 | 0.00E+00 | 0.00E+00 | 0.00E+00 | 0.00E+00 | 0.00E+00 | 0.00E+00 | 0.00E+00 | 0.00E+00 |
| thiazole | | | | | | | | | |
| 2-methoxy-3-(1- | 0.00E+00 | 0.00E+00 | 0.00E+00 | 0.00E+00 | 0.00E+00 | 7.63E−04 | 0.00E+00 | 0.00E+00 | 0.00E+00 |
| methylpropyl) pyrazine | | | | | | | | | |
| 2-methoxy-4-methylphenol | 5.54E−04 | 2.53E−03 | 5.97E−05 | 4.29E−02 | 5.38E−02 | 7.78E−04 | 3.14E−04 | 2.87E−04 | 4.17E−04 |
| (creosol) | | | | | | | | | |
| 2-methoxy-4-propylphenol | 9.81E−04 | 4.74E−03 | 5.06E−04 | 7.61E−02 | 5.73E−02 | 2.93E−03 | 5.09E−04 | 0.00E+00 | 9.00E−04 |
| 2-methylbutyl acetate | 2.16E−01 | 4.15E−01 | 8.98E−01 | 8.61E−01 | 3.04E−01 | 2.38E−01 | 2.14E−01 | 2.07E−01 | 1.65E−01 |
| 2-methylbutyl isovalerate | 0.00E+00 | 7.81E−04 | 4.23E−03 | 0.00E+00 | 2.79E−03 | 0.00E+00 | 3.98E−03 | 0.00E+00 | 0.00E+00 |
| 2-methylbutyraldehyde | 6.96E+00 | 9.15E+00 | 6.57E+00 | 5.87E+00 | 9.87E+00 | 6.93E+00 | 6.11E+00 | 7.22E+00 | 6.96E+00 |
| 2-nonanol | 0.00E+00 | 3.83E−02 | 0.00E+00 | 0.00E+00 | 0.00E+00 | 0.00E+00 | 0.00E+00 | 1.99E−01 | 0.00E+00 |
| 2-nonanone | 4.08E−03 | 7.73E−02 | 3.52E−03 | 1.73E−02 | 7.18E−03 | 1.69E−02 | 1.91E−03 | 2.32E−02 | 1.58E−02 |
| 2-pentyl furan | 2.45E−02 | 2.76E−02 | 5.86E−02 | 1.35E−02 | 2.16E−02 | 4.07E−02 | 1.69E−02 | 4.87E−02 | 0.00E+00 |
| 2-phenylethanol | 8.76E+00 | 3.58E+01 | 4.72E+01 | 4.16E+01 | 4.97E+01 | 3.28E+01 | 3.65E+01 | 2.11E+01 | 7.42E+00 |
| 2-phenylethylacetate | 1.35E+00 | 2.06E+00 | 2.75E+00 | 3.17E+00 | 1.44E+00 | 1.60E+00 | 1.15E+00 | 1.10E+00 | 1.02E+00 |
| 2-undecanone | 2.98E−03 | 4.53E−03 | 5.09E−03 | 7.76E−03 | 2.30E−03 | 7.03E−03 | 8.38E−03 | 1.63E−02 | 0.00E+00 |
| 3-carene | 0.00E+00 | 0.00E+00 | 0.00E+00 | 0.00E+00 | 0.00E+00 | 0.00E+00 | 0.00E+00 | 0.00E+00 | 0.00E+00 |
| 3-methylthio hexyl acetate | 0.00E+00 | 0.00E+00 | 0.00E+00 | 0.00E+00 | 0.00E+00 | 0.00E+00 | 0.00E+00 | 0.00E+00 | 0.00E+00 |
| 3-phenylpropanal | 0.00E+00 | 0.00E+00 | 0.00E+00 | 0.00E+00 | 0.00E+00 | 0.00E+00 | 0.00E+00 | 0.00E+00 | 0.00E+00 |
| 4,5,6,7-tetrahydro-3,6- | 0.00E+00 | 0.00E+00 | 0.00E+00 | 0.00E+00 | 0.00E+00 | 0.00E+00 | 0.00E+00 | 0.00E+00 | 0.00E+00 |
| dimethylbenzofuran | | | | | | | | | |
| 4-carvomenthenol | 0.00E+00 | 0.00E+00 | 0.00E+00 | 0.00E+00 | 0.00E+00 | 0.00E+00 | 8.33E−04 | 1.21E−03 | 0.00E+00 |
| 4-Ethyl Guaiacol | 1.69E−02 | 8.13E−02 | 2.73E−03 | 2.07E+00 | 1.37E+00 | 2.78E−02 | 8.33E−03 | 1.70E−03 | 1.77E−02 |
| 4-Ethyl Phenol | 7.23E−02 | 1.48E−01 | 1.89E−04 | AC | 8.40E−01 | 5.70E−02 | 4.71E−02 | 4.56E−02 | 0.00E+00 |
| 4-mercapto-4-methyl-2- | 0.00E+00 | 0.00E+00 | 0.00E+00 | 0.00E+00 | 0.00E+00 | 0.00E+00 | 0.00E+00 | 0.00E+00 | 0.00E+00 |
| pentanone | | | | | | | | | |
| 5 [symbol] ethyl-2-phenyl-2- | 2.26E−04 | 1.01E−03 | 2.68E−04 | 6.18E−03 | 4.09E−03 | 3.86E−04 | 6.13E−04 | 3.65E−04 | 0.00E+00 |
| [symbol] enal | | | | | | | | | |
| 6-methyl-5-hepten-2-one | 7.42E−03 | 1.38E−02 | 3.97E−03 | 1.75E−02 | 7.97E−03 | 1.94E−02 | 2.44E−02 | 8.51E−03 | 0.00E+00 |
| acetoin | 0.00E+00 | 0.00E+00 | 0.00E+00 | 0.00E+00 | 0.00E+00 | 0.00E+00 | 0.00E+00 | 0.00E+00 | 0.00E+00 |
| acetophenone | 0.00E+00 | 2.80E−02 | 1.28E−02 | 1.47E−01 | 1.38E−01 | 1.13E−01 | 1.29E−02 | 0.00E+00 | 0.00E+00 |
| allyl heptanoate | 0.00E+00 | 0.00E+00 | 0.00E+00 | 0.00E+00 | 0.00E+00 | 0.00E+00 | 0.00E+00 | 0.00E+00 | 0.00E+00 |
| alpha ionone | 0.00E+00 | 0.00E+00 | 0.00E+00 | 0.00E+00 | 0.00E+00 | 0.00E+00 | 0.00E+00 | 0.00E+00 | 0.00E+00 |
| amyl alcohol | 0.00E+00 | 0.00E+00 | 0.00E+00 | 0.00E+00 | 0.00E+00 | 0.00E+00 | 0.00E+00 | 0.00E+00 | 0.00E+00 |
| amyl butyrate | 0.00E+00 | 0.00E+00 | 0.00E+00 | 0.00E+00 | 0.00E+00 | 0.00E+00 | 0.00E+00 | 0.00E+00 | 0.00E+00 |
| anisyl acetate | 0.00E+00 | 0.00E+00 | 0.00E+00 | 0.00E+00 | 0.00E+00 | 0.00E+00 | 0.00E+00 | 0.00E+00 | 0.00E+00 |
| anisyl butyrate | 0.00E+00 | 0.00E+00 | 0.00E+00 | 0.00E+00 | 0.00E+00 | 0.00E+00 | 0.00E+00 | 0.00E+00 | 0.00E+00 |
| a-pinene | 0.00E+00 | 0.00E+00 | 0.00E+00 | 0.00E+00 | 0.00E+00 | 0.00E+00 | 0.00E+00 | 0.00E+00 | 0.00E+00 |
| a-terpineol | 4.96E−02 | 6.22E−02 | 2.69E−02 | 0.00E+00 | 4.85E−02 | 9.75E−02 | 1.90E−01 | 7.07E−02 | 1.93E−03 |
| b-caryophellene | 0.00E+00 | 0.00E+00 | 0.00E+00 | 0.00E+00 | 0.00E+00 | 0.00E+00 | 0.00E+00 | 0.00E+00 | 0.00E+00 |
| benzaldehyde | ND | 6.55E−01 | 3.45E−01 | 1.79E+00 | 3.42E−01 | 4.30E−01 | 4.66E−01 | 3.26E−01 | ND |
| benzyl acetate | 1.44E−04 | 2.27E−03 | 6.18E−04 | 0.00E+00 | 2.25E−03 | 1.50E−03 | 0.00E+00 | 0.00E+00 | 0.00E+00 |
| benzyl alcohol | 0.00E+00 | 0.00E+00 | 0.00E+00 | 0.00E+00 | 0.00E+00 | 0.00E+00 | 0.00E+00 | 0.00E+00 | 0.00E+00 |
| benzyl benzoate | 0.00E+00 | 7.34E−04 | 0.00E+00 | 1.88E−03 | 3.06E−04 | 0.00E+00 | 1.17E−03 | 0.00E+00 | 0.00E+00 |
| benzyl butyrate | 0.00E+00 | 0.00E+00 | 0.00E+00 | 0.00E+00 | 0.00E+00 | 0.00E+00 | 0.00E+00 | 0.00E+00 | 0.00E+00 |
| benzyl formate | 0.00E+00 | 0.00E+00 | 0.00E+00 | 0.00E+00 | 0.00E+00 | 0.00E+00 | 0.00E+00 | 0.00E+00 | 0.00E+00 |
| benzyl propionate | 0.00E+00 | 4.43E−03 | 0.00E+00 | 0.00E+00 | 0.00E+00 | 4.46E−03 | 0.00E+00 | 0.00E+00 | 6.20E−03 |
| beta-ionone | 4.61E−04 | 3.40E−04 | 0.00E+00 | 4.95E−04 | 0.00E+00 | 6.94E−04 | 6.88E−04 | 0.00E+00 | 0.00E+00 |
| beta-pinene | 0.00E+00 | 0.00E+00 | 0.00E+00 | 0.00E+00 | 0.00E+00 | 0.00E+00 | 0.00E+00 | 0.00E+00 | 0.00E+00 |
| butyl acetate | 3.72E−03 | 7.96E−02 | 0.00E+00 | 4.71E−01 | 0.00E+00 | 0.00E+00 | 0.00E+00 | 1.27E−01 | 0.00E+00 |
| butyl alcohol | ND | 1.37E+01 | 6.98E+00 | 7.07E+01 | 1.05E+01 | 1.29E+01 | 7.62E+00 | 2.23E+00 | ND |
| butyl butyryllactate | 0.00E+00 | 0.00E+00 | 0.00E+00 | 0.00E+00 | 0.00E+00 | 0.00E+00 | 0.00E+00 | 0.00E+00 | 0.00E+00 |
| butyl formate | 0.00E+00 | 0.00E+00 | 0.00E+00 | 0.00E+00 | 0.00E+00 | 0.00E+00 | 0.00E+00 | 0.00E+00 | 0.00E+00 |
| Butyraldehyde | 0.00E+00 | 0.00E+00 | 0.00E+00 | 0.00E+00 | 0.00E+00 | 0.00E+00 | 0.00E+00 | 0.00E+00 | 0.00E+00 |
| [symbol] ric acid | 0.00E+00 | 8.00E−01 | 5.49E−01 | 5.65E−01 | 5.11E−01 | 5.48E−01 | 6.15E−01 | 1.05E+00 | 0.00E+00 |
| carvacrol | 0.00E+00 | 5.02E−04 | 1.78E−04 | 0.00E+00 | 4.76E−03 | 7.39E−04 | 1.95E−04 | 3.98E−04 | 1.81E−04 |
| carvone | 0.00E+00 | 0.00E+00 | 0.00E+00 | 0.00E+00 | 0.00E+00 | 0.00E+00 | 0.00E+00 | 0.00E+00 | 0.00E+00 |
| Cinnamaldehyde | 2.04E−02 | 4.50E−03 | 3.11E−03 | 0.00E+00 | 0.00E+00 | 2.27E−03 | 2.01E−03 | 1.53E−03 | 0.00E+00 |
| cis-3-hexenyl acetate | 0.00E+00 | 0.00E+00 | 0.00E+00 | 0.00E+00 | 0.00E+00 | 0.00E+00 | 0.00E+00 | 0.00E+00 | 0.00E+00 |
| cis-3-hexenyl butyrate | 0.00E+00 | 0.00E+00 | 0.00E+00 | 0.00E+00 | 0.00E+00 | 0.00E+00 | 0.00E+00 | 0.00E+00 | 0.00E+00 |
| cis-3-hexenyl valerate | 0.00E+00 | 0.00E+00 | 0.00E+00 | 0.00E+00 | 0.00E+00 | 0.00E+00 | 0.00E+00 | 0.00E+00 | 0.00E+00 |
| cis-5-octen-1-ol | ND | 0.00E+00 | 0.00E+00 | 1.51E+00 | 0.00E+00 | 0.00E+00 | 0.00E+00 | 0.00E+00 | ND |
| cis-6-nonen-1-ol | 0.00E+00 | 0.00E+00 | 0.00E+00 | 0.00E+00 | 0.00E+00 | 0.00E+00 | 0.00E+00 | 0.00E+00 | 0.00E+00 |
| citral | 1.92E−02 | 0.00E+00 | 0.00E+00 | 1.88E−02 | 0.00E+00 | 0.00E+00 | 0.00E+00 | 0.00E+00 | 5.63E−02 |
| citronellal | 0.00E+00 | 0.00E+00 | 0.00E+00 | 0.00E+00 | 0.00E+00 | 0.00E+00 | 0.00E+00 | 0.00E+00 | 0.00E+00 |
| citronellol | ND | 6.37E−01 | 5.28E−01 | 1.44E+00 | 6.42E−01 | 4.92E−01 | 4.21E−01 | 1.63E−01 | ND |
| cuminaldehyde | 0.00E+00 | 7.80E−04 | 5.72E−04 | 0.00E+00 | 0.00E+00 | 1.46E−03 | 8.65E−04 | 0.00E+00 | 0.00E+00 |
| damascenone | ND | 7.01E−02 | 2.67E−02 | AC | 6.02E−02 | 0.00E+00 | 7.04E−02 | 2.21E−02 | ND |
| D-camphor | 0.00E+00 | 1.61E−03 | 4.42E−04 | 1.25E−03 | 2.60E−04 | 1.15E−03 | 3.78E−04 | 2.10E−04 | 0.00E+00 |
| D-carvone | 0.00E+00 | 0.00E+00 | 0.00E+00 | 0.00E+00 | 0.00E+00 | 0.00E+00 | 0.00E+00 | 0.00E+00 | 0.00E+00 |
| decanal | 3.02E−03 | 1.79E−02 | 4.23E−03 | 8.72E−03 | 0.00E+00 | 1.17E−02 | 8.73E−03 | 0.00E+00 | 1.00E−02 |
| decanoic acid | 4.30E+00 | 2.29E+01 | 1.71E+01 | 2.72E+01 | 6.73E+00 | 1.90E+01 | 3.74E+01 | 6.95E+01 | 3.43E+00 |
| delta-decalactone | 4.51E−02 | 8.24E−02 | 4.71E−02 | 4.92E−02 | 2.70E−02 | 3.29E−02 | 1.36E−01 | 7.01E−02 | 1.08E−01 |
| delta-dodecalactone | 2.15E−02 | 3.27E−02 | 6.89E−03 | 3.52E−02 | 2.96E−02 | 2.79E−02 | 4.40E−02 | 4.98E−02 | 2.71E−02 |
| d-fenchone | 0.00E+00 | 0.00E+00 | 0.00E+00 | 0.00E+00 | 0.00E+00 | 0.00E+00 | 0.00E+00 | 0.00E+00 | 0.00E+00 |
| diethyl malate | ND | 8.16E−01 | 1.55E−01 | 2.11E+00 | 4.12E−01 | 1.55E+00 | 1.97E+00 | 1.25E+00 | ND |
| diethyl succinate | ND | 4.73E+00 | 6.31E−01 | 1.81E+00 | 1.43E+00 | 1.01E+01 | 6.38E+00 | 3.57E+00 | ND |
| DL-3-methyl-2-butanol | 0.00E+00 | 0.00E+00 | 0.00E+00 | 0.00E+00 | 0.00E+00 | 0.00E+00 | 0.00E+00 | 0.00E+00 | 0.00E+00 |
| ethyl 2-trans-4-cis- | 0.00E+00 | 0.00E+00 | 0.00E+00 | 0.00E+00 | 0.00E+00 | 0.00E+00 | 0.00E+00 | 0.00E+00 | 0.00E+00 |
| decadienoate | | | | | | | | | |
| ethyl 3-hydroxyhexanoate | 0.00E+00 | 0.00E+00 | 0.00E+00 | 0.00E+00 | 0.00E+00 | 0.00E+00 | 0.00E+00 | 0.00E+00 | 0.00E+00 |
| e [symbol] l benzoate | 8.89E−02 | 1.17E−01 | 1.50E−01 | 1.42E−01 | 1.61E−01 | 1.16E−01 | 8.61E−02 | 1.65E−01 | 9.03E−03 |
| ethyl butanoate | 1.56E+00 | 1.56E+00 | 2.79E+00 | 2.84E+00 | 2.40E+00 | 2.79E+00 | 2.39E+00 | 3.40E+00 | 2.01E+00 |
| ethyl cinnamate | 9.98E−03 | 5.31E−03 | 1.13E−03 | 9.09E−03 | 2.44E−03 | 2.29E−03 | 5.61E−03 | 3.17E−03 | 1.56E−03 |
| ethyl decanoate | 5.96E+00 | 2.36E+01 | 1.59E+01 | 2.24E+01 | 7.31E+00 | 1.77E+01 | 3.34E+01 | 3.89E+01 | 2.47E+00 |
| ethyl heptanoate | 3.48E−02 | 8.85E−02 | 3.64E−02 | 1.77E−01 | 1.33E−01 | 5.55E−02 | 3.58E−02 | 2.43E−02 | 1.26E−02 |
| ethyl hexanoate | 6.88E−01 | 1.80E+00 | 1.55E+00 | 2.38E+00 | 9.99E−01 | 1.96E+00 | 3.36E+00 | 5.13E+00 | 3.71E−01 |
| ethyl isobutyrate | 0.00E+00 | 0.00E+00 | 0.00E+00 | 0.00E+00 | 0.00E+00 | 0.00E+00 | 0.00E+00 | 0.00E+00 | 0.00E+00 |
| ethyl isovalerate | ND | 3.47E−01 | 1.51E−01 | 1.37E+00 | 2.25E−01 | 2.15E−01 | 5.04E−01 | 2.32E−01 | ND |
| ethyl lactate | ND | 4.41E+01 | 1.74E+00 | 7.43E+01 | 1.98E+01 | 1.42E+01 | 9.82E+00 | 2.95E+01 | ND |
| ethyl laurate | 1.51E+01 | 1.51E+01 | 1.19E+02 | 1.08E+02 | 5.64E+01 | 4.34E+01 | 1.19E+02 | 1.36E+02 | 1.29E+01 |
| ethyl levulinate | 3.09E−02 | 8.68E−02 | 3.25E−02 | 8.18E−02 | 5.15E−02 | 4.71E−02 | 1.56E−01 | 0.00E+00 | 2.44E−02 |
| ethyl myristate | ND | 3.00E+00 | 7.01E−01 | 1.53E+00 | 3.21E−01 | 3.83E−01 | 1.10E+00 | 1.33E+00 | ND |
| ethyl nonanoate | 1.28E−01 | 1.73E−01 | 1.52E−01 | 1.91E−01 | 1.54E−01 | 1.52E−01 | 1.96E−01 | 1.29E−01 | 6.46E−02 |
| ethyl octanoate | 4.00E+00 | 1.21E+01 | 7.80E+00 | 1.27E+01 | 4.52E+00 | 1.03E+01 | 2.08E+01 | 2.64E+01 | 1.73E+00 |
| ethyl phenyl acetate | 5.38E−02 | 7.14E−02 | 3.78E−02 | 2.87E−02 | 3.34E−02 | 5.05E−02 | 5.47E−02 | 5.32E−02 | 0.00E+00 |
| ethyl propionate | ND | 1.22E+00 | 1.36E+00 | 1.43E+00 | 1.14E+00 | 1.42E+00 | 1.49E+00 | 6.84E−01 | ND |
| ethyl salicylate | 1.11E−04 | 7.64E−04 | 1.87E−03 | 2.44E−03 | 1.59E−03 | 1.94E−03 | 1.82E−03 | 1.85E−03 | 8.71E−05 |
| ethyl trans-2-butenoate | 1.65E−02 | 1.09E−02 | 8.62E−03 | 3.56E−02 | 8.88E−03 | 3.46E−02 | 3.13E−02 | 2.85E−02 | 0.00E+00 |
| ethyl trans-3-hexenoate | 0.00E+00 | 0.00E+00 | 0.00E+00 | 0.00E+00 | 0.00E+00 | 0.00E+00 | 0.00E+00 | 0.00E+00 | 0.00E+00 |
| ethyl undecanoate | 1.47E−02 | 5.53E−02 | 5.92E−02 | 2.23E−02 | 3.88E−02 | 2.59E−02 | 2.05E−02 | 4.86E−02 | 1.43E−02 |
| Ethyl Valerate | 9.12E−03 | 7.67E−02 | 5.31E−02 | 1.15E−01 | 6.51E−02 | 4.73E−02 | 4.31E−02 | 1.36E−02 | 3.47E−02 |
| ethyl(methylthio) acetate | 0.00E+00 | 0.00E+00 | 0.00E+00 | 0.00E+00 | 0.00E+00 | 0.00E+00 | 0.00E+00 | 0.00E+00 | 0.00E+00 |
| ethyl-2-methylbutyrate | 0.00E+00 | 0.00E+00 | 0.00E+00 | 0.00E+00 | 0.00E+00 | 0.00E+00 | 0.00E+00 | 0.00E+00 | 0.00E+00 |
| eucalyptol | 0.00E+00 | 0.00E+00 | 0.00E+00 | 0.00E+00 | 0.00E+00 | 0.00E+00 | 0.00E+00 | 0.00E+00 | 0.00E+00 |
| eugenol | 3.70E−02 | 1.04E−01 | 4.02E−02 | 6.42E−02 | 9.66E−02 | 1.01E−01 | 4.03E−02 | 2.18E−03 | 1.39E−02 |
| furfural | 5.84E+00 | 1.63E+01 | 5.29E+00 | 4.32E+00 | 7.78E+00 | 7.92E+00 | 1.29E+01 | 1.05E+01 | 1.39E+00 |
| furufyl thioacetate | 0.00E+00 | 0.00E+00 | 0.00E+00 | 0.00E+00 | 0.00E+00 | 0.00E+00 | 0.00E+00 | 0.00E+00 | 0.00E+00 |
| g [symbol] ma-decalactone | 4.21E−02 | 5.12E−02 | 0.00E+00 | 1.76E−01 | 9.31E−02 | 5.07E−02 | 5.02E−02 | 1.99E−01 | 1.35E−02 |
| gamma-dodecalactone | 1.13E+00 | 7.06E+00 | 4.72E+00 | 2.48E+00 | 3.43E+00 | 1.72E+00 | 4.95E+00 | 1.67E+00 | 1.00E+00 |
| gamma-heptalactone | 0.00E+00 | 1.26E−03 | 0.00E+00 | 8.75E−03 | 0.00E+00 | 0.00E+00 | 0.00E+00 | 0.00E+00 | 0.00E+00 |
| gamma-hexalactone | 0.00E+00 | 0.00E+00 | 0.00E+00 | 0.00E+00 | 0.00E+00 | 0.00E+00 | 0.00E+00 | 0.00E+00 | 0.00E+00 |
| gamma-nonalactone | 4.32E−02 | 3.37E−01 | 8.33E−02 | 1.28E−01 | 8.83E−02 | 8.01E−02 | 1.01E−01 | 1.56E−01 | 1.34E−02 |
| gamma-octalactone | 1.72E−02 | 2.68E−02 | 3.54E−03 | 3.67E−02 | 2.72E−02 | 3.14E−02 | 4.40E−02 | 6.24E−02 | 1.10E−02 |
| gamma-terpinene | 0.00E+00 | 0.00E+00 | 0.00E+00 | 0.00E+00 | 0.00E+00 | 6.66E−04 | 0.00E+00 | 0.00E+00 | 0.00E+00 |
| gamma-undecalactone | 0.00E+00 | ND | 0.00E+00 | 0.00E+00 | 0.00E+00 | 0.00E+00 | 0.00E+00 | 0.00E+00 | 8.80E−02 |
| gamma-valerolactone | 0.00E+00 | 0.00E+00 | 0.00E+00 | 0.00E+00 | 0.00E+00 | 0.00E+00 | 0.00E+00 | 0.00E+00 | 0.00E+00 |
| geraniol | 0.00E+00 | 0.00E+00 | 0.00E+00 | 0.00E+00 | 0.00E+00 | 0.00E+00 | 0.00E+00 | 0.00E+00 | 0.00E+00 |
| guaiacol | ND | 1.70E−01 | 0.00E+00 | 3.46E+00 | 3.61E+00 | 1.39E−01 | 4.22E−02 | 5.57E−02 | ND |
| heptyl acetate | 0.00E+00 | 4.72E−03 | 2.42E−02 | 0.00E+00 | 0.00E+00 | 5.11E−03 | 0.00E+00 | 1.22E−02 | 0.00E+00 |
| Hexanoic acid | 7.37E+00 | 1.11E+01 | 8.95E+00 | 9.48E+00 | 7.89E+00 | 8.45E+00 | 9.81E+00 | 1.49E+01 | 7.31E+00 |
| hexanol | 1.52E+00 | 1.55E+00 | 1.48E+00 | 9.18E−01 | 1.27E+00 | 1.08E+00 | 1.17E+00 | 1.69E+00 | 3.05E−01 |
| hexyl 3-methylbutanoate | 0.00E+00 | 0.00E+00 | 0.00E+00 | 0.00E+00 | 0.00E+00 | 0.00E+00 | 0.00E+00 | 0.00E+00 | 0.00E+00 |
| hexyl acetate | 2.65E−02 | 7.93E−02 | 1.08E−01 | 9.59E−02 | 1.81E−02 | 3.95E−02 | 5.31E−03 | 3.92E−02 | 4.13E−02 |
| hexyl isobutyrate | 0.00E+00 | 0.00E+00 | 0.00E+00 | 0.00E+00 | 0.00E+00 | 0.00E+00 | 0.00E+00 | 0.00E+00 | 0.00E+00 |
| IBMP (3-Isobutyl-2- | 0.00E+00 | 0.00E+00 | 0.00E+00 | 0.00E+00 | 0.00E+00 | 0.00E+00 | 0.00E+00 | 0.00E+00 | 0.00E+00 |
| methoxypyrazine) | | | | | | | | | |
| indole | 0.00E+00 | 1.41E−04 | 0.00E+00 | 0.00E+00 | 0.00E+00 | 0.00E+00 | 7.82E−05 | 0.00E+00 | 0.00E+00 |
| isoamyl acetate | 2.33E+00 | 4.27E+00 | 8.84E+00 | 8.61E+00 | 3.25E+00 | 2.57E+00 | 2.30E+00 | 2.27E+00 | 1.91E+00 |
| isoamyl alcohol | 1.77E+03 | 1.68E+03 | 2.14E+03 | 1.76E+03 | 2.20E+03 | 1.88E+03 | 1.89E+03 | 9.15E+02 | 7.57E+01 |
| isoamyl cinnamate | 0.00E+00 | 0.00E+00 | 1.37E−03 | 1.24E−03 | 0.00E+00 | 1.54E−03 | 1.04E−03 | 2.29E−03 | 0.00E+00 |
| isoamyl hexanoate | 2.11E−02 | 1.69E−02 | 0.00E+00 | 3.39E−02 | 1.68E−02 | 8.38E−03 | 1.57E−02 | 4.72E−02 | 3.22E−03 |
| isoamyl isovalerate | 0.00E+00 | 6.43E−04 | 9.96E−04 | 0.00E+00 | 5.29E−04 | 0.00E+00 | 0.00E+00 | 0.00E+00 | 0.00E+00 |
| isoamyl octanoate | ND | 5.13E−01 | 3.58E−01 | 1.45E+00 | 3.57E−01 | 3.59E−01 | 4.08E−01 | 6.40E−01 | ND |
| isoamyl phenylacetate | 0.00E+00 | 3.35E−04 | 1.11E−03 | 1.37E−03 | 5.95E−04 | 9.99E−04 | 4.69E−04 | 1.03E−03 | 0.00E+00 |
| i [symbol] utanol | 7.26E+02 | 7.17E+02 | 7.26E+02 | 6.52E+02 | 7.99E+02 | 7.11E+02 | 6.85E+02 | 2.97E+02 | 3.43E+02 |
| isobutyl acetate | ND | 5.08E−01 | 4.64E−01 | 1.45E+00 | 2.99E−01 | 4.35E−01 | 2.86E−01 | 2.59E−01 | ND |
| isobutyl isobutyrate | 0.00E+00 | 0.00E+00 | 0.00E+00 | 0.00E+00 | 0.00E+00 | 0.00E+00 | 0.00E+00 | 0.00E+00 | 0.00E+00 |
| isobutyl propionate | 0.00E+00 | 1.64E−02 | 0.00E+00 | 0.00E+00 | 1.96E−02 | 0.00E+00 | 0.00E+00 | 0.00E+00 | 0.00E+00 |
| isobutyraldehyde | ND | 7.85E−01 | 2.86E−01 | 1.37E+00 | 1.76E−01 | 7.95E−01 | 2.21E+00 | 4.65E−02 | ND |
| Isobutyric Acid | 1.64E+00 | 3.93E+00 | 3.32E+00 | 2.59E+00 | 2.96E+00 | 2.30E+00 | 2.47E+00 | 2.96E+00 | 1.18E+00 |
| isoeugenol | 1.17E−02 | 1.95E−02 | 0.00E+00 | 2.46E−02 | ND | 3.27E−02 | 3.02E−02 | 1.28E−02 | 1.10E−02 |
| Isovaleraldehyde | 0.00E+00 | 0.00E+00 | 0.00E+00 | 0.00E+00 | 0.00E+00 | 0.00E+00 | 0.00E+00 | 0.00E+00 | 0.00E+00 |
| Isovaleric acid | 0.00E+00 | 1.83E+00 | 1.42E+00 | 1.05E+00 | 1.52E+00 | 8.40E−01 | 1.34E+00 | 1.93E+00 | 0.00E+00 |
| limonene | 3.11E−03 | 5.04E−03 | 5.00E−03 | 3.99E−03 | 3.66E−03 | 3.57E−03 | 5.13E−03 | 5.16E−03 | 1.48E−03 |
| linalool | ND | 7.73E−02 | 4.58E−02 | 1.62E+00 | 8.57E−02 | 2.04E−01 | 7.42E−02 | 0.00E+00 | ND |
| linalyl acetate | 0.00E+00 | 0.00E+00 | 0.00E+00 | 0.00E+00 | 0.00E+00 | 0.00E+00 | 0.00E+00 | 7.48E−04 | 0.00E+00 |
| L-menthyl acetate | 0.00E+00 | 0.00E+00 | 0.00E+00 | 0.00E+00 | 0.00E+00 | 0.00E+00 | 0.00E+00 | 0.00E+00 | 0.00E+00 |
| Maltol | 0.00E+00 | 0.00E+00 | 0.00E+00 | 0.00E+00 | 0.00E+00 | 0.00E+00 | 0.00E+00 | 0.00E+00 | 0.00E+00 |
| massoia lactone | 1.84E−03 | 1.23E−03 | 9.32E−04 | 2.01E−03 | 0.00E+00 | 5.88E−06 | 2.88E−03 | 4.20E−04 | 0.00E+00 |
| methionyl acetate (3- | 0.00E+00 | 0.00E+00 | 0.00E+00 | 0.00E+00 | 0.00E+00 | 0.00E+00 | 0.00E+00 | 0.00E+00 | 0.00E+00 |
| methylthio-propylacetate) | | | | | | | | | |
| methyl acetate | 0.00E+00 | 0.00E+00 | 0.00E+00 | 0.00E+00 | 0.00E+00 | 0.00E+00 | 0.00E+00 | 0.00E+00 | 0.00E+00 |
| Methyl anthranilate | 0.00E+00 | 0.00E+00 | 0.00E+00 | 0.00E+00 | 0.00E+00 | 0.00E+00 | 0.00E+00 | 0.00E+00 | 0.00E+00 |
| methyl benzoate | 4.47E−04 | 5.80E−04 | 1.96E−04 | 1.48E−02 | 1.05E−02 | 6.55E−04 | 7.95E−04 | 5.78E−04 | 0.00E+00 |
| methyl beta-naphthyl | 0.00E+00 | 2.78E−03 | 0.00E+00 | 3.00E−03 | 2.24E−03 | 3.24E−03 | 0.00E+00 | 0.00E+00 | 9.17E−03 |
| ketone | | | | | | | | | |
| methyl cinnamate | 0.00E+00 | 1.24E−04 | 5.59E−05 | 4.04E−04 | 2.53E−04 | 1.15E−04 | 8.72E−05 | 0.00E+00 | 0.00E+00 |
| Methyl cyclopentenolone | 0.00E+00 | 0.00E+00 | 0.00E+00 | 0.00E+00 | 0.00E+00 | 0.00E+00 | 0.00E+00 | 0.00E+00 | 0.00E+00 |
| methyl decanoate | 2.02E−03 | 4.92E−03 | 5.69E−03 | 6.97E−03 | 2.03E−03 | 5.53E−03 | 9.36E−03 | 1.43E−02 | 8.77E−04 |
| methyl hexanoate | 6.34E−04 | 9.73E−04 | 7.10E−04 | 3.87E−04 | 0.00E+00 | 6.83E−04 | 6.37E−04 | 1.08E−03 | 6.58E−04 |
| methyl laurate | 6.64E−04 | 3.52E−03 | 4.47E−03 | 5.98E−03 | 1.15E−03 | 2.03E−03 | 8.10E−03 | 2.16E−03 | 2.26E−05 |
| Methyl Octanoate | 1.30E−03 | 2.26E−03 | 1.83E−03 | 2.37E−03 | 1.69E−04 | 3.21E−03 | 4.36E−03 | 3.40E−03 | 0.00E+00 |
| [symbol] hyl salicylate | 0.00E+00 | 7.46E−03 | 3.91E−04 | 9.82E−04 | 3.55E−03 | 1.28E−02 | 0.00E+00 | 0.00E+00 | 1.04E−03 |
| methyl-2-pyrrolyl ketone | 0.00E+00 | 8.85E−03 | 0.00E+00 | 3.43E−02 | 2.55E−02 | 1.14E−02 | 1.06E−02 | 0.00E+00 | 0.00E+00 |
| Myrcene | 0.00E+00 | 0.00E+00 | 0.00E+00 | 0.00E+00 | 0.00E+00 | 0.00E+00 | 0.00E+00 | 0.00E+00 | 0.00E+00 |
| nerolidol | 1.17E−03 | 0.00E+00 | 1.22E−03 | 1.28E−02 | 5.26E−03 | 2.62E−03 | 0.00E+00 | 0.00E+00 | 0.00E+00 |
| nonanal | 1.01E−02 | 1.21E−02 | 3.70E−02 | 6.50E−03 | 0.00E+00 | 1.76E−02 | 6.07E−03 | 3.24E−02 | 0.00E+00 |
| Nonanoic acid | 0.00E+00 | 0.00E+00 | 0.00E+00 | 0.00E+00 | 0.00E+00 | 0.00E+00 | 0.00E+00 | 0.00E+00 | 0.00E+00 |
| octanal | 2.57E−03 | 4.71E−03 | 1.15E−02 | 4.86E−03 | 2.34E−03 | 3.39E−03 | 0.00E+00 | 1.12E−02 | 0.00E+00 |
| octanoic acid | 5.03E+00 | 1.89E+01 | 1.27E+01 | 2.02E+01 | 8.09E+00 | 1.57E+01 | 2.11E+01 | 5.70E+01 | 4.93E+00 |
| omega-pentadecalactone | ND | 0.00E+00 | 0.00E+00 | 1.65E+00 | 0.00E+00 | 0.00E+00 | 0.00E+00 | 0.00E+00 | ND |
| p,a-dimethylstyrene | 5.43E−04 | 2.00E−04 | 1.98E−04 | 0.00E+00 | 0.00E+00 | 7.06E−04 | 1.83E−04 | 1.45E−04 | 0.00E+00 |
| p-anisaldehyde | 0.00E+00 | 0.00E+00 | 0.00E+00 | 0.00E+00 | 0.00E+00 | 0.00E+00 | 0.00E+00 | 0.00E+00 | 0.00E+00 |
| p-cresol | ND | 8.32E+00 | 4.81E−01 | AC | AC | 2.47E+00 | 6.85E−01 | 3.21E+00 | ND |
| p-cymene | 0.00E+00 | 0.00E+00 | 0.00E+00 | 0.00E+00 | 0.00E+00 | 0.00E+00 | 0.00E+00 | 0.00E+00 | 0.00E+00 |
| Perillaldehyde | 0.00E+00 | 0.00E+00 | 0.00E+00 | 0.00E+00 | 0.00E+00 | 0.00E+00 | 0.00E+00 | 0.00E+00 | 0.00E+00 |
| phenethyl 2-methylbutyrate | 0.00E+00 | 0.00E+00 | 0.00E+00 | 8.46E−04 | 0.00E+00 | 0.00E+00 | 0.00E+00 | 0.00E+00 | 0.00E+00 |
| Phenethyl Butyrate | 1.50E−03 | 3.40E−03 | 4.43E−03 | 7.80E−03 | 1.93E−03 | 3.41E−03 | 2.35E−03 | 3.01E−03 | 6.08E−04 |
| phenethyl formate | 0.00E+00 | 0.00E+00 | 0.00E+00 | 0.00E+00 | 0.00E+00 | 0.00E+00 | 0.00E+00 | 0.00E+00 | 0.00E+00 |
| phenethyl octanoate | 1.16E−01 | 1.50E−01 | 1.28E−01 | 8.85E−02 | 1.42E−01 | 1.82E−01 | 2.06E−01 | 8.21E−02 | 2.62E−02 |
| phenethyl propionate | 0.00E+00 | 3.73E−02 | 9.77E−03 | 0.00E+00 | 0.00E+00 | 0.00E+00 | 0.00E+00 | 0.00E+00 | 1.42E−02 |
| phenethyl tiglate | 2.88E−03 | 1.60E−03 | 3.78E−03 | 4.19E−03 | 2.04E−03 | 4.72E−03 | 3.50E−03 | 0.00E+00 | 0.00E+00 |
| phenylacetaldehyde | 0.00E+00 | 1.61E−01 | 6.34E−02 | 1.55E−01 | 7.76E−02 | 1.42E−01 | 1.37E−01 | 1.02E−01 | 1.64E−03 |
| phenylacetaldehyde | 0.00E+00 | 0.00E+00 | 0.00E+00 | 0.00E+00 | 0.00E+00 | 0.00E+00 | 0.00E+00 | 0.00E+00 | 0.00E+00 |
| dimethyl acetal | | | | | | | | | |
| propanol | 1.32E+03 | 1.32E+03 | 1.85E+03 | 1.31E+03 | 1.45E+03 | 1.30E+03 | 8.24E+02 | 1.20E+03 | 1.55E+03 |
| Propionaldehyde | 0.00E+00 | 0.00E+00 | 0.00E+00 | 0.00E+00 | 0.00E+00 | 0.00E+00 | 0.00E+00 | 0.00E+00 | 0.00E+00 |
| Propionic acid | 7.76E−01 | 9.47E−01 | 1.25E+00 | 1.42E+00 | 1.43E+00 | 1.06E+00 | 1.53E+00 | 2.10E+00 | 9.09E−01 |
| propyl acetate | 0.00E+00 | 0.00E+00 | 0.00E+00 | 0.00E+00 | 0.00E+00 | 0.00E+00 | 0.00E+00 | 0.00E+00 | 0.00E+00 |
| [symbol] yl butyrate | 0.00E+00 | 0.00E+00 | 0.00E+00 | 0.00E+00 | 0.00E+00 | 0.00E+00 | 0.00E+00 | 0.00E+00 | 0.00E+00 |
| propyl isovalerate | 0.00E+00 | 0.00E+00 | 0.00E+00 | 1.59E−03 | 8.97E−04 | 1.30E−03 | 2.09E−03 | 2.05E−03 | 0.00E+00 |
| salicylaldehyde | 2.25E−03 | 5.47E−03 | 4.57E−03 | 1.83E−02 | 1.73E−02 | 8.62E−03 | 7.89E−03 | 4.72E−03 | 2.31E−03 |
| tetrahydrolinalool | 0.00E+00 | 0.00E+00 | 0.00E+00 | 0.00E+00 | 0.00E+00 | 0.00E+00 | 0.00E+00 | 0.00E+00 | 0.00E+00 |
| thymol | 0.00E+00 | 6.71E−04 | 1.27E−04 | 0.00E+00 | 3.57E−03 | 8.23E−04 | 3.24E−04 | 5.75E−04 | 3.60E−04 |
| trans-2-hexen-1-al | 0.00E+00 | 0.00E+00 | 0.00E+00 | 0.00E+00 | 0.00E+00 | 0.00E+00 | 0.00E+00 | 0.00E+00 | 0.00E+00 |
| valencene | 2.69E−05 | 5.46E−04 | 1.07E−03 | 2.67E−03 | 1.50E−03 | 1.87E−03 | 5.38E−03 | 6.45E−04 | 0.00E+00 |
| Valeraldehyde | 0.00E+00 | 0.00E+00 | 0.00E+00 | 0.00E+00 | 0.00E+00 | 0.00E+00 | 0.00E+00 | 0.00E+00 | 0.00E+00 |
| Valeric acid | 0.00E+00 | 0.00E+00 | 0.00E+00 | 0.00E+00 | 0.00E+00 | 0.00E+00 | 0.00E+00 | 0.00E+00 | 0.00E+00 |
| vanillyl butyl ether | 0.00E+00 | 0.00E+00 | 0.00E+00 | 0.00E+00 | 0.00E+00 | 0.00E+00 | 0.00E+00 | 0.00E+00 | 0.00E+00 |
| vanillyl ethyl ether | 3.45E−03 | 3.06E−02 | 2.28E−02 | 5.11E−02 | 7.60E−02 | 3.22E−02 | 0.00E+00 | 0.00E+00 | 0.00E+00 |
| whiskey lactone | ND | 5.09E−01 | 1.86E−01 | 1.42E+00 | 2.74E−01 | 4.87E−01 | 5.69E−01 | 4.95E−02 | ND |

AC = above the standard curve
ND = not done [symbol]
indicates data missing or illegible when filed

LC-MS was used to measure the levels of various non-volatile compounds in several reference Scotch samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:

Polarity: positive or negative mode, as indicated for each method

Resolution: 70,000

Scan range: 60-900 m/z for all methods with the exception of the lipid method, which is 134-2000 m/z

Isolation window: 1.5 m/z

MS/MS collision energy: 30

Preparation of analytical standards: Stock solutions at a concentration of 1 mg/mL were made for each compound in 50% methanol. Serial dilutions were then made of each compound to create a 7-point standard curve, ranging from 10 ng/mL to 20 μg/mL. Standard curves were run in combinations of 7-12 compounds from each category per set, so long as there were no overlaps in retention time, which would have hindered quantitation.

Retention times were pre-determined for each compound by running the analytical standard at a 20 μg/mL dilution, and identifying the compound based on its accurate mass.

In all cases, five μL of each standard mix was injected through the autosampler and LC to the MS. Separation took place on a chromatographic column that was specific to each class of compounds. The conditions for each chromatographic method are described below, including the column, mobile phase and gradient used for each method.

Several types of columns were used for the different classes of compounds, as indicated in TABLE 5.

TABLE 5
List of compounds quantified by each method and LODs

| Compound | Method | LOD | |
|---|---|---|---|
| 2,3,5,6-Tetramethylpyrazine | C18 Positive | <1 | ppd |
| 2,3,5-trimethylpyrazine | C18 Positive | <1 | ppd |
| 2,3-dimethylpyrazine | C18 Positive | <1 | ppd |
| 2-Furoic Acid | Omega Negative | l0 | ng |
| 2-Isopropylmalic Acid | Omega Negative | 100 | pg |
| 3,4-dihydroxybenzoic acid | Omega Negative | 100 | pg |
| 4-guanidinobutyric acid | C18 Positive | 100 | ppt |
| Acetovanillone | C18 Positive | 1 | ng |
| Acetylcholine | C18 Positive | 1 | ng |
| Adenine | C18 Positive | 200 | pg |
| Adipic_Acid | C18 Negative | 200 | pg |
| Alanine | HILIC Positive | 10 | ng |
| AMP | C18 Positive | 10 | ppd |
| Arabitol | HILIC Negative | 2 | ng |
| Arginine | HILIC Positive | 10 | ng |
| Asparagine | HILIC Positive | 10 | ng |
| Aspartic Acid | HILIC Positive | 5 | ug |
| Beta-Alanine | HILIC Negative | 100 | ppd |
| Betaine | HILIC Positive | <10 | ppd |
| Caffeic Acid | C18 Positive | 20 | ng |
| Camphoric Acid | C18 Positive | not detected well | |
| Carnitine | HILIC Positive | 500 | pg |
| Carnosine | HILIC Positive | <10 | ppd |
| Catechin | C18 Negative | 1 | ng |
| Choline | HILIC Positive | 2 | ng |
| Cinnamic Acid | C18 Positive | 500 | ng |
| Citric Acid | Omega Negative | 10 | ng |
| Citrulline | C18 Positive or | 100 ppd or 200 pg | |
| | HILIC Negative | | |
| CMP | C18 Positive | <10 | ppd |
| Coumaric Acid | C18 Positive | 4 | ng |
| Cysteine | HILIC Positive | 1 | ug |
| Cystine | HILIC Positive | <100 | ppd |
| Cytidine | C18 Positive | 5 | ppd |
| Cytosine | C18 Positive | 100 | ppt |
| D-Glucuronic Acid | C18 Negative | 100 | pg |
| Ellagic Acid | C18 Negative | 1 | ng |
| Epicatechin | C18 Negative | 1 | ng |
| Epicatechin Gallate | C18 Positive | 2 | ng |
| Fructose | HILIC Negative | 2 | ng |
| Fucose | HILIC Negative | 100 | ng |
| Fumaric Acid | Omega Negative | 500 | pg |
| γ-Aminobutyric Acid | HILIC Positive | 2 | ng |
| Galactose | HILIC Negative | 10 | ng |
| Galacturonic Acid | Omega Negative | 100 | pg |
| Gallic Acid | Omega Negative | 500 | pg |
| Glucosamine | HILIC Positive | 50 | ng |
| Glucose | HILIC Negative | 100 | ng |
| Glucuronic Acid | Omega Negative | 500 | ppt |
| Glutamic Acid | HILIC Positive | 10 | ng |
| Glutamine | HILIC Positive | 10 | ng |
| Glycine | HILIC Positive | 50 | ppd |
| Guanine | C18 Positive | 200 | pg |
| Hesperetin | C18 Negative | 200 | pg |
| Histidine | HILIC Positive | 10 | ng |
| Inositol | HILIC Negative | 10 | ng |
| Isoleucine | HILIC Positive | 10 | ng |
| Kynurenic Acid | C18 Positive | 200 | pg |
| Lactic Acid | Omega Negative | 2 | ng |
| Lauric Acid | C18 Positive | 200 | pg |
| Leucine | HILIC Positive | 500 | pg |
| Lysine | HILIC Positive | 10 | ng |
| Malic Acid | Omega Negative | 100 | pg |
| Mannitol | HILIC Negative | 2 | ng |
| Mannose | HILIC Negative | 10 | ng |
| Methionine | HILIC Positive | 500 | pg |
| Methyl Gallate | C18 Negative | 200 | pg |
| Methyl 2-pyrrolyl ketone | C18 Positive | <1 | ppd |
| Inositol (e.g., myo-inositol) | HILIC Negative | 50 | ppd |
| Ornithine | HILIC Positive | 10 | ng |
| Palmitic Acid | C18 Positive | 200 | pg |
| Pantothenic Acid | C18 Positive | 0.2 | ng |
| Phenylalanine | HILIC Positive | 500 | pg |
| Pipecolinic acid | HILIC Positive | <10 | ppd |
| Piperine | C18 Positive | <1 | ppd |
| Polydatin | C18 Positive | 4 | ng |
| Proline | HILIC Positive | 2 | ng |
| Propyl Gallate | C18 Negative | 200 | pg |
| Pyridine | C18 Positive | <1 | ppd |
| Pyridoxine | HILIC Positive | 100 | pg |
| Pyruvic Acid | Omega Negative | 100 | pg |
| Quercetin | C18 Negative | 1 | ng |
| Quinic Acid | C18 Positive | 1 | ng |
| Resveratrol | C18 Negative | 4 | ng |
| Rhamnose | HILIC Negative | 10 | ng |
| Ribose | HILIC Negative | 10 | ng |
| Rutin | C18 Negative | 1 | ng |
| Salicylic Acid | C18 Negative | 200 | pg |
| Serine | HILIC Positive | 2 | ng |
| Sinapinic Acid | C18 Negative | 200 | pg |
| Sorbic Acid | C18 Positive | 100 | ng |
| Sorbitol | HILIC Negative | 2 | ng |
| Succinic Acid | Omega Negative | 500 | pg |
| Syringaldehyde | C18 Positive | 1 | ng |
| Syringic Acid | C18 Positive | 50 | ng |
| Tartaric Acid | Omega Negative | 100 | pg |
| Threonine | HILIC Positive | 10 | ng |
| Trans-4-hydroxy proline | C18 Positive | 200 | pg |
| Trans-Ferulic Acid | C18 Negative | 1 | ng |
| Tryptamine | C18 Positive | 200 | pg |
| Tryptophan | HILIC Positive | 2 | ng |
| Tyramine | C18 Positive | 1 | ng |
| Tyrosine | HILIC Positive | 2 | ng |
| Uracil | C18 Positive | 5 | ppd |
| Valine | HILIC Positive | 100 | ng |
| Vanillic Acid | C18 Positive | 100 | ng |
| Vanillin | C18 Positive | 200 | pg |
| Xylose | HILIC Negative | 100 | ng |

Quantitation of Amino Acids and Similar Polar Compounds: A HILIC (hydrophilic interaction liquid chromatography) column was used to assess polar compounds that can retain a positive charge. The mobile phase used with this column included A: H₂O+5 mM Ammonium Acetate+0.1% TFA (trifluoroacetic acid), and B: 90/10 ACN (Acetonitrile)/H₂O+5 mM Ammonium Acetate+0.1% TFA. Each chromatographic run was 27.5 minutes long, and the column temperature was maintained at 40° C. The column used was a Phenomenex Luna, 3 μm NH2, 100 Å, 150×2 mm (Product #00F-4377-B0), and the guard column was a Phenomenex Security Guard Cartridges, NH2, 4×2 mm (#PRD-196870).

TABLE 6
HILIC positive mode gradient conditions

| Time | Flow Rate (mL/min) | % A | % B |
|---|---|---|---|
| 0 | 0.5 | 5 | 95 |
| 6 | 0.5 | 5 | 95 |
| 18 | 0.5 | 60 | 40 |
| 20 | 0.5 | 80 | 20 |
| 22 | 0.5 | 5 | 95 |
| 27 | 0.5 | 5 | 95 |

Quantitation of Sugars and Sugar Alcohols: The same HILIC column used for quantitation of the amino acids was used for quantitation of sugars, but the polarity of the MS was run in negative mode. While the same mobile phases were used, the gradient was slightly modified to help with retention. The temperature of the column also was held at 50° C. for better peak shape and separation of the isobaric sugars.

TABLE 7
HILIC negative mode gradient conditions

| Time | Flow Rate (mL/min) | % A | % B |
|---|---|---|---|
| 0 | 0.5 | 0 | 100 |
| 3 | 0.5 | 0 | 100 |
| 18 | 0.5 | 18 | 82 |
| 19 | 0.5 | 26 | 74 |
| 20 | 0.5 | 60 | 40 |
| 21 | 0.4 | 80 | 20 |
| 23 | 0.4 | 0 | 100 |
| 28 | 0.4 | 0 | 100 |

Quantitation of Non-Polar Compounds: A C18 column was used to assess non-polar compounds, as they are retained in the long carbon chains under polar conditions. This method was run in both positive and negative modes, depending on each compound and whether it ionizes better with a positive or negative charge, respectively. The mobile phases used for this method were A: H₂O+0.1% FA, and B: Methanol, and the temperature of the column was held at 50° C. The column used was an Agilent Poroshell 120, EC-C18 2.7 μm, 3.0×100 mm (Product #695975-302).

TABLE 8
C18 positive/negative mode gradient conditions

| Time | Flow Rate (mL/min) | % A | % B |
|---|---|---|---|
| 0 | 0.6 | 100 | 0 |
| 1.5 | 0.6 | 100 | 0 |
| 4 | 0.6 | 0 | 100 |
| 6 | 0.6 | 0 | 100 |
| 6.1 | 0.6 | 100 | 0 |
| 9 | 0.6 | 100 | 0 |

Quantitation of Organic Acids and Similarly Charged Polar Compounds: To look at organic acids, a charged C18 column was used. The gradient used for the organic method was the same as for the C18 non-polar methods, as shown in TABLE 8. There was a modification to mobile phase B for this method, in that B: ACN+0.1% FA. The column used was a Phenomenex Luna Omega, 1.6 μm, PS C18 100 Å, 100×2.1 mm (Product #00D-4752-AN).

Quantitation of Lipids: As lipids are very hydrophobic, they require stronger organic solvents in order to elute from any chromatographic column. The C18 column discussed above (Agilent Poroshell) was used to quantitate lipids, but the mobile phases that were used had a higher concentration of organic solvents. Samples were run in both positive and negative ionization modes, but the positive mode was used for quantitation of the two lipid standards. Mobile phase A: 60/40 H₂O/ACN+5 mM Ammonium Acetate+0.1% FA, and B: 90/10 IPA/ACN+5 mM Ammonium Acetate+0.1% FA. The column temperature was held at 50° C.

TABLE 9
C18 Lipid positive/negative mode gradient conditions

| Time | Flow Rate (mL/min) | % A | % B |
|---|---|---|---|
| 0 | 0.6 | 80 | 20 |
| 1.5 | 0.6 | 80 | 20 |
| 4 | 0.6 | 45 | 55 |
| 10 | 0.6 | 20 | 80 |
| 11.5 | 0.6 | 0 | 100 |
| 15 | 0.6 | 0 | 100 |
| 15.5 | 0.6 | 80 | 20 |
| 17.5 | 0.6 | 80 | 20 |

Data analysis: Data analysis methods were developed with the XCalibur Processing Setup program, where methods were made for each standard cassette for each LC method. The compound mass and retention time was added for each standard, and calibration levels were applied for each standard. To calculate concentrations in samples, the samples and standards for each run were processed together using XCalibur Quan software, and concentrations calculated based on the respective compound calibration curve. Limits of detection were determined for each standard by running each standard curve at low levels until nothing was detected.

The average levels of the non-volatile compounds measured in reference Scotches samples are shown in TABLE 10 and TABLE 11.

TABLE 10
LC-MS of reference Scotches

| Average values in mg/L | Ardbeg | Lagavulin | Laphroaig | Macallan |
|---|---|---|---|---|
| 2,3,5,6-tetramethylpyrazine | ND | ND | ND | ND |
| 2,3,5-trimethylpyrazine | ND | ND | ND | ND |
| 2,3-dimethylpyrazine | 2.21E−01 | 1.75E−01 | 1.44E−01 | ND |
| 2-furoic acid | NF | NF | NF | NF |
| 2-isopropylmalic acid | 1.52E+00 | 7.02E−02 | 5.52E−02 | 1.64E+00 |
| 3,4-dihydroxybenzoic acid | 6.95E−01 | 2.11E−01 | 2.23E−01 | 6.41E−01 |
| acetovanillone | 1.01E−01 | 2.56E−02 | 5.26E−02 | 1.29E−01 |
| adenine | 7.31E−02 | ND | ND | 1.57E−02 |
| arabitol | 1.43E+00 | 2.00E−01 | 1.96E−01 | 1.66E+00 |
| arginine | 1.59E−01 | 8.40E−02 | 8.15E−02 | 9.56E−02 |
| asparagine | 4.17E−02 | NF | NF | NF |
| aspartic acid | 2.97E−01 | 2.17E−02 | 2.17E−02 | 6.35E−02 |
| b-alanine | 2.28E−01 | NF | NF | 1.41E−01 |
| caffeic acid | 1.41E+00 | 1.63E+00 | 1.30E+00 | 1.74E+00 |
| camphoric acid | BC | BC | BC | BC |
| carnitine | 3.18E−02 | ND | ND | 1.35E−02 |
| choline | 1.27E+00 | 3.03E−01 | 2.45E−01 | 1.15E+00 |
| cinnamic acid | NF | NF | NF | NF |
| citric acid | 2.66E+00 | 1.42E−01 | 1.42E−01 | 2.98E+00 |
| citrulline | 1.20E−02 | 8.57E−03 | 1.11E−02 | 8.05E−03 |
| coumaric acid | 1.41E+00 | 7.02E−01 | 1.13E+00 | 1.63E+00 |
| cysteine | NF | NF | NF | NF |
| D-glucuronic acid | 9.87E+00 | 3.89E−01 | 2.65E−01 | 9.64E+00 |
| epicatechin gallate | NF | NF | NF | NF |
| fructose | 6.85E+01 | 3.22E+01 | 2.12E+01 | 3.14E+01 |
| fucose | 3.24E+01 | 2.02E+01 | 2.68E+01 | 5.33E+01 |
| fumaric acid | 2.92E−01 | 1.57E−01 | 1.54E−01 | 2.48E−01 |
| GABA | 1.37E+00 | 4.13E−02 | 2.43E−02 | 1.06E+00 |
| galactose | 1.19E+01 | 1.12E+01 | 1.08E+01 | 7.64E+00 |
| gallic acid | 5.64E+00 | 1.76E+00 | 2.62E+00 | 2.17E+01 |
| glucosamine | 2.58E−01 | NF | 2.70E−02 | 1.70E−01 |
| glucose | 5.40E+01 | 2.67E+01 | 2.33E+01 | 5.00E+01 |
| glutamic acid | 1.17E−01 | 1.88E−02 | NF | 6.68E−02 |
| glutamine | 2.15E−02 | NF | NF | NF |
| guanine | 2.21E−01 | 2.01E−04* | ND | 8.16E−02 |
| histidine | 7.84E−02 | NF | NF | NF |
| isoleucine | NF | NF | NF | NF |
| kynurenic acid | 7.46E−02 | 8.14E−03 | 8.06E−03 | 5.48E−02 |
| lactic acid | 1.65E+01 | 4.75E+00 | 3.91E+00 | 1.53E+01 |
| leucine | NF | NF | NF | NF |
| lysine | 1.21E−01 | NF | NF | 1.12E−01 |
| malic acid | 7.78E+00 | 6.68E−01 | 9.90E−01 | 7.50E+00 |
| mannitol | 1.91E+00 | 1.16E−01 | 1.53E−01 | 3.00E+00 |
| mannose | NF | NF | NF | NF |
| methionine | 3.46E−02 | 3.55E−02 | 3.44E−02 | NF |
| Methyl 2-pyrrolyl ketone | NF | NF | NF | NF |
| inositol | 8.21E+00 | 1.23E+00 | 2.36E+00 | 1.07E+01 |
| ornithine | NF | NF | NF | NF |
| pantothenic acid | NF | NF | NF | NF |
| phenylalanine | 1.77E−01 | 4.72E−02 | 4.72E−02 | NF |
| piperine | NF | NF | NF | NF |
| polydatin | NF | NF | NF | NF |
| proline | 1.36E+01 | 4.35E−01 | 2.14E−01 | 6.32E+00 |
| pyridine | 1.76E+00 | 1.86E+00 | 2.94E+00 | ND |
| pyridoxine | 3.51E−03 | ND | 1.12E−03* | ND |
| pyruvic acid | 3.36E−01 | 1.98E+00 | 4.01E−01 | 3.97E−01 |
| quinic acid | 9.52E−01 | 1.36E+00 | 1.25E+00 | 1.54E+00 |
| rhamnose | 1.39E+01 | 7.78E+00 | 1.08E+01 | 2.23E+01 |
| ribose | 2.90E+01 | 1.33E+01 | 1.92E+01 | 4.60E+01 |
| serine | 1.19E−01 | 3.43E−02 | 3.43E−02 | 6.14E−02 |
| sorbic acid | NF | NF | NF | NF |
| sorbitol | 2.32E+00 | 4.12E−01 | 3.95E−01 | 1.68E+00 |
| succinic acid | 7.80E+00 | 3.74E−01 | 4.44E−01 | 4.79E+00 |
| syringaldehyde | 4.78E+00 | 1.17E+00 | 2.82E+00 | 5.99E+00 |
| syringic acid | 2.29E−02 | 1.46E+00 | 1.45E+00 | 2.56E+00 |
| tartaric acid | 1.95E+02 | 3.70E+00 | 5.53E−01 | 2.54E+02 |
| threonine | NF | NF | NF | NF |
| Trans-4-hydroxy-L-proline | 4.92E−01 | 1.48E−02 | 3.29E−02 | 3.76E−01 |
| trans-ferulic acid | ND | ND | ND | ND |
| tryptamine | NF | NF | NF | NF |
| tryptophan | NF | NF | NF | NF |
| tyramine | 2.22E−03* | NF | NF | 3.84E−03* |
| tyrosine | ND | NF | NF | NF |
| valine | NF | NF | NF | NF |
| vanillic acid | 4.44E+01 | 2.11E+01 | 4.09E+01 | 5.31E+01 |
| vanillin | 2.43E+00 | 7.37E−01 | 1.85E+00 | 3.36E+00 |
| xylose | NF | NF | NF | NF |

Values are the average of measurements for three samples of each whiskey type, excepted where noted by an asterisk(*).
NF = not present or below the limit of detection
ND = not determined
BC = bad curve

TABLE 11
LC-MS of reference Scotches

| Average values in mg/L) | W1 | W2 | W3 | W4 | W5 | W6 | W7 | W8 | W9 |
|---|---|---|---|---|---|---|---|---|---|
| 2,3,5,6-tetramethylpyrazine | BBSC | BBSC | BBSC | BBSC | BBSC | BBSC | BBSC | BBSC | BBSC |
| 2,3,5-trimethylpyrazine | BBSC | BBSC | BBSC | 1.14E−02 | 1.51E−02 | BBSC | BBSC | BBSC | BBSC |
| 2,3-dimethylpyrazine | NF | BBSC | BBSC | 1.24E−01 | 1.36E−01 | NF | NF | BBSC | NF |
| 2-furoic acid | 1.71E+01 | 1.73E+01 | 9.61E+00 | 9.01E+00 | 7.85E+00 | 1.98E+01 | 3.18E+01 | 1.27E+01 | 5.33E+00 |
| 2-isopropylmalic acid | 1.56E−01 | 2.89E−01 | 3.84E−01 | 3.36E−01 | BBSC | 5.03E−01 | 2.45E−01 | 3.06E−01 | BBSC |
| 3,4-dihydroxybenzoic acid | 3.64E−01 | 5.65E−01 | 3.58E−01 | 3.55E−01 | 3.08E−01 | 5.08E−01 | 3.97E−01 | 3.36E−01 | BBSC |
| 4-guanidinobutyric acid | BBSC | BBSC | BBSC | BBSC | BBSC | 3.93E−02 | 8.98E−02 | BBSC | BBSC |
| acetovanillone | BBSC | BBSC | BBSC | BBSC | BBSC | BBSC | 5.13E−02 | BBSC | BBSC |
| adenine | BBSC | BBSC | BBSC | BBSC | BBSC | BBSC | BBSC | BBSC | BBSC |
| a [symbol] ic acid | NF | NF | NF | NF | NF | NF | NF | NF | NF |
| AMP | BBSC | BBSC | BBSC | BBSC | BBSC | BBSC | BBSC | BBSC | BBSC |
| arginine | BBSC | BBSC | NF | BBSC | BBSC | BBSC | BBSC | NF | BBSC |
| asparagine | NF | BBSC | NF | NF | NF | BBSC | NF | NF | NF |
| aspartic acid | NF | NF | NF | NF | NF | NF | NF | NF | NF |
| beta-alanine | BBSC | 2.73E−02 | NF | NF | NF | 1.23E−01 | BBSC | NF | NF |
| betaine | NF | BBSC | NF | NF | NF | BBSC | BBSC | NF | NF |
| caffeic acid | NF | BBSC | NF | NF | NF | NF | NF | NF | NF |
| camphoric acid | 0.00E+00 | 0.00E+00 | 0.00E+00 | 0.00E+00 | 0.00E+00 | 0.00E+00 | 0.00E+00 | 0.00E+00 | 0.00E+00 |
| carnitine | BBSC | BBSC | NF | NF | NF | BBSC | BBSC | NF | NF |
| carnosine | NF | NF | NF | NF | NF | NF | NF | NF | NF |
| catechin | NF | NF | NF | NF | NF | NF | NF | NF | NF |
| choline | BBSC | BBSC | BBSC | BBSC | BBSC | BBSC | BBSC | BBSC | BBSC |
| cinnamic acid | BBSC | 1.99E+00 | BBSC | BBSC | BBSC | 1.33E+00 | 2.79E+00 | 1.04E+00 | BBSC |
| citric acid | NF | NF | NF | NF | NF | NF | NF | NF | NF |
| citrulline | NF | NF | NF | NF | NF | NF | NF | NF | NF |
| CMP | BBSC | NF | BBSC | BBSC | NF | NF | NF | BBSC | BBSC |
| coumaric acid | BBSC | BBSC | BBSC | BBSC | NF | BBSC | BBSC | BBSC | NF |
| cysteine | NF | NF | NF | NF | NF | NF | NF | NF | NF |
| cystine | NF | NF | NF | NF | NF | NF | NF | NF | NF |
| cytidine | BBSC | BBSC | NF | NF | NF | BBSC | BBSC | BBSC | NF |
| cytosine | NF | NF | NF | NF | BBSC | NF | NF | NF | BBSC |
| D-glucuronic acid | 1.80E+00 | 2.40E+00 | 8.50E−01 | 7.25E−01 | 3.63E−01 | 2.82E+00 | 3.61E+00 | 6.35E−01 | BBSC |
| egallic acid | ABSC | ABSC | ABSC | ABSC | ABSC | ABSC | ABSC | ABSC | 2.04E+01 |
| epicatechin gallate | NF | NF | NF | NF | NF | NF | NF | NF | NF |
| epichatechin | NF | NF | NF | NF | NF | NF | NF | NF | NF |
| fucose | ABSC | 3.66E+01 | ABSC | ABSC | ABSC | ABSC | ABSC | ABSC | 0.00E+00 |
| f [symbol] ric acid | NF | NF | NF | NF | NF | NF | NF | NF | NF |
| GABA | NF | BBSC | NF | NF | NF | BBSC | BBSC | NF | NF |
| galactose | NF | NF | NF | NF | NF | NF | NF | NF | 0.00E+00 |
| gallic acid | 3.73E+00 | 3.46E+00 | 2.11E+00 | 1.55E+00 | 2.22E+00 | 3.06E+00 | 1.08E+01 | 2.16E+00 | 4.86E−01 |
| glucosamine | NF | NF | NF | NF | NF | NF | NF | NF | NF |
| glutamic acid | NF | NF | NF | NF | NF | NF | NF | NF | NF |
| glutamine | NF | NF | NF | NF | NF | NF | NF | NF | NF |
| glycine | NF | NF | NF | BBSC | NF | BBSC | NF | NF | NF |
| guanine | BBSC | BBSC | NF | NF | NF | BBSC | BBSC | NF | BBSC |
| hesperetin | NF | NF | NF | NF | NF | NF | NF | NF | NF |
| histidine | NF | NF | NF | NF | NF | NF | NF | NF | NF |
| homoserine | BBSC | 7.01E−02 | BBSC | BBSC | BBSC | 9.08E−02 | 6.81E−02 | BBSC | BBSC |
| inositol | 7.96E+00 | 2.66E+01 | 1.07E+01 | 1.03E+01 | 1.61E+01 | 5.09E+00 | 2.08E+01 | 1.21E+01 | 0.00E+00 |
| (e.g., myo-inositol) | | | | | | | | | |
| isoleucine | NF | NF | NF | NF | NF | NF | NF | NF | NF |
| kynurenic acid | 0.00E+00 | 0.00E+00 | 0.00E+00 | 0.00E+00 | 0.00E+00 | 0.00E+00 | 0.00E+00 | 0.00E+00 | 0.00E+00 |
| lactic acid | 2.05E+01 | 1.27E+01 | 1.42E+00 | 3.73E+00 | 7.00E+00 | 1.06E+01 | 6.08E+00 | 1.40E+01 | 1.44E+00 |
| leucine | NF | BBSC | NF | NF | NF | BBSC | NF | NF | NF |
| lysine | NF | NF | NF | NF | NF | NF | NF | NF | NF |
| malic acid | 2.48E+00 | 2.91E+00 | 1.74E+00 | 1.83E+00 | 1.60E+00 | 3.63E+00 | 3.67E+00 | 1.80E+00 | 4.17E−01 |
| mannose | 1.69E+01 | 1.70E+01 | 1.69E+01 | 2.35E+01 | 1.69E+01 | 1.70E+01 | 2.58E+01 | 1.70E+01 | 0.00E+00 |
| methionine | NF | NF | NF | NF | NF | NF | NF | NF | NF |
| methyl gallate | BBSC | BBSC | BBSC | BBSC | BBSC | BBSC | BBSC | BBSC | BBSC |
| methyl-2-pyrrolyl ketone | NF | BBSC | BBSC | BBSC | BBSC | NF | NF | BBSC | NF |
| ornithine | NF | NF | NF | NF | NF | NF | NF | NF | NF |
| pantothenic acid | NF | NF | NF | NF | NF | NF | NF | NF | NF |
| phenylalanine | BBSC | BBSC | NF | NF | NF | BBSC | BBSC | NF | NF |
| pipecolinic acid | 1.07E−01 | 1.66E−01 | NF | NF | NF | 2.55E−01 | 3.08E−01 | 1.07E−01 | NF |
| p [symbol] rine | NF | NF | NF | NF | NF | NF | NF | NF | NF |
| polydatin | NF | NF | NF | NF | NF | NF | NF | NF | NF |
| proline | BBSC | 3.53E+00 | NF | BBSC | NF | 4.67E+00 | BBSC | BBSC | BBSC |
| propyl gallate | BBSC | NF | NF | BBSC | BBSC | NF | NF | BBSC | BBSC |
| pyridine | BBSC | BBSC | BBSC | 7.95E−01 | 8.27E+00 | BBSC | BBSC | BBSC | BBSC |
| pyridoxine | BBSC | BBSC | BBSC | BBSC | BBSC | BBSC | BBSC | BBSC | BBSC |
| pyruvic acid | BBSC | BBSC | BBSC | BBSC | BBSC | BBSC | BBSC | BBSC | BBSC |
| quercetin | 0.00E+00 | 0.00E+00 | 0.00E+00 | 0.00E+00 | 0.00E+00 | 0.00E+00 | 0.00E+00 | 0.00E+00 | 0.00E+00 |
| quinic acid | BBSC | BBSC | BBSC | BBSC | BBSC | BBSC | BBSC | BBSC | BBSC |
| resveratrol | NF | NF | NF | NF | NF | NF | NF | NF | NF |
| rutin | BBSC | BBSC | BBSC | BBSC | BBSC | NF | NF | BBSC | BBSC |
| salicylic acid | BBSC | BBSC | BBSC | BBSC | BBSC | BBSC | BBSC | BBSC | BBSC |
| serine | BBSC | BBSC | NF | NF | NF | BBSC | BBSC | NF | NF |
| sinapinic acid | NF | NF | NF | NF | NF | NF | NF | NF | NF |
| sorbic acid | 1.68E−01 | 1.92E−01 | 1.10E−01 | 2.78E−01 | 1.20E−01 | 2.04E−01 | 3.82E−01 | 1.81E−01 | 1.26E−01 |
| sorbitol | NF | NF | NF | NF | NF | NF | NF | NF | 0.00E+00 |
| succinic acid | 6.67E−01 | 8.42E−01 | BBSC | BBSC | 4.15E−01 | 1.40E+00 | 9.39E−01 | 4.33E−01 | BBSC |
| syringaldehyde | 1.43E+00 | 2.44E+00 | 2.17E+00 | 7.81E−01 | 2.07E+00 | 3.21E+00 | 4.57E+00 | 1.71E+00 | 4.29E−01 |
| syringic acid | BBSC | BBSC | BBSC | BBSC | 9.46E−01 | BBSC | BBSC | BBSC | 2.80E−01 |
| tartaric acid | 1.52E+01 | 1.44E+01 | 1.49E+00 | 2.42E+00 | 1.38E+00 | 3.82E+01 | 3.42E+01 | 2.00E+00 | 1.65E+00 |
| threonine | BBSC | BBSC | NF | NF | NF | BBSC | BBSC | NF | NF |
| trans 4-hydroxy-L-proline | BBSC | BBSC | NF | NF | NF | BBSC | BBSC | NF | NF |
| trans-ferulic acid | 1.75E+00 | BBSC | 1.00E+00 | 1.88E+00 | 1.81E+00 | BBSC | BBSC | 1.57E+00 | 1.25E+00 |
| tryptamine | NF | NF | NF | BBSC | NF | NF | NF | NF | BBSC |
| tryptophan | NF | NF | NF | NF | NF | NF | NF | NF | NF |
| tyramine | BBSC | BBSC | NF | NF | NF | BBSC | BBSC | NF | NF |
| tyrosine | NF | BBSC | NF | NF | NF | BBSC | NF | NF | NF |
| [symbol] il | BBSC | 9.25E−02 | NF | NF | NF | 1.02E−01 | 1.18E−01 | BBSC | NF |
| valine | NF | NF | NF | NF | NF | NF | NF | NF | NF |
| vanillic acid | NF | NF | NF | NF | 2.16E+01 | NF | NF | NF | 1.26E+01 |
| vanillin | 8.26E−01 | 1.29E+00 | 8.78E−01 | 4.67E−01 | 1.07E+00 | 9.55E−01 | 1.63E+00 | 9.52E−01 | 2.47E−01 |
| xylose | 0.00E+00 | 0.00E+00 | 0.00E+00 | 0.00E+00 | 0.00E+00 | 0.00E+00 | 0.00E+00 | 0.00E+00 | 0.00E+00 |

NF = Not found
ABSC = above best quality standard curves
BBSC = below best quality standard curves [symbol]
indicates data missing or illegible when filed

### Example 3—Generation of Concentrated Scotch Replicas

Scotch replica concentrates are made in ˜100 L test batches and held for a minimum of 8 weeks, with periodic sampling at 1, 2, 4, 6, and 8 weeks. Density measurements are taken each week, and three replicate bottles of whiskey replica are produced by adding 43% ABV spirit whiskey prior to filtering through a 0.45 PVDF vacuum filter. Samples are then submitted for analytical testing versus a corresponding non-concentrated whiskey replica, and versus each other, to assess volatile and non-volatile components. Organoleptic comparisons also are conducted. The concentrates are held in HDPE vessels, or in stainless steel at the highest concentration, to ensure that there are no changes in composition due to the storage material.

To generate a 5× Scotch replica concentrate, the ingredients listed below are added to 140 L of 43% ABV grain neutral spirits. This is an effective 700 L batch, but due to loss during decanting and filtering, excess is needed.

| Ingredient | Kg added |
|---|---|
| tannins | 0.14-2.24 |
| wood | 1.22-19.50 |

The ingredients are stirred in and held for 24 hours. The liquid is decanted and held for 24 hours to allow larger particulates to settle. The liquid is then filtered through a 5 micron absolute polypropylene cartridge filter prior to being dosed to 100 L in an HDPE open top drum that has been pre-measured to 100 L.

The following ingredients, as well as the VOCs for a 500 L (5×100 L) batch of a formulation from Table 1A or 1B are added to the drum and stirred thoroughly.

| Ingredient | Grams added |
|---|---|
| malic acid | 1.13-18.00 |
| tartaric acid | 9.50-152.00 |
| lactic acid | 2.63-42.00 |
| citric acid | 2.13-34.00 |
| D-glucuronic acid | 0.63-10.00 |
| cinnamic acid | 0.25-4.00 |
| succinic acid | 0.63-10.00 |
| fructose | 2.88-46.00 |
| glucose | 5.63-90.00 |
| gum arabic | 0.13-2.00 |
| glycerol | 1000-16000 |

To generate a 10× whiskey replica concentrate, the ingredients listed below are added to 140 L of 43% ABV grain neutral spirits. Again, this is an effective 700 L batch, but due to loss during decanting and filtering, excess is needed.

| Ingredient | Kg added |
|---|---|
| tannins | 0.28-4.48 |
| wood | 2.44-39.04 |

The ingredients are stirred in and held for 24 hours. The liquid is decanted and held for 24 hours to allow larger particulates to settle. The liquid is then filtered through a 5 micron absolute polypropylene cartridge filter prior to being dosed to 100 L in an HDPE open top drum that has been pre-measured to 100 L.

The following ingredients, as well as the VOCs for a 1000 L batch (10×100 L) of a formulation from Table 1A or 1B are added to the drum and stirred thoroughly.

| Ingredient | Grams added |
|---|---|
| malic acid | 2.25-36.00 |
| tartaric acid | 19.00-304.00 |
| lactic acid | 5.25-84.00 |
| citric acid | 4.25-68.00 |
| D-glucuronic acid | 1.25-20.00 |
| cinnamic acid | 0.50-8.00 |
| succinic acid | 1.25-20.00 |
| fructose | 5.75-92.00 |
| glucose | 11.25-180.00 |
| gum arabic | 0.25-4.00 |
| glycerol | 2000-32000 |

To generate a 20× Scotch replica concentrate, the ingredients listed below are added to 350 L of 43% ABV grain neutral spirits. Again, this is an effective 700 L batch, but due to loss during decanting and filtering, excess is needed.

| Ingredient | Kg added |
|---|---|
| tannins | 1.40-22.40 |
| wood | 12.20-195.16 |

The ingredients are stirred in and held for 24 hours. The liquid is decanted and held for 24 hours to allow larger particulates to settle. The liquid is then filtered through a 5 micron absolute polypropylene cartridge filter prior to being dosed to 100 L in an HDPE open top drum that has been pre-measured to 100 L.

The following ingredients, as well as the VOCs for a 2000 L batch (20×100 L) of a formulation from Table 1A or 1B were added to the drum and stirred thoroughly.

| Ingredient | Grams added |
|---|---|
| malic acid | 4.50-72.00 |
| tartaric acid | 38.00-608.00 |
| lactic acid | 10.50-168.00 |
| citric acid | 8.50-136.00 |
| D-glucuronic acid | 2.50-40.00 |
| cinnamic acid | 1.00-16.00 |
| succinic acid | 2.50-40.00 |
| fructose | 11.50-184.00 |
| glucose | 22.50-360.00 |
| gum arabic | 0.50-8.00 |
| glycerol | 4000-64000 |

To find the appropriate volume of concentrate (5×, 10×, or 20×) to add to create a finished product, the following formulas are used:

$$( {C}_{c o ncentrate} ) ( {V}_{c o ncentrate} ) = ( {C}_{finalproduct} ) ( {V}_{finalproduct} )$$

$${V}_{c o ncentrate} = \frac{( 1 ) ( {V}_{finalproduct} )}{( {C}_{c o ncentrate} )}$$

### Where:

C_{final product}=concentration of final product=1 (i.e., 1×)

V_{final product}=desired volume of finished product

C_{concentrate}=concentration of the concentrate (5×, 10×, or 20×)

V_{concentrate}=volume of concentrate to add to create finished product

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A Scotch-like alcoholic beverage comprising:
ethanol;
water; and
one or more additional volatile organic compounds (VOCs),
wherein the one or more additional VOCs comprise at least one compound selected from the group consisting of acetoin, (1R)-(−)-myrtenal, 3-ethyl-2-hydroxy-2-cyclopenten-1-one (ethyl cyclopentenolone), 1,4-cineole, 2-acetyl-1-methylpyrrole, 2-isopropyl-4-methyl thiazole, 3-methylthio hexyl acetate, 3-phenylpropanal, 4,5,6,7-tetrahydro-3,6-dimethylbenzofuran, 4-mercapto-4-methyl-2-pentanone, allyl heptanoate, amyl butyrate, anisyl acetate, anisyl butyrate, b-caryophellene, benzyl alcohol, benzyl butyrate, benzyl formate, beta-pinene, butyl butyryllactate, butyl formate, butyraldehyde, cis-3-hexenyl butyrate, cis-3-hexenyl valerate, cis-6-nonen-1-ol, citronellal, D-carvone, d-fenchone, DL-3-methyl-2-butanol, ethyl 2-trans-4-cis-decadienoate, ethyl trans-3-hexenoate, ethyl(methylthio) acetate, eucalyptol, furufyl thioacetate, gamma-hexalactone, gamma-valerolactone, hexyl 3-methylbutanoate, hexyl isobutyrate, IBMP (3-Isobutyl-2-methoxypyrazine), L-menthyl acetate, maltol, methionyl acetate (3-methylthio-propylacetate), methyl anthranilate, methyl cyclopentenolone, myrcene, nonanoic acid, p-anisaldehyde, perillaldehyde, phenylacetaldehyde dimethyl acetal, propionaldehyde, propyl butyrate, tetrahydrolinalool, trans-2-hexen-1-al, valeraldehyde, valeric acid, vanillyl butyl ether.

2. The Scotch-like alcoholic beverage of claim 1, wherein the one or more additional VOCs comprise at least one compound selected from the group consisting of acetoin, amyl butyrate, beta-pinene, butyl formate, butyraldehyde, maltol, myrcene, nonanoic acid, p-anisaldehyde, propionaldehyde, trans-2-hexen-1-al, valeraldehyde, valeric acid, and combinations thereof.

3. The Scotch-like alcoholic beverage of claim 1 or claim 2, wherein the one or more additional VOCs comprise at least one compound selected from the group consisting of acetoin, beta-pinene, butyl formate, maltol, myrcene, trans-2-hexen-1-al, valeraldehyde, and combinations thereof.

4. The Scotch-like alcoholic beverage of any one of claims 1-3, wherein the one or more additional VOCs do not comprise at least one compound selected from the group consisting 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone.

5. The Scotch-like alcoholic beverage of claim 4, wherein the one or more additional VOCs do not comprise at least one compound selected from the group consisting of 2-methoxy-4-methylphenol, 2-methylbutyl acetate, cis-3-hexen-1-ol, decanoic acid, delta-dodecalactone, ethyl salicylate, gamma-dodecalactone, gamma-octalactone, geranyl acetone, hexanoic acid, hexyl acetate, isoamyl isobutyrate, isobutyric acid, methyl decanoate, methyl laurate, myrtenol, octanoic acid, phenethyl octanoate, and propionic acid.

6. The Scotch-like alcoholic beverage of claim 4 or claim 5, wherein the one or more additional VOCs do not comprise at least one compound selected from the group consisting of 2-methoxy-4-methylphenol, cis-3-hexen-1-ol, delta-dodecalactone, ethyl salicylate, gamma-dodecalactone, gamma-octalactone, geranyl acetone, hexyl acetate, isoamyl isobutyrate, myrtenol, and phenethyl octanoate.

7. The Scotch-like alcoholic beverage of any one of claims 4-6, wherein the one or more additional VOCs do not comprise at least one compound selected from the group consisting of 2-methoxy-4-methylphenol, cis-3-hexen-1-ol, delta-dodecalactone, ethyl salicylate, gamma-dodecalactone, gamma-octalactone, hexyl acetate, and isoamyl isobutyrate.

8. The Scotch-like alcoholic beverage of any one of claims 1-7, wherein the one or more additional VOCs are present in a total amount of less than about 650 mg/L.

9. A Scotch-like alcoholic beverage comprising:
ethanol;
water; and
one or more additional VOCs, wherein the one or more additional VOCs do not comprise at least one compound selected from the group consisting of 1,1-diethoxyethane, 1-decanol, 2-heptanone, 2-methoxy-4-methylphenol (creosol), 2-methyl-1-butanol, 2-methylbutyl acetate, 2-methylbutyraldehyde, 2-nonanone, 2-phenylethanol, 2-phenylethylacetate, benzaldehyde, butanol, cis-3-hexen-1-ol, citronellol, decanoic acid, delta-decalactone, delta-dodecalactone, diethyl malate, diethyl succinate, ethyl acetate, ethyl benzoate, ethyl butanoate, ethyl cinnamate, ethyl decanoate, ethyl heptanoate, ethyl hexanoate, ethyl isovalerate, ethyl laurate, ethyl myristate, ethyl nonanoate, ethyl octanoate, ethyl propionate, ethyl salicylate, ethyl undecanoate, ethyl valerate, eugenol, farnesol, furfural, gamma-dodecalactone, gamma-nonalactone, gamma-octalactone, geranyl acetone undacadien, hexanoic acid, hexanol, hexyl acetate, isoamyl acetate, isoamyl alcohol, isoamyl isobutyrate, isoamyl octanoate, isobutanol, isobutyl acetate, isobutyraldehyde, isobutyric acid, limonene, methyl decanoate, methyl laurate, myrtenol, octanoic acid, phenethyl butyrate, phenethyl octanoate, propanol, propionic acid, salicylaldehyde, and whiskey lactone.

10. The Scotch-like alcoholic beverage of any one of claims 1-9, wherein the one or more additional VOCs are present in a total amount of less than about 650 mg/L.

11. A Scotch-like alcoholic beverage comprising:
ethanol;
water; and
one or more additional VOCs, wherein the one or more additional VOCs are present in a total amount of less than about 650 mg/L.

12. The Scotch-like alcoholic beverage of any one of claims 1 to 11, wherein the one or more additional VOCs comprise:
an ester;
an alcohol;
an aldehyde, a ketone, or a mixture thereof; and
a terpene, an isoprenoid, or a mixture thereof.

13. The Scotch-like alcoholic beverage of any one of claims 1 to 12, further comprising one or more non-volatile compounds.

14. The Scotch-like alcoholic beverage of claim 13, wherein the one or more non-volatile compounds comprise one or more compounds selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose. In some embodiments, a non-volatile compound that is not present in traditional Scotch can be selected from the group consisting of valine, and xylose.

15. The Scotch-like alcoholic beverage of claim 14, wherein the one or more non-volatile compounds comprise one or more compounds selected from the group consisting of valine, xylose, and combinations thereof.

16. The Scotch-like alcoholic beverage of any one of claims 13 to 15, wherein the one or more non-volatile compounds do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.

17. The Scotch-like alcoholic beverage of claim 16, wherein the one or more non-volatiles do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, AMP, arabitol, egallic acid, homoserine, methyl gallate, pyridine, pyruvic acid, quinic acid, rhamnose, and salicylic acid.

18. A Scotch-like alcoholic beverage comprising:
ethanol;
water; and
one or more additional VOCs,
wherein at least one of the following, in any combination, is true:
2-methyl-1-butanol is present in an amount less than about 75 mg/L or 2-methyl-1-butanol is present in an amount of at least about 635 mg/L;
delta-decalactone is present in an amount less than about 0.013 mg/L or delta-decalactone is present in an amount of at least about 0.27 mg/L;
ethyl acetate is present in an amount less than about 42 mg/L or ethyl acetate is present in an amount of at least about 780 mg/L;
ethyl undecanoate is present in an amount less than about 0.007 mg/L or ethyl undecanoate is present in an amount of at least about 0.12 mg/L;
1-decanol is present in an amount less than about 0.065 mg/L;
2-methylbutyraldehyde is present in an amount less than about 0.012 mg/L;
benzaldehyde is present in an amount less than about 0.003 mg/L;
butanol is present in an amount less than about 3.3 mg/L;
citronellol is present in an amount less than about 0.0002 mg/L;
decanoic acid is present in an amount less than about 1.7 mg/L;
diethyl succinate is present in an amount less than about 0.3 mg/L;
ethyl butanoate is present in an amount less than about 0.14 mg/L;
ethyl cinnamate is present in an amount less than about 0.00035 mg/L;
ethyl heptanoate is present in an amount less than about 0.006 mg/L;
ethyl isovalerate is present in an amount less than about 0.06 mg/L;
ethyl nonanoate is present in an amount less than about 0.0075 mg/L;
ethyl octanoate is present in an amount less than about 0.85 mg/L;
ethyl propionate is present in an amount less than about 0.34 mg/L;
Ethyl Valerate is present in an amount less than about 0.0045 mg/L;
furfural is present in an amount less than about 0.7 mg/L;
hexanol is present in an amount less than about 0.014 mg/L;
isoamyl acetate is present in an amount less than about 0.18 mg/L;
isoamyl alcohol is present in an amount less than about 38 mg/L;
isoamyl octanoate is present in an amount less than about 0.0005 mg/L;
isobutanol is present in an amount less than about 72 mg/L;
isobutyl acetate is present in an amount less than about 0.03 mg/L;
methyl decanoate is present in an amount less than about 0.0004 mg/L;
Myrtenol is present in an amount less than about 0.085 mg/L;
octanoic acid is present in an amount less than about 2.5 mg/L;
p-cresol is present in an amount less than about 0.009 mg/L;
Phenethyl Butyrate is present in an amount less than about 0.0003 mg/L;
phenethyl octanoate is present in an amount less than about 0.0006 mg/L;
propanol is present in an amount less than about 100 mg/L;
ethyl benzoate is present in an amount less than about 0.0045 mg/L;
gamma-nonalactone is present in an amount less than about 0.0065 mg/L;
Propionic acid is present in an amount less than about 0.38 mg/L;
Hexanoic acid is present in an amount less than about 3.6 mg/L;
1,1-diethoxyethane is present in an amount of at least about 4 mg/L;
2,3-pentadione is present in an amount of at least about 0.0015 mg/L;
4-Ethyl Phenol is present in an amount of at least about 1.7 mg/L;
amyl alcohol is present in an amount of at least about 0.03 mg/L;
beta-ionone is present in an amount of at least about 0.004 mg/L;
butyl acetate is present in an amount of at least about 0.98 mg/L;
butyric acid is present in an amount of at least about 2 mg/L;
carvone is present in an amount of at least about 0.0023 mg/L;
Cinnamaldehyde is present in an amount of at least about 0.04 mg/L;
damascenone is present in an amount of at least about 0.14 mg/L;
ethyl isobutyrate is present in an amount of at least about 5.5 mg/L;
gamma-decalactone is present in an amount of at least about 0.4 mg/L;
gamma-terpinene is present in an amount of at least about 0.0013 mg/L;
limonene is present in an amount of at least about 0.01 mg/L;
linalyl acetate is present in an amount of at least about 0.03 mg/L;
methyl hexanoate is present in an amount of at least about 0.002 mg/L;
geraniol is present in an amount of at least about 0.04 mg/L;
isobutyraldehyde is present in an amount of at least about 4.4 mg/L;
at least about 0.4% by mass of the one or more additional VOCs is isobutyl acetate;
less than about 0.026% by mass of the one or more additional VOCs is decanoic acid;
less than about 0.004885% by mass of the one or more additional VOCs is diethyl succinate;
less than about 0.00007% by mass of the one or more additional VOCs is Ethyl Valerate;
less than about 0.85% by mass of the one or more additional VOCs is isoamyl alcohol;
less than about 0.0013% by mass of the one or more additional VOCs is Myrtenol;
less than about 0.0000045% by mass of the one or more additional VOCs is Phenethyl Butyrate;
at least about 0.00035% by mass of the one or more additional VOCs is carvone;
at least about 0.006% by mass of the one or more additional VOCs is Cinnamaldehyde;
at least about 0.02% by mass of the one or more additional VOCs is damascenone;
at least about 0.04% by mass of the one or more additional VOCs is delta-decalactone;
at least about 0.0035% by mass of the one or more additional VOCs is ethyl cinnamate;
at least about 0.78% by mass of the one or more additional VOCs is ethyl isobutyrate;
at least about 0.4% by mass of the one or more additional VOCs is ethyl isovalerate;
at least about 19% by mass of the one or more additional VOCs is ethyl lactate;
at least about 0.017% by mass of the one or more additional VOCs is ethyl undecanoate;
at least about 04.5% by mass of the one or more additional VOCs is furfural;
at least about 0.06% by mass of the one or more additional VOCs is gamma-decalactone;
at least about 0.0002% by mass of the one or more additional VOCs is gamma-terpinene;
at least about 0.014% by mass of the one or more additional VOCs is isoamyl hexanoate;
at least about 0.0015% by mass of the one or more additional VOCs is limonene;
at least about 0.004% by mass of the one or more additional VOCs is linalyl acetate;
at least about 0.0003% by mass of the one or more additional VOCs is methyl hexanoate;
at least about 0.0025% by mass of the one or more additional VOCs is methyl laurate;
at least about 0.003% by mass of the one or more additional VOCs is ethyl 3-hydroxyhexanoate;
at least about 0.045% by mass of the one or more additional VOCs is ethyl levulinate;
at least about 0.008% by mass of the one or more additional VOCs is farnesol Results;
at least about 0.006% by mass of the one or more additional VOCs is geraniol;
at least about 0.65% by mass of the one or more additional VOCs is isobutyraldehyde;
at least about 0.008% by mass of the one or more additional VOCs is phenethyl formate;
at least about 0.035% by mass of the one or more additional VOCs is propyl acetate;
at least about 0.02% by mass of the one or more additional VOCs is vanillyl ethyl ether Results;
at least about 0.0732393% by mass of the one or more additional VOCs is 2-heptanone;
at least about 0.0025% by mass of the one or more additional VOCs is geranyl acetone undacadien;
at least about 0.001% by mass of the one or more additional VOCs is methional;
at least about 0.01% by mass of the one or more additional VOCs is ethyl trans-2-butenoate; or
at least about 0.0003% by mass of the one or more additional VOCs is isoamyl isovalerate.

19. A Scotch-like alcoholic beverage comprising:
ethanol;
water; and
one or more additional VOCs,
wherein at least one of the following, in any combination, is true:
1-decanol is present in an amount less than about 0.065 mg/L;
2-methyl-1-butanol is present in an amount less than about 75 mg/L;
decanoic acid is present in an amount less than about 1.7 mg/L;
diethyl succinate is present in an amount less than about 0.3 mg/L;
ethyl acetate is present in an amount less than about 42 mg/L;
ethyl butanoate is present in an amount less than about 0.14 mg/L;
ethyl propionate is present in an amount less than about 0.34 mg/L;
isobutanol is present in an amount less than about 72 mg/L;
Myrtenol is present in an amount less than about 0.085 mg/L;
octanoic acid is present in an amount less than about 2.5 mg/L;
p-cresol is present in an amount less than about 0.009 mg/L;
Phenethyl Butyrate is present in an amount less than about 0.0003 mg/L;
phenethyl octanoate is present in an amount less than about 0.0006 mg/L;
propanol is present in an amount less than about 100 mg/L;
gamma-nonalactone is present in an amount less than about 0.0065 mg/L;
Propionic acid is present in an amount less than about 0.38 mg/L;
Hexanoic acid is present in an amount less than about 3.6 mg/L;
amyl alcohol is present in an amount of at least about 0.03 mg/L;
delta-decalactone is present in an amount of at least about 0.27 mg/L;
linalyl acetate is present in an amount of at least about 0.03 mg/L;
geraniol is present in an amount of at least about 0.04 mg/L;
at least about 0.04% by mass of the one or more additional VOCs is delta-decalactone;
at least about 0.0035% by mass of the one or more additional VOCs is ethyl cinnamate;
at least about 0.0015% by mass of the one or more additional VOCs is limonene;
at least about 0.004% by mass of the one or more additional VOCs is linalyl acetate; or
at least about 0.006% by mass of the one or more additional VOCs is geraniol.

20. The Scotch-like alcoholic beverage of any one of claims 1 to 19, further comprising one or more non-volatile compounds.

21. The Scotch-like alcoholic beverage of claim 20, wherein the one or more non-volatile compounds comprise one or more compounds selected from the group consisting of adipic acid, camphoric acid, carnosine, catechin, cysteine, cystine, epicatechin gallate, epichatechin, hesperetin, isoleucine, ornithine, pantothenic acid, piperine, polydatin, quercetin, resveratrol, sinapinic acid, tryptophan, valine, and xylose. In some embodiments, a non-volatile compound that is not present in traditional Scotch can be selected from the group consisting of valine, and xylose.

22. The Scotch-like alcoholic beverage of claim 21, wherein the one or more non-volatile compounds comprise one or more compounds selected from the group consisting of valine, xylose, and combinations thereof.

23. The Scotch-like alcoholic beverage of any one of claims 20 to 22, wherein the one or more non-volatile compounds do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, acetovanillone, adenine, AMP, arabitol, choline, D-glucuronic acid, egallic acid, fructose, gallic acid, glucose, homoserine, lactic acid, malic acid, mannitol, methyl gallate, pyridine, pyridoxine, pyruvic acid, quinic acid, rhamnose, ribose, salicylic acid, succinic acid, syringaldehyde, syringic acid, tartaric acid, trans-ferulic acid, and vanillin.

24. The Scotch-like alcoholic beverage of claim 23, wherein the one or more non-volatiles do not comprise one or more compounds selected from the group consisting of 2,3,5,6-tetramethylpyrazine, 2,3,5-trimethylpyrazine, 2-isopropylmalic acid, 3,4-dihydroxybenzoic acid, 4-guanidinobutyric acid, AMP, arabitol, egallic acid, homoserine, methyl gallate, pyridine, pyruvic acid, quinic acid, rhamnose, and salicylic acid.

25. A method of making a Scotch-like alcoholic beverage, the method comprising:
providing an aqueous solution; and
adding to the aqueous solution ingredients comprising:
ethanol,
a source of a tannin,
a plurality of oak pieces or oak extract,
nonvolatile compounds, wherein the nonvolatile compounds comprise a sugar or sugar alcohol and an acid, and
VOCs, wherein the VOCs comprise an ester, an alcohol, an aldehyde or a ketone or both, and a terpene or an isoprenoid or both.

26. A method of making a Scotch-like alcoholic beverage, the method comprising:
combining ingredients comprising:
water;
ethanol; and
five or more additional VOCs, wherein at least five of the five or more additional VOCs are provided as separate ingredients.

27. The method of claim 26, comprising 10 or more additional VOCs, wherein at least 10 of the 10 or more additional VOCs are provided as separate ingredients.

28. A method of making a Scotch-like alcoholic beverage, the method comprising:
providing a composition comprising:
ethanol;
water; and
one or more additional VOCs, wherein at least one of the one or more additional VOCs is present in a concentration of at least about 2-fold the concentration of the same VOC in a corresponding traditional Scotch, and
adding to the composition ethanol, water, or a combination thereof such that the concentration of the at least one additional VOC is reduced to about the concentration of the same VOC in a corresponding traditional Scotch.

29. The method of claim 28, wherein the one or more additional VOCs comprise at least one VOC that is not present in a corresponding traditional Scotch.

30. The method of claim 28 or claim 29, wherein the one or more additional VOCs do not comprise at least one VOC that is present in a corresponding traditional Scotch.

31. The method of any one of claims 28-30, wherein the Scotch-like alcoholic beverage further comprises one or more non-volatile compounds, and wherein the one or more non-volatile compounds comprise at least one non-volatile compound that is not present in a corresponding traditional Scotch.

32. The method of any one of claims 28-31, wherein the Scotch-like alcoholic beverage further comprises one or more non-volatile compounds, and wherein the one or more non-volatile compounds do not comprise at least one non-volatile compound that is present in a corresponding traditional Scotch.

33. The method of any one of claims 28-32, wherein the one or more additional VOCs are present in the composition in a concentration of at least about 5-fold the concentration of the same VOCs in a corresponding traditional Scotch.

34. The method of any one of claims 28-33, wherein the one or more additional VOCs are present in the composition in a concentration of at least about 10-fold the concentration of the same VOC in a corresponding traditional Scotch.

35. The method of any one of claims 28-34, wherein after the adding step, the Scotch-like alcoholic beverage is the Scotch-like alcoholic beverage of any one of claims 1-24.
